(19) United States
(12) Patent Application Publication
(10) Pub. No.: US 2022/0179665 A1
(43) Pub. Date: Jun. 9, 2022

(54) Displaying user related contextual keywords and controls for user selection and storing and associating selected keywords and user interaction with controls data with user

(71) Applicant: Yogesh Rathod, Mumbai (IN)

(72) Inventor: Yogesh Rathod, Mumbai (IN)

(21) Appl. No.: 17/336,346

(22) Filed: Jun. 2, 2021

Related U.S. Application Data
(63) Continuation of application No. PCT/IB2017/057578, filed on Dec. 1, 2017.
Application No. PCT/IB2017/057578 is a continuation of application No. PCT/IB2017/050468, filed on Jan. 29, 2017.

(51) Int. Cl. G06F 9/451

(52) U.S. Cl. CPC G06F 9/451

(57) ABSTRACT

System and method for displaying contextual keywords with corresponding associated or related or contextual one or more types of user actions, reactions, call-to-actions, relations, activities and interactions for user selection, wherein displaying contextual keywords based on plurality of factors and in the event of selection of keywords store and associate keywords with unique identity of user and in the event of selection of keyword associated action, associate keywords with unique identity of user and store data related to selected type of user actions, reactions, call-to-actions, relations, activities and interactions.

### COPYRIGHTS INFORMATION

A portion of the disclosure of this patent document contains material which is subject to (copyright or mask work) protection. The (copyright or mask work) owner has no objection to the facsimile reproduction by anyone of the patent document or the patent disclosure, as it appears in the Patent and Trademark Office patent file or records, but otherwise reserves all (copyright or mask work) rights whatsoever. The applicant acknowledges the respective rights of various Intellectual property owners.

### FIELD OF INVENTION

The present invention relates generally to displaying contextual keywords with corresponding associated or related or contextual one or more types of user actions, reactions, call-to-actions, relations, activities and interactions for user selection, wherein displaying contextual keywords based on plurality of factors and in the event of selection of keywords store and associate keywords with unique identity of user and in the event of selection of keyword associated action, associate keywords with unique identity of user and store data related to selected type of user actions, reactions, call-to-actions, relations, activities and interactions.

### BACKGROUND OF THE INVENTION

Recently Apple™ offers touch ID to use fingerprint to unlock a handset, Google™ has now released an update to its Android software allowing owners to unlock their phone with their voice. U.S. Pat. No. 8,235,529 teaches “The computing system may generate a display of a moving object on the display screen of the computing system. An eye tracking system may be coupled to the computing system. The eye tracking system may track eye movement of the user. The computing system may determine that a path associated with the eye movement of the user substantially matches a path associated with the moving object on the display and switch to be in an unlocked mode of operation including unlocking the screen.” All above prior arts requires particular hardware or user intervention to unlock device. Most of the smart device including mobile devices now enabled user to use camera while device is lock by tapping on camera icon. Present invention enables user to either unlock device by using eye tracking system via employing user device image sensor or auto open camera display screen by identifying pre-defined types of device orientation and pre-defined aye gaze via eye tracking system. Because present invention wants to auto open camera on lacked device which at present user has to tap on camera icon to open the camera, so it's possible to employ simple eye tracking system and orientation sensor(s) to auto open camera and there is no issue of privacy and security to need to employ advance fingerprint hardware or each time issue voice command.

Currently user has to each time unlock device and invoke or click or tap on default camera application or other one or more types of photo applications for capturing photo or recording video or voice or preparing one or more type of media. In an embodiment present invention identifies user intention to take photo or video based on one or more types of eye tracking system to detect that user want to start camera screen display to capture photo or record video or invoke & access camera display screen and based on that automatically open camera display screen or application or interface without user need to manually open it each time when user want's to capture photo or record video/voice or access device camera. Eye tracking system identifies eye positions and movement by eye tracking to measure the point of gaze to identify eye position e.g. straight to eye(s) for taking photo or video and automatically invoke, open and show camera display screen so user is enable to capture photo or video without each time manually open camera application. In another embodiment present invention identifies user intention to take photo or video based on one or more types of sensors by identifying device position i.e. far from body. Based on one or more types of eye tracking system and/or sensors, present invention also detect or identifies user intention to view received or shared contents or one or more types of media including photos or videos or posts from one or more contacts or sources e.g. Eye tracking system identifies eye positions and movement by eye tracking to measure the point of gaze to identify eye position and proximity sensor identifies distance of user device (e.g. device in hand in viewing position), so based on that system identifies user intention to read or view media.

At present Snapchat™ or Instagram™ enables user to view received ephemeral message or one or more types of visual media items or content items from senders for pre-set view duration set by sender and in the event of expiration of said timer, remove said ephemeral message from recipient's device and/or server. Because there are plurality types of user contacts including friends, relatives, family, other types of contacts there is need of identifying or providing different ephemeral and/or non-ephemeral settings for different types of users. For example for family members user wants that they can save user's posts or view alter and for other users e.g. some friends wants they can view user posted content items for pre-set view duration only and in the event of expiry of said pre-set duration of timer remove said user ported content items from their device. For some contacts e.g. best friends user wants they can real-time view and react real-time. So present invention enables sender user and receiving user to select, input, apply, and set one or more types of ephemeral and non-ephemeral settings for one or more contacts or senders or recipients or sources or destinations for sending or receiving of contents.

U.S. Pat. No. 9,148,569 teaches “according to one embodiment of the present invention, a check's image is automatically captured. A stabilization parameter of the mobile device is determined using a movement sensor. It is determined whether the stabilization parameter is greater than or equal to a stabilization threshold. An image of the check is captured using the mobile device if the stabilization parameter is greater than or equal to the stabilization threshold.” But said invention does not tech about in single mode capturing of photo or video based on the stabilization threshold and the receiving of haptic contact engagement or tap on the single mode input icon which determines whether a photograph will be recorded or a video. Present invention teaches, based on monitored device stabilization parameter via device senor, stabilization threshold is identified. In the event of stabilization parameter is greater than or equal to a stabilization threshold and in response to haptic contact engagement, photo is captured and photo is store. If stabilization parameter is not greater than or not equal to a stabilization threshold or in the event of stabilization parameter is less than to a stabilization threshold and in response to haptic contact engagement, start recording of video and start timer and in an embodiment stop video, store video and stop or re-initiate timer in the event of expiration of pre-set timer.

At present Snapchat™ or Instagram™ enables user to add one or more photos or videos to “My Stories” or feed for publishing or broadcasting or presenting said added phots or videos or sequence of photos or videos to one or more or all friends or contacts or connections or followers or particular category or type of user. Snapchat™ or Instagram™ enables user to add one or more photos or videos to “Our Stories” or feed i.e. add photos or videos to particular events or place or location or activity or category and making them available to requested user or searching user or connected or related user.

At present some of the photo sharing applications enables user to prepare one or more types of media including capture photo or record video or prepare text contents or any combination thereof and add to user's stories or add to particular type or category related feeds or add to particular event(s) for making them available to one or more or all friends or contacts or connections or networks or followers or groups or making available for all or particular type of users. None of the presently available type of feed(s) or story or stories enables user to provide object criteria i.e. model of object or sample image or sample photo and provide one or more criteria or conditions or rules or preferences or settings and based on that provide object model or sample image and provided one or more criteria or conditions or rules or preferences or settings identify or recognize or track or match one or more matched object or full or part of image or photo or video inside captured or presented or live photo or video and merge all identified photos or videos and present to user. For example by using present invention user can provide object model or sample image of “coffee” and/or provide “coffee” keyword and/or provide location as “Mumbai” for searching all coffee related photos and videos by identifying or recognizing “coffee” object inside photo or video and matching said provided “coffee” object or sample image with said identified “coffee” object or image inside said captured or selected or live photo or video and processing or merging or separating or sequencing said all identified photos and videos and presenting to user or searching user or requesting user or recipient user or targeting user.

At present photo applications or Google Glass™ or Snapchat Spectacles™ enables user to capture photo or record video and send or post to one or more selected contacts or one or more types of stories or feeds. So by using camera of smartphone or photo applications or one or more types of wearable devices including spectacles, it's very easy to capture someone's photos or selfie or record video without knowing to them. So there is need arise to provide privacy settings to allow or not allow 3^{rd} parties or user's contacts or other users to capture user's photo or record video. Present invention enables user to allow or not allow all or selected one or more users and/or allow or not allow all or selected one or more users at particular one or more pre-defined location(s) or place(s) or pre-defined geo-fence boundaries and/or allow or not allow all or selected one or more users at particular one or more pre-defined location(s) or place(s) or pre-defined geo-fence boundaries at particular pre-set schedule(s) to capture user's photo or record video or allow or not allow to capture photo or record video at particular selected location(s) or place(s) or within pre-defined geo-fence boundaries and/or at particular pre-set schedule(s) and/or for all or one or more selected users (phone contacts, social contacts, clients, customers, guests, subscribers, attendees, ticket holders etc.) or one or more types of pre-defined users or pre-defend particular type of characteristics of users.

Currently Google™ search engine enables user to search as per user provided search query or keywords and present search result. Advertisers can create and manage one or more campaign and associate advertisements groups and associate advertisements. Advertisers can provide keywords, bids, advertisement text or description, image, video and settings. Based on said created advertisements related keywords and bids Google™ search present advertisement to searching user by matching user's search keywords with advertisement related keywords and present highest bids advertisement top position or in prominent place on search result page. Google Image Search™ search and present matched or some level identical images based on user provided image. Present invention enables user to provide or upload or set or apply image or image of part of or particular object, item, face of people, brand, logo, thing, product or object model and/or provide textual description, keywords, tags, metadata, structured fields and associate values, templates, samples & requirement specification and/or provide one or more conditions including similar, exact match, partially match, include & exclude, Boolean operators including AND/OR/NOT/+/−/Phrases, rules. Based on provided object model, object type, metadata, object criteria & conditions server identifies, matches, recognize photos or videos stored by server or accessed but server provided from one or more sources, databases, networks, applications, devices, storage mediums and present to users wherein presented media includes series of or collections of or groups of or slide shows of photos or merged or sequences of or collection of videos or live streams. For example plurality of merchant can upload videos of available products and/or associate details which server stores at server database. Searching user is enabled to provide or input or select or upload one or more image(s) or object model of particular object or product e.g. “mobile device” and provide particular location or place name as search query. Based on said search query server matches or identifies said object e.g. “mobile device” with recognized or detected or identified object inside videos and/or photos and/or live stream and/or one or more types of media stored or accessed from one or more sources and present or present merged or series of said identified or searched or matched videos and/or photos and/or live stream and/or one or more type of media to searching user or contextual user or requested user or user(s) of network.

Present invention teaches various embodiments related to ephemeral contents including rule base ephemeral message system, enabling sender to post content or media including photo and enable to add or update or edit or delete one or more content item including photo or video from one or more recipient devices, whom sender sends or adds based on connection with recipient and/or privacy settings of recipient.

At present plurality of applications particularly Snapchat™ enables user to capture and post captured photo or video to selected contacts and/or “My Stories” and/or “Our Stories” and post will delete after particular set period of time by sender at recipient device or application. U.S. Pat. No. 8,914,752 teaches “present on a display indicia of a set of ephemeral messages available for viewing; present on the display a first ephemeral message of the set of ephemeral messages for a first transitory period of time defined by a timer, wherein the first ephemeral message is deleted when the first transitory period of time expires; receive from a touch controller a haptic contact signal indicative of a gesture applied to the display during the first transitory period of time; wherein the ephemeral message controller deletes the first ephemeral message in response to the haptic contact signal and proceeds to present on the display a second ephemeral message of the set of ephemeral messages for a second transitory period of time defined by the timer, wherein the ephemeral message controller deletes the second ephemeral message upon the expiration of the second transitory period of time; wherein the second ephemeral message is deleted when the touch controller receives another haptic contact signal indicative of another gesture applied to the display during the second transitory period of time; and wherein the ephemeral message controller initiates the timer upon the display of the first ephemeral message and the display of the second ephemeral message.”

Ephemeral messaging may rely on a timer to determine the length of viewing time for content. For example, a message sender may specify the length of viewing time for the message recipient. When receiving a set of timed content to be viewed sequentially, sometimes the set viewing period for a given piece of content can exceed the viewing period desired by the message recipient. That is, the message recipient may want to terminate the current piece of content to view the next piece of content. U.S. Pat. No. 8,914,752 (Spiegel Evan et el), discloses an electronic device comprises a display and an ephemeral message controller to present on the display an ephemeral message for a transitory period of time. A touch controller identifies haptic contact on the display during the transitory period of time. The ephemeral message controller terminates the ephemeral message in response to the haptic contact. Present invention discloses an electronic device comprises a display and an ephemeral message controller to present on the display an ephemeral message for a transitory period of time. A sensor controller identifies user sense on the display or application or device during the transitory period of time. The ephemeral message controller terminates the ephemeral message in response to the receiving of one or more type of identified user sense via one or more type of sensors. Present invention also teaches multi-tabs presentation of ephemeral messages and based on switching of tab, pausing of view timer associated with each message presented on current tab and presents set of content items related to switched tab and start timers associated with each presented message related to switched tab and in the event of expiry of timer or haptic contact engagement remove ephemeral message and present next one or more (if any) ephemeral messages.

At present photo applications enables user to capture photo or record video and send to one or more contacts or feeds or stories or destinations and recipient or viewing user can view said posted content items at their time and provide reactions e.g. like, dislike, rating or emoticons at any time. Present invention enables real-time or maximum possible near real-time sharing and/or viewing and/or reacting of/on posted or broadcasted or sent one or more types of one or more content items or visual media items or news items or posts or ephemeral message(s).

Ephemeral messaging may rely on a timer to determine the length of viewing time for content. For example, a message sender may specify the length of viewing time for the message recipient. When receiving a set of timed content to be viewed sequentially, sometimes the set viewing period for a given piece of content can exceed the viewing period desired by the message recipient. That is, the message recipient may want to terminate the current piece of content to view the next piece of content. U.S. Pat. No. 8,914,752 (Spiegel Evan et el), discloses an electronic device comprises a display and an ephemeral message controller to present on the display an ephemeral message for a transitory period of time. A touch controller identifies haptic contact on the display during the transitory period of time. The ephemeral message controller terminates the ephemeral message in response to the haptic contact. Present invention discloses or teaches about various types of ephemeral stories, feeds, galleries or albums including view and completely scroll content item to remove or hide from presentation interface or remove after pre-set wait duration, load more or push to refresh or auto refresh (after pre-set interval duration) to remove currently present content and present next set of contents (if any) from presentation or user interface or enable sender to apply or pre-set view duration for set of content items and present said posted set of or one or more content items to viewers or target o intended recipients and present for pre-set duration of timer and in the event of expiry of timer remove set of presented content items or visual media items and display next set of content items or visual media items or enable sender to apply view timer for each posted content item and present more than one content items and each content item having different pre-set view duration and in the event of expiry of view duration remove each expired content item and present new content item, enable receiver to pre-set number of times of views and remove after said pre-set number of times of views or enabling viewing user to mark content item as ephemeral or non-epithermal or enabling viewing user to hold and view photo or video and in the event of releases or expiry of pre-set view timer remove viewed content and also remove thumbnail or index item.

At present GroupOn™ and other group deals sites enables group deals or Group buying, also known as collective buying, offers products and services at significantly reduced prices on the condition that a minimum number of buyers would make the purchase. Typically, these websites feature a “deal of the day”, with the deal kicking in once a set number of people agree to buy the product or service. Buyers then print off a voucher to claim their discount at the retailer. Many of the group-buying sites work by negotiating deals with local merchants and promising to deliver a higher foot count in exchange for better prices. Present invention enables one or more types of mass user action(s) including participate in mass deals, buy or make order, view and like & review movie trailer release first time, download, install & register application, listen first time launched music, buy curate product, buy latest technology products, subscribe services, like and comment on movie song or story, buy books, view latest or top trend news or tweet or advertisement or announcement at specified date & time for particular pre-set duration of time with customized offer e.g. get points, get discounts, get free samples, view first time movie trailer, refer friends and get more discounts (like chain marketing), which mainly enables curate or verified or picked up or mas level effected but less known or first time launch products, services, mobile application to get huge traction and sells or bookings. User can get preference based or use data specific contextual push notifications or indication or can directly view from application, date & time specific presented content (advertisement, news, group deals, trailer, music, customized offers etc.) with one or more types of mass action (install, sign off mass or group deals, register, view trailer, fill survey form, like product, subscribe service etc.)

Current methods of visual media recording require that a user specify the format of the visual media—either a photograph or a video—prior to capture. Problematically, a user must determine the optimal mode for recording a given moment before the moment has occurred. Moreover, the time required to toggle between different media settings often results in a user failing to capture an experience. Snapchat U.S. Pat. No. 8,428,453 (et. el. Spiegel; Evan Thomas) discloses an electronic device includes digital image sensors to capture visual media, a display to present the visual media from the digital image sensors and a touch controller to identify haptic contact engagement, haptic contact persistence and haptic contact release on the display. A visual media capture controller alternately records the visual media as a photograph or a video based upon an evaluation of the time period between the haptic contact engagement and the haptic contact release. A device may include a media application to capture digital photos or digital video. In many cases, the application needs to be configured into a photo-specific mode or video-specific mode. Switching between modes may cause delays in capturing a scene of interest. Further, multiple inputs may be needed thereby causing further delay. Improvements in media applications may therefore be needed. Facebook U.S. Pat. No. 9,258,480 discloses techniques to selectively capture media using a single user interface element are described. In one embodiment, an apparatus may comprise a touch controller, a visual media capture component, and a storage component. The touch controller may be operative to receive a haptic engagement signal. The visual media capture component may be operative to be configured in a capture mode based on whether a haptic disengagement signal is received by the touch controller before expiration of a first timer, the capture mode one of a photo capture mode or video capture mode, the first timer started in response to receiving the haptic engagement signal, the first timer configured to expire after a first preset duration. The storage component may be operative to store visual media captured by the visual media capture component in the configured capture mode. Users of client devices often use one or more messaging applications to send messages to other users associated with client devices. The messages include a variety of content ranging from text to images to videos. However, the messaging applications often provide the user with a cumbersome interface that requires users to perform multiple user interactions with multiple user interface elements or icons in order to capture images or videos and send the captured images or videos to a contact or connection associated with the user. If a user simply wishes to quickly capture a moment with an image or video and send to another user, typically the user must click through multiple interfaces to take the image/video, select the user to whom it will be sent, and initiate the sending process. It would instead be beneficial for a messaging application to present a user interface to a user allowing the user to send images and videos to other users based on as few as possible user interactions with one or more of the user interface elements. Facebook U.S. patent application Ser. No. 14/561,733 discloses a user interacts with a messaging application on a client device to capture and send images to contacts or connections of the user, with a single user interaction. The messaging application installed on the client device, presents to the user a user interface. The user interface includes a camera view and a face tray including contact icons. On receiving a single user interaction with a contact icon in the face tray, the messaging application captures an image including the current camera view presented to the user, and sends the captured image to the contact represented by the contact icon. In another example, the messaging application may receive a single user interaction with a contact icon for a threshold period of time, and may capture a video for the threshold period of time, and send the captured video to the contact. U.S. patent application Ser. No. 15/079,836 (et. El. Yogesh Rathod) discloses devices are configured to capture and share media based on user touch and other interaction. Functional labels show the user the operation being undertaken for any media captured. For example, functional labels may indicate a group of receivers, type of media, media sending method, media capture or sending delay, media persistence time, discrimination type and threshold for capturing different types of media, etc., all customizable by the user or auto-generated. Media is selectively captured and broadcast to receivers in accordance with the configuration of the functional label. A user may engage the device and activate the functional label through a single haptic engagement, allowing highly-specific media capture and sharing through a single touch or other action, without having to execute several discrete actions for capture, sending, formatting, notifying, deleting, storing, etc. Some of the said prior arts teach about single mode capturing of photo or video and some of the prior arts disclose presenting contact(s) or group(s) specific visual media capture controller control or label and/or icon or image and one tap photo capturing or video recording and optionally previewing and auto sending to said contact specific visual media capture controller control or label and/or icon or image associated contact(s) or group(s). Present invention enables multi-tasking visual media capture controller control or label and/or icon or image including selecting front or back camera mode, capturing photo or start recording video and sop while further tap on icon or recording pre-set duration video or stop before pre-set duration of video or remove pre-set duration of video and capture as per user need, optionally preview or preview for pre-set duration, auto send to said visual media capture controller control or label and/or icon or image associated or pre-configured contact(s) or group(s) or destination(s) and view said visual media capture controller control or label and/or icon or image associated or pre-configured contact(s) or group(s) or destination(s) specific received content items or view pre-configured one or more interfaces and optionally via status (e.g. online or offline, last seen, manual status, received or not-received or read or not read sent or posted content items) or view reactions of visual media capture controller control or label and/or icon or image associated or pre-configured contact(s) or group(s) or destination(s).

At present many web sites and applications provides check-in functionality to enable user to automatically publish or share user's current checked-in place to contacts of user and some of the websites and applications enables user to provide user's status or updated status, which will automatically publish or present to contacts of user. Facebook™ provides Activity/feeling option, which enables user to select from list one or more type of feelings and activities from list which automatically publish to connections of user via news feed. U.S. Pat. No. 8,423,622 (et. El. Neeraj Jhanji) teaches systems for “sharing current location information among users by using relationship information stored in a database, the method comprising: a) receiving data sent from a sender's communication device, the data containing self-declared location information indicating a physical location of the sender at the time the sender sent the data determined without the aid of automatic location determination technology; b) determining from the data the sender's identity and based on the sender's identity and the relationship information stored in the database, determining a plurality of users associated with the sender and who have agreed to receive messages about the sender, each of the plurality of users having a communication device; c) wherein the data sent from the sender's communication device does not contain an indication of contact information of said plurality of users; and d) sending a notification message to the communication devices of, among the users, only the determined users, the notification message containing the sender's self-declared location information. All these methods and systems enables user to manually provide or select one or more types of status, but none of these teaches auto identifying, preparing and generating and presenting user's status based on user's supplied data including image (via scanning, capturing, selecting), user's voice, and/or user related data including user device's current location or place, user profile (age, gender, various dates & times.

At present Snapchat™ enable's to provide geo-location based emoji and customized emoji or photo filter, but none of these teaches generating and presenting cartoon or emoji or avatar based on auto generated user's status i.e. based on plurality of factors including scanning or providing image via camera display screen and/or user's voice and/or user and connected users' data (current location, date & time) and identification of user's related activities, actions, events, entities, and transactions.

At present photo applications enables user to capture and share visual media in plurality of ways. But user has to each time start camera application and each time start recording of video which will takes time. Present invention suggests always on camera (when user's intention to take visual media based on recognition of particular type of pre-defined user's eye gaze) and auto start video (even if user is not ready to take proper scene) and then enable user to trim unnecessary part and mark as start of video and mark as end of one or more videos and enable to capture one or more photos and share all or one or more or preset or default or updated one or more contacts and/or one or more types of destination(s) (make it one or more types of ephemeral or non-ephemeral and/or real-time viewing based on setting(s)) and/or enable to record front camera video (for providing video commentaries) simultaneously with back camera video during parent video recording session. So like eye (always ON and always recoding views) user can instantly, real-time view and simultaneously record one or more videos and captures one or more photos and provide commentary with back camera video and share with one or more contacts and make it one or more types of ephemeral or non-ephemeral and/or real-time viewing.

Mobile devices, such as smartphones, are used to generate messages. The messages may be text messages, photographs (with or without augmenting text) and videos. Users can share such messages with individuals in their social network. However, there is no mechanism for sharing messages with strangers that are participating in a common event. U.S. Pat. No. 9,113,301 (et. el. Spiegel Evan—title Geo-location based event gallery) teaches a computer implemented method includes receiving a message and geo-location data for a device sending the message. It is determined whether the geo-location data corresponds to a geo-location fence associated with an event. The message is posted to an event gallery associated with the event when the geo-location data corresponds to the geo-location fence associated with the event. The event gallery is supplied in response to a request from a user. A computer implemented method, comprising: receiving a message and geo-location data for a device sending the message, wherein the message includes a photograph or a video; determining whether the geo-location data corresponds to a geo-location fence associated with an event; supplying a destination list to the device in response to the geo-location data corresponding to the geo-location fence associated with the event, wherein the destination list includes a user selectable event gallery indicium associated with the event and a user selectable entry for an individual in a social network; adding a user of the device as a follower of the event in response to the event gallery indicium being selected by the user; and supplying an event gallery in response to a request from the user, wherein the event gallery includes a sequence of photographs or videos and wherein the event gallery is available for a specified transitory period. Present invention discloses user created gallery or event including provide name, category, icon or image, schedule(s), location or place information of event or predefine characteristics or type of location (via SQL or natural query or wizard interface), define participant members criteria or characteristics including invited or added members from contact list(s) or request accepted or based on SQL or natural query or wizard and define viewers criteria or characteristics and define presentation or feed type. Based on auto starting or manually started by creator or authorized user(s) and said provided settings and information, in the event of matching of said defined target criteria specific including schedule(s) and/or location(s) and/or authorization matching with user device current location or type or category of location and/or user device current date & time and/or user identity or type of user based on user data or user profile, system presents one or more visual media capture controller control or icon and/or label on user device display or camera screen display or device camera for enabling user to alerting, notifying, capturing, recording, storing, previewing, and autos sending to visual media capture controller control or icon and/or label associated created one or more galleries or events or folders or visual stories and/or one or more types of destination(s) and/or contact(s) and/or group(s).

At present online application stores, web sites, search engine and platform enables user to search, match view details, select, if paid then make payment, download, install one or more application at user device and access them by tapping on individual application icon. U.S. Pat. No. 8,099,332 discloses methods that include the actions of receiving a touch input to access an application management interface on a mobile device; presenting an application management interface; receiving one or more inputs within the application management interface including an input to install a particular application; installing the selected application; and presenting the installed application. At present there is plurality of augmented reality applications available at application stores (e.g. Google Play Store™ or Apple App Store™) e.g. Pokemon Go™, Google Translate™, and Wikitude World Browser™ etc. User has to install each application from app store and access independently. At present there is no augmented reality applications, functions, features, controls (e.g. button), and interfaces search engine, platform and client application available. Present invention enables registered developers of network to register, verify, make listing payment (if paid), upload or listing with details and making them searchable one or more augmented reality applications, functions, features, controls (e.g. button), and interfaces and enabling user to download and install augmented reality client application and enabling searching users including advertisers of network to search, match, select, select from one or more types of categories, make payment (if paid), download, update, upgrade, install or access from server or select link(s) of one or more augmented reality applications, functions, features, controls (e.g. button), and interfaces and enable to customize or configure and associate with defined or created named publication or advertisement said one or more augmented reality applications, functions, features, controls (e.g. button), and interfaces and provide publication criteria including provide object criteria including object model(s), so when user scan said object then auto present said one or more augmented reality applications, functions, features, controls (e.g. button), and interfaces related to said user or advertiser or publisher and/or target audience criteria, so user data match with said target criteria then present one or more augmented reality applications, functions, features, controls (e.g. button), and interfaces and/or target location(s) or place(s) or defined location(s) based on structured query language (SQL), natural query and step by step wizard to define location(s) type(s), categories & filters (e.g. all shops related to particular brand, all flower seller—system identifies based on pre-stored categories, types, tags, keywords, taxonomy, associated information associated with location or place or point of interest or spot or location point or location or each identified or updated places or point of interests or spots or location points on map of world or databases or storage mediums of locations or places, so when user device monitored current location is matched with or near to said target location or place then auto present said one or more augmented reality applications, functions, features, controls (e.g. button), and interfaces and any combination thereof. In another embodiment user or developer or advertiser or server 110 may be publisher of one or more augmented reality applications, functions, features, controls (e.g. button), and interfaces.

Currently yahoo Answers™ enables user to post question and gets answers from users of network in exchange of points. Present invention enables user to post structured or freeform requirement specification and get response from matched actual customers, contacts of user, experts, users of network and sellers. System maintains logs of who saved use's time, money, and energy and provides best price, best matched and best quality of matched products and services to user. Present invention provides user to user saving money (best price, quality and matched products and services) platform.

Currently social networks web sites or applications enables user to post contents and receive user reactions from recipient or viewing users of network including like, dislike, rating, emoticons and comments. Present invention enables auto recording of user reaction on viewed or viewing content item or visual media item or message in visual media format including photo or video and auto posting said auto recorded photo or video reaction on all viewers or recipients for viewing of reactions at prominent place e.g. below said post or content item or visual media item. In another embodiment enabling user to make said visual media reaction ephemeral at viewing user's or recipient user's device or interface or application.

At present plurality of web sites, social network, search engines and applications including chatting, instant messaging & communication applications accumulate user data including user associated keywords based on user's search queries, search result item(s) selection or access, sharing of content, viewing of posts, subscribing or following of users or sources and viewing messages posted by followed users, exchanging of messages, logging of user activities, status, locations, checked-in places, and like. All these web sites and applications accumulated user related keywords indirectly or automatically (without user intervention or user mediated action or editing or acceptance or permission or verifying that particular keyword(s) is/are useful and actually related to user), without directly asking user to provided user associated keywords. Present invention enables user to provide, search, match, select, add, identify, recognize, notify user to add, update & remove keywords, key phrases, categories, tags and associated relationships including type of one or more entities, activities, actions, events, transactions, connections, status, interaction, locations, communication, sharing, participation, expression senses & behavior and associate information, structured information (e.g. selected one or more fields and provided one or more data types or types specific one or more values) metadata & system data, Boolean operators, natural queries, Structures Query Language (SQL). So said each user related, associated, provided, accumulated, identified, recognized, ranked, updated keywords, key phrases, tags, hashtags and one or more types of one or more identified or updated or created or defined relationships and ontologies among or between said one or more keywords, key phrases, tags, hashtags, associated one or more categories, sub-categories, taxonomy, system can utilize said user contextual relational keywords for plurality of purposes including search, match user specific contextual visual media items, content items to user, present contextual advertisements, enable 3^{rd} parties enterprise subscribers to access or data mine said users' contextual and relational keywords for one or more types of purposes based on user permission, privacy settings & preferences.

Currently tourists or users when visits at particle tourist place or point of interest and wants to take his/her or group selfie photo or group photo or record video, then they manually find out, ask or call or request to somebody to take their photo or record video and handover their camera to said request accepted user who willing to take said user's or group's selfie photo or record video and after each taking of visual media view preview of said captured visual media by reaching to said visual media taking user and request to re-take or take more photos or videos. Sometimes finding out point of interest, finding out visual media taking anonymous user, handover tourist's smartphone or camera device to said visual media taking user, previewing each visual media is cumbersome, tedious manual process. Present invention enables users to relieve from said manual process and enables to send request to auto select or select from map nearest available or ranked visual media taking service provider and in the event of acceptance of request enable both to find out each other, enable visual media taking service provider or photographer to capture, preview, cancel, retake, and auto send visual media of requestor user or his/her group from visual media taking service provider's or photographer's smartphone camera or camera device to said visual media taking service consumer's or tourists or requestor user's device and enabling him/her to preview, cancel, and accept said visual media including one or more photos or videos, send request to retake or take more or enable both to finish or done current photo taking or shooting service session and provide ratings and reviews of each other.

Currently plurality of calendar applications and web sites enables user to create calendar, schedules, events, appointments, tasks, to-dos, auto import dates & times and associate events from emails and shows at calendar entries and enables collaborative calendar and event creation and management. But none of these applications and websites auto identifies user's free or available time to conduct one or more activities and enables user to manually provide that user is free to conduct one or more activities which are best as per user's profile (age, gender, income range, place, location, education, preferences, interests or hobbies) and suggested by user's friends, family, contacts and nearby. Present invention enables to identify user's free or available time or date & time range(s) (i.e. wants suggestions for types of contextual activities) and suggests (by server based on match making, by user's contacts, by 3^{rd} parties) contextual activities including shopping, viewing movie or drama, tours & packages, paly games, eat foods, visit places based on one or more types of user and connected users' data including duration and date & time of free or available time for conducting one or more activities, type of activity do (e.g. alone, collaborative—with selected one or more contacts etc.), real-time provide preferences for types of activities, detail user profile (age, gender, income range, education, work type, skills, hobbies, interest types), past liked or conducted activities & transactions, participated events, current location or place, home or work address, nearby places, date & time,

current trend (new movie, popular drama etc.), holiday, vacation, preferences, privacy settings, requirements, suggested by contacts or invited by contacts for collaborative activities or plan, status, nearest location, budget, type of accompanied contacts, length of free or available time, type of location or place, matched events locations and date & time, types and names or brands of products and services used, using & want to use. Currently there are lot calendar applications available to enable user to note various events, meetings, and appointments at particular date & time or time ranges or time slots in the form of calendar entries. Microsoft U.S. Pat. No. 8,799,073, suggest to presenting contextual advertisements based on existing calendar entries and user profile. None of the calendar applications, patent, patent applications or literature suggest to identify user's available time to conduct various types of activities or various activities and suggest prospective best contextual activities from one or more sources that user can do at particular date & time or time range, wherein in source contains other users of network, users who already conduct or experienced particular activities, suggest by server, provide by 3^{rd} arties advertisers, sellers & service providers. Present invention enables user to utilize user available time for conducting various activities in best possible manner by suggesting or updating various activities from plurality of sources.

Currently Twitter™ enables user to post tweet or message and make available said posted tweets or message to followers of user at each follower's feed and enables user to follow via search, select one or more users from directory and follow or follow from user's profile page. Each user can directly post and have one feed where all tweets or message from all followed users are presented to user. But due to this each post of user presented at each follower's feed and each follower receive each posted message from each followed users. So there is grate possibilities that user receives irrelevant tweets or message from followed users. Present invention enables user to create one or more type of feeds including e.g. personal, relatives specific, best friends specific, friends specific, interest specific, professional type specific, news specific, and enable to provide configuration settings, privacy settings, presentation settings and preferences for one or more or each feeds including allow to contacts to follow or subscribe said particular type of feed(s), allow all or allow invited or allow request accepted of requestors or allow to follow or subscribe one or more types of created feeds to pre-defined characteristics of followers only based on use data and user profile. For example personal feeds type is allow following or subscribing only to user's contacts. For example for News type of feed, allowing following or subscribing to all users of network. For example for professional type of feed, allowing to subscribe or follow to connected users only or to pre-defined types of characteristics users of network only. In another embodiment make particular feed real-time only i.e. receiving user can accept push notification to view said message within pre-set duration else receiving or following user or follower is unable to view said message. In another embodiment enable posting user to make posted content item as ephemeral and provide ephemeral settings including pre-set view or display duration, pre-set number of times of allow to view, pre-set number of times of allow to view within pre-set life duration and after presenting in the event of expiry of view timer or surpass number of times of views or expiry of life duration remove said message from recipient user's device. In another embodiment enable posting user to start broadcasting session and enable followers to start real-time view content as and when contents are posted, in the event of first posted content item if follower not viewed said content item then in the event of posting of second content item follower can view only second posted & received content item and in the event of follower viewed said content item then in the event of posting of and receiving of second content item then system removes first content item from recipient device and present second posted content item. In another embodiment following user can provide scale to indicate how much content user likes to receive from all or particular followed user or particular feed of particular followed user(s) and/or also provide one or more keywords, categories, hashtags inside posted messages which user likes to receive said keywords, categories, hashtags specific messages from followed user(s). In another embodiment enable searching user to provide search query and search users and related one or more types of feeds and select from search result users and/or related one or more types of feeds and follow all or selected one or more types of feeds of one or more selected users or provide search query to search posted contents or messages of users of network and select source(s) or user(s) or related one or more types of feeds associated with posted message or content items and follow source(s) or related one or more types of feeds or follow user's all or selected one or more types of feeds of user from search result item or from user's profile page or from categories directory item or from suggested list or from user created list or from 3rd parties' web sites or applications. In another embodiment follower receives posted messages or one or more types of one or more content items or visual media items from followed user(s)'s followed type of feed(s) related posted messages at/under/within//in said categories or type of feed(s) presented messages. For example when user [A] followed user [Y]'s “Sports” type feed then when user [Y] post message under “Sports” type feed or first select “Sports” type feed and then tap on post to post said message at server 110 then server 110 presents said posted message related to “Sports” type feed of user [Y] at following user [A]'s “Sports” category tab so receiving user can view all followed “Sports” type feed related messages from all followed users in said “Sports” category tab. Present invention also enables group of users to posts under one or more created and selected types of feeds for making them available for common followers of group.

Currently Google Search Engine™ enables user to search based on one or more keywords and presents search query specific search results. Google Map™ enables user to search, navigate and select particular location(s) or place(s) or point of interest(s) or particular type or category specific location(s) or place(s) or spot(s) on map and enable to view information, user posted photos, reviews, nearby locations, find route and direction. At present some applications enables users to provides user status (online, busy, offline, away etc.), and manual status (“I am watching movie”, “I am at gym” etc.) and structured status (e.g. selecting one or more types of user activities or actions watching, reading etc.). At present some applications identifies user device current location and enable user to share with other users or connected users of user or enabling user to manually checked-in place and make them available to or share with one or more friends, contacts or connected users of user. At present messaging applications enables user to exchange messages. All these websites and applications are either indirectly identifies keywords in user's exchanging of messages, search queries keywords or directly identifies based on user status and location or place sharing, which are very limited. Present invention enables user to input (auto-fill from suggested keywords) or selects keywords, key phrases, categories, and associated relationships or ontology(ies) from auto presented suggested list of keywords, key phrases, categories, and associated relationships or ontology(ies) based on user's voice or talks, user scanning, providing object criteria, object model(s) (select or take visual media including photo(s) or video(s)), user device(s) monitored current location, user provided status, user domain specific profile, provided structured information via structured forms, templates and wizard related to user's activities, actions, events, transactions, interests, hobbies, likes, dislikes, preferences, privacy, requirement specifications, search queries, and selecting, applying and executing one or more rules to identify contextual keywords, key phrases, categories, and associated relationships or ontology(ies). Present invention enables user to search and present location on map or navigate map to select location or search address for finding particular location or place on map and further enable user to provide said location or place associate one or more searching keywords and/or object criteria or object model(s) and/or preferences and/or filter criteria to search, match, select, identify recognize and presents visual media items in sequence and display next based on haptic contact engagement on display or tapping on presentation interface or presented visual media item or auto advance next visual media item based on pre-set interval period of time. So user can view location or place and/or associated supplied object criteria and/or filter criteria specific visual media items. For example user can select particular place where conference is organized and provide keywords “Mobile application presentation” and based on said provided location and associate conference name and keywords, search engine searches and matches user generated and posted or conference administrator generated or posted visual media items or content items related to said particular keywords and present to user sequentially. So user can view visual media items based on plurality of angles, attributes, properties, ontology, characteristics including reviews, presentation, video, menu, price, description, catalogues, photos, blogs, comments, feedbacks, complaints, suggestions, how to use or access or made, manufacturing or how to made, questions and answers, customer interviews or opinions, video survey, particular product or object model specific or type of product related visual media, view design, wearable particular designed or particular type of cloths by customers, user experience videos, learning and educational or entertainment visual media, view interior, view management or marketing style, tips, tricks & live marketing of various products or services. In another embodiment user can search based on defined type(s) or characteristics of location(s) or place(s) via structured query language (SQL) or natural query or wizard interface e.g. “Gardens of world” and then provide one or more object criteria (e.g. sample image or object model of Passiflora flower) and/or keywords “how to plant” then system identifies all gardens of Passiflora flower and presents visual media related to plantings posted by visitors or users of network or posted by 3^{rd} parties, who associated or provided one or more flower related ontology(ies), keywords, tags, hashtags, categories, and information.

At present video calling applications enable user to select one or more contacts or group(s) and initiate or start video calling and in the event of acceptance of call by called user, starts video communication or talking with each other and in the event of end of call, terminates or closes the video communication between calling and called user(s). User has to open video call application each time of video calling, each time of video calling user has to search & select or select contact(s) and/or group(s) to call them. Each video calling user has to wait for call acceptance by callee or called user(s) and each time user (caller or callee) has to end video call to end current video call and if user wants to again video talk then again same process happen. In natural talk user can quickly starts and stops and again starts and stops talking with other user in front of or surround to user. Likewise present invention enables user to provide voice command to start video talk with voice command related contact and auto ON user's and called user's device, auto open application and front camera video interface of camera display screen in both caller and called user's device and enable them starts video talking and/or chatting and/or voice talk and/or sharing one or more types of media including photo, video, video streaming, files, text, blog, links, emoticons, edited or augmented or photo filter(s) applied photo or video with each other. In the event of no talk for pre-specified period of time then close or hide video interface and OFF user's device and further start in the event of receiving of voice command instructing start of video talk with particular contact(s). User doesn't have to each video calling open device, open application, select contacts, make calling, wait for call acceptance by called user, end call and in the event of further talk user doesn't have to again follow same process each time.

Therefore, it is with respect to these considerations and others that the present invention has been made.

### OBJECT OF THE INVENTION

The object of present invention is to identify user intention to take photo or video and automatically invokes, open and show camera display screen so user is enable to capture photo or video without each time manually open camera application.

The object of present invention is to identify user's intention to view media and show interface to view media.

The object of present invention is to auto capture photo or auto record video.

The object of present invention is to single mode visual media capture that alternately produces photographs and videos.

The object of present invention is to enabling sender or source to select, input, update, apply and configure one or more types of ephemeral or non-ephemeral content access privacy and presentation settings for one or more types of one or more destination(s) or recipient(s) or contact(s).

The object of present invention is to enabling content receiving user or destination(s) of contents to select, input, update, apply and configure one or more types of privacy settings, presentation settings and ephemeral or non-ephemeral settings for receiving of contents and making of contents as ephemeral or non-ephemeral received from one or more types of one or more source(s) or sender(s) or contact(s).

The another important object of the present invention is to enable user to provide, select, input, apply one or more criteria including one or more keywords, preferences, settings, metadata, structured fields including age, gender, education, school, college, company, place, location, activity or actions or transaction or event name or type, category, one or more rules, rules from rule base, conditions including level of matching, similar, exact match, include, exclude, Boolean operators including AND, OR, NOT, Phrases, object criteria i.e. provide image or object model or sample image or photo or pattern or structure or model of match making for matching object inside the photo or video with captured or stored photos or videos or matching text criteria e.g. keywords with text content or matching voice with voice content for identifying, matching, processing, merging, separating, searching, matching, subscribing, generating, storing or saving, viewing, bookmarking, sequencing, serving, presenting one or more types of feeds or stories or set of sequences identified media including one or more types of media, photos, images, videos, voice, sound, text and like.

The object of present invention is to enabling user to select, input, update, apply and configure privacy settings for allowing or not-allowing other users to capture or record visual media related to user.

The object of present invention is to enabling advertiser to create visual media advertisements with target criteria including object criteria or supplied object model or sample image and/or target audience criteria for presenting with or integrating in or embedded within visual media stories related to said recognized target object model inside said user presented matched visual media items for presenting to requesting or searching or viewing or subscriber users of network.

Other important object of present invention is to enabling sender of media to access media shared by sender at recipient device including add, remove, edit & update shared media at recipient's device or application or gallery or folder.

Other important object of present invention is to enable accelerated display of ephemeral messages based on sender provided view or display timer as well as one or more types of pre-defined user sense via user device one or more types of sensor(s).

Other important object of present invention is to real-time display of ephemeral messages.

Other important object of present invention is to real-time starting session of displaying or broadcasting of ephemeral messages.

Other important object of present invention is to provide various types of ephemeral stories, feeds, galleries or albums including view and completely scroll content item to remove or hide from presentation interface or remove after pre-set wait duration, load more or push to refresh or auto refresh (after pre-set interval duration) to remove currently present content and present next set of contents (if any) from presentation or user interface or enable sender to apply or pre-set view duration for set of content items and present said posted set of or one or more content items to viewers or target o intended recipients and present for pre-set duration of timer and in the event of expiry of timer remove set of presented content items or visual media items and display next set of content items or visual media items or enable sender to apply view timer for each posted content item and present more than one content items and each content item having different pre-set view duration and in the event of expiry of view duration remove each expired content item and present new content item, enable receiver to pre-set number of times of views and remove after said pre-set number of times of views or enabling viewing user to mark content item as ephemeral or non-epithermal or enabling viewing user to hold and view photo or video and in the event of releases or expiry of pre-set view timer remove viewed content and also remove thumbnail or index item.

Other important object of present invention is to enable mass user actions at particular date & time for pre-set period of time and during that period enabling user to take presented one or more types of content (group deal, application details, advertisement, news, movie trailer etc.) specific one or more types of action(s) including buy or participate in group deals, buy or order product, subscribe service, view news or movie trailer, listen music, register web site, confirm to participate in event, like, provide comments, reviews, feedback, complaints, suggestions, answers, idea & rating, fill survey form, view visual media or content items, book tickets.

Other important object of present invention is to provides multi-tasking visual media capture controller control or label and/or icon or image including selecting front or back camera mode, capturing photo or start recording video and sop while further tap on icon or recording pre-set duration video or stop before pre-set duration of video or remove pre-set duration of video and capture as per user need, optionally preview or preview for pre-set duration, auto send to said visual media capture controller control or label and/or icon or image associated or pre-configured contact(s) or group(s) or destination(s) and view said visual media capture controller control or label and/or icon or image associated or pre-configured contact(s) or group(s) or destination(s) specific received content items or view pre-configured one or more interfaces and optionally via status (e.g. online or offline, last seen, manual status, received or not-received or read or not read sent or posted content items) or view reactions of visual media capture controller control or label and/or icon or image associated or pre-configured contact(s) or group(s) or destination(s).

Other important object of present invention is to enable multi-tabs accelerated display of ephemeral messages and based on switching of tab, pausing of timer associated with each message presented on current tab and presents set of content items related to switched tab and start timers associated with each presented message related to switched tab and in the event of expiry of timer or haptic contact engagement remove ephemeral message and present next one or more (if any) ephemeral messages.

Other important object of present invention is to auto identify, prepare, generate and present user status (description about user's current activities, actions, events, transactions, expressions, feeling, senses, places, accompanied persons or user contacts, purpose, requirements, date & time etc.) based on real-time user supplied updated data and pre-stored user or connected user's data.

Other important object of present invention is to auto generate or identify and present one or more cartoons, emoji, avatars, emoticons, photo filters or image based on auto identified, prepared and generated user status (description about user's current activities, actions, events, transactions, expressions, feeling, senses, places, accompanied persons or user contacts, purpose, requirements, date & time etc.) based on real-time user supplied updated data and pre-stored user or connected user's data.

Other important object of present invention is to provide always on and always started parent video session (while user's intention to take visual media—hold device to take visual media) and during that parent video session enable user to conduct multi-tasking (for utilizing user's time) including enable to mark as start via trimming and end of one or more video via tapping on anywhere on display or on particular icon and captured photo(s) and sharing to one or more contacts (all during recording of parent video recording session) i.e. instant, real-time, ephemeral, same time sharing which utilizes user' time and provide instant gratification.

Other important object of present invention is to enable user to creation of gallery or story or location or place or defined geo-fence boundaries specific scheduled event and define and invite participants. Based on event location, date & time and participant data, presents auto generated visual media capture & view controller(s) on display screen of device of each authorized participant member and enable them to one tap front or back camera capturing of one or more photos or recording of one or more videos and present preview interface for previewing said visual media for set pre-set duration and within that duration user is enable to remove said previewed photo or video and/or change or select destination(s) or auto send to pre-set destination(s) after expiry of said pre-set period of time. Admin of gallery or story or album or event creator is enabled to update event, start manually or auto start at scheduled period, invite, update or change, remove and define participants of event and accept request of user to participate in the event, define target viewers, select one or more types of one or more destinations, provide or define on or more types of presentation settings.

Other important object of present invention is to provide or enabled augmented reality platform, network, application, web site, server, device, storage medium, store, search engine, developer client application for registering developer, make payment for membership as per payment mode or models (if paid), registering, verifying, make payment for listing as per payment mode or models (if paid), listing, uploading with details (description, categories, keywords, help, configuration, customization, setup, & integration manual, payment details, mode & models (fix, monthly subscription, pay per presentation, use or access, action, transaction etc.)) or making available for searching users of network one or more augmented reality applications, functions, controls (e.g. button), interfaces, one or more types of media, data, application programming language (API), software development toolkit (SDK), web services, objects and any combination thereof (packaged), advertiser or merchant or publisher's client application for searching, matching, viewing details, selecting, adding link to list for selection while creating publication or advertisement, downloading, installing, making payment as per selected payment modes and models (if paid), updating, upgrading or accessing from server 110 or from 3^{rd} parties server, creating publication or advertisement including provide publisher or advertiser or user details, provide object criteria, schedules of publication or presentation, target audience criteria, target location criteria and searching, matching, selecting, configuring, customizing, adding, updating, removing or associating and publishing one or more augmented reality applications, functions, controls (e.g. button), interfaces, one or more types of media, data, application programming language (API), software development toolkit (SDK), web services, objects and any combination thereof (packaged) as per said target criteria including object criteria, target audience criteria, target locations or places (selected, current location as location, defined location (via SQL or natural query or wizard interface), schedules and user client application for auto presenting or allow to search, match, select said configured and published one or more augmented reality applications, functions, controls (e.g. button), interfaces, one or more types of media, data, application programming language (API), software development toolkit (SDK), web services, objects and any combination thereof (packaged) from/of or provided or listed by one or more of developers at client device for user access, wherein said auto presenting based on object criteria includes enabling user to scan object(s) which is/are recognized by server based on object recognition, optical character recognition, face recognition technologies (identification and matching of said scanned object or identified object or text or face with provided object criteria associated with advertisements or publication of plurality of advertisers or publishers) visual media items at server 110 and auto present matched or contextual one or more augmented reality applications, functions, controls (e.g. button), interfaces, one or more types of media, data, application programming language (API), software development toolkit (SDK), web services, objects and any combination thereof (packaged). After presenting, for example user scan particular product and tap on presented “Visual Story” button or control configured and published by particular brand related advertiser or publisher, then system presents visual media items related to said product of said advertiser (e.g. shop, manufacturer, seller, merchant, brand at particular location etc.). User client application enables object scanning, object or face or text recognition, identification and matching via object recognition, machine vision, optical character recognition, face recognition technologies including 3^{rd} parties SDK (e.g. Augmented Reality SDK—Wikitude™, Open Source Augmented Reality SDK etc.) with object criteria and/or visual media items at server 110, object tracking, 3D object tracking, 3d model rendering, location based augmented reality, content augmentation, objects or media or information overlays or presentation on scanned view.

Other important object of present invention is to enabling user to provide auto capture or record visual media including photo or video reactions on one or more viewed or currently viewing visual media item or content item or news item or feed item or received or presented from connected or other users or sources of network and auto post said user reaction photo or video to and present to below or at prominent place of said presented visual media item or content item in feed of receiving or viewing all or one or more selected users (like content item associate likes or dislikes or comments).

Other important object of present invention is to enabling user to post requirement specification and receive response from matched or contextual users who helps user in find out best matched in terms of budget, price, quality, availability and saves user's time, money and energy by enabling user to user money saving platform.

Other important object of present invention is to enabling user to navigation of map including from world map select country, state, city, area, place and point or search particular place or spot or POI or point or access map to search, match, identify and find out location, place, spot, point, Points of Interest (POI) and associated or nearest or located or situated or advertised or listed or marked or suggested one or more types of entities including mall, shop, person, product, item, building, road, tourist place, river, forest, garden, mountain, hotel, restaurant, exhibition, events, fair, conference, structure, station, market, vendor, temple, apartment or society or house, and one or more types of one or more addresses and after identifying particular entity or item on map, user is enabled to provide, search, input, update, add, remove, re-arrange, select, provide via auto fill-up or auto suggested one or more keywords, key phrases and Boolean operators and optionally selecting and applying of one or more conditions, rules, preferences, settings for identifying or matching or searching and presenting visual media or content items which were generated from that particular location or place or POI or spot or point or matched pre-defined geo-fence(s) and related to said user supplied one or more keywords or key phrases and Boolean operates including AND, OR, NOT and brackets. So user is enabled to view contextual stories

Other important object of present invention is to enabling user to user providing and consuming on demand services including visual media taking services or photography service.

Other important object of present invention is to suggest contextual activities based on user provided or auto identified date & time range(s) and duration within which user wants to do activities and needs suggestions from serve, experts, 3^{rd} parties, user contacts and based on one or more types of user data. In an another embodiment system continuously presents and updates suggested, alternative one or more types of one or more contextual activities (activity item with details including description, name, brand, links, one or more types of user actions comprises book, view, refer, buy, direction, share, like, order, read, listen, install, paly, register, presentation, and media) as per one or more types of user timeline (free, available, want to do collaborative activity, have particular duration free time, want to do activity with family or selected friends, scheduled events, required suggestions from actual users or contacts and based on one or more types of user data. The of the present invention is to facilitating user time line including identifying & storing user's available timings or duration or date(s) & time range(s) or schedules, user's calendar entries, user data, suggesting or presenting contents or various activities or prospective activity items that user can do from one or more sources including contextual users of network, advertisers, marketers, sellers, and service providers based on user data including user profile, user preferences, interests, privacy settings, past activities, actions, events, transactions, status, updates, locations, & check-in places, rank of prospective activity, ran of provider of activity item and also facilitating user in planning, sharing, executing & conducting one or more activities including book ticket, book rooms, purchase product, subscribe service, participate in group deals, ask queries to other users of network who already experienced or conducted particular activity. The other object of the present invention is to continuously updating time-line specific presentation of activities items based on updated user data.

Other important object of present invention is to enabling user to create one or more types of feeds and post message to said selected one or more types of feeds and making them available to followers of said posting user's posted message associated selected one or more types of feeds. Enabling user to search and select users via search engine, directory, from user's profile page and from 3^{rd} parties' web sites, web pages, applications, interfaces, devices and follow user(s) i.e. follow each selected user's all or selected one or more types of feeds.

Other important object of present invention is to enabling user to select, input, add, remove, update and save user related keywords. Present invention enables user to input (auto-fill from suggested keywords) or selects keywords, key phrases, categories, and associated relationships or ontology(ies) from auto presented suggested list of keywords, key phrases, categories, and associated relationships or ontology(ies) based on user's voice or talks, user scanning, providing object criteria, object model(s) (select or take visual media including photo(s) or video(s)), user device(s) monitored current location, user provided status, user domain specific profile, provided structured information via structured forms, templates and wizard related to user's activities, actions, events, transactions, interests, hobbies, likes, dislikes, preferences, privacy, requirement specifications, search queries, and selecting, applying and executing one or more rules to identify contextual keywords, key phrases, categories, and associated relationships or ontology(ies).

Other important object of present invention is to enabling user to start and stop and re-start and stop video talk based on voice command, face expression detection, voice detection without each time open (make ON) device, open video calling or video communication application, selecting of contact(s), make calling, wait for call acceptance by called user(s), end call (by caller or called user).

### SUMMARY OF THE INVENTION

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

The present invention now will be described more fully hereinafter with reference to the accompanying drawings, which form a part hereof, and which show, by way of illustration, specific exemplary embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” or “in an embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “receiving” posted or shared contents & communication and any types of multimedia contents from a device or component includes receiving the shared or posted contents & communication and any types of multimedia contents indirectly, such as when forwarded by one or more other devices or components. Similarly, “sending” shared contents & communication and any types of multimedia contents to a device or component includes sending the shared contents & communication and any types of multimedia contents indirectly, such as when forwarded by one or more other devices or components.

As used herein, the term “client application” refers to an application that runs on a client computing device. A client application may be written in one or more of a variety of languages, such as ‘C’, ‘C++’, ‘C#’, ‘J2ME’, Java, ASP.Net, VB.Net and the like. Browsers, email clients, text messaging clients, calendars, and games are examples of client applications. A mobile client application refers to a client application that runs on a mobile device.

As used herein, the term “network application” refers to a computer-based application that communicates, directly or indirectly, with at least one other component across a network. Web sites, email servers, messaging servers, and game servers are examples of network applications.

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later. Various embodiments describe in detail in drawings and claims.

In an embodiment present invention identifies user intention to take photo or video based on one or more types of eye tracking system to detect that user want to start camera screen display to capture photo or record video or invoke & access camera display screen and based on that automatically open camera display screen or application or interface without user need to manually open it each time when user want's to capture photo or record video/voice or access device camera. Eye tracking system identifies eye positions and movement by eye tracking to measure the point of gaze to identify eye position e.g. straight to eye(s) for taking photo or video and automatically invoke, open and show camera display screen so user is enable to capture photo or video without each time manually open camera application. In another embodiment present invention identifies user intention to take photo or video based on one or more types of sensors by identifying device position i.e. far from body. Based on one or more types of eye tracking system and/or sensors, present invention also detect or identifies user intention to view received or shared contents or one or more types of media including photos or videos or posts from one or more contacts or sources e.g. Eye tracking system identifies eye positions and movement by eye tracking to measure the point of gaze to identify eye position and proximity sensor identifies distance of user device (e.g. device in hand in viewing position), so based on that system identifies user intention to read or view media.

In an embodiment present invention single mode capturing of photo or video based on the stabilization threshold and the receiving of haptic contact engagement or tap on the single mode input icon which determines whether a photograph will be recorded or a video. Based on monitored device stabilization parameter via device senor, stabilization threshold is identified. In the event of stabilization parameter is greater than or equal to a stabilization threshold and in response to haptic contact engagement, photo is captured and photo is store. If stabilization parameter is not greater than or not equal to a stabilization threshold or in the event of stabilization parameter is less than to a stabilization threshold and in response to haptic contact engagement, start recording of video and start timer and in an embodiment stop video, store video and stop or re-initiate timer in the event of expiration of pre-set timer.

In an embodiment present invention enables sender user and receiving user to select, input, apply, and set one or more types of ephemeral and non-ephemeral settings for one or more contacts or senders or recipients or sources or destinations for sending or receiving of contents.

In an embodiment present invention enables user to provide object criteria i.e. model of object or sample image or sample photo and provide one or more criteria or conditions or rules or preferences or settings and based on that provide object model or sample image and provided one or more criteria or conditions or rules or preferences or settings identify or recognize or track or match one or more matched object or full or part of image or photo or video inside captured or presented or live photo or video and merge all identified photos or videos and present to user. For example by using present invention user can provide object model or sample image of “coffee” and/or provide “coffee” keyword and/or provide location as “Mumbai” for searching all coffee related photos and videos by identifying or recognizing “coffee” object inside photo or video and matching said provided “coffee” object or sample image with said identified “coffee” object or image inside said captured or selected or live photo or video and processing or merging or separating or sequencing said all identified photos and videos and presenting to user or searching user or requesting user or recipient user or targeting user.

In an embodiment present invention enables user to allow or not allow all or selected one or more users and/or allow or not allow all or selected one or more users at particular one or more pre-defined location(s) or place(s) or pre-defined geo-fence boundaries and/or allow or not allow all or selected one or more users at particular one or more pre-defined location(s) or place(s) or pre-defined geo-fence boundaries at particular pre-set schedule(s) to capture user's photo or record video or allow or not allow to capture photo or record video at particular selected location(s) or place(s) or within pre-defined geo-fence boundaries and/or at particular pre-set schedule(s) and/or for all or one or more selected users (phone contacts, social contacts, clients, customers, guests, subscribers, attendees, ticket holders etc.) or one or more types of pre-defined users or pre-defend particular type of characteristics of users.

In an embodiment present invention enables user to provide or upload or set or apply image or image of part of or particular object, item, face of people, brand, logo, thing, product or object model and/or provide textual description, keywords, tags, metadata, structured fields and associate values, templates, samples & requirement specification and/or provide one or more conditions including similar, exact match, partially match, include & exclude, Boolean operators including AND/OR/NOT/+/−/Phrases, rules. Based on provided object model, object type, metadata, object criteria & conditions server identifies, matches, recognize photos or videos stored by server or accessed but server provided from one or more sources, databases, networks, applications, devices, storage mediums and present to users wherein presented media includes series of or collections of or groups of or slide shows of photos or merged or sequences of or collection of videos or live streams. For example plurality of merchant can upload videos of available products and/or associate details which server stores at server database. Searching user is enabled to provide or input or select or upload one or more image(s) or object model of particular object or product e.g. “mobile device” and provide particular location or place name as search query. Based on said search query server matches or identifies said object e.g. “mobile device” with recognized or detected or identified object inside videos and/or photos and/or live stream and/or one or more types of media stored or accessed from one or more sources and present or present merged or series of said identified or searched or matched videos and/or photos and/or live stream and/or one or more type of media to searching user or contextual user or requested user or user(s) of network.

In an embodiment present invention teaches various embodiments related to ephemeral contents including rule base ephemeral message system, enabling sender to post content or media including photo and enable to add or update or edit or delete one or more content item including photo or video from one or more recipient devices, whom sender sends or adds based on connection with recipient and/or privacy settings of recipient.

In an embodiment present invention discloses an electronic device comprises a display and an ephemeral message controller to present on the display an ephemeral message for a transitory period of time. A sensor controller identifies user sense on the display or application or device during the transitory period of time. The ephemeral message controller terminates the ephemeral message in response to the receiving of one or more type of identified user sense via one or more type of sensors. Present invention also teaches multi-tabs presentation of ephemeral messages and based on switching of tab, pausing of view timer associated with each message presented on current tab and presents set of content items related to switched tab and start timers associated with each presented message related to switched tab and in the event of expiry of timer or haptic contact engagement remove ephemeral message and present next one or more (if any) ephemeral messages.

In an embodiment present invention enables real-time or maximum possible near real-time sharing and/or viewing and/or reacting of/on posted or broadcasted or sent one or more types of one or more content items or visual media items or news items or posts or ephemeral message(s).

In an embodiment present invention discloses or teaches about various types of ephemeral stories, feeds, galleries or albums including view and completely scroll content item to remove or hide from presentation interface or remove after pre-set wait duration, load more or push to refresh or auto refresh (after pre-set interval duration) to remove currently present content and present next set of contents (if any) from presentation or user interface or enable sender to apply or pre-set view duration for set of content items and present said posted set of or one or more content items to viewers or target o intended recipients and present for pre-set duration of timer and in the event of expiry of timer remove set of presented content items or visual media items and display next set of content items or visual media items or enable sender to apply view timer for each posted content item and present more than one content items and each content item having different pre-set view duration and in the event of expiry of view duration remove each expired content item and present new content item, enable receiver to pre-set number of times of views and remove after said pre-set number of times of views or enabling viewing user to mark content item as ephemeral or non-epithermal or enabling viewing user to hold and view photo or video and in the event of releases or expiry of pre-set view timer remove viewed content and also remove thumbnail or index item.

In an embodiment present invention enables one or more types of mass user action(s) including participate in mass deals, buy or make order, view and like & review movie trailer release first time, download, install & register application, listen first time launched music, buy curate product, buy latest technology products, subscribe services, like and comment on movie song or story, buy books, view latest or top trend news or tweet or advertisement or announcement at specified date & time for particular pre-set duration of time with customized offer e.g. get points, get discounts, get free samples, view first time movie trailer, refer friends and get more discounts (like chain marketing), which mainly enables curate or verified or picked up or mas level effected but less known or first time launch products, services, mobile application to get huge traction and sells or bookings. User can get preference based or use data specific contextual push notifications or indication or can directly view from application, date & time specific presented content (advertisement, news, group deals, trailer, music, customized offers etc.) with one or more types of mass action (install, sign off mass or group deals, register, view trailer, fill survey form, like product, subscribe service etc.)

In an embodiment present invention enables multi-tasking visual media capture controller control or label and/or icon or image including selecting front or back camera mode, capturing photo or start recording video and sop while further tap on icon or recording pre-set duration video or stop before pre-set duration of video or remove pre-set duration of video and capture as per user need, optionally preview or preview for pre-set duration, auto send to said visual media capture controller control or label and/or icon or image associated or pre-configured contact(s) or group(s) or destination(s) and view said visual media capture controller control or label and/or icon or image associated or pre-configured contact(s) or group(s) or destination(s) specific received content items or view pre-configured one or more interfaces and optionally via status (e.g. online or offline, last seen, manual status, received or not-received or read or not read sent or posted content items) or view reactions of visual media capture controller control or label and/or icon or image associated or pre-configured contact(s) or group(s) or destination(s).

In an embodiment present invention enables auto identifying, preparing and generating and presenting user's status based on user's supplied data including image (via scanning, capturing, selecting), user's voice, and/or user related data including user device's current location or place, user profile (age, gender, various dates & times etc.).

In an embodiment present invention enables generating and presenting cartoon or emoji or avatar based on auto generated user's status i.e. based on plurality of factors including scanning or providing image via camera display screen and/or user's voice and/or user and connected users' data (current location, date & time) and identification of user's related activities, actions, events, entities, and transactions.

In an embodiment present invention suggests always on camera (when user's intention to take visual media based on recognition of particular type of pre-defined user's eye gaze) and auto start video (even if user is not ready to take proper scene) and then enable user to trim unnecessary part and mark as start of video and mark as end of one or more videos and enable to capture one or more photos and share all or one or more or preset or default or updated one or more contacts and/or one or more types of destination(s) (make it one or more types of ephemeral or non-ephemeral and/or real-time viewing based on setting(s)) and/or enable to record front camera video (for providing video commentaries) simultaneously with back camera video during parent video recording session. So like eye (always ON and always recoding views) user can instantly, real-time view and simultaneously record one or more videos and captures one or more photos and provide commentary with back camera video and share with one or more contacts and make it one or more types of ephemeral or non-ephemeral and/or real-time viewing.

In an embodiment present invention discloses user created gallery or event including provide name, category, icon or image, schedule(s), location or place information of event or predefine characteristics or type of location (via SQL or natural query or wizard interface), define participant members criteria or characteristics including invited or added members from contact list(s) or request accepted or based on SQL or natural query or wizard and define viewers criteria or characteristics and define presentation or feed type. Based on auto starting or manually started by creator or authorized user(s) and said provided settings and information, in the event of matching of said defined target criteria specific including schedule(s) and/or location(s) and/or authorization matching with user device current location or type or category of location and/or user device current date & time and/or user identity or type of user based on user data or user profile, system presents one or more visual media capture controller control or icon and/or label on user device display or camera screen display or device camera for enabling user to alerting, notifying, capturing, recording, storing, previewing, and autos sending to visual media capture controller control or icon and/or label associated created one or more galleries or events or folders or visual stories and/or one or more types of destination(s) and/or contact(s) and/or group(s).

In an embodiment present invention enables registered developers of network to register, verify, make listing payment (if paid), upload or listing with details and making them searchable one or more augmented reality applications, functions, features, controls (e.g. button), and interfaces and enabling user to download and install augmented reality client application and enabling searching users including advertisers of network to search, match, select, select from one or more types of categories, make payment (if paid), download, update, upgrade, install or access from server or select link(s) of one or more augmented reality applications, functions, features, controls (e.g. button), and interfaces and enable to customize or configure and associate with defined or created named publication or advertisement said one or more augmented reality applications, functions, features, controls (e.g. button), and interfaces and provide publication criteria including provide object criteria including object model(s), so when user scan said object then auto present said one or more augmented reality applications, functions, features, controls (e.g. button), and interfaces related to said user or advertiser or publisher and/or target audience criteria, so user data match with said target criteria then present one or more augmented reality applications, functions, features, controls (e.g. button), and interfaces and/or target location(s) or place(s) or defined location(s) based on structured query language (SQL), natural query and step by step wizard to define location(s) type(s), categories & filters (e.g. all shops related to particular brand, all flower seller—system identifies based on pre-stored categories, types, tags, keywords, taxonomy, associated information associated with location or place or point of interest or spot or location point or location or each identified or updated places or point of interests or spots or location points on map of world or databases or storage mediums of locations or places, so when user device monitored current location is matched with or near to said target location or place then auto present said one or more augmented reality applications, functions, features, controls (e.g. button), and interfaces and any combination thereof. In another embodiment user or developer or advertiser or server 110 may be publisher of one or more augmented reality applications, functions, features, controls (e.g. button), and interfaces.

In an embodiment present invention enables user to post structured or freeform requirement specification and get response from matched actual customers, contacts of user, experts, users of network and sellers. System maintains logs of who saved use's time, money, and energy and provides best price, best matched and best quality of matched products and services to user. Present invention provides user to user saving money (best price, quality and matched products and services) platform.

In an embodiment present invention enables auto recording of user reaction on viewed or viewing content item or visual media item or message in visual media format including photo or video and auto posting said auto recorded photo or video reaction on all viewers or recipients for viewing of reactions at prominent place e.g. below said post or content item or visual media item. In another embodiment enabling user to make said visual media reaction ephemeral at viewing user's or recipient user's device or interface or application.

In an embodiment present invention enables user to provide, search, match, select, add, identify, recognize, notify user to add, update & remove keywords, key phrases, categories, tags and associated relationships including type of one or more entities, activities, actions, events, transactions, connections, status, interaction, locations, communication, sharing, participation, expression senses & behavior and associate information, structured information (e.g. selected one or more fields and provided one or more data types or types specific one or more values) metadata & system data, Boolean operators, natural queries, Structures Query Language (SQL). So said each user related, associated, provided, accumulated, identified, recognized, ranked, updated keywords, key phrases, tags, hashtags and one or more types of one or more identified or updated or created or defined relationships and ontologies among or between said one or more keywords, key phrases, tags, hashtags, associated one or more categories, sub-categories, taxonomy, system can utilize said user contextual relational keywords for plurality of purposes including search, match user specific contextual visual media items, content items to user, present contextual advertisements, enable 3^{rd} parties enterprise subscribers to access or data mine said users' contextual and relational keywords for one or more types of purposes based on user permission, privacy settings & preferences.

In an embodiment present invention enables users to relieve from said manual process and enables to send request to auto select or select from map nearest available or ranked visual media taking service provider and in the event of acceptance of request enable both to find out each other, enable visual media taking service provider or photographer to capture, preview, cancel, retake, and auto send visual media of requestor user or his/her group from visual media taking service provider's or photographer's smartphone camera or camera device to said visual media taking service consumer's or tourists or requestor user's device and enabling him/her to preview, cancel, and accept said visual media including one or more photos or videos, send request to retake or take more or enable both to finish or done current photo taking or shooting service session and provide ratings and reviews of each other.

In an embodiment present invention enables to identify user's free or available time or date & time range(s) (i.e. wants suggestions for types of contextual activities) and suggests (by server based on match making, by user's contacts, by 3^{rd} parties) contextual activities including shopping, viewing movie or drama, tours & packages, paly games, eat foods, visit places based on one or more types of user and connected users' data including duration and date & time of free or available time for conducting one or more activities, type of activity do (e.g. alone, collaborative—with selected one or more contacts etc.), real-time provide preferences for types of activities, detail user profile (age, gender, income range, education, work type, skills, hobbies, interest types), past liked or conducted activities & transactions, participated events, current location or place, home or work address, nearby places, date & time, current trend (new movie, popular drama etc.), holiday, vacation, preferences, privacy settings, requirements, suggested by contacts or invited by contacts for collaborative activities or plan, status, nearest location, budget, type of accompanied contacts, length of free or available time, type of location or place, matched events locations and date & time, types and names or brands of products and services used, using & want to use. Present invention enables user to utilize user available time for conducting various activities in best possible manner by suggesting or updating various activities from plurality of sources.

In an embodiment present invention enables user to create one or more type of feeds including e.g. personal, relatives specific, best friends specific, friends specific, interest specific, professional type specific, news specific, and enable to provide configuration settings, privacy settings, presentation settings and preferences for one or more or each feeds including allow to contacts to follow or subscribe said particular type of feed(s), allow all or allow invited or allow request accepted of requestors or allow to follow or subscribe one or more types of created feeds to pre-defined characteristics of followers only based on use data and user profile. For example personal feeds type is allow following or subscribing only to user's contacts. For example for News type of feed, allowing following or subscribing to all users of network. For example for professional type of feed, allowing to subscribe or follow to connected users only or to pre-defined types of characteristics users of network only. In another embodiment make particular feed real-time only i.e. receiving user can accept push notification to view said message within pre-set duration else receiving or following user or follower is unable to view said message. In another embodiment enable posting user to make posted content item as ephemeral and provide ephemeral settings including pre-set view or display duration, pre-set number of times of allow to view, pre-set number of times of allow to view within pre-set life duration and after presenting in the event of expiry of view timer or surpass number of times of views or expiry of life duration remove said message from recipient user's device. In another embodiment enable posting user to start broadcasting session and enable followers to start real-time view content as and when contents are posted, in the event of first posted content item if follower not viewed said content item then in the event of posting of second content item follower can view only second posted & received content item and in the event of follower viewed said content item then in the event of posting of and receiving of second content item then system removes first content item from recipient device and present second posted content item. In another embodiment following user can provide scale to indicate how much content user likes to receive from all or particular followed user or particular feed of particular followed user(s) and/or also provide one or more keywords, categories, hashtags inside posted messages which user likes to receive said keywords, categories, hashtags specific messages from followed user(s). In another embodiment enable searching user to provide search query and search users and related one or more types of feeds and select from search result users and/or related one or more types of feeds and follow all or selected one or more types of feeds of one or more selected users or provide search query to search posted contents or messages of users of network and select source(s) or user(s) or related one or more types of feeds associated with posted message or content items and follow source(s) or related one or more types of feeds or follow user's all or selected one or more types of feeds of user from search result item or from user's profile page or from categories directory item or from suggested list or from user created list or from 3rd parties' web sites or applications. In another embodiment follower receives posted messages or one or more types of one or more content items or visual media items from followed user(s)'s followed type of feed(s) related posted messages at/under/within//in said categories or type of feed(s) presented messages. For example when user [A] followed user [Y]'s “Sports” type feed then when user [Y] post message under “Sports” type feed or first select “Sports” type feed and then tap on post to post said message at server 110 then server 110 presents said posted message related to “Sports” type feed of user [Y] at following user [A]'s “Sports” category tab so receiving user can view all followed “Sports” type feed related messages from all followed users in said “Sports” category tab. Present invention also enables group of users to posts under one or more created and selected types of feeds for making them available for common followers of group.

In an embodiment present invention enables user to input (auto-fill from suggested keywords) or selects keywords, key phrases, categories, and associated relationships or ontology(ies) from auto presented suggested list of keywords, key phrases, categories, and associated relationships or ontology(ies) based on user's voice or talks, user scanning, providing object criteria, object model(s) (select or take visual media including photo(s) or video(s)), user device(s) monitored current location, user provided status, user domain specific profile, provided structured information via structured forms, templates and wizard related to user's activities, actions, events, transactions, interests, hobbies, likes, dislikes, preferences, privacy, requirement specifications, search queries, and selecting, applying and executing one or more rules to identify contextual keywords, key phrases, categories, and associated relationships or ontology(ies). Present invention enables user to search and present location on map or navigate map to select location or search address for finding particular location or place on map and further enable user to provide said location or place associate one or more searching keywords and/or object criteria or object model(s) and/or preferences and/or filter criteria to search, match, select, identify recognize and presents visual media items in sequence and display next based on haptic contact engagement on display or tapping on presentation interface or presented visual media item or auto advance next visual media item based on pre-set interval period of time. So user can view location or place and/or associated supplied object criteria and/or filter criteria specific visual media items. For example user can select particular place where conference is organized and provide keywords “Mobile application presentation” and based on said provided location and associate conference name and keywords, search engine searches and matches user generated and posted or conference administrator generated or posted visual media items or content items related to said particular keywords and present to user sequentially. So user can view visual media items based on plurality of angles, attributes, properties, ontology, characteristics including reviews, presentation, video, menu, price, description, catalogues, photos, blogs, comments, feedbacks, complaints, suggestions, how to use or access or made, manufacturing or how to made, questions and answers, customer interviews or opinions, video survey, particular product or object model specific or type of product related visual media, view design, wearable particular designed or particular type of cloths by customers, user experience videos, learning and educational or entertainment visual media, view interior, view management or marketing style, tips, tricks & live marketing of various products or services. In another embodiment user can search based on defined type(s) or characteristics of location(s) or place(s) via structured query language (SQL) or natural query or wizard interface e.g. “Gardens of world” and then provide one or more object criteria (e.g. sample image or object model of Passiflora flower) and/or keywords “how to plant” then system identifies all gardens of Passiflora flower and presents visual media related to plantings posted by visitors or users of network or posted by 3^{rd} parties, who associated or provided one or more flower related ontology(ies), keywords, tags, hashtags, categories, and information.

In an embodiment present invention enables user to provide voice command to start video talk with voice command related contact and auto ON user's and called user's device, auto open application and front camera video interface of camera display screen in both caller and called user's device and enable them starts video talking and/or chatting and/or voice talk and/or sharing one or more types of media including photo, video, video streaming, files, text, blog, links, emoticons, edited or augmented or photo filter(s) applied photo or video with each other. In the event of no talk for pre-specified period of time then close or hide video interface and OFF user's device and further start in the event of receiving of voice command instructing start of video talk with particular contact(s). User doesn't have to each video calling open device, open application, select contacts, make calling, wait for call acceptance by called user, end call and in the event of further talk user doesn't have to again follow same process each time.

The following presents some of the limited details about various technologies, technical terms used in or useful in understanding various inventions.

Eye tracking is the process of measuring either the point of gaze (where one is looking) or the motion of an eye relative to the head. An eye tracker is a device for measuring eye positions and eye movement. Eye trackers are used in research on the visual system, in psychology, in psycholinguistics, marketing, as an input device for human-computer interaction, and in product design. There are a number of methods for measuring eye movement. The most popular variant uses video images from which the eye position is extracted. Other methods use search coils or are based on the electrooculogram.

Tracker types: Eye trackers measure rotations of the eye in one of several ways, but principally they fall into three categories: (i) measurement of the movement of an object (normally, a special contact lens) attached to the eye, (ii) optical tracking without direct contact to the eye, and (iii) measurement of electric potentials using electrodes placed around the eyes.

Eye-attached tracking: The first type uses an attachment to the eye, such as a special contact lens with an embedded mirror or magnetic field sensor, and the movement of the attachment is measured with the assumption that it does not slip significantly as the eye rotates. Measurements with tight fitting contact lenses have provided extremely sensitive recordings of eye movement, and magnetic search coils are the method of choice for researchers studying the dynamics and underlying physiology of eye movement. It allows the measurement of eye movement in horizontal, vertical and torsion directions.

Optical tracking: An eye-tracking head-mounted display. Each eye has an LED light source (gold-color metal) on the side of the display lens, and a camera under the display lens. The second broad category uses some non-contact, optical method for measuring eye motion. Light, typically infrared, is reflected from the eye and sensed by a video camera or some other specially designed optical sensor. The information is then analyzed to extract eye rotation from changes in reflections. Video-based eye trackers typically use the corneal reflection (the first Purkinje image) and the center of the pupil as features to track over time. A more sensitive type of eye tracker, the dual-Purkinje eye tracker, uses reflections from the front of the cornea (first Purkinje image) and the back of the lens (fourth Purkinje image) as features to track. A still more sensitive method of tracking is to image features from inside the eye, such as the retinal blood vessels, and follow these features as the eye rotates. Optical methods, particularly those based on video recording, are widely used for gaze tracking and are favored for being non-invasive and inexpensive.

Technologies and techniques: The most widely used current designs are video-based eye trackers. A camera focuses on one or both eyes and records their movement as the viewer looks at some kind of stimulus. Most modern eye-trackers use the center of the pupil and infrared/near-infrared non-collimated light to create corneal reflections (CR). The vector between the pupil center and the corneal reflections can be used to compute the point of regard on surface or the gaze direction. A simple calibration procedure of the individual is usually needed before using the eye tracker.

The proximity sensor is common on most smart-phones, the ones that have a touchscreen. This is because the primary function of a proximity sensor is to disable accidental touch events. The most common scenario being—The ear coming in contact with the screen and generating touch events, while on a call. Proximity Sensor is interrupt based (NOT polling). This means that we get a proximity event only when the proximity changes (either NEAR to FAR or FAR to NEAR).

Gyroscope sensor helps in identifying rate of rotation around the x, y and z axis. It's needed in VR (virtual reality). Accelerometer sensor identifies acceleration force along the x, y and z axis (including gravity). Needed to measure any motion inputs like games. Proximity sensor is used to disable accidental touch events. The most common scenario is the ear coming in contact with the screen, while on a call. Compass sensor is a magnetometer which measures the strength and direction of magnetic fields.

Accelerometers in mobile phones are used to detect the orientation of the phone. The gyroscope, or gyro for short, adds an additional dimension to the information supplied by the accelerometer by tracking rotation or twist.

An accelerometer measures linear acceleration of movement, while a gyro on the other hand measures the angular rotational velocity. Both sensors measure rate of change; they just measure the rate of change for different things. In practice, that means that an accelerometer will measure the directional movement of a device but will not be able to resolve its lateral orientation or tilt during that movement accurately unless a gyro is there to fill in that info.

Object recognition is a technology in the field of computer vision for finding and identifying objects in an image or video sequence. Humans recognize a multitude of objects in images with little effort, despite the fact that the image of the objects may vary somewhat in different viewpoints, in many different sizes and scales or even when they are translated or rotated. Objects can even be recognized when they are partially obstructed from view. Object recognition is a process for identifying a specific object in a digital image or video. Object recognition algorithms rely on matching, learning, or pattern recognition algorithms using appearance-based or feature-based techniques.

Face detection is a computer technology being used in a variety of applications that identifies human faces in digital images. Face detection also refers to the psychological process by which humans locate and attend to faces in a visual scene.

Object detection is a computer technology related to computer vision and image processing that deals with detecting instances of semantic objects of a certain class (such as humans, buildings, or cars) in digital images and videos. Well-researched domains of object detection include face detection and pedestrian detection. Object detection has applications in many areas of computer vision, including image retrieval and video surveillance. It is used in face detection and face recognition. It is also used in tracking objects, for example tracking a ball during a football match, tracking movement of a cricket bat, tracking a person in a video.

Optical character recognition (also optical character reader, OCR) is the mechanical or electronic conversion of images of typed, handwritten or printed text into machine-encoded text, whether from a scanned document, a photo of a document, a scene-photo (for example the text on signs and billboards in a landscape photo) or from subtitle text superimposed on an image (for example from a television broadcast). It is widely used as a form of information entry from printed paper data records, whether passport documents, invoices, bank statements, computerized receipts, business cards, mail, printouts of static-data, or any suitable documentation. It is a common method of digitizing printed texts so that they can be electronically edited, searched, stored more compactly, displayed on-line, and used in machine processes such as cognitive computing, machine translation, (extracted) text-to-speech, key data and text mining. OCR is a field of research in pattern recognition, artificial intelligence and computer vision.

Computer vision is an interdisciplinary field that deals with how computers can be made to gain high-level understanding from digital images or videos. From the perspective of engineering, it seeks to automate tasks that the human visual system can do.

Computer vision tasks include methods for acquiring, processing, analyzing and understanding digital images, and in general, deal with the extraction of high-dimensional data from the real world in order to produce numerical or symbolic information, e.g., in the forms of decisions. Understanding in this context means the transformation of visual images (the input of the retina) into descriptions of the world that can interface with other thought processes and elicit appropriate action. This image understanding can be seen as the disentangling of symbolic information from image data using models constructed with the aid of geometry, physics, statistics, and learning theory.

As a scientific discipline, computer vision is concerned with the theory behind artificial systems that extract information from images. The image data can take many forms, such as video sequences, views from multiple cameras, or multi-dimensional data from a medical scanner. As a technological discipline, computer vision seeks to apply its theories and models for the construction of computer vision systems.

Sub-domains of computer vision include scene reconstruction, event detection, video tracking, object recognition, object pose estimation, learning, indexing, motion estimation, and image restoration.

The fields most closely related to computer vision are image processing, image analysis and machine vision.

Image analysis is the extraction of meaningful information from images; mainly from digital images by means of digital image processing techniques. Image analysis tasks can be as simple as reading bar coded tags or as sophisticated as identifying a person from their face.

Speech recognition (SR) is the inter-disciplinary sub-field of computational linguistics that develops methodologies and technologies that enables the recognition and translation of spoken language into text by computers. It is also known as “automatic speech recognition” (ASR), “computer speech recognition”, or just “speech to text” (STT).

Some SR systems use “training” (also called “enrollment”) where an individual speaker reads text or isolated vocabulary into the system. The system analyzes the person's specific voice and uses it to fine-tune the recognition of that person's speech, resulting in increased accuracy. Systems that do not use training are called “speaker independent” systems. Systems that use training are called “speaker dependent”.

Speech recognition applications include voice user interfaces such as voice dialing (e.g. “Call home”), call routing (e.g. “I would like to make a collect call”), domotic appliance control, search (e.g. find a podcast where particular words were spoken), simple data entry (e.g., entering a credit card number), preparation of structured documents (e.g. a radiology report), speech-to-text processing (e.g., word processors or emails), and aircraft (usually termed Direct Voice Input). The term voice recognition or speaker identification refers to identifying the speaker, rather than what they are saying. Recognizing the speaker can simplify the task of translating speech in systems that have been trained on a specific person's voice or it can be used to authenticate or verify the identity of a speaker as part of a security process.

A barcode is an optical, machine-readable, representation of data; the data usually describes something about the object that carries the barcode. Originally barcodes systematically represented data by varying the widths and spacings of parallel lines, and may be referred to as linear or one-dimensional (1D). Later two-dimensional (2D) codes were developed, using rectangles, dots, hexagons and other geometric patterns in two dimensions, usually called barcodes although they do not use bars as such. Barcodes originally were scanned by special optical scanners called barcode readers. Later applications software became available for devices that could read images, such as smartphones with cameras.

QR code (abbreviated from Quick Response Code) is the arcode is a machine-readable optical label that contains information about the item to which it is attached. A QR code uses four standardized encoding modes (numeric, alphanumeric, byte/binary, and kanji) to efficiently store data; extensions may also be used. The QR code system became popular outside the automotive industry due to its fast readability and greater storage capacity compared to standard UPC barcodes. Applications include product tracking, item identification, time tracking, document management, and general marketing. A QR code consists of black squares arranged in a square grid on a white background, which can be read by an imaging device such as a camera, and processed using Reed-Solomon error correction until the image can be appropriately interpreted. The required data are then extracted from patterns that are present in both horizontal and vertical components of the image.

In computer science and information science, ontology is a formal naming and definition of the types, properties, and interrelationships of the entities that really or fundamentally exist for a particular domain of discourse. It is thus a practical application of philosophical ontology, with taxonomy. The core meaning within computer science is a model for describing the world that consists of a set of types, properties, and relationship types. There is also generally an expectation that the features of the model in an ontology should closely resemble the real world (related to the object). Common components of ontologies include: Individuals-Instances or objects (the basic or “ground level” objects), Classes—Sets, collections, concepts, classes in programming, types of objects, or kinds of things, Attributes—Aspects, properties, features, characteristics, or parameters that objects (and classes) can have, Relations—Ways in which classes and individuals can be related to one another, Function terms—Complex structures formed from certain relations that can be used in place of an individual term in a statement, Restrictions—Formally stated descriptions of what must be true in order for some assertion to be accepted as input, Rules—Statements in the form of an if-then (antecedent-consequent) sentence that describe the logical inferences that can be drawn from an assertion in a particular form, Axioms—Assertions (including rules) in a logical form that together comprise the overall theory that the ontology describes in its domain of application, Events—The changing of attributes or relations. Ontologies are commonly encoded using ontology languages. A domain ontology (or domain-specific ontology) represents concepts which belong to part of the world. Particular meanings of terms applied to that domain are provided by domain ontology. For example, the word card has many different meanings. An ontology about the domain of poker would model the “playing card” meaning of the word, while an ontology about the domain of computer hardware would model the “punched card” and “video card” meanings.

A geo-fence is a virtual perimeter for a real-world geographic area. A geo-fence could be dynamically generated—as in a radius around a store or point location, or a geo-fence can be a predefined set of boundaries, like school attendance zones or neighborhood boundaries.

The use of a geo-fence is called geo-fencing, and one example of usage involves a location-aware device of a location-based service (LBS) user entering or exiting a geo-fence. This activity could trigger an alert to the device's user as well as messaging to the geo-fence operator. This info, which could contain the location of the device, could be sent to a mobile telephone or an email account. Geo-fencing, used with child location services, can notify parents if a child leaves a designated area. Geo-fencing used with locationized firearms can allow those firearms to fire only in locations where their firing is permitted, thereby making them unable to be used elsewhere. Geo-fencing is critical to telematics. It allows users of the system to draw zones around places of work, customer's sites and secure areas. These geo-fences when crossed by an equipped vehicle or person can trigger a warning to the user or operator via SMS or Email. In some companies, geo-fencing is used by the human resource department to monitor employees working in special locations especially those doing field works. Using a geofencing tool, an employee is allowed to log his attendance using a GPS-enabled device when within a designated perimeter. Other applications include sending an alert if a vehicle is stolen and notifying rangers when wildlife stray into farmland. Geofencing, in a security strategy model, provides security to wireless local area networks. This is done by using predefined borders, e.g., an office space with borders established by positioning technology attached to a specially programmed server. The office space becomes an authorized location for designated users and wireless mobile devices.

Geo-fencing (geofencing) is a feature in a software program that uses the global positioning system (GPS) or radio frequency identification (RFID) to define geographical boundaries. A geofence is a virtual barrier. Programs that incorporate geo-fencing allow an administrator to set up triggers so when a device enters (or exits) the boundaries defined by the administrator, a text message or email alert is sent. Many geo-fencing applications incorporate Google Earth, allowing administrators to define boundaries on top of a satellite view of a specific geographical area. Other applications define boundaries by longitude and latitude or through user-created and Web-based maps. The technology has many practical uses. For example, a network administrator can set up alerts so when a hospital-owned iPad leaves the hospital grounds, the administrator can disable the device. A marketer can geo-fence a retail store in a mall and send a coupon to a customer who has downloaded a particular mobile app when the customer (and his smartphone) crosses the boundary.

Geo-fencing has many uses including: Fleet management—e.g. When a truck driver breaks from his route, the dispatcher receives an alert. Human resource management—e.g. An employee smart card will send an alert to security if an employee attempts to enter an unauthorized area.

Compliance management—e.g. Network logs record geo-fence crossings to document the proper use of devices and their compliance with established rules. Marketing—e.g. A restaurant can trigger a text message with the day's specials to an opt-in customer when the customer enters a defined geographical area. Asset management—e.g. An RFID tag on a pallet can send an alert if the pallet is removed from the warehouse without authorization. Law enforcement—e.g. An ankle bracelet can alert authorities if an individual under house arrest leaves the premises.

Rather than using a GPS location, network-based geofencing “uses carrier-grade location data to determine where SMS subscribers are located.” If the user has opted in to receive SMS alerts, they will receive a text message alert as soon as they enter the geofence range. As always, users have the ability to opt-out or stop the alerts at any time.

Beacons can achieve the same goal as app-based geofencing without invading anyone's privacy or using a lot of data. They can't pinpoint the user's exact location on a map like a geofence can, but they can still send signals when it's triggered by certain events (like entering or exiting the beacon's signal, or getting within a certain distance of the beacon)—and they can determine approximately how close the user is to the beacon, down to a few inches. Best of all, because beacons rely on bluetooth technology, they hardly use any data and won't affect the user's battery life.

Geo-location: identifying the real-world location of a user with GPS, Wi-Fi, and other sensors

Geo-fencing: taking an action when a user enters or exits a geographic area

Geo-awareness: customizing and localizing the user experience based on rough approximation of user location, often used in browsers

Augmented reality (AR) is a live direct or indirect view of a physical, real-world environment whose elements are augmented (or supplemented) by computer-generated sensory input such as sound, video, graphics or GPS data. It is related to a more general concept called mediated reality, in which a view of reality is modified (possibly even diminished rather than augmented) by a computer. As a result, the technology functions by enhancing one's current perception of reality. By contrast, virtual reality replaces the real world with a simulated one. Augmentation is conventionally in real time and in semantic context with environmental elements, such as sports scores on TV during a match. With the help of advanced AR technology (e.g. adding computer vision and object recognition) the information about the surrounding real world of the user becomes interactive and digitally manipulable. Information about the environment and its objects is overlaid on the real world. This information can be virtual or real, e.g. seeing other real sensed or measured information such as electromagnetic radio waves overlaid in exact alignment with where they actually are in space. Augmented reality brings out the components of the digital world into a person's perceived real world. One example is an AR Helmet for construction workers which displays information about the construction sites.

Hardware components for augmented reality are: processor, display, sensors and input devices. Modern mobile computing devices like smartphones and tablet computers contain these elements which often include a camera and MEMS sensors such as accelerometer, GPS, and solid state compass, making them suitable AR platforms.

Various technologies are used in Augmented Reality rendering including optical projection systems, monitors, hand held devices, and display systems worn on the human body.

AR displays can be rendered on devices resembling eyeglasses. Versions include eyewear that employ cameras to intercept the real world view and re-display its augmented view through the eye pieces and devices in which the AR imagery is projected through or reflected off the surfaces of the eyewear lens pieces.

Modern mobile augmented-reality systems use one or more of the following tracking technologies: digital cameras and/or other optical sensors, accelerometers, GPS, gyroscopes, solid state compasses, RFID and wireless sensors. These technologies offer varying levels of accuracy and precision. Most important is the position and orientation of the user's head. Tracking the user's hand(s) or a handheld input device can provide a 6DOF interaction technique

Techniques include speech recognition systems that translate a user's spoken words into computer instructions and gesture recognition systems that can interpret a user's body movements by visual detection or from sensors embedded in a peripheral device such as a wand, stylus, pointer, glove or other body wear. Some of the products which are trying to serve as a controller of AR Headsets include Wave by Seebright Inc. and Nimble by Intugine Technologies.

The computer analyzes the sensed visual and other data to synthesize and position augmentations.

A key measure of AR systems is how realistically they integrate augmentations with the real world. The software must derive real world coordinates, independent from the camera, from camera images. That process is called image registration which uses different methods of computer vision, mostly related to video tracking. Many computer vision methods of augmented reality are inherited from visual odometry. Usually those methods consist of two parts.

First detect interest points, or fiducial markers, or optical flow in the camera images. First stage can use feature detection methods like corner detection, blob detection, edge detection or thresholding and/or other image processing methods. The second stage restores a real world coordinate system from the data obtained in the first stage. Some methods assume objects with known geometry (or fiducial markers) present in the scene. In some of those cases the scene 3D structure should be precalculated beforehand. If part of the scene is unknown simultaneous localization and mapping (SLAM) can map relative positions. If no information about scene geometry is available, structure from motion methods like bundle adjustment are used. Mathematical methods used in the second stage include projective (epipolar) geometry, geometric algebra, rotation representation with exponential map, kalman and particle filters, nonlinear optimization, robust statistics.

Augmented Reality Markup Language (ARML) is a data standard developed within the Open Geospatial Consortium (OGC), which consists of an XML grammar to describe the location and appearance of virtual objects in the scene, as well as ECMAScript bindings to allow dynamic access to properties of virtual objects.

To enable rapid development of Augmented Reality Application, some software development kits (SDK) have emerged. A few SDK such as CloudRidAR leverage cloud computing for performance improvement. Some of the well known AR SDKs are offered by Vuforia, ARToolKit, Catchoom CraftAR Mobinett AR, Wikitude, Blippar Layar, and Meta.

Handheld displays employ a small display that fits in a user's hand. All handheld AR solutions to date opt for video see-through. Initially handheld AR employed fiducial markers,[48] and later GPS units and MEMS sensors such as digital compasses and six degrees of freedom accelerometer-gyroscope. Today SLAM markerless trackers such as PTAM are starting to come into use. Handheld display AR promises to be the first commercial success for AR technologies. The two main advantages of handheld AR is the portable nature of handheld devices and ubiquitous nature of camera phones.

AR is used to integrate print and video marketing. Printed marketing material can be designed with certain “trigger” images that, when scanned by an AR enabled device using image recognition, activate a video version of the promotional material. A major difference between Augmented Reality and straight forward image recognition is that you can overlay multiple media at the same time in the view screen, such as social media share buttons, in-page video even audio and 3D objects. Traditional print only publications are using Augmented Reality to connect many different types of media. AR can enhance product previews such as allowing a customer to view what's inside a product's packaging without opening it.[102] AR can also be used as an aid in selecting products from a catalog or through a kiosk. Scanned images of products can activate views of additional content such as customization options and additional images of the product in its use. In educational settings, AR has been used to complement a standard curriculum. Text, graphics, video and audio were superimposed into a student's real time environment. Textbooks, flashcards and other educational reading material contained embedded “markers” or triggers that, when scanned by an AR device, produced supplementary information to the student rendered in a multimedia format. Augmented reality technology enhanced remote collaboration, allowing students and instructors in different locales to interact by sharing a common virtual learning environment populated by virtual objects and learning materials. The gaming industry embraced AR technology. A number of games were developed for prepared indoor environments, such as AR air hockey, collaborative combat against virtual enemies, and AR-enhanced pool-table games. Augmented reality allowed video game players to experience digital game play in a real world environment. Companies and platforms like Niantic and LyteShot emerged as major augmented reality gaming creators. Niantic is notable for releasing the record-breaking Pokémon Go game. Travelers used AR to access real time informational displays regarding a location, its features and comments or content provided by previous visitors. Advanced AR applications included simulations of historical events, places and objects rendered into the landscape. AR applications linked to geographic locations presented location information by audio, announcing features of interest at a particular site as they became visible to the user. AR systems can interpret foreign text on signs and menus and, in a user's augmented view, re-display the text in the user's language. Spoken words of a foreign language can be translated and displayed in a user's view as printed subtitles. Augmented GeoTravel application displays information about users' surroundings in a mobile camera view. The application calculates users' current positions by using the Global Positioning System (GPS), a compass, and an accelerometer and accesses the Wikipedia data set to provide geographic information (e.g. longitude, latitude, distance), history, and contact details of points of interest. Augmented GeoTravel overlays the virtual 3-dimensional (3D) image and its information on real-time view.

An augmented reality development framework utilizes image recognition and tracking, and geolocation technologies. For location-based augmented reality, the position of objects on the screen of the mobile device is calculated using the user's position (by GPS or Wifi), the direction in which the user is facing (by using the compass) and accelerometer.

Smartglasses or smart glasses are wearable computer glasses that add information alongside or to what the wearer sees. Typically this is achieved through an optical head-mounted display (OHMD) or embedded wireless glasses with transparent heads-up display (HUD) or augmented reality (AR) overlay that has the capability of reflecting projected digital images as well as allowing the user to see through it, or see better with it. While early models can perform basic tasks, such as just serve as a front end display for a remote system, as in the case of smartglasses utilizing cellular technology or Wi-Fi, modern smart glasses are effectively wearable computers which can run self-contained mobile apps. Some are handsfree that can communicate with the Internet via natural language voice commands, while other use touch buttons.

Like other computers, smartglasses may collect information from internal or external sensors. It may control or retrieve data from other instruments or computers. It may support wireless technologies like Bluetooth, Wi-Fi, and GPS. While a smaller number of models run a mobile operating system and function as portable media players to send audio and video files to the user via a Bluetooth or WiFi headset. Some smartglasses models, also feature full lifelogging and activity tracker capability.

Such smartglasses devices may also have all the features of a smartphone. Some also have activity tracker functionality features (also known as “fitness tracker”) as seen in some GPS watches.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

One or more embodiments described herein provide that methods, techniques, and actions performed by a computing device are performed programmatically, or as a computer-implemented method. Programmatically, as used herein, means through the use of code or computer-executable instructions. These instructions can be stored in one or more memory resources of the computing device. A programmatically performed step may or may not be automatic.

One or more embodiments described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some embodiments described herein can generally require the use of computing devices, including processing and memory resources. For example, one or more embodiments described herein may be implemented, in whole or in part, on computing devices such as servers, desktop computers, cellular or smartphones, personal digital assistants (e.g., PDAs), laptop computers, printers, digital picture frames, network equipments (e.g., routers) and tablet devices. Memory, processing, and network resources may all be used in connection with the establishment, use, or performance of any embodiment described herein (including with the performance of any method or with the implementation of any system).

Furthermore, one or more embodiments described herein may be implemented through the use of instructions that are executable by one or more processors. These instructions may be carried on a computer-readable medium. Machines shown or described with Figures below provide examples of processing resources and computer-readable mediums on which instructions for implementing embodiments of the invention can be carried and/or executed. In particular, the numerous machines shown with embodiments of the invention include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, embodiments may be implemented in the form of computer-programs, or a computer usable carrier medium capable of carrying such a program.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

### BRIEF DESCRIPTION OF THE DRAWINGS

Non-limiting and non-exhaustive embodiments of the present invention are described with reference to the following drawings. In the drawings, like reference numerals refer to like parts throughout the various Figures unless otherwise specified.

For a better understanding of the present invention, reference will be made to the following Detailed Description, which is to be read in association with the accompanying drawings, wherein:

FIG. 1 is a network diagram depicting a network system having a client-server architecture configured for exchanging data over a network, according to one embodiment.

FIG. 2 illustrates components of an electronic device implementing various embodiments of intelligent camera & story system including components of an electronic device implementing content sending and receiving privacy & presentation settings, auto present camera display screen or media view interface, various types of ephemeral feeds, galleries and stories, sender controlled shared media items at recipient device, real-time ephemeral messages, object criteria specific search, subscription, presentation of visual media, stories and visual media advertisements integration within story or sequences of visual media items, auto identified user reactions, scan to access various types of features, intelligent or multi-tasking visual media capture controller, accelerated display of ephemeral messages, single mode front or back photo capture, user to user on demand providing and consuming service(s), search keyword(s) specific visual media posted at particular place, provide user related keywords, augmented reality application, user reaction application, user's auto status application, mass user action application, user requirement specific responses application, suggested prospective activities application, and natural talking application in accordance with the invention.

FIG. 3 illustrates flowchart explaining eye tracking system to auto open one or more types of interfaces including camera display screen in the event of auto detection of user's intent to take photo or video or present album or gallery or inbox or received media items interface based on user's intent to view past or received media items, according to an embodiment.

FIG. 4 illustrates flowchart explaining auto capturing of one or more photos or auto recording of pre-set duration video(s) based on starting and expiration of pre-set timer duration and optionally provide auto preview and/or auto send to pre-set one or more destinations.

FIG. 5 illustrates flowchart explaining auto capturing of photo or auto recording of video, according to an embodiment.

FIGS. 6 (C) & (D) illustrate processing operations associated with single mode visual media capture in accordance with the invention. FIGS. 6 (A) & (B) illustrates the exterior of an electronic device implementing auto mode turn on user device or switch on display screen and auto capture photo or auto start of recording of video discussed in detail in FIGS. 3 and 4.

FIG. 7 illustrates exemplary graphical user interface, describing ephemeral or non-ephemeral content access privacy and presentation settings for one or more types of one or more destination(s) or recipient(s) or contact(s) by sender with examples.

FIG. 8 illustrates exemplary graphical user interface, describing privacy settings, presentation settings and ephemeral settings for receiving of contents and making of contents as ephemeral or non-ephemeral received from one or more types of one or more source(s) or sender(s) or contact(s).

FIG. 9-13 illustrates a various embodiments for searching, matching, presenting, subscribing, and auto generating visual media story system.

FIG. 14 illustrates exemplary graphical user interface, describing proving of user preferences for consuming one or more types of series of visual media items or stories.

FIG. 15 illustrates exemplary graphical user interface, describing privacy settings for allowing or not-allowing other users to capture or record visual media related to user.

FIG. 16-17 illustrates exemplary graphical user interface, describing creating visual media advertisements with target criteria including object criteria or supplied object model or sample image for presenting with or integrating in or embedded within visual media stories for presenting to users of network.

FIG. 18 illustrates exemplary graphical user interface, describing sender access shared content item(s) by sender at recipient(s) based system.

FIG. 19 illustrates processing operations associated with accelerated display of ephemeral messages in accordance with an embodiment of the invention and illustrates the exterior of an electronic device implementing accelerated display of ephemeral messages in accordance with the invention.

FIG. 20-24 illustrates processing operations associated with real-time display of ephemeral messages in accordance with various embodiments of the invention.

FIG. 25-27 illustrates exemplary graphical user interface, describing real-time display of ephemeral messages in accordance with various embodiments of the invention.

FIG. 28-29 illustrates processing operations associated with real-time starting session of displaying or broadcasting of ephemeral messages in accordance with an embodiment of the invention.

FIG. 30 illustrates processing operations associated with display of ephemeral messages and media item and enabling user to remove from first list and add to second list and enabling to further move to first list within life timer and in the event of expiry of life timer remove from second list.

FIG. 31 illustrates processing operations associated with display of ephemeral messages and media item completely scroll-up to remove and append media item at the end of feed of or set of ephemeral messages in accordance with an embodiment of the invention.

FIG. 32 illustrates processing operations associated with display of ephemeral messages and based on load more user action remove currently presented ephemeral messages or media items and load or present next available (if any) set of ephemeral messages in accordance with an embodiment of the invention.

FIG. 33 illustrates processing operations associated with display of ephemeral messages and based on push to refresh user action remove currently presented ephemeral messages or media items and load or present next available (if any) set of ephemeral messages in accordance with an embodiment of the invention.

FIG. 34 illustrates processing operations associated with display of ephemeral messages and based on expiration of pre-set duration of timer auto refresh and remove currently presented ephemeral messages or media items and load or present next available (if any) set of ephemeral messages in accordance with an embodiment of the invention.

FIG. 35 illustrates processing operations associated with display of ephemeral messages and based on expiration of pre-set duration of timer associated with or correspond to presented each set of ephemeral messages, remove currently presented set of ephemeral messages or media items and load or present next available (if any) set of ephemeral messages in accordance with an embodiment of the invention.

FIG. 36 illustrates processing operations associated with display of ephemeral messages and based on expiration of pre-set duration of timer for scrolled-up ephemeral message (s) or media item(s), remove expired scrolled-up ephemeral message(s) or media item(s) from presented feed or set of ephemeral messages and in the event of removal of ephemeral message(s) or media item(s), load or present next available (if any) removed number equivalent or particular pre-set number of or available to present ephemeral messages in accordance with an embodiment of the invention.

FIG. 37 illustrates processing operations associated with display of ephemeral messages with no scrolling and based on expiration of pre-set duration of timer associated with each ephemeral message, remove expired ephemeral message(s) or media item(s) from presented feed or set of ephemeral messages and in the event of removal of ephemeral message(s) or media item(s), load or present next available (if any) removed number equivalent or available to present ephemeral messages in accordance with an embodiment of the invention.

FIG. 38 illustrates processing operations associated with display of ephemeral messages and based on expiration of pre-set duration of timer associated with each ephemeral message, remove expired ephemeral message(s) or media item(s) from presented feed or set of ephemeral messages and in the event of removal of ephemeral message(s) or media item(s), load or present next available (if any) removed number equivalent or particular pre-set number of or available to present ephemeral messages in accordance with an embodiment of the invention.

FIG. 39 illustrates processing operations associated with accelerated display of ephemeral messages in accordance with an embodiment of the invention and illustrates interface and the exterior of an electronic device implementing accelerated display of ephemeral messages in accordance with the invention.

FIG. 40 illustrates processing operations associated with single mode front or back photo or live photo capture embodiment of the invention and illustrates the exterior of an electronic device implementing single mode front or back photo or live photo capture.

FIG. 41 illustrates an electronic device includes digital image sensors to capture visual media, a display to present the visual media from the digital image sensors and a touch controller to identify haptic contact engagement, haptic contact persistence and haptic contact release on the display. A visual media capture controller alternately records the visual media as a photograph or a video based on pre-defined haptic contact engagement duration threshold. If threshold not exceeded then photo captured and if threshold exceeded then starting of video recording and if pre-set associated timer expired then stop video and store video and if not expired and receiving of haptic contact engagement on icon or display then stop said pre-defined video duration timer and enabling user to record video up-to further haptic contact engagement on icon or anywhere on display.

FIG. 42 illustrates processing operations associated with single mode front or back video recording embodiment of the invention and illustrates the exterior of an electronic device implementing single mode front or back video recording.

FIG. 43 illustrates an electronic device includes digital image sensors to capture visual media, a display to present the visual media from the digital image sensors and a touch controller to identify haptic contact engagement, haptic contact persistence and haptic contact release on the display and illustrates a visual media capture controller enables to slide or swipe or haptic contact swipe to change front or back camera or view on or more type of pre-set interfaces including view gallery or album or inbox or received media items mode and alternately records the visual media as a photo or a video based upon an evaluation of the time period between the haptic contact engagement and the haptic contact release.

FIG. 44 illustrates processing operations associated with slide or swipe or haptic contact swipe to change to front or back camera mode and based on selection of mode capture photo or record video embodiment of the invention and illustrates the exterior of an electronic device implementing the single mode invention slide to change front to back or back to front camera mode and alternately records the visual media as a photo or a video based upon an evaluation of the time period between the haptic contact engagement and the haptic contact release.

FIG. 45 illustrates processing operations associated with slide or swipe or haptic contact swipe to change to front or back camera mode and based on selection of mode capture photo or start recording of video and auto stop and store after pre-set duration, stop and store while further haptic contact energumen, stop and store before expiration of pre-set duration, stop pre-set timer to record video up-to next user haptic contact engagement embodiments of the invention.

FIG. 46 illustrates processing operations associated with slide or swipe or haptic contact swipe to change to front or back camera mode or view one or more types of pre-set interface(s) and based on selection of mode capture photo or start recording of video and auto stop after pre-set duration embodiment of the invention and illustrates the exterior of an electronic device implementing the single mode invention slide to change front to back or back to front camera mode or show one or more types of pre-set interface(s) and alternately records the visual media as a photo or a pre-set duration of video based upon an evaluation of the time period between the haptic contact engagement and the haptic contact release.

FIG. 47 illustrates processing operations associated with slide or swipe or haptic contact swipe to change to front or back camera mode or view one or more types of pre-set interface(s) and based on selection of mode capture photo or start recording of video and auto stop and store after pre-set duration, stop and store while further haptic contact energumen, stop and store before expiration of pre-set duration, stop pre-set timer to record video up-to next user haptic contact engagement embodiments of the invention.

FIG. 48 illustrates an electronic device includes digital image sensors to capture visual media, a display to present the visual media from the digital image sensors and a touch controller to identify haptic contact engagement, haptic contact persistence and haptic contact release on the display and illustrates a visual media capture controller enables to Haptic Contact Engagement on pre-defined area of visual media capture controller to change front or back camera or view on or more type of pre-set interfaces including view gallery or album or inbox or received media items mode and alternately records the visual media as a photo or a video based upon an evaluation of the time period between the haptic contact engagement and the haptic contact release.

FIG. 49 illustrates processing operations associated with Haptic Contact Engagement on pre-defined area of visual media capture controller to change to front or back camera mode and based on selection of mode capture photo or record video embodiment of the invention and illustrates the exterior of an electronic device implementing the single mode invention Haptic Contact Engagement on pre-defined area of visual media capture controller to change front to back or back to front camera mode and alternately records the visual media as a photo or a video based upon an evaluation of the time period between the haptic contact engagement and the haptic contact release.

FIG. 50 illustrates processing operations associated with Haptic Contact Engagement on pre-defined area of visual media capture controller to change to front or back camera mode and based on selection of mode capture photo or start recording of video and auto stop and store after pre-set duration, stop and store while further haptic contact energumen, stop and store before expiration of pre-set duration, stop pre-set timer to record video up-to next user haptic contact engagement embodiments of the invention.

FIG. 51 illustrates processing operations associated with Haptic Contact Engagement on pre-defined area of visual media capture controller to change to front or back camera mode or view one or more types of pre-set interface(s) and based on selection of mode capture photo or start recording of video and auto stop after pre-set duration embodiment of the invention and illustrates the exterior of an electronic device implementing the single mode invention Haptic Contact Engagement on pre-defined area of visual media capture controller to change front to back or back to front camera mode or show one or more types of pre-set interface(s) and alternately records the visual media as a photo or a pre-set duration of video based upon an evaluation of the time period between the haptic contact engagement and the haptic contact release.

FIG. 52 illustrates processing operations associated with Haptic Contact Engagement on pre-defined area of visual media capture controller to change to front or back camera mode or view one or more types of pre-set interface(s) and based on selection of mode capture photo or start recording of video and auto stop and store after pre-set duration, stop and store while further haptic contact energumen, stop and store before expiration of pre-set duration, stop pre-set timer to record video up-to next user haptic contact engagement embodiments of the invention.

FIGS. 53-54 illustrates identifying, preparing, generating and presenting status based on user provided and user related data.

FIG. 55 illustrates processing operations associated with accelerated taking, sharing visual media including taking one or more video(s), trimming video(s), capture photo(s) during recording of single video session.

FIG. 56-57 illustrates real-time sending and viewing ephemeral message in accordance with the invention.

FIG. 58 illustrates processing operations associated with multi-tabs accelerated display of ephemeral messages in accordance with an embodiment of the invention and illustrates the exterior of an electronic device implementing multi-tabs accelerated display of ephemeral messages in accordance with the invention.

FIGS. 59-64 illustrates processing operations, flowchart, exemplary interfaces and examples associated with creation of gallery or story or location or place or defined geo-fence boundaries specific scheduled event and define and invite participants. Based on event location, date & time and participant data, presents auto generated visual media capture & view controller(s) on display screen of device of each authorized participant member and enable them to one tap front or back camera capturing of one or more photos or recording of one or more videos and present preview interface for previewing said visual media for set pre-set duration and within that duration user is enable to remove said previewed photo or video and/or change or select destination(s) or auto send to pre-set destination(s) after expiry of said pre-set period of time. Admin of gallery or story or album or event creator is enabled to update event, start manually or auto start at scheduled period, invite, update or change, remove and define participants of event and accept request of user to participate in the event, define target viewers, select one or more types of one or more destinations, provide or define on or more types of presentation settings.

FIGS. 65-66 illustrates exemplary interface of augment reality application 280 and platform 180 wherein user can provide object model or object image or captured or selected image or photo or video (i.e. series of images), provide associated details and select one or more said provided scan able object associate one or more user action controls, wherein when user scans or view via camera display screen particular scene or object or select one or more objects from map then system matches with said supplied object model(s) or object image(s) or sample photo or video related images based on employing of image recognition technologies and optical character recognition technologies and present said matched user provided object model(s) or object image(s) or sample photo or video related images associated one or more user action control(s) on the user device, so scanned user can access or tap on preferred user action control.

FIG. 67 illustrates exemplary interface for auto recording video & audio or recording audio or auto capturing photo reaction on received and currently viewing media item(s) or feed item(s) or news feed item(s) or content item(s) or search result item(s) and auto sending said auto recorded or captured user reactions to sender or source of said media item(s) or feed item(s) or news feed item(s) or content item(s) or search result item(s). Optionally user can make reaction ephemeral based on set period of view duration and preview before send.

FIG. 68 illustrates user interface for enabling user to submit requirement specification and receives responses from contextual users or sources including actual users, contacts of users, experts, sellers and 3^{rd} parties in exchange of points or one or more types of payment models & modes. System logs and presents information and statistics & analytics about in which product or service user bought or subscribes or use with the help of which response of which user(s) and user provided related details including saved amount of money, ratings, quality, level of match making, experience, and updated details after purchase of products and services.

FIGS. 69-70 illustrates exemplary interface for enabling user to navigation of map including from world map select country, state, city, area, place and point or search particular place or spot or POI or point or access map to search, match, identify and find out location, place, spot, point, Points of Interest (POI) and associated or nearest or located or situated or advertised or listed or marked or suggested one or more types of entities including mall, shop, person, product, item, building, road, tourist place, river, forest, garden, mountain, hotel, restaurant, exhibition, events, fair, conference, structure, station, market, vendor, temple, apartment or society or house, and one or more types of one or more addresses and after identifying particular entity or item on map, user is enabled to provide, search, input, update, add, remove, re-arrange, select, provide via auto fill-up or auto suggested one or more keywords, key phrases and Boolean operators and optionally selecting and applying of one or more conditions, rules, preferences, settings for identifying or matching or searching and presenting visual media or content items which were generated from that particular location or place or POI or spot or point or matched pre-defined geo-fence(s) and related to said user supplied one or more keywords or key phrases and Boolean operates including AND, OR, NOT and brackets. So user is enabled to view contextual stories. So user can view contextual photos or videos previously taken at a particular geographic location (e.g.) which are related to or filtered or contextually matched with said user provided one or more keywords, key phrases and/or associated Boolean operators, conditions, advance search criteria, and rules. User can further sort as per date & time or ranges of date & time, types of sources or one or more particular sources or identified or selected or defined sources, type of visual media or content including photo and/or video, most reacted including most viewed, most rated, most liked, least disliked, most commented, most re-shared, apply safe search, apply omit duplicate visual media or content item, select presentation type, apply view interval duration between two visual media items in sequence of auto presenting of visual media items based on said pre-set interval duration. In another embodiment user can visually define ontology or semantic syntax including providing or selecting categories, sub-categories, taxonomy, keywords and visually defining or providing one or more types of one or more relationships.

FIG. 71 illustrates an example system for enabling a user to request on-demand services using a computing device, under an embodiment.

FIG. 72 illustrates exemplary interface for enabling user to provide and consume visual media taker's service or user to user photographer service. User can select on map particular visual media taker and send request or send request to identify and consume nearest or matched or ranked visual media taker service provider(s) i.e. user who capture photo or record video of user and in the event of acceptance of request of user by the visual media taker, requestor user is notified about visual media taker. Visual media taker starts capturing of one or more photos or recording one or more videos and sends to visual media taker service consumer user and in the event of acceptance of received photo(s) or video(s), system adds points to account of visual media capturing service provider user and deduct points from visual media capturing service consumer.

FIG. 73 illustrates processing operations associated with display of ephemeral messages and media item based on identification of read or unread or viewed or not viewed status or based on identification or read or unread or viewed or not viewed status and associated life time of message in accordance with an embodiment of the invention.

FIG. 74 illustrates processing operations associated with display of ephemeral messages and media item based on identification of mark as ephemeral message(s) or mark as non-ephemeral message(s) status and message associated pre-set duration of timer in accordance with an embodiment of the invention.

FIG. 75 illustrates processing operations associated with display of next ephemeral message and media item based on identification of removing or saving of said presented message or display of next ephemeral message and media item based on identification of removing or saving or expiration of said presented message associated pre-set duration timer in accordance with an embodiment of the invention.

FIG. 76 illustrates user interface for enabling publisher or advertiser or user to create mass user action one or more types of campaign(s) including mobile application installation, deals, offers, advertisements etc. and select available time slot (date & time and length of duration and in the event of expiry of said pre-set duration present next one or more types of content item(s) and associated one or more types of action(s) (if any)) for presenting said created mass user action and associated content e.g. present group deal information with present associated user action e.g. buy or participate or sign group deals, present movie trailer and enable to view, like, provide comments, reviews & ratings, present details of mobile application and enable to download, install, & register, present survey forms and enable to fill-up survey and get gift within said pre-set duration of time.

FIGS. 77-79 illustrates user interface for enabling user to provide details about user's scheduled or day to day general activities, events, to-dos, meetings, appointments, tasks and available date & time range(s) for conducting of other activities and/or system auto identifies user's available date & time range(s) based on provided data and user related data for conducting of other activities and provides each available date & time range(s) specific suggested list of contextual activities.

FIG. 80 illustrates an electronic device includes digital image sensors to capture visual media, a display to present the visual media from the digital image sensors and a touch controller to identify haptic contact engagement, haptic contact persistence and haptic contact release on the display. A visual media capture controller alternately records the visual media as a photograph or a video based on pre-defined haptic contact engagement duration threshold. If threshold not exceeded then photo captured and if threshold exceeded then starting of video recording and if pre-set associated timer expired then stop video and store video and if not expired and receiving of haptic contact engagement on icon or display then stop said pre-defined video duration timer and stop video recording and save recorded video.

FIG. 81 illustrates processing operations associated with display of index or indicia or list item(s) or inbox list of items or search result item(s) or thumbnails of requested or searched or subscribed or auto presented or received digital item(s) or thumbnails or thumbshot or small representation of ephemeral message(s) or visual media item(s) including photo or video or content item(s) or post(s) or news item(s) or story item(s) for user selection based on type of feed (discussed throughout the specification), user is presented with said selection specific original version of ephemeral message(s) or content item(s) or visual media item(s) and starts timer associated with one or more or set of messages 8154 and in the event of expiry of timer or receiving of haptic contact engagement or recognizing or detection of one or more types of pre-defined user sense on message or on feed or set of message(s), remove presented messages on the display and proceed to present index or list item(s) or thumbnails or thumbshot of ephemeral message(s) (if any) for further selection in accordance with an embodiment of the invention in accordance with an embodiment of the invention.

FIG. 82 illustrates user interface for creating one or more types of feeds, posting of one or more types of one or more content items or visual media items in selected one or more types of said created feeds and also enabling to follow of one or more types of feeds of one or more users of network for receiving of posted messages from followed users' followed one or more types of feeds in said received message associated type of feed or tab or categories presentation interface.

FIG. 83-84 illustrates exemplary interface for providing settings for allowing system to, monitoring, tracking, storing and analyzing, applying rules, extracting or identifying or recognizing plurality of keywords, key phrases, categories, ontology provided by user and/or from one or more types of user data including from one or more types of detail user profiles, monitored or tracked or detected or recognized or sensed or logged or stored activities, actions, status, manual status provided or updated by user, locations or checked-in-places, events, transactions, reactions (liked or disliked or commented contents), sharing (one or more types of visual media or contents), viewing (one or more types of visual media or contents), reading, listing, communications, collaborations, interactions, following, participations, behavior and senses from one or more sources, domain or subject or activities specific contextual survey structured (fields and values) or un-structured forms, devices, sensors, accounts, profiles, domains, storage mediums or databases, web sites, applications, services or web services, networks, servers and user connections, contacts, groups, networks, relationships and followers. User is also enable to provide categories, sub-categories or taxonomy and provided one or more keywords and mention relationships. Based on plurality of accumulated categories, sub-categories, taxonomy and associated keywords or key phrases or based on identifying keywords or key phrases, system can matched said keywords with stored one or more types of visual media or content items associated recognized or identified and stored keywords or dictionary of keywords and select, apply and execute one or more rules from rule base to search, match, recognize and identify user related matched, relevant and contextual visual media or content item(s) for continuously creating, updating, generating and providing or presenting or serving one or more types of story or gallery or feed or series of sequences of visual media or content items. Based on monitoring, tracking and soring user's viewing behavior including liked, disliked, rated, commented, re-shared, bookmarked, number of times viewed, skipped, most liked sources, system further identifies and filters providing of contextual visual media or content items to user subsequently.

FIG. 85 (A) illustrates user interface for enabling user to scan and view suggested keywords based on scan for enabling user to add to user's collection of keywords or add to user's collection of keywords & share with contact(s). FIG. 85 (B) illustrates user interface for enabling user to view suggested keywords based on recognition of keywords from recorded user's voice for enabling user to add to user's collection of keywords or add to user's collection of keywords & share with contact(s). FIG. 85 (C) illustrates user interface for enabling user to view user's current location or checked-in place specific suggested keywords for enabling user to add to user's collection of keywords or add to user's collection of keywords & share with contact(s).

FIG. 86 (A) illustrates user interface for enabling user to scan one or more types of barcode or code including QRcode and view suggested keywords based on scan of code for enabling user to add to user's collection of keywords or add to user's collection of keywords & share with contact(s). FIG. 86 (B) illustrates user interface for enabling user to view suggested keywords based on recognition of user's eye view of particular object or scene or code via one or more types of wearable device including eye glasses or digital spectacles equipped with video camera and connected with user device(s) including smart phone for enabling user to add selected keywords from suggested keywords to user's collection of keywords or add to user's collection of keywords & share with contact(s).

FIG. 87 (A) illustrates user interface for enabling user to input keywords and/or associated one or more types of user actions, relationships, status, activities, actions, events, senses, interaction, status, location or place, connection, and communication by user and add to user related collection of keywords or add to user related collection of keywords and share with one or more types of one or more contacts and/or destinations. FIG. 87 (B) illustrates user interface for enabling user to view user's current status (manual or auto identified) specific suggested keywords for enabling user to add to user's collection of keywords or add to user's collection of keywords & share with contact(s). FIG. 87 (C) illustrates user interface for enabling user to select one or more categories, select or select from suggested keywords or input one or more keywords and/or associated one or more types of user actions, relationships, status, activities, properties, attributes, selected or added field(s) and associated value(s), actions, events, senses, interaction, status, location or place, connection, and communication by user and add to user related collection of keywords or add to user related collection of keywords and share with one or more types of one or more contacts and/or destinations. FIG. 87 (D) illustrates user interface for enabling user to suggested keywords including advertised keywords (discuss in detail in FIGS. 91-98) based on one or more types of updated user data for enabling user to add to user's collection of keywords or add to user's collection of keywords & share with contact(s).

FIG. 88 (A) illustrates user interface for enabling user to view user's current location or checked-in place related nearby places & locations and/or user data specific suggested keywords (e.g. brands, products, services, activities type specific etc.) for enabling user to add to user's collection of keywords or add to user's collection of keywords & share with contact(s). FIG. 88 (B) illustrates user interface for enabling user to view suggested keywords provided by user's one or more contacts or suggested by contextual or related or interacted or liked or currently visited or visiting advertisers, sellers, merchants, places, shops, service providers, point of interest, hotels, restaurants etc. for enabling user to add to user's collection of keywords or add to user's collection of keywords & share with contact(s). FIG. 88 (C) illustrates user interface for enabling user to provide user details via one or more types of profiles or forms, search and select or use auto presented one or more categories templates or forms for providing domain or subject or field or category or activity specific keywords, relationships, type of user action, provide user preferences for suggesting keywords to user, and enable to create, update, add in selected domain or subject or activity type specific user ontology (ies). FIG. 88 (D) illustrates user interface for enabling user to input multiple keywords including keywords and associated one or more types of user actions, relationships, status, activities, actions, events, senses, interaction, status, location or place, connection, and communication and add to user related collection of keywords or add to user related collection of keywords and share with one or more types of one or more contacts and/or destinations.

FIG. 89 (A) illustrates user interface for enabling user to search and select location or place on map and search, select, input and add from suggested list of keywords. FIG. 89 (B) illustrates user interface for enabling user to view suggested local keywords based on one or more types of user related addresses. FIG. 89 (C) illustrates user interface for enabling user to view one or more types of received notifications. FIG. 89 (D) illustrates user interface for enabling user to add keywords from 3^{rd} parties' web sites and applications integrated by 3^{rd} parties' web sites and applications and provided by server 110, advertisers and 3^{rd} parties' web sites and applications.

FIG. 90 (A) illustrates user interface for enabling user to view suggested keywords related to user selected keywords and enabling user to add to user's collection of keywords or add to user's collection of keywords & share with contact(s). FIG. 90 (B) illustrates user interface for enabling user to view user related keywords and take one or more user actions from provide contextual user actions. FIG. 90 (C) illustrates user interface for enabling user to view suggested structured form(s) or template(s) or field(s) or questions based on user's scan of object or code, recording of voice, view object via eye glasses, supplied object model, status, current location, checked-in place, and status and enable to provide associated value(s) or answers or details and enabling user to add to user's collection of keywords or add to user's collection of keywords & share with contact(s). FIG. 90 (D) illustrates user interface for enabling user to provide various settings.

FIG. 91 illustrates user interface for enabling advertiser or publisher user to create campaign(s), set budget, and provide target user criteria, location criteria, schedule and other settings.

FIG. 92 illustrates user interface for enabling advertiser or publisher user to create and manage campaign related advertisement group(s), advertisement (s), advertisement related advertised keywords, associate type of relationships, user actions, categories, & hashtags, associate one or more user action controls or links or applications or interfaces or media, provide target keywords, and object criteria.

FIG. 93 illustrates user interface for enabling advertiser or publisher user to show keyword advertisement(s) to/at/in one or more selected features.

FIG. 94 illustrates user interface for enabling user to search, match, select, create, update, suggest, generate one or more user related customized and configured categories templates for providing presented or selected one or more fields specific one or more types of values including brand name, product name, service name, one or more types of entity name, user actions or reactions or relationships.

FIG. 95-96 illustrates user interface for enabling user to provide one or more types of profiles related structured as well as un-structured details.

FIG. 97 illustrates user interface for enabling user to provide preferences for receiving suggested keywords.

FIG. 98 illustrates user interface for enabling user to search, browse categories directories and select one or more keywords and add to user related collections of keywords or add to user related collections of keywords and share with one or more contacts and/or destinations.

FIG. 99 illustrates user interface for enabling user to create, provide, update and suggest user related simplified ontology(ies) or similar to ontology(ies), wherein system interpreted said simplified ontology(ies) based on one or more keywords, structured details including auto presented contextual or added or suggested one or more fields (or set of categories or activity specific fields via forms and templates or questionnaire) specific one or more data types specific values or data or details, associate types, categories, types & name of entities, activities, actions, events, transactions, status, locations, places, requirements, sharing, participations, reactions, tasks.

FIG. 100 illustrates user interface for enabling user to accelerate mode video talking with one or more users or contacts. A user can instant starts and stops and again restarts and stops video talking instantly. Based on voice command, if user device is OFF then system makes it auto ON and user is auto presented with front camera display screen for enabling user to instantly start video talking. Server connects with user's contact based on recognizing said voice command related user's contact and stores said started video talk related incremental video stream at relay server. In the event of successful connection both can starts video talking with each other. In the event of delay in making connection server presents said recorded video first. In the event of non-establishment of connection between video talk started user and called user, server presents system message or called user's status to caller and sent said recorded video message of caller user to called user, so called user can view and issue voice command to connect with said user. In the event of providing voice command for ending of video talk or in the event of non-receiving of user's voice for pre-set duration, system makes caller and called users device OFF and hide or close loaded & presented video interface to stop video talking with each other. Like natural face to face talk, user can talk sometime and again stop, then again talk, busy sometime and pause talking and again talk in the event of availability of users. So hands free starting and stopping or restarting video talking makes user feels like natural talking.

FIG. 101 is a block diagram that illustrates a mobile computing device upon which embodiments described herein may be implemented.

While the invention is described herein by way of example for several embodiments and illustrative drawings, those skilled in the art will recognize that the invention is not limited to the embodiments or drawings described. It should be understood, that the drawings and detailed description thereto are not intended to limit the invention to the particular form disclosed, but on the contrary, the intention is to cover all modifications, equivalents and alternatives falling within the spirit and scope of the present invention. The headings used herein are for organizational purposes only and are not meant to be used to limit the scope of the description. As used throughout this application, the word “may” is used in a permissive sense (e.g., meaning having the potential to), rather than the mandatory sense (e.g., meaning must). Similarly, the words “include”, “including”, and “includes” mean including, but not limited to.

### DETAILED DESCRIPTION OF THE INVENTION

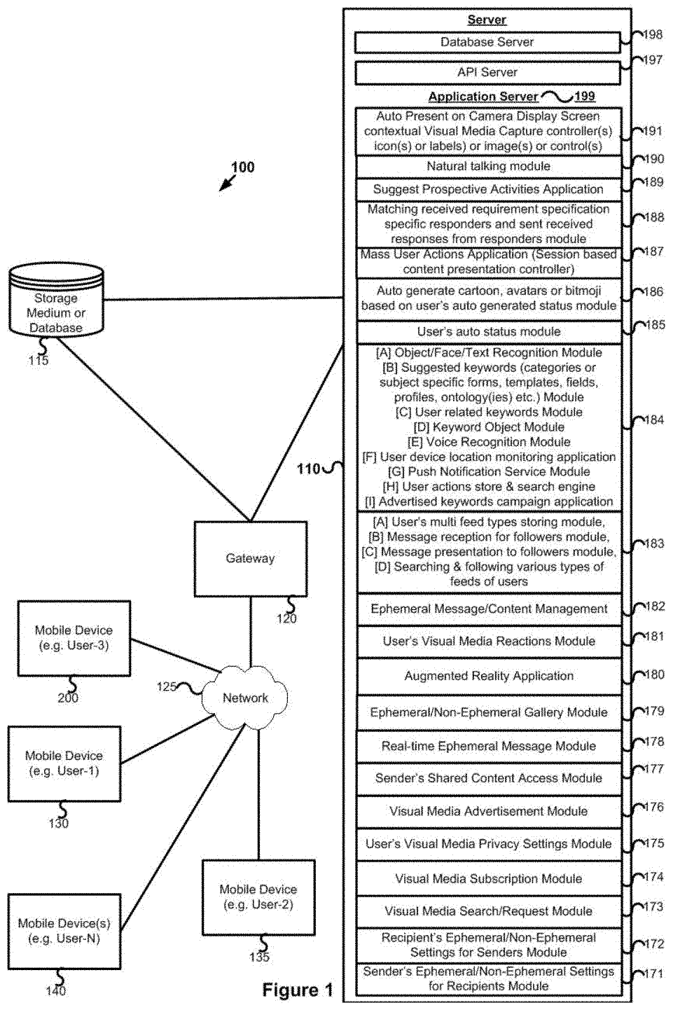

FIG. 1 is a network diagram depicting a network system 100 having a client-server architecture configured for exchanging data over a network, according to one embodiment. For example, the network system 100 may be a messaging system where clients may communicate and exchange data within the network system 100. The data may pertain to various functions (e.g., sending and receiving ephemeral or non-ephemeral messages, logging, user activities, actions, events, transactions, senses, behavior, status, receiving user profile, privacy settings, preferences, access conditions & rules, ephemeral settings, rules & conditions, sensor data from one or more types of user device sensors, indications or notifications, text and media communication, media items, and receiving search query including keywords, rules, preferences & Boolean operators, object criteria including object models, keywords & conditions, search result, supplied object criteria and target criteria specific visual media advertisements, created configuration of gallery or story or event, configuration of visual media capture controller, scanned object, supplied scanned objects and associated user actions or controls or interfaces or applications, user actions or controls or interfaces or applications from 3^{rd} parties developers or providers for augment reality platform or portal or service, provided schedules, user related keywords) associated with the network system 100 and its users. Although illustrated herein as client-server architecture, other embodiments may include other network architectures, such as peer-to-peer or distributed network environments.

A platform, in an example, includes a server 110 which includes various applications describe in detail in 236, and may provide server-side functionality via a network 125 (e.g., the Internet) to one or more clients. The one or more clients may include users that utilize the network system 100 and, more specifically, the server applications 236, to exchange data over the network 125. These operations may include transmitting, receiving (communicating), and processing data to, from, and regarding content and users of the network system 100. The data may include, but is not limited to, content and user data such as shared or broadcasted visual media, user profiles, user status, user location or checked-in place, search queries, saved search results or bookmarks, privacy settings, preferences, created events, feeds, stories related settings & preferences, user contacts, connections, groups, networks, opt-in contacts, followed feeds, stories & hashtag, following users & followers, user logs of user's activities, actions, events, transactions messaging content, shared or posted contents or one or more types of media including text, photo, video, edited photo or video e.g. applied one or more photo filters, lenses, emoticons, overlay drawings or text, messaging attributes or properties, media attributes or properties, client device information, geolocation information, and social network information, among others.

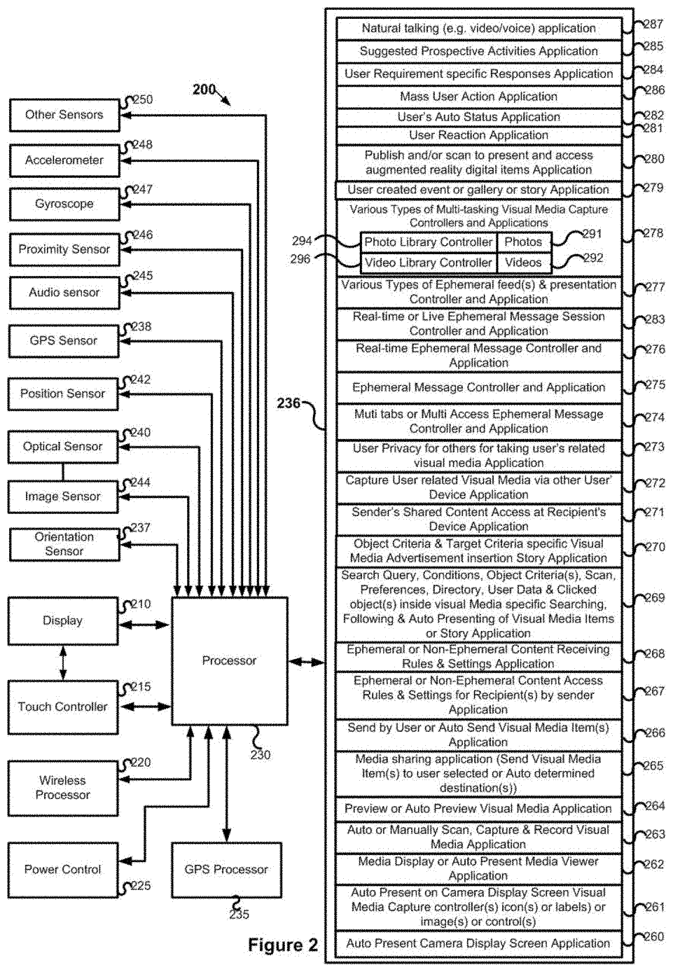

In various embodiments, the data exchanges within the network system 100 may be dependent upon user-selected functions available through one or more client or user interfaces (UIs). The UIs may be associated with a client machine, such as mobile devices or one or more types of computing device 130, 135, 140. The mobile devices e.g. 130 and 135 may be in communication with the server application(s) 236 via an application server 199. The mobile devices e.g. 130, 135 include wireless communication components, and audio and optical components for capturing various forms of media including photos and videos as described with respect to FIG. 2.

The server messaging application 236, an application program interface (API) server is coupled to, and provides programmatic interface to the application server 199. The application server 199 hosts the server application(s) 236. The application server 199 is, in turn, shown to be coupled to one or more database servers 198 that facilitate access to one or more databases 199.

The Application Programming Interface (API) server 110 communicates and receives data pertaining to visual media, user profile, preferences, privacy settings, presentation settings, user data, search queries, user actions or controls from 3^{rd} parties developers, providers, servers, networks, applications, devices & storage mediums, notifications, ephemeral or non-ephemeral messages, media items, and communications, among other things, via various user input tools. For example, the API server 197 may send and receive data to and from an application running on another client machine (e.g., mobile devices 130, 135, 140 or one or more types of computing devices or a third party server).

The server application(s) 236 provides messaging mechanisms for users of the mobile devices e.g. 130, 135 to send messages that include ephemeral or non-ephemeral messages or text and media items or contents such as pictures and video and search request, subscribe or follow request, request to access search query based feeds, and stories. The mobile devices 130, 135 can access and view the messages from the server application(s) 236. The server application(s) 236 may utilize any one of a number of message delivery networks and platforms to deliver messages to users. For example, the messaging application(s) 236 may deliver messages using electronic mail (e-mail), instant message (IM), Push Notifications, Short Message Service (SMS), text, facsimile, or voice (e.g., Voice over IP (VoIP)) messages via wired (e.g., the Internet), plain old telephone service (POTS), or wireless networks (e.g., mobile, cellular, WiFi, Long Term Evolution (LTE), Bluetooth).

FIG. 1 illustrates an example platform, under an embodiment. According to some embodiments, system 100 can be implemented through software that operates on a portable computing device, such as a mobile computing device 110. System 100 can be configured to communicate with one or more network services, databases, objects that coordinate, orchestrate or otherwise provide advertised contents of each user to other users of network. Additionally, the mobile computing device can integrate third-party services which enable further functionality through system 100.

The system for enabling users to use platform for auto or manually or via auto presented or selected or configured one or more types of one or more multi-tasking visual media capture, view controllers capturing, recording, previewing real-time or non-real-time sending ephemeral or non-ephemeral one or more type of visual media or content items at one or more types of ephemeral or non-ephemeral feds, galleries, applications & stories including capture photo(s) or record video(s) or broadcast live stream or draft post(s) and share with auto identified contextual one or more types of one or more destinations or entities or selected one or more types of destinations including one or more contacts, groups, networks, feeds, stories, categories, hashtags, servers, applications, services, networks, devices, domains, web sites, web pages, user profiles and storage mediums. Various embodiments of system also enables user to create events or groups, so invited participants or presented members at particular place or location can share media including photos and videos with each other. The system also enabling user to create, save, bookmark, subscribe and view one or more object criteria including provided object model(s) or sample image(s), identified object(s) related keywords, object conditions including exact match, similar, pattern matched specific searched or matched series of one or more types of media or contents including photo, video, voice, text & like. The system also enabling user to display ephemeral messages in real-time or via sensors and/or timers or in tabs. The system also enabling sender of media to access media shared by sender at recipient device including add, remove, edit & update shared media at recipient's device or application or gallery or folder. There is plurality of embodiments described in detail in Figures details of the specifications. While FIG. 1 illustrates a gateway 120, a database 115 and a server 110 as separate entities, the illustration is provided for example purposes only and is not meant to limit the configuration of the system. In some embodiments, gateway 120, database 115 and server 110 may be implemented in the system as separate systems, a single system, or any combination of systems.

As illustrated in FIG. 1, the system may include a posting or sender user device or mobile devices 130/140 and viewing or receiving user device or mobile devices 135. Devices or Mobile devices 130/140/135 may be particular set number of or an arbitrary number of devices or mobile devices which may be capable of capturing, recording, previewing, posting, sharing, publishing, broadcasting, advertising, notifying, sensing, sending, presenting, searching, matching, accessing and managing shared contents or visual media or content items. Each device or mobile device in the set of posting or sending or broadcasting or advertising or sharing user(s) 130/140 and viewing ore receiving user(s) device or mobile devices 135/140 may be configured to communicate, via a wireless connection, with each one of the other mobile devices 130/140/135. Each one of the mobile devices 130/140/135 may also be configured to communicate, via a wireless connection, to a network 125, as illustrated in FIG. 1. The wireless connections of mobile devices 130/140/135 may be implemented within a wireless network such as a Bluetooth network or a wireless LAN.

As illustrated in FIG. 1, the system may include gateway 120. Gateway 120 may be a web gateway which may be configured to communicate with other entities of the system via wired and/or wireless network connections. As illustrated in FIG. 1, gateway 120 may communicate with mobile devices 130/140/135 via network 125. In various embodiments, gateway 120 may be connected to network 125 via a wired and/or wireless network connection. As illustrated in FIG. 1, gateway 120 may be connected to database 115 and server 110 of system. In various embodiments, gateway 120 may be connected to database 115 and/or server 110 via a wired or a wireless network connection.

Gateway 120 may be configured to send and receive user contents or posts or data to targeted or prospective, matched & contextual viewers based on preferences, wherein user data comprises user profile, user connections, connected users' data, user shared data or contents, user logs, activities, actions, events, senses, transactions, status, updates, presence information, locations, check-in places and like) to/from mobile devices 130/140/135. For example, gateway 120 may be configured to receive posted contents provided by posting users or publishers or content providers to database 115 for storage.

As another example, gateway 120 may be configured to send or present posted contents to contextual viewers stored in database 115 to mobile devices 130/140/135. Gateway 120 may be configured to receive search requests from mobile devices 130/140/135 for searching and presenting posted contents.

For example, gateway 120 may receive a request from a mobile device and may query database 115 with the request for searching and matching request specific matched posted contents, sources, followers, following users and viewers. Gateway 120 may be configured to inform server 110 of updated data. For example, gateway 120 may be configured to notify server 110 when a new post has been received from a mobile device or device of posting or publishing or content broadcaster(s) or provider(s) stored on database 115.

As illustrated in FIG. 1, the system may include a database, such as database 115. Database 115 may be connected to gateway 120 and server 110 via wired and/or wireless connections. Database 115 may be configured to store a database of registered user's profile, accounts, posted or shared contents, followed updated keyword(s), key phrase(s), named entities, nodes, ontology, semantic syntax, categories & taxonomies, user data, payments information received from mobile devices 130/140/135 via network 125 and gateway 120.

Database 115 may also be configured to receive and service requests from gateway 120. For example, database 115 may receive, via gateway 120, a request from a mobile device and may service the request by providing, to gateway 120, user profile, user data, posted or shared contents, user followers, following users, viewers, contacts or connections, user or provider account's related data which meet the criteria specified in the request. Database 115 may be configured to communicate with server 110.

As illustrated in FIG. 1, the system may include a server, such as server 110. Server may be connected to database 115 and gateway 120 via wired and/or wireless connections. As described above, server 110 may be notified, by gateway 120, of new or updated user profile, user data, user posted or shared contents, user followed updated keyword(s), key phrase(s), named entities, nodes, ontology, semantic syntax, categories & taxonomies & various types of status stored in database 115.

FIG. 1 illustrates a block diagram of a system configured to implement the various embodiments including system identifies user intention to take photo or video and automatically invokes, open and show camera display screen so user is enable to capture photo or video without each time manually open camera application. In another embodiment system identifies user's intention to view media and show interface to view media. In an another embodiment system enables user to create events so invited participants or presented members at particular place or location can share media including photos and videos with each other. In an another embodiment system enables user to create, save, bookmark, subscribe and view one or more object criteria including provided object model(s) or sample image(s), identified object(s) related keywords, object conditions including exact match, similar, pattern matched specific searched or matched series of one or more types of media or contents including photo, video, voice, text & like. In another embodiment system also enables to display of ephemeral messages in real-time or via sensors and/or timers or in tabs. In an embodiment system enables sender of media to access media shared by sender at recipient device including add, remove, edit & update shared media at recipient's device or application or gallery or folder. There is plurality of other embodiments described in Figures details of the specifications. While FIG. 1 illustrates a gateway 120, a database 115 and a server 110 as separate entities, the illustration is provided for example purposes only and is not meant to limit the configuration of the system. In some embodiments, gateway 120, database 115 and server 110 may be implemented in the system as separate systems, a single system, or any combination of systems.

The server 110 stores database server 198, API server 197 and application server 199 which stores Sender's Ephemeral/Non-Ephemeral Settings for Recipients Module 171, Recipient's Ephemeral/Non-Ephemeral Settings for Senders Module 172, Visual Media Search/Request Module 173, Visual Media Subscription Module 174, User's Visual Media Privacy Settings Module 175, Visual Media Advertisement Module 176, Sender's Shared Content Access Module 177, Real-time Ephemeral Message Module 178, Ephemeral/Non-Ephemeral Gallery Module 179, Augmented Reality Application 180, User's Visual Media Reactions Module 181, Ephemeral Message/Content Management 182, User's multi feed types storing module 183 [A], Message reception for followers module 183 [B], Message presentation to followers module 183 [B], Searching & following various types of feeds of users 183 [D], Object/Face/Text Recognition Module 184 [A], Suggested keywords (categories or subject specific forms, templates, fields, profiles, ontology(ies) etc.) Module 184 [B], User related keywords Module 184 [C], Keyword Object Module 184 [D], Voice Recognition Module 184 [E], User device location monitoring application 184 [F], Push Notification Service Module 184 [G], User actions store & search engine 184 [H], Advertised keywords campaign application 184 [I], User's auto status module 185, Auto generate cartoon, avatars or bitmoji based on user's auto generated status module 186, Mass User Actions Application (Session based content presentation controller) 187, Matching received requirement specification specific responders and sent received responses from responders module 188, Suggest Prospective Activities Application 189, Natural talking module 190, Auto Present on Camera Display Screen contextual Visual Media Capture controller(s) icon(s) or labels) or image(s) or control(s) 191 to implement operations of various embodiments of the invention and may include executable instructions to access a client device which coordinates operations disclosed herein. Alternately, may include executable instructions to coordinate some of the operations disclosed herein, while the client device implements other operations.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an Auto Present Camera Display Screen 260 to implement operations of one of the embodiment of the invention. The Auto Present Camera Display Screen 260 may include executable instructions to access a client device and/or a server which coordinates operations disclosed herein. Alternately, the Auto Present Camera Display Screen 260 may include executable instructions to coordinate some of the operations disclosed herein, while the server implements other operations.

The memory 236 stores an Auto Present on Camera Display Screen Visual Media Capture controller(s) icon(s) or labels) or image(s) or control(s) 261 to enabling user to one tap capture photo or record video, preview for pre-set duration and manually select destination(s) and send or auto send to auto determined destination(s) to implement operations of another embodiment of the invention. The Auto Present on Camera Display Screen Visual Media Capture controller(s) icon(s) or labels) or image(s) or control(s) 261 may include executable instructions to access a server which coordinates operations disclosed herein. Alternately, the Auto Present on Camera Display Screen Visual Media Capture controller(s) icon(s) or labels) or image(s) or control(s) 261 may include executable instructions to coordinate some of the operations disclosed herein, while the server implements other operations.

The memory 236 stores Auto Present Media Viewer Application 262 to implement operations of one of the embodiment of the invention. The Auto Present Media Viewer Application 262 may include executable instructions to access a client device and/or server which coordinates operations disclosed herein. Alternately, the Auto Present Media Viewer Application 262 may include executable instructions to coordinate some of the operations disclosed herein, while the server implements other operations.

The memory 236 stores an Auto or Manually Capture Visual Media Application 263 to implement operations of one of the embodiment of the invention. The Auto or Manually Capture Visual Media Application 263 may include executable instructions to access a client device and/or a server which coordinates operations disclosed herein. Alternately, the Auto or Manually Capture Visual Media Application 263 may include executable instructions to coordinate some of the operations disclosed herein, while the server implements other operations.

The memory 236 stores a Preview or Auto Preview Visual Media Application 264 to implement operations of one of the embodiment of the invention. The Preview or Auto Preview Visual Media Application 264 may include executable instructions to access a client device and/or a server which coordinates operations disclosed herein. Alternately, the Preview or Auto Preview Visual Media Application 264 may include executable instructions to coordinate some of the operations disclosed herein, while the server implements other operations.

The memory 236 stores an Media sharing application (Send Visual Media Item(s) to user selected or Auto determined destination(s)) 265 to implement operations of one of the embodiment of the invention. The Media sharing application (Send Visual Media Item(s) 265 to user selected or Auto determined destination(s)) 265 may include executable instructions to access a client device and/or a server which coordinates operations disclosed herein. Alternately, the Media sharing application (Send Visual Media Item(s) to user selected or Auto determined destination(s)) 265 may include executable instructions to coordinate some of the operations disclosed herein, while the server implements other operations.

The memory 236 stores a Send by User or Auto Send Visual Media Item(s) Application 266 to implement operations of one of the embodiment of the invention. The Send by User or Auto Send Visual Media Item(s) Application 266 may include executable instructions to access a client device and/or a server which coordinates operations disclosed herein. Alternately, the Send by User or Auto Send Visual Media Item(s) Application 266 may include executable instructions to coordinate some of the operations disclosed herein, while the server implements other operations.

The memory 236 stores an Ephemeral or Non-Ephemeral Content Access Rules & Settings for Recipient(s) by sender Application 267 to implement operations of one of the embodiment of the invention. The Ephemeral or Non-Ephemeral Content Access Rules & Settings for Recipient(s) by sender Application 267 may include executable instructions to access a client device and/or a server which coordinates operations disclosed herein. Alternately, the Ephemeral or Non-Ephemeral Content Access Rules & Settings for Recipient(s) by sender Application 267 may include executable instructions to coordinate some of the operations disclosed herein, while the server implements other operations.

The memory 236 stores an Ephemeral or Non-Ephemeral Content Receiving Rules & Settings Application 268 to implement operations of one of the embodiment of the invention. The Ephemeral or Non-Ephemeral Content Receiving Rules & Settings Application 268 may include executable instructions to access a client device and/or a server which coordinates operations disclosed herein. Alternately, the Ephemeral or Non-Ephemeral Content Receiving Rules & Settings Application 268 may include executable instructions to coordinate some of the operations disclosed herein, while the server implements other operations.

The memory 236 stores a Search Query, Conditions, Object Criteria(s), Scan, Preferences, Directory, User Data & Clicked object(s) inside visual Media specific Searching, Following & Auto Presenting of Visual Media Items or Story Application 269 to implement operations of various embodiments of the invention. The Search Query, Conditions, Object Criteria(s), Scan, Preferences, Directory, User Data & Clicked object(s) inside visual Media specific Searching, Following & Auto Presenting of Visual Media Items or Story Application 269 may include executable instructions to access a client device and/or a server which coordinates operations disclosed herein. Alternately, the Search Query, Conditions, Object Criteria(s), Scan, Preferences, Directory, User Data & Clicked object(s) inside visual Media specific Searching, Following & Auto Presenting of Visual Media Items or Story Application 269 may include executable instructions to coordinate some of the operations disclosed herein, while the server implements other operations.

The memory 236 stores an Object Criteria & Target Criteria specific Visual Media Advertisement insertion Story Application 270 to implement operations of one of the embodiment of the invention. The Object Criteria & Target Criteria specific Visual Media Advertisement insertion Story Application 270 may include executable instructions to access a client device and/or a server which coordinates operations disclosed herein. Alternately, the Object Criteria & Target Criteria specific Visual Media Advertisement insertion Story Application 270 may include executable instructions to coordinate some of the operations disclosed herein, while the server implements other operations.

The memory 236 stores a Sender's Shared Content Access at Recipient's Device Application 271 to implement operations of one of the embodiment of the invention. The Sender's Shared Content Access at Recipient's Device Application 271 may include executable instructions to access a client device and/or a server which coordinates operations disclosed herein. Alternately, the Sender's Shared Content Access at Recipient's Device Application 271 may include executable instructions to coordinate some of the operations disclosed herein, while the server implements other operations.

The memory 236 stores a Capture User related Visual Media via other User' Device Application 272 to implement operations of one of the embodiment of the invention. The Capture User related Visual Media via other User' Device Application 272 may include executable instructions to access a client device and/or a server which coordinates operations disclosed herein. Alternately, the Capture User related Visual Media via other User' Device Application 272 may include executable instructions to coordinate some of the operations disclosed herein, while the server implements other operations.

The memory 236 stores a User Privacy for others for taking user's related visual media Application 273 to implement operations of one of the embodiment of the invention. The User Privacy for others for taking user's related visual media Application 273 may include executable instructions to access a client device and/or a server which coordinates operations disclosed herein. Alternately, the User Privacy for others for taking user's related visual media Application 273 may include executable instructions to coordinate some of the operations disclosed herein, while the server implements other operations.

The memory 236 stores a Muti tabs or Multi Access Ephemeral Message Controller and Application 274 to implement operations of one of the embodiment of the invention. The Muti tabs or Multi Access Ephemeral Message Controller and Application 274 may include executable instructions to access a client device and/or a server which coordinates operations disclosed herein. Alternately, the Muti tabs or Multi Access Ephemeral Message Controller and Application 274 may include executable instructions to coordinate some of the operations disclosed herein, while the server implements other operations.

The memory 236 stores an Ephemeral Message Controller and Application 275 to implement operations of one of the embodiment of the invention. The Ephemeral Message Controller and Application 275 may include executable instructions to access a client device and/or a server which coordinates operations disclosed herein. Alternately, the Ephemeral Message Controller and Application 275 may include executable instructions to coordinate some of the operations disclosed herein, while the server implements other operations.

The memory 236 stores a Real-time Ephemeral Message Controller and Application 276 to implement operations of one of the embodiment of the invention. The Real-time Ephemeral Message Controller and Application 276 may include executable instructions to access a client device and/or a server which coordinates operations disclosed herein. Alternately, the Real-time Ephemeral Message Controller and Application 276 may include executable instructions to coordinate some of the operations disclosed herein, while the server implements other operations.

The memory 236 stores a Various Types of Ephemeral feed(s) Controller and Application 277 to implement operations of various embodiments of the invention. The Various Types of Ephemeral feed(s) Controller and Application 277 may include executable instructions to access a client device and/or a server which coordinates operations disclosed herein. Alternately, the Various Types of Ephemeral feed(s) Controller and Application 277 may include executable instructions to coordinate some of the operations disclosed herein, while the server implements other operations.

The memory 236 stores a Various Types of Multi-tasking Visual Media Capture Controllers and Applications 278 to implement operations of various embodiments of the invention. The Various Types of Multi-tasking Visual Media Capture Controllers and Applications 278 may include executable instructions to access a client device and/or a server which coordinates operations disclosed herein. Alternately, the Various Types of Multi-tasking Visual Media Capture Controllers and Applications 278 may include executable instructions to coordinate some of the operations disclosed herein, while the server implements other operations. FIG. 2 (278) illustrates components of an electronic device implementing single mode visual media capture in accordance with the invention.

The memory 236 stores a User created event or gallery or story Application 279 to implement operations of one of the embodiment of the invention. The User created event or gallery or story Application 279 may include executable instructions to access a client device and/or a server which coordinates operations disclosed herein. Alternately, the User created event or gallery or story Application 279 may include executable instructions to coordinate some of the operations disclosed herein, while the server implements other operations.

The memory 236 stores a Scan to Access Digital Items Application 280 to implement operations of one of the embodiment of the invention. The Scan to Access Digital Items Application 280 may include executable instructions to access a client device and/or a server which coordinates operations disclosed herein. Alternately, the Scan to Access Digital Items Application 280 may include executable instructions to coordinate some of the operations disclosed herein, while the server implements other operations.

The memory 236 stores a User Reaction Application 281 to implement operations of one of the embodiment of the invention. The User Reaction Application 281 may include executable instructions to access a client device and/or a server which coordinates operations disclosed herein. Alternately, the User Reaction Application 281 may include executable instructions to coordinate some of the operations disclosed herein, while the server implements other operations.

The memory 236 stores a User's Auto Status Application 282 to implement operations of one of the embodiment of the invention. The User's Auto Status Application 282 may include executable instructions to access a client device and/or a server which coordinates operations disclosed herein. Alternately, the User's Auto Status Application 282 may include executable instructions to coordinate some of the operations disclosed herein, while the server implements other operations.

The memory 236 stores a Mass User Action Application 286 to implement operations of one of the embodiment of the invention. The Mass User Action Application 286 may include executable instructions to access a client device and/or a server which coordinates operations disclosed herein. Alternately, the Mass User Action Application 286 may include executable instructions to coordinate some of the operations disclosed herein, while the server implements other operations.

The memory 236 stores a User Requirement specific Responses Application 284 to implement operations of one of the embodiment of the invention. The User Requirement specific Responses Application 284 may include executable instructions to access a client device and/or a server which coordinates operations disclosed herein. Alternately, the User Requirement specific Responses Application 284 may include executable instructions to coordinate some of the operations disclosed herein, while the server implements other operations.

The memory 236 stores a Suggested Prospective Activities Application 285 to implement operations of one of the embodiment of the invention. The Suggested Prospective Activities Application 285 may include executable instructions to access a client device and/or a server which coordinates operations disclosed herein. Alternately, the Suggested Prospective Activities Application 285 may include executable instructions to coordinate some of the operations disclosed herein, while the server implements other operations.

The memory 236 stores a Natural talking (e.g. video/voice) application 287 to implement operations of one of the embodiment of the invention. The Natural talking (e.g. video/voice) application 287 may include executable instructions to access a client device and/or a server which coordinates operations disclosed herein. Alternately, the Natural talking (e.g. video/voice) application 287 may include executable instructions to coordinate some of the operations disclosed herein, while the server implements other operations.

The processor 230 is also coupled to image sensors 238. The image sensors 238 may be known digital image sensors, such as charge coupled devices. The image sensors capture visual media, which is presented on display 210. The image sensors 238 capture visual media and present the visual media on the display 210 so that a user can observe the captured visual media.

A touch controller 215 is connected to the display 210 and the processor 230. The touch controller 215 is responsive to haptic signals applied to the display 210.

The electronic device 200 may also include other components commonly associated with a smartphone, such as a wireless signal processor 220 to provide connectivity to a wireless network. A power control circuit 225 and a global positioning system (GPS) processor 235 may also be utilized. While many of the components of FIG. 2 are known in the art, new functionality is achieved through the notification application 260 operating in conjunction with a server.

FIG. 2 shows a block diagram illustrating one example embodiment of a mobile device 200. The mobile device 200 includes an optical sensor 244 or image sensor 238, a Global Positioning System (GPS) sensor 235, a position sensor 242, a processor 230, a storage 236, and a display 210.

The optical sensor 244 includes an image sensor 238, such as, a charge-coupled device. The optical sensor 244 captures visual media. The optical sensor 244 can be used to media items such as pictures and videos.

The GPS sensor 238 determines the geolocation of the mobile device 200 and generates geolocation information (e.g., coordinates including latitude, longitude, aptitude). In another embodiment, other sensors may be used to detect a geolocation of the mobile device 200. For example, a WiFi sensor or Bluetooth sensor or Beacons including iBeacons or other accurate indoor or outdoor location determination and identification technologies can be used to determine the geolocation of the mobile device 200.

The position sensor 242 measures a physical position of the mobile device relative to a frame of reference. For example, the position sensor 242 may include a geomagnetic field sensor to determine the direction in which the optical sensor 240 or the image sensor 244 of the mobile device is pointed and an orientation sensor 237 to determine the orientation of the mobile device (e.g., horizontal, vertical etc.).

The processor 230 may be a central processing unit that includes a media capture application 263, a media display application 262, and a media sharing application 265.

The media capture application 263 includes executable instructions to generate media items such as pictures and videos using the optical sensor 240 or image sensor 244. The media capture application 263 also associates a media item with the geolocation and the position of the mobile device 200 at the time the media item is generated using the GPS sensor 238 and the position sensor 242.

The storage 236 includes a memory that may be or include flash memory, random access memory, any other type of memory accessible by the processor 230, or any suitable combination thereof. The storage 236 stores the media items generated or shared or received by user and also store the corresponding geolocation information, auto identified system data including date & time, auto recognized keywords, metadata, and user provided information. The storage 236 also stores executable instructions corresponding to the Auto Present Camera Display Screen Application 260, the Auto Present on Camera Display Screen Visual Media Capture controller(s) icon(s) or labels) or image(s) or control(s) 261, the Media Display or Auto Present Media Viewer Application 262, the Auto or Manually Capture Visual Media Application 263, the Preview or Auto Preview Visual Media Application 264, the User selected or Auto determine destination(s) for sending Visual Media Item(s) Application 265, the Send by User or Auto Send Visual Media Item(s) Application 266, the Ephemeral or Non-Ephemeral Content Access Rules & Settings for Recipient(s) by sender Application 267, the Ephemeral or Non-Ephemeral Content Receiving Rules & Settings Application 268, the Search Query, Conditions, Object Criteria(s), Scan, Preferences, Directory, User Data & Clicked object(s) inside visual Media specific Searching, Following & Auto Presenting of Visual Media Items or Story Application 269, the Object Criteria & Target Criteria specific Visual Media Advertisement insertion Story Application 270, the Sender's Shared Content Access at Recipient's Device Application 271, the Capture User related Visual Media via other User' Device Application 272, the User Privacy for others for taking user's related visual media Application 273, the Muti tabs or Multi Access Ephemeral Message Controller and Application 274, the Ephemeral Message Controller and Application 275, the Real-time Ephemeral Message Controller and Application 276, the Various Types of Ephemeral feed(s) Controller and Application 277, the Various Types of Multi-tasking Visual Media Capture Controllers and Applications 278, the User created event or gallery or story Application 279, the Scan to Access Digital Items Application 280, and the Scan to Access Digital Items Application 280.

The display 210 includes, for example, a touch screen display. The display 210 displays the media items generated by the media capture application 263. A user captures record and selects media items for sending to one or more selected or auto determined destinations or adding to one or more types of feeds, stories or galleries by touching the corresponding media items on the display 210. A touch controller monitors signals applied to the display 210 to coordinate the capturing, recording, and selection of the media items.

The mobile device 200 also includes a transceiver that interfaces with an antenna. The transceiver may be configured to both transmit and receive cellular network signals, wireless data signals, or other types of signals via the antenna, depending on the nature of the mobile device 200. Further, in some configurations, the GPS sensor 238 may also make use of the antenna to receive GPS signals.

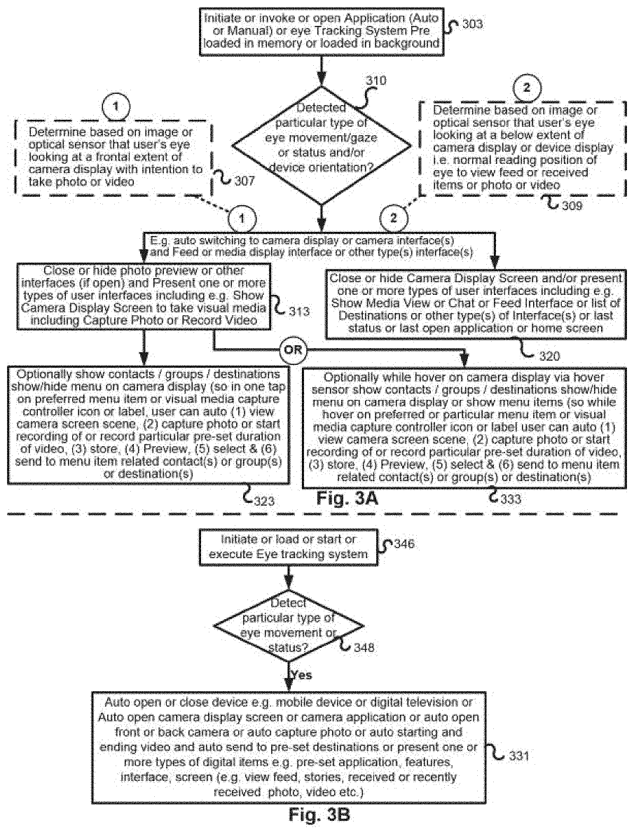

FIG. 3 illustrates an embodiment of a logic flow 300 for the visual media capture system 200 of FIG. 2. The logic flow 300 may be representative of some or all of the operations executed by one or more embodiments described herein.

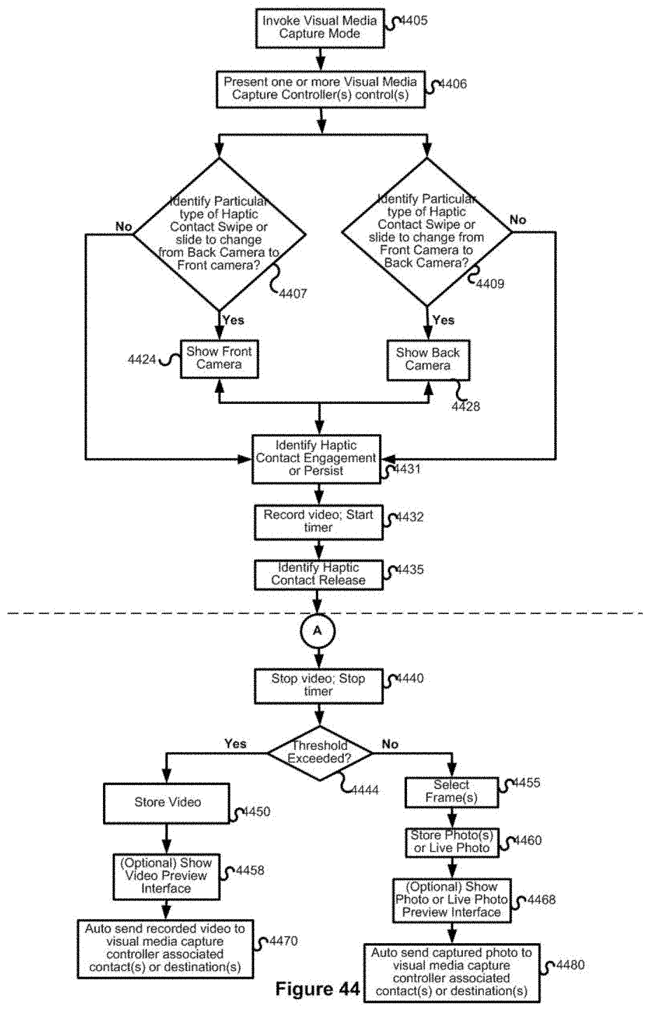

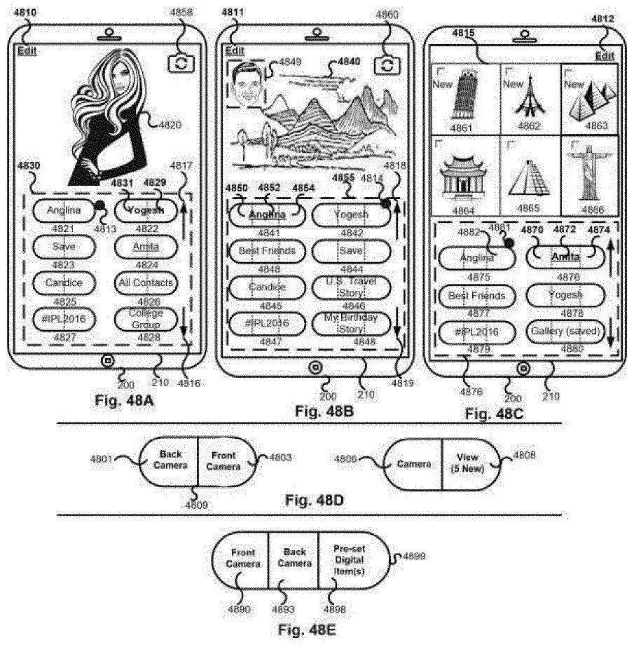

FIG. 3 (A) illustrates processing operations associated with the Auto Present Camera Display Screen Application and/or auto present visual media capture controller 260. Initially an eye tracking system is loaded in memory or loaded in background mode 303, so it can continuously monitor user's eye by using one or more types of image sensors 244 or optical sensors 240 or for example, a user may access an application presented on display 210 to invoke or initiate or open an eye tracking system 303. In an embodiment At 310 an eye tracking system monitors, tracks and recognize user's one or more types of eye movement or eye status or eye position by using one or more types of one or more optical sensors 240 or image sensors 244. In another embodiment at 310 an eye tracking system monitors, tracks and recognize user's one or more types of eye movement or eye status or eye position by using one or more types of one or more optical sensors 240 or image sensors 244 relative to or correspond to display 210 or user device 200 position by employing Accelerometer sensor 248 and/or employing other user device orientation sensors including gyroscope 247 of user device 200. An accelerometer is a sensor which measures the tilting motion and orientation of a mobile phone. At 313 based on determination or recognition of particular type of user's eye movement or eye status or eye position and type of device orientation, for example similar to hold device to see camera display screen i.e. camera view or camera application view for capturing photo or recording video e.g. 460 or 470, auto open camera application or camera display screen to capture photo or record video or take visual media i.e. mobile device is off or lock screen is off and auto o mobile device and auto open mobile camera application to enable user to capture photo or record video without manually on camera device and open camera application to take photo or video. At 320 If an eye tracking system recognize or detects another particular type of user's eye movement or eye status or eye position and type of device orientation, for example similar to hold device to view photos from gallery or album e.g. 480 or 490 then open photo or video view application or gallery or album or one or more types of one or more preconfigured or pre-set application or interface(s). At 323 Optionally preset duration of timer started and in the event of expiry of timer auto capture photo or auto start recording of video up-to end video by user or up-to pre-set maximum duration of video or optionally user is auto presented with one or more visual media capture controller labels or icons on camera display screen or camera screen to within one tap capture photo or record video or record pre-set duration video and auto send to said visual media capture controller associated contact(s) or group of contacts or group(s) discussed in detail in FIGS. 44 and 48 or optionally auto present photo preview interface or video preview interface for pre-set duration to review or cancel or change destination(s) and after expiry of said pre-set duration or preview timer, auto send said captured to said visual media capture controller associated contact(s) or group of contacts or group(s) discussed in detail in FIGS. 44 and 48. At 333 optionally while hover on camera display via hover sensor show contacts/groups/destinations show/hide menu on camera display or show menu items (so while hover on preferred or particular menu item or visual media capture controller icon or label user can auto (1) view camera screen scene, (2) capture photo or start recording of or record particular pre-set duration of video, (3) store, (4) Preview, (5) select & (6) send to menu item related contact(s) or group(s) or destination(s).

In another embodiment FIG. 3 (B) illustrates processing operations associated with the Auto Present Camera Display Screen Application and/or auto present visual media capture controller 260. Initially an eye tracking system is loaded in memory or loaded in background mode 346, so it can continuously monitor user's eye by using one or more types of image sensors 244 or optical sensors 240 or for example, a user may access an application presented on display 210 to invoke or initiate or open an eye tracking system 346. At 348 based on determination or recognition of particular type of user's eye movement or eye status or eye position, at 331 auto open or close device e.g. mobile device or digital television or auto open camera display screen or camera application or present one or more types of digital items e.g. pre-set application, features, interface, screen (e.g. view feed, stories, received or recently received photos, videos.

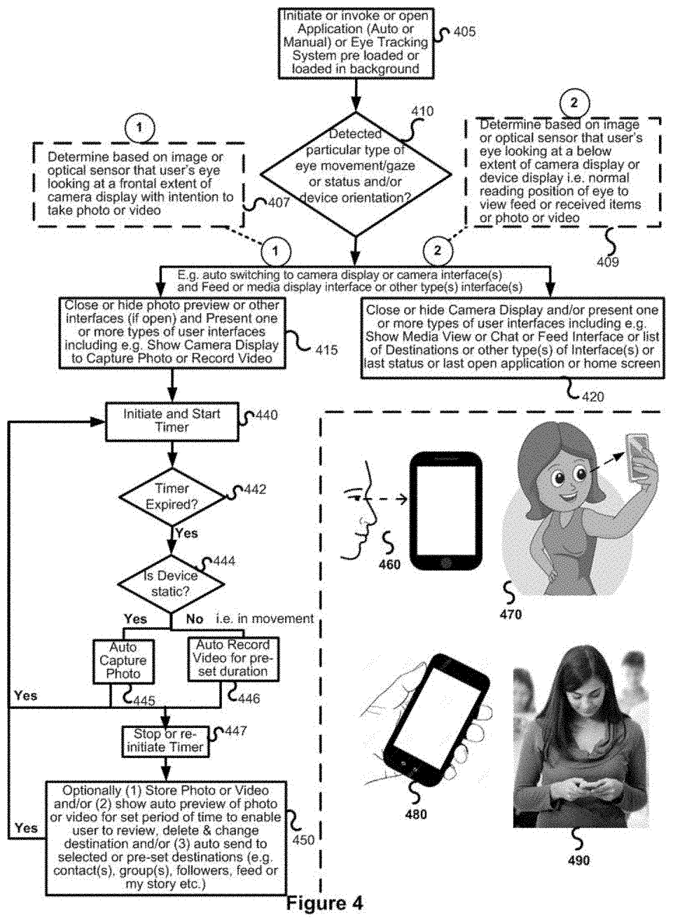

FIG. 4 illustrates processing operations associated with the Auto Present Camera Display Screen Application and/or auto present visual media capture controller 260. Initially an eye tracking system is loaded in memory or loaded in background mode 405, so it can continuously monitor user's eye by using one or more types of image sensors 244 or optical sensors 240 or for example, a user may access an application presented on display 210 to invoke or initiate or open an eye tracking system 405. In an embodiment at 410 an eye tracking system monitors, tracks and recognize user's one or more types of eye movement or eye status or eye position by using one or more types of one or more optical sensors 240 or image sensors 244. In another embodiment at 410 an eye tracking system monitors, tracks and recognize user's one or more types of eye movement or eye status or eye position by using one or more types of one or more optical sensors 240 or image sensors 244 relative to or correspond to display 210 or user device 200 position by employing accelerometer sensor 248 and/or employing other user device orientation sensors including gyroscope 247 of user device 200. An accelerometer is a sensor which measures the tilting motion and orientation of a mobile phone. At 415 based on determination or recognition of particular type of user's eye movement or eye status or eye position and type of device orientation, for example similar to hold device to see camera display screen i.e. camera view or camera application view for capturing photo or recording video e.g. 460 or 470, auto open camera application or camera display screen to capture photo or record video or take visual media i.e. mobile device is off or lock screen is off and auto o mobile device and auto open mobile camera application to enable user to capture photo or record video without manually on camera device and open camera application to take photo or video. After auto opening camera application for enabling user to take visual media at 440 pre-set duration of timer started. At 442 in the event of expiration of said timer, at 444 based on one or more types of sensors system determine whether device is static or in movement, if device is static or sufficient static (e.g. while taking still photo) then at 445 it auto captures photo and at 450 system optionally stores photo and/or show pre-set duration of photo preview for enabling user to cancel or remove photo, review photo and select one or more contact(s), group(s) or one or more types of one or more destinations and/or auto sent said captured or saved photo to auto determined or pre-set or default or user selected said one or more contacts, groups and destinations. If device is in movement or slight movement initially and then static then at 446 system auto starts recording of video and in the event of expiry of pre-set maximum duration of video then auto stop video and at 450 optionally store video and/or show pre-set duration of video preview for enabling user to cancel or remove video, review video and select one or more contact(s), group(s) or one or more types of one or more destinations and/or auto sent said recorded or saved video to auto determined or pre-set or default or user selected said one or more contacts, groups and destinations.

At 420 If an eye tracking system recognize or detects another particular type of user's eye movement or eye status or eye position and type of device orientation, for example similar to hold device to view photos from gallery or album e.g. 480 or 490 then open photo or video view application or gallery or album or one or more types of one or more preconfigured or pre-set application or interface(s).

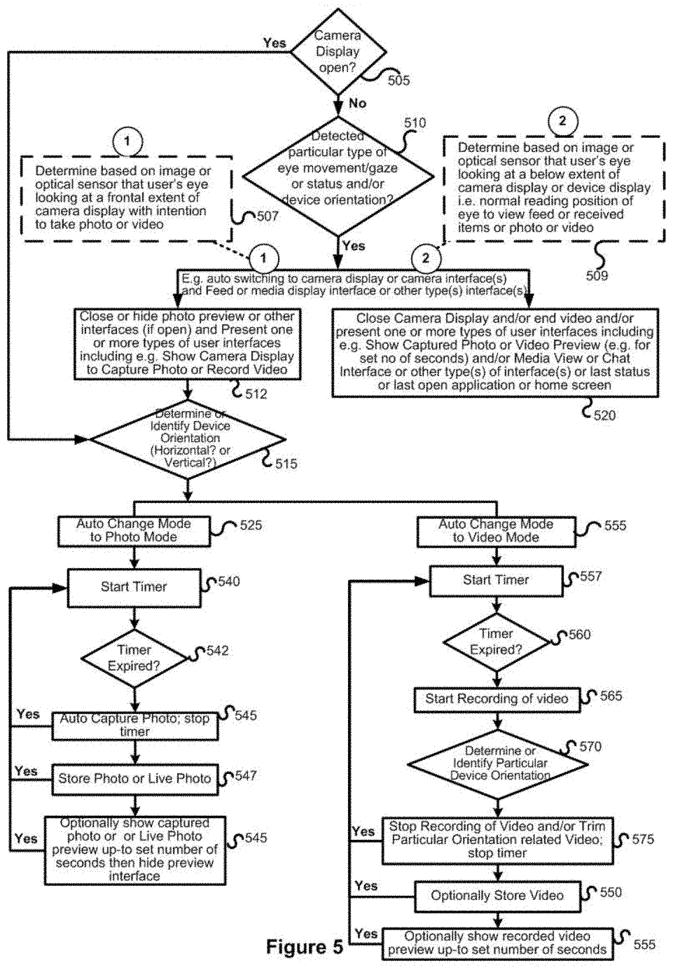

FIG. 5 illustrates processing operations associated with the Auto Present Camera Display Screen Application and/or auto present visual media capture controller 260. Initially an eye tracking system is loaded in memory or loaded in background mode 505, so it can continuously monitor user's eye by using one or more types of image sensors 244 or optical sensors 240 or for example, a user may access an application presented on display 210 to invoke or initiate or open an eye tracking system 505. In an embodiment at 510 an eye tracking system monitors, tracks and recognize user's one or more types of eye movement or eye status or eye position by using one or more types of one or more optical sensors 240 or image sensors 244. In another embodiment at 510 an eye tracking system monitors, tracks and recognize user's one or more types of eye movement or eye status or eye position by using one or more types of one or more optical sensors 240 or image sensors 244 relative to or correspond to display 210 or user device 200 position by employing accelerometer sensor 248 and/or employing other user device orientation sensors including gyroscope 247 of user device 200. An accelerometer is a sensor which measures the tilting motion and orientation of a mobile phone. At 512 based on determination or recognition of particular type of user's eye movement or eye status or eye position and type of device orientation, for example similar to hold device to see camera display screen i.e. camera view or camera application view for capturing photo or recording video e.g. 460 or 470, auto open camera application or camera display screen to capture photo or record video or take visual media i.e. mobile device is off or lock screen is off and auto o mobile device and auto open mobile camera application to enable user to capture photo or record video without manually on camera device and open camera application to take photo or video. After auto opening camera application for enabling user to take visual media at 515 based on accelerometer sensor 248 and/or employing other user device orientation sensors including gyroscope 247 of user device 200, system determines device horizontal or vertical orientation and based on pre-set orientation associated visual media capture mode including for example set horizontal orientation to capture photo or record video or set vertical orientation to capture photo or record video, at 525 system auto change mode to for example photo mode or at 555 auto change mode to video mode. In the event of change of mode to photo mode at 540 pre-set duration of timer started. At 542 in the event of expiration of said timer, at 545 it auto captures photo and at 547 system optionally stores photo and/or at 545 system shows pre-set duration of photo preview for enabling user to cancel or remove photo, review photo and select one or more contact(s), group(s) or one or more types of one or more destinations and/or auto sent said captured or saved photo to auto determined or pre-set or default or user selected said one or more contacts, groups and destinations. If based on detected orientation visual media capture mode is video mode at 555 then at 557 system starts timer 557 and in the event of expiration of said timer at 560, at 565 system auto starts recording of video and at 570 determination or detection of change of particular pre-set or defined type orientation or in the event of expiry of pre-set maximum duration of video then at 575 auto stop video and trim last changed orientation related images from video and at 550 optionally store video and/or at 555 show pre-set duration of video preview for enabling user to cancel or remove video, review video and select one or more contact(s), group(s) or one or more types of one or more destinations and/or auto sent said recorded or saved video to auto determined or pre-set or default or user selected said one or more contacts, groups and destinations.

At 520 If an eye tracking system recognize or detects another particular type of user's eye movement or eye status or eye position and type of device orientation, for example similar to hold device to view photos from gallery or album e.g. 480 or 490 then open photo or video view application or gallery or album or one or more types of one or more preconfigured or pre-set application or interface(s).

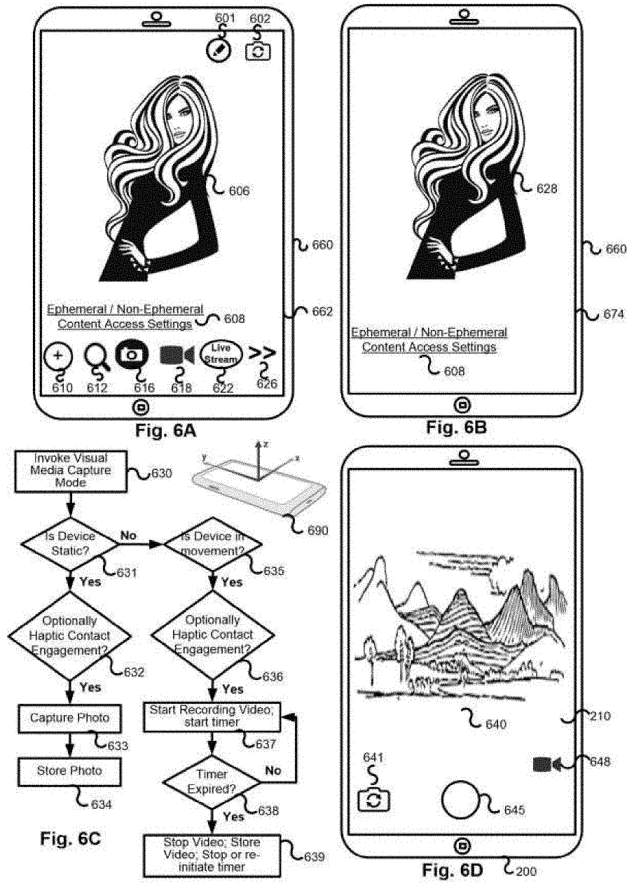

FIG. 6 (A) illustrates user interface 662 on user device 660 wherein user can select 610, search & select 612, capture photo e.g. 606 via tapping or clicking on photo icon 616, recording video 606 via tapping or clicking on video icon 618, start broadcasting live stream 606 via tapping or clicking on live streaming icon 622, edit said captured or selected or recorded visual media 601, switch front or back camera 602 to capture photo or record video, and select one or more destinations 626 including one or more or all contacts, groups, networks, contacts of contacts, follower(s) of contact(s), hashtags, categories, keywords, events or galleries, followers, save locally, broadcast in public, make it public, post to one or more types of feeds, post to one or more types of stories, post to one or more 3^{rd} parties web sites, web pages, applications, services, user profile pages, servers, storage mediums, databases, devices, and networks and post via one or more channels or communication interfaces or mediums including email, instant messenger, phone contacts, social networks, clouds, Bluetooth, Wi-Fi & like.

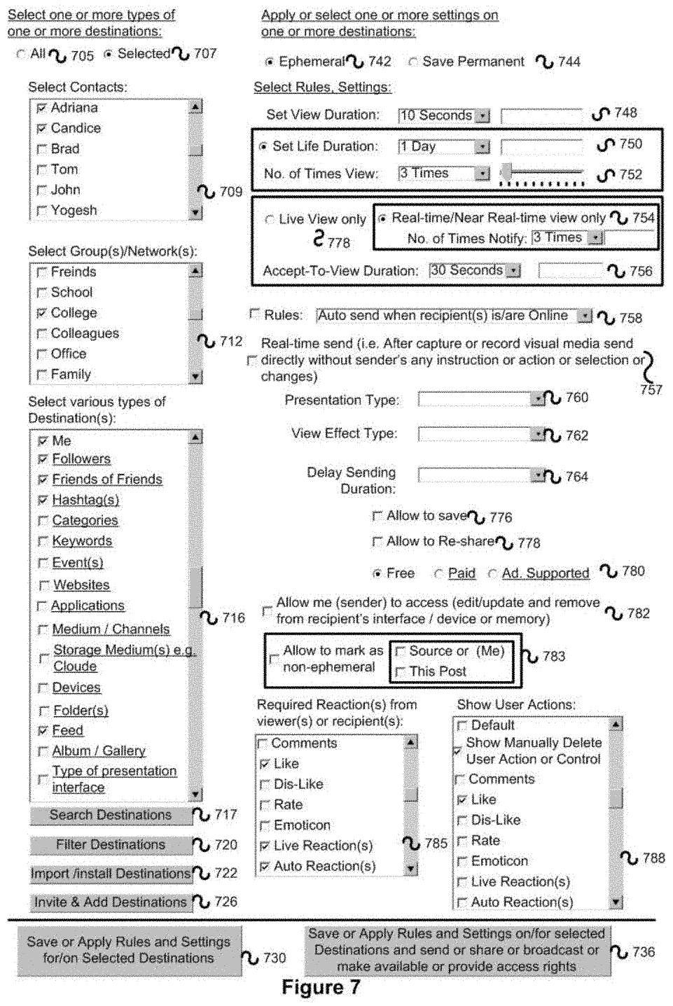

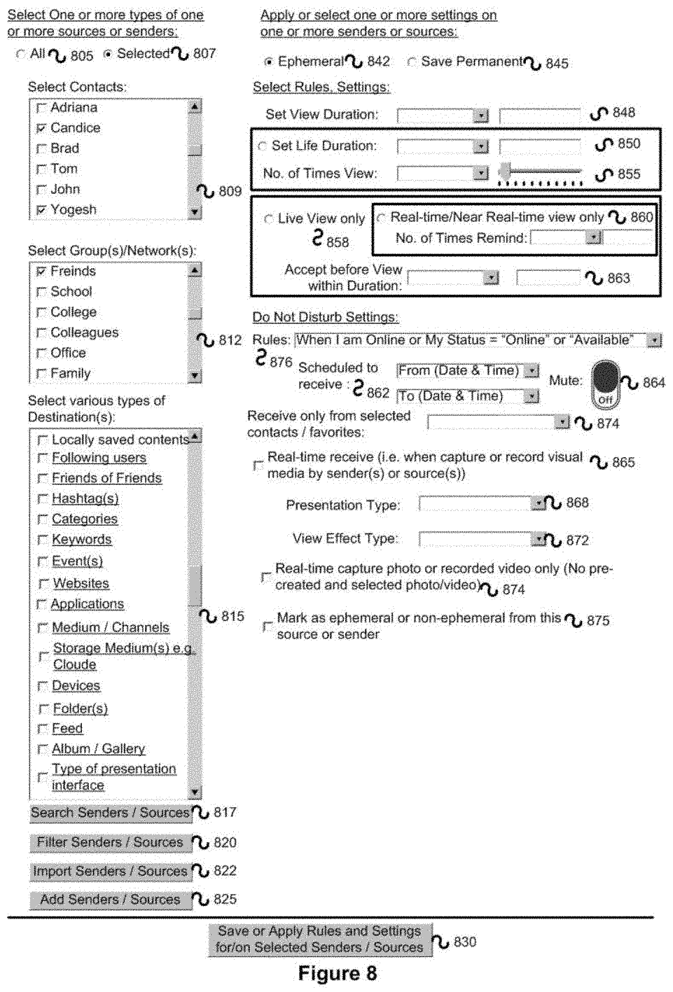

In an embodiment Ephemeral/Non-Ephemeral Content Access Controller 608 or Ephemeral/Non-Ephemeral Content Access Settings 608 (discuss in detail in FIG. 7) enables user to make or pre-set said captured or selected or recorded visual media including photo or video or stream or one or more types of one or more content items as ephemeral including present ephemeral message to recipient(s) in the event of acceptance of push notification, present ephemeral message to recipient(s) in the event of acceptance of push notification within pre-set accept-to-view timer, allow recipient(s) to view shared or sent message real-time only, remind recipient(s) for particular number of times to view shared or sent message(s), allow recipient(s) to view shared or sent message(s) for particular pre-set duration and in the event of expiry of timer remove message(s) from sender and/or recipient(s) and/or server and/or storage medium and/or anywhere where it stored in volatile or non-volatile memory, allow recipient(s) to view shared or sent message for particular pre-set number of times within pre-set duration, auto send message(s) to recipient(s) to when recipient(s) is/are online or not-mute or manually status is “available” or as per do not disturb setting recipient is available OR make said shared or sent message non-ephemeral including allow to save, allow to re-share and/or allow recipient(s) to view shared or sent message(s) in real-time or non-real-time viewable for one or more selected or selected from suggested or auto determined or auto selected or pre-set or default destinations. In an embodiment sender is enable to select one or more types of feeds or stories (which are discussed throughout the specification). In an embodiment recipient is also enabled to receive message as per message(s) receiving settings discussed in detail in FIG. 8. In an embodiment user can apply pre-set settings or user can select or update settings real-time or after selecting or taking visual media including selecting or capturing photo or selecting or recording video or starting live stream and before sending of said visual media to one or more destinations via Ephemeral/Non-Ephemeral Content Access Controller 608 or Ephemeral/Non-Ephemeral Content Access Settings 608 (discuss in detail in FIG. 7).

In an embodiment FIG. 6 (B) illustrates user interface 674 on user device 660 wherein user can auto switch on user device 660 and/or auto start visual media camera display screen or camera interface 674 to take visual media e.g. 628 and/or auto capture photo or auto start recording of video or auto start broadcasting of stream or auto record video e.g. 628 and/or as discussed in FIG. 3-5 or throughout the specification.

FIG. 6 (C) illustrates processing operations associated with single mode visual media capture embodiment of the invention. FIG. 6 (D) illustrates the exterior of an electronic device implementing single mode visual media capture. FIG. 2 (278) illustrates components of an electronic device implementing single mode visual media capture in accordance with the invention. According to one embodiment of the present invention, in the event of detection of device stabilization and in the event of receiving of haptic contact engagement capture photo or in the event of detection of device movement and in the event of receiving of haptic contact engagement start recording of video. A stabilization parameter of the mobile device is determined using a movement sensor. It is determined whether the stabilization parameter is greater than or equal to a stabilization threshold. An image of the scene in camera display screen is captured using the mobile device if the stabilization parameter is greater than or equal to the stabilization threshold and receiving of haptic contact engagement signal from touch controller 215 or star recording of video if the stabilization parameter is less than the stabilization threshold and receiving of haptic contact engagement signal from touch controller 215.

FIG. 2 (278) illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores a visual media capture controller 278 to implement operations of the invention. The visual media capture controller 278 includes executable instructions to alternately record a photograph or a video based upon the processing of device stability and haptic signals, as discussed below.

The visual media controller 278 interacts with a photograph library controller 294, which includes executable instructions to store, organize and present photos 291. The photograph library controller may be a standard photograph library controller known in the art. The visual media controller 278 also interacts with a video library controller 296, which includes executable instructions to store, organize and present videos 292. The video library controller may also be a standard video library controller known in the art.

The processor 230 is also coupled to image sensors 244. The image sensors 244 may be known digital image sensors, such as charge coupled devices. The image sensors capture visual media, which is presented on display 210. That is, in a visual media mode controlled by the visual media capture controller 278, the image sensors 244 capture visual media and present the visual media on the display 210 so that a user can observe the captured visual media.

A touch controller 215 is connected to the display 210 and the processor 230. The touch controller 215 is responsive to haptic signals applied to the display 210. In one embodiment, the visual media capture controller 278 presents a single mode input icon on the display 210. That is, the visual media capture controller 278 includes executable instructions executed by the processor to present a single mode input icon on the display 210.

The visual media capture controller 278 communicates with the processor 230 regarding haptic signals applied to the display 210, which are recorded by the touch controller 215. In one configuration, the visual media capture controller 278 processes haptic signals applied to the single mode input icon, as detailed in connection with the discussion of FIG. 6 9D), and determines whether to record a photograph or a video, as discussed below.

The electronic device 200 may also include other components commonly associated with a smartphone, such as a wireless signal processor 220, a power control circuit 225 and a global positioning system processor 235. While many of components of FIG. 2 are known in the art, new functionality is achieved through the visual media capture controller 278.

FIG. 6 (C) illustrates processing operations associated with the visual media capture controller 278. Initially, a visual media capture mode is invoked 630. For example, a user may access an application presented on display 210 to invoke a visual media capture mode or auto switch on of closed mobile device and auto present visual media capture mode or open camera display screen or open camera application (as discussed in detail in FIGS. 3 and 4). FIG. 6 (D) illustrates the exterior of electronic device 200. The figure also illustrates the display 210. The electronic device 200 is in a visual media capture mode and presents visual media 640. The display 210 also includes a single mode input icon 645.

In one embodiment, the stabilization threshold and the receiving of haptic contact engagement or tap on the single mode input icon 640 determines whether a photograph will be recorded or a video. For example, if a user initially intends to take a photograph, then user has to hold mobile device stable and the icon 645 is engaged with a haptic signal or in an embodiment tap anywhere on camera display screen. If the user decides that the visual media should instead be a video, the user has to slight move user device and engage the icon 645 and in the event of start of video user can then move or keep device stable to record video. In an embodiment If the device is stable for a specified period of time (e.g., 3 seconds) and receiving of haptic contact engagement on icon or anywhere on device, then the output of the visual media capture is determined to be photo or If the device is not stable for a specified period of time (e.g., 3 seconds) and receiving of haptic contact engagement on icon or anywhere on device, then the output of the visual media capture is determined to be video. The photo mode or video mode may be indicated on the display 210 with an icon 648. Thus, a single gesture allows the user to seamlessly transition from a photograph mode to a video mode and therefore control the media output during the recording process. This is accomplished without entering one mode or another prior to the capture sequence.

Returning to FIG. 6 (C), based on device stabilization parameter stabilization threshold is identified 631 and haptic contact engagement is identified 632. For example, the haptic contact engagement may be at icon 645 on display 210. The touch controller 215 generates haptic contact engagement signals for processing by the visual media capture controller 278 in conjunction with the processor 230. Alternately, the haptic contact may be at any location on the display 210.

The stabilization parameter is based on a motion of the camera on the x-axis, a motion of the camera on the y-axis, and a motion of the camera on the z-axis. In an embodiment the movement sensor comprises an accelerometer.

Based on monitored device stabilization parameter via device senor, stabilization threshold is identified. In the event of stabilization parameter is greater than or equal to a stabilization threshold (631—Yes) and in response to haptic contact engagement (632—Yes), photo is captured 633 and photo is store 634. If stabilization parameter is not greater than or not equal to a stabilization threshold (631—No) or in the event of stabilization parameter is less than to a stabilization threshold (635—Yes) and in response to haptic contact engagement (636—Yes), start recording of video and start timer 637 and in an embodiment stop video, store video and stop or re-initiate timer 639 in the event of expiration of pre-set timer (638—Yes). In an embodiment in the event of further identification of haptic contact engagement during or before expiration of timer then stop timer. In an embodiment identify further haptic contact engagement to stop video and store video. In an embodiment identify one or more types of users sense via one or more types of user device(s) sensor(s) including voice command to stop video and store video or hover on camera display screen or pre-defined area of camera display screen to stop video and store video or based on eye tracking system identify particular type of pre-defined eye gaze to stop video and store video. In an embodiment receiving one or more types of pre-defined device orientation data via device orientation sensor(s) then stop video, trim said changed device orientation related video part and then store video.

The video is recorded by the processor 230 operating in conjunction with the memory 236. Alternately, a still frame is taken from the video feed and is stored as a photograph in response to haptic contact engagement and then video is recorded. The timer is executed by the processor 230 under the control of the visual media capture controller 278.

In particular, a video is sent to the video library controller 296 for handling. In one embodiment, the visual media capture controller 278 includes executable instructions to prompt the video library controller to enter a video preview mode. Consequently, a user can conveniently review a recently recorded video.

In an embodiment at 633 video is recorded and a frame of video is selected and is stored as a photograph 634. As indicated, an alternate approach is to capture a still frame from the camera video feed as a photograph. Such a photograph is then passed to the photographic library controller 294 for storage. The visual media capture controller 278 may then invoke a photo preview mode to allow a user to easily view the new photograph.

In one embodiment, the visual media capture controller 278 includes executable instructions to prompt the photo library controller to enter a photo preview mode. Consequently, a user can conveniently review a recently captured photo.

In one embodiment, determining a stabilization parameter is based on a motion of the camera on the x-axis, a motion of the camera on the y-axis, and a motion of the camera on the z-axis 690, wherein the movement sensor comprises an accelerometer. Using motion-sensing technology, such as an accelerometer or a gyroscope, the stability or movement of the mobile device is determined. When the mobile device is stable, the camera automatically captures the image. When the mobile device is in movement, the camera automatically starts recording of video. This eliminates a user action to capture the image or start recording of the video. In addition, the mobile device may include a stability meter to notify the user of the current stability of the mobile device and/or camera.

Movement sensor 247 or 248 represents any suitable indicator used to determine a position and/or motion (e.g., velocity, acceleration, or any other type of motion) of one or more points of mobile device 200 and/or camera display screen e.g. 210. Movement sensor 247 or 248 may be communicatively coupled to processor 230 to communicate position and/or motion data to processor 230. Movement sensor 247 or 248 may comprise a single-axis accelerometer, a two-axis accelerometer, or a three-axis accelerometer. For example, a three-axis accelerometer measures linear acceleration in the x, y, and z directions. Movement sensor 247 or 248 may be any motion-sensing device, including a gyroscope, a global positioning system (GPS) unit 235, a digital compass, a magnetic compass, an orientation center, magnetometer, a motion sensor, rangefinder, any combination of the preceding, or any other type of device suitable to detect and/or transmit information regarding the position and/or motion of mobile device 200 and/or camera display screen e.g. 210.

In one embodiment, stabilization parameter is a value determined from the data received from movement sensor 247 or 248 and stored on memory. The data represents a change in position and/or motion to mobile device 200. Stabilization parameter may be a dataset of values (e.g., position change in X-axis, position change in Y-axis, and position change in Z-axis) or a single value. The dataset of values in stabilization parameter may reflect the change in position and/or motion of mobile device 200 on the X, Y, and Z axes. Stabilization parameter may be a function of an algorithm, of a mean, of a standard deviation, or of a variance of the data received from movement sensor 247 or 248. Stabilization parameter may also be any other suitable type of value and/or data that represents the position and/or motion of mobile device 200 or camera display screen e.g. 210.

For example, in one embodiment, application 278 receives the acceleration of mobile device 200 according to its X, Y, and Z axes. Single mode visual media capture controller application 278 stores these values as variables prevX, prevY, and prevZ. Application 278 waits a predetermined amount of time, and then receives an updated acceleration of device in the X, Y, and Z axes. Application 278 stores these values as curX, curY, and curZ. Next, application 278 determines the change in acceleration in the X, Y, and Z axes by subtracting prevX from curX, prevY from curY, and prevZ from curZ and then stores these values as difX, difY, and difZ. Finally, stabilization parameter may be determined by taking the average of the absolute value of difX, difY, and difZ. Stabilization parameter may also be determined by taking the mean, median, standard deviation, variance, or function of an algorithm of difX, difY, and difZ.

In one embodiment, stabilization threshold is a value that represents the minimum stability required for application 278 to initiate capturing the image 200 by camera display screen e.g. 210. Stabilization threshold may be a single value or a dataset, and may be a fixed number or an adaptive number. Adaptive stabilization thresholds can be a function of an algorithm, of a mean, of a standard deviation, or of a variance of the data received from movement sensor 247 or 248. Adaptive stabilization threshold may also be based on previous stabilization parameter values. For example, in one embodiment, mobile device 200 records twenty iterations of stabilization parameter. Stabilization threshold may then be determined to be one standard deviation lower than the previous twenty stabilization parameter iterations. As a new stabilization parameter is recorded, stabilization threshold will adjust its value accordingly.

FIG. 7 illustrates user interface 267 wherein user can select, set, apply, save, save default various types of or combinations of ephemeral or non-ephemeral one or more types of content or visual media sharing or sending settings from one or more types of one or more selected destinations or provided access rights to one or more selected recipient(s) or destination(s). User is enabled to select all 705 or select, match, auto match, search 717, filter 720, import or install 722 and accept request or invite and add 726 one or more types of one or more destinations 707 including one or more phone contacts, unique user name or identities, social network connections or accounts or contacts 709, groups & networks 712, email addresses, or one or more types of unique user or recipient or destination identities, local save, making available for public or search engine, followers, contacts of contacts up-to one or more depths, followers of contacts, hashtags, categories, events or galleries, one or more types of feeds or stories or folders, interfaces, one or more 3^{rd} parties web sites, web pages, applications, web services, servers, devices, networks, and databases or storage mediums, one or more communication channels or mediums or interfaces including share via 3^{rd} parties applications and web services, email application, social network web site or application, instant messenger application, Bluetooth, Wi-Fi or cellular network 716 and define, configure, apply, set, select, select group of or select default one or more ephemeral or non-ephemeral content or visual media item sharing or sending settings, so based on said applied or set or configured settings system send or share or present content items or visual media to/at/on said applied or configured or set settings associated destination(s) or recipient(s) interface(s) on recipient device(s), wherein Ephemeral/Non-Ephemeral Content Access Controller 608 (FIG. 7) or Ephemeral/Non-Ephemeral Content Access Settings 608 (FIG. 7) enables user to pre-set or set before sending said captured photo 616 or selected 610 or searched and selected 612 or recorded visual media including video 618 or stream 622 or one or more types of one or more content items or visual media as ephemeral 742 including present ephemeral message to recipient(s) in the event of acceptance of push notification or live only (present as and when it sent or shared or generated) 778 (user can view during starting and ending of presentation session only, if user is starting to view in middle then can view only currently shared and presented visual media items only), present ephemeral message to recipient(s) in the event of acceptance of push notification within pre-set accept-to-view timer 756 else recipient is not able to view message or shared content item(s), allow recipient(s) to view shared or sent message in real-time only 754, remind recipient(s) for particular number of times to view shared or sent message(s) 754, allow recipient(s) to view shared or sent message(s) for particular pre-set duration 748 and in the event of expiry of said pre-set duration timer remove message(s) from sender and/or recipient(s) and/or server and/or storage medium and/or anywhere where it stored in volatile or non-volatile memory, allow recipient(s) to view shared or sent message for particular pre-set number of times 752 within pre-set life duration 750 and in the event of expiry of said pre-set duration timer remove message(s) from sender and/or recipient(s) and/or server and/or storage medium and/or anywhere where it stored in volatile or non-volatile memory, auto send message(s) to recipient(s) when recipient(s) is/are online or not-mute or manually status of recipient(s) is “available” or as per do not disturb setting recipient is available 758 OR make said shared or sent message non-ephemeral 744 including allow to save 776, allow to re-share 778 and/or allow recipient(s) to view shared or sent message(s) in real-time 778 or non-real-time 754 viewable for said one or more selected or selected from suggested or auto determined or auto selected or pre-set or default destinations e.g. 707. In an embodiment sender is enable to select one or more types of presentation interface(s) or feeds or galleries or folders or stories 760 and/or view effect type or style (present shared visual media or content item(s) to recipient based on one or more effects, access logic and pre-presentation) 762 for presenting to one or more selected destination(s) or recipient(s) (which are discussed throughout the specification). In an embodiment recipient is also enabled to receive message as per message(s) receiving settings discussed in detail in FIG. 8, in which sender's settings applied first and then recipient's settings applied. In an embodiment user can apply & save pre-set settings for/on selected destination(s) 730 at user device 200 via client-side module 267 and/or server 110 via server module 172 or user can select or update settings real-time at user device 200 via client-side module 267 and/or server 110 via server module 172 and send or share content items or visual media items 736 or user can set settings after selecting or taking visual media including selecting 610 or searching & selecting 612 or capturing photo 616 or selecting 610 or searching & selecting 612 or recording video 618 or starting live stream 622 and before sending of said visual media to one or more selected or auto determined destinations 626 via Ephemeral/Non-Ephemeral Content Access Controller 608 or Ephemeral/Non-Ephemeral Content Access Settings 608 (FIG. 7). In an embodiment sender user is enable to set delay sending timer, wherein delay time started after user sends shared content or visual media items to target or selected or auto determined destination(s) and in the event of expiry of said pre-set delay timer, system actually auto send said shared visual media or content item(s) to destination(s) or recipient(s). In an embodiment sender can make shared content or visual media item(s) as free or paid or sponsored 780. In an embodiment enable sender to access including edit, update and remove said shared or sent content or visual media items at/from/on recipient's application, interface(s), storage medium, folder or gallery or device memory 782, where said shared visual media or content items by sender stored. In an embodiment sender can request or set required reaction(s) 785 on one or more or all sent or shared content or visual media items for selected destination(s) or target recipient(s). In an embodiment sender can select user action(s) 788 on one or more or all sent or shared content or visual media items for selected destination(s) or target recipient(s) which shows to said selected destination(s) or target recipient(s) on said shared content or visual media items shared by sender and enabling said selected destination(s) or target recipient(s) to optionally access said selected one or more user actions or controls. User can apply different settings for each or selected or different set of recipient(s) or destination(s). In an embodiment allow to mark sender's all or particular type of received content or currently posted content as ephemeral 783 by sender selected one or more contacts and/or groups and/or one or more types of destinations.

In an embodiment FIG. 8 illustrates user interface 268 for applying one or more ephemeral or non-ephemeral settings on received content or visual media items from selected one or more senders or sources. FIG. 8 illustrates user interface wherein user can select, set, apply, save, save default various types of or combinations of ephemeral or non-ephemeral one or more types of content or visual media receiving and/or viewing settings from one or more types of one or more selected senders or sources or contacts. User is enabled to select all 805 or select, match, auto match, search 817, filter 820, import or install 822 and add one or more types of one or more sources or senders 825 including one or more phone contacts, unique user name or identities, social network connections or accounts or contacts 809, groups & networks 812, email addresses, or one or more types of unique user or sender or source identities, locally saved, receiving from public sources, following users, contacts of contacts up-to one or more depths, followers or following users of contacts, accessed or subscribed hashtags, categories, events or galleries, received on one or more types of feeds or stories or folders, interfaces, content items or visual media items received from one or more 3^{rd} parties web sites, web pages, applications, web services, servers, devices, networks, and databases or storage mediums, received on/via one or more communication channels or mediums or interfaces including share via 3^{rd} parties applications and web services, email application, social network web site or application, instant messenger application, Bluetooth, Wi-Fi or cellular network 716 and define, configure, apply, set, select, select group of or select default one or more ephemeral 842 or non-ephemeral 845 content or visual media item sharing or receiving settings including pre-set view duration or timer 848 to view each or particular or received during particular session or time or time ranges or all received content items or visual media items from selected sender(s) or source(s) and in the event of expiry of said pre-set view timer remove or hide content item or visual media item from recipient's user device(s) and/or remove from server or server database or storage medium, pre-set received content life duration 850 and pre-set number of times of views 855 within said pre-set life duration 850 for each or particular or received during particular session or time or time ranges or all received content items or visual media items from selected sender(s) or source(s) e.g. 807 and in the event of expiry of said pre-set life duration timer and/or number of times of pre-set views within said pre-set life duration remove or hide content item or visual media item from recipient's user device(s) and/or remove from server or server database or storage medium, receive and view content items or visual media items from selected sender(s) or source(s) in real-time only 860 based on pre-set number of times of reminder(s) 860 at pre-set period of interval or receive or present received content items or visual media items live only 858, accept or not-accept received content items or visual media items within pre-set duration 863 to view or not-view from selected senders or sources. Apply one or more types of “Do not Disturb” settings for receiving content items or visual media items from one or more sources or senders including receive when user is online, user's manual status is e.g. “Available” 876, user is not-mute 864, set scheduled to receive 862, while “Do Not Disturb” is on receive from all or selected or favorites contacts or senders or sources only 874, receive real-time only (as and when content shared) 865. In an embodiment recipient is enabled to mark content received from selected one or more senders or contacts or sources as ephemeral or non-ephemeral 875. In an embodiment receiving or viewing user can select one or more types of presentation style or feeds or stories or interfaces 868 to view received one or more content items or visual media items from one or more senders or sources or contacts. In an embodiment receiving or viewing user can select one or more types of view effect type or style (present shared visual media or content item(s) to recipient based on one or more effects, access logic and pre-presentation) 872. So based on said applied or set or configured settings system received or maintain or present content items or visual media from said applied or configured or set settings associated senders(s) or source(s), After selecting one or more sources or senders 807 including one or more contacts, groups, networks, following users, categories, hashtags, feeds, galleries, keywords, folders, interfaces, applications, servers, web sites, devices and storage mediums and selecting or applying or configuring one or more types of ephemeral or non-ephemeral settings on received content items or visual media items and user can save 830 different settings for each or selected or different set of senders or sources to receive and/or present content items or visual media items at local storage of user device 200 via client-side module 268 and/or server 110 via server module 171.

In an embodiment system can implemented sender side settings only as discussed in FIG. 7 or in another embodiment system can implemented recipient side settings only as discussed in FIG. 8 and in an another embodiment system can implemented both sender's side and recipient side settings as discussed in FIGS. 7 and 8, but first applied sender side settings and then applied recipient side settings.

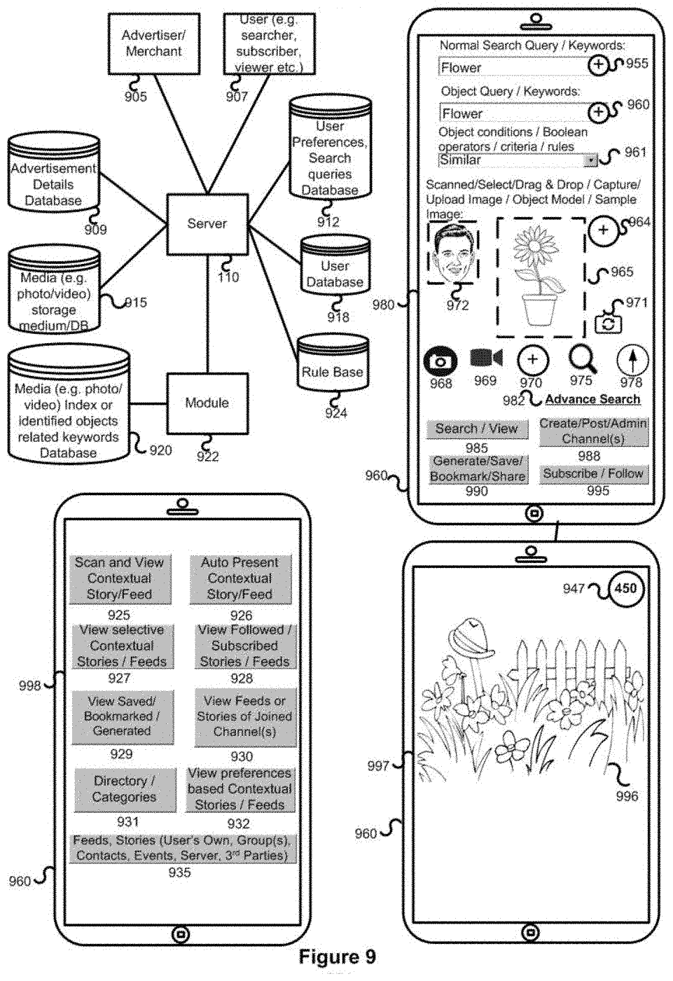

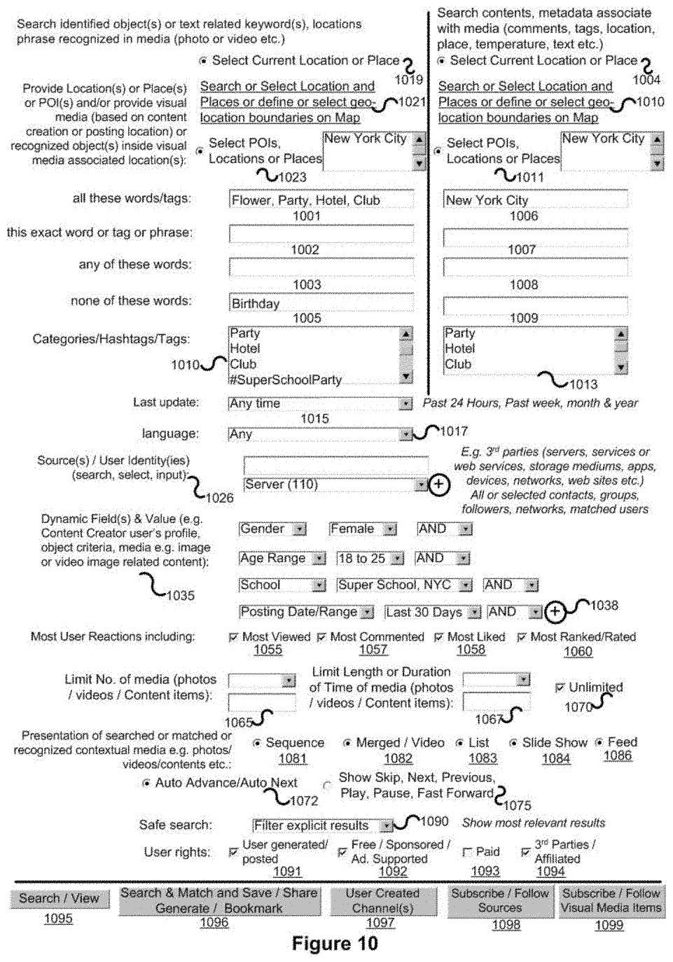

FIGS. 9-13 illustrates a various embodiments for searching, matching, presenting, subscribing, and auto generating visual media story system 269, wherein searching request or request to present or auto generate or auto present visual media received and processed at server module 173 of server 110 and request to subscribe one or more types of subscription or following processes and stores at server module 174 of server 110. A “story” as described herein is one or more types of set of contents or visual media items. A story may be generated from pieces of content that are related in a variety of different ways, as is described in more detail throughout the specification. Pieces of content comprises one or more types of content items including visual media, photo, video, video clip, voice, blog, text, emoticons, photo filter, object, application, interface, data, user action or control, form & like from one or more sources including user generated or user posted contents or contents posted by users of network, from one or more servers, storage mediums, databases, web sites, applications, web services, networks, and devices. For example story generated based on search criteria, auto present or auto update contextual story based on user data, present stories or present updated stories or new stories based on user's subscriptions or following of sources and/or preferences specific contents, present stories based on scan of object(s) by user via camera display screen in camera view mode. FIG. 9 illustrates searching visual media items based on supplying or adding 964 one or more object criteria including object model or image 965 via selecting from pre-stored 970 or real-time capturing or recording front camera 972 and/or back camera 965 photo 968 or video and/or voice 969 or search from one or more sources or websites or servers or search engines or storage mediums 975 or drag and drop or scan via camera or upload 978 and one or more object keywords (pre-recognized objects inside stored photos and videos associate identified or related keywords database 920) 960 and object conditions comprises similar object, include object, exclude object, exact match object, pattern match, attribute match including color, resolution, & quality, part match, Boolean operators 961 between more than two supplied objects including AND, OR and NOT, wherein object criteria matched with recognized or pre-recognized objects inside photos or images of videos to identify supplied object criteria including object model specific visual media items including photos and videos or clips or multimedia or voice. User can select, input or auto-fill one or more keywords 955 which are matched with visual media items including photo or video associated contents and metadata including date & time, location, comments, identified or recognized or supplied or associated information from one or more sources or users. User can employ advance search 982 or FIG. 10 to provide one or more advance search criteria. Based on said supplied or provided search query and associated one or more criteria and object criteria, server 110 via server module 173 searches and matches 985 visual media items from one or more sources including media items or visual media content including phots, videos, clips & voice storage medium or database 915 and present sequences of searched and matched visual media items e.g. 996 to user at user interface 997 at device 960. User can view one by one or auto present one by one visual media items based on pre-set period of interval. User can also view length of duration of visual media items for viewing 947. For example 450 seconds of visual media items which includes for example 300 seconds of length of videos and 50 photos each presented with 3 seconds of intervals i.e. total 150 seconds which grand total 450 seconds of length of viewing time for user. In another embodiment user can save or bookmark or share said searched or matched visual media items 990. In an another embodiment user can create micro channels 988 related to particular keywords or key phrases and search, match and manually select or add or remove not related, duplicate & inappropriate or rank or order or edit or curate visual media items from said searched or matched visual media items. In an another embodiment search engine also use one or more types of user data including user profile (age, gender, qualification, skill, interest etc.), locations or checked-in places, status, activities to refine searched or matched visual media items.

In an another embodiment user can subscribing or following sources 995 or receiving matched updated contents or visual media items from sources 995 based on supplying or adding 964 one or more object criteria including object model or image 965 via selecting from pre-stored 970 or real-time capturing or recording photo or video 968 or search from one or more sources or websites or servers or search engines or storage mediums 975 or drag and drop or scan via camera or upload 978 and one or more object keywords (pre-recognized objects inside stored photos and videos associate identified or related keywords database 920) 960 and object conditions comprises similar object, include object, exclude object, exact match object, pattern match, attribute match including color, resolution, & quality, part match, Boolean operators 961 between more than two supplied objects including AND, OR and NOT, wherein object criteria matched with recognized or pre-recognized objects inside photos or images of videos to identify supplied object criteria including object model specific visual media items including photos and videos or clips or multimedia or voice and said visual media items associated sources. User can select, input or auto-fill one or more keywords 955 which are matched with visual media items including photo or video associated contents and metadata including date & time, location, comments, identified or recognized or supplied or associated information from one or more sources or users and identify sources. User can employ advance search 982 or FIG. 10 to provide one or more advance search criteria. Based on said supplied or provided one or more criteria and object criteria, server 110 via server module 173 searches and matches 985 visual media items from one or more sources and identify said search or matched visual media items associated unique sources for enabling user to subscribe all or selected or auto subscribe or follow all matched sources to continuously receive updated visual media item as and when they are posted or uploaded or updated at server 110 or view from auto presented or auto updated feed or story at user interface 997 e.g. visual media item 996 from one of the followed or subscribed source(s). Based on settings user can view only updated visual media items received from followed sources for pre-set number of times and/or within pre-set period of time and then remove or hide from user interface or user device or user device storage medium. Based on setting user is notified via push notification or provide indication of new visual media items from one or more followed sources.

FIG. 10 illustrates user interface 269 for advance search for searching and viewing visual media items, search and following or subscribing sources of visual media items. User can provide various object criteria related to recognized object inside visual media items and criteria related to contents associated with visual media items. User can select or select as current location or select from map or select or define geo-boundaries, ranges or geo-fences or provide location(s) or place(s) or points of interest (POI(s)) 1019, 1021 & 1023 with intention to search or match visual media items created from said provided one or more types of one or more locations 1019, 1021 & 1023 and/or provide one or more object models 965 & 964 with intention to match provided object models with recognized or identified objects inside stored visual media items and match provided location(s) with location of visual media items where visual media items captures or content creation or posting location of visual media items or match provided object model(s) with recognized object(s) inside visual media associated location(s). User can provide locations 1004, 1010 & 1011 with intention to match provided location(s) with content associated with visual media items. User can provide object keywords or keywords including all these words/tags 1001 or 1006, this exact word or tag or phrase 1002 or 1007, any of these words 1003 or 1008, none of these words 1005 or 1009, Categories, Hashtags & Tags 1010 or 1013 recognized via optical character recognition (OCR), wherein said provided keywords and associated conditions or type matched with recognized objects inside pre-stored visual media items including photos and videos related or associated or identified or keywords. User is enabled to search, select and provide one or more types or categories or user name(s) or contact(s) or group(s) or unique identities or name of sources of visual media items 1026. User can use structured query language (SQL) or natural query to identify or define type of sources of visual media items for searching or subscribing or following visual media items. In an embodiment sources comprises phone contacts, groups, social network identities or user names, followers, categories or locations or taxonomy of users or sources, one or more 3^{rd} parties servers, web sites, applications, web services, devices, networks and storage mediums 1026. User can provide or define type of content or visual media items creator users or sources of visual media items including one or more profile fields including gender, age or age range, education, qualification, home or work locations, related entities including organization or school or college or company name(s) and Boolean operators 1035. User can add one or more fields 1038. User can provide most user reacted visual media items related criteria to search visual media items including most viewed 1055, most commented 1057, most ranked 1060, and most liked 1058. User can limit number of media items including photos and/or videos and/or content items 1065 of search results. User can limit length or duration of time of searched media items including photos and/or videos and/or content items 1067 or select unlimited or system default limit 1070 searched media items. User is enabled to select type of presentation including present searched or matched visual media items sequentially 1081 i.e. show consecutive media items based on pre-set interval of time, show in video format 1082, show visual media items in list format 1083, show visual media items in slide show format 1084 and show in one or more types feed format 1086. User can provide other types of presentation settings including set auto advance or auto show next visual media items after expiry of pre-set duration of timer 1072 or provide to user next, previous, skip, play, pause, start, fast forward options or buttons or controls 1075 to manually show next or previous or skip or paly selected or all or pause playing or fast forward sequence or list of searched or matched visual media items. User can provide safe search setting including show most relevant results or filter explicit results 1090. User can limit search to user generated visual media items 1091 and/or free or sponsored or advertisement supported visual media items 1092 and/or paid visual media items or contents 1093 and/or 3^{rd} parties affiliated visual media items 1094. User can limit searching of visual media items which are created at particular time or range of date & time or duration including any time, last 24 hours, past number of seconds, minutes, hours, days, weeks, months and years, range of date & time 1015. User can provide language of creator or language associated with object inside visual media items or language associated with contents associated with visual media items 1017. After providing one or more advance search criteria as discussed above user can search and view 1095 with intention to view searched or matched visual media items provided by server 110 via server module 173 or user can save search result or share search result or bookmark all or selected searched visual media items 1096 or user can search, select, add to earlier saved search result items or remove one or more search result items or rank search result items and add to user created one or more channels 1097 for making said curated visual media items available to subscribers of said user created channel(s) or user can subscribe or follow identified or searched or matched sources of visual media items 1098 based on one or more advance search criteria as discussed above or user can subscribe or follow identified or searched or matched visual media items 1098 based on one or more advance search criteria as discussed above, server 110 via server module 174 stores said user's one or more types of one or more subscriptions or following of searched or matched or selected sources list. For example when user provides keyword “Flower” 955, which will match with content associated with visual media items at server 110 at the time of searching, when user provides object keyword “Flower” 960, which will match with pre-identified and pre-stored recognized objects inside visual media items related keywords at server 110 at the time of searching to find out matched visual media items, when user provides object model or sample image of Flower 965, which will match with objects inside visual media items including photos or images of videos based on employing image recognition technologies, system & methods at server 110 via server module 173 at the time of searching to find out matched visual media items and after providing said one or more keywords, object criteria and one or more advance search criteria when user execute search 985 then server 110 via server module 173 searches and matches and presents matched visual media items e.g. 996 at user interface 997 on user device 960 (e.g. user can view flowers inside visual media item 996 based on keyword 955, object keyword 960, object condition 961 and object model 961 “Flower”).

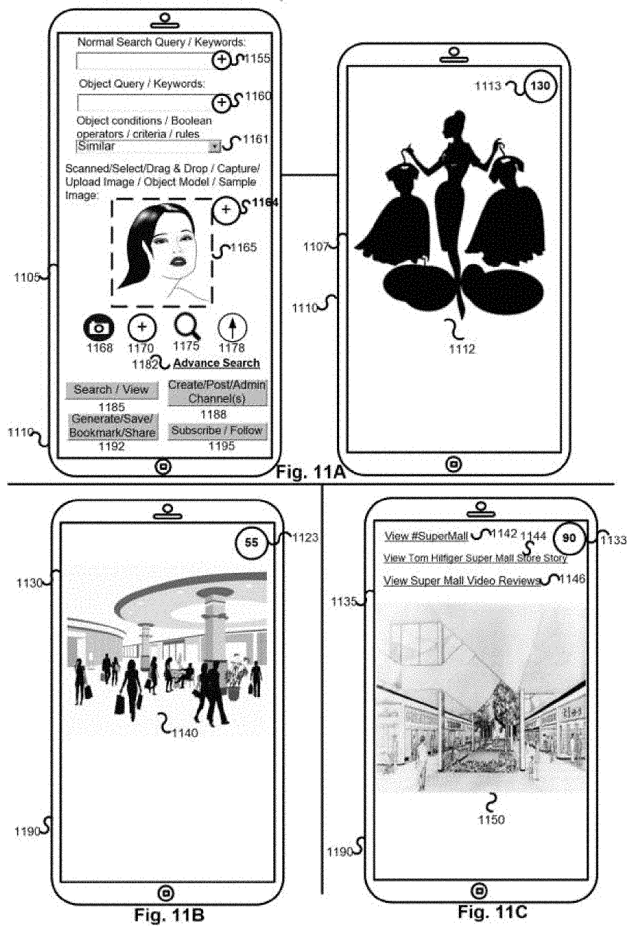

FIG. 11 (A) illustrates another example wherein user provides object model 1165 of human face and provides object condition “similar” 1161 and instruct to execute search via button 1185, then server 110 via server module 173 searches said human face with photos and videos or user generated and user posted visual media items at server storage medium or database 115 or 915 (search at one or more 3^{rd} parties servers, databases, storage mediums, applications, web sites, networks, devices and via web services or APIs) and find out matched visual media items including photos and videos or clips which have said human face based on employing one or more face recognition technologies, systems, methods & algorithms and present to user sequentially or as per user's or server's presentation settings at user interface 1107 on user device 1110. For example present one of the visual media items 1112 out of many 1113 which have said user supplied similar face image or object model 1165. User is presented with matched visual media items sequentially one by one based on pre-set interval time.

In another embodiment FIG. 11 (B) illustrates auto presented contextual stories, generated by server 110 via server module 173 based on matching stored one or more types of contents or visual media items e.g. 1140 from server storage medium 115 and/or one or more sources, storage mediums, servers, databases, web sites, networks, via web services & application programming language (APIs) and applications with one or more types of user data related to each user or particular user or requesting user or identified user, wherein user data including detail user profile including user gender, age, income, qualification, education, skills, home address, work address, interacted entities including schools, colleges, companies, organizations, user connections, interests & hobbies and like or domain specific profile inkling job profile, dating or matrimonial profile, travel profile, food profile, personality profile & like, ono or more types of one or more logged or stored or identified or recognized user activities, actions, events, logs, transactions, locations, checked-in places, status, interactions, communications, participations, collaborations, sharing, search queries, senses, and user behavior and selecting, applying and executing one or more contextual rules from rule base. For example when user enters in to particular mall and when stands opposite to particular shop then user is presented with said shop of said mall related contextual sequences of contents or visual media items e.g. 1140 and auto present next after pre-set duration of interval expires 1123 and further filters based on one or more types of user data and execute selected or pre-stored one or more rules from rule base and selected or provided one or more filter criteria including one or more keywords, key phases, Boolean operators, advance search options including creation or posting date, source type(s) or categories or names or groups, most reacted including most liked, disliked, rated & commented visual media items generated, created, updated & posted by users of network. Based on user data, executed rules and filter data, system displays the filtered visual media items e.g. 1140 to a display e.g. 1130 at user device 1190. When user walks and go to another shop then user is presented with said shop of said mall related contextual sequences of contents or visual media items. For example while user traveling on cruise then user is presented with water travel, cruises, whales, water sports, water rated stories. In an embodiment each next visual media item in sequences of visual media item is presented based on updated user context including user's current location, checked-in place, current point of interest (POI) nearest to user's current location, update in user's status, activity, actin, movement, sense, behavior, identification of event, transaction, identification of presence of user's one or more connections or contacts or family members or friends and update in or change in one or more types of user data. For example while user in particular brand of ice-cream shop then user is presented with contents posted by users of network from location of said ice-cream shop or similar brand ice cream shop or said ice-cream brand related most ranked or rated or commented, most liked and most viewed visual media items or content items and in the event of user walk out from mall and enter in to sport zone then user is presented with said sports related visual media item(s). If user is not viewing or viewed few of visual media items from earlier presented or in queue for user's viewing purpose then based on updates system removes or hides visual media items which are earlier presented or in sequence or in queue and add newly found contextual or searched or matched visual media items in viewing sequences or in queue based on identification of updates in user's context. In an another embodiment in FIG. 11 (C) user is presented with accessible links or icons or images or video snippets or controls of one or more contextual stories based on one or more user context factors as discussed above and enabling user to play, view, fast view, fast forward, pause, cancel, start next, skip stories and view next, previous, skip one or more visual media items within particular story. In an another embodiment user is enable to like, dis-like, select emoticon(s), comment, rate one or more visual media items at the time of viewing of visual media items.

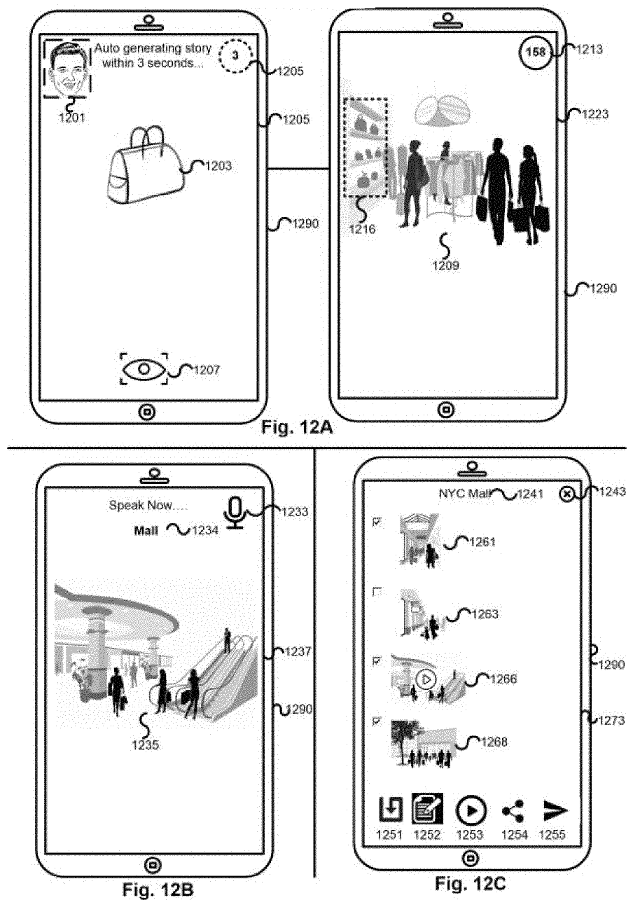

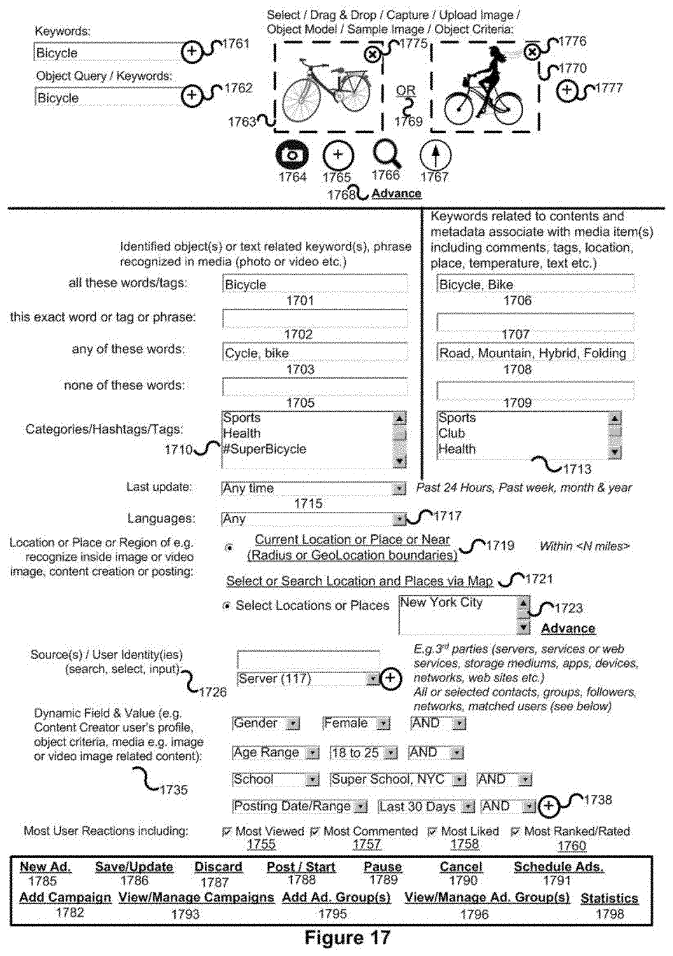

In an another embodiment illustrates in FIG. 12 (A), wherein user is enable to scan 1207 or view 1370 one or more scene or object or particular pre-defined object or area or spot or logo or QRcode 1203 via e.g. back camera display screen 1205 and/or provide additional visual instruction, searching requirements or search query or preferences, commands and comments via front camera of 1201 of user device 1290 i.e. camera view (without capturing photo or taking video or visual media) and based on user command or instruction to generate story via button 1207 or after expiry of pre-set duration of timer 1205 (i.e. e.g. three . . . two . . . one . . . zero second in reverse order), system auto recognizes and identifies object(s) or pre-defined object or area or spot or logo 1203 inside camera view for example when user is viewing particular bag 1203 from particular shop via camera view 1205 and after tap on button 1207 or based on setting after holding some level static at particular object or pre-defined or pre-stored object or logo or QRcode for pre-set period of time 1205, system identifies or auto recognizes object inside camera view 1203 and matches said identifies one or more objects 1203 with recognized object e.g. 1216 inside visual media item(s) e.g. 1209 and/or pre-defined and pre-stored object(s) e.g. 1763 (discuss in detail in FIG. 17) provided by advertiser or user or merchant and associated one or more types of data including said pre-provided or pre-defined object(s) or object model(s) provider's profile, object model(s) associated details, preferences, target viewers' criteria including target viewer's pre-defined characteristics including gender, age, interest, education, qualification, skills, interacted or related entities and matches with viewing's user's data including user's current location or checked-in place or nearest location, user profile including age, gender, interest & like, user activities, actions, events, transactions, status, locations, behavior, senses, communications, sharing and presents sequences of contextual visual media items e.g. 1209 at user interface 1223 on user device 1290. User can view total number of searched or matched visual media items (not shown in Figure) or user can view length of duration 1213 to view said searched or matched sequences of visual media items. In an embodiment sequences or series of searched or matched or contextual visual media items comprise system can recognize, identifies, search, match, serve, add or remove in queue, select, select from curated or select by editor or human, rank, load particular number of visual media items at user device, add, remove, update, and present one by one visual media items based on updated one or more types of contextual factors related to each user, and log user's each search query or request or subscription or scan request or voice request and associated searched or matched each visual media item's unique item number, associate user's like, dislike, selected emoticon, comments & ratings. In another embodiment user can scan via camera display screen particular object, product or logo or capture photo or record video (image(s) of video) and select one or more filter criteria including one or more keywords, key phases, Boolean operators, advance search options including creation or posting date, source type(s) or categories or names or groups, most reacted including most liked, disliked, rated & commented visual media items generated, created, updated & posted by users of network. Based on scanned image, scanned object or logo or object model, captured photo or video (image(s) inside video), system recognized objects inside said scanned view or captured visual media and searches, matches and selects contextual visual media items generated, created, updated and posted by users of network and further filter based one aid one or more provided filter criteria (not shown in FIG. 12 (A)) and displays the filtered visual media items e.g. 1209 to a display e.g. 1223 at user device 1290.

In an another embodiment illustrates in FIG. 12 (B), wherein user is enabled to speak keyword(s) or key phrases 1233 and based on voice recognition system identifies keyword(s) e.g. 1234 and based on keywords system matches said identified keyword(s) 1234 with keywords associated with contents associated with visual media items and/or based on image recognition pre-identified object keywords associated with visual media items and presents sequences of visual media items e.g. 1235 at user interface 1237 on user device 1290.

In an another embodiment user can select presentation style in list format for search results 1241 or presented contextual visual media items' presentation style and select one or more identified or preferred visual media items based on snippets and can play visual media items i.e. view one by one in selected sequence which are auto advances based on pre-set interval of time. User is enabled to select one or more visual media items e.g. 1261, 1266 & 1268, rank, rate, order, bookmark, save 1251, share via selecting one or more mediums or channels 1254 or select one or more destinations or contacts or group(s) and send 1255 to them.

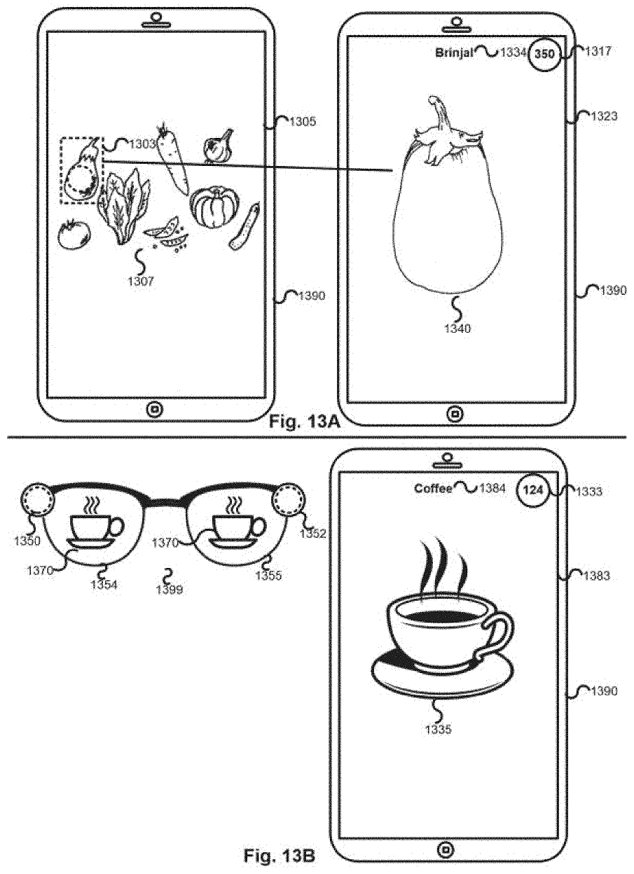

In an another embodiment FIG. 13 (A) illustrates one type of the user interface 1305 where e.g. user is viewing particular image or photo or video (i.e. particular image inside particular position of video) 1307, in the event of haptic contact engagement or tap or click on preferred object or within area of particular object e.g. 1303, system identifies or recognizes object inside said image or photo or video and matches said identified object or object model or associated identified object details and object keywords with similar recognized objects inside visual media items and presents searched or matched series or sequences of visual media items e.g. 1340 at user interface 1323 on user device 1390. User can view number of searched or matched visual media items at prominent place or view number of pending to view presented visual media items or view total length of duration of view of presented searched or matched number of visual media items 1317. System can identifies keyword(s) 1334 associated with tapped object and present to user at prominent place. System can integrate with 3^{rd} parties' web sites, web pages, web browsers, video or photo search engines or search results, presented visual media search item(s), applications, services, interfaces, servers, devices via web services and application programming interface (API).

In an another embodiment illustrates in FIG. 13 (B), wherein user is enabled to view or scan or identify interested via tapping button via spectacles 1399 associated or integrated video cameras 1350 and/or 1342 which is connected with device 1390 and enabling user to view or scan or capture or record photo or video via spectacles 1399 which have an integrated wireless video camera 1350 and/or 1342 that enable user to view or scan or capture photo or record video clips and save them in spectacles 1399 and/or to user device 1390 connected with spectacles 1399 via one or more communication interface or save to server 110 database or storage medium 115. The glasses 1354 or 1355 enables user to view or begin to capture photo or record video after user 510 tap a small button near the left or right camera. The camera can scan or capture photo or record videos for particular period of time or up-to user stops it. The snaps will live on user's Spectacles until user transfer them to smartphone 1390 and upload to server database or storage medium 115 via Bluetooth or Wi-Fi or any communication interface, channel, medium, application or service. Based on identified object inside real-time viewed or scanned by tapping on button or captured photo or recorded video (i.e. particular image inside video) e.g. 1370, system matches said identified object and identified associated details with similar objects inside visual media items and presents searched or matched visual media items e.g. 1335 at user interface 1383 on user device 1390. User can view number of searched or matched visual media items at prominent place or view number of pending to view presented visual media items or view total length of duration of view of presented searched or matched number of visual media items 1333. System can identifies keyword(s) 1384 associated with tapped object and present to user at prominent place.

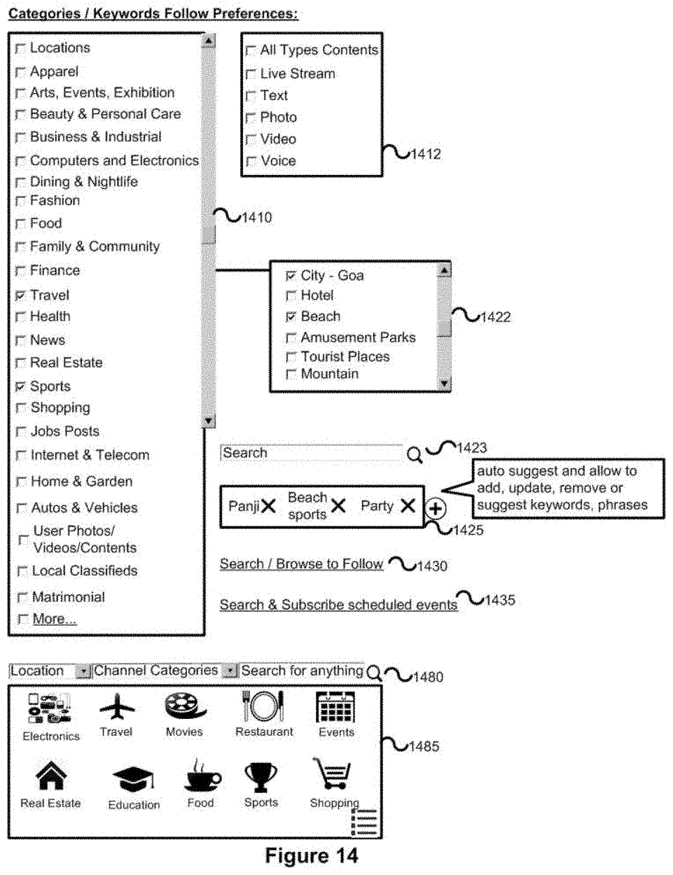

FIG. 14 illustrates user interface for enabling user to select one or more categories 1410, sub-categories 1422 and sub-sub-categories (not shown in Figure) and enable to follow or subscribe said categories or taxonomy related stories. Enable user to search 1422 and subscribe or follow one or more sources of stories. Enable user to input, search, select and add or remove or update one or more keywords or key-phrases 1425 and enable to subscribe or follow said added keywords related visual media stories from one or more sources. In an embodiment enabling user to add and suggest one or more keywords 1425 for making them verify and available for other users off network. In an embodiment enable user to search 1480 from directories 1485 and subscribe or follow one or more sources of stories or one or more scheduled events available for users to view posted stories.

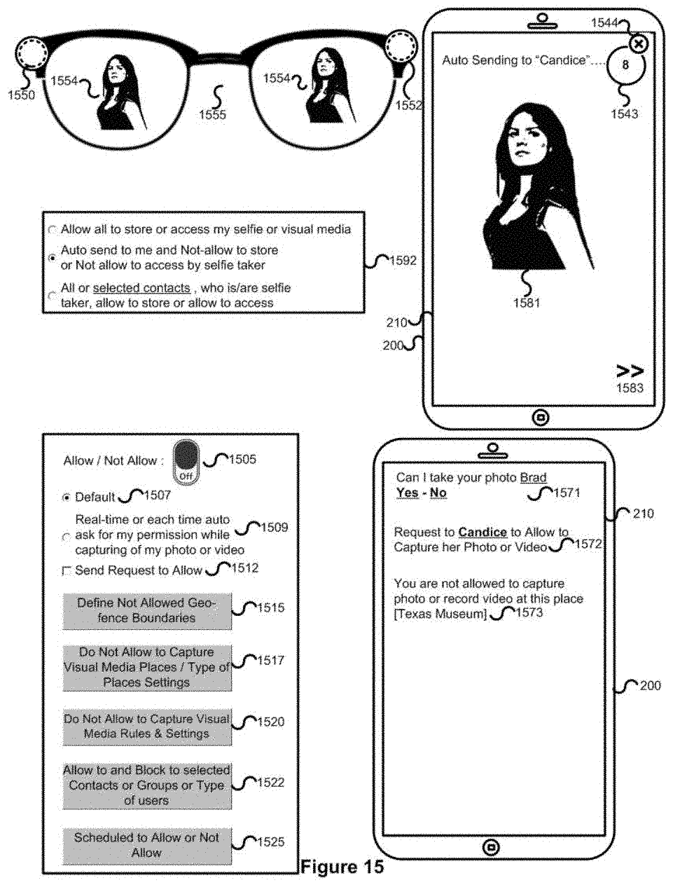

FIG. 15 illustrates interface 273 and examples explaining providing of privacy settings, which are processes and stores at client device 200 and/or processes and stores at server module 175 of server 110, for allowing or not-allowing 3^{rd} parties or device(s) of 3^{rd} parties to capture or record user's photo or video or one or more types of visual media. User is enabled to allow or not allow 1505 to capture photo or record video of user to other users. In the event of not allowing to capturing of photo(s) or recording video(s) of user to other users, if other users took visual media related to user then based on face recognition system identifies or recognized user's image (provided by user e.g. user's profile picture(s) or sample image model(s) or sample image(s) or video(s) of user) inside said captured photo(s) or recorded video(s) related image(s) and removes photo(s) or video(s) from capturer's device(s) or recorder's device(s) or in another embodiment removes photo(s) or video(s) from capturer's device(s) or recorder's device(s) immediately after capturing or ending of recording of video and not previewing or showing to capturer or recorder or visual media taker user and not saving at user device of photo capturer or video recorder or visual media taker user. In another embodiment user can allow or not allow to take visual media related to user to one or more types of one or more selected contacts, groups, networks, followers and one or more types of pre-defined users or target users including paid users or subscribed users, as per one or more conditions or rules e.g. Gender=Female (allow only to female), age range=18 to 25 (i.e. allow to users who are falls in 18 to 25 years age range) or one or more types of fields and associated values and enable to apply Boolean operator(s) between conditions or criteria 1522 and/or user can allow or not allow to take visual media related to user to authorized user as per schedule(s) 1525. In another embodiment user can apply default settings for determining allowing or not allowing of taking of visual media by other users related to user 1507. In another embodiment user can enable other users to take visual media of user based on real-time or each time auto asking to user for user's permission while capturing of user's photo or video by other users 1509. In another embodiment other users of network can request user to allow to capture user's visual media and in the event of acceptance of request other users of network can take visual media related to user 1512 as per one or more other settings including schedules, locations etc. In another embodiment user can set location(s) or place(s) (e.g. current location, checked-in place, defined place including work place, school place, shooting place, public place etc.), type of place (e.g. swimming pools etc.), define geo-fence boundaries where other users of network allow to or not allow to take user's photo or video or one or more types of visual media 1515. In another embodiment user can apply “Do Not Allow to Capture Visual Media” Rules & Settings including enabled or disabled settings, allow or not allow to anybody o contacts, allow or not allow to one or more contacts, allow to favorites contacts only, notify when somebody takes user's photo or video (event when allowed to them), not allow while mute, not allow to blocked users or type(s) of user(s), allow or not allow based on schedules, allow or not allow at one or more location(s) or place(s) or geo-location boundaries and any combination thereof.

In another embodiment user can select and apply settings for whether allow to store or not allow to store user's one or more types of visual media at visual media taker user's device 1592 including allow or not allow all other users of network or allow or not allow selected users or contacts or pre-defined type of users or allow to capture or record but not allow to store or access and/or auto send to user, for example user [Yogesh] captures photo 1554 via video camera(s) 1550 and/or 1552 integrated with spectacles 1555 and based on setting user [Yogesh] can store or access or preview or not-store or not-access or not-preview said captured visual media 1554 and auto send to user 1581 whose photo recognized inside said captured photo 1554 or 1581 based on face recognition technologies (user's digital spectacles e.g. user [Candice] 1555 connected with user's [Candice] device 200, so user can preview for set period of time 1543 before auto send to said recognized face associated person 1581 for enabling to review, cancel 1544 or change destination(s) or recipient(s) 1583).

In another embodiment user is notified with various types of notifications including receiving request from other users to allow to capture or record user's visual media or take visual media at particular place where user is administrator and enabling notification receiving user to accept or reject said request 1571. In another embodiment user can send request to other users to allow requesting user to capture their photos or videos 1572. In another embodiment when user are at particular place or point of interest or location and authorized user pre-set to not to allow to capture photos or videos of that place(s) or location(s) or within pre-defined geo-fence boundaries then when user tries to capture photo or record video then user is notified that user is not allowed to take visual media at said not-allowed pre-defined place(s) 1573 or when user tap on photo icon or video icon or one or more types of visual media capture controller control or label or icon then above icon or at prominent place message or indication is shown that “You are not allowed to take photo or video”.

In another embodiment authorized user (request to system administrator or register with system to authorize) can define geo-fence boundaries or defined location(s) or place(s) and/or schedule(s) and/or target criteria specific users for allowing or not allowing users of network or one or more selected users or defined type(s) of users including defined characteristics of users including type of similar interests, structured query language (SQL) or natural query specific, one or more fields and associated values or ranges and Boolean operators (e.g. Age Range=18 to 25 AND School=“ABC school” AND location or place=Paris), members, guests, customers, clients, invitation accepted users, invited users, request accepted users to capture photos or record videos within said pre-defined one or more geo-fence boundaries.

In another embodiment invention discussed in FIG. 15 can implemented via application programming language (API) so other camera applications, default device cameras can implement said invention.

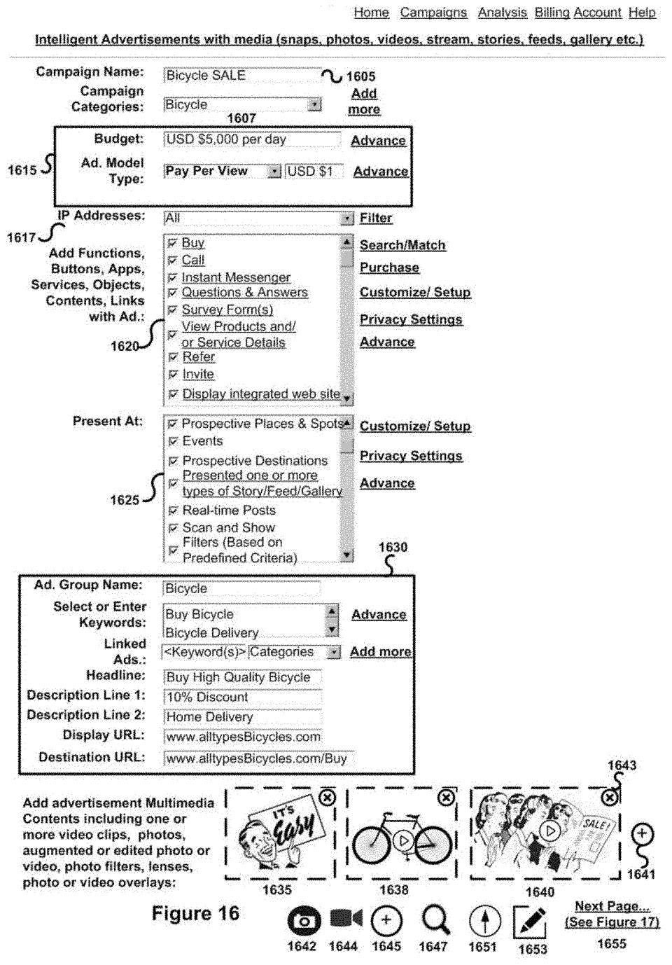

FIG. 16-17 illustrates user interface 270 for advertiser to create one or more advertisement campaigns including provide campaign name 1605, campaign categories 1607, provide budget for particular duration including daily maximum spending budget of advertisement, advertisement model including pay per view of advertised visual media by viewer 1615, associated target criteria including add, include or exclude IP addresses, search, match, select, purchase, customize, apply privacy settings & add one or more user actions, controls, functions, objects, buttons, interfaces, links, contents, applications, forms and like 1620, select one or more types of target destinations or applications or features where advertisements present to users or viewers 1625, provide advertisement group name, target keywords, linked advertisements, headline, description line 1 and description line 2 and links or Uniform Resource Locator (URL) 1630, add 1641 including capture photo 1642, record video 1644, select 1645, search 1647 & upload 1651 for verification, edit 1653 & remove 1643 advertisement related visual media items 1635, 1638 & 1640 which will show to target criteria specific viewing users, one or more target criteria including provide or add keywords 1761, provide one or more object criteria including add 1777 including capture photo 1764, select image or object model 1765, search image or object model 1766 and add and upload for verification 1767 or remove 1775 or 1776 one or more object models or sample image 1763 & 1770, object keywords 1762, object conditions including AND/OR/NOT/+/− 1769, wherein said visual media advertisement associated object criteria including object keywords and object model matched with pre-stored identified or recognized objects related keywords and/or recognized object(s) inside visual media items or identified visual media items which are ready to serve as particular story to users of network from storage medium 115 of server 110 and/or one or more 3^{rd} parties domains, servers, applications, access via web services or application programming language (API), storage mediums, databases, networks and devices and integrate or add or add in sequences of visual media said advertised visual media items with said one or more visual media stories which will serve to viewing user or followers or subscribers or searching users or requestor or receiving of auto present request or based on user scan (as discussed in FIG. 9-14).

User can provide one or more other criteria and object criteria including FIG. 17 illustrates user interface for advance search for providing target criteria for adding or integrating advertised visual media items with visual media stories which are presented to requestor or searching user or scanned user (discussed in detail in FIG. 9-14) based on said advance target criteria specific viewing users including searchers and viewing users of visual media items, following or subscribing users of sources of visual media items. Advertised user can provide various object criteria related to recognized object inside visual media items and criteria related to contents associated with visual media items. Advertised user can select or select as current location or select from map or select or define geo-boundaries, ranges or geo-fences or provide location(s) or place(s) or points of interest (POI(s)) 1719, 1721 & 1723 with intention to add advertised visual media item(s) to visual media viewing users of said provided one or more types of one or more locations 1019, 1021 & 1023 and/or provide one or more object models 1763 Or 1770 with intention to match provided object models with recognized or identified objects inside stored visual media items and match provided location(s) with location of viewers of visual media items where serve visual media items or match provided object model(s) with recognized object(s) inside visual media associated location(s). Advertised user can provide locations 1719, 1721 & 1723 with intention to match provided location(s) with content associated with visual media items and add or integrate advertised visual media items with served contents or visual media items of various types of stories requested by searching user, scanned user, followers (discussed in detail in FIG. 9-14). Advertised can provide object keywords or keywords including all these words/tags 1701 or 1706, this exact word or tag or phrase 1702 or 1707, any of these words 1703 or 1708, none of these words 1705 or 1709, Categories, Hashtags & Tags 1710 or 1713 recognized via optical character recognition (OCR), wherein said provided keywords and associated conditions or type matched with recognized objects inside pre-stored visual media items including photos and videos related or associated or identified or keywords. Advertised user is enabled to search, select and provide one or more types or categories or entities or user name(s) or contact(s) or group(s) or unique identities or names of viewing users for targeting advertised visual media items 1726. Advertise user can use structured query language (SQL) or natural query to identify or define type of viewing users of advertised visual media items for adding or integrating advertised visual media items to viewing users of stories. In an embodiment sources comprises phone contacts, groups, social network identities or user names, followers, categories or locations or taxonomy of users or sources, one or more 3^{rd} parties servers, web sites, applications, web services, devices, networks and storage mediums 1726. Advertise user can provide or define type of content or visual media items searching users, requesting users, scanned users, following users & viewing users of visual media items or stories (discussed in detail in FIG. 9-14) including one or more profile fields including gender, age or age range, education, qualification, home or work locations, related entities including organization or school or college or company name(s) and Boolean operators 1735. Advertise user can add one or more fields 1738. Advertise user can add or integrate advertised visual media item(s) e.g. 1635, 1638 & 1640 with visual media items which are most viewed 1755, most commented 1757, most ranked 1760, and most liked 1758 visual media items while serving and presenting to viewing users including searching users, requestors, followers or subscribers and scanned users (discussed in detail in FIG. 9-14).

Advertise user can limit adding or integrating advertised visual media item(s) with visual media items which are created at particular time or range of date & time or duration including any time, last 24 hours, past number of seconds, minutes, hours, days, weeks, months and years, range of date & time 1715. Advertiser user can provide language of creator or language associated with object inside visual media items or language associated with contents associated with visual media items 1717. After providing one or more advance search criteria as discussed above advertiser user can save or save as draft or update 1786 or discard 1787 said settings (wherein settings processes and saved at local storage of client device 200 and/or at server 110 via server module 176), target criteria and created advertisements and can start 1788 or pause 1789 or stop or cancel 1790 or scheduled to start 1791 advertisement campaign. Advertise user can create new campaign 1782, view and manage existing campaign(s) 1793, add new advertisement group 1795, view and manage existing advertisement group(s) 1796, create new advertisement 1785 and view statistics & analytics 1798 for all or selected campaigns related advertisements performance including number of viewers of visual media advertisements as per each provided advertisement criteria, associated spending, number of users who access advertisement associated one or more types of user actions or controls 1620, number of visual media item(s) presented at particular type of applications, interfaces, features, feeds, and stories 1625 and like.

For example when user provides keyword “Bicycle” 1761, which will match with content associated with visual media items at storage medium 115 of server 110 and/or one or more 3^{rd} parties domains, servers, applications, services, devices, storage mediums & databases access via web services & application programing language (APIs) at the time of adding or integrating advertised visual media item(s) which are presented to searching user or requesting users of visual media items, when advertised user provides object keyword “Bicycle” 1762, which will match with pre-identified and pre-stored recognized objects inside visual media items related keywords at server 110 at the time of adding or integrating advertised visual media items with visual media items presented to searching or requesting users or viewing users to find out matched visual media items viewers, when advertised user provides object model or sample image of Bicycle 1763 OR 1770, which will match with objects inside visual media items including photos or images of videos based on employing image recognition technologies, system & methods at server 110 at the time of adding or integrating advertised visual media items with presented visual media items at searching user's or viewing user's interface and after providing said one or more keywords, object criteria and one or more advance visual media advertisement target criteria when user execute or start campaign 1788 then server 110 searches and matches target criteria specific viewers and adds, integrates, add in sequences of visual media items and presents advertised visual media items e.g. 1635 or 1638 or 1640 at user interface e.g. 997 or 1107 or 1130 or 1135 or 1223 or 1237 or 1273 or 1323 or 1383 or 1965 or 2626 or 2644 or 2626 2736 or 2744 or 3965 or 44413 or 4813 5438 or 5865 or 6305 or 6350 or 6372 or 63926683 on user device.

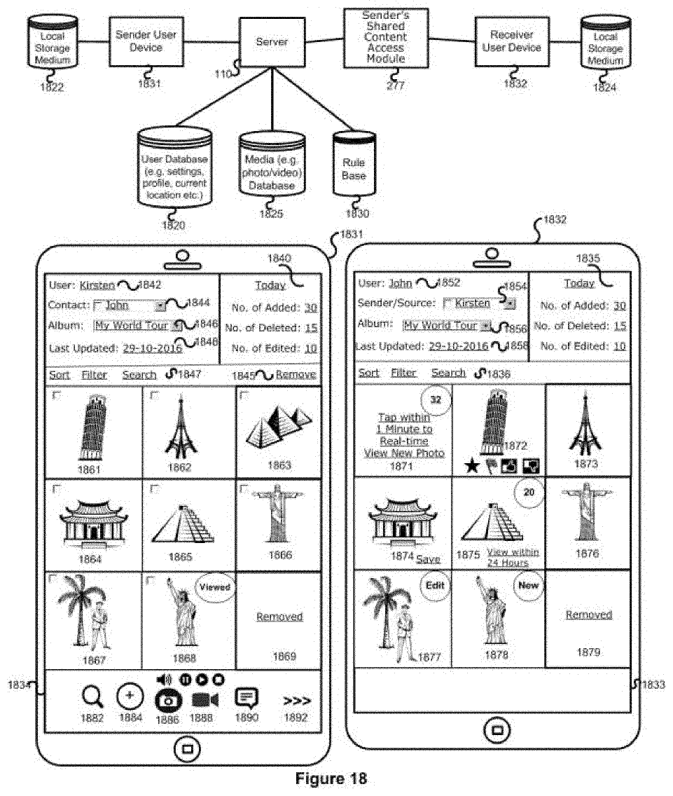

FIG. 18 illustrates user interface 271 for enabling user to add to selected or auto determined one or more recipient(s) or destination(s)'s local storage or sender named folder or gallery or album or feed of web page or application or interface or send or post or share or broadcast one or more types of content items or visual media items including select 1884, search 1882& capture 1886 photo(s), select 1884, search 1882 & record videos and/or voice 1888, augment or edit or apply one or more photo filters, and overlays on visual media, broadcast live stream, prepare, edit & draft text contents 1890 or any combination thereof from sender user device 1831 to one or more selected or pre-set or default or auto determined contacts or one or more types of one or more selected or pre-set or default or auto determined destinations e.g. recipient's device 1832. A server 110 via server module 177, comprising: a processor; and a memory storing instructions executed by the processor to: receives said posted content item(s) or visual media item(s) 1861-1869 from said sender or posting user or broadcaster user device e.g. 1831 for sending to one or more sender selected or target destination(s) or intended recipient(s) e.g. recipient's device 1832 or local storage medium 1824 of recipient's device 1832. Server 110 presents or sends or stores with recipient's permission or based on setting auto stores at local storage or stores at particular sender named gallery or album or feed or web page or application or interface or folder of recipient user's device 1832. Recipient user 1852 can search, filter, sort 1836 and select one or more senders or sources or content items or set or group or categories of content items or album 1856 and can access or view received content item(s) or visual media item(s) 1871-1879 from said selected sender or source 1854 at user interface 1833 of user device 1832. Sender user 1842 can search, filter, sort 1847 & select one or more recipients or destinations 1844 and can search, select, view, access, add or post new selected 1884 or search & selected 18882 or captured photo 1886 or recorded video 1888 or visual media item(s), update or remove 1845 from shared content item(s) or visual media item(s) by sender via sender user interface 1834, after add, update & remove changes or synchronization including employing of pull replication, push replication, snapshot & merge replication or updates will effect at recipient's device and/or access from server, after add, update & remove changes or synchronization or updates will effect at recipient's device and/or access directly at said selected recipient's or destination's user interface 1834 at user device 1831 via e.g. emulator for enabling sending user 1842 to access said posted content items 1861-1869 at recipient device 1832. In an embodiment user can add invitation to add contacts or destinations. In an embodiment user can block or mute one or more senders or sources or contacts to receive contents. In an embodiment user can scheduled to receive contents from one or more selected sources or senders. In an embodiment user can apply do not disturb settings to receive from all or selected or favorite contacts, receive when user is online, receive at particular schedules date & time. In an embodiment send push notification regarding receiving of new or updated or removal of one or more content item(s) or visual media item(s). In an embodiment receive new, updated content item(s) or visual media item(s) in background mode or without prompting or notifying or alerting to recipient user and auto update or synchronize new, updated & removed content item(s) or visual media item(s) at recipient user device 1832 or interface 1833. In an embodiment in the event of addition, updating and removal of one or more content item(s) or visual media item(s) at sender user's or source user's or creator user's device 1831 or local storage medium 1822 of creator user's device 1831 or interface 1834 or gallery or feed or folder or story, auto synchronization or addition, updating and removing of said added or updated or removed by source user at one or more recipient's user device 1832 or storage medium of 1824 of recipient's user device 1832 or user interface 1833 or gallery or feed or folder or story. In an embodiment sender can apply content item or visual media sending and access settings for one or more contact(s) or target recipient(s) or destination(s) as discuss in detail in FIG. 7. In an embodiment receiver can apply content item or visual media receiving, presenting and access settings for one or more contact(s) or sender(s) or source(s) as discuss in detail in FIG. 8. In an embodiment sender can view various status including content or visual media sent or post or add new, received at server or by recipient at recipient's device, viewed or not-viewed by recipient, recipient is online or offline, update by sender, remove by sender, saved by recipient, screenshot taken by recipient, auto removed from recipient's device based on ephemeral settings as discussed in detail in FIG. 7. In an embodiment sender can allow receiver to save, re-share, rate, make comment, like or dislike, update or edit and remove content items. In an embodiment sender can select one or more content items or visual media items and select one or more recipients and select one or more user action(s) including add new or updated or post new or updated, real-time view only, view within pre-set duration after that remove, view for particular number of times within particular life duration after that auto remove, view within particular life duration after that auto remove (as discussed in FIG. 7) and remove at/from said selected one or more recipient(s)′ device(s).

In an embodiment the server receives a selection of a content view setting(s) and rule(s) (as discussed in detail in FIG. 7) to be associated with the destination(s) or recipient(s) e.g. 1832 from the user 1831, the content view setting(s) and rule(s) establishing one or more destination(s) or recipient(s) allowed to view the content item(s) 1861-1869 sent by sender 1831; and presenting content item(s) e.g. 1833 to each destination or recipients e.g. 1832 based on applied one or more content view setting(s) and rule(s) (as discussed in detail in FIG. 7).

In an embodiment sender(s) or source(s) of content is/are enabled to send one or more types of one or more media with associated applied or pre-set view settings, rules and conditions and associated dynamic actions to one or more contacts, connections, followers, targeted recipients based on one or more target criteria or contextual users or network, destinations, groups, networks, web sites, devices, databases, servers, applications and services.

In an embodiment sender(s) or source(s) 1831 or 1842 of content 1861-1869 is/are enabled to access shared contents or media 1861-1869 and update or apply view settings at one or more recipient's ends 1832 or 1852 or at one or more devices, applications, interfaces e.g. 1833, web page or profile page, and storage medium of recipients 1832 or 1852.

In an embodiment view settings, rules and conditions including remove after set period of time, set period of time to view each shared media item, particular number of or type of reaction required or required within particular set period of time for second time receiving of shared content.

In an embodiment content including one or more type of media including photo, video, stream, voice, text, link, file, object or one or more types of digital items.

In an embodiment access rights including add new or send one or more types of media, delete or remove, edit one or more types of media, update associated viewing settings for recipient including update set period of time to delete message, allow to save or not, re-share allow or not, sort, filter, search.

In an embodiment enabling sender to select one or more media items at sender's device or application or interface or storage medium or explorer or media gallery and select one or more contacts or user names or identities or destinations and send or send updated or update.

In an embodiment enabling sender to select one or more media items at sender's device or application or interface or storage medium or explorer or media gallery and select one or more contacts or user names or identities or destinations whom sender sends said media item(s) and remove.

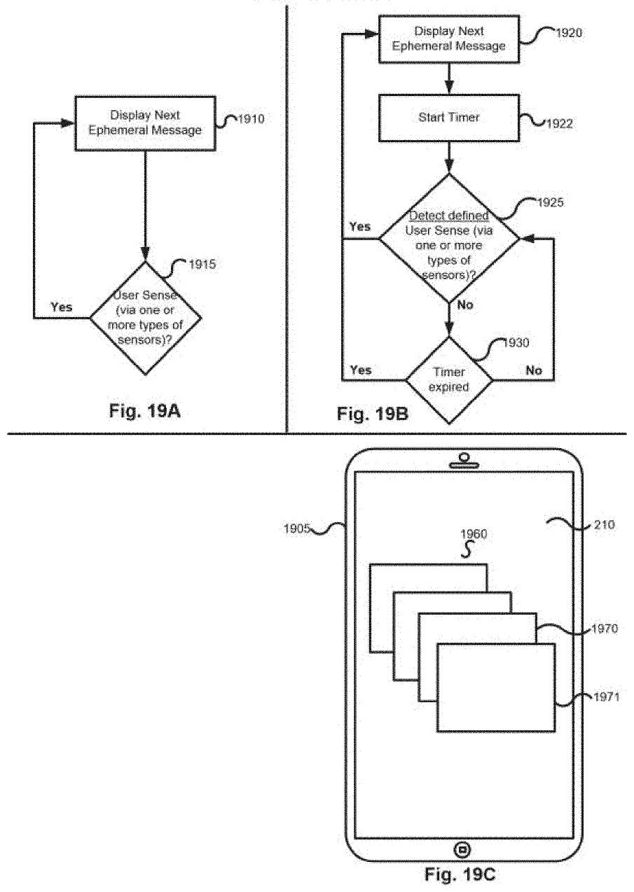

FIG. 19 illustrates processing operations associated with accelerated display of ephemeral messages in accordance with an embodiment of the invention and illustrates the exterior of an electronic device implementing accelerated display of ephemeral messages in accordance with the invention. FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 275 to implement operations of the invention. The ephemeral message controller 275 includes executable instructions to accelerate display of ephemeral messages. An ephemeral message may be a text, an image, a video and the like. The display time for the ephemeral message is typically set by the message sender. However, the display time may be a default setting or a setting specified by the recipient. Regardless of the setting technique, the message is transitory.

The processor 230 is also coupled to image sensors 244. The image sensors 244 may be known digital image sensors, such as charge coupled devices. The image sensors capture visual media, which is presented on display 210. The processor 230 is also coupled to one or more sensors including Orientation Sensor 237, Position Sensor 242, GPS Sensor 238, Audio sensor 245, Proximity Sensor 246, Gyroscope 247, Accelerometer 248 and other one or more types of sensors 250 including hover sensor, eye tracking system via optical sensors 240 or image sensors 244. In one embodiment, the ephemeral message controller 275 monitors signals or senses or one or more types of pre-defined equivalents of generated or updated sensor data from the one or more sensors including voice command from audio sensor 245 or particular type of eye movement from eye tracking system based on image sensors 244 or optical sensors 240 or hover signal from e.g. specific type of proximity sensor 246. If one of the pre-defined types of said senses detected or is observed by the said one or more types of sensors during the display of an ephemeral message, then the display of the existing message is terminated and a subsequent ephemeral message, if any, is displayed. In one embodiment, two types of signals or senses from sensors may be monitored. A continuous signal or senses from one or more types of sensors may be required to display a message, while an additional sensor signal or sense may operate to terminate the display of the message. For example, the viewer might instruct via voice command or hover on display or done one or more types of pre-defined eye movement. This causes the screen to display the next piece of media in the set. In one embodiment, the one or more types of pre-defined signal or senses provide by user and detected or sense by sensor to terminate a message while media viewer application or interface is open or while viewing of display 210. In another embodiment, the sensor signal or sense is any sense applied on the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 100 may also include other components commonly associated with a smartphone, such as a wireless signal processor 220, a power control circuit 225 and a global positioning system processor 242. While many of components of FIG. 2 are known in the art, new functionality is achieved through the ephemeral message controller 275.

FIG. 19 (B) illustrates processing operations associated with the ephemeral message controller 275. Initially, an ephemeral message is displayed 1920 (In an embodiment message can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof). A timer is then started 1922. The timer may be associated with the processor 230.

One or more types of user sense is/are then monitored, tracked, detected and identified 1925. If pre-defined user sense identified or detected or recognized or exists (1925—Yes), then the current message is deleted and the next message, if any, is displayed 1920. If user sense does not identified or detected or recognized or exist (1925—No), then the timer is checked 1930. If the timer has expired (1930—Yes), then the current message is deleted and the next message, if any, is displayed 1920. If the timer has not expired (1930—No), then another user sense identification or detection or recognition check is made 1925. This sequence between blocks 1925 and 1930 is repeated until one or more types of pre-defined user sense is identified or detected or recognized or the timer expires.

In an embodiment in FIG. 19 (A) illustrates processing operations associated with the ephemeral message controller 275. Initially, an ephemeral message is displayed 1910 (In an embodiment message can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof). One or more types of user sense is/are then monitored, tracked, detected and identified 1915. If pre-defined user sense identified or detected or recognized or exists (1915—Yes), then the current message is deleted and the next message, if any, is displayed 1910, then another user sense identification or detection or recognition check is made 1915. This sequence between blocks 1910 and 1915 is repeated until one or more types of pre-defined user sense is identified or detected or recognized or the timer expires.

FIG. 19 (C) illustrates the exterior of electronic device 200. The Figure also illustrates the display 210. The display 210 presents a set of ephemeral messages 1960 available for viewing. A first message 1971 may be displayed. Upon expiration of the timer, a second message 1970 is displayed. Alternately, if one or more types of pre-define user sense or user sense data or signal via one or more types of sensor is received before the timer expires the second message 1970 is displayed.

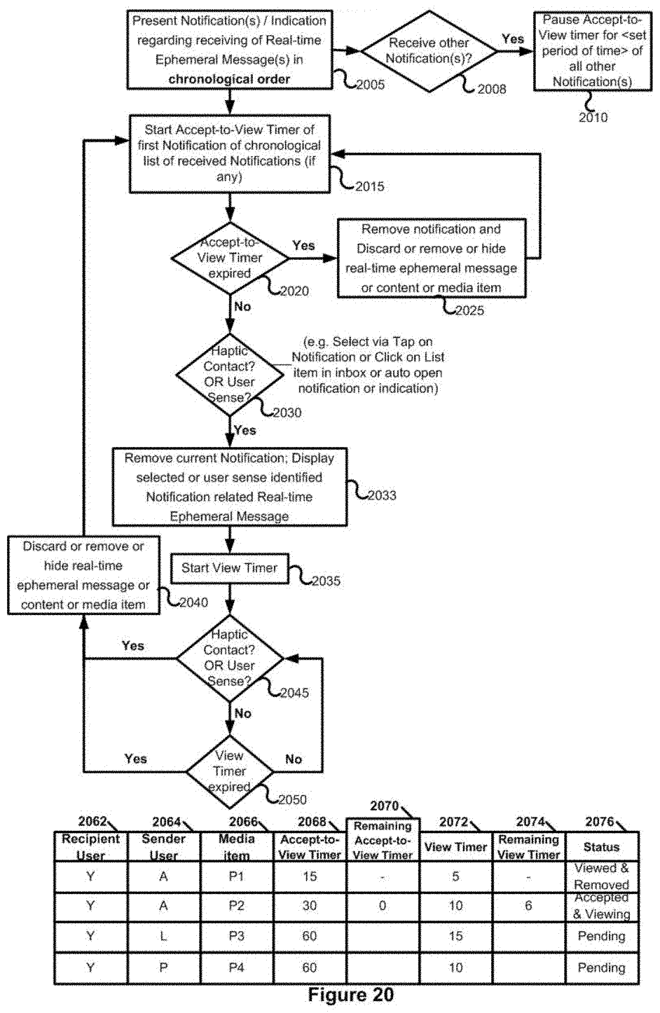

FIG. 20 illustrates processing operations associated with real-time display of ephemeral messages in accordance with an embodiment of the invention. An real-time ephemeral message controller 276 with instructions executed by a processor to: present notification(s) or indication 2005 regarding receiving of Real-time Ephemeral Message(s) (In an embodiment message can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof) in chronological order; in the event of receiving of other notification(s) 2008, pause Accept-to-View timer for pre-set period of time of all other received Notification(s) 2010; start Accept-to-View Timer of first Notification of chronological list of received Notifications (if any) 2015; in the event of Accept-to-View Timer expired 2020 remove notification and discard or remove or hide real-time ephemeral message or content or media item 2025; in the event of Haptic Contact or User Sense or click or tap on particular Notification or click on List item in inbox or auto open of notification, remove current Notification and display selected or user sense identified Notification related Real-time Ephemeral Message on the user display 2033; start view timer 2035; in the event of Haptic Contact or user sense 2045 or expiry of view timer 2050, discard or remove or hide real-time ephemeral message or content or media item 2040.

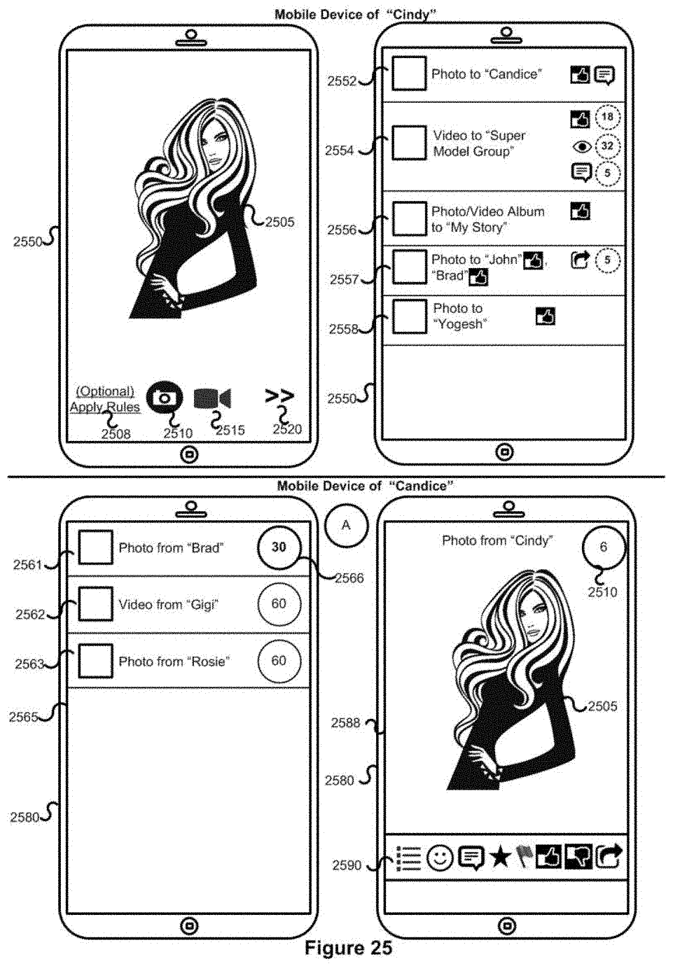

FIG. 20 illustrates a data structure for real-time ephemeral messages. FIG. 25 (A) illustrates the exterior of an electronic device implementing real-time accelerated display of ephemeral messages in accordance with the invention. A column 2062 may have a recipient user's unique identity, a column 2064 may have a sender user's unique identity, a column 2066 may have a list of messages or media items. Another column 2068 may have a list of message accept-to-view duration parameters for individual messages, wherein accept-to-view timer is a pre-set duration within which user have to accept notification or view indication or tap on notification to open & view message. Another column 2072 may have a list of message display or message view duration parameters for individual messages, wherein message display or message view duration is a pre-set duration within which user have to view said presented message and in the event of expiry of said view duration timer said message is removed and another message is presented (if any). For example user “Cindy” selects or takes visual media including photo 2510 or video 2515 and select contacts 2520 e.g. contact user [Candice] and send said visual media item 2505. The recipient user e.g. [Candice] receives and presented with said message contains said visual media item on user interface or indication list or notification list or inbox 2565. Observe in this example that the first received message user viewed and in the event of expiry of view timer, message [P1] removed, and user accepts second message notification within accept-to-view timer and in the event of acceptance of notification or tapping on indication or notification or inbox-item message is presented user and view timer started and reaming time 2074 is now e.g. 6 seconds 2510, after expiry of said remaining time of 6 seconds 2510, said presented message 2505 is removed and user is enabled to accept next message notification 2561 within next message associated accept-to-view timer 2566 or based on settings user is directly presented with next message without providing accept-to-view timer duration and in the event of next message presentation, system starts view timer or display timer, within which user have to view message and in the event of expiry of said view duration timer, system removes messages and present next message 2562 (if any). In an embodiment recipient user in real-time i.e. before expiry of view timer 2510 can provide one or more types of user reactions including like, dislike, comment, re-share or save based on sender's permission or privacy settings, report, rating on said visual media 2505. In an embodiment sender user can in real-time view said reactions 2552 from one or more recipient users (e.g. from user interface 2590 of user [Candice]'s device 2580) of said shared or sent visual media 2505. In an embodiment sender user can apply settings as discussed in FIG. 7. In an embodiment recipient user can apply settings as discussed in FIG. 8.

In the event of non-acceptance of notification or indication based on settings system remind or re-send non-accepted or pending notifications for particular pre-set number of times only and after re-sending of notifications for said particular pre-set number of times system removes message from the server 110. In an embodiment system after sending of first notification or indication about receiving message, remind or re-send non-accepted or pending notifications for particular pre-set number of times only based on identification of recipient is online, when recipient user's manual status is “available” or “online” & like, remind or re-send after pre-set interval duration, re-send when user is not muted, re-send based on sender's scheduled availability, re-send based on “Do not disturb” policy or settings of recipients including sender is allowed to send & like, re-send when recipient user is not block sender and when particular application or interface is open, and determine that user device is open and user is busy in pre-define activities including calling or attending phone call of others, busy in texting via instant messenger(s) and determine that user is not busy and currently doing non-busy pre-defined activities including playing games, browsing social networks & like. So remind or re-send notification when user is not busy. So present invention makes possible maximum real-time or near real-time sending and viewing of messages.

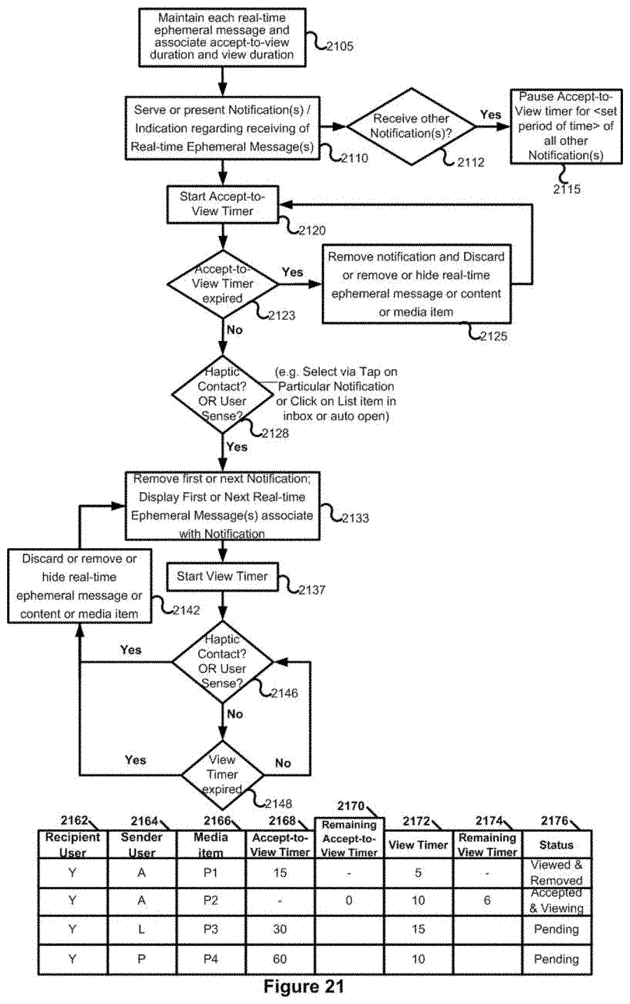

In another embodiment in FIG. 21 illustrates processing operations associated with real-time display of ephemeral messages in accordance with an embodiment of the invention. An real-time ephemeral message controller 276 with instructions executed by a processor to: the first processing operation of FIG. 21 is to maintain each real-time ephemeral message and associate accept-to-view duration and view duration 2105; the next processing operation of FIG. 21 is to serve or present notification(s) or indication regarding receiving of real-time ephemeral message(s) or present on a display indicia of one or more notification(s) of receiving of real-time ephemeral messages available for viewing 2110 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof); At 2120 start accept-to-view timer(s) associate with notification and pause accept-to-view timer of all other received notifications 2115; in response to expire of accept-to-view timer 2123 associate with notification, remove or disable notification(s) and/or remove real-time ephemeral message(s) 2125; and in the event of not expiring of said accept-to-view timer and in response to receiving from a touch controller 215 the haptic contact signal indicative of a gesture applied to the display or receiving from a sensor controller one or more types of pre-defined user sense via one or more types of sensors of user device 200 or receiving from a touch controller the haptic contact signal indicative of a gesture applied on the notification area or tap or click on notification 2128, remove first or next notification and display first or next Real-time Ephemeral Message associate with Notification 2133; At 2137 start view timer; in response to receiving from a touch controller 215 the haptic contact signal indicative of a gesture applied to the display or receiving from a sensor controller one or more types of pre-defined user sense via one or more types of sensors of user device (200) 2146 or in the event of expiry of view timer 2148, discard or remove or hide real-time ephemeral message or content or media item 2142.

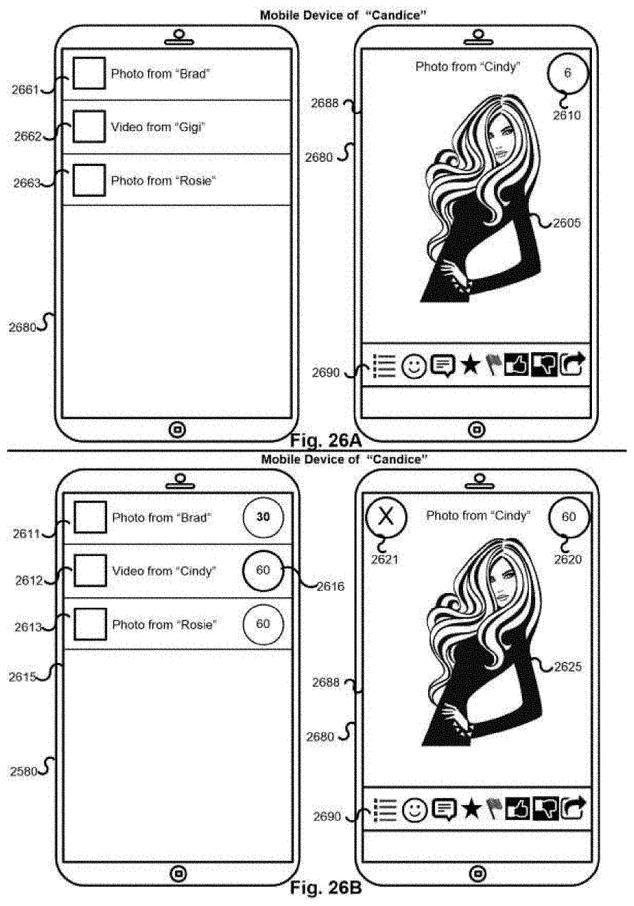

FIG. 21 illustrates a data structure for real-time ephemeral messages. FIG. 26 (A) illustrates the exterior of an electronic device implementing real-time accelerated display of ephemeral messages in accordance with the invention. A column 2162 may have a recipient user's unique identity, a column 2164 may have a sender user's unique identity, a column 2166 may have a list of messages or media items. Another column 2168 may have a list of message accept-to-view duration parameters for individual messages, wherein accept-to-view timer is a pre-set duration within which user have to accept notification or view indication or tap on notification to open & view message. Another column 2172 may have a list of message display or message view duration parameters for individual messages, wherein message display or message view duration is a pre-set duration within which user have to view said presented message and in the event of expiry of said view duration timer said message is removed and another message is presented (if any). Observe in this example that the user tapped on notification about receiving of first message within accept-to-view time and viewed first received message 2605 within view time 2610 and in the event of expiry of view timer 2610, message [P1] 2605 removed, and in the event of receiving of second message [P2] 2661 while user is viewing first message [P1] 2605, user does not have to accepts second message notification within accept-to-view timer, user is directly presented with second message [P2] 2661 after expiry of timer 2610 and removal of first message [P1] 2605 and view timer associated with second message [P2] started and reaming time is now e.g. 6 seconds, after expiry of said remaining time of 6 seconds, said presented message [P2] is removed and in an embodiment in the event of receiving of next message notification not during viewing of second message [P2] but after viewing and removing of second message [P2], user is further enabled to accept or tap on next message [P3] notification within next message [P3] associated accept-to-view timer and in the event of acceptance or tapping on next message [P3] notification or indication within accept-to-view time, user is presented with next message [P3] and starts view timer associated with that message [P3] and in the event of expiry of view timer, message [P3] is removed and user is presented with next message (if any received and pending to view) e.g. ephemeral message [P4].

In an embodiment, in the event of non-acceptance of notification or indication based on settings system remind or re-send non-accepted or pending notifications for particular pre-set number of times only and after re-sending of notifications for said particular pre-set number of times system removes message from the server 110. In an embodiment system after sending of first notification or indication about receiving message, remind or re-send non-accepted or pending notifications for particular pre-set number of times only based on identification of recipient is online, while recipient user's manual status is “available” or “online” & like, remind or re-send after pre-set interval duration, re-send when user is not muted, re-send based on sender's scheduled availability, re-send based on “Do not disturb” policy or settings of recipients including sender is allowed to send & like, re-send when recipient user is not block sender, when particular application or interface is open, and determine that user device is open and user is busy in pre-define activities including calling or attending phone call of others, busy in texting via instant messenger(s) and determine that user is not busy and currently doing non-busy pre-defined activities including playing games, browsing social networks & like. So remind or re-send notification when user is not busy. So present invention makes possible maximum real-time or near real-time sending and viewing of messages.

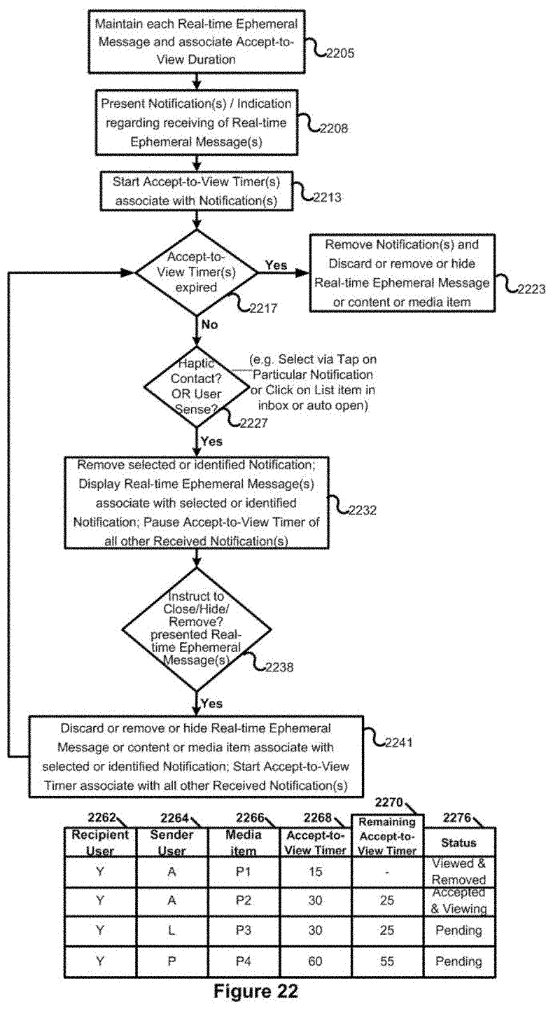

In another embodiment in FIG. 22 illustrates processing operations associated with real-time display of ephemeral messages in accordance with an embodiment of the invention. An real-time ephemeral message controller 276 with instructions executed by a processor to: maintain each Real-time Ephemeral Message and associate Accept-to-View Duration 2205; present Notification(s) or indication regarding receiving of Real-time Ephemeral Message(s) 2208 (In an embodiment message can serve by server 110 via server module 178 or serve from client device 200 storage medium or from message queue or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof); starts Accept-to-View Timer(s) associate with Notification(s) 2213; in the event of expiry of Accept-to-View Timer(s), remove Notification(s) and discard or remove or hide Real-time Ephemeral Message or content or media item 2223; in the event of not expiry of accept-to-view timer and in the event of Haptic Contact or User Sense or click or tap on Particular Notification or click on list item in inbox or auto open of message 2227, remove selected or identified Notification and display Real-time Ephemeral Message(s) associate with selected or identified Notification and pause Accept-to-View Timer of all other received Notification(s) 2232; in the event of receiving instruction to close or hide or intention to view next message (if any) or remove presented Real-time Ephemeral Message(s) 2238, discard or remove or hide Real-time Ephemeral Message or content or media item associate with selected or identified Notification and start Accept-to-View Timer associate with all other Received Notification(s) 2241.

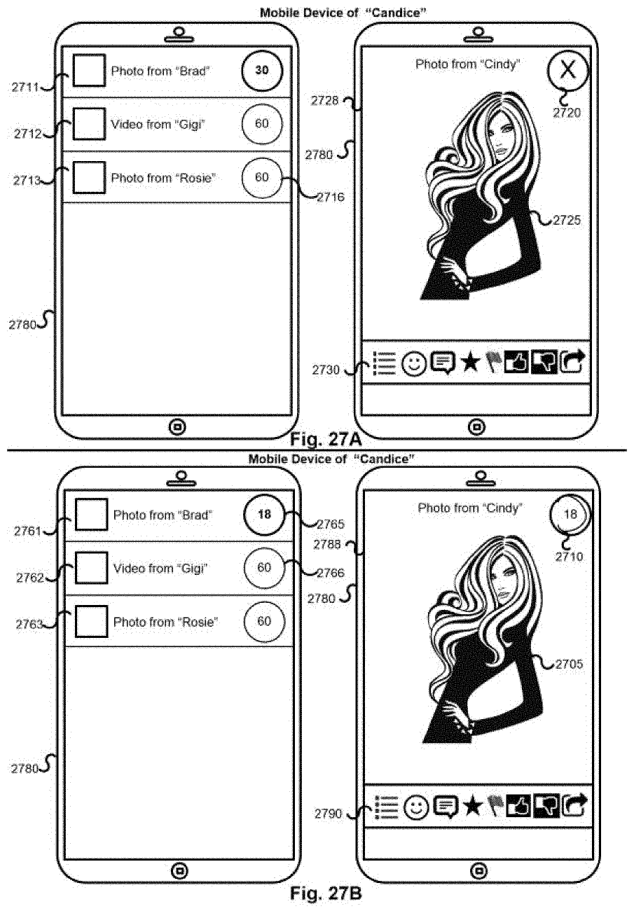

FIG. 22 illustrates a data structure for real-time ephemeral messages. FIG. 27 (D) illustrates the exterior of an electronic device implementing real-time accelerated display of ephemeral messages in accordance with the invention. A column 2262 may have a recipient user's unique identity, a column 2264 may have a sender user's unique identity, a column 2266 may have a list of messages or media items. Another column 2268 may have a list of message accept-to-view duration parameters for individual messages, wherein accept-to-view timer is a pre-set duration within which user have to accept notification or view indication or tap on notification to open & view message. Observe in this example that when the user tapped on notification about receiving of first message within accept-to-view time then user is presented with first received message 2705 and pause accept-to-view times of one or more received notification(s) (e.g. 2711, 2712 & 2713) about received message and user is enabled to view said presented first message 2725 up-to user instruction to close or hide or remove (e.g. tap on remove or hide or close icon 2720 or tap anywhere on user interface 2728 or display 210) said first message 2725 and in the event of user instruction to close or hide or remove said presented first message e.g. 2720, first message [P1] 2725 removed and starts accept-to-view timer(s) of all paused notification(s) (e.g. 2711, 2712 & 2713), and in the event of tapping on second notification or preferred notification e.g. 2713 within accept-to-view time of second notification 2716 present message and pause accept-to-view timer of all other received notification(s) (e.g. 2711& 2712) and in the event of user instruction to close or hide or remove presented second message [P2], close or hide or remove presented second message [P2] and starts timer of all other paused notification(s).

In an another embodiment when the user tapped on notification about receiving of first message within accept-to-view time then user is presented with first received message and pause accept-to-view times of one or more received notification(s) (e.g. 2611, 2612 & 2613) (FIG. 26 (C) illustrates the exterior of an electronic device implementing real-time accelerated display of ephemeral messages in accordance with the invention.) about received message and user is enabled to view said presented first message up-to expiry of associate view timer and/or user instruction to close or hide or remove said first message and in the event of expiry of message associate view timer and/or user instruction to close or hide or remove said presented first message, first message [P1] removed and starts accept-to-view timer(s) of all paused notification(s) (e.g. 2611, 2612 & 2613), and in the event of tapping on second notification or any preferred notification e.g. 2612 from list 2615 within accept-to-view time 2616 of second notification or preferred or selected message notification 2612, present message 2625 and pause accept-to-view timer of all other received notification(s) (e.g. 2611 & 2613) and in the event of expiry of message 2625 associate view timer 2620 and/or user instruction to close or hide or remove (e.g. tap on remove or hide or close icon 2621 or tap anywhere on user interface 2688 or display 210) presented second message [P2] 2625, close or hide or remove presented second message [P2] 2625 and starts timer of all other paused notification(s) (e.g. 2611 & 2613).

In an embodiment, in the event of non-acceptance of notification or indication based on settings system remind or re-send non-accepted or pending notifications for particular pre-set number of times only and after re-sending of notifications for said particular pre-set number of times system removes message from the server 110. In an embodiment system after sending of first notification or indication about receiving message, remind or re-send non-accepted or pending notifications for particular pre-set number of times only based on identification of recipient is online, while recipient user's manual status is “available” or “online” & like, remind or re-send after pre-set interval duration, re-send when user is not muted, re-send based on sender's scheduled availability, re-send based on “Do not disturb” policy or settings of recipients including sender is allowed to send & like, re-send when recipient user is not block sender, when particular application or interface is open, and determine that user device is open and user is busy in pre-define activities including calling or attending phone call of others, busy in texting via instant messenger(s) and determine that user is not busy and currently doing non-busy pre-defined activities including playing games, browsing social networks & like. So remind or re-send notification when user is not busy. So present invention makes possible maximum real-time or near real-time sending and viewing of messages.

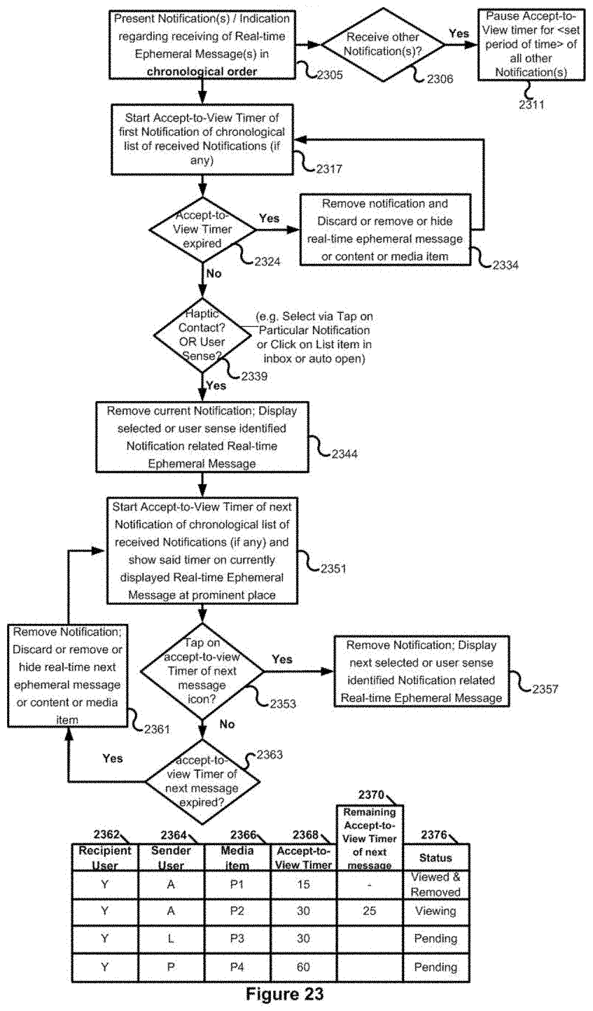

In another embodiment in FIG. 23 illustrates processing operations associated with real-time display of ephemeral messages in accordance with an embodiment of the invention. An real-time ephemeral message controller 276 with instructions executed by a processor to: present notification(s) or indication regarding receiving of Real-time Ephemeral Message(s) in chronological order 230 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof) 5; in the event of receiving of other notification(s) 2306, pause Accept-to-View timer for pre-set period of time of all other received Notification(s) 2311; start Accept-to-View Timer of first Notification of chronological list of received Notifications (if any) 2317; in the event of Accept-to-View Timer expired remove notification and discard or remove or hide real-time ephemeral message or content or media item 2334; in the event of not expiring of accept-to-view timer 2324 and in the event of Haptic Contact or User Sense or click or tap on particular Notification or click on List item in inbox or auto open of message 2339, remove current Notification and display selected or user sense identified Notification related Real-time Ephemeral Message on the user display 2344; start Accept-to-View Timer of next Notification of chronological list of received Notifications (if any) and show said timer with icon on currently displayed Real-time Ephemeral Message at prominent place 2351; in the event of haptic contact engagement or user sense or click or tap on presented timer icon showing remaining timer 2353, remove Notification and display next selected or user sense identified Notification related Real-time Ephemeral Message 2357; in the event of expiration of timer 2363, remove Notification and discard or remove or hide real-time ephemeral message or content or media item 2361 and Start Accept-to-View Timer of next Notification of chronological list of received Notifications (if any) and show said timer on currently displayed Real-time Ephemeral Message at prominent place 2351.

FIG. 23 illustrates a data structure for real-time ephemeral messages. FIG. 27 (E) illustrates the exterior of an electronic device implementing real-time accelerated display of ephemeral messages in accordance with the invention. A column 2362 may have a recipient user's unique identity, a column 2364 may have a sender user's unique identity, a column 2366 may have a list of messages or media items. Another column 2368 may have a list of message accept-to-view duration parameters for individual messages and another column 2368 may have a remaining Accept-to-View Timer of next message 2370, wherein accept-to-view timer is a pre-set duration within which user have to accept next notification or view indication or tap on next notification or tap on timer icon to open & view next message. Observe in this example that when the user tapped on notification about receiving of first message within accept-to-view time then user is presented with first received message 2705 and pause accept-to-view times of one or more received notification(s) (e.g. 2761, 2762 & 2763) and user is enabled to view said presented first message 2705 and Start Accept-to-View Timer 2710 of next Notification 2761 of chronological list of received Notifications (if any) and show said timer 2710 on currently displayed Real-time Ephemeral Message 2705 at prominent place. In the event of tap or haptic contact engagement on accept-to view timer 2710, Remove Notification 2761; Display next Real-time Ephemeral Message 2761 and in the event of non-tapping on accept-to-view timer icon 2710 and expiry of accept-to-view timer of next message 2765, remove next message 2761 and start-accept-to-view timer of next of next 2766 message 2762.

In an embodiment, in the event of non-acceptance of notification or indication based on settings system remind or re-send non-accepted or pending notifications for particular pre-set number of times only and after re-sending of notifications for said particular pre-set number of times system removes message from the server 110. In an embodiment system after sending of first notification or indication about receiving message, remind or re-send non-accepted or pending notifications for particular pre-set number of times only based on identification of recipient is online, while recipient user's manual status is “available” or “online” & like, remind or re-send after pre-set interval duration, re-send when user is not muted, re-send based on sender's scheduled availability, re-send based on “Do not disturb” policy or settings of recipients including sender is allowed to send & like, re-send when recipient user is not block sender, when particular application or interface is open, and determine that user device is open and user is busy in pre-define activities including calling or attending phone call of others, busy in texting via instant messenger(s) and determine that user is not busy and currently doing non-busy pre-defined activities including playing games, browsing social networks & like. So remind or re-send notification when user is not busy. So present invention makes possible maximum real-time or near real-time sending and viewing of messages.

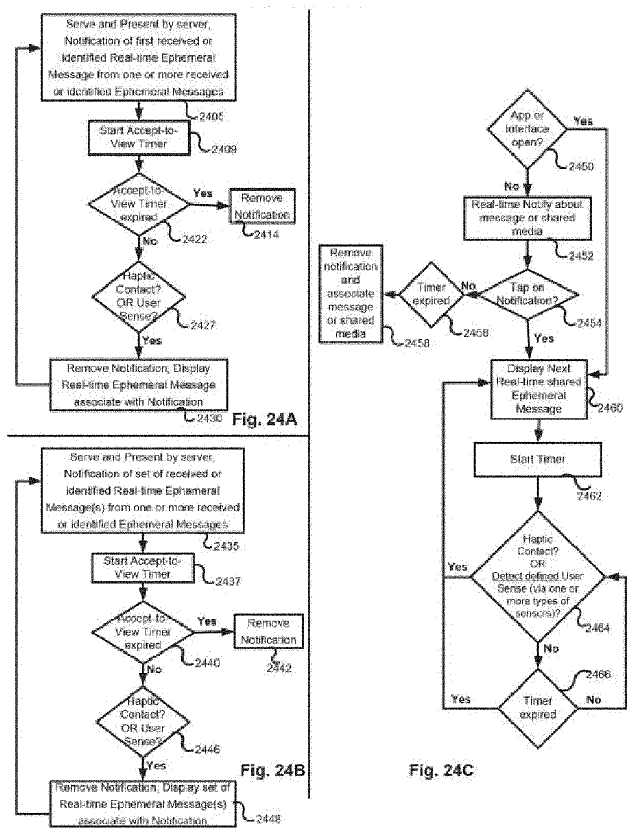

In another embodiment in FIG. 24 (A) illustrates processing operations associated with real-time display of ephemeral messages in accordance with an embodiment of the invention. An real-time ephemeral message controller with instructions executed by a processor to: maintain by the server system, each real-time ephemeral message and associate accept-to-view duration; present by the server system, on the display first notification for providing indication of receiving of first real-time ephemeral message from received or identified one or more ephemeral messages 2405 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof); start accept-to-view timer associate with first notification of receiving of first ephemeral message 2409; in response to expire of accept-to-view timer associate with first notification of receiving of first ephemeral message 2422, remove or disable first notification 2414; in response to receiving from a touch controller the haptic contact signal indicative of a gesture applied to the display or receiving from a sensor controller pre-defined user sense or receiving from a touch controller the haptic contact signal indicative of a gesture applied on the notification area or tap or click on first notification 2427, present on the display, by the server system, a first real-time ephemeral message and remove first notification 2430; in response to removal of first notification or viewing of first real-time ephemeral message, enable to the server system to present next or second notification on the display for providing indication of receiving of second real-time ephemeral message from received or identified one or more ephemeral messages 2405; start accept-to-view timer associate with second notification of receiving of second ephemeral message 2409; in response to expire of accept-to-view timer associate with second notification of receiving of second ephemeral message 2422, remove or disable second notification 2414; and in response to receiving from a touch controller the haptic contact signal indicative of a gesture applied to the display or receiving from a sensor controller pre-defined user sense or receiving from a touch controller the haptic contact signal indicative of a gesture applied on the notification area or tap or click on second notification 2427, present on the display, by the server system, a second real-time ephemeral message and remove second notification 2430.

In another embodiment in FIG. 24 (B) illustrates processing operations associated with real-time display of ephemeral messages in accordance with an embodiment of the invention. An real-time ephemeral message controller 276 with instructions executed by a processor to: maintain by the server system, each real-time ephemeral message and associate accept-to-view duration; present by the server system, first notification for providing indication of receiving of first set of real-time ephemeral message(s) from received or identified one or more ephemeral messages 2435 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof); start accept-to-view timer associate with first notification of receiving of first set of ephemeral message(s) 2437; in response to expire of accept-to-view timer associate with first notification of receiving of first set of ephemeral message(s) 2440, remove or disable first notification 2442; in response to receiving from a touch controller the haptic contact signal indicative of a gesture applied to the display or receiving from a sensor controller pre-defined user sense or receiving from a touch controller the haptic contact signal indicative of a gesture applied on the notification area or tap or click on first notification 24446, present on the display, by the server system, a first set of real-time ephemeral message(s) and remove first notification 2448; in response to removal of first notification or viewing of first set of real-time ephemeral message, enable to the server system to present next or second notification on the display for providing indication of receiving of second set of real-time ephemeral message(s) from received or identified one or more ephemeral messages 2435; start accept-to-view timer associate with second notification of receiving of second set of ephemeral message 2437; in response to expire of accept-to-view timer associate with second notification of receiving of second set of ephemeral message 2440, remove or disable second notification 2442; and in response to receiving from a touch controller the haptic contact signal indicative of a gesture applied to the display or receiving from a sensor controller pre-defined user sense or receiving from a touch controller the haptic contact signal indicative of a gesture applied on the notification area or tap or click on second notification 2446, present on the display, by the server system, a second set of real-time ephemeral message(s) and remove second notification 2448.

In another embodiment in FIG. 24 (C) illustrates processing operations associated with real-time display of ephemeral messages in accordance with an embodiment of the invention. An real-time ephemeral message controller 276 with instructions executed by a processor to: maintain each real-time ephemeral message and associate accept-to-view duration and view duration; determine that application or interface or display is open 2450; in the event of not opening of application, serve or present notification(s) or indication regarding receiving of real-time ephemeral message(s) or present on a display indicia of one or more notification(s) of receiving of ephemeral messages available for viewing 2452 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof); start accept-to-view timer 2409 associate with first received or selected notification and/or real-time ephemeral message for a first transitory period of time defined by associate accept-to-view timer; in response to expire of accept-to-view timer 2456 associate with first notification and/or first real-time ephemeral message, remove first notification and/or first real-time ephemeral message 2458; in response to receiving from a touch controller the haptic contact signal indicative of a gesture applied to the display or receiving from a sensor controller pre-defined user sense or receiving from a touch controller the haptic contact signal indicative of a gesture applied on the first notification area during the accept-to-view timer 2454, present on the display a first real-time ephemeral message for a first transitory period of time defined by a timer 2462, wherein the first real-time ephemeral message and notification is deleted when the first transitory period of time expires 2466 or receive from a touch controller a haptic contact signal indicative of a gesture applied to the display or receiving from a sensor controller pre-defined user sense during the first transitory period of time; wherein the real-time ephemeral message controller deletes the first real-time ephemeral message in response to the haptic contact signal or the pre-defined user sense 2464 and proceeds to present on the display a second real-time ephemeral message 2460 for a second transitory period of time defined by the timer (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof), wherein the real-time ephemeral message controller deletes the second real-time ephemeral message upon the expiration of the second transitory period of time 2466; wherein the second real-time ephemeral message and notification is deleted when the touch controller receives another haptic contact signal indicative of another gesture applied to the display or receives another pre-defined user sense during the second transitory period of time 2464, wherein timer associate with real-time ephemeral message notification defined or set by sender or server or recipient.

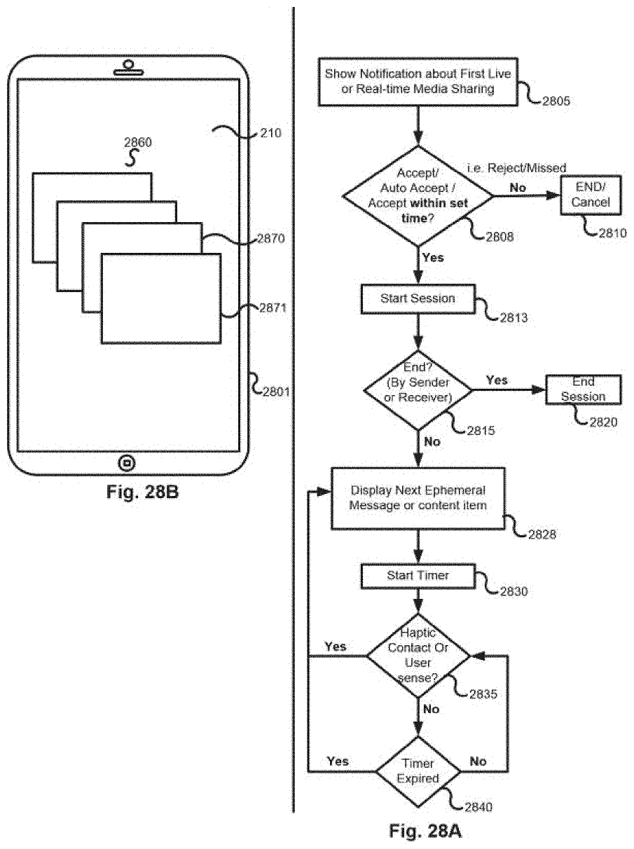

In another embodiment FIG. 28 illustrates processing operations associated with real-time session specific display of ephemeral messages in accordance with an embodiment of the invention. FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores a Real-time or Live Ephemeral Message Session Controller and Application 283 to implement operations of the invention. The Real-time or Live Ephemeral Message Session Controller and Application includes executable instructions to real-time or live accelerate display of ephemeral messages. An ephemeral message may be a text, an image, a video, a voice, a one or more types of multi-media, augmented or edited media and the like. The display time for the ephemeral message is typically set by the message sender. However, the display time may be a default setting or a setting specified by the recipient or a setting specified by the server or a setting auto determined based on type of sender, type of receiver, determined availability of receiver, number of messages pending to view, number of message sent by particular sender, type of relationship with sender, frequency of sharing between sender and receiver & like. Regardless of the setting technique, the message is transitory.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the Real-time or Live Ephemeral Message Session Controller 283 monitors signals from the touch controller 215. If haptic contact is observed by the touch controller 215 during the display of an ephemeral message, then the display of the existing message is terminated and a subsequent ephemeral message, if any, is displayed. In one embodiment, two haptic signals may be monitored. A continuous haptic signal may be required to display a message, while an additional haptic signal may operate to terminate the display of the message. For example, the viewer might tap the screen with a finger while maintaining haptic contact with another finger. This causes the screen to display the next piece of media in the set. In one embodiment, the haptic contact to terminate a message is any gesture applied to any location on the display 210. In another embodiment, the haptic contact is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the Real-time or Live Ephemeral Message Session Controller 283.

FIG. 28 (A) illustrates processing operations associated with the Real-time or Live Ephemeral Message Session Controller 283. Initially, a notification is displayed 2805. In the event of expiry of accept-to view-timer associated with notification or in the event of rejection via tapping on notification associated “Reject” button or control or link or image or in the event of receiving of rejection signal or pre-defined user sense indication rejection command or instruction from user via one or more types of one or more sensors of user device(s) or haptic contact engagement on “rejection” or “cancel” or “end” button or link or image or control or pre-defined area or identification of block of sender by recipient or identification of mute by recipient or identification of “Do Not Disturb” policies or settings by recipient including not allow recipient or not falls in scheduled to receive by recipient or auto determined busy status of recipient or identification of offline status of user 2808, reject or end or cancel or miss said notification associated session 2810 OR in the event of haptic contact engagement on notification area or identification or recognition of one or more type of pre-defined user senses via one or more sensors of user device(s) or in the event of acceptance by tapping on “Accept” button or icon or link or control associated with notification or in the event of auto accept based on pre-set auto accept settings or auto accept after expiry of pre-set period of time settings or accept within pre-set accept-to-view duration timer, start session (i.e. real-time sharing or sending, receiving and viewing session) 2813. In an embodiment after starting of session receiver or sender can any time haptic contact engagement or haptic contact swipe on tap on “end” button or link or image or control or pre-defined full or part of display area or detection or recognition or receiving of one or more types of pre-defined user senses via one or more types of one or more sensors of user device(s) instructing system to “end” session 2815 then end said started 2813 session 2820. In an embodiment after starting of session 2813 allowing one or more senders to capture one or more or series or sequences of photo or video or voice or one or more types of content items or visual media items or augment or edit & send or select & send or search, select & send or auto send one or more ephemeral messages or server send received or stored one or more ephemeral messages from one or more sources or senders to one or more target recipients or requesting user or searching user or auto determined recipients and add to ephemeral message queue(s) at each intended or targeted recipient's device(s) or interface(s) for presenting said ephemeral message(s) to recipient or viewer or an ephemeral message is displayed 2828. In an embodiment after starting of session 2813 an ephemeral message is displayed 2828. A timer is then started 2830. The timer may be associated with the processor 230.

In an embodiment message 2828 or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof.

In an embodiment Haptic contact is then monitored 2835. If haptic contact exists (2835—Yes), then the current message is deleted and the next message, if any, is displayed 2828. If haptic contact does not exist (2835—No), then the timer is checked 2840. If the timer has expired (2840—Yes), then the current message is deleted and the next message, if any, is displayed 2828. If the timer has not expired (2840—No), then another haptic contact check is made 2835. This sequence between blocks 2835 and 2840 is repeated until haptic contact is identified or the timer expires.

In another embodiment one or more types of pre-defined user sense(s) via one or more types of sensors (e.g. voice sensor (for detecting or recognizing voice command), image sensor (for tracking eye movement), and proximity sensor (recognizing hovering on particular area of display) as discussed in detail in FIG. 19) is/are then monitored 2835. If pre-defined user sense(s) or signal(s) detected or recognized or identified or exists (2835—Yes), then the current message is deleted and the next message, if any, is displayed 2828. If pre-defined user sense(s) or signal(s) does not detected or recognized or identified or exists (2835—No), then the timer is checked 2840. If the timer has expired (2840—Yes), then the current message is deleted and the next message, if any, is displayed 2828. If the timer has not expired (2840—No), then another user sense(s) or signal(s) check is made 2835. This sequence between blocks 2835 and 2840 is repeated until user sense(s) or signal(s) is identified or the timer expires.

FIG. 28 (B) illustrates the exterior of electronic device 200. The Figure also illustrates the display 210. The display 210 presents a set of ephemeral messages 2860 available for viewing. A first message 2871 may be displayed. Upon expiration of the timer, a second message 2870 is displayed. Alternately, if haptic contact or one or more types of pre-defined user sense(s) is received before the timer expires the second message 2870 is displayed.

In an embodiment instead of remove ephemeral messages, if message is non-ephemeral then system hide message. In another embodiment ephemeral message is conditional including enable recipient user to view message unlimited times within pre-set life duration and after expiry of said pre-set life duration remove message or allow recipient or viewing user to view message for pre-set number of times then remove message after passing said limit of viewing of message or allow recipient or viewing user to view message for pre-set number of times within pre-set life duration then remove message after expiry of said life duration or after passing said limit of viewing of message whichever is earlier.

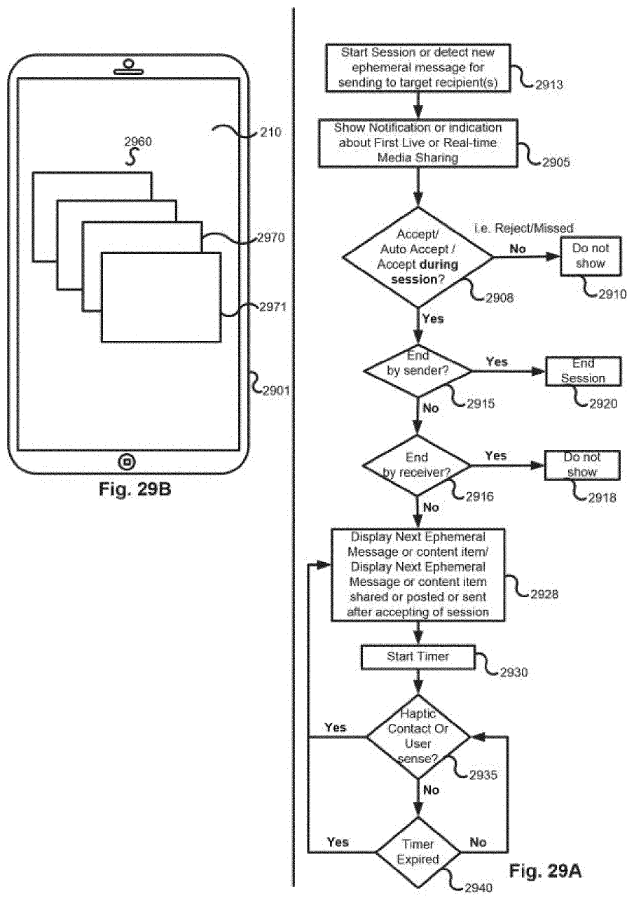

In another embodiment FIG. 29 illustrates processing operations associated with real-time session specific display of ephemeral messages in accordance with an embodiment of the invention. FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores a Real-time or Live Ephemeral Message Session Controller and Application 283 to implement operations of the invention. The Real-time or Live Ephemeral Message Session Controller and Application includes executable instructions to real-time or live accelerate display of ephemeral messages. An ephemeral message may be a text, an image, a video, a voice, a one or more types of multi-media, augmented or edited media and the like. The display time for the ephemeral message is typically set by the message sender. However, the display time may be a default setting or a setting specified by the recipient or a setting specified by the server or a setting auto determined based on type of sender, type of receiver, determined availability of receiver, number of messages pending to view, number of message sent by particular sender, type of relationship with sender, frequency of sharing between sender and receiver & like. Regardless of the setting technique, the message is transitory.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the Real-time or Live Ephemeral Message Session Controller 283 monitors signals from the touch controller 215. If haptic contact is observed by the touch controller 215 during the display of an ephemeral message, then the display of the existing message is terminated and a subsequent ephemeral message, if any, is displayed. In one embodiment, two haptic signals may be monitored. A continuous haptic signal may be required to display a message, while an additional haptic signal may operate to terminate the display of the message. For example, the viewer might tap the screen with a finger while maintaining haptic contact with another finger. This causes the screen to display the next piece of media in the set. In one embodiment, the haptic contact to terminate a message is any gesture applied to any location on the display 210. In another embodiment, the haptic contact is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the Real-time or Live Ephemeral Message Session Controller 283.

FIG. 29 (A) illustrates processing operations associated with the Real-time or Live Ephemeral Message Session Controller 283. Initially, in the event of starting of session start session 2913. After starting of session 2913 allowing sender or broadcaster or session starter to capture one or more or series or sequences of photo or video or voice or one or more types of content items or visual media items or augment or edit & send or select & send or search, select & send or auto send one or more ephemeral messages to one or more contacts and/or destinations. In the event of starting of session 2913 concurrently send and display notification or indication 2905 of starting of said session 2913 to one or more contacts and/or destinations selected or set by sender or session starter user. In the event of rejection via tapping on notification associated “Reject” button or control or link or image or in the event of receiving of rejection signal or pre-defined user sense indication rejection command or instruction from user via one or more types of one or more sensors of user device(s) or haptic contact engagement on “rejection” or “cancel” or “end” button or link or image or control or pre-defined area or identification of block by recipient to sender or ending of session identification of mute by recipient or identification of “Do Not Disturb” policies or settings by recipient including not allow recipient or not falls in scheduled to receive by recipient or auto determined busy status of recipient or identification of offline status of user 2908, then do not show shared or sent or broadcasted one or more types of visual media items or content items 2910 OR in the event of haptic contact engagement on notification area or identification or recognition of one or more type of pre-defined user senses via one or more sensors of user device(s) or in the event of acceptance by tapping on “Accept” button or icon or link or control associated with notification or in the event of auto accept based on pre-set auto accept settings or auto accept after expiry of pre-set period of time settings or accept within any time during session (i.e. accept any time before ending of currently started session), start presenting ephemeral message. In an embodiment after starting of session sender can any time haptic contact engagement or haptic contact swipe on tap on “end” button or link or image or control or pre-defined full or part of display area or detection or recognition or receiving of one or more types of pre-defined user senses via one or more types of one or more sensors of user device(s) instructing system to “end” 2915 session 2913 then end 2920 said started session 2913. In an embodiment after starting of session receiver can any time haptic contact engagement or haptic contact swipe on tap on “end” 2916 button or link or image or control or pre-defined full or part of display area or detection or recognition or receiving of one or more types of pre-defined user senses via one or more types of one or more sensors of user device(s) instructing system to “end” showing of ephemeral message(s) 2918. In an embodiment after accepting (2908=Yes and 2915=No and 2916=No) then an ephemeral message which is/are posted by sender from start of session 2913 (which is/are stored by server 110) is displayed 2928. A timer is then started 2930. The timer may be associated with the processor 230. In an embodiment after accepting (2908=Yes and 2915=No and 2916=No) then an ephemeral message which is/are posted by sender after accepting of said notification or indication is displayed 2928 (i.e. recipient user is not presented with contents which is posted by sender before acceptance). A timer is then started 2930. The timer may be associated with the processor 230.

In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof.

In an embodiment Haptic contact is then monitored 2935. If haptic contact exists (2935—Yes), then the current message is deleted and the next message, if any, is displayed 2928. If haptic contact does not exist (2935—No), then the timer is checked 2840. If the timer has expired (2940—Yes), then the current message is deleted and the next message, if any, is displayed 2928. If the timer has not expired (2940—No), then another haptic contact check is made 2935. This sequence between blocks 2935 and 2940 is repeated until haptic contact is identified or the timer expires.

In another embodiment one or more types of pre-defined user sense(s) via one or more types of sensors (e.g. voice sensor (for detecting or recognizing voice command), image sensor (for tracking eye movement), and proximity sensor (recognizing hovering on particular area of display) as discussed in detail in FIG. 19) is/are then monitored 2935. If pre-defined user sense(s) or signal(s) detected or recognized or identified or exists (2935—Yes), then the current message is deleted and the next message, if any, is displayed 2928. If pre-defined user sense(s) or signal(s) does not detected or recognized or identified or exists (2935—No), then the timer is checked 2940. If the timer has expired (2940—Yes), then the current message is deleted and the next message, if any, is displayed 2928. If the timer has not expired (2940—No), then another user sense(s) or signal(s) check is made 2935. This sequence between blocks 2935 and 2940 is repeated until user sense(s) or signal(s) is identified or the timer expires.

FIG. 29 (B) illustrates the exterior of electronic device 200. The Figure also illustrates the display 210. The display 210 presents a set of ephemeral messages 2960 available for viewing. A first message 2971 may be displayed. Upon expiration of the timer, a second message 2970 is displayed. Alternately, if haptic contact or one or more types of pre-defined user sense(s) is received before the timer expires the second message 2970 is displayed.

In an embodiment instead of remove ephemeral messages, if message is non-ephemeral then system hide message. In another embodiment ephemeral message is conditional including enable recipient user to view message unlimited times within pre-set life duration and after expiry of said pre-set life duration remove message or allow recipient or viewing user to view message for pre-set number of times then remove message after passing said limit of viewing of message or allow recipient or viewing user to view message for pre-set number of times within pre-set life duration then remove message after expiry of said life duration or after passing said limit of viewing of message whichever is earlier.

In an embodiment after accepting of session recipient can view first ephemeral message and in the event of closing of application or interface or non-viewing by recipient use (due to gap of duration between sending of first and second ephemeral message) then user is notifies about receiving of new ephemeral message.

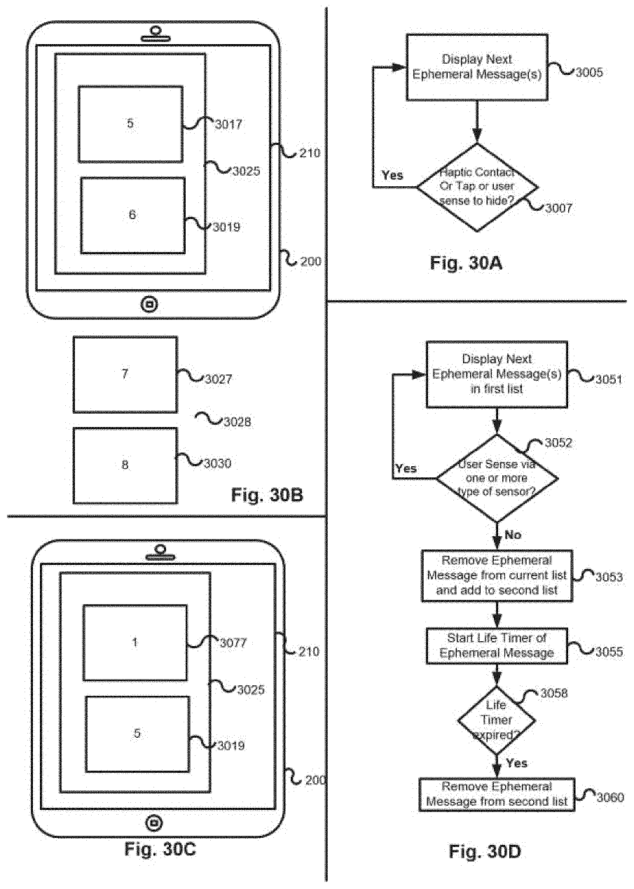

FIG. 30 illustrates processing operations associated with display of ephemeral messages and based on haptic contact engagement or tap on particular content item e.g. 3017 from list of presented on or more content items 3025, then hide said ephemeral messages 3017 or media items 3017 and load or present next available (if any) ephemeral messages e.g. 3027 and add or send said hided ephemeral messages 3017 or media items 3017 to another list illustrated in FIG. 30 (C) e.g. 3019, wherein user can further add or send said hided ephemeral messages 3017 or media items 3017 to list illustrated in FIG. 30 (B) or remove manually (by providing one or more types of remove instruction including e.g. double tap on content item or voice command to remove particular content item or tap on remove icon associated with each presented content item to removing the content item) or in the event of non-action on the user side on said hided ephemeral messages 3017 or media items 3017 and in the event of expiration of life timer or number of times allowed views associated with said hided ephemeral messages 3017 or media items 3017, system removes said hided ephemeral messages 3017 or media items 3017 from list illustrated in FIG. 30 (C) in accordance with an embodiment of the invention.

A non-transitory computer readable storage medium, comprising instructions executed by a processor to: displaying a set of or particular number(s) of list of content item(s) or visual media item(s) or ephemeral message(s) 3025 (e.g. 3027 and 3030); in response to receive haptic contact engagement or tap on particular content item e.g. 3017 then hide said ephemeral messages 3017 or media items 3017 and load or present next available (if any) ephemeral messages e.g. 3027. In an embodiment receive from a touch controller a haptic contact signal indicative of a gesture applied on the particular content item e.g. 3017 on the display 210, wherein the ephemeral message controller hides the ephemeral content item(s) e.g, 3017 in response to the haptic contact signal 3007 and proceeds to present on the display 210 a second ephemeral content item .g. 3027 of the collection of ephemeral content item(s) 3028 (e.g. 3027 and 3030), wherein system adds or sends said hided ephemeral messages 3017 or media items 3017 to another list illustrated in FIG. 30 (C) e.g. 3019, wherein user can further add or send said hided ephemeral messages 3017 or media items 3019 to list illustrated in FIG. 30 (B) or remove manually (by providing one or more types of remove instruction including e.g. double tap on content item or voice command to remove particular content item or tap on remove icon associated with each presented content item to removing the content item) or in the event of non-action on the user side on said hided ephemeral messages 3017 or media items 3017 and in the event of expiration of life timer or number of times allowed views associated with said hided ephemeral messages 3017 or media items 3017, system removes said hided ephemeral messages 3017 or media items 3017 from list illustrated in FIG. 30 (C).

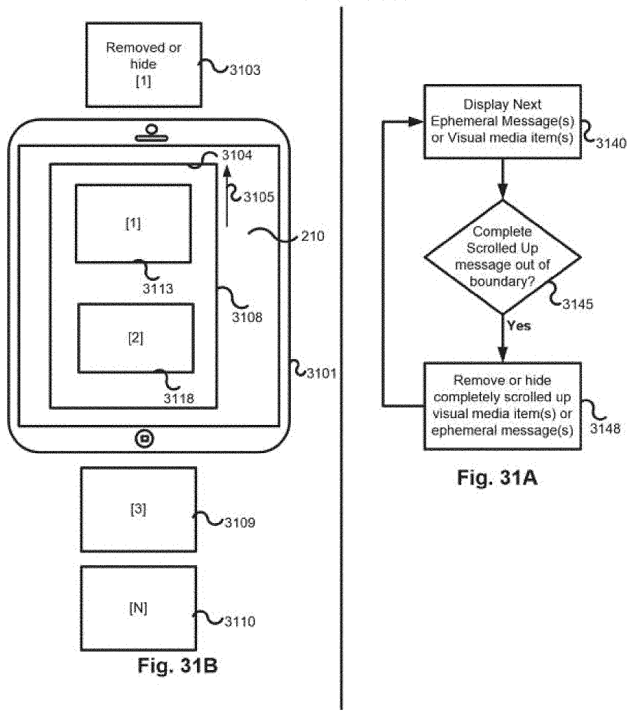

FIG. 31 illustrates processing operations associated with display of ephemeral messages and media item completely scroll-up to remove and append media item at the end of feed of or set of ephemeral messages in accordance with an embodiment of the invention.

A non-transitory computer readable storage medium, comprising instructions executed by a processor to: displaying a scrollable list of content items 3108 (e.g. 3113 & 3118); receiving input associated with a scroll command 3105; based on the scroll command identify complete scroll-up of one or more digital content items e.g. 3103 out of pre-defined boundary e.g. 3104, in response to identifying of complete scroll-up of one or more digital content items e.g. 3103, remove complete scrolled-up one or more digital content items e.g. 3103. In response to identifying of number of complete scroll-up of digital content item(s) e.g. 3103, append or update equivalent number of digital item(s) to a scrollable list of content items e.g. 3109.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the ephemeral message controller 277 monitors signals from the touch controller 215. If receiving input associated with a scroll command, then based on the scroll command identify complete scroll-up of one or more digital content items, in response to identifying of complete scroll-up of one or more digital content items, remove complete scrolled-up one or more digital content items or if haptic swipe contact is observed by the touch controller 215 and displayed visual media item completely scrolled up over pre-defined boundaries during the display of an ephemeral message, then the display of the existing message is terminated and a subsequent ephemeral message, if any, is displayed.

In another embodiment, the haptic swipe is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

In an embodiment FIG. 31 (A) illustrates processing operations associated with the ephemeral message controller 277. Initially, an ephemeral message is displayed 3140 (e.g. 3113 and 3118) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof). Haptic swipe is then monitored 3145. If haptic swipe leads to complete scrolling up of displayed visual media item (e.g. 3113) out of pre-defined boundary e.g. 3104 (3145—Yes), then the completely scrolled-up visual media item or message (e.g. 3113) is deleted (e.g. 3103) and the next message (e.g. 3109) 3140, if any, is appended to feed and displayed. This sequence is repeated until haptic swipe identified which leads to complete scrolling up of displayed visual media item out of pre-defined boundaries.

FIG. 31 (B) illustrates the exterior of electronic device 200. The Figure also illustrates the display 210. The display 210 presents a set of ephemeral messages 3108 available for viewing. A first one or more or set of message(s) e.g. 3113 & 3118 may be displayed. Upon complete scrolling up of displayed visual media item (e.g. 3113) out of pre-defined boundaries e.g. 3104, a second message or subsequent message(s) in queue 3109 is displayed.

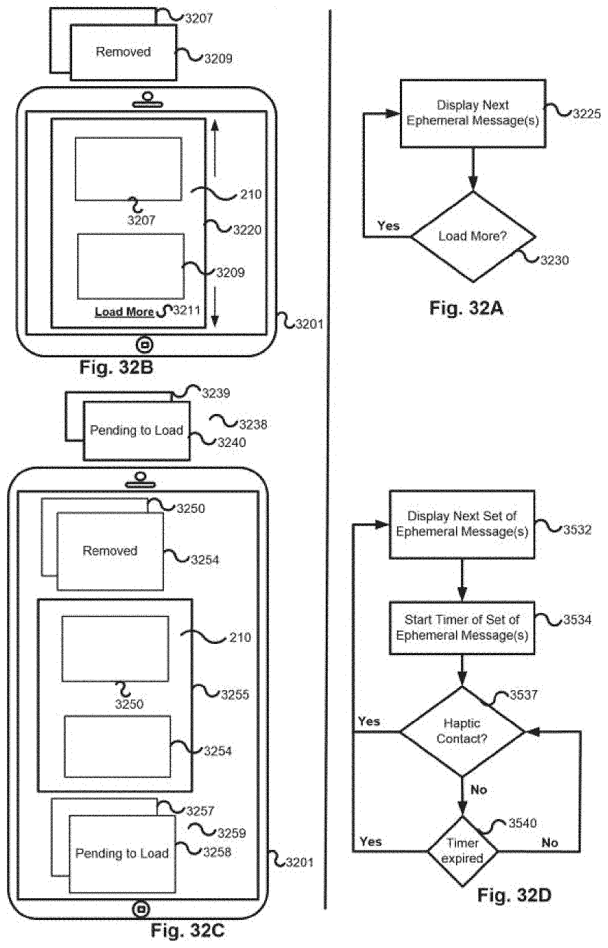

FIG. 32 illustrates processing operations associated with display of ephemeral messages and based on load more user action, remove currently presented ephemeral messages or media items and load or present next available (if any) set of ephemeral messages in accordance with an embodiment of the invention.

A non-transitory computer readable storage medium, comprising instructions executed by a processor to: displaying a set of or particular number(s) of list of content item(s) or visual media item(s) or ephemeral message(s) 3220 (e.g. 3207 and 3209); in response to receive instruction to load more or load next 3211 (if any available) or tap anywhere on screen r in an embodiment in the event of expiration of pre-set default timer or pre-set timer associated with presented set of contents, remove displayed list of content item(s) 3220 (e.g. 3207 and 3209) and displaying next set or particular number(s) of list (if any available) of content item(s) or visual media item(s) or ephemeral message(s) 3228 (e.g. 3238 and 3239), wherein receiving input associated with a load next command or receiving instruction to load next based on user input. In an embodiment receive from a touch controller a haptic contact signal indicative of a gesture applied on the “Load More” icon or button or link or control 3211 of the display 210, wherein the ephemeral message controller deletes the first set of ephemeral content item(s) 3220 (e.g. 3207 and 3209) in response to the haptic contact signal 3211 and proceeds to present on the display 210 a second set of ephemeral content item(s) of the collection of ephemeral content item(s) 3228 (e.g. 3238 and 3239).

A non-transitory computer readable storage medium of claim 158 wherein receive from a sensor controller a pre-defined user sense signal indicative of a user sense or gesture applied to the display, wherein the ephemeral message controller deletes the first set of ephemeral content item(s) in response to the user sense or sensor signal and proceeds to present on the display a second set of ephemeral content item(s) of the collection of ephemeral content item(s).

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the ephemeral message controller 277 monitors signals from the touch controller 215. If haptic contact on or tap or click load more icon is observed by the touch controller 215 or keyboard during the display of an ephemeral message, then the display of the existing message is terminated and a subsequent ephemeral message(s), if any, is displayed or in response to receive instruction to load more or load next (if any available), remove displayed list of content item(s) and displaying next set or particular number(s) of list (if any available) of content item(s) or visual media item(s) or ephemeral message(s). In one embodiment, the haptic contact to terminate a message is any gesture applied to any location on the display 210. In another embodiment, the haptic contact is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

In an embodiment FIG. 32 (A) illustrates processing operations associated with the ephemeral message controller 277. Initially, a set of visual media item(s) or content item(s) or ephemeral message(s) is/are displayed 3225 (e.g. 3207 and 3209) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof). Haptic contact on or tap on or click on “Load More” or “Load Next” icon or button or link or control is then monitored or user instruction to “Load More” or “Load Next” set of visual media item(s) or content item(s) or ephemeral message(s) is/are received (3230—Yes), then the current one or more or set of visual media item(s) or content item(s) or message(s) is/are deleted (e.g. 3207 and 3209) and the next one or more or set of visual media item(s) or content item(s) or message(s), if any, is/are displayed 3225, then another haptic contact on or tap on or click on “Load More” or “Load Next” icon or button or link or control check is made 3230. These sequences is repeated until haptic contact on or taps on or click on “Load More” or “Load Next” icon or button or link or control is identified.

FIG. 32 (B) illustrates the exterior of electronic device 200. The Figure also illustrates the display 210. The display 210 presents a set of ephemeral messages 3220 available for viewing. A first one or more or set of message(s) e.g. 3207 and 3209 may be displayed. Upon receiving of Haptic contact on or tap on or click on “Load More” or “Load Next” icon or button or link or control is then monitored or user instruction to “Load More” or “Load Next” set of visual media item(s) or content item(s) or ephemeral message(s), a second set of message(s) 3238 (e.g. 3239 and 3240) or subsequent message(s) in queue 3238 is/are displayed.

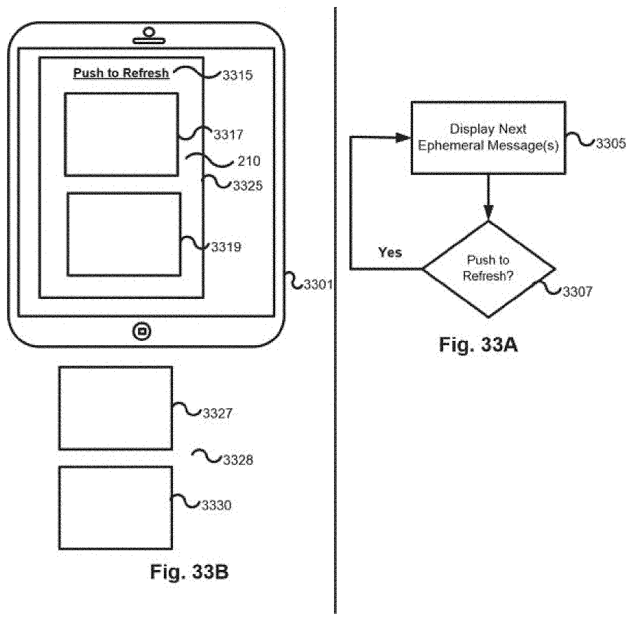

FIG. 33 illustrates processing operations associated with display of ephemeral messages and based on push to refresh user instruction or user command or user action remove currently presented ephemeral messages or media items and load or present next available (if any) set of ephemeral messages in accordance with an embodiment of the invention. In another embodiment while push to refresh remove currently presented ephemeral messages or media items and load or present next available (if any) set of ephemeral messages with earlier presented non-ephemeral message(s), wherein remove non-ephemeral message(s) based on life duration, date & time of posting or presenting, mark as viewed or not-viewed, numbers of viewers, numbers of views, numbers of views within particular period of time, numbers of reactions including likes, dislikes, comments, and ratings, user relationship with posting user or sending user, frequency of posting and viewing between sender and viewer.

A non-transitory computer readable storage medium, comprising instructions executed by a processor to: displaying a scrollable particular set number(s) of list of content item(s) 3325 (e.g. 3317 and 3319); receiving input associated with a scroll command; based on the scroll command, displaying a scrollable refresh trigger 3315; and in response to determining, based on the scroll command, that the scrollable refresh trigger has been activated 3315, removing one or more or all or particular number of ephemeral message(s) or visual media item(s) or content item(s) and adding or updating or displaying next particular set number(s) of list of ephemeral message(s) or visual media item(s) or content item(s) 3328 (e.g. 3327 and 3330).

In another embodiment removing of number of content item based on or equivalent to newly available number of content items or removing number of content item equivalent to updated number of content items available for viewing user.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the ephemeral message controller 277 monitors signals from the touch controller 215. If haptic contact on or haptic swipe on or tap or click push to refresh icon is observed by the touch controller 215 or keyboard during the display of an ephemeral message, then the display of the existing message is terminated and a subsequent ephemeral message(s), if any, is displayed or in response to receive input associated with a scroll command and based on the scroll command, displaying a scrollable refresh trigger 3315; and in response to determining, based on the scroll command, that the scrollable refresh trigger has been activated 3315, removing one or more or all or particular number of ephemeral message(s) or visual media item(s) or content item(s) and adding or updating or displaying next particular set number(s) of list of ephemeral message(s) or visual media item(s) or content item(s) 3328 (e.g. 3327 and 3330). In one embodiment, the haptic contact to terminate a message is any gesture applied to any location on the display 210. In another embodiment, the haptic contact is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

In an embodiment FIG. 33 (A) illustrates processing operations associated with the ephemeral message controller 277. Initially, a set of visual media item(s) or content item(s) or ephemeral message(s) is/are displayed 3325 (e.g. 3317 and 3319). Haptic contact on or tap on or click on “Push to Refresh” icon or button or link or control is then monitored or user instruction to “Push to Refresh” to load next set of visual media item(s) or content item(s) or ephemeral message(s) is/are received (3307—Yes), then the current one or more or set of visual media item(s) or content item(s) or message(s) is/are deleted (e.g. 3317 and 3319) and the next one or more or set of visual media item(s) or content item(s) or message(s), if any, is/are displayed 3305 (e.g. 3327 and 3330) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof), then receiving of another instruction of activating of “Push to Refresh” or receiving of haptic contact on or tap on or click on “Push to Refresh” icon or button or link or control check is made 3230. These sequences is repeated until receiving of instruction to activate “Push to Refresh” or receiving of haptic contact on or tap on or click on “Push to Refresh” icon or button or link or control is identified.

FIG. 33 (B) illustrates the exterior of electronic device 200. The Figure also illustrates the display 210. The display 210 presents a set of ephemeral messages 3325 available for viewing. A first one or more or set of message(s) e.g. 3317 and 3319 may be displayed. Upon receiving of receiving of instruction to activate “Push to Refresh” or receiving of haptic contact on or tap on or click on “Push to Refresh” icon or button or link or control 3315 is then monitored, a second set of message(s) 3328 (e.g. 3227 and 3330) or subsequent message(s) in queue 3328 is/are displayed.

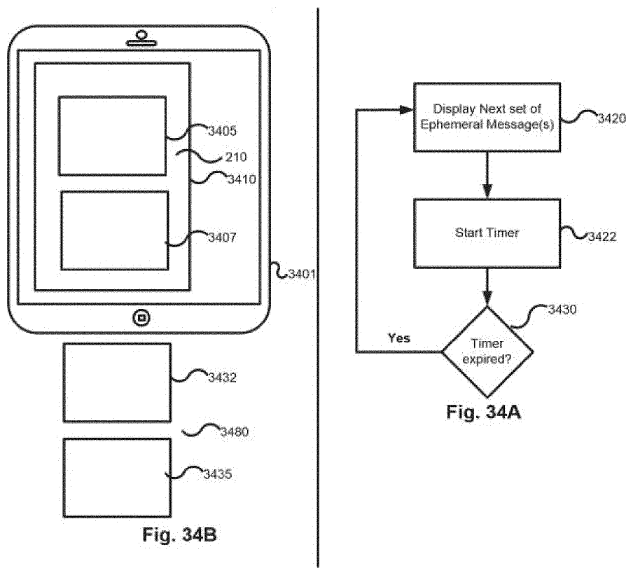

FIG. 34 illustrates processing operations associated with display of ephemeral messages and based on expiration of pre-set duration of timer auto refresh and remove currently presented ephemeral messages or media items and load or present next available (if any) set of ephemeral messages in accordance with an embodiment of the invention.

A non-transitory computer readable storage medium, comprising instructions executed by a processor to: present on the display a first set of ephemeral content item(s) or message(s) of the collection of ephemeral content item(s) or messages(s) 3420 (3410—e.g. 3405 and 3407) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof) for a first transitory period of time defined by a timer 3422, wherein the first set of ephemeral content item(s) or messages(s) 3420 (3410—e.g. 3405 and 3407) is/are deleted when the first transitory period of time expires 3430; and proceeds to present on the display a second set of ephemeral content item(s) or messages(s) of the collection of or identified or contextual ephemeral content item(s) or messages(s) 3420 (3480—e.g. 3432 and 3435) for a second transitory period of time defined by the timer 3422, wherein the ephemeral message controller deletes the second set of ephemeral content item(s) or messages(s) (3480—e.g. 3432 and 3435) upon the expiration of the second transitory period of time 3430; and wherein the ephemeral content or message controller initiates the timer 3422 upon the display of the first set of ephemeral content item(s) or messages(s) (3410—e.g. 3405 and 3407) and the display of the second set of ephemeral content item(s) or messages(s) (3480—e.g. 3432 and 3435).

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like. The auto refresh to display time for the ephemeral message(s) is/are typically set by the server or set by the message sender. However, the display time may be a default setting or a setting specified by the recipient. Regardless of the setting technique, the message(s) is/are transitory.

The processor 230 is also coupled to image sensors 244. The image sensors 244 may be known digital image sensors, such as charge coupled devices. The image sensors capture visual media, which is presented on display 210.

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

In an embodiment FIG. 34 (A) illustrates processing operations associated with the ephemeral message controller 277. Initially, one or more or set of ephemeral message(s) is/are displayed 3420 (3410—e.g. 3405 and 3407). A timer is then started 3422. The timer may be associated with the processor 230.

Then the timer is then checked 3430. If the timer has expired (3430—Yes), then the current one or more or set of message(s) is/are deleted and the next message(s), if any, is/are displayed 3420 (3480—e.g. 3432 and 3435).

FIG. 34 (B) illustrates the exterior of electronic device 200. The Figure also illustrates the display 210. The display 210 presents a set of ephemeral messages 3410 available for viewing. A first set of message(s) 3410 may be displayed. Upon expiration of the timer 3430, a second set of message(s) 3480 is displayed.

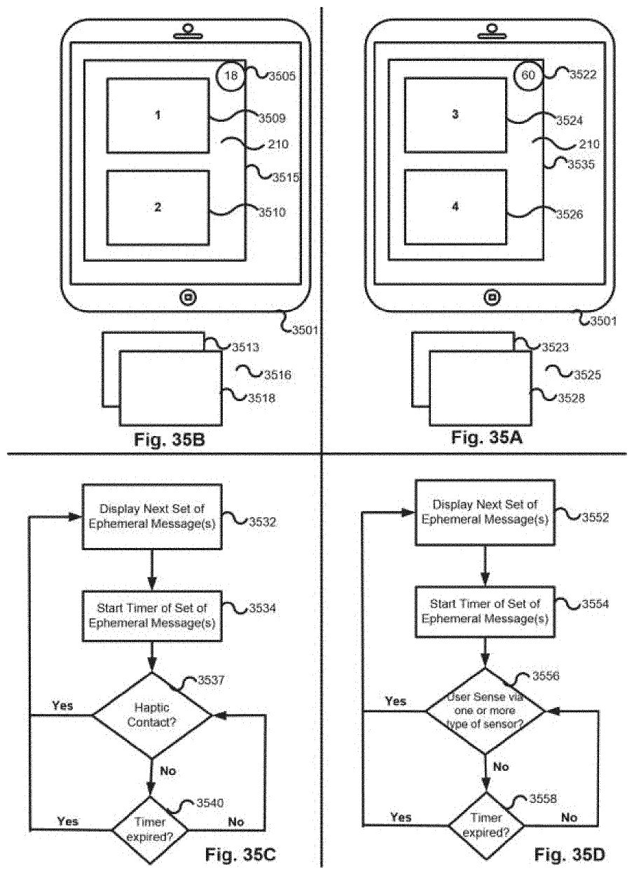

FIG. 35 illustrates processing operations associated with display of ephemeral messages and based on expiration of pre-set duration of timer associated with or correspond to presented each set of ephemeral messages, remove currently presented set of ephemeral messages or media items and load or present next available (if any) set of ephemeral messages in accordance with an embodiment of the invention.

In an embodiment describe in FIGS. 35(A) and 35 (B), an ephemeral message controller with instructions executed by a processor to: present on the display a first set of ephemeral content item(s) or message(s) of the collection of ephemeral content item(s) or messages(s) 3532 (3515—e.g. 3509 and 3510) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof) for a first transitory period of time defined by a timer 3534, wherein the first set of ephemeral content item(s) or messages(s) 3515 (e.g. 3509 and 3510) is/are deleted when the first transitory period of time expires 3540; receive from a touch controller a haptic contact signal 3537 indicative of a gesture applied to the display 210 during the first transitory period of time 3534; wherein the ephemeral message controller deletes the first set of ephemeral content item(s) or messages(s) 3515 (e.g. 3509 and 3510) in response to the haptic contact signal 3537 and proceeds to present on the display a second set of ephemeral content item(s) or messages(s) 3532 (3516—e.g. 3513 and 3518) of the collection of or identified or contextual ephemeral content item(s) or messages(s) for a second transitory period of time defined by the timer 3534, wherein the ephemeral message controller deletes the second set of ephemeral content item(s) or messages(s) 3532 (3516—e.g. 3513 and 3518) upon the expiration of the second transitory period of time 3540; wherein the second set of ephemeral content item(s) or messages(s) 3532 (3516—e.g. 3513 and 3518) is deleted when the touch controller receives another haptic contact signal 3537 indicative of another gesture applied to the display during the second transitory period of time 3534; and wherein the ephemeral content or message controller initiates the timer 3534 upon the display of the first set of ephemeral content item(s) or messages(s) 3532 (3516—e.g. 3513 and 3518) and the display of the second set of ephemeral content item(s) or messages(s) 3532 (3516—e.g. 3513 and 3518).

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like. The display time for the one or more or set of ephemeral message is/are typically set by the message sender. However, the display time may be a default setting or a setting specified by the recipient. Regardless of the setting technique, the message is transitory.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the ephemeral message controller 277 monitors signals from the touch controller 215. If haptic contact is observed by the touch controller 215 during the display of set of ephemeral message(s), then the display of the existing message(s) is/are terminated and a subsequent set of ephemeral message(s), if any, is displayed. In one embodiment, two haptic signals may be monitored. A continuous haptic signal may be required to display a message(s), while an additional haptic signal may operate to terminate the display of the set of displayed message(s). For example, the viewer might tap the screen with a finger while maintaining haptic contact with another finger. This causes the screen to display the next set of media in the collection. In one embodiment, the haptic contact to terminate a set of message(s) is any gesture applied to any location on the display 210. In another embodiment, the haptic contact is any gesture applied to the message(s) itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

FIG. 35 (B) illustrates processing operations associated with the ephemeral message controller 106. Initially, one or more or set of ephemeral message(s) is/are displayed 3532 (e.g. 3515-3509 and 3510). A timer associated with said displayed set of ephemeral message(s) is then started 3534. The timer may be associated with the processor 230.

Haptic contact is then monitored 3537. If haptic contact exists (3537—Yes), then the current one or more or set of message(s) is/are deleted and the next message, if any, is displayed 3532. If haptic contact does not exist (3537—No), then the timer is checked 3540. If the timer has expired (3540—Yes), then the current one or more or set of message(s) is/are deleted and the next one or more or set of message(s), if any, is/are displayed 3532. If the timer has not expired (3540—No), then another haptic contact check is made 3537. This sequence between blocks 3537 and 3540 is repeated until haptic contact is identified or the timer expires.

FIG. 35 (A) illustrates the exterior of electronic device 200. The Figure also illustrates the display 210. The display 210 presents a set of ephemeral messages 3532 available for viewing. A first set of message(s) 3532 may be displayed. Upon expiration of the timer, a second set of message(s) 3532 is displayed. Alternately, if haptic contact is received before the timer expires the second set of message(s) 3532 is displayed.

In an another embodiment an ephemeral message controller with instructions executed by a processor to: present on the display a first set of ephemeral content item(s) or message(s) 3552 (3535—e.g. 3524 and 3526) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof) of the collection of ephemeral content item(s) or messages(s) for a first transitory period of time defined by a timer 3354, wherein the first set of ephemeral content item(s) or messages(s) 3552 (3535—e.g. 3524 and 3526) is/are deleted when the first transitory period of time expires 3558; receive from a sensor controller a pre-defined user sense or sensor signal 3556 indicative of a gesture applied to the display during the first transitory period of time 3554; wherein the ephemeral message controller deletes the first set of ephemeral content item(s) or messages(s) 3552 (3535—e.g. 3524 and 3526) in response to the pre-defined user sense or sensor signal 3556 and proceeds to present on the display a second set of ephemeral content item(s) or messages(s) 3552 (3525—e.g. 3523 and 3528) of the collection of or identified or contextual ephemeral content item(s) or messages(s) for a second transitory period of time defined by the timer 3554, wherein the ephemeral message controller deletes the second set of ephemeral content item(s) or messages(s) 3552 (3525—e.g. 3523 and 3528) upon the expiration of the second transitory period of time 3558; wherein the second set of ephemeral content item(s) or messages(s) 3552 (3525—e.g. 3523 and 3528) is/are deleted when the sensor controller receives another pre-defined user sense or sensor signal 3556 indicative of another gesture applied to the display during the second transitory period of time 3554; and wherein the ephemeral content or message controller initiates the timer 3554 upon the display of the first set of ephemeral content item(s) or messages(s) 3552 (3535—e.g. 3524 and 3526) and the display of the second set of ephemeral content item(s) or messages(s) 3552 (3525—e.g. 3523 and 3528).

FIG. 35 (D) illustrates processing operations associated with accelerated display of ephemeral messages in accordance with an embodiment of the invention and FIG. 35 (C) illustrates the exterior of an electronic device implementing accelerated display of ephemeral messages in accordance with the invention. FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like. The display time for the ephemeral message is typically set by the message sender. However, the display time may be a default setting or a setting specified by the recipient. Regardless of the setting technique, the message is transitory.

The processor 230 is also coupled to image sensors 244. The image sensors 244 may be known digital image sensors, such as charge coupled devices. The image sensors capture visual media, which is presented on display 210. The processor 230 is also coupled to one or more sensors including Orientation Sensor 237, Position Sensor 242, GPS Sensor 238, Audio sensor 245, Proximity Sensor 246, Gyroscope 247, Accelerometer 248 and other one or more types of sensors 250 including hover sensor, eye tracking system via optical sensors 240 or image sensors 244. In one embodiment, the ephemeral message controller 277 monitors signals or senses or one or more types of pre-defined equivalents of generated or updated sensor data from the one or more sensors including voice command from audio sensor 245 or particular type of eye movement from eye tracking system based on image sensors 244 or optical sensors 240 or hover signal from e.g. specific type of proximity sensor 246. If one of the pre-defined types of said senses detected or is observed by the said one or more types of sensors during the display of a set of ephemeral message(s), then the display of the existing set of message(s) is/are terminated and a subsequent set of ephemeral message(s), if any, is displayed. In one embodiment, two types of signals or senses from sensors may be monitored. A continuous signal or senses from one or more types of sensors may be required to display a set of message(s), while an additional sensor signal or sense may operate to terminate the display of the set of message(s). For example, the viewer might instruct via voice command or hover on display or done one or more types of pre-defined eye movement. This causes the screen to display the next set of media in the collection. In one embodiment, the one or more types of pre-defined signal or senses provide by user and detected or sense by sensor to terminate a message while media viewer application or interface is open or while viewing of display 210. In another embodiment, the sensor signal or sense is any sense applied on the message area itself. In one embodiment, the gesture is un-prompted (i.e., there is no prompt such as “Delete” to solicit an action from the user). In another embodiment, the gesture may be prompted (e.g., by supplying a “Delete” option on the display, which must be sensed or touched to effectuate deletion).

The electronic device 200 may also include other components commonly associated with a smartphone, such as a wireless signal processor 220, a power control circuit 225 and a global positioning system processor 242. While many of components of FIG. 2 are known in the art, new functionality is achieved through the ephemeral message controller 277.

FIG. 35 (D) illustrates processing operations associated with the ephemeral message controller 277. Initially, a set of ephemeral message(s) is/are displayed 3552 (e.g. 3535-3524 and 3526). A timer associated with displayed set of message(s) is then started 3554. The timer may be associated with the processor 230.

One or more types of user sense is/are then monitored, tracked, detected and identified 3556. If pre-defined user sense identified or detected or recognized or exists (3556—Yes), then the current set of message(s) is/are deleted and the next set of message(s) 3552 (e.g. 3525-3523 and 3528), if any, is displayed 3552. If user sense does not identified or detected or recognized or exist (3556—No), then the timer is checked 3558. If the timer has expired (3558—Yes), then the current set of message(s) (e.g. 3525-3523 and 3528) is/are deleted and the next set of message(s) (e.g. 3525-3523 and 3528), if any, is displayed 3552. If the timer has not expired (3558—No), then another user sense identification or detection or recognition check is made 3556. This sequence between blocks 3556 and 3558 is repeated until one or more types of pre-defined user sense is identified or detected or recognized or the timer expires.

FIG. 35 (C) illustrates the exterior of electronic device 200. The Figure also illustrates the display 210. The display 210 presents a set of ephemeral messages 3552 (e.g. 3535—3524 and 3525) available for viewing. A first set of message 3552 (e.g. 3535-3524 and 3525) may be displayed. Upon expiration of the timer 3558, a second set of messages 3552 (e.g. 3525—3523 and 3528) is displayed. Alternately, if one or more types of pre-define user sense or user sense data or signal via one or more types of sensor is received before the timer expires the second set of message(s) 3552 (e.g. 3525-3523 and 3528) is displayed.

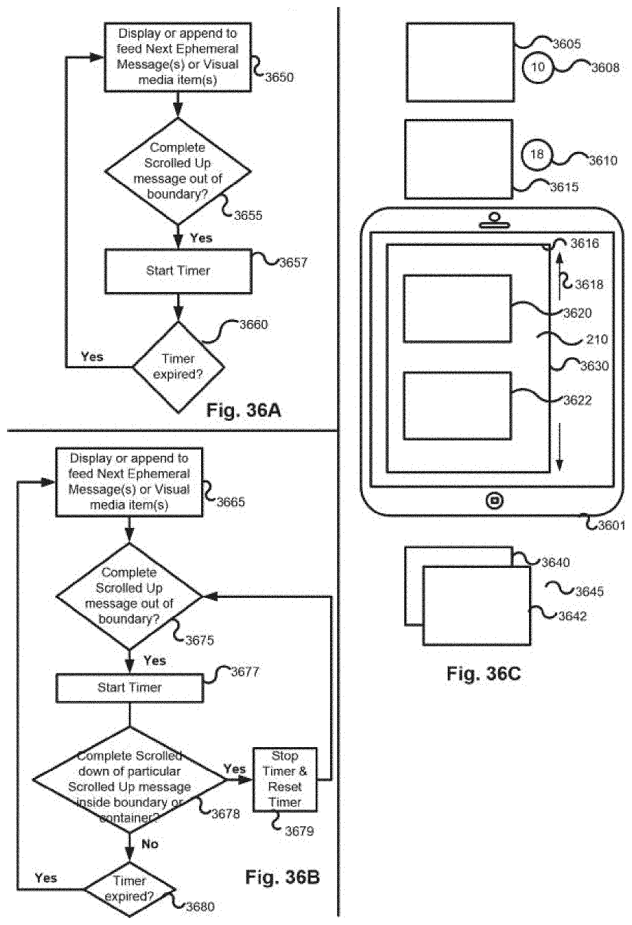

FIG. 36 illustrates processing operations associated with display of ephemeral messages and based on expiration of pre-set duration of timer for scrolled-up ephemeral message (s) or media item(s), remove expired scrolled-up ephemeral message(s) or media item(s) from presented feed or set of ephemeral messages and in the event of removal of ephemeral message(s) or media item(s), load or present next available (if any) removed number equivalent or particular pre-set number of or available to present ephemeral messages in accordance with an embodiment of the invention.

A non-transitory computer readable storage medium, comprising instructions executed by a processor to: displaying a scrollable list of content items 3650 (3630—e.g. 3620 & 3622) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof); receiving input associated with a scroll command; based on the scroll command identify complete scrolled-up of one or more digital content items 3655 (3618), in response to identifying of complete scrolled-up of one or more digital content items 3655—yes (e.g. 3605 and 3615) out of pre-defined boundary 3616 of scrollable display container e.g. 210, start pre-set duration of wait timer(s) 3657 (e.g. 3608 and 3610) for each scrolled up visual media item or content item (e.g. 3605 and 3615) and in the event of expiration of pre-set duration of timer 3660 (e.g. 3608 and 3610) for each scrolled-up ephemeral message(s) or media item(s) (e.g. 3605 and 3615), remove expired timer 3660—yes related scrolled-up ephemeral message(s) or media item(s) (e.g. 3605 and 3615) from presented feed or set of ephemeral messages 3630 and in the event of removal of ephemeral message(s) or media item(s) (e.g. 3605 and 3615), load or present next available (if any) or present removed items equivalent number(s) of or particular pre-set number(s) of or available to present ephemeral messages 3650 (e.g. 3645-3640 and 3642) in accordance with an embodiment of the invention.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the ephemeral message controller 277 monitors signals from the touch controller 215. If receiving input associated with a scroll command, then based on the scroll command identify complete scrolled-up of one or more digital content items, start timer associated with each scrolled-up visual media item or content item and in the event of expiry of said each scrolled-up visual media item or content item associated started time, remove expired timer associated complete scrolled-up one or more digital content items or if haptic swipe contact is observed by the touch controller 215 and displayed visual media item completely scrolled up over pre-defined boundaries during the display of an ephemeral message, then each scrolled-up message or visual media item or content item associated timer started and in the vent of expiration of said each timer the display of the said timer related existing message is terminated and a subsequent ephemeral message, if any, is displayed.

In another embodiment, the haptic swipe is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

In an embodiment FIG. 36 (A) illustrates processing operations associated with the ephemeral message controller 277. Initially, an ephemeral message is displayed 3650 (e.g. 3630—3620 and 3622). Haptic swipe is then monitored 3618. If haptic swipe leads to complete scrolling up of displayed visual media item (e.g. 3605 and 3615) out of pre-defined boundary 3616 of display 210 or container 3630 (3655—Yes), then the timer associated with each scrolled-up message(s) or visual media item(s) or content item(s) is starts 3657 (e.g. timer 3608 associated with complete scrolled-up message or visual media item 3605 starts and timer 3610 associated with complete scrolled-up message or visual media item 3615 starts) and in the event of expiry of said timer 3660 (e.g. 3608 and 3610) then the completely scrolled-up visual media item or message (e.g. 3605 and 3615) is/are deleted and the next message(s) 3650 (e.g. 3645-3640 and 3642), if any, is appended to feed and displayed. This sequence is repeated until haptic swipe identified which leads to complete scrolling up of displayed visual media item out of pre-defined boundaries.

In another embodiment FIG. 36 (B) illustrates processing operations associated with the ephemeral message controller 277. Initially, an ephemeral message is displayed 3665 (e.g. 3630-3620 and 3622) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof). Haptic swipe is then monitored 3618. If haptic swipe leads to complete scrolling up of displayed visual media item (e.g. 3605 and 3615) out of pre-defined boundary 3616 of display 210 or container 3630 (3675—Yes), then the timer associated with each scrolled-up message(s) or visual media item(s) or content item(s) is starts 3677 (e.g. timer 3608 associated with complete scrolled-up message or visual media item 3605 starts and timer 3610 associated with complete scrolled-up message or visual media item 3615 starts) and before expiry of timer 3677 (e.g. 3608 and 3610) enabling user to scroll down said previously scrolled-up message(s) (e.g. 3605 and 3615) and in the event of completely scrolled-down of said previously scrolled-up message(s) (e.g. 3605 and 3615), stop & reset or initiate timer 3679 and in the event of expiry of said timer 3680 (e.g. 3608 and 3610) then the completely scrolled-up visual media item or message (e.g. 3605 and 3615) is/are deleted and the next message(s) 3665 (e.g. 3645-3640 and 3642), if any, is appended to feed and displayed. In another embodiment instead of scroll up, user can tap or click on next button or icon or link or control or instruct or issue next command via pre-defined user sense(s) via one or more types of sensors of user device(s) on to view next visual media item or content item (if any) or instead of scroll down, user can tap or click on previous button or icon or link or control or instruct or issue previous command via pre-defined user sense(s) via one or more types of sensors of user device(s) to view visual media item or content item.

FIG. 36 (C) illustrates the exterior of electronic device 200. The Figure also illustrates the display 210. The display 210 presents a set of ephemeral messages 3130 available for viewing. A first one or more or set of message(s) e.g. 3620 & 3622 may be displayed. Upon complete scrolling up of displayed visual media item(s) (e.g. 3605 and 3610) out of pre-defined boundary 3616 of display 210 or container 3630, a second message(s) 3645 or subsequent message(s) in queue 3645 is/are displayed.

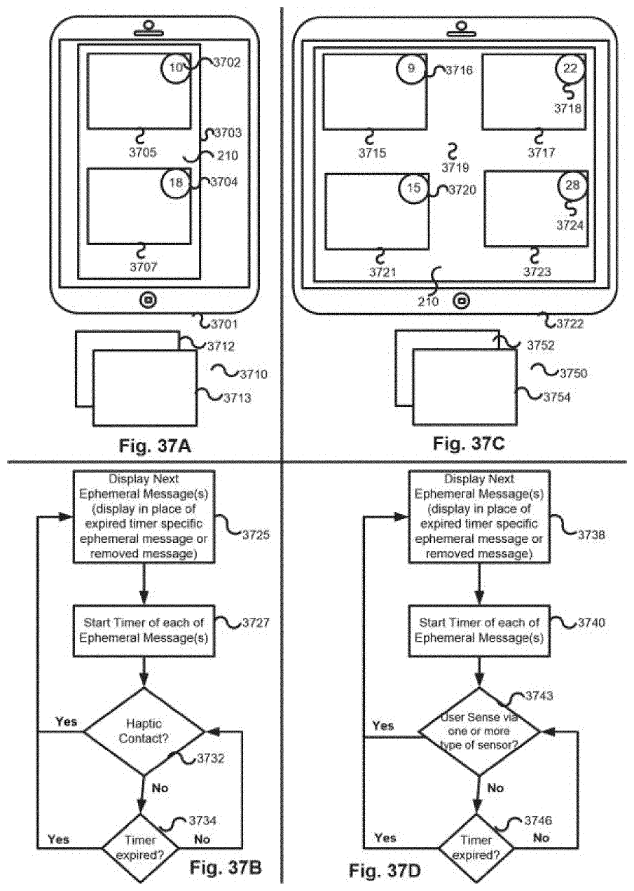

FIG. 37 illustrates processing operations associated with display of ephemeral messages with no scrolling and based on expiration of pre-set duration of timer associated with each ephemeral message, remove expired ephemeral message(s) or media item(s) from presented feed or set of ephemeral messages and in the event of removal of ephemeral message(s) or media item(s), load or present next available (if any) removed number equivalent or available to present ephemeral messages in accordance with an embodiment of the invention.

In an embodiment describe in FIGS. 37(A) and 37(B), an ephemeral message controller 277 with instructions executed by a processor 230 to: present on the display 210 a one or more ephemeral content item(s) or message(s) 3725 (e.g. 3712 and 3713) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof) of the collection of ephemeral content item(s) or messages(s) 3710 for a corresponding associated transitory period of time defined by a timer 3727 (e.g. 3702 and 3704) for each presented ephemeral content item(s) or messages(s) (e.g. timer 3702 for media item 3701 and timer 3704 for media item 3707), wherein the first ephemeral content item(s) or messages(s) 3705 from the presented set of ephemeral content item(s) or messages(s) 3703 is/are deleted when the corresponding associated transitory period of time expires 3702; receive from a touch controller a haptic contact signal 3732 indicative of a gesture applied to the display 210 during the first transitory period of time 3734 (e.g. 3702); wherein the ephemeral message controller 277 deletes first set of presented ephemeral content item(s) or messages(s) (e.g. 3703-3705 and 3707) in response to the haptic contact signal (3732) and proceeds to present on the display 210 a second set of ephemeral content item(s) or messages(s) 3725 (e.g. 3710-3712 and 3713) of the collection of or identified or contextual ephemeral content item(s) or messages(s) 3710 for a corresponding associated transitory period of time defined by the timer 3727 for each presented ephemeral content item(s) or messages(s) 3725, wherein the ephemeral message controller 277 deletes the presented ephemeral content item(s) or messages(s) upon the expiration of the corresponding associated transitory period of time 3734 defined by a timer for each presented ephemeral content item(s) or messages(s); wherein the second set of ephemeral content item(s) or messages(s) 3710 is deleted when the touch controller receives another haptic contact signal 3732 indicative of another gesture applied to the display during the second transitory period of time 3734; and wherein the ephemeral content or message controller 277 initiates the timer upon the display of the first set of ephemeral content item(s) or messages(s) 3703 and the display of the second set of ephemeral content item(s) or messages(s) 3710.

The ephemeral message controller 277, in response to deletion of ephemeral message(s) e.g. 3705 and 3707, add to display or present to display 210 another available ephemeral message(s) e.g. 3712 and 3713 on the display 210.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like. The display time for the one or more or set of ephemeral message is/are typically set by the message sender. However, the display time may be a default setting or a setting specified by the recipient. Regardless of the setting technique, the message is transitory.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the ephemeral message controller 277 monitors signals from the touch controller 215. If haptic contact is observed by the touch controller 215 during the display of set of ephemeral message(s), then the display of the existing message(s) is/are terminated and a subsequent set of ephemeral message(s), if any, is displayed. In one embodiment, two haptic signals may be monitored. A continuous haptic signal may be required to display a message(s), while an additional haptic signal may operate to terminate the display of the set of displayed message(s). For example, the viewer might tap the screen with a finger while maintaining haptic contact with another finger. This causes the screen to display the next set of media in the collection. In one embodiment, the haptic contact to terminate a set of message(s) is any gesture applied to any location on the display 210. In another embodiment, the haptic contact is any gesture applied to the message(s) itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

FIG. 37 (B) illustrates processing operations associated with the ephemeral message controller 277. Initially, one or more or set of ephemeral message(s) is/are displayed 3725 (e.g. 3703-3705 and 3707). A timer associated with said each ephemeral message (e.g. timer 3702 for media item 3701 and timer 3704 for media item 3707) is/are then started 3725. The timer may be associated with the processor 230.

Haptic contact is then monitored 3732. If haptic contact exists (7532—Yes), then the current one or more or set of message(s) (e.g. 3703-3705 and 3707) is/are deleted and the next message(s) (e.g. 3710-3712 and 3713), if any, is displayed 3532. If haptic contact does not exist (3732—No), then the timer is checked 3734. If the timer has expired (3734—Yes), then the current one or more or set of message(s) (e.g. 3703-3705 and 3707) is/are deleted and the next one or more or set of message(s) 3725 (e.g. 3710-3712 and 3713), if any, is/are displayed 3725. If the timer has not expired (3734—No), then another haptic contact check is made 3732. This sequence between blocks 3732 and 3734 is repeated until haptic contact is identified or the timer expires.

FIG. 37 (A) illustrates the exterior of electronic device 200. The Figure also illustrates the display 210. The display 210 presents a set of ephemeral messages (3703) available for viewing. A first set of message(s) 3725 (3703) may be displayed. Upon expiration of the timer 3734 (e.g. 3702, 3704) associate with each presented ephemeral message (e.g. 3705, 3707), a second message e.g. 3712 is displayed. Alternately, if haptic contact 3732 is received before the timer expires 3734 (e.g. 3702, 3704) the second set of message(s) 3725 (3710) is displayed.

In another embodiment FIG. 37 (D) illustrates processing operations associated with accelerated display of ephemeral messages in accordance with an embodiment of the invention and FIG. 37 (C) illustrates the exterior of an electronic device implementing accelerated display of ephemeral messages in accordance with the invention. FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like. The display time for the ephemeral message is typically set by the message sender. However, the display time may be a default setting or a setting specified by the recipient. Regardless of the setting technique, the message is transitory.

The processor 230 is also coupled to image sensors 244. The image sensors 244 may be known digital image sensors, such as charge coupled devices. The image sensors capture visual media, which is presented on display 210. The processor 230 is also coupled to one or more sensors including Orientation Sensor 237, Position Sensor 242, GPS Sensor 238, Audio sensor 245, Proximity Sensor 246, Gyroscope 247, Accelerometer 248 and other one or more types of sensors 250 including hover sensor, eye tracking system via optical sensors 240 or image sensors 244. In one embodiment, the ephemeral message controller 277 monitors signals or senses or one or more types of pre-defined equivalents of generated or updated sensor data from the one or more sensors including voice command from audio sensor 245 or particular type of eye movement from eye tracking system based on image sensors 244 or optical sensors 240 or hover signal from e.g. specific type of proximity sensor 246. If one of the pre-defined types of said senses detected or is observed by the said one or more types of sensors during the display of a set of ephemeral message(s), then the display of the existing set of message(s) is/are terminated and a subsequent set of ephemeral message(s), if any, is displayed. In one embodiment, two types of signals or senses from sensors may be monitored. A continuous signal or senses from one or more types of sensors may be required to display a set of message(s), while an additional sensor signal or sense may operate to terminate the display of the set of message(s). For example, the viewer might instruct via voice command or hover on display or done one or more types of pre-defined eye movement. This causes the screen to display the next set of media in the collection. In one embodiment, the one or more types of pre-defined signal or senses provide by user and detected or sense by sensor to terminate a message while media viewer application or interface is open or while viewing of display 210. In another embodiment, the sensor signal or sense is any sense applied on the message area itself. In one embodiment, the gesture is un-prompted (i.e., there is no prompt such as “Delete” to solicit an action from the user). In another embodiment, the gesture may be prompted (e.g., by supplying a “Delete” option on the display, which must be sensed or touched to effectuate deletion).

The electronic device 200 may also include other components commonly associated with a smartphone, such as a wireless signal processor 220, a power control circuit 225 and a global positioning system processor 242. While many of components of FIG. 2 are known in the art, new functionality is achieved through the ephemeral message controller 277.

FIG. 37 (D) illustrates processing operations associated with the ephemeral message controller 277. Initially, a set of ephemeral message(s) is/are displayed 3738 (e.g. 3719-3715, 3717, 3721 and 3723) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof). A timer 3740 (3716, 3718, 3720 and 3724) associated with displayed set of message(s) (e.g. 3719-3715, 3717, 3721 and 3723) is/are then started 3740. The timer may be associated with the processor 230.

One or more types of user sense is/are then monitored, tracked, detected and identified 3743. If pre-defined user sense identified or detected or recognized or exists (3743—Yes), then the current set of message(s) (e.g. 3719-3715, 3717, 3721 and 3723) is/are deleted and the next set of message(s) 3738 (e.g. 3750-3752 and 3754), if any, is displayed 3738. If user sense does not identified or detected or recognized or exist (3743—No), then the timer is checked 3746. If the timer has expired (3746—Yes), then the each expired timer associated message (e.g. 3719-3715, 3717, 3721 and 3723) is/are deleted and the next set of message(s) (e.g. 3525-3523 and 3528), if any, is displayed 3738. If the timer has not expired (3746—No), then another user sense identification or detection or recognition check is made 3743. This sequence between blocks 3743 and 3746 is repeated until one or more types of pre-defined user sense is identified or detected or recognized or the timer expires.

FIG. 37 (C) illustrates the exterior of electronic device 200. The Figure also illustrates the display 210. The display 210 presents a set of ephemeral messages 3738 (e.g. 3719-3715, 3717, 3721 and 3723) available for viewing. A first set of message 3738 (e.g. 3719-3715, 3717, 3721 and 3723) may be displayed. Upon expiration of the timer 3746 (3716, 3718, 3720 and 3724) associated with each displayed message (e.g. 3719-3715, 3717, 3721 and 3723), after expiry of each timer a second messages 3738 (e.g. 3752 or 3754) is displayed. Alternately, if one or more types of pre-define user sense or user sense data or signal via one or more types of sensor is received (3743) before the timer expires 3746 the second set of message(s) 3738 (e.g. 3750-3752 and 3754) is/are displayed.

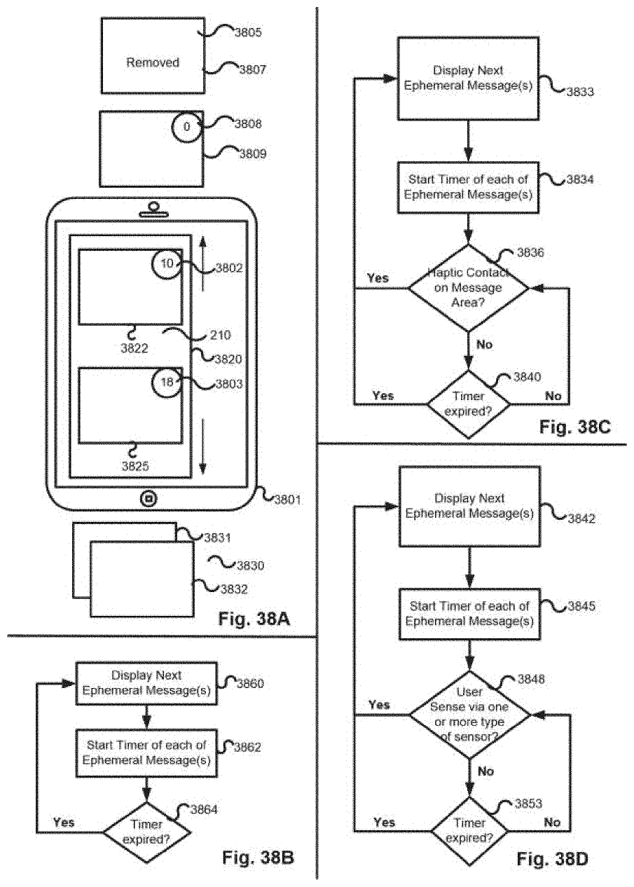

FIG. 38 illustrates processing operations associated with display of ephemeral messages and based on expiration of pre-set duration of timer associated with each ephemeral message, remove expired ephemeral message(s) or media item(s) from presented feed or set of ephemeral messages and in the event of removal of ephemeral message(s) or media item(s), load or present next available (if any) removed number equivalent or particular pre-set number of or available to present ephemeral messages in accordance with an embodiment of the invention.

In an embodiment in FIG. 38 (B), a non-transitory computer readable storage medium, comprising instructions executed by a processor to: present on the display a first set of ephemeral content item(s) or message(s) of the collection of ephemeral content item(s) or messages(s) 3860 (3820—e.g. 3822 and 3425) for a first transitory period of time defined by a timer (e.g. 3802 and 3803) associated with each message or visual media item or content item 3820 (3822 and 3825), wherein the first one or more or set of ephemeral content item(s) or messages(s) (3420—e.g. 3822 and 3825) is/are deleted when the first transitory period of time associated with each message expires 3864; and proceeds to present on the display a second one or more or set of ephemeral content item(s) or messages(s) of the collection of or identified or contextual ephemeral content item(s) or messages(s) 3860 (3830—e.g. 3831 and 3832) for a second transitory period of time defined by the timer associated with each message (3802 and 3803), wherein the ephemeral message controller 277 deletes the second set of ephemeral content item(s) or messages(s) (3830—e.g. 3831 and 3832) upon the expiration of the second transitory period of time associated with each message 3864; and wherein the ephemeral content or message controller initiates the timer 3862 associated with each next displayed message.

In an embodiment in FIG. 38 (C), a non-transitory computer readable storage medium, comprising instructions executed by a processor to: present on the display a scrollable list of ephemeral content item(s) or message(s) 3833 (e.g. 3822 and 3825) of the collection of ephemeral content item(s) or messages(s) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof) for a corresponding associated transitory period of time defined by a timer 3834 (e.g. 3802 and 3803) for each presented ephemeral content item(s) or messages(s) (e.g. 3822 and 3825), wherein the first ephemeral content item(s) or messages(s) (e.g. 3822) from the presented set of ephemeral content item(s) or messages(s) (3820—e.g. 3822 and 3825) is/are deleted when the corresponding associated transitory period of time expires 3840 (e.g. 3802); receive from a touch controller a haptic contact signal indicative of a gesture applied on the particular ephemeral content item or message area 3836; wherein the ephemeral message controller 277 deletes first presented ephemeral content item(s) or messages(s) (e.g. 3802) in response to the haptic contact signal on message area (e.g. 3822) and proceeds to present on the display 210 a second ephemeral content item(s) or messages(s) 3833 (e.g. 3831) of the collection of or identified or contextual ephemeral content item(s) or messages(s) 3830 for a corresponding associated transitory period of time defined by the timer 3834, wherein the ephemeral message controller 277 deletes the presented ephemeral content item(s) or messages(s) upon the expiration of the corresponding associated transitory period of time defined by a timer 3840 for each presented ephemeral content item(s) or messages(s); wherein the second ephemeral content item(s) or messages(s) (e.g. 3803) is deleted when the touch controller receives another haptic contact signal indicative of another gesture applied on the particular ephemeral content item or message; and wherein the ephemeral content or message controller initiates the corresponding timer associated with each next displayed ephemeral content item or messages.

In an embodiment in FIG. 38 (D), a non-transitory computer readable storage medium, comprising instructions executed by a processor to: present on the display a scrollable list of ephemeral content item(s) or message(s) 3842 (e.g. 3822 and 3825) of the collection of ephemeral content item(s) or messages(s) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof) for a corresponding associated transitory period of time defined by a timer 3845 (e.g. 3802 and 3803) for each presented ephemeral content item(s) or messages(s) (e.g. 3822 and 3825), wherein the first ephemeral content item(s) or messages(s) (e.g. 3822) from the presented set of ephemeral content item(s) or messages(s) (3820—e.g. 3822 and 3825) is/are deleted when the corresponding associated transitory period of time expires 3853 (e.g. 3802); receive from a one or more types of one or more sensors of user device(s) a pre-defined user sense or sensor data or sensor signal indicative of a gesture applied on the particular ephemeral content item or message area 3848; wherein the ephemeral message controller 277 deletes first presented ephemeral content item(s) or messages(s) (e.g. 3802) in response to the one or more types of one or more sensors of user device(s) a pre-defined user sense or sensor data or sensor signal on message area (e.g. 3822) and proceeds to present on the display 210 a second ephemeral content item(s) or messages(s) 3842 (e.g. 3831) of the collection of or identified or contextual ephemeral content item(s) or messages(s) 3830 for a corresponding associated transitory period of time defined by the timer 3845, wherein the ephemeral message controller 277 deletes the presented ephemeral content item(s) or messages(s) upon the expiration of the corresponding associated transitory period of time defined by a timer 3853 for each presented ephemeral content item(s) or messages(s); wherein the second ephemeral content item(s) or messages(s) (e.g. 3803) is deleted when the one or more types of one or more sensors of user device(s) receives another a pre-defined user sense or sensor data or sensor signal indicative of another gesture applied on the particular ephemeral content item or message area; and wherein the ephemeral content or message controller 277 initiates the corresponding timer associated with each next displayed ephemeral content item or messages.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like. The auto refresh to display time for the ephemeral message(s) is/are typically set by the server or set by the message sender. However, the display time may be a default setting or a setting specified by the recipient. Regardless of the setting technique, the message(s) is/are transitory.

The processor 230 is also coupled to image sensors 244. The image sensors 244 may be known digital image sensors, such as charge coupled devices. The image sensors capture visual media, which is presented on display 210.

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

In an embodiment FIG. 38 (B) illustrates processing operations associated with the ephemeral message controller 277. Initially, one or more or set of ephemeral message(s) is/are displayed 3860 (3820—e.g. 3822 and 3825) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof). A timer associated with each presented message is then started 3862. The timer may be associated with the processor 230.

Then the timer associated with each displayed message is then checked 3864. If the timer associated with one or more message has expired (3864—Yes), then the expired timer 3864 associated one or more or set of message(s) (e.g. 3822) is/are deleted and the next message(s), if any, is/are displayed 3860 (e.g. 3831).

FIG. 38 (B) illustrates the exterior of electronic device 200. The Figure also illustrates the display 210. The display 210 presents a set of ephemeral messages 3860 (e.g. 3822 and 3825) available for viewing. A first set of message(s) 3860 (e.g. 3822 and 3825) may be displayed. Upon expiration of the timer 3864, a second set of message(s) 3860 (e.g. 3830-3831 and 3832) is displayed.

FIG. 38 illustrates processing operations associated with display of ephemeral messages with scrolling and based on expiration of pre-set duration of timer associated with each ephemeral message, remove expired ephemeral message(s) or media item(s) from presented feed or set of ephemeral messages and in the event of removal of ephemeral message(s) or media item(s), load or present next available (if any) removed number equivalent or available to present ephemeral messages in accordance with an embodiment of the invention.

In an embodiment describe in FIGS. 37(A) and 37(C), an ephemeral message controller 277 with instructions executed by a processor 230 to: present on the display 210 a one or more ephemeral content item(s) or message(s) 3833 (e.g. 3822 and 3825) of the collection of ephemeral content item(s) or messages(s) 3820 for a corresponding associated transitory period of time defined by a timer 3834 (e.g. 3802 and 3803) for each presented ephemeral content item(s) or messages(s) (e.g. timer 3802 for media item 3822 and timer 3803 for media item 3825), wherein the first ephemeral content item(s) or messages(s) 3822 from the presented set of ephemeral content item(s) or messages(s) 3833 (e.g. 3822 and 3825) is/are deleted when the corresponding associated transitory period of time expires 3840 (e.g. 3802); receive from a touch controller a haptic contact signal 3836 indicative of a gesture applied on the particular message area (e.g. 3822) of the display 210 during the first transitory period of time 3840 (e.g. 3802); wherein the ephemeral message controller 277 deletes first set of presented ephemeral content item(s) or messages(s) (e.g. 3820-3822 and 3825) in response to the haptic contact signal (3836) on the particular message area (e.g. 3822) and proceeds to present on the display 210 a second set of ephemeral content item(s) or messages(s) 3833 (e.g. 3831 and 3832) of the collection of or identified or contextual ephemeral content item(s) or messages(s) 3830 for a corresponding associated transitory period of time defined by the timer 3834 for each presented ephemeral content item(s) or messages(s) (e.g. 3830-3831 and 3832), wherein the ephemeral message controller 277 deletes the presented ephemeral content item(s) or messages(s) (e.g. 3830-3831 and 3832) upon the expiration of the corresponding associated transitory period of time 3840 defined by a timer for each presented ephemeral content item(s) or messages(s) (e.g. 3830-3831 and 3832); wherein the second set of ephemeral content item(s) or messages(s) (e.g. 3830-3831 and 3832) is deleted when the touch controller receives another haptic contact signal 3836 indicative of another gesture applied on the particular message area (e.g. 3825) of the display during the second transitory period of time 3840; and wherein the ephemeral content or message controller 277 initiates the timer upon the display of the first set of ephemeral content item(s) or messages(s) 3833 (e.g. 3820-3822 and 3825) and the display of the second set of ephemeral content item(s) or messages(s) 3833 (e.g. 3830-3831 and 3832).

The ephemeral message controller 277, in response to deletion of ephemeral message(s) e.g. 3822 and 3825, add or append to display or present to display 210 replaced in place of deleted message another available ephemeral message(s) e.g. 3831 and 3832 on the display 210.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like. The display time for the one or more or set of ephemeral message is/are typically set by the message sender. However, the display time may be a default setting or a setting specified by the recipient. Regardless of the setting technique, the message is transitory.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied on the particular message area (e.g. 3822 or 3825) of the display 210. In one embodiment, the ephemeral message controller 277 monitors signals from the touch controller 215 on the particular message area (e.g. 3822). If haptic contact is observed by the touch controller 215 on the particular message area (e.g. 3822) during the display of set of ephemeral message(s), then the display of the existing message(s) (e.g. 3822) is/are terminated and a subsequent set of ephemeral message(s) (e.g. 3831), if any, is displayed. In one embodiment, two haptic signals on the particular message area (e.g. 3822 and 3825) may be monitored. A continuous haptic signal on the particular message area may be required to display a message(s), while an additional haptic signal on the particular message area may operate to terminate the display of the one or more or set of displayed message(s). For example, the viewer might tap the screen with a finger while maintaining haptic contact on the particular message area with another finger. This causes the screen to display the next set of media in the collection. In one embodiment, the haptic contact to terminate a message(s) is any gesture applied to any location on the particular message area (e.g. 3822) on the display 210. In another embodiment, the haptic contact is any gesture applied to the message(s) area itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

FIG. 37 (C) illustrates processing operations associated with the ephemeral message controller 277. Initially, one or more or set of ephemeral message(s) is/are displayed 3833 (e.g. 3820-3822 and 3825). A timer associated with said each ephemeral message (e.g. timer 3802 for media item 3822 and timer 3803 for media item 3825) is/are then started 3834. The timer may be associated with the processor 230.

Haptic contact on the each message area is then monitored 3836. If haptic contact on particular message area (e.g. 3822) exists (3836—Yes), then the said message (e.g. 3822) is deleted and the next message (e.g. 3831), if any, is displayed 3833. If haptic contact on particular message area (e.g. 3822) does not exist (3836—No), then the timer is checked 3840 (e.g. timer 3802 of message 3822). If the timer has expired (3840—Yes) (e.g. timer 3802 of message 3822 expired), then the message (e.g. 3822) is deleted and the next message 3833 (e.g. 3831), if any, is displayed 3833. If the timer has not expired (3840—No), then another haptic contact check is made 3836. This sequence between blocks 3836 and 3840 is repeated until haptic contact on particular message area is identified or the timer associated with particular message expires.

FIG. 38 (A) illustrates the exterior of electronic device 200. The Figure also illustrates the display 210. The display 210 presents a set of ephemeral messages (3820) available for viewing. A first set of message(s) 3833 (3820) may be displayed. Upon expiration of the timer 3840 (e.g. 3802) associate with each presented ephemeral message (e.g. 3822), a second message e.g. 3831 is displayed. Alternately, if haptic contact on message 3802 area (e.g. 3822) is received before the timer expires 3840 (e.g. 3802) the second set of message(s) (3831) is displayed 3833.

In another embodiment FIG. 38 (D) illustrates processing operations associated with accelerated display of ephemeral messages in accordance with an embodiment of the invention and FIG. 38 (A) illustrates the exterior of an electronic device implementing accelerated display of ephemeral messages in accordance with the invention. FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like. The display time for the ephemeral message is typically set by the message sender. However, the display time may be a default setting or a setting specified by the recipient. Regardless of the setting technique, the message is transitory.

The processor 230 is also coupled to image sensors 244. The image sensors 244 may be known digital image sensors, such as charge coupled devices. The image sensors capture visual media, which is presented on display 210. The processor 230 is also coupled to one or more sensors including Orientation Sensor 237, Position Sensor 242, GPS Sensor 238, Audio sensor 245, Proximity Sensor 246, Gyroscope 247, Accelerometer 248 and other one or more types of sensors 250 including hover sensor, eye tracking system via optical sensors 240 or image sensors 244. In one embodiment, the ephemeral message controller 277 monitors signals or senses or one or more types of pre-defined equivalents of generated or updated sensor data from the one or more sensors 3848 including user voice command via audio sensor 245 or particular type of user's eye movement via eye tracking system based on image sensors 244 or optical sensors 240 or hover signal from user via e.g. specific type of proximity sensor 246. If one of the pre-defined types of said senses detected or is observed 3848 on particular or selected or identified message area (e.g. 3822) by the said one or more types of sensors 3848 during the display of a set of ephemeral message(s) 3842, then the display of the particular or selected or identified message (e.g. 3822) is terminated and a subsequent ephemeral message (e.g. 3831), if any, is displayed. In one embodiment, two types of signals or senses from sensors may be monitored 3848. A continuous signal or senses from one or more types of sensors may be required 3848 to display a one or more or set of message(s), while an additional sensor signal or sense 3848 may operate to terminate the display of the set of message(s). For example, the viewer might instruct via voice command or hover on display or done one or more types of pre-defined eye movement. This causes the screen to display the next set of media (e.g. 3831 and 3832) in the collection (e.g. 3830). In one embodiment, the one or more types of pre-defined signal or senses provide by user and detected or sense by sensor 3848 to terminate a message while media viewer application or interface is open or while viewing of display 210. In another embodiment, the sensor signal or sense is any sense applied on the message area itself. In one embodiment, the gesture is un-prompted (i.e., there is no prompt such as “Delete” to solicit an action from the user). In another embodiment, the gesture may be prompted (e.g., by supplying a “Delete” option on the display, which must be sensed or touched to effectuate deletion).

The electronic device 200 may also include other components commonly associated with a smartphone, such as a wireless signal processor 220, a power control circuit 225 and a global positioning system processor 242. While many of components of FIG. 2 are known in the art, new functionality is achieved through the ephemeral message controller 277.

FIG. 38 (D) illustrates processing operations associated with the ephemeral message controller 277. Initially, a set of ephemeral message(s) is/are displayed 3842 (e.g. 3820-3822 and 3825). A timer 3845 correspondingly (timer 3802 associated with message 3822 and timer associated 3803 with message 3825) associated with displayed each message is then started 3845. The timer may be associated with the processor 230.

One or more types of user sense on particular or selected or identified message area (e.g. 3822) is then monitored, tracked, detected and identified 3848. If pre-defined user sense identified or detected or recognized or exists on particular or selected or identified message area (e.g. 3822) (3848—Yes), then said message (e.g. 3822) is deleted and the next message (e.g. 3831), if any, is displayed 3842. If user sense does not identified or detected or recognized or exist on particular or selected or identified message area (e.g. 3822) (3848—No), then the timer associated with each displayed message is checked 3853. If the timer associated with each displayed message has expired (3853—Yes), then the each expired timer associated message (e.g. 3822) is deleted and the next message(s) (e.g. 3831), if any, is displayed 3842. If the timer associated with each message or particular message has not expired (3853—No), then another user sense identification or detection or recognition check is made 3848. This sequence between blocks 3848 and 3853 is repeated until one or more types of pre-defined user sense is identified or detected or recognized 3848 or the timer expires 3853.

FIG. 38 (A) illustrates the exterior of electronic device 200. The Figure also illustrates the display 210. The display 210 presents a set of ephemeral messages 3842 (e.g. 3820-3822 and 3825) available for viewing. A first set of message 3842 (e.g. 3820-3822 and 3825) may be displayed. Upon expiration of the timer 3853 (e.g. timer 3802 associated with message 3822 expired) associated with each displayed message, after expiry of particular timer associated with particular message, a second message (e.g. 3831) is displayed 3842. Alternately, if one or more types of pre-define user sense or user sense data or signal via one or more types of sensor is received (3848) before the timer expires 3848 the second message (e.g. 3831) is displayed 3842.

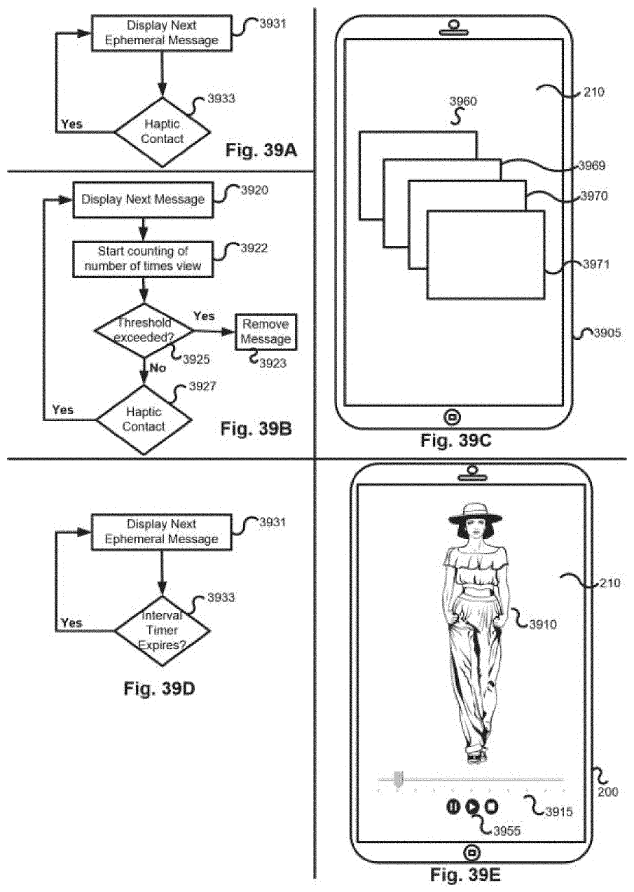

FIG. 39 illustrates processing operations associated with accelerated display of ephemeral messages in accordance with an embodiment of the invention and illustrates interface and the exterior of an electronic device implementing accelerated display of ephemeral messages in accordance with the invention.

In an embodiment an ephemeral message controller with instructions executed by a processor to: present on a display indicia of a set of ephemeral messages available for viewing; present on the display a first ephemeral message 3971 of the set of ephemeral messages 3960; receive from a touch controller a haptic contact signal 3933 indicative of a gesture applied to the display 210; wherein the ephemeral message controller 277 deletes the first ephemeral message 3971 in response to the haptic contact signal 3933 and proceeds to present on the display a second ephemeral message 3970 of the set of ephemeral messages 3960; wherein the second ephemeral message 3970 is deleted when the touch controller receives another haptic contact signal 3933 indicative of another gesture applied to the display 210.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the ephemeral message controller 277 monitors signals from the touch controller 215. If haptic contact is observed by the touch controller 215 during the display of an ephemeral message, then the display of the existing message is terminated and a subsequent ephemeral message, if any, is displayed. In one embodiment, two haptic signals may be monitored. A continuous haptic signal may be required to display a message, while an additional haptic signal may operate to terminate the display of the message. For example, the viewer might tap the screen with a finger while maintaining haptic contact with another finger. This causes the screen to display the next piece of media in the set. In one embodiment, the haptic contact to terminate a message is any gesture applied to any location on the display 210. In another embodiment, the haptic contact is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

FIG. 2 illustrates processing operations associated with the ephemeral message controller 277. Initially, an ephemeral message is displayed 3931 (e.g. 3971) (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof).

Haptic contact is then monitored 3933. If haptic contact exists (3933—Yes), then the current message (e.g. 3971) is deleted and the next message (e.g. 3970), if any, is displayed 3931. Then another haptic contact check is made 3933. If haptic contact exists (3933—Yes), then the current message (e.g. 3970) is deleted and the next message (e.g. 3969), if any, is displayed 3931. If haptic contact does not exist (3933—No) then does not show next message.

FIG. 39 (C) illustrates the exterior of electronic device 200. The Figure also illustrates the display 210. The display 210 presents a set of ephemeral messages 3960 available for viewing. A first message 3971 may be displayed 3931. If haptic contact 3933 is received then the second message 3970 is displayed 3931.

In another embodiment FIG. 39 (B), an ephemeral message controller 277 with instructions executed by a processor to: present on a display indicia of a set of ephemeral messages available for viewing; present on the display 210 a first ephemeral message 3920 (e.g. 3971) of the set of ephemeral messages 3960 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof) for a first pre-set number of times of views 3922 defined by a sender or server or as per default settings or receiver, wherein the first ephemeral message (e.g. 3971) is deleted when the first pre-set number of times of views expires (3925—Yes); receive from a touch controller a haptic contact signal 3927 indicative of a gesture applied to the display 210 during the balance of first pre-set number of times of views (3925—No); wherein the ephemeral message controller 277 hides the first ephemeral message (e.g. 3971) in response to the haptic contact signal 3927 and proceeds to present on the display 210 a second ephemeral message (e.g. 39710 of the set of ephemeral messages 3960 for a second pre-set number of times of views 3922 defined by a sender or server ore receiver, wherein the ephemeral message controller 277 deletes the second ephemeral message (e.g. 3970) upon the expiration of the second pre-set number of times of views (3925—Yes); wherein the second ephemeral message (e.g. 3970) is hides when the touch controller 215 receives another haptic contact signal 3927 indicative of another gesture applied to the display 210 during the balance of second pre-set number of times of views (3925—No).

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like. The pre-set number of times of views or display for the ephemeral message is typically set by the message sender. However, the display time may be a default setting or a setting specified by the recipient. Regardless of the setting technique, the message is transitory i.e. after pre-set number of times of views, it will remove by system.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the ephemeral message controller 277 monitors signals from the touch controller 215. If haptic contact is observed by the touch controller 215 during the display of an ephemeral message, then the subsequent ephemeral message, if any, is displayed. In one embodiment, two haptic signals may be monitored. A continuous haptic signal may be required to display a message, while an additional haptic signal may operate to the display of the next message. For example, the viewer might tap the screen with a finger while maintaining haptic contact with another finger. This causes the screen to display the next piece of media in the set. In one embodiment, the haptic contact to display a next message is any gesture applied to any location on the display 210. In another embodiment, the haptic contact is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

FIG. 39 (B) illustrates processing operations associated with the ephemeral message controller 277. Initially, an ephemeral message is displayed 3971. A starting of counting of number of times of views or displays associated with each ephemeral message is then started 3922.

Haptic contact is then monitored 3927. If haptic contact exists (3927—Yes), then the current message is hide and the next message, if any, is displayed 3920. If haptic contact does not exist (3927—No), then the counter is checked 3925. If the counter threshold exceeded (3925—Yes), then the current message is deleted and the next message, if any, is displayed 200. If the counter threshold not exceeded (3925—No), then another haptic contact check is made 3927. This sequence between blocks 3925 and 3927 is repeated until haptic contact 3927 is identified or the pre-set number of times of views or displays counter exceeded (3925—Yes).

FIG. 39 (C) illustrates the exterior of electronic device 200. The Figure also illustrates the display 210. The display 210 presents a set of ephemeral messages 3960 available for viewing. A first message 3971 may be displayed. Upon exceeding of pre-set number of views or displays of the counter, a second message 3970 is displayed. Alternately, if haptic contact 3927 is received before pre-set number of views or displays of the counter exceeded, the second message 3970 is displayed 3920.

In an another embodiment FIGS. 39 (D) and 39 (E), an ephemeral message controller with instructions executed by a processor to: present on a display indicia of a set of ephemeral messages available for viewing; present on the display a first ephemeral message of the set of ephemeral messages for a pre-set interval period of time defined by a timer, wherein the first ephemeral message is deleted when the pre-set interval period of time expires and proceeds to present on the display a second ephemeral message of the set of ephemeral messages for a pre-set interval period of time defined by the timer, wherein the ephemeral message controller deletes the second ephemeral message upon the expiration of the pre-set interval period of time; and wherein enabling viewer to change pre-set interval period of time (e.g. change interval period of time via slider 3915) and based on changes the ephemeral message controller initiates the interval timer for display of the next ephemeral message.

FIG. 39 (E) illustrates the user interface of electronic device 200. The Figure also illustrates the display 210. The display 210 presents a first ephemeral message 3910 available for viewing. A first message 3910 may be displayed. Upon expiration of the interval timer, a second message is displayed. User is enabling to change pre-set interval period of time (e.g. change interval period of time via slider 3915) and based on changes the ephemeral message controller initiates the interval timer for display of the next ephemeral message, so use can make slow or fast of auto presenting and removing of message(s) as for their dynamic need. In an another embodiment user is enabled to pause, play or re-start and stop 3955 presenting of visual media items or content items or particular story or set of visual media items or content items. In another embodiment user can view previous via swipe right or next via swipe left visual media items for content items for pre-set number of times, in the event of exceeding of said pre-set number of times of view, removing of visual media items or content items.

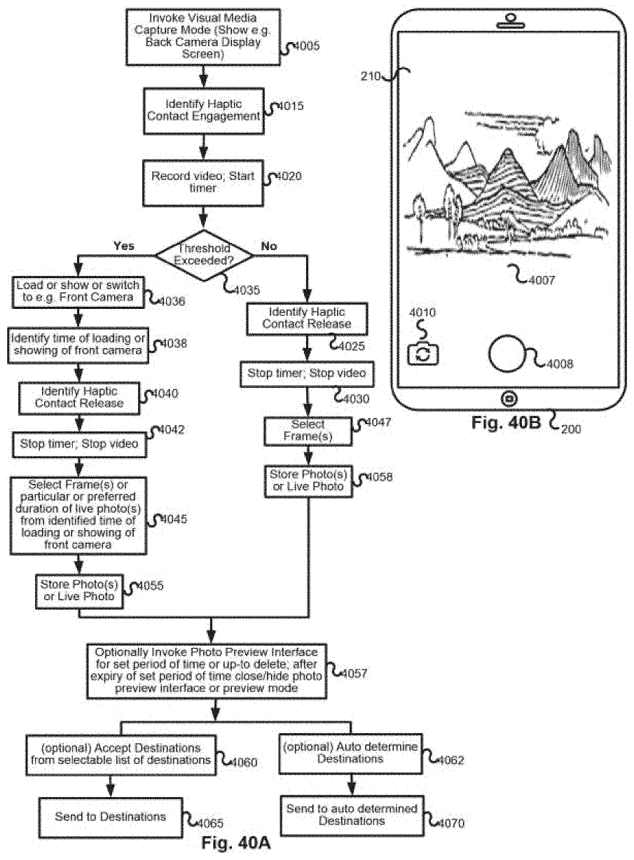

FIG. 40 illustrates logic flow for the visual media capture system. Techniques to selectively capture front camera or back camera photo using a single user interface element are described. In one embodiment, an apparatus may comprise a touch controller 215, a visual media capture controller 278, and a storage 236. The touch controller 215 may be operative to receive a haptic engagement signal. The visual media capture controller 278 may be operative to be configured in a capture mode based on whether a haptic disengagement signal is received by the touch controller 215 before expiration of a pre-set threshold of first timer, the capture mode one of a front camera photo capture mode or back camera photo capture mode, the first timer 4020 started in response to receiving the haptic engagement signal 4015, the first timer 4020 maximum threshold configured to expire after a first preset duration. The storage component may be operative to store visual media captured by the visual media capture controller in the configured capture mode. Other embodiments are described and claimed.

In an embodiment, an electronic device 200, comprising: digital image sensors 244 to capture visual media; a display 210 to present the visual media from the digital image sensors 244; a touch controller 215 to identify haptic contact engagement, haptic contact persistence and haptic contact release or haptic contact disengagement on the display 210; and a visual media capture controller 278 to alternately record the visual media as a back camera photo or a front camera photo based upon an evaluation of the time period between the haptic contact engagement and the haptic contact release. The visual media capture controller 278 presents a single mode input icon on the display to receive the haptic contact engagement, haptic contact persistence and haptic content release. The visual media capture controller 278 selectively stores the photo in a photo library. After capturing back camera photo or front camera photo, the visual media capture controller invokes a photo preview mode. The visual media capture controller selects a frame of the video to form the photo. The visual media capture controller stores the photo upon haptic contact engagement.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores a visual media capture controller 278 to implement operations of the invention. The visual media capture controller 278 includes executable instructions to alternately record a front camera photo or a back camera photo based upon the processing of haptic signals, as discussed below.

The visual media controller 278 interacts with a photo library controller 294, which includes executable instructions to store, organize and present photos 291. The photo library controller may be a standard photo library controller known in the art.

The processor 230 is also coupled to image sensors 244. The image sensors 244 may be known digital image sensors, such as charge coupled devices. The image sensors capture visual media, which is presented on display 210. That is, in a visual media mode controlled by the visual media capture controller 278, the image sensors 244 capture visual media and present the visual media on the display 210 so that a user can observe the captured visual media.

A touch controller 215 is connected to the display 210 and the processor 230. The touch controller 215 is responsive to haptic signals applied to the display 210. In one embodiment, the visual media capture controller 278 presents a single mode input icon on the display 210. That is, the visual media capture controller 278 includes executable instructions executed by the processor to present a single mode input icon on the display 210.

The visual media capture controller 278 communicates with the processor 230 regarding haptic signals applied to the display 210, which are recorded by the touch controller 215. In one configuration, the visual media capture controller 278 processes haptic signals applied to the single mode input icon, as detailed in connection with the discussion of FIG. 40 (B), and determines whether to record a front camera photo or a back camera photo, as discussed below.

The electronic device 200 may also include other components commonly associated with a smartphone, such as a wireless signal processor 220, a power control circuit 225 and a global positioning system processor 235. While many of components of FIG. 2 are known in the art, new functionality is achieved through the visual media capture controller 278.

FIG. 40 (A) illustrates processing operations associated with the visual media capture controller 278. Initially, a visual media capture mode is invoked 4005. For example, a user may access an application presented on display 210 to invoke a visual media capture mode. FIG. 40 (B) illustrates the exterior of electronic device 200. The Figure also illustrates the display 210. The electronic device 200 is in a visual media capture mode and presents visual media 4007. The display 210 also includes a single mode input icon 4008. In one embodiment, the amount of time that a user presses the single mode input icon 4008 determines whether a capture photo will be a front camera photo or a back camera photo. For example, if a user initially intends to take a back camera photo, then the icon 4008 is engaged with a haptic signal. If the user decides that the visual media should instead be a front camera photo, the user continues to engage the icon 4008. If the engagement is persists for a specified period of time (e.g., 3 seconds), then the output of the visual media capture is determined to be front camera photo. The back or front camera mode may be indicated on the display 210 with an icon 4010. Thus, a single gesture allows the user to seamlessly transition from a back camera photo mode to a front camera photo mode or from a front camera photo mode to a back camera photo mode and therefore control the media output during the capturing or recording process. This is accomplished without entering one mode or another prior to the capture sequence.

Returning to FIG. 40 (A), haptic contact engagement is identified 4015. For example, the haptic contact engagement may be at icon 4008 on display 210. The touch controller 215 generates haptic contact engagement signals for processing by the visual media capture controller 278 in conjunction with the processor 230. Alternately, the haptic contact may be at any location on the display 210.

Video is recorded and a timer is started 4020 in response to haptic contact engagement 4015. The video is recorded by the processor 230 operating in conjunction with the memory 236. Alternately, a still frame is taken from the video feed and is stored as a photo in response to haptic contact engagement. The timer is executed by the processor 230 under the control of the visual media capture controller 278.

Video continues to record and the timer continues to run in response to persistent haptic contact on the display. The elapsed time recorded by the timer is then evaluated by the visual media capture controller 278 against a specified threshold (e.g., 3 seconds). If the threshold is exceeded (4035—Yes), then the back camera mode change to front camera mode or front camera mode change to back camera mode (e.g. front camera mode) 4036. Then Saving or identifying time of loading or showing of or switching of front camera or back camera (e.g. front camera) 4038. Haptic contact release is identified 4040. The timer is then stopped then video is stored 4042, a frame of video is selected after loading time of front camera 4047 and is stored as a photo 4055. As indicated above, an alternate approach is to capture a still frame from the camera video feed as a photo upon haptic engagement. Such a photo is then passed to the photo library controller 294 for storage 291. The visual media capture controller 278 may then invoke a photo preview mode 4057 to allow a user to easily view the new photo.

If the threshold not exceeded (4035—No) and Haptic contact release is identified 4025. The timer is then stopped then video is stored 4030, a frame of video is selected 4047 and is stored as a photo 4058. As indicated above, an alternate approach is to capture a still frame from the camera video feed as a photo upon haptic engagement. Such a photo is then passed to the photo library controller 294 for storage. The visual media capture controller 278 may then invoke a photo preview mode 4057 to allow a user to easily view the new photo.

The foregoing embodiment relies upon evaluating haptic contact engagement, haptic contact persistence and haptic contact release. Based upon the expired time, either a front camera photo or a front camera photo is preserved. Thus, a single recording mode allows one to seamlessly transition between front camera photo and back camera photo capturing or recording.

In an alternate embodiment, the visual media capture mode is responsive to a first haptic contact signal (e.g., one tap) to record a front camera photo and a second haptic contact signal (e.g., two taps) to record a back camera photo. In an alternate embodiment, the visual media capture mode is responsive to a first haptic contact signal (e.g., one tap) to record a back camera photo and a second haptic contact signal (e.g., two taps) to record a front camera photo. In this case, there is not persistent haptic contact, but different visual media modes are easily entered. Indeed, the visual media capture controller 278 may be configured to interpret two taps within a specified period as an invocation of the front or back camera photo capture mode. This allows a user to smoothly transition from intent to take a front camera picture to a desire to take a back camera picture or allows a user to smoothly transition from intent to take a back camera picture to a desire to take a front camera picture.

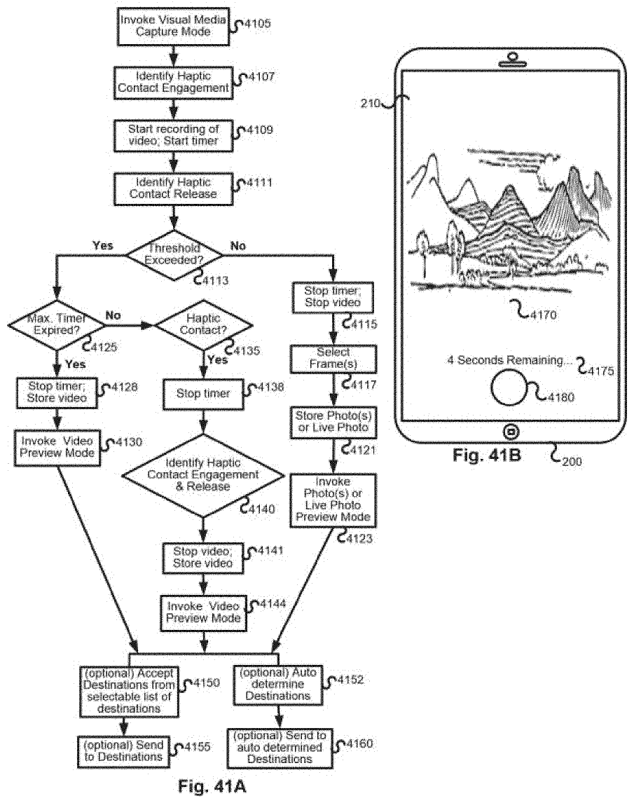

FIG. 41 illustrates in an embodiment the visual media capture controller 278 which enable user to single mode visual media capture that alternately produces photos and pre-set duration of video and in the event of haptic contact engagement enables user to stop said pre-set duration of video limitation and allow user to record video up-to further haptic contact engagement for manually stopping video.

FIG. 41 explains, a computer-implemented method, comprising: receiving a haptic engagement signal 4105; starting a recording of video and starting a timer 4109 in response to receiving the haptic engagement signal 4107; receiving a haptic release signal 4111; in the event not exceeding of threshold (e.g. less than or equal to 2 or 3 seconds) (4113—No) stop timer and stop video 4115; select or extract frame(s) 4117; store photo 4121; in the event exceeding of threshold (e.g. greater than or equal to 2 or 3 seconds) (4113—Yes), check is made whether pre-set maximum duration of timer expired or pre-set maximum duration of video recorded (4125—Yes) (e.g. pre-set maximum of 10 seconds of video) stop timer and stop video; in the event of pre-set maximum duration of timer not expired or pre-set maximum duration of video not yet recorded (4125—No) (e.g. recording of less than pre-set maximum of 10 seconds of video) and receiving a haptic engagement signal 4135; stop timer (for enabling user to take more than pre-set duration of video i.e. more than pre-set 10 seconds of video) 4138; in the event of identifying Haptic Contact Engagement & Release 4140, stop video and store video 4142.

In another embodiment invoke photo preview mode 4123; accept one or more destinations including accept from user one or more contacts or groups 4150 or auto determine destination(s) 4152 based on pre-set default destination(s) or auto selected destination(s); and enable user to send to 4155 or auto send 4160 said captured photo to said destination(s).

In another embodiment invoke video preview mode 4130 or 4144; accept one or more destinations including accept from user one or more contacts or groups 4150 or auto determine destination(s) 4152 based on pre-set default destination(s) or auto selected destination(s); and enable user to send to 4155 or auto send 4160 said recorded video to said destination(s).

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores a visual media capture controller 278 to implement operations of the invention. The visual media capture controller 278 includes executable instructions to alternately record a photo or a pre-set duration of recording of video or cancel said pre-set duration of video and record video as per user need base length of video based upon the processing of haptic signals, as discussed below.

The visual media controller 278 interacts with a photo library controller 294, which includes executable instructions to store, organize and present photos 291. The photo library controller may be a standard photo library controller known in the art. The visual media controller 278 also interacts with a video library controller 296, which includes executable instructions to store, organize and present videos 292. The video library controller may also be a standard video library controller known in the art.

The processor 230 is also coupled to image sensors 244. The image sensors 244 may be known digital image sensors, such as charge coupled devices. The image sensors capture visual media, which is presented on display 210. That is, in a visual media mode controlled by the visual media capture controller 278, the image sensors 244 capture visual media and present the visual media on the display 210 so that a user can observe the captured visual media.

A touch controller 215 is connected to the display 210 and the processor 230. The touch controller 215 is responsive to haptic signals applied to the display 210. In one embodiment, the visual media capture controller 278 presents a single mode input icon on the display 210. That is, the visual media capture controller 278 includes executable instructions executed by the processor to present a single mode input icon on the display 210.

The visual media capture controller 278 communicates with the processor 230 regarding haptic signals applied to the display 210, which are recorded by the touch controller 215. In one configuration, the visual media capture controller 278 processes haptic signals applied to the single mode input icon, as detailed in connection with the discussion of FIG. 41 (A), and determines whether to record a photo or auto stop and save pre-set duration of video or based on haptic contact engagement & release record length or duration of video as per user need, as discussed below.

The electronic device 100 may also include other components commonly associated with a smartphone, such as a wireless signal processor 220, a power control circuit 225 and a global positioning system processor 235. While many of components of FIG. 2 are known in the art, new functionality is achieved through the visual media capture controller 278.

FIG. 41 (A) illustrates processing operations associated with the visual media capture controller 278. Initially, a visual media capture mode is invoked 4105. For example, a user may access an application presented on display 210 to invoke a visual media capture mode. FIG. 41 (B) illustrates the exterior of electronic device 200. The Figure also illustrates the display 210. The electronic device 200 is in a visual media capture mode and presents visual media 4170. The display 210 also includes a single mode input icon 4180. In one embodiment, the amount of time that a user presses the single mode input icon 4180 determines whether a photo will be recorded or a pre-set duration of video and further haptic contact engagement & release enable user to cancel auto stopping of video after pre-set duration of video and continue record video as per user need or up-to stop by user via further haptic contact engagement & release. For example, if a user initially intends to take a photo, then the icon 4180 is engaged with a haptic signal. If the user decides that the visual media should instead be a pre-set duration of video and in the expiry of pre-set duration timer auto stop video & auto save video, the user continues to engage the icon 4180 to start recording of video. If the engagement is persists for a specified period of time (e.g., 3 seconds), then the output of the visual media capture is determined to be video and starts recording of video. In the event of further haptic contact user can stop pre-set duration limitations and enable to continue recording of video up-to user further haptic contact and manually stops video. The video mode may be indicated on the display 210 with an icon. Thus, a single gesture allows the user to seamlessly transition from a photo mode to a video mode and therefore control the media output during the recording process. This is accomplished without entering one mode or another prior to the capture sequence.

Returning to FIG. 41(A), haptic contact engagement is identified 4107. For example, the haptic contact engagement may be at icon 4180 on display 210. The touch controller 215 generates haptic contact engagement signals for processing by the visual media capture controller 210 in conjunction with the processor 230. Alternately, the haptic contact may be at any location on the display 210.

Video is recorded and a timer is started 4109 in response to haptic contact engagement 4107. The video is recorded by the processor 230 operating in conjunction with the memory 236. Alternately, a still frame is taken from the video feed 4117 and is stored as a photo 4121 in response to haptic contact engagement and then video is recorded. The timer is executed by the processor 230 under the control of the visual media capture controller 278.

Video continues to record up-to pre-set duration of timer expired 4125. Haptic contact release is subsequently identified 4111. The elapsed time recorded by the timer is then evaluated by the visual media capture controller 278 against a specified threshold (e.g., 3 seconds). If the threshold is exceeded (4113—Yes) and pre-set duration of timer expired (4125—Yes) then timer is then stopped and video is stored 4128. If -set duration of timer not expired or not exceeded (4125—No) and identification of haptic contact engagement (4135—Yes) then stop timer 4138 of pre-set duration of video limitation and in the event of further identification of haptic contact engagement & release (4140—Yes) stop video and store video 4142. In particular, a video is sent to the video library controller 296 for handling. In one embodiment, the visual media capture controller 278 includes executable instructions to prompt the video library controller to enter a video preview mode 4130 or 4144. Consequently, a user can conveniently review a recently recorded video.

If the threshold is not exceeded (4113—No), a frame of video is selected 4117 and is stored as a photo 4121. As indicated above, an alternate approach is to capture a still frame from the camera video feed as a photo upon haptic engagement. Such a photo is then passed to the photo library controller 294 for storage 291. The visual media capture controller 278 may then invoke a photo preview mode 4123 to allow a user to easily view the new photo.

In an embodiment user is informed about remaining time of pre-set duration of video via text status or icon or visual presentation e.g. 4175.

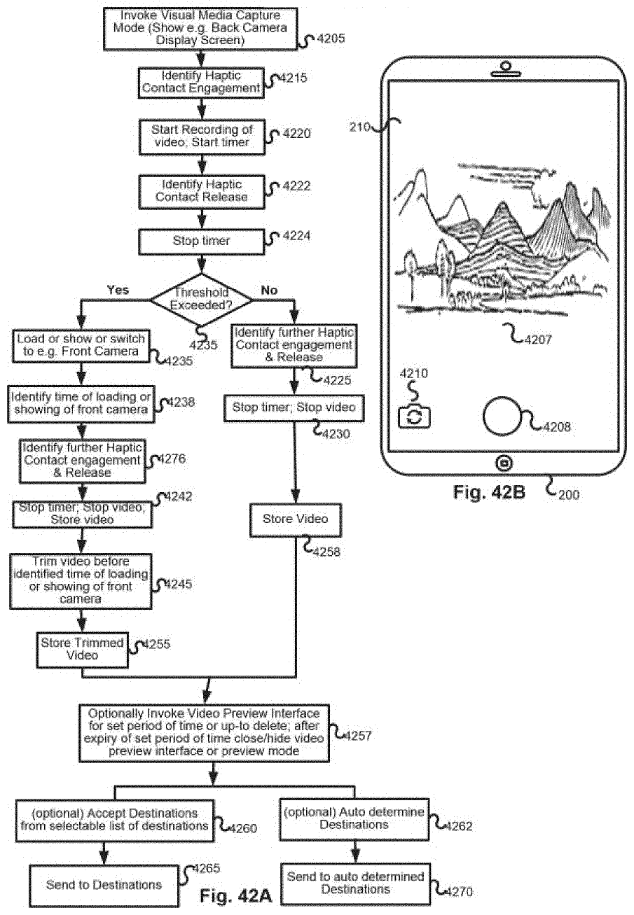

FIG. 42 illustrates logic flow for the visual media capture system. Techniques to selectively capture front camera or back camera video using a single user interface element are described. In one embodiment, an apparatus may comprise a touch controller 215, a visual media capture controller 278, and a storage 236. The touch controller 215 may be operative to receive a haptic engagement signal. The visual media capture controller 278 may be operative to be configured in a capture mode based on whether a haptic disengagement signal is received by the touch controller 215 before expiration of a pre-set threshold of first timer, the capture mode one of a front camera video record mode or back camera video record mode, the first timer 4020 started in response to receiving the haptic engagement signal 4215, the first timer 4220 maximum threshold configured to expire after a first preset duration. The storage component may be operative to store visual media captured by the visual media capture controller in the configured capture mode. Other embodiments are described and claimed.

In an embodiment, an electronic device 200, comprising: digital image sensors 244 to capture visual media; a display 210 to present the visual media from the digital image sensors 244; a touch controller 215 to identify haptic contact engagement, haptic contact persistence and haptic contact release or haptic contact disengagement on the display 210; and a visual media capture controller 278 to alternately record the visual media as a back camera video or a front camera video based upon an evaluation of the time period between the haptic contact engagement and the haptic contact release. The visual media capture controller 278 presents a single mode input icon on the display to receive the haptic contact engagement, haptic contact persistence and haptic content release. The visual media capture controller 278 selectively stores the video in a video library. After capturing back camera video or front camera video, the visual media capture controller invokes a video preview mode. The visual media capture controller stores the video upon haptic contact engagement.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores a visual media capture controller 278 to implement operations of the invention. The visual media capture controller 278 includes executable instructions to alternately record a front camera video or a back camera video based upon the processing of haptic signals, as discussed below.

The visual media controller 278 also interacts with a video library controller 296, which includes executable instructions to store, organize and present videos 292. The video library controller may also be a standard video library controller known in the art.

The processor 230 is also coupled to image sensors 244. The image sensors 244 may be known digital image sensors, such as charge coupled devices. The image sensors capture visual media, which is presented on display 210. That is, in a visual media mode controlled by the visual media capture controller 278, the image sensors 244 capture visual media and present the visual media on the display 210 so that a user can observe the captured visual media.

A touch controller 215 is connected to the display 210 and the processor 230. The touch controller 215 is responsive to haptic signals applied to the display 210. In one embodiment, the visual media capture controller 278 presents a single mode input icon on the display 210. That is, the visual media capture controller 278 includes executable instructions executed by the processor to present a single mode input icon on the display 210.

The visual media capture controller 278 communicates with the processor 230 regarding haptic signals applied to the display 210, which are recorded by the touch controller 215. In one configuration, the visual media capture controller 278 processes haptic signals applied to the single mode input icon, as detailed in connection with the discussion of FIG. 42 (B), and determines whether to record a front camera photo or a back camera video, as discussed below.

The electronic device 200 may also include other components commonly associated with a smartphone, such as a wireless signal processor 220, a power control circuit 225 and a global positioning system processor 235. While many of components of FIG. 2 are known in the art, new functionality is achieved through the visual media capture controller 278.

FIG. 42 (A) illustrates processing operations associated with the visual media capture controller 278. Initially, a visual media capture mode is invoked 4205. For example, a user may access an application presented on display 210 to invoke a visual media capture mode. FIG. 42 (B) illustrates the exterior of electronic device 200. The Figure also illustrates the display 210. The electronic device 200 is in a visual media capture mode and presents visual media 4207. The display 210 also includes a single mode input icon 4208. In one embodiment, the amount of time that a user presses the single mode input icon 4208 determines whether a capture video will be a front camera video or a back camera video. For example, if a user initially intends to take a back camera video, then the icon 4208 is engaged with a haptic signal. If the user decides that the visual media should instead be a front camera video, the user continues to engage the icon 4208. If the engagement is persists for a specified period of time (e.g., 3 seconds), then the output of the visual media capture is determined to be front camera video. The back or front camera mode may be indicated on the display 210 with an icon 4010. Thus, a single gesture allows the user to seamlessly transition from a back camera video mode to a front camera video mode or from a front camera video mode to a back camera video mode and therefore control the media output during the capturing or recording process. This is accomplished without entering one mode or another prior to the capture sequence.

Returning to FIG. 42 (A), haptic contact engagement is identified 4215. For example, the haptic contact engagement may be at icon 4208 on display 210. The touch controller 215 generates haptic contact engagement signals for processing by the visual media capture controller 278 in conjunction with the processor 230. Alternately, the haptic contact may be at any location on the display 210.

Video is recorded and a timer is started 4220 in response to haptic contact engagement 4215. The video is recorded by the processor 230 operating in conjunction with the memory 236. The timer is executed by the processor 230 under the control of the visual media capture controller 278.

Video continues to record and the timer continues to run in response to persistent haptic contact on the display. The elapsed time recorded by the timer is then evaluated by the visual media capture controller 278 against a specified threshold (e.g., 3 seconds). Identify haptic contact release 4222 and stop timer 4224. If the threshold is exceeded (4235—Yes), then the back camera mode change to front camera mode or front camera mode change to back camera mode (e.g. front camera mode) 4235. Then Saving or identifying time of loading or showing of or switching of front camera or back camera (e.g. front camera) 4238. In an embodiment further Haptic contact engagement & release is identified 4276. The timer is then stopped, video is stopped then video is stored 4242 or in another embodiment auto stop video after expiry of pre-set duration and store video. Then trim video before identified time of loading or showing of front camera 4245 and is stored as a trimmed video 4255. The visual media capture controller 278 may then invoke a video preview mode 4257 to allow a user to easily view the new video.

If the threshold not exceeded (4235—No) and Haptic contact engagement & release is identified 4225. The timer is then stopped then video is stopped 4230, and video is stored 4258. The visual media capture controller 278 may then invoke a video preview mode 4257 to allow a user to easily view the new video.

The foregoing embodiment relies upon evaluating haptic contact engagement, haptic contact persistence and haptic contact release. Based upon the expired time, either a front camera video or a front camera video is preserved. Thus, a single recording mode allows one to seamlessly transition between front camera video and back camera video recording.

In an alternate embodiment, the visual media capture mode is responsive to a first haptic contact signal (e.g., one tap) to record a front camera video and a second haptic contact signal (e.g., two taps) to record a back camera video. In an alternate embodiment, the visual media capture mode is responsive to a first haptic contact signal (e.g., one tap) to record a back camera video and a second haptic contact signal (e.g., two taps) to record a front camera video. In this case, there is not persistent haptic contact, but different visual media modes are easily entered. Indeed, the visual media capture controller 278 may be configured to interpret two taps within a specified period as an invocation of the front or back camera video capture mode. This allows a user to smoothly transition from intent to take a front camera video to a desire to take a back camera video or allows a user to smoothly transition from intent to take a back camera video to a desire to take a front camera video.

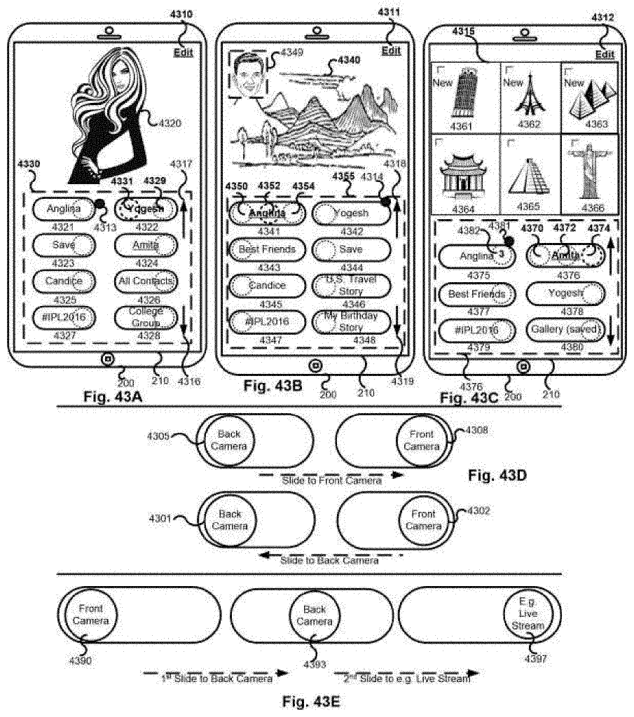

FIG. 43-47 illustrates various embodiments of intelligent multi-tasking visual media capture controller 278.

Some of the components of an electronic device of FIG. 2 illustrate implementing multi-tasking single mode visual media capture in accordance with the invention. FIG. 44 illustrates processing operations associated with an embodiment of the invention. FIG. 43 (A) illustrates the exterior of an electronic device implementing multi-tasking single mode visual media capture.

In another embodiment FIGS. 44 with 43(A) illustrates, an electronic device 200, comprising: digital image sensors 244 to capture visual media e.g. 4320; a display 210 to present the visual media e.g. 4320 from the digital image sensors 244; a touch controller 215 to identify haptic contact engagement, haptic swipe, haptic contact persistence and haptic contact release on the display 210; present a user interface or tray 4330 on the display 210 to a user of a client device 200, the user interface 4330 comprising visual media capture controller controls or labels and/or images or icons 4406 (e.g. 4321-4328) includes a plurality of contact icons or labels e.g. 4321-4328, each contact icon or label representing one or more contacts of the user; receive a single user interaction with a selected contact icon of the plurality of contact icons included in the user interface or tray 4330; a multi-tasking pre-configured or auto generated or auto presented visual media capture controller controls or labels and/or images or icons 4406 (e.g. 4321-4328); in responsive to receiving the single user interaction or identification of haptic swipe or particular type of swipe from particular visual media capture controller control (e.g. 4322) including e.g. swipe right (4329) to swipe left (4331) for changing from front camera to back camera (4409—Yes) then show Back Camera 4428 or e.g. swipe left (4331) to swipe right (4329) for changing from back camera to front camera (4407—Yes) then show Front Camera 4424 OR in response to not changing of front camera to back camera or back camera to front camera or keep current mode as it 4407—No or 4409—No, receiving haptic contact engagement 4431 on left side 4331 or on right side 4329 of particular visual media capture controller control e.g. 4322 from set of presented visual media capture controller controls or icons or labels 4331 (4321-4328); after changing mode via swipe from left to right or swipe from right to left and maintaining of haptic contact persistent on left side (e.g. 4331) or right side (e.g. 4329) area of visual media capture controller control (e.g. 4322) or after not changing mode and receiving of direct haptic contact engagement on left side e.g. 4331 or right side e.g. 4329 of particular visual media capture controller control (e.g. 4322), start recording of video and start timer 4432; in response to identification or receiving of haptic contact release 4435 stop video and stop timer and if threshold not exceeded (e.g. less than 2 or 3 seconds) 4444—No then select or extract one or more frames or images 4455 from recorded video or series of images 4440 and store photo 4460; optionally invoke photo preview mode 4468 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4322 or selected visual media capture controller control or label associated contact e.g. 4322, and send the captured photo to the identified contact 4470 or in other embodiment send to user selected contact; If threshold exceeded (e.g. more than 2 or 3 seconds) 4444—Yes then store video 4450; optionally invoke video preview mode 4458 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4322, and send the recorded video to the identified contact 4480 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores a visual media capture controller 278 to implement operations of the invention. The visual media capture controller 278 includes executable instructions to alternately record a front camera or back camera photo or a video or conduction one or more pre-configured tasks or activities or processing or executing of functions including cancel capturing of photo or recording of video or view received contents from visual media capture controller label associated contact(s) or group(s) or source(s) or broadcast live video streaming & like based upon the processing of haptic signals, as discussed below.

The visual media controller 278 interacts with a photo library controller 294, which includes executable instructions to store, organize and present photos 291. The photo library controller may be a standard photo library controller known in the art. The visual media controller 278 also interacts with a video library controller 296, which includes executable instructions to store, organize and present videos 292. The video library controller may also be a standard video library controller known in the art.

The processor 230 is also coupled to image sensors 244. The image sensors 244 may be known digital image sensors, such as charge coupled devices. The image sensors capture visual media, which is presented on display 210. That is, in a visual media mode controlled by the visual media capture controller 278, the image sensors 244 capture visual media and present the visual media on the display 210 so that a user can observe the captured visual media.

A touch controller 215 is connected to the display 210 and the processor 230. The touch controller 215 is responsive to haptic signals applied to the display 210. In one embodiment, the visual media capture controller 278 presents a single mode input icon e.g. 4322 on the display 210. That is, the visual media capture controller 278 includes executable instructions executed by the processor to present a single mode input icon on the display 210.

The visual media capture controller 278 communicates with the processor 230 regarding haptic signals applied to the display 210, which are recorded by the touch controller 215. In one configuration, the visual media capture controller 278 processes haptic signals applied to the single mode input icon or multi-tasking visual media capture controller label and/or icon or control e.g. 4322, as detailed in connection with the discussion of FIG. 44, and determines whether to record a front camera photo or a back camera photo or a front camera video or a back camera video or access pre-configured interface or execute pre-configured functions including view visual media controller associated contact related received visual media including photos or videos 4315 or cancel capturing of photo or recording of video or broadcast recorded video & like, as discussed below.

The electronic device 200 may also include other components commonly associated with a smartphone, such as a wireless signal processor 220, a power control circuit 225 and a global positioning system processor 235. While many of components of FIG. 2 are known in the art, new functionality is achieved through the visual media capture controller 278.

FIG. 44 illustrates processing operations associated with the visual media capture controller 278. Initially, a visual media capture mode is invoked 4405. For example, a user may access an application presented on display 210 to invoke a visual media capture mode. FIG. 43 (A) illustrates the exterior of electronic device 200. The Figure also illustrates the display 210. The electronic device 200 is in a visual media capture mode and presents visual media 4320. The display 210 also includes one or more visual media capture controller controls or a single mode input icons 4330 (e.g. 4321-4328). In one embodiment, based on type of receiving of haptic contact swipe the single mode input icon e.g. 4322 determines whether a front or back camera photo will be recorded or a front camera or back camera video. In one embodiment, the amount of time that a user presses the single mode input icon e.g. 4322 determines whether a photo will be recorded or a video. For example, if a user initially intends to take a photo, then the icon (4330—front camera photo or 4329—back camera photo) 4322 is engaged with a haptic signal. If the user decides that the visual media should instead be a video, the user continues to engage the icon (4330—front camera video or 4329—back camera video) 4322. If the engagement is persists for a specified period of time (e.g., 3 seconds), then the output of the visual media capture is determined to be video. The video mode may be indicated on the display 210 (at prominent place—not shown in Figure) with an icon or label or animated or visual presentation. Thus, a single gesture allows the user to seamlessly transition from a front camera to back camera mode or from a back camera to a front camera mode and from a photo mode to a video mode and therefore control the media output during the recording process. This is accomplished without entering one mode or another prior to the capture sequence.

Returning to FIG. 44, particular type of haptic contact swipe including swipe or slide left to right or right to left is identified 4407 or 4409. For example, the haptic contact engagement may be at icon or pre-defined area 4331 or icon or pre-defined area 4329 on the visual media capture controller control or label e.g., 4322 on display 210. The touch controller 215 generates haptic contact swipe signals for processing by the visual media capture controller 278 in conjunction with the processor 230. Alternately, the haptic contact may be at any location on the display 210 for single visual media capture controller for capturing or recording front camera or back camera photo or video e.g. swipe left to switch to back camera and swipe right to switch to front camera and based on haptic contact persist for particular period decide capture mode as photo (e.g. 3 seconds) or video (if more than 3 seconds) and record video up-to haptic contact release then stop video and store video.

Based on haptic contact persist after switching of front camera to back camera mode or from back camera to front camera mode or direct haptic contact engagement on current default mode icon or area e.g. left side 4331 or right side 4329 of visual media capture controller label e.g. 4322, video is recorded and a timer is started in response to haptic contact engagement or persist 4431. The video is recorded by the processor 230 operating in conjunction with the memory 236. Alternately, a still frame is taken from the video feed and is stored as a photo in response to haptic contact engagement and then video is recorded. The timer is executed by the processor 230 under the control of the visual media capture controller 278.

Video continues to record 4432 and the timer continues to run 4432 in response to persistent haptic contact 4431 on the display 210. Haptic contact release is subsequently identified 4435. The timer is then stopped 4440, as is the recording of video 4440. The elapsed time recorded by the timer is then evaluated by the visual media capture controller 278 against a specified threshold (e.g., 3 seconds). If the threshold is exceeded (4444—Yes), then video is stored 4450. In particular, a video is sent to the video library controller 296 for handling. In one embodiment, the visual media capture controller 278 includes executable instructions to prompt the video library controller to enter a video preview mode 4958. Consequently, a user can conveniently review a recently recorded video.

If the threshold is not exceeded (4444—No), a frame of video is selected 4455 and is stored as a photo 4460. As indicated above, an alternate approach is to capture a still frame from the camera video feed as a photo upon haptic engagement. Such a photo is then passed to the photo library controller 294 for storage 291. The visual media capture controller 278 may then invoke a photo preview mode 4468 to allow a user to easily view the new photo.

The foregoing embodiment relies upon evaluating haptic contact engagement, haptic swipe, haptic contact persistence and haptic contact release. Based upon the expired time, either a front camera or back camera photo or a video is preserved. Thus, a single recording mode allows one to seamlessly transition between front camera and back camera and between photo and video recording.

In another embodiment, a photo is taken upon haptic contact engagement and a timer is started (but video is not recorded). If persistent haptic contact exists, as measured by the timer, for a specified period of time, then video is recorded. In this case, the user may then access both the photo and the video. Indeed, an option to choose both a photo and video may be supplied in accordance with different embodiments of the invention.

In an another embodiment after starting of video, user is enable to (1) while haptic contact persist e.g. 4331 (to take video up-to haptic release) swipe left side e.g. 4331 or swipe right side 4329 on particular visual media capture controller e.g. 4322 (2) haptic engagement and swipe left e.g. 4331 or swipe right e.g. 4329 on particular visual media capture controller e.g. 4322 (3) directly haptic contact engagement on left side or right side area or icon of particular visual media capture controller e.g. 4322 for switching from front camera to back camera or from back camera to front camera while recording of video, so user can record single video in both front camera or back camera mode.

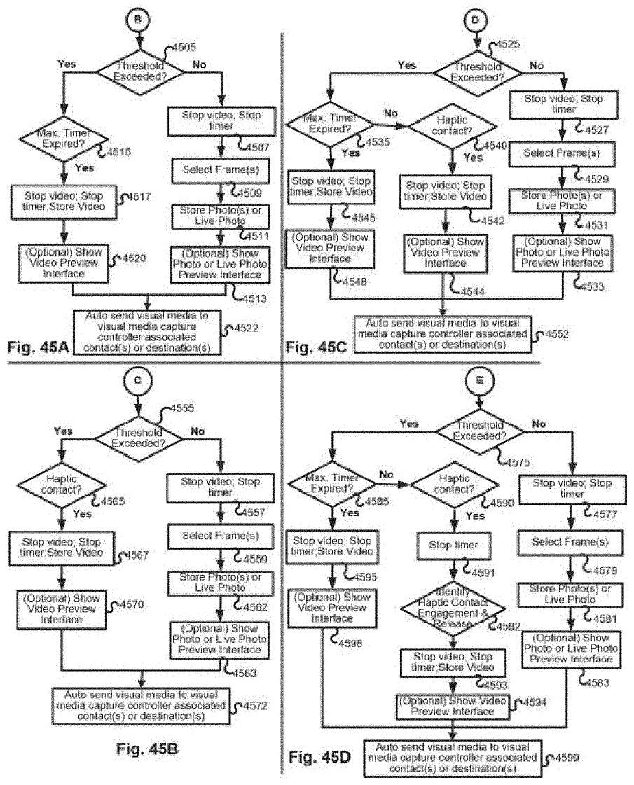

FIG. 45 illustrates various embodiments of FIG. 44. In another embodiment FIG. 43 (A) and FIG. 44 with FIG. 45 (B) illustrates, an electronic device 200, comprising: digital image sensors 244 to capture visual media e.g. 4320; a display 210 to present the visual media e.g. 4320 from the digital image sensors 244; a touch controller 215 to identify haptic contact engagement, haptic swipe, haptic contact persistence and haptic contact release on the display 210; present a user interface or tray 4330 on the display 210 to a user of a client device 200, the user interface 4330 comprising visual media capture controller controls or labels and/or images or icons 4406 (e.g. 4321-4328) includes a plurality of contact icons or labels e.g. 4321-4328, each contact icon or label representing one or more contacts of the user; receive a single user interaction with a selected contact icon of the plurality of contact icons included in the user interface or tray 4330; a multi-tasking pre-configured or auto generated or auto presented visual media capture controller controls or labels and/or images or icons 4406 (e.g. 4321-4328); in responsive to receiving the single user interaction or identification of haptic swipe or particular type of swipe from particular visual media capture controller control (e.g. 4322) including e.g. swipe right (4329) to swipe left (4331) for changing from front camera to back camera (4409—Yes) then show Back Camera 4428 or e.g. swipe left (4331) to swipe right (4329) for changing from back camera to front camera (4407—Yes) then show Front Camera 4424 OR in response to not changing of front camera to back camera or back camera to front camera or keep current mode as it 4407—No or 4409—No, receiving haptic contact engagement 4431 on left side 4331 or on right side 4329 of particular visual media capture controller control e.g. 4322 from set of presented visual media capture controller controls or icons or labels 4330 (4321-4328); after changing mode via swipe from left to right or swipe from right to left and maintaining of haptic contact persistent on left side (e.g. 4331) or right side (e.g. 4329) area of visual media capture controller control (e.g. 4322) or after not changing mode and receiving of direct haptic contact engagement on left side e.g. 4331 or right side e.g. 4329 of particular visual media capture controller control (e.g. 4322), start recording of video and start timer 4432; receive haptic contact release 4435; if threshold not exceeded (e.g. less than 2 or 3 seconds) 4505—No then stop video and stop timer 4507; select or extract one or more frames or images 4509 from recorded video or series of images and store photo 4511; optionally invoke photo preview mode 4513 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4322 or selected visual media capture controller control or label associated contact e.g. 4322, and send the captured photo to the identified contact 4522 or in other embodiment send to user selected contact; If threshold exceeded (e.g. more than 2 or 3 seconds) 4505—Yes then in the event of pre-set duration of video timer expires (4515—Yes) then store video 4517; optionally invoke video preview mode 4520 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4322, and send the recorded video to the identified contact 4522 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

In another embodiment FIG. 43 (A) and FIG. 44 with FIG. 45 (C) illustrates, an electronic device 200, comprising: digital image sensors 244 to capture visual media e.g. 4320; a display 210 to present the visual media e.g. 4320 from the digital image sensors 244; a touch controller 215 to identify haptic contact engagement, haptic swipe, haptic contact persistence and haptic contact release on the display 210; present a user interface or tray 4330 on the display 210 to a user of a client device 200, the user interface 4330 comprising visual media capture controller controls or labels and/or images or icons 4406 (e.g. 4321-4328) includes a plurality of contact icons or labels e.g. 4321-4328, each contact icon or label representing one or more contacts of the user; receive a single user interaction with a selected contact icon of the plurality of contact icons included in the user interface or tray 4330; a multi-tasking pre-configured or auto generated or auto presented visual media capture controller controls or labels and/or images or icons 4406 (e.g. 4321-4328); in responsive to receiving the single user interaction or identification of haptic swipe or particular type of swipe from particular visual media capture controller control (e.g. 4322) including e.g. swipe right (4329) to swipe left (4331) for changing from front camera to back camera (4409—Yes) then show Back Camera 4428 or e.g. swipe left (4331) to swipe right (4329) for changing from back camera to front camera (4407—Yes) then show Front Camera 4424 OR in response to not changing of front camera to back camera or back camera to front camera or keep current mode as it 4407—No or 4409—No, receiving haptic contact engagement 4431 on left side 4331 or on right side 4329 of particular visual media capture controller control e.g. 4322 from set of presented visual media capture controller controls or icons or labels 4330 (4321-4328); after changing mode via swipe from left to right or swipe from right to left of visual media capture controller control (e.g. 4322) or after not changing mode and receiving of direct haptic contact engagement on left side e.g. 4331 or right side e.g. 4329 of particular visual media capture controller control (e.g. 4322), start recording of video and start timer 4432; receive haptic contact release 4435; if threshold not exceeded (e.g. less than 2 or 3 seconds) 4555—No then stop video and stop timer 4557; select or extract one or more frames or images 4559 from recorded video or series of images and store photo 4562; optionally invoke photo preview mode 4563 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4322 or selected visual media capture controller control or label associated contact e.g. 4322, and send the captured photo to the identified contact 4572 or in other embodiment send to user selected contact; If threshold exceeded (e.g. more than 2 or 3 seconds) 4555—Yes then in the event of identification of further haptic contact & release (4565—Yes) then store video 4567; optionally invoke video preview mode 4570 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4322, and send the recorded video to the identified contact 4572 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

FIG. 45 illustrates various embodiments of FIG. 44. In another embodiment FIG. 43 (A) and FIG. 44 with FIG. 45 (D) illustrates, an electronic device 200, comprising: digital image sensors 244 to capture visual media e.g. 4320; a display 210 to present the visual media e.g. 4320 from the digital image sensors 244; a touch controller 215 to identify haptic contact engagement, haptic swipe, haptic contact persistence and haptic contact release on the display 210; present a user interface or tray 4330 on the display 210 to a user of a client device 200, the user interface 4330 comprising visual media capture controller controls or labels and/or images or icons 4406 (e.g. 4321-4328) includes a plurality of contact icons or labels e.g. 4321-4328, each contact icon or label representing one or more contacts of the user; receive a single user interaction with a selected contact icon of the plurality of contact icons included in the user interface or tray 4330; a multi-tasking pre-configured or auto generated or auto presented visual media capture controller controls or labels and/or images or icons 4406 (e.g. 4321-4328); in responsive to receiving the single user interaction or identification of haptic swipe or particular type of swipe from particular visual media capture controller control (e.g. 4322) including e.g. swipe right (4329) to swipe left (4331) for changing from front camera to back camera (4409—Yes) then show Back Camera 4428 or e.g. swipe left (4331) to swipe right (4329) for changing from back camera to front camera (4407—Yes) then show Front Camera 4424 OR in response to not changing of front camera to back camera or back camera to front camera or keep current mode as it 4407—No or 4409—No, receiving haptic contact engagement 4431 on left side 4331 or on right side 4329 of particular visual media capture controller control e.g. 4322 from set of presented visual media capture controller controls or icons or labels 4330 (4321-4328); after changing mode via swipe from left to right or swipe from right to left and maintaining of haptic contact persistent on left side (e.g. 4331) or right side (e.g. 4329) area of visual media capture controller control (e.g. 4322) or after not changing mode and receiving of direct haptic contact engagement on left side e.g. 4331 or right side e.g. 4329 of particular visual media capture controller control (e.g. 4322), start recording of video and start timer 4432; receive haptic contact release 4435; if threshold not exceeded (e.g. less than 2 or 3 seconds) 4525—No then stop video and stop timer 4527; select or extract one or more frames or images 4529 from recorded video or series of images and store photo 4531; optionally invoke photo preview mode 4533 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4322 or selected visual media capture controller control or label associated contact e.g. 4322, and send the captured photo to the identified contact 4552 or in other embodiment send to user selected contact; If threshold exceeded (e.g. more than 2 or 3 seconds) 4525—Yes then in the event of pre-set duration of video timer expires (4535—Yes) then store video 4545; optionally invoke video preview mode 4548 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4322, and send the recorded video to the identified contact 4552 or in other embodiment send to selected contact. If threshold exceeded (e.g. more than 2 or 3 seconds) 4525—Yes and pre-set duration of video timer not expires (4535—No) and in the event of receiving of haptic contact engagement (4540—Yes) then stop video & store video 4542; optionally invoke video preview mode 4544 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4322, and send the recorded video to the identified contact 4552 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

FIG. 45 illustrates various embodiments of FIG. 44. In another embodiment FIG. 43 (A) and FIG. 44 with FIG. 45 (E) illustrates, an electronic device 200, comprising: digital image sensors 244 to capture visual media e.g. 4320; a display 210 to present the visual media e.g. 4320 from the digital image sensors 244; a touch controller 215 to identify haptic contact engagement, haptic swipe, haptic contact persistence and haptic contact release on the display 210; present a user interface or tray 4330 on the display 210 to a user of a client device 200, the user interface 4330 comprising visual media capture controller controls or labels and/or images or icons 4406 (e.g. 4321-4328) includes a plurality of contact icons or labels e.g. 4321-4328, each contact icon or label representing one or more contacts of the user; receive a single user interaction with a selected contact icon of the plurality of contact icons included in the user interface or tray 4330; a multi-tasking pre-configured or auto generated or auto presented visual media capture controller controls or labels and/or images or icons 4406 (e.g. 4321-4328); in responsive to receiving the single user interaction or identification of haptic swipe or particular type of swipe from particular visual media capture controller control (e.g. 4322) including e.g. swipe right (4329) to swipe left (4331) for changing from front camera to back camera (4409—Yes) then show Back Camera 4428 or e.g. swipe left (4331) to swipe right (4329) for changing from back camera to front camera (4407—Yes) then show Front Camera 4424 OR in response to not changing of front camera to back camera or back camera to front camera or keep current mode as it 4407—No or 4409—No, receiving haptic contact engagement 4431 on left side 4331 or on right side 4329 of particular visual media capture controller control e.g. 4322 from set of presented visual media capture controller controls or icons or labels 4330 (4321-4328); after changing mode via swipe from left to right or swipe from right to left and maintaining of haptic contact persistent on left side (e.g. 4331) or right side (e.g. 4329) area of visual media capture controller control (e.g. 4322) or after not changing mode and receiving of direct haptic contact engagement on left side e.g. 4331 or right side e.g. 4329 of particular visual media capture controller control (e.g. 4322), start recording of video and start timer 4432; receive haptic contact release 4435; if threshold not exceeded (e.g. less than 2 or 3 seconds) 4575—No then stop video and stop timer 4577; select or extract one or more frames or images 4579 from recorded video or series of images and store photo 4581; optionally invoke photo preview mode 4583 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4322 or selected visual media capture controller control or label associated contact e.g. 4322, and send the captured photo to the identified contact 4599 or in other embodiment send to user selected contact; If threshold exceeded (e.g. more than 2 or 3 seconds) 4575—Yes then in the event of pre-set duration of video timer expires (4585—Yes) then store video 4595; optionally invoke video preview mode 4598 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4322, and send the recorded video to the identified contact 4599 or in other embodiment send to selected contact. If threshold exceeded (e.g. more than 2 or 3 seconds) 4575—Yes and pre-set duration of video timer not expires (4585—No) and in the event of receiving of haptic contact engagement (4590—Yes) then stop maximum or pre-set duration of video timer 4291 (for enabling user to stop video manually); in the event of identification of further haptic contact engagement & release or disengagement 4292 stop video & store video 4593; optionally invoke video preview mode 4594 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4322, and send the recorded video to the identified contact 4599 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

In an another embodiment after starting of video, user is enable to (1) while haptic contact persist e.g. 4331 (to take video up-to haptic release) swipe left side e.g. 4331 or swipe right side 4329 on particular visual media capture controller e.g. 4322 (2) haptic engagement and swipe left e.g. 4331 or swipe right e.g. 4329 on particular visual media capture controller e.g. 4322 (3) directly haptic contact engagement on left side or right side area or icon or anywhere area of particular visual media capture controller e.g. 4322 for capturing photo simultaneously while recording of video and after ending of video via (1) haptic release 4435 (44A), (2) Max. timer expired 4515—Yes (44B), (3) further haptic contact engagement 4565—Yes (44C) then photo or video preview mode invoke for pre-set duration and in the event of expiration of said pre-set preview of preview auto send said recorded video as well as one or more captured photo(s) while recording of video to said particular or accessed or selected visual media capture controller control or icon or label e.g. 4322 associated one or more contacts or groups or one or more types of one or more destinations (e.g. send to contact [Yogesh]). While capturing photo(s) during recording of video, system identifies or saves or mark time(s) in video and extract or takes or select said marked time(s) associated frame(s) or screenshot(s) or image(s) inside video or in another embodiment simultaneously recording video and capturing photo(s) while recording of video.

In another embodiment FIG. 43 (A) and FIG. 44 illustrates, an electronic for taking a still picture while recording a moving picture including video, the electronic device 200, comprising: digital image sensors 244 to capture visual media e.g. 4320; a display 210 to present the visual media e.g. 4320 from the digital image sensors 244; a touch controller 215 to identify haptic contact engagement, haptic swipe, haptic contact persistence and haptic contact release on the display 210; present a user interface or tray 4330 on the display 210 to a user of a client device 200, the user interface 4330 comprising visual media capture controller controls or labels and/or images or icons 4406 (e.g. 4321-4328) includes a plurality of contact icons or labels e.g. 4321-4328, each contact icon or label representing one or more contacts of the user; receive a single user interaction with a selected contact icon of the plurality of contact icons included in the user interface or tray 4330; a multi-tasking pre-configured default or user selected or auto generated or auto presented visual media capture controller controls or labels and/or images or icons 4406 (e.g. 4321-4328) to enable to capture photo while recording front camera or back camera video based on a user input instruction to take the still picture while recording the moving picture; in responsive to receiving the single user interaction or identification of haptic swipe or particular type of swipe from particular visual media capture controller control (e.g. 4322) including e.g. swipe right (4329) to swipe left (4331) for changing from front camera to back camera (4409—Yes) then show Back Camera 4428 or e.g. swipe left (4331) to swipe right (4329) for changing from back camera to front camera (4407—Yes) then show Front Camera 4424 OR in response to not changing of front camera to back camera or back camera to front camera or keep current mode as it 4407—No or 4409—No, receiving haptic contact engagement 4431 on left side 4331 or on right side 4329 of particular visual media capture controller control e.g. 4322 from set of presented visual media capture controller controls or icons or labels 4330 (4321-4328); after changing mode via swipe from left to right or swipe from right to left and maintaining of haptic contact persistent on left side (e.g. 4331) or right side (e.g. 4329) area of visual media capture controller control (e.g. 4322) or after not changing mode and receiving of direct haptic contact engagement on left side e.g. 4331 or right side e.g. 4329 of particular visual media capture controller control (e.g. 4322), start recording of video and start timer 4432; in response of threshold exceeded (4444—Yes) for start recording video user is enable to (1) while haptic contact persist e.g. 4331 (to take video up-to haptic release) swipe left side e.g. 4331 or swipe right side 4329 on particular visual media capture controller e.g. 4322 (2) haptic engagement and swipe left e.g. 4331 or swipe right e.g. 4329 on particular visual media capture controller e.g. 4322 (3) directly haptic contact engagement on left side or right side area or icon or anywhere area of particular visual media capture controller e.g. 4322 for capturing photo simultaneously while recording of video and after ending of video via (1) haptic release 4435 (44A), (2) Max. timer expired 4515—Yes (44B), (3) further haptic contact engagement 4565—Yes (44C) then sequences of photo(s) or video preview mode invoke for pre-set interval of duration and in the event of expiration of said pre-set preview timer present next photo or video and after expiry of last presented visual media associated preview timer, auto send said recorded video as well as one or more captured photo(s) to said particular or accessed or selected visual media capture controller control or icon or label e.g. 4322 associated one or more contacts or groups or one or more types of one or more destinations (e.g. send to contact [Yogesh]). While capturing photo(s) during recording of video, system identifies or saves or mark time(s) in video and extract or takes or select said marked time(s) associated frame(s) or screenshot(s) or image(s) inside video or in another embodiment simultaneously recording video and capturing of particular pre-set resolution photo(s) while recording of video. So snapping photos while recording video is possible and it will provide the ability to take a still photo while shooting video and user can take picture(s) during a single recording session as many times as user like in order to take multiple stills. In an embodiment the device, in a case where the picture being recorded has the same size as the previously set size of the still picture, the controller generates a control signal for instructing the camera picture capturing unit to capture the still picture and memorize a position where the captured picture is recorded as a recorded picture in the moving picture recorder, wherein information on the memorized position of the recorded picture is used to search the moving picture recorder for a corresponding picture, and then the corresponding picture is decoded and displayed so that, after recording is finished, a user can view the still picture and determine whether to store the still picture. In an embodiment the device, the controller reads and transmits the captured picture from the memory to the image signal processor, and the image signal processor adjusts the captured picture to have a size of the moving recorded picture and transmits the adjusted captured picture to the moving picture recorder.

In an another embodiment after changing to front camera mode 4424 or back camera mode 4428 and while maintaining of haptic contact persist on left or right side icon or pre-defined area of visual media capture controller control or label and/or icon e.g. 4322 and after starting of recording of video 4432 but before releasing of haptic contact 4335, in the event of further receiving of particular type of pre-defined swipe including swipe from left to right or right to left then cancel capturing of photo or recording of video 4432 i.e. stop recording of video, stop timer or reset or initiate timer and remove recorded video at 4432 and based on swipe type further start from 4407 or 4409 or 4424 or 4428. In an another embodiment after changing to front camera mode 4424 or back camera mode 4428 and while maintaining of haptic contact persist on left or right side icon or pre-defined area of visual media capture controller control or label and/or icon e.g. 4322, provide pre-set period of time (e.g. 1-2 seconds—in an embodiment show indication, in the form of icon or text or number of animation or visually, of wait timer on display 210) before starting recording of video and starting of timer 4432 for enabling user to change mode or properly view scene via camera display screen or camera view to take visual media.

In another embodiment after changing front camera 4428 or left camera mode 4428 via e.g. haptic swipe left or right, then in the event of haptic release from visual media capture controller e.g. 4322, user can haptic engagement or tap on left side icon or left side pre-defined area to capture photo or user can haptic engagement or tap on right side icon or right side pre-defined area to record video and stop video in the event of (1) expiration of pre-set duration of timer, (2) manually tap by user on video icon or further haptic contact engagement on pre-defined area of visual media capture controller control e.g. 4322, (3) one or more type of user sense via one or more types of sensor(s) and (4) hold to start recording of video and release to stop video.

In another embodiment enable user to tap pre-defined left side 4331 or right side 4329 or haptic contact engagement on pre-defined area of visual media capture controller control 4322 at step 4540 to stop video and store video 4542 and enable user to tap pre-defined left side 4331 or right side 4329 or haptic contact engagement on pre-defined area of visual media capture controller control 4322 at step 4590 to stop timer 4291 for enabling user to stop before expiration of maximum pre-defined or pre-set duration of video i.e. stop recording of video before auto stop after pre-set duration of time of video or enabling user to prevent auto stop after expiration of pre-set duration of video, so user can take more than pre-set duration of video and stop video manually.

In another embodiment after capturing photo and invoking photo preview mode or after recording video and invoking video preview mode, during pre-set duration of preview time user can tap on left or right side or enabled cross icon to cancel & remove photo or video and stop sending to destination(s) or contact(s) or user can tap on left or right side or enabled edit icon on visual media capture controller e.g. 4322 to edit or augment including select overlays, write text, use photo filters on recorded visual media.

In another embodiment after starting of video user can swipe left or right to stop video.

In another embodiment swipe left for photo or swipe right for video and in the event of not exceeding threshold use default or currently available or at present viewed or front or back camera and in the event of exceeding threshold change default or currently enabled mode e.g. if current mode is front camera mode then change to back camera mode and if current mode is back camera mode then change to front camera mode.

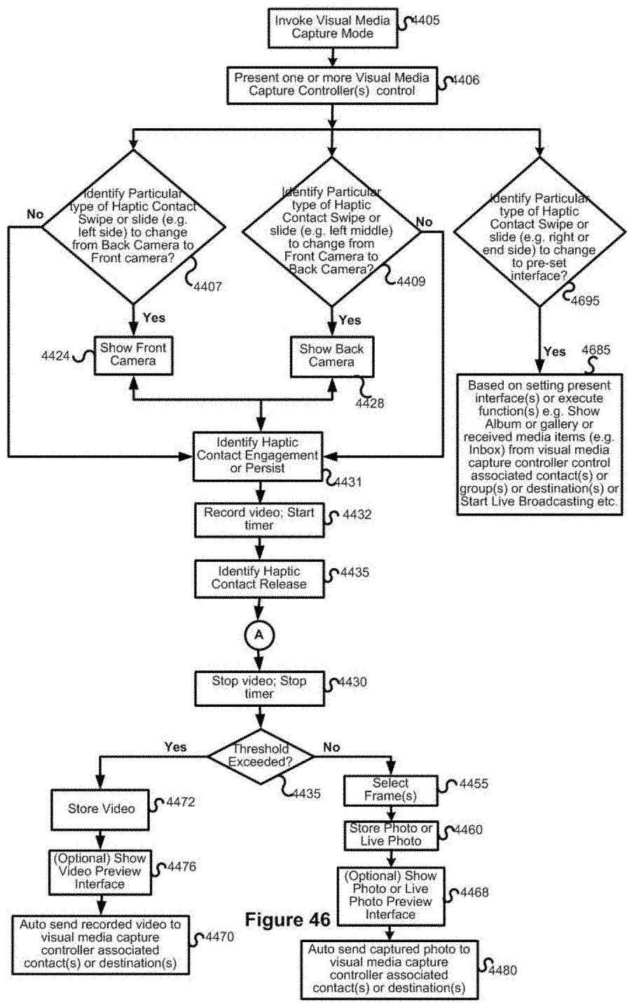

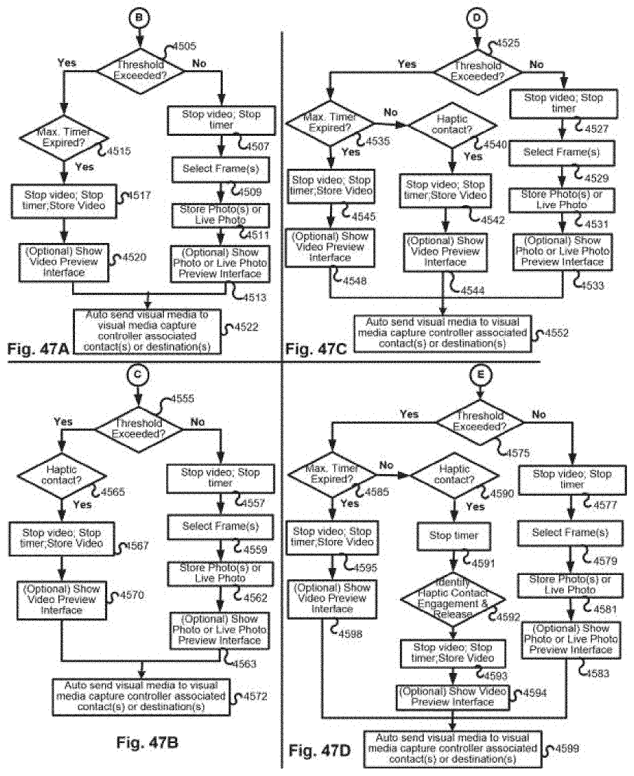

In another embodiment FIGS. 46 and 47 are slight variation of FIGS. 44 and 45, additional component is 3^{rd} or more customized button(s) 4695 in multi-tasking visual media capture control explains in 4695 and 4685 and FIG. 43 (B) which adds additional pre-defined area or button 4354 and enable user to customized said 3^{rd} button or pre-defined area e.g. 4354. In the event of identification of particular type of Haptic Contact swipe or slide (e.g. right or end side) to change to pre-set interface based on setting present interface(s) or execute function(s) e.g. show album or gallery or received media items (e.g. Inbox) from visual media capture controller control associated contact(s) or group(s) or destination(s) or start live broadcasting etc.

In another embodiment FIGS. 46 with 43(B) illustrates, an electronic device 200, comprising: digital image sensors 244 to capture visual media e.g. 4320; a display 210 to present the visual media e.g. 4340 from the digital image sensors 244; a touch controller 215 to identify haptic contact engagement, haptic swipe, haptic contact persistence and haptic contact release on the display 210; present a user interface or tray 4355 on the display 210 to a user of a client device 200, the user interface 4355 comprising visual media capture controller controls or labels and/or images or icons 4606 (e.g. 4341-4348) includes a plurality of contact icons or labels e.g. 4341-4348, each contact icon or label representing one or more contacts of the user; receive a single user interaction with a selected contact icon of the plurality of contact icons included in the user interface or tray 4355; a multi-tasking pre-configured or auto generated or auto presented visual media capture controller controls or labels and/or images or icons 4606 (e.g. 4341-4348); in responsive to receiving the single user interaction or identification of haptic swipe or particular type of swipe from particular visual media capture controller control (e.g. 4341) including e.g. swipe right (first button or pre-define area (4329)) to swipe left (second or middle or center button or pre-defined area (4331)) for changing from front camera to back camera (4409—Yes) then show Back Camera 4428 or e.g. swipe left (4331) to swipe right (4329) for changing from back camera to front camera (4407—Yes) then show Front Camera 4424 and swipe to end or 3^{rd} button or pre-defined area 4354 to access, execute, open, invoke or present one or more types of pre-configured or pre-set one or more interfaces, applications, features (e.g. show all or received new media items from said visual media capture controller associate contact or show inbox 4315), media items, functions (e.g. start broadcasting) OR in response to not changing of front camera to back camera or back camera to front camera or to 3^{rd} button or keep current mode as it 4607—No or 4609—No, receiving haptic contact engagement 4631 on left side 4350 or on right side 4352 of particular visual media capture controller control e.g. 4341 from set of presented visual media capture controller controls or icons or labels 4355 (4341-4348); after changing mode via swipe from left to right or swipe from right to left and maintaining of haptic contact persistent on left side (e.g. 4350) or right or middle or center side (e.g. 4352) area of visual media capture controller control (e.g. 4341) or after not changing mode and receiving of direct haptic contact engagement on left side e.g. 4350 or right or middle or center side e.g. 4352 of particular visual media capture controller control (e.g. 4341), start recording of video and start timer 4632; in response to identification or receiving of haptic contact release 4635 stop video and stop timer and if threshold not exceeded (e.g. less than 2 or 3 seconds) 4644—No then select or extract one or more frames or images 4655 from recorded video or series of images 4640 and store photo 4660; optionally invoke photo preview mode 4668 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4341 or selected visual media capture controller control or label associated contact e.g. 4341, and send the captured photo to the identified contact 4670 or in other embodiment send to user selected contact; If threshold exceeded (e.g. more than 2 or 3 seconds) 4644—Yes then store video 4650; optionally invoke video preview mode 4658 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4341, and send the recorded video to the identified contact 4680 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

FIG. 46 is similar to FIG. 44 and details of FIG. 46 are same as discussed in FIG. 44, only addition is 3^{rd} button or 3^{rd} pre-defined area (e.g. 4354) 4695 and 4685 (as describe above). FIG. 47 is similar to FIG. 45 and details of FIG. 47 are same as discussed in FIG. 45.

In another embodiment after selecting back camera mode and after staring of back camera video user can swipe to 3^{rd} button or pre-defined area 4354 and can able to start front camera selfie video 4349 to provide commentary on recording of video 4340 via back camera. For example user is recording natural scenery video 4340 at particular tourist place and can also enable to concurrently record front camera video to provide video comments or reviews or description or commentary on said currently recording of video via back camera related to current scene view by recorder.

In another embodiment after selecting back camera mode and after staring of back camera video user can swipe to 3^{rd} button or pre-defined area 4354 and can able to start capturing of one or more front camera selfie photo(s) 4349 via tapping at/on or swiping to particular pre-defined area of visual media capture controller label e.g. 4341 to provide user's expressions during recording of video 4340 via back camera. For example user is recording natural scenery video 4340 at particular tourist place and can also enable to concurrently capture one or more photo(s) via tapping on 4341 to provide user's face expressions on said currently recording of video via back camera related to current scene view by recorder.

In another embodiment FIG. 4309 illustrates single multi-tasking visual media capture controller with 2 buttons or 2 pre-defined area as discussed above, difference is it is not associated with contact, it enables to switch from front camera 4302 to back camera 4301 or from back camera 4305 to front camera 4308 and capture photo or record video based on duration of haptic contact persist and engagement as discussed above. Instead of auto sending to visual media capture controller associate contact, user have to manually select one or more contact(s) and/or destinations or auto send to pre-set one or more types of contact(s)/group(s) and/or destination(s) associate with said single visual media capture controller. It's an alternative to currently presented front or back camera mode button or icon, photo capture icon and video record icon of standard smartphone camera application or interface. User doesn't have to first change mode by tapping on camera mode change icon, then tap on photo icon to load photo capture interface and capture photo or tap on video icon to load video mode and start recording of video and then tap on stop icon to stop video. Instead user can swipe left to change mode to back camera or swipe right to change mode to front camera and based on duration of haptic contact engagement and persist on single mode multi-tasking visual media capture controller control or label and/or icon user can take photo or start recording of video and in an embodiment further tap to stop & store video or in an embodiment auto stop after pre-set duration of time and auto store (or tap before expiry of said pre-set max. duration of video to stop and store video) or in an embodiment in the event of haptic release from said single mode multi-tasking visual media capture controller control or label and/or icon stop and store video.

In another embodiment FIG. 4392 illustrates single multi-tasking visual media capture controller control with 3 buttons or 3 pre-defined area as discussed above, difference is it is not associated with contact, it enables to switch from front camera 4390 to back camera 4393 or from back camera 4393 to front camera 4390 and capture photo or record video based on duration of haptic contact persist and engagement as discussed above and also provide 3^{rd} button or predefined area on single multi-tasking visual media capture controller control 4392 and enable to configure or associate one or more applications, features, interfaces, functions and in the event of swipe to 3^{rd} button or 3^{rd} end side pre-defined area, present said associated or pre-set or pre-configured one or more applications, features, interfaces, or execute functions. Instead of auto sending to visual media capture controller associate contact, user have to manually select one or more contact(s) and/or destinations or auto send to pre-set one or more types of contact(s)/group(s) and/or destination(s) associate with said single visual media capture controller. It's an alternative to currently presented front or back camera mode button or icon, photo capture icon and video record icon of standard smartphone camera application or interface. User doesn't have to first change mode by tapping on camera mode change icon, then tap on photo icon to load photo capture interface and capture photo or tap on video icon to load video mode and start recording of video and then tap on stop icon to stop video and. Instead user can swipe left to change mode to back camera or swipe right to change mode to front camera and based on duration of haptic contact engagement and persist on single mode multi-tasking visual media capture controller control or label and/or icon user can take photo or start recording of video and in an embodiment further tap to stop & store video or in an embodiment auto stop after pre-set duration of time and auto store (or tap before expiry of said pre-set max. duration of video to stop and store video) or in an embodiment in the event of haptic release from said single mode multi-tasking visual media capture controller control or label and/or icon stop and store video. User can swipe to end or swipe to pre-defined area of said single mode multi-tasking visual media capture controller control or label and/or icon to view or access said presented pre-set or pre-configured one or more applications, interfaces, features and/or execute functions.

FIG. 48-52 illustrates various embodiments of intelligent multi-tasking visual media capture controller 278.

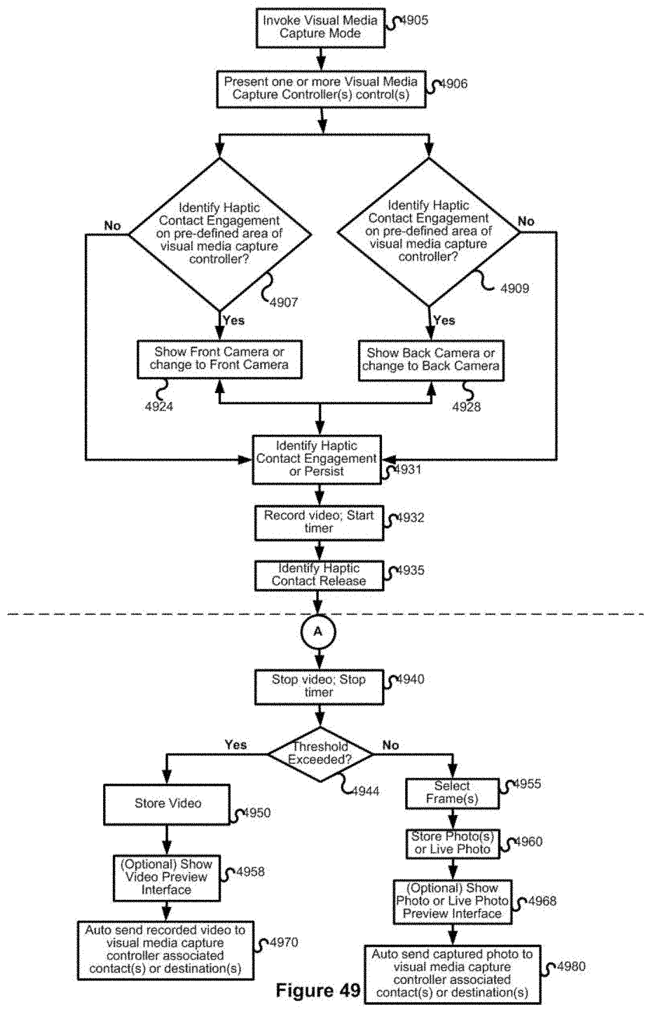

Some of the components of an electronic device of FIG. 2 illustrate implementing multi-tasking single mode visual media capture in accordance with the invention. FIG. 49 illustrates processing operations associated with an embodiment of the invention. FIG. 48 (A) illustrates the exterior of an electronic device implementing multi-tasking single mode visual media capture.

In another embodiment FIGS. 49 with 48(A) illustrates, an electronic device 200, comprising: digital image sensors 244 to capture visual media e.g. 4320; a display 210 to present the visual media e.g. 4320 from the digital image sensors 244; a touch controller 215 to identify haptic contact engagement, haptic contact persistence and haptic contact release on the display 210; present a user interface or tray 4830 on the display 210 to a user of a client device 200, the user interface 4830 comprising visual media capture controller controls or labels and/or images or icons 4906 (e.g. 4821-4828) includes a plurality of contact icons or labels e.g. 4821-4828, each contact icon or label representing one or more contacts of the user; receive a single user interaction with a selected contact icon of the plurality of contact icons included in the user interface or tray 4830; a multi-tasking pre-configured or auto generated or auto presented visual media capture controller controls or labels and/or images or icons 4906 (e.g. 4821-4828); in responsive to receiving the single user interaction or identification of haptic contact engagement on particular visual media capture controller control (e.g. 4822) including haptic contact engagement on pre-defined area (4829) to take visual media in front camera mode (If current camera mode is back camera mode then it will change to front camera mode 4924 (4907=Yes)) or haptic contact engagement on pre-defined area (4831) to take visual media in back camera mode (If current camera mode is front camera mode then it will change to back camera mode 4928 (4909=Yes)) OR in response to not changing of front camera to back camera or back camera to front camera or keep current mode as it 4907—No or 4909—No, receiving haptic contact engagement 4931 on left side 4831 or on right side 4829 of particular visual media capture controller control e.g. 4822 from set of presented visual media capture controller controls or icons or labels 4830 (4821-4828); after haptic contact engagement on pre-defined area and maintaining of haptic contact persistent on left side (e.g. 4831) or right side (e.g. 4829) area of visual media capture controller control (e.g. 4822), start recording of video and start timer 4932; in response to identification or receiving of haptic contact release 4935 stop video and stop timer and if threshold not exceeded (e.g. less than 2 or 3 seconds) 4944—No then select or extract one or more frames or images 4955 from recorded video or series of images 4940 and store photo 4960; optionally invoke photo preview mode 4968 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4822 or selected visual media capture controller control or label associated contact e.g. 4822, and send the captured photo to the identified contact 4970 or in other embodiment send to user selected contact; If threshold exceeded (e.g. more than 2 or 3 seconds) 4944—Yes then store video 4950; optionally invoke video preview mode 4958 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4822, and send the recorded video to the identified contact 4980 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

FIG. 1 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores a visual media capture controller 278 to implement operations of the invention. The visual media capture controller 278 includes executable instructions to alternately record a front camera or back camera photo or a video or conduction one or more pre-configured tasks or activities or processing or executing of functions including cancel capturing of photo or recording of video or view received contents from visual media capture controller label associated contact(s) or group(s) or source(s) or broadcast live video streaming & like based upon the processing of haptic signals, as discussed below.

The visual media controller 278 interacts with a photo library controller 294, which includes executable instructions to store, organize and present photos 291. The photo library controller may be a standard photo library controller known in the art. The visual media controller 278 also interacts with a video library controller 296, which includes executable instructions to store, organize and present videos 292. The video library controller may also be a standard video library controller known in the art.

The processor 230 is also coupled to image sensors 244. The image sensors 244 may be known digital image sensors, such as charge coupled devices. The image sensors capture visual media, which is presented on display 210. That is, in a visual media mode controlled by the visual media capture controller 278, the image sensors 244 capture visual media and present the visual media on the display 210 so that a user can observe the captured visual media.

A touch controller 215 is connected to the display 210 and the processor 230. The touch controller 215 is responsive to haptic signals applied to the display 210. In one embodiment, the visual media capture controller 278 presents a single mode input icon e.g. 4822 on the display 210. That is, the visual media capture controller 278 includes executable instructions executed by the processor to present a single mode input icon on the display 210.

The visual media capture controller 278 communicates with the processor 230 regarding haptic signals applied to the display 210, which are recorded by the touch controller 215. In one configuration, the visual media capture controller 278 processes haptic signals applied to the single mode input icon or multi-tasking visual media capture controller label and/or icon or control e.g. 4822, as detailed in connection with the discussion of FIG. 49, and determines whether to record a front camera photo or a back camera photo or a front camera video or a back camera video or access pre-configured interface or execute pre-configured functions including view visual media controller associated contact related received visual media including photos or videos 4815 or cancel capturing of photo or recording of video or broadcast recorded video & like, as discussed below.

The electronic device 200 may also include other components commonly associated with a smartphone, such as a wireless signal processor 220, a power control circuit 225 and a global positioning system processor 235. While many of components of FIG. 2 are known in the art, new functionality is achieved through the visual media capture controller 278.

FIG. 49 illustrates processing operations associated with the visual media capture controller 278. Initially, a visual media capture mode is invoked 4905. For example, a user may access an application presented on display 210 to invoke a visual media capture mode. FIG. 48 (A) illustrates the exterior of electronic device 200. The Figure also illustrates the display 210. The electronic device 200 is in a visual media capture mode and presents visual media 4820. The display 210 also includes one or more visual media capture controller controls or a single mode input icons 4830 (e.g. 4821-4828). In one embodiment, based on type of receiving of haptic contact swipe the single mode input icon e.g. 4822 determines whether a front or back camera photo will be recorded or a front camera or back camera video. In one embodiment, the amount of time that a user presses the single mode input icon e.g. 4822 determines whether a photo will be recorded or a video. For example, if a user initially intends to take a photo, then the icon (4831—front camera photo or 4829—back camera photo) 4822 is engaged with a haptic signal. If the user decides that the visual media should instead be a video, the user continues to engage the icon (4831—front camera video or 4829—back camera video) 4822. If the engagement is persists for a specified period of time (e.g., 3 seconds), then the output of the visual media capture is determined to be video. The video mode may be indicated on the display 210 (at prominent place—not shown in Figure) with an icon or label or animated or visual presentation. Thus, a single gesture allows the user to seamlessly transition from a front camera to back camera mode or from a back camera to a front camera mode and from a photo mode to a video mode and therefore control the media output during the recording process. This is accomplished without entering one mode or another prior to the capture sequence.

Returning to FIG. 49, identify haptic contact engagement on pre-defined area 4907 (4829) to take visual media in front camera mode 4924 (e.g. 4829) or identify haptic contact engagement on pre-defined area 4909 (4831) to take visual media in back camera mode 4928 (4829). For example, the haptic contact engagement may be at icon or pre-defined area 4831 or icon or pre-defined area 4829 on the visual media capture controller control or label e.g., 4822 on display 210. The touch controller 215 generates haptic contact engagement and persist signals for processing by the visual media capture controller 278 in conjunction with the processor 230. Alternately, the haptic contact may be at any location on the display 210 for single visual media capture controller for capturing or recording front camera or back camera photo or video e.g. haptic contact engagement on pre-defined area on left side to switch to back camera and haptic contact engagement on pre-defined area on right side to switch to front camera and based on haptic contact persist for particular period decide capture mode as photo (e.g. 3 seconds) or video (if more than 3 seconds) and record video up-to haptic contact release then stop video and store video.

Based on haptic contact persist after haptic contact engagement on current default mode icon or area e.g. left side 4831 for back camera mode or right side 4829 for front camera mode of visual media capture controller label e.g. 4822, video is recorded and a timer is started 4932 in response to haptic contact engagement or persist 4931. The video is recorded by the processor 230 operating in conjunction with the memory 236. Alternately, a still frame is taken from the video feed and is stored as a photo in response to haptic contact engagement and then video is recorded. The timer is executed by the processor 230 under the control of the visual media capture controller 278.

Video continues to record 4932 and the timer continues to run 4932 in response to persistent haptic contact 4931 on the display 210. Haptic contact release is subsequently identified 4935. The timer is then stopped 4940, as is the recording of video 4940. The elapsed time recorded by the timer is then evaluated by the visual media capture controller 278 against a specified threshold (e.g., 3 seconds). If the threshold is exceeded (4944—Yes), then video is stored 4950. In particular, a video is sent to the video library controller 296 for handling. In one embodiment, the visual media capture controller 278 includes executable instructions to prompt the video library controller to enter a video preview mode 4958. Consequently, a user can conveniently review a recently recorded video.

If the threshold is not exceeded (4944—No), a frame of video is selected 4955 and is stored as a photo 4960. As indicated above, an alternate approach is to capture a still frame from the camera video feed as a photo upon haptic engagement. Such a photo is then passed to the photo library controller 294 for storage 291. The visual media capture controller 278 may then invoke a photo preview mode 4968 to allow a user to easily view the new photo.

The foregoing embodiment relies upon evaluating haptic contact engagement, haptic contact persistence and haptic contact release. Based upon the expired time, either a front camera or back camera photo or a video is preserved. Thus, a single recording mode allows one to seamlessly transition between front camera and back camera and between photo capturing and video recording.

In another embodiment, a photo is taken upon haptic contact engagement and a timer is started (but video is not recorded). If persistent haptic contact exists, as measured by the timer, for a specified period of time, then video is recorded. In this case, the user may then access both the photo and the video. Indeed, an option to choose both a photo and video may be supplied in accordance with different embodiments of the invention.

In an another embodiment after starting of video, user is enable to (1) while haptic contact persist e.g. 4831 (to take video up-to haptic release) swipe left side e.g. 4831 or swipe right side 4829 on particular visual media capture controller e.g. 4822 (2) haptic engagement and swipe left e.g. 4831 or swipe right e.g. 4829 on particular visual media capture controller e.g. 4822 (3) directly haptic contact engagement on left side or right side area or icon of particular visual media capture controller e.g. 4822 for switching from front camera to back camera or from back camera to front camera while recording of video, so user can record single video in both front camera or back camera mode.

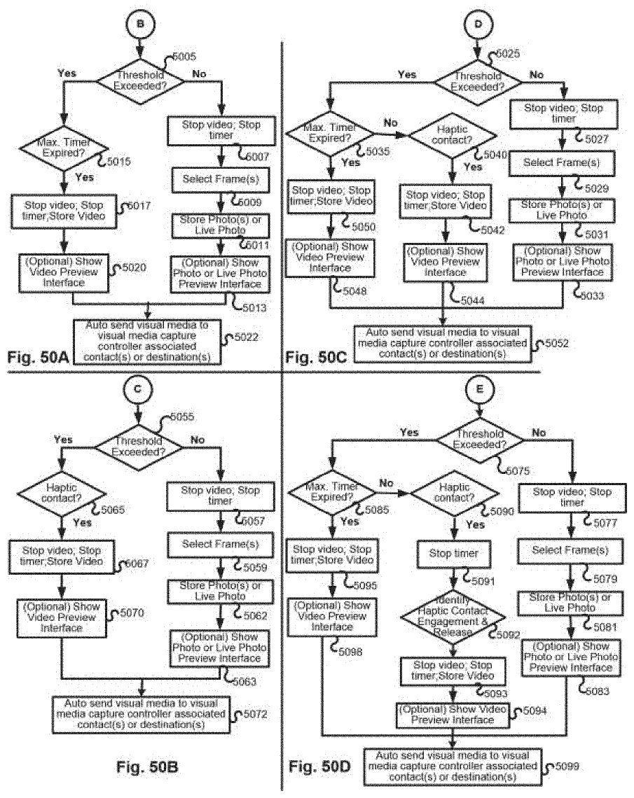

FIG. 50 illustrates various embodiments of FIG. 49. In another embodiment FIG. 48 (A) and FIG. 49 with FIG. 50 (B) illustrates, an electronic device 200, comprising: digital image sensors 244 to capture visual media e.g. 4820; a display 210 to present the visual media e.g. 4820 from the digital image sensors 244; a touch controller 215 to identify haptic contact engagement, haptic contact persistence and haptic contact release on the display 210; present a user interface or tray 4830 on the display 210 to a user of a client device 200, the user interface 4830 comprising visual media capture controller controls or labels and/or images or icons 4906 (4830 e.g. 4821-4828) includes a plurality of contact icons or labels e.g. 4821-4828, each contact icon or label representing one or more contacts of the user; receive a single user interaction with a selected contact icon of the plurality of contact icons included in the user interface or tray 4830; a multi-tasking pre-configured or auto generated or auto presented visual media capture controller controls or labels and/or images or icons 4906 (e.g. 4821-4828); in responsive to receiving the single user interaction or identification of haptic contact engagement on pre-defined area of particular visual media capture controller control (e.g. 4822) including haptic contact engagement on pre-defined area 4907=Yes e.g. right side (4829) to select front camera mode (if current camera mode is back camera mode then change to front camera mode 4924) or haptic contact engagement on pre-defined area 4909=Yes e.g. left side (4831) to select back camera mode (if current camera mode is front camera mode then change to back camera mode 4928) OR in response to not changing of front camera to back camera or back camera to front camera or keep current mode as it 4907—No or 4909—No, receiving haptic contact engagement or persist 4931 on left side 4831 to take visual media in back camera mode or on right side 4829 to take visual media in front camera mode of particular visual media capture controller control e.g. 4822 from set of presented visual media capture controller controls or icons or labels 4830 (4821-4828); after haptic contact engagement or left side area or right side area and maintaining of haptic contact persistent on left side (e.g. 4831) or right side (e.g. 4829) area of visual media capture controller control (e.g. 4822) or after not changing mode and receiving of direct haptic contact engagement on left side e.g. 4831 or right side e.g. 4829 of particular visual media capture controller control (e.g. 4822), start recording of video and start timer 4932; receive haptic contact release 4935; if threshold not exceeded (e.g. less than 2 or 3 seconds) 5005—No then stop video and stop timer 5007; select or extract one or more frames or images 5009 from recorded video or series of images and store photo 5011; optionally invoke photo preview mode 5013 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4822 or selected visual media capture controller control or label associated contact e.g. 4822, and send the captured photo to the identified contact 5022 or in other embodiment send to user selected contact; If threshold exceeded (e.g. more than 2 or 3 seconds) 5005—Yes then in the event of pre-set duration of video timer expires (5015—Yes) then store video 5017; optionally invoke video preview mode 5020 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4822, and send the recorded video to the identified contact 5022 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

In another embodiment FIG. 48 (A) and FIG. 49 with FIG. 50 (C) illustrates, an electronic device 200, comprising: digital image sensors 244 to capture visual media e.g. 4820; a display 210 to present the visual media e.g. 4820 from the digital image sensors 244; a touch controller 215 to identify haptic contact engagement, haptic contact persistence and haptic contact release on the display 210; present a user interface or tray 4830 on the display 210 to a user of a client device 200, the user interface 4830 comprising visual media capture controller controls or labels and/or images or icons 4906 (e.g. 4821-4828) includes a plurality of contact icons or labels e.g. 4821-4828, each contact icon or label representing one or more contacts of the user; receive a single user interaction with a selected contact icon of the plurality of contact icons included in the user interface or tray 4830; a multi-tasking pre-configured or auto generated or auto presented visual media capture controller controls or labels and/or images or icons 4906 (e.g. 4821-4828); in responsive to receiving the single user interaction or identification of haptic contact engagement on pre-defined area of particular visual media capture controller control (e.g. 4822) including haptic contact engagement on pre-defined area 4907=Yes e.g. right side (4829) to select front camera mode (if current camera mode is back camera mode then change to front camera mode 4924) or haptic contact engagement on pre-defined area 4909=Yes e.g. left side (4831) to select back camera mode (if current camera mode is front camera mode then change to back camera mode 4928) OR in response to not changing of front camera to back camera or back camera to front camera or keep current mode as it 4907—No or 4909—No, receiving haptic contact engagement or persist 4931 on left side 4831 to take visual media in back camera mode or on right side 4829 to take visual media in front camera mode of particular visual media capture controller control e.g. 4822 from set of presented visual media capture controller controls or icons or labels 4830 (4821-4828); after haptic contact engagement or left side area or right side area and maintaining of haptic contact persistent on left side (e.g. 4831) or right side (e.g. 4829) area of visual media capture controller control (e.g. 4822) or after not changing mode and receiving of direct haptic contact engagement on left side e.g. 4831 or right side e.g. 4829 of particular visual media capture controller control (e.g. 4822), start recording of video and start timer 4932; receive haptic contact release 4935; if threshold not exceeded (e.g. less than 2 or 3 seconds) 5055—No then stop video and stop timer 5057; select or extract one or more frames or images 5059 from recorded video or series of images and store photo 5062; optionally invoke photo preview mode 5063 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4822 or selected visual media capture controller control or label associated contact e.g. 4822, and send the captured photo to the identified contact 5072 or in other embodiment send to user selected contact; If threshold exceeded (e.g. more than 2 or 3 seconds) 5055—Yes then in the event of identification of further haptic contact & release (5065—Yes) then store video 5067; optionally invoke video preview mode 5070 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4822, and send the recorded video to the identified contact 5072 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

FIG. 50 illustrates various embodiments of FIG. 49. In another embodiment FIG. 48 (A) and FIG. 49 with FIG. 50 (D) illustrates, an electronic device 200, comprising: digital image sensors 244 to capture visual media e.g. 4820; a display 210 to present the visual media e.g. 4820 from the digital image sensors 244; a touch controller 215 to identify haptic contact engagement, haptic contact persistence and haptic contact release on the display 210; present a user interface or tray 4830 on the display 210 to a user of a client device 200, the user interface 4830 comprising visual media capture controller controls or labels and/or images or icons 4906 (e.g. 4821-4828) includes a plurality of contact icons or labels e.g. 4821-4828, each contact icon or label representing one or more contacts of the user; receive a single user interaction with a selected contact icon of the plurality of contact icons included in the user interface or tray 4830; a multi-tasking pre-configured or auto generated or auto presented visual media capture controller controls or labels and/or images or icons 4906 (e.g. 4821-4828); in responsive to receiving the single user interaction or identification of haptic contact engagement on pre-defined area of particular visual media capture controller control (e.g. 4822) including haptic contact engagement on pre-defined area 4907=Yes e.g. right side (4829) to select front camera mode (if current camera mode is back camera mode then change to front camera mode 4924) or haptic contact engagement on pre-defined area 4909=Yes e.g. left side (4831) to select back camera mode (if current camera mode is front camera mode then change to back camera mode 4928) OR in response to not changing of front camera to back camera or back camera to front camera or keep current mode as it 4907—No or 4909—No, receiving haptic contact engagement or persist 4931 on left side 4831 to take visual media in back camera mode or on right side 4829 to take visual media in front camera mode of particular visual media capture controller control e.g. 4822 from set of presented visual media capture controller controls or icons or labels 4830 (4821-4828); after haptic contact engagement or left side area or right side area and maintaining of haptic contact persistent on left side (e.g. 4831) or right side (e.g. 4829) area of visual media capture controller control (e.g. 4822) or after not changing mode and receiving of direct haptic contact engagement on left side e.g. 4831 or right side e.g. 4829 of particular visual media capture controller control (e.g. 4822), start recording of video and start timer 4932; receive haptic contact release 4935; if threshold not exceeded (e.g. less than 2 or 3 seconds) 5025—No then stop video and stop timer 5027; select or extract one or more frames or images 5029 from recorded video or series of images and store photo 5031; optionally invoke photo preview mode 5033 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4822 or selected visual media capture controller control or label associated contact e.g. 4822, and send the captured photo to the identified contact 5052 or in other embodiment send to user selected contact; If threshold exceeded (e.g. more than 2 or 3 seconds) 5025—Yes then in the event of pre-set duration of video timer expires (5035—Yes) then store video 5045; optionally invoke video preview mode 5048 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4822, and send the recorded video to the identified contact 5052 or in other embodiment send to selected contact. If threshold exceeded (e.g. more than 2 or 3 seconds) 5025—Yes and pre-set duration of video timer not expires (5035—No) and in the event of receiving of haptic contact engagement (5040—Yes) then stop video & store video 5042; optionally invoke video preview mode 5044 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4822, and send the recorded video to the identified contact 5052 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

FIG. 50 illustrates various embodiments of FIG. 49. In another embodiment FIG. 48 (A) and FIG. 49 with FIG. 50 (E) illustrates, an electronic device 200, comprising: digital image sensors 244 to capture visual media e.g. 4820; a display 210 to present the visual media e.g. 4820 from the digital image sensors 244; a touch controller 215 to identify haptic contact engagement, haptic contact persistence and haptic contact release on the display 210; present a user interface or tray 4830 on the display 210 to a user of a client device 200, the user interface 4830 comprising visual media capture controller controls or labels and/or images or icons 4906 (e.g. 4821-4828) includes a plurality of contact icons or labels e.g. 4821-4828, each contact icon or label representing one or more contacts of the user; receive a single user interaction with a selected contact icon of the plurality of contact icons included in the user interface or tray 4830; a multi-tasking pre-configured or auto generated or auto presented visual media capture controller controls or labels and/or images or icons 4906 (e.g. 4821-4828); in responsive to receiving the single user interaction or identification of haptic contact engagement on pre-defined area of particular visual media capture controller control (e.g. 4822) including haptic contact engagement on pre-defined area 4907=Yes e.g. right side (4829) to select front camera mode (if current camera mode is back camera mode then change to front camera mode 4924) or haptic contact engagement on pre-defined area 4909=Yes e.g. left side (4831) to select back camera mode (if current camera mode is front camera mode then change to back camera mode 4928) OR in response to not changing of front camera to back camera or back camera to front camera or keep current mode as it 4907—No or 4909—No, receiving haptic contact engagement or persist 4931 on left side 4831 to take visual media in back camera mode or on right side 4829 to take visual media in front camera mode of particular visual media capture controller control e.g. 4822 from set of presented visual media capture controller controls or icons or labels 4830 (4821-4828); after haptic contact engagement or left side area or right side area and maintaining of haptic contact persistent on left side (e.g. 4831) or right side (e.g. 4829) area of visual media capture controller control (e.g. 4822) or after not changing mode and receiving of direct haptic contact engagement on left side e.g. 4831 or right side e.g. 4829 of particular visual media capture controller control (e.g. 4822), start recording of video and start timer 4932; receive haptic contact release 4935; if threshold not exceeded (e.g. less than 2 or 3 seconds) 5075—No then stop video and stop timer 5077; select or extract one or more frames or images 5079 from recorded video or series of images and store photo 5081; optionally invoke photo preview mode 5083 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4822 or selected visual media capture controller control or label associated contact e.g. 4822, and send the captured photo to the identified contact 5099 or in other embodiment send to user selected contact; If threshold exceeded (e.g. more than 2 or 3 seconds) 5075—Yes then in the event of pre-set duration of video timer expires (5085—Yes) then store video 5095; optionally invoke video preview mode 5098 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4822, and send the recorded video to the identified contact 5099 or in other embodiment send to selected contact. If threshold exceeded (e.g. more than 2 or 3 seconds) 5075—Yes and pre-set duration of video timer not expires (5085—No) and in the event of receiving of haptic contact engagement (5090—Yes) then stop maximum or pre-set duration of video timer 4291 (for enabling user to stop video manually); in the event of identification of further haptic contact engagement & release or disengagement 4292 stop video & store video 5093; optionally invoke video preview mode 5094 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4822, and send the recorded video to the identified contact 5099 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

In an another embodiment after starting of video, user is enable to (1) while haptic contact persist e.g. 4831 (to take video up-to haptic release) swipe left side e.g. 4831 or swipe right side 4829 on particular visual media capture controller e.g. 4822 (2) haptic engagement and swipe left e.g. 4831 or swipe right e.g. 4829 on particular visual media capture controller e.g. 4822 (3) directly haptic contact engagement on left side or right side area or icon or anywhere area of particular visual media capture controller e.g. 4822 for capturing photo simultaneously while recording of video and after ending of video via (1) haptic release 4935 (49A), (2) Max. timer expired 5015—Yes (49B), (3) further haptic contact engagement 5065—Yes (49C) then photo or video preview mode invoke for pre-set duration and in the event of expiration of said pre-set preview of preview auto send said recorded video as well as one or more captured photo(s) while recording of video to said particular or accessed or selected visual media capture controller control or icon or label e.g. 4822 associated one or more contacts or groups or one or more types of one or more destinations (e.g. send to contact [Yogesh]). While capturing photo(s) during recording of video, system identifies or saves or mark time(s) in video and extract or takes or select said marked time(s) associated frame(s) or screenshot(s) or image(s) inside video or in another embodiment simultaneously recording video and capturing photo(s) while recording of video.

In another embodiment FIG. 48 (A) and FIG. 49 illustrates, an electronic device 200 for taking a still picture while recording a moving picture including video, the electronic device 200, comprising: digital image sensors 244 to capture visual media e.g. 4820; a display 210 to present the visual media e.g. 4820 from the digital image sensors 244; a touch controller 215 to identify haptic contact engagement, haptic contact persistence and haptic contact release on the display 210; present a user interface or tray 4830 on the display 210 to a user of a client device 200, the user interface 4830 comprising visual media capture controller controls or labels and/or images or icons 4906 (e.g. 4821-4828) includes a plurality of contact icons or labels e.g. 4821-4828, each contact icon or label representing one or more contacts of the user; receive a single user interaction with a selected contact icon of the plurality of contact icons included in the user interface or tray 4830; a multi-tasking pre-configured default or user selected or auto generated or auto presented visual media capture controller controls or labels and/or images or icons 4906 (e.g. 4821-4828) to enable to capture photo while recording front camera or back camera video based on a user input instruction to take the still picture while recording the moving picture; in responsive to receiving the single user interaction or identification of haptic contact engagement on pre-defined area of particular visual media capture controller control (e.g. 4822) including haptic contact engagement on pre-defined area 4907=Yes e.g. right side (4829) to select front camera mode (if current camera mode is back camera mode then change to front camera mode 4924) or haptic contact engagement on pre-defined area 4909=Yes e.g. left side (4831) to select back camera mode (if current camera mode is front camera mode then change to back camera mode 4928) OR in response to not changing of front camera to back camera or back camera to front camera or keep current mode as it 4907—No or 4909—No, receiving haptic contact engagement or persist 4931 on left side 4831 to take visual media in back camera mode or on right side 4829 to take visual media in front camera mode of particular visual media capture controller control e.g. 4822 from set of presented visual media capture controller controls or icons or labels 4830 (4821-4828); after haptic contact engagement or left side area or right side area and maintaining of haptic contact persistent on left side (e.g. 4831) or right side (e.g. 4829) area of visual media capture controller control (e.g. 4822) or after not changing mode and receiving of direct haptic contact engagement on left side e.g. 4831 or right side e.g. 4829 of particular visual media capture controller control (e.g. 4822), start recording of video and start timer 4932; in response of threshold exceeded (4944—Yes) for start recording video user is enable to (1) while haptic contact persist e.g. 4831 (to take video up-to haptic release) swipe left side e.g. 4831 or swipe right side 4829 on particular visual media capture controller e.g. 4822 (2) haptic engagement and swipe left e.g. 4831 or swipe right e.g. 4829 on particular visual media capture controller e.g. 4822 (3) directly haptic contact engagement on left side or right side area or icon or anywhere area of particular visual media capture controller e.g. 4822 for capturing photo simultaneously while recording of video and after ending of video via (1) haptic release 4935 (49A), (2) Max. timer expired 5015—Yes (49B), (3) further haptic contact engagement 5065—Yes (49C) then sequences of photo(s) or video preview mode invoke for pre-set interval of duration and in the event of expiration of said pre-set preview timer present next photo or video and after expiry of last presented visual media associated preview timer, auto send said recorded video as well as one or more captured photo(s) to said particular or accessed or selected visual media capture controller control or icon or label e.g. 4822 associated one or more contacts or groups or one or more types of one or more destinations (e.g. send to contact [Yogesh]). While capturing photo(s) during recording of video, system identifies or saves or mark time(s) in video and extract or takes or select said marked time(s) associated frame(s) or screenshot(s) or image(s) inside video or in another embodiment simultaneously recording video and capturing of particular pre-set resolution photo(s) while recording of video. So snapping photos while recording video is possible and it will provide the ability to take a still photo while shooting video and user can take picture(s) during a single recording session as many times as user like in order to take multiple stills. In an embodiment the device, in a case where the picture being recorded has the same size as the previously set size of the still picture, the controller generates a control signal for instructing the camera picture capturing unit to capture the still picture and memorize a position where the captured picture is recorded as a recorded picture in the moving picture recorder, wherein information on the memorized position of the recorded picture is used to search the moving picture recorder for a corresponding picture, and then the corresponding picture is decoded and displayed so that, after recording is finished, a user can view the still picture and determine whether to store the still picture. In an embodiment the device, the controller reads and transmits the captured picture from the memory to the image signal processor, and the image signal processor adjusts the captured picture to have a size of the moving recorded picture and transmits the adjusted captured picture to the moving picture recorder.

In an another embodiment after changing to front camera mode 4924 or back camera mode 4928 and while maintaining of haptic contact persist on left or right side icon or pre-defined area of visual media capture controller control or label and/or icon e.g. 4822 and after starting of recording of video 4932 but before releasing of haptic contact 4835, in the event of further receiving of particular type of pre-defined haptic contact engagement at predefined area or swipe including swipe from left to right or right to left then cancel capturing of photo or recording of video 4932 i.e. stop recording of video, stop timer or reset or initiate timer and remove recorded video at 4932 and based on swipe type or haptic contact engagement at pre-defined area further start from 4907 or 4909 or 4924 or 4928. In an another embodiment after changing to front camera mode 4924 or back camera mode 4928 and while maintaining of haptic contact persist on left or right side icon or pre-defined area of visual media capture controller control or label and/or icon e.g. 4822, provide pre-set period of time (e.g. 1-2 seconds—in an embodiment show indication, in the form of icon or text or number of animation or visually, of wait timer on display 210) before starting recording of video and starting of timer 4932 for enabling user to change mode or properly view scene via camera display screen or camera view to take visual media.

In another embodiment after changing front camera 4928 or left camera mode 4928, then in the event of haptic release from visual media capture controller e.g. 4822, user can haptic engagement or tap on left side icon or left side pre-defined area to capture photo or user can haptic engagement or tap on right side icon or right side pre-defined area to record video and stop video in the event of (1) expiration of pre-set duration of timer, (2) manually tap by user on video icon or further haptic contact engagement on pre-defined area of visual media capture controller control e.g. 4822, (3) one or more type of user sense via one or more types of sensor(s) and (4) hold to start recording of video and release to stop video.

In another embodiment enable user to tap pre-defined left side 4831 or right side 4829 or haptic contact engagement on pre-defined area of visual media capture controller control 4822 at step 5040 to stop video and store video 5042 and enable user to tap pre-defined left side 4831 or right side 4829 or haptic contact engagement on pre-defined area of visual media capture controller control 4822 at step 5090 to stop timer 4291 for enabling user to stop before expiration of maximum pre-defined or pre-set duration of video i.e. stop recording of video before auto stop after pre-set duration of time of video or enabling user to prevent auto stop after expiration of pre-set duration of video, so user can take more than pre-set duration of video and stop video manually.

In another embodiment after capturing photo and invoking photo preview mode or after recording video and invoking video preview mode, during pre-set duration of preview time user can tap on left or right side or enabled cross icon to cancel & remove photo or video and stop sending to destination(s) or contact(s) or user can tap on left or right side or enabled edit icon on visual media capture controller e.g. 4822 to edit or augment including select overlays, write text, use photo filters on recorded visual media.

In another embodiment after starting of video user can swipe left or right to stop video or haptic contact engagement on pre-defined area e.g. left side or right side of visual media capture controller control. In another embodiment haptic contact engagement on left side pre-defined area or swipe left for photo or haptic contact engagement on right side pre-defined area or swipe right for video and in the event of not exceeding threshold use default or currently available or at present viewed or front or back camera and in the event of exceeding threshold change default or currently enabled mode e.g. if current mode is front camera mode then change to back camera mode and if current mode is back camera mode then change to front camera mode.

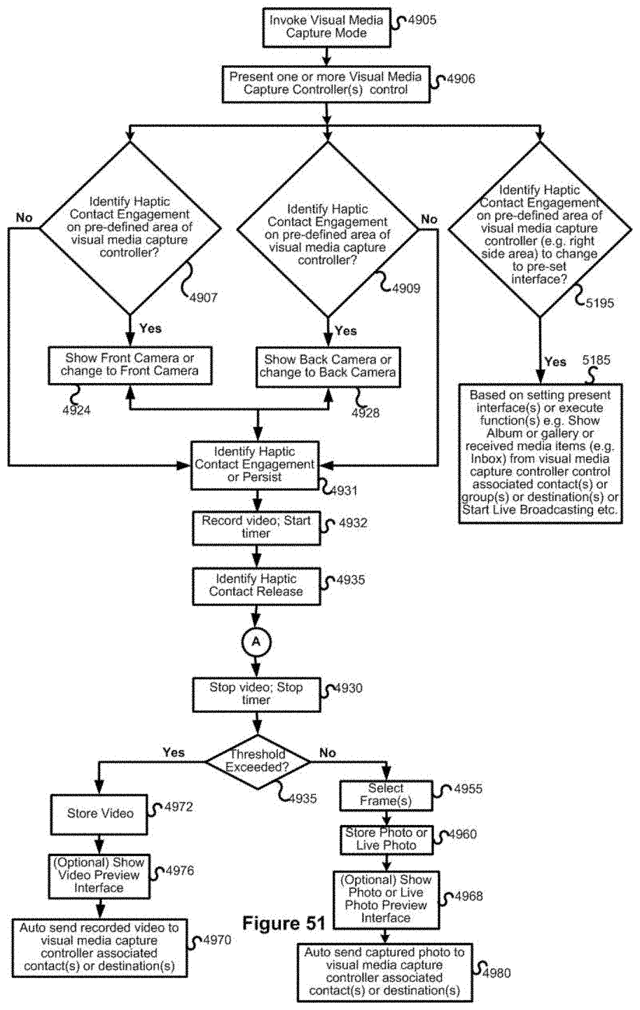

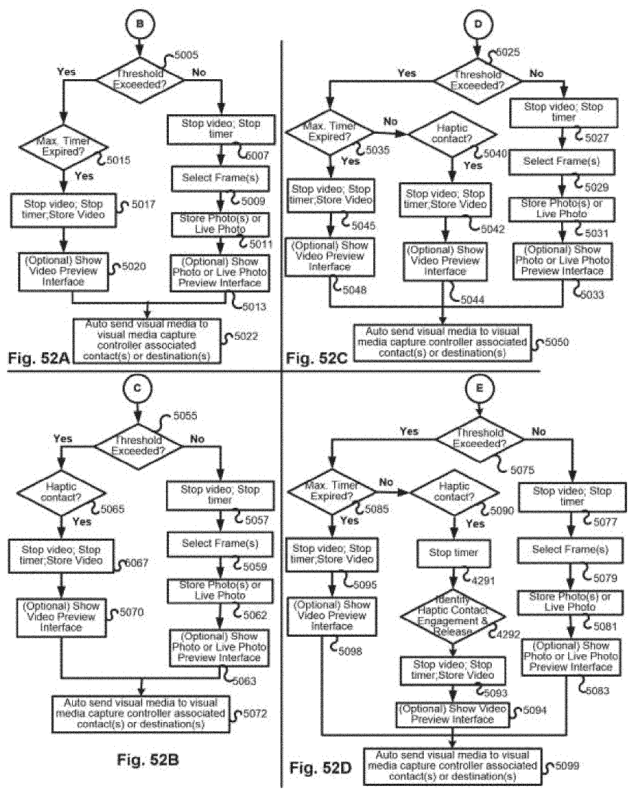

In another embodiment FIGS. 51 and 52 are slight variation of FIGS. 49 and 50, additional component is 3^{rd} or more customized button(s) 5195 in multi-tasking visual media capture control explains in 5195 and 5185 and FIG. 48 (B) which adds additional pre-defined area or button 4854 and enable user to customized said 3^{rd} button or pre-defined area e.g. 4854. In the event of identification of haptic contact engagement on pre-defined area (e.g. end side of visual media capture controller control or label and/or icon) to change to pre-set interface. Based on settings, present said pre-set interface(s) or execute function(s) e.g. show album or gallery or received media items (e.g. Inbox) from visual media capture controller control associated contact(s) or group(s) or destination(s) or start live broadcasting etc.

In another embodiment FIGS. 51 with 48(B) illustrates, an electronic device 200, comprising: digital image sensors 244 to capture visual media e.g. 4820; a display 210 to present the visual media e.g. 4840 from the digital image sensors 244; a touch controller 215 to identify haptic contact engagement, haptic contact persistence and haptic contact release on the display 210; present a user interface or tray 4855 on the display 210 to a user of a client device 200, the user interface 4855 comprising visual media capture controller controls or labels and/or images or icons 5106 (e.g. 4841-4848) includes a plurality of contact icons or labels e.g. 4841-4848, each contact icon or label representing one or more contacts of the user; receive a single user interaction with a selected contact icon of the plurality of contact icons included in the user interface or tray 4855; a multi-tasking pre-configured or auto generated or auto presented visual media capture controller controls or labels and/or images or icons 5106 (e.g. 4841-4848); in responsive to receiving the single user interaction or identification of haptic contact engagement on pre-defined area of particular visual media capture controller control (e.g. 4822) including haptic contact engagement on pre-defined area 4907=Yes e.g. right side (4829) to select front camera mode (if current camera mode is back camera mode then change to front camera mode 4924) or haptic contact engagement on pre-defined area 4909=Yes e.g. left side (4831) to select back camera mode (if current camera mode is front camera mode then change to back camera mode 4928) and swipe to end or 3^{rd} button or pre-defined area 4854 to access, execute, open, invoke or present one or more types of pre-configured or pre-set one or more interfaces, applications, features (e.g. show all or received new media items from said visual media capture controller associate contact or show inbox 4815), media items, functions (e.g. start broadcasting) OR in response to not changing of front camera to back camera or back camera to front camera or haptic contact engagement on 3^{rd} button or keep current mode as it 4907—No or 4909—No, receiving haptic contact engagement or persist 4931 on left side 4831 to take visual media in back camera mode or on right side 4829 to take visual media in front camera mode of particular visual media capture controller control e.g. 4822 from set of presented visual media capture controller controls or icons or labels 4830 (4821-4828); after haptic contact engagement or left side area or right side area and maintaining of haptic contact persistent on left side (e.g. 4831) or right side (e.g. 4829) area of visual media capture controller control (e.g. 4822) or after not changing mode and receiving of direct haptic contact engagement on left side e.g. 4831 or right side e.g. 4829 of particular visual media capture controller control (e.g. 4822), start recording of video and start timer 5132; in response to identification or receiving of haptic contact release 5135 stop video and stop timer and if threshold not exceeded (e.g. less than 2 or 3 seconds) 5144—No then select or extract one or more frames or images 5155 from recorded video or series of images 5140 and store photo 5160; optionally invoke photo preview mode 5168 for pre-set duration of time (for optionally enabling user to review photo, remove photo, edit or augment photo and change destination(s) for sending) and in the event of expiry of said pre-set duration of preview timer, hide or close photo preview interface and identify the contact represented by the selected contact icon e.g. 4841 or selected visual media capture controller control or label associated contact e.g. 4841, and send the captured photo to the identified contact 5170 or in other embodiment send to user selected contact; If threshold exceeded (e.g. more than 2 or 3 seconds) 5144—Yes then store video 5150; optionally invoke video preview mode 5158 for pre-set duration of time (for optionally enabling user to review video, delete video, edit or augment video and change destination(s) for sending) and in the event of expiry of said pre-set duration of preview timer, hide or close video preview interface and identify the contact represented by the selected contact icon or selected visual media capture controller control or label associated contact e.g. 4841, and send the recorded video to the identified contact 5180 or in other embodiment send to selected contact. In another embodiment enable user to execute or provide or instruct cancel command from particular visual media controller control to cancel the capturing or recording of from or back camera photo or video via one or more type of haptic contact including swipe up or via one or more types of pre-defined user sense via one or more types of one or more sensors of user device(s) including voice command or particular type of eye movement.

FIG. 51 is similar to FIG. 49 and details of FIG. 51 are same as discussed in FIG. 49, only addition is 3^{rd} button or 3^{rd} pre-defined area (e.g. 4854) 5195 and 5185 (as describe above). FIG. 52 is similar to FIG. 50 and details of FIG. 52 are same as discussed in FIG. 50.

In another embodiment after selecting back camera mode and after staring of back camera video user can haptic contact engagement on 3^{rd} button or pre-defined area 4854 and can able to start front camera selfie video 4849 to provide commentary on recording of video 4840 via back camera. For example user is recording natural scenery video 4840 at particular tourist place and can also enable to concurrently record front camera video to provide video comments or reviews or description or commentary on said currently recording of video via back camera related to current scene view by recorder.

In another embodiment after selecting back camera mode and after staring of back camera video user can haptic contact engagement on 3^{rd} button or pre-defined area 4854 and can able to start capturing of one or more front camera selfie photo(s) 4849 via tapping at/on or swiping to particular pre-defined area of visual media capture controller label e.g. 4841 to provide user's expressions during recording of video 4840 via back camera. For example user is recording natural scenery video 4840 at particular tourist place and can also enable to concurrently capture one or more photo(s) via tapping on 4841 to provide user's face expressions on said currently recording of video via back camera related to current scene view by recorder.

In another embodiment FIG. 4809 illustrates single multi-tasking visual media capture controller with 2 buttons or 2 pre-defined area as discussed above, difference is it is not associated with contact, it enables to switch from front camera 4802 to back camera 4801 or from back camera 4805 to front camera 4808 via haptic contact engagement on pre-defined area and capture photo or record video based on duration of haptic contact persist and engagement as discussed above. Instead of auto sending to visual media capture controller associate contact, user have to manually select one or more contact(s) and/or destinations or auto send to pre-set one or more types of contact(s)/group(s) and/or destination(s) associate with said single visual media capture controller. It's an alternative to currently presented front or back camera mode button or icon, photo capture icon and video record icon of standard smartphone camera application or interface. User doesn't have to first change mode by tapping on camera mode change icon, then tap on photo icon to load photo capture interface and capture photo or tap on video icon to load video mode and start recording of video and then tap on stop icon to stop video. Instead user can haptic contact engagement on pre-defined area e.g. left side to change mode to back camera or haptic contact engagement on pre-defined area e.g. right to change mode to front camera and based on duration of haptic contact engagement and persist on single mode multi-tasking visual media capture controller control or label and/or icon user can take photo or start recording of video and in an embodiment further tap to stop & store video or in an embodiment auto stop after pre-set duration of time and auto store (or tap before expiry of said pre-set max. duration of video to stop and store video) or in an embodiment in the event of haptic release from said single mode multi-tasking visual media capture controller control or label and/or icon stop and store video.

In another embodiment FIG. 4892 illustrates single multi-tasking visual media capture controller control with 3 buttons or 3 pre-defined area as discussed above, difference is it is not associated with contact, it enables to switch from front camera 4890 to back camera 4893 or from back camera 4893 to front camera 4890 via haptic contact engagement on pre-defined area and capture photo or record video based on duration of haptic contact persist and engagement as discussed above and also provide 3^{rd} button or predefined area on single multi-tasking visual media capture controller control 4892 and enable to configure or associate one or more applications, features, interfaces, functions and in the event of haptic contact engagement on pre-defined area on 3^{rd} button or 3^{rd} end side pre-defined area, present said associated or pre-set or pre-configured one or more applications, features, interfaces, or execute functions. Instead of auto sending to visual media capture controller associate contact, user have to manually select one or more contact(s) and/or destinations or auto send to pre-set one or more types of contact(s)/group(s) and/or destination(s) associate with said single visual media capture controller. It's an alternative to currently presented front or back camera mode button or icon, photo capture icon and video record icon of standard smartphone camera application or interface. User doesn't have to first change mode by tapping on camera mode change icon, then tap on photo icon to load photo capture interface and capture photo or tap on video icon to load video mode and start recording of video and then tap on stop icon to stop video and. Instead user can haptic contact engagement on pre-defined area on left side to change mode to back camera or haptic contact engagement on pre-defined area on right side to change mode to front camera and based on duration of haptic contact engagement and persist on single mode multi-tasking visual media capture controller control or label and/or icon user can take photo or start recording of video and in an embodiment further tap to stop & store video or in an embodiment auto stop after pre-set duration of time and auto store (or tap before expiry of said pre-set max. duration of video to stop and store video) or in an embodiment in the event of haptic release from said single mode multi-tasking visual media capture controller control or label and/or icon stop and store video. User can haptic contact engagement on pre-defined area e.g. on 3^{rd} button or end side of said single mode multi-tasking visual media capture controller control or label and/or icon to view or access said presented pre-set or pre-configured one or more applications, interfaces, features and/or execute functions.

In an embodiment multi-tasking visual media capture controller (“MVMCC”) discussed in FIGS. 43 to 52 or anywhere else in specification (e.g. 4830 or 4822), in an embodiment user can create or add one or more contact(s) or connection(s) or group(s) specific MVMCCs via auto or manually importing phone book contacts, import from device storage, one or more contacts, connections or social connections from one or more 3^{rd} parties applications, web sites, servers, databases, devices, networks, user accounts, user profiles, followers via providing login information, web services, APIs and SDKs and one or more types of destinations including sharing or posting or publishing or storing destinations including one or more applications, web sites, web pages, interfaces, servers, databases, devices, and networks. Based on contacts and/or connections and/or destinations or creating of named group(s) of contacts and/or connections and/or destinations, system 261 auto creates contact name specific or group name specific MVMCC labels and/or images (e.g. auto import profile picture of contact) or icons and present at user device 200 display 210 (e.g. 4330) for enabling user to capture or record front or back camera photo or video and send said visual media to said MVMCC control or label and/or image or icon associated or added contact(s) and/or group(s) and/or destination(s). In an embodiment user can edit or update MVMCC label name or change icon or image (contact's profile picture). In an embodiment user is enabled to add or remove contacts to existing MVMCC control or label and/or image or icon for sending visual media to added contacts and/or users and/or one or more types of destinations. In an embodiment user is enabled to create news, remove existing or edit existing one or more MVMCC label name or change icon or image. For example user can create MVMCC labels including individual phone book contact, create named one or more groups of contacts or connections, add one or more types of destinations e.g. Facebook™, Instagram™, Twitter™ and by one tap on said created and present MVMCC label, user can capture or record front or back camera photo or video, preview for pre-set duration (to review visual media, remove and change destination) and send said visual media to said MVMCC control or label and/or image or icon associated one or more or all contact(s) and/or save locally and/or album or gallery or event or folder and/or group(s) and/or followers and/or one or more types of one or more destination(s) including 3^{rd} parties web sites (e.g. social networks, search engine, image sites, news sites), web pages, applications, storage mediums, devices, networks, and web services via integrating, plugging, using and accessing their one or more application programming language (APIs), controls (button etc.), web services and software development toolkit (SDKs). In an embodiment user can invite one or more users and in the event of invitation acceptance auto add invitation accepted user's MVMCC label and/or image or enable user to add said contact to one or more group(s). In an embodiment user is enabled to search user by user name, phone number, e-mail address, social network user name or via one or more types of unique identity to identify user and add to MVMCC label and/or image. In an embodiment user is enabled to mute showing of user related MVMCC label on other users' devices who added user in their contacts or MVMCC label. In an embodiment user is enabled to block adding to user by other one or more users of network. In an embodiment user is enabled to apply do not disturb policy including allow only selected one or more contacts to add user or show user related MVMCC label on their devices, allow one or more selected or other users to view user related MVMCC label based on schedules of user, show user related MVMCC label on one or more selected or all other contact users' devices when user is online and hide when user is offline, show user related MVMCC label on user's contacts' devices when user sets ON or hide when user sets OFF via settings.

In an embodiment multi-tasking visual media capture controller (“MVMCC”) discussed in FIGS. 43 to 52 or anywhere else in specification (e.g. 4830 or 4822), can auto presented or auto show, auto created, auto arranged, auto ranked, auto hide or remove in plurality of ways including in an embodiment as discussed in FIG. 3 (323), after auto open or unlock device and auto open camera display screen, then auto present user created, auto created and dynamically auto presented MVMCC controls or labels and/or images 261 (e.g. 4330). In an another embodiment based on object recognition, face recognition, code recognition, Optical Character Recognition (OCR) and voice recognition and monitored user device's or connected users devices' current location, system 261 identifies and auto present one or more types of contacts and/or groups and/or destinations specific one or more or set of MVMCC controls or labels and/or images from local user storage of user device (i.e. created by user) via client application 261 or from server via server module 191 (e.g. advertisers, created by server admin) on user device's 200 display 210, when user scans or scans one or more types of objects including shop name, logo, image, view scene or one or more types of code including QRcode or talking about some nearest brand or instructing voice command to present named one or more MVMCC controls or labels and/or images, so user is enable to one tap on preferred MVMCC control or label and/or image to capture or record front or back camera photo or video and send to said auto presented and selected or tapped MVMCC control or label and/or image associate destination(s) including post or share or broadcast or send to particular web site, web page, application, feed, folder, database, gallery, album, event or advertiser's server, web site, application, web page or database. For example when user scan or view via camera display screen scene which includes “flower” object then user is presented with identified flower specific MVMCC control or label and/or image, so user can one tap on said flower named MVMCC control or label and/or image and capture or record photo or video and sent to said flower named MVMCC control or label and/or image associate destination e.g. Flower gallery or collection of flower photos. In an another example when user scans or view via camera display screen particular GUCCI™ bag then user is presented with identified object or brand GUCCI™ specific “GUCCI”™ named MVMCC control or label and/or image on user display 210 of user device 200 and enabling user to one tap capture photo or video and e.g. share said captured or recorded photo or video to user's contacts and e.g. gets some offers or benefits (e.g. discount, redeemable points, voucher, gift etc.) from advertiser GUCCI™ brand.

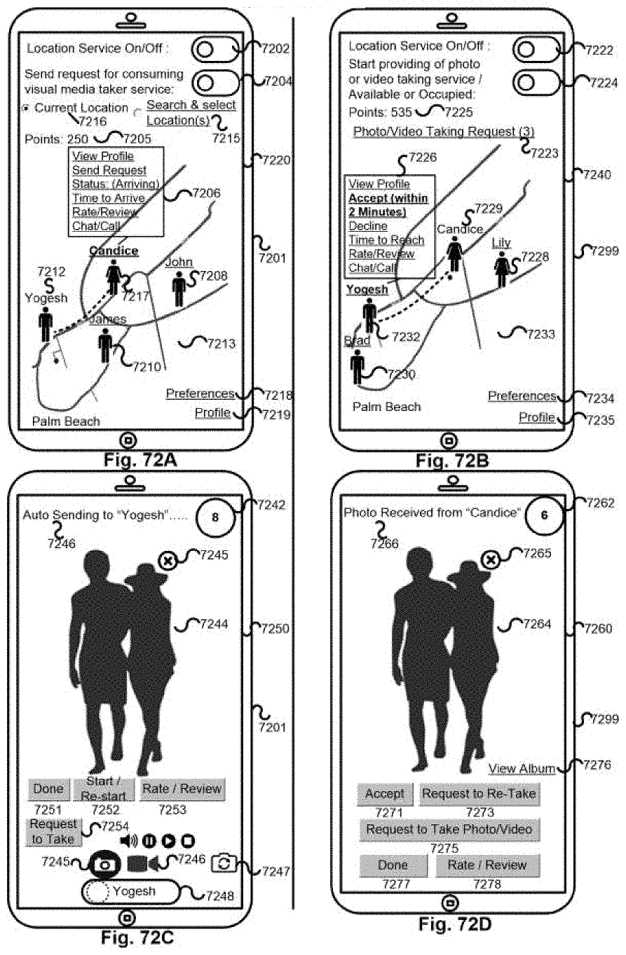

In an embodiment as discussed in FIG. 72 (c) auto present visual media photography service consumer user's label 7248 on visual media photography service provider's device 7201 by server module 191 of server 110 in the event of accepting of request and/or reaching at particular POI for taking requestor's visual media. In an another embodiment in the event of acceptance of one or more requests, server module 191 of server 110 shows each accepted requestor related named MVMCC control or label and/or image by on service providers device.

In another embodiment presents label(s) based on voice command provided by user. For example based on voice “Kristine”, show “Kristine” named MVMCC control or label and/or image on display 210 of user device 200 by client application 161 and/or server module 191 of server 110 for enabling user to one tap capture or record front or back camera photo or video and/or preview for pre-set duration for enabling to review or remove or change destination and in the event of expiry of pre-set preview duration remove preview interface and auto sent said visual media to “Kristine”.

In another embodiment based on monitored user device's location, identify current user place and based on identification of user's pre-set duration of stay on said place, server module 191 of server 110 auto presents said place related named MVMCC control or label and/or image on display 210 of user device 200 and in the event of away from said place or enter into other place and stays for pre-set duration, server module 191 of server 110 hides previously presented label and present newly entered place specific named MVMCC control or label and/or image on display 210 of user device 200 for enabling user to one-tap take visual media and auto sent to one or more contacts and/or groups and//or destinations pre-set or pre-configured to said tapped MVMCC control or label and/or image.

In another embodiment present e.g. “Real-time” named MVMCC control or label and/or image on user device 200 display 210 via client application 161 and/or server module 191 of server 110 to one-tap capture and send visual media with intention to real-time view and receive real-time one or more types of reactions including likes, dislikes, comments, emoticons as discuss in FIGS. 7, 8, 20-24, 28 & 29.

In another embodiment present e.g. “Ephemeral” named MVMCC control or label and/or image on user device 200 display 210 via client application 161 and/or server module 191 of server 110 to one-tap capture and send visual media as ephemeral message with intention to recipient view shared visual media or ephemeral message for pre-set view duration or display duration only and remove after expiry of said pre-set duration timer which starts when user starts viewing or when user is presented with said visual media or ephemeral message or view unlimited times within pre-set life duration or view pre-set numbers of times within pre-set life duration and remove after expiry of life timer (starts from when user received) or viewing of pre-set numbers of times as discuss in FIGS. 7, 8, 19-24, 28-39, 43 (C), 48 (C), 56 (A) & (B), 58, 63 (6350), 73-75.

In another embodiment present request sender's named MVMCC control or label and/or image on display 210 of user device 200 via server module 191 of server 110. In another embodiment present request accepted user's named MVMCC control or label and/or image on display 210 of user device 200 via server module 191 of server 110.

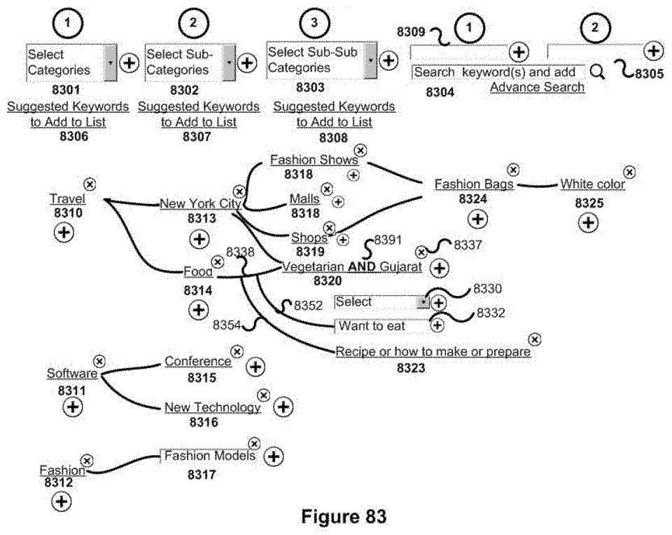

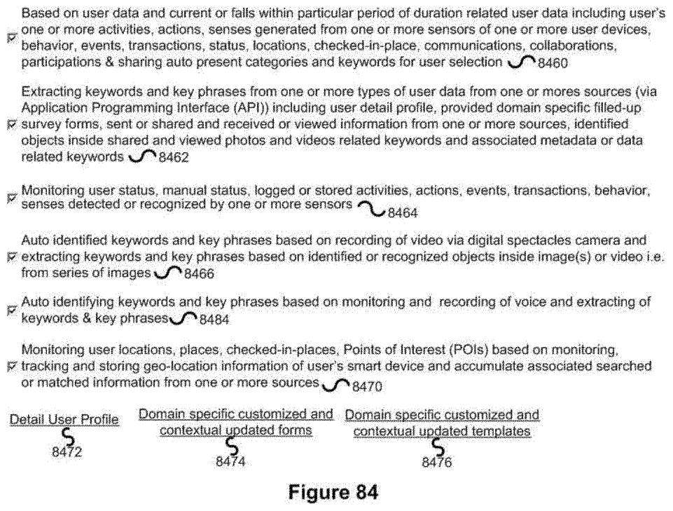

In another embodiment server module 191 of server 110, presents suggested one or more MVMCC controls or labels and/or images on display 210 of user device user 200 based on one or more types of user data and one or more types of currently update user data including one or more types of activities, actions, events, transactions, current location or place or checked-in place of user and connected users of user, updated one or more types of status (discussed throughout the specification), current place or location and current date & time specific associated events and schedules, and one or more types of profile or associated fields related one or more types of values (e.g. age, gender, interests, hobbies, preferences, privacy settings, other settings, education, qualification, skill types, interacted or related entities including school, college, company etc.) and identified and currently added one or more keywords or user related collection of keywords (as discussed in detail in FIGS. 83-99) specific suggested one or more MVMCC controls or labels and/or images and any combination thereof. In an embodiment change MVMCC controls or labels and/or images as per live event data (e.g. sports score) or update in user status or place.

In an embodiment enabling advertiser to create one or more MVMCC controls or labels and/or images, provide associate one or more types of destination(s) including web site, web page, application, capturer user's contacts, capturer user's profile page, album, gallery, folder, server, database, and device (when user captures visual media via said MVMCC label then captured visual media sent to said provided one or more types of destination(s)), provide associate one or more types of offers including redeemable points, discount, gift, sample, invitation, ticket, voucher, coupon etc. (when user captures visual media via said MVMCC label then captured visual media sent to said provided one or more types of destination(s) and user gets one or more said benefits), set target criteria including current location as target location, one or more selected includes or excludes locations, pre-defined one or more types of locations, places (configuring based on structured query language (SQL), natural query and wizard interface), target users profile (e.g. one or more selected fields related one or more types of values and Boolean operator(s) e.g. provide or selects age range, gender type, language, education or skill type, type and name of entity(ies) related users, income range, user rating, home location, work location, interest type, preference type, device types, included or excluded IP addresses, one or more keywords (found in target user's one or more types of data) etc.), object criteria including provide object model, publishing or presentation schedules of said created one or more MVMCC controls or labels and/or images at target user's devices. After providing target criteria advertiser can post or save details to server module 191 of server 110 for verification and validation. In the event of acceptance of said created one or more MVMCC controls or labels and/or images, server module 191 of server 110, in the event of identification of said target criteria specific users or user devices, present matched or contextual one or more MVMCC controls or labels and/or images on display 210 of user device 200.

In an another embodiment based on matching monitored user device's current location with monitored connected users of user device's current location and current date & time, server module 191 of server 110 identifies user accompanied contacts and presents said contacts specific one or more MVMCC controls or labels and/or images on display 210 of user device 200 for enabling each other to capture visual media and share with each other.

In an another embodiment enabling user to search, select, sort, filter, show, hide, add, remove, provide rating, manually arrange, drag and drop to arrange or auto arrange (based on frequency of use, rank provided by user, relationship type, provide or receive number and/or types of reactions, do not policy of user and contact users, currently used etc.) MVMCC controls or labels and/or images (e.g. 4330) on display 210 of user device 200

In an another embodiment configure 3^{rd} button (e.g. 4374) to enabling user to capture visual media and/or retrieve and share captured, recorded, selected or camera display screen related viewed scene(s) and/or object(s) and/or code(s) and/or voice related one or more types of recognized or identified contents or information from one or more sources based on object recognition technologies (which identifies object(s) related keywords and server module 191 searches, matches said identified keywords specific information from one or more sources including one or more web sites (search engines, social networks), applications, user accounts, user generated or provided contents, servers, databases, devices, networks, advertisers, 3^{rd} parties providers etc.) by/via server module 191 of server 110 by tapping on e.g. 3^{rd} button of MVMCC control or label and/or image (e.g. 4374). For example when user scans or views “ ” via camera display screen or via one or more types of wearable device(s) e.g. eye glasses then, server module 191 recognizes said viewed or scanned or captured image(s) and/or photo(s) and/or video(s) and/or voice(s) and/or code including QRcode and identifies recognized, related, matched and contextual keyword(s) and searches and matches one or more types of contents including web links, blogs, articles, news, tweets, user posted contents like visual media and sends to one or more pre-set contacts and/or groups and/or destinations.

In an another embodiment user can configure 3^{rd} or subsequent button or pre-defined area and associate one or more interfaces, features, functions, applications, set of controls and one or more types of media presentation.

In an another embodiment enabling user to view MVMCC control or label and/or image associate contact provided reactions on shared visual media in the form of popups coming out from MVMCC control or label and/or image in animated likes, dislikes or emoticons form provided by one or more recipient(s).

In an another embodiment enabling admin user to create publishable group(s) and add one or more contacts and create MVMCC control or label and/or image which publishes or presented to said added members' devices 200 on display 210. In an another embodiment enabling members to remove or use said presented group named MVMCC control or label and/or image for one tap capturing and sharing visual media with said MVMCC control or label and/or image associate added contacts or members by admin user.

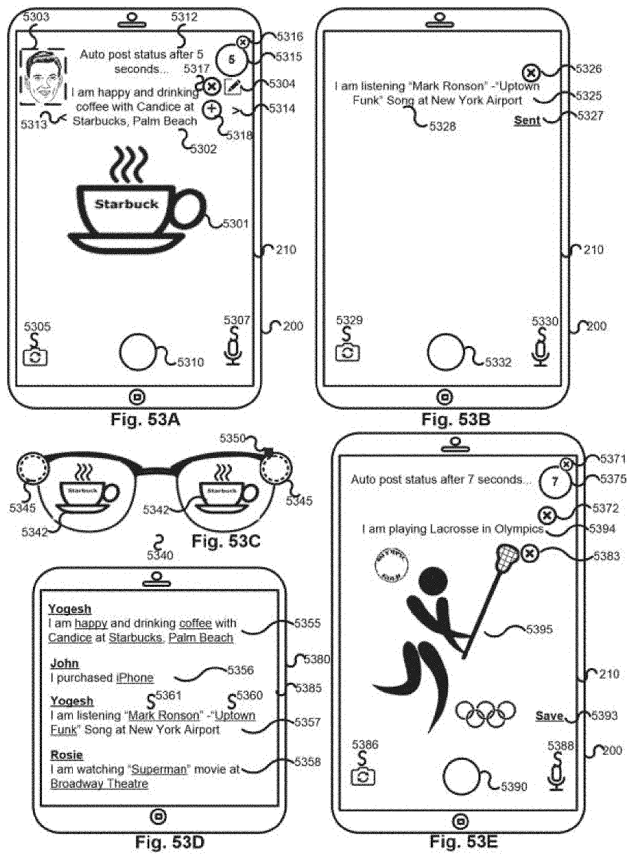

FIG. 53 illustrates user interface 282 for enabling user to providing of user status (identified, prepared, generated and presented by server module 185 of server 110) to one or more user's contacts or connections and/or one or more types of destination(s) based on scanning or selecting or taking front and/or back camera visual media including photo(s) or video(s) (series of image(s)) or viewing via eyeglass or wearable device's integrated camera and/or user device's current location or place or checked-in place or auto checked-in place or nearest identified place(s) and/or user's voice or voice command and/or date and time and/or user's connected one or more users devices' current location or place or checked-in place or auto checked-in place or nearest identified place(s) and/or one or more types of user's and/or user's one or more contact(s)′ data including profile (age, birthdate, anniversary date, gender, home and work address, interacted entities type(s) and name(s) including school name, college name, company name(s) etc., educations, qualifications, skills, interests, hobbies, user's schedules or calendar information, user's one or more logged or stored contacts, connections, activities, actions, events, transactions, status, locations, checked-in places, senses, behavior, requirements, tasks, reactions (likes, dislikes, ratings & comments), sharing, communication, collaboration, sharing and participation information.

In an embodiment user can view, select, capture, record, or scan particular scene, object, item, thing, product, logo, name, person or group(s) of persons and scene via user device camera display screen or wearable device(s) e.g. eye glasses or digital spectacles which is/are equipped or integrated with video cameras, Wi-Fi connection, memory and connected with user's smart device(s) e.g. mobile device or smart phone. For example when user [Yogesh] views or scans or captures “coffee cup” 5301 via tap or click on button 5310 on camera display screen 210 of user device 200 then server module 185 recognizes object and object associate keywords e.g. “coffee cup” and based on user device's current location identifies said location associate place and associate information. In an embodiment user can also use front camera to provide one or more types of expressions. For example user [Yogesh] also use front camera and provide expression 5303 for example user [Yogesh] shows happy face expression which stores and send to server module 185 of server 110 to recognize user's face expression(s) based on employing face detection technologies e.g. it identifies “happy” expression. After identifying user [Yogesh]'s happy face expression 5303, object 5301 keyword(s) e.g. “coffee”, user device's place information and nearest one or more friends' or contacts' current location or place (who is/are accompanies with user [Yogesh]) based on date & time and monitoring of user device's 200 current location by server module 185 of server 110, server module 185 of server 110 prepares status based on one or more rules of rule base For example, “I am” (or Yogesh i.e. user)+“happy” (based on identified face expression video or photo)+“and” (if more than one activity or status or action)+“drinking” (coffee is associated with “drinking” action)+“coffee” (based on user device's current identified place or place information and based on user supplied image 5201)+“with” (If other one or more person(s) [e.g. Candice] accompanies with user [e.g. Yogesh])+“Candice” (based on monitoring and matching user [Candice] device's current location or place information and current date & time with connected user [Yogesh] device's current location or place information and current date & time)+“at” (to provide place information)+“Starbuck” (based on place information e.g. place name or brand name or shop name etc. accessed from one or more sources)+“, Palm Beach” (based on stored or accessed place address or location information from one or more sources) and presents said prepared user's current status “I am happy and drinking coffee with Candice at Starbucks, Palm Beach” 5302 to user device 200 at user interface 210. In another embodiment server module 185 of server 110, can prepares one or more status based on user provided details (via scan, object model, voice etc.) or user or connected users' of user related data (e.g. user device's current location, date & time, user profile etc.), wherein user can view previous 5313 or next 5314 status (if more than one generated and presented status by server module 185) and can tap on said presented status e.g. 5302 or tap on edit icon 5304 to edit and update said status (if user want to change and in an embodiment in the event of tap on edit icon, system stops auto send or auto publish timer icon 5315) or user can remove said presented status 5302 via remove icon 5317 or swipe left or swipe right to remove said presented status 5302 or user can manually add status via add status icon 5318. In another embodiment server module 185 of server 110, after identifying, preparing, generating and presenting said status 5302 removes supplied image 5301, front camera video or image 5303, recorded voice file (if any), and monitored location etc. In an embodiment after presenting status, system wait for pre-set duration 5315 for enabling user to view status and in the event of expiry of said pre-set wait duration timer 5315, system automatically posts, sent, shares, stores, processes, publishes or advertises and presents said status 5302 to one or more pre-set users or default users or selected connected users of user and/or one or more types of one or more selected or pre-set or default set destination(s) e.g. user [Candice] is connected user of status sender user [Yogesh] and is presented with said posted status 5355 of user [Yogesh] on user interface 5385 at user device 5380. In an another embodiment recipient user e.g. user [Candice] can access status associated additional information via provided links e.g. user can access photos, videos, profile photo(s) of sender and addition related contextual information provide by 3^{rd} parties one or more types of sources including web sites, applications, storage mediums, networks, devise, databases via web services, user's login information, APIs, SDKs and communication interfaces.

In an embodiment user can ON or OFF user device's location service, voice recording 5307, scanning or sending image(s) to server 5310 or viewed image(s) 5342 via wearable device(s) e.g. eye glasses 5340, front camera 5303 and auto identifying, preparing, generating and/or auto providing of status to one or more types of connected users of user and/or destination(s) based on settings.

In an another example when user make ON voice recording via voice recording ON/OFF icon 5330 (User make ON voice recording when user wants to auto identify said voice associate information by server and prepares status for user for sending or sharing or publishing to connected users of user) and when user listening particular song, then client side application 283, sends said recorded voice file or incrementally sends stream of voice, when user tap on icon 5332, to server module 185 of server 110 which employs voice recognition technologies to identify said song related details and prepares status, “I am”+listing (based on recording of and receiving of voice file”+“Mark Ronson” (identified song related identified singer)+“Uptown Funk” Song” ((identified song based on voice recognition and stored information about song at server 110 and/or 3^{rd} parties service providers or domains)+“at New York Airport” (location information), for user and send to user device 200 at user interface 210 e.g. “I am listing “Mark Ronson”−“Uptown Funk” Song at New York Airport” 5328. In another embodiment user is enabled to listen said song via provided link 5360 or view singer information via accessing link 5361. In another embodiment user is enabled to remove status 5326, edit status by tapping on status or sent status via tapping on sent icon or label or button 5327 and any other manner including after expiration of displayed pre-set duration timer, voice command, hover on status etc.

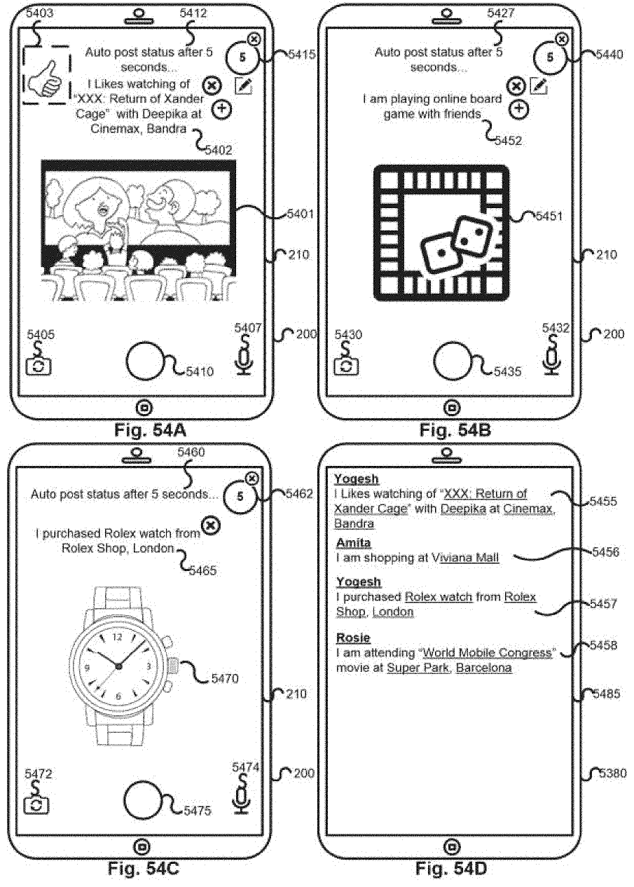

In an another example of FIG. 54 (A), in the event of providing of movie snapshot or scan movie poster or providing of captured photo or screenshot or video related to said movie 5401 and front camera user expression or reaction video 5403 to server module 185 of server 110 via client side auto status application 283 (via tapping button 5410), server module 185 identifies and retrieves movie related information based on recognizing provided image 5401 related text and movie stars and associated current movie, front camera user expression or reaction video 5403 and identifying user device's current location and connected user device's current location specific place related current movie information e.g. movie show date & time and associated movie details from one or more sources' database(s) and presents to user prepared or generated and provided status 5402 for enabling viewing user to edit or remove or send manually or auto send to pre-set contacts and/or group(s) and/or one or more types of destination(s).

In an another example of FIG. 54 (B), in the event of providing of screenshot or snapshot of playing of online game or providing of captured photo or screenshot or video related to said online game 5451 to server module 185 of server 110 via client side auto status application 283 (via tapping button 5435), server module 185 identifies and retrieves game related information based on recognizing provided image 5451 and presents to user prepared or generated and provided status 5452 for enabling viewing user to edit or remove or send manually or auto send to pre-set contacts and/or group(s) and/or one or more types of destination(s).

In an another example of FIG. 54 (C), in the event of providing of image of product 5470 at or inside particular place (i.e. user device's monitored place by server 110) and settings (i.e. user pre-set that in the event of taking of photo of any branded product in shop as type of place then treat it as “Purchased”) to server module 185 of server 110 via client side auto status application 283 (via tapping button 5475), server module 185 identifies and retrieves said product related information based on recognizing provided image 5470 and/or identified or provided or monitored location or place and/or said provided setting and presents to user prepared or generated and provided status 5465 for enabling viewing user to edit or remove or send manually or auto send to pre-set contacts and/or group(s) and/or one or more types of destination(s).

In an another embodiment user can provide user expressions in the form of one or more photos or videos and provide associated meaning in text format to each said user expression photo or video e.g. “Like” associate with user's thumb expression or reaction of user photo or video (so system can recognize thumb expression in front camera photo or video and identifies user associate text “Like” for preparing status), e.g. ““Dis-like” associate with user's down thumb photo or video, “Purchased” associate with 2 fingers (e.g. victory sign) photo or video, “Viewed” associate with user's round finger on user's eye photo or video etc.

In an another embodiment auto sending or updating or presenting or publishing user's status to connected users or related or pre-set users of network. In another embodiment notifying user about updating or auto publishing of user's status and enabling user to remove or update or add new status.

FIG. 54 (D) illustrates some of the exemplary status of user [Yogesh], user can view his own or other connected or related users of network's auto generated or partially auto generated (in the event of edited by user) and auto presented status.

As discussed above based on provided user data (object model, voice, location information and one or more types of updated user data and provided via front camera video user's expressions, and visual commands) for auto generating user status, server module 185 of sever 1110 can enabled to provide various types of user status including about user's various types of reactions or feeling including happy, loved, blessed, sad, wow, crazy, awesome, cool, like, dislike, thankful, wonderful, good, bored, hungry, great, strong, ready, sleepy, cute, annoyed or anger, hurt, frustrated, satisfied, beautiful, sorry, curious, lazy, full, etc., about user's various types of activities, actions, events, participations & transactions like watching, reading, listening, watched, listened, purchasing, purchased, interest to buy, drinking of/at e.g. coffee, tea, soft drinks, milk etc. with friend(s) at, eating pizza, birthday cakes (based on user's or friend's birth date) launch or dinner (based on day time-country specific) with <friends> based on location of friends at <place> based on device location, playing particular sport or online games e.g. cricket, Temple Run™, football, volleyball, badminton etc. based on photo or video or scanning for some time (in background send photo or video) recognize sport type, place, with <friends> etc., travelling to, strolling at, shopping at/of, looking for, searching for, attending at, viewing, preparing of, selling of, buying of, praising, talking about, walking at, exercising, sleeping, awaking, just awaked, reaching at, arriving at, arrived, requesting for/to, inviting to, invitation accepted, celebrating of, in meeting at, available, not available or busy, making of, thinking about, remembering, working, dancing, making jokes, viewing show, celebrating attending birthday party, marriage party, particular day etc. (based on stored date & time of user's, connected users of user profile and calendar entries, 3rd parties or server—various days of various countries, events, movie shows etc.), wear new cloths or shoes, watching television serial, taking breakfast or lunch or dinner (based on timings).

In an another embodiment sender user of status or server module of 185 of server 110 can attach one or more user actions, call-to-actions, controls (e.g. button), accessible links of one or more applications, web sites, interfaces, one or more types of visual media or content items with said auto generated and auto presented status, for enabling sending user and viewing or receiving users of status to participate in or conduct one or more activities, actions, events, transactions, tasks, participations and providing one or more types of actions (likes, dislikes, ratings & comments) including watch movie trailer, listen music, make order, book tickets, share payments, make plan, meet at periocular place, invite, refer, share visual media or links, ask query, provide answer etc.

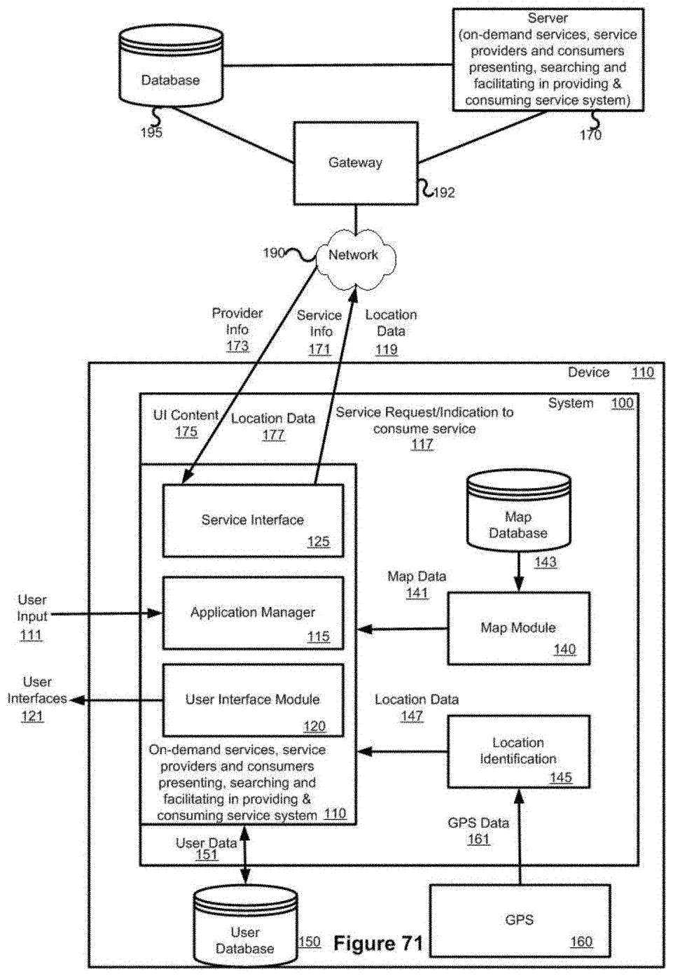

In another embodiment user can take photo taking service of other users of network including nearest available friend(s) or particular friend or any other photo taking service providers as discussed in detail in FIGS. 71-72, for taking photo for preparing status e.g. when user's swimming, dancing then user's request accepted photo taking service provider user or nearest request accepted user's friend can take user's swimming photo or dancing photo and sent to server module 185 of server 110 for identifying and preparing user's status i.e. <user> is participate in swimming competition at <place> with <friend(s)> etc.

In an another embodiment based on user supplied data and user related data and identified, prepared and generated status by server module 185 of server 110, based on status 5394 related keywords and keyword associate type(s) and/or name(s) of activities, actions, events, transactions, place, expressions, reactions, categories, entities (e.g. brand, product, service), text, current location, checked-in-place or identified place and current date & time, and one or more types of user data or profile data including gender, age, age range, hobbies, interests, preferences, privacy settings, home and work place, interacted or related entities, and physical characteristics, server module 186 of server 110 identifies pre-stored or dynamically creates, articulates, merges, updates, overlays, assembles as one piece, generates and presents one or more types of one or more cartoons, avatars, emoticons or emoji's 5395 (i.e. a small digital image or icon used to express a user status (including facial expressions, activities, actions, events, common objects, places and types of weather etc.), which user can save 5383 and can share in/via electronic communication or one or more types of communication or sharing or other applications.

For example based on generated status “I am happy and drinking coffee with Candice at Starbucks, Palm Beach”, server module 185 of server 110 identifies pre-stored “happy” related icon or image or emoticon or cartoon, “drinking coffee” related icon or image or emoticon or cartoon, “Starbucks” related icon or image or emoticon or cartoon and “Palm Beach” related icon or image or emoticon or cartoon and based on type arrange, overlays, juxtapose, overlays and assemble as one piece of image or cartoon or emoticon or emoji and generates and presents to related user.

In an embodiment generate status and create and show to user only generated one or more cartoons, avatars, emoticons or emoji's. In an embodiment generate status and create and auto share or publish said generated one or more cartoons, avatars, emoticons or emoji's to user's one or more contacts or pre-set contacts.

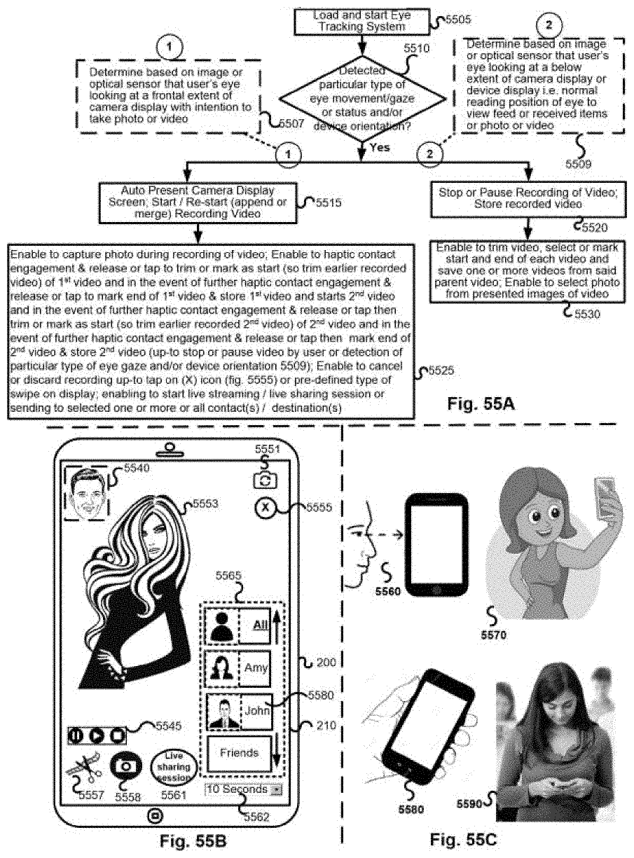

FIG. 55 illustrates an embodiment of a logic flow 300 for the visual media capture system 200 of FIG. 2. The logic flow 300 may be representative of some or all of the operations executed by one or more embodiments described herein.

FIG. 55 illustrates processing operations associated with the Auto Present Camera Display Screen Application and/or auto present visual media capture controller 260. Initially an eye tracking system is loaded in memory or loaded in background mode 5505, so it can continuously monitor user's eye by using one or more types of image sensors 244 or optical sensors 240 or for example, a user may access an application presented on display 210 to invoke or initiate or open an eye tracking system 5505. In an embodiment at 5510 an eye tracking system monitors, tracks and recognize user's one or more types of eye movement or eye status or eye position by using one or more types of one or more optical sensors 240 or image sensors 244. In another embodiment at 5510 an eye tracking system monitors, tracks and recognize user's one or more types of eye movement or eye status or eye position by using one or more types of one or more optical sensors 240 or image sensors 244 relative to or correspond to display 210 or user device 200 position by employing accelerometer sensor 248 and/or employing other user device orientation sensors including gyroscope 247 of user device 200. An accelerometer is a sensor which measures the tilting motion and orientation of a mobile phone. At 5515 based on determination or recognition of particular type of user's eye movement or eye status or eye position and type of device orientation, for example similar to hold device to see camera display screen i.e. camera view or camera application view e.g. 5560 or 5570, auto open camera application or camera display screen and auto start recording of video (if. mobile device is off or lock screen is off then auto ON mobile device and auto open mobile camera application).

At 5520 if an eye tracking system recognizes or detects another particular type of user's eye movement or eye status or eye position and type of device orientation, for example similar to hold device to view photos from gallery or album e.g. 480 or 490 then stop or pause recording of video and store recorded video. At 5530 user is enabled to trim video, select or mark start and end of each video and save one or more videos from said parent video and enable to select photo from presented images of video,

At 5525 user is enabled to (1) capture photo during recording of video; (2) during recording of video enable to haptic contact engagement & release or tap to trim or mark as start (so trim earlier recorded video) of 1st video and during recording of video in the event of further haptic contact engagement & release or tap to mark end of 1st video & store 1st video and during recording of video starts 2nd video and during recording of video in the event of further haptic contact engagement & release or tap then trim or mark as start (so trim earlier recorded 2nd video) of 2nd video and during recording of video in the event of further haptic contact engagement & release or tap then mark end of 2nd video & store 2nd video (up-to stop or pause video by user or detection of particular type of eye gaze and/or device orientation 5509); (3) during recording of video enable to cancel or discard recording up-to tap on (X) icon (FIG. 5555) or pre-defined type of swipe on display; (4) during recording of video enabling to start live streaming/live sharing session or sending to selected one or more or all contact(s)/destination(s)

FIG. 55 (B) illustrates graphical user interface wherein based on user's eye gaze or status and device orientation, system auto opens camera display screen 210 of user device 200 and auto starts recording of video 5553 (5515) and during recording of video enabling user to tap on icon 5557 or anywhere on display 210 to trim video and starts recoding of first video after tap on 5557 or anywhere on camera display screen 210. During recording of video user can further tap on anywhere on camera display screen 210 to stop first video and store first video and start recording second video. If user further tap on trim video icon 5557 or tap anywhere on display 210, then system further trim video from end of 1S^{t} video or start of 2^{nd} video up-to user tap on trim video icon 5557 or tap anywhere on display 210 and starts recording of 2^{nd} video and stops recording of 2^{nd} video up-to user further tap anywhere on display 210 or in the event of detection or recognition of particular type of user's eye gaze or status and device orientation 5509. During recording of video user is enabled to capture photo via photo capture icon 5558 or during recording of video user is enabled to start live broadcasting 5561 to selected one or more contacts 5565. In another embodiment during recording of video user is enabled to tap on one or more user contact icon(s) e.g. 5580 from auto presented list of user contacts icons 5565 on display 210, to send said recorded one or more video, captured one or more photos during recording of video to said selected or tapped e.g. user contact icon 5580. In another embodiment user is enabled to make said shared videos or photos as ephemeral content for recipient, so recipient(s) can view said video up-to length of video and in the event of end of video removes said shared video from recipient's device and/or from server or server storage medium and/or remove from sender's device or recipient user can view received said photo up-to pre-set duration of timer set by sender 5562 and in the event of expiry of timer after display of said photo, removes said photo from recipient's device and/or from server or server storage medium and/or remove from sender's device. So by using present invention user is enabled to quickly auto open camera display screen and immediately starts recording of video, due to immediate starting of video, some initial parts of video user want to trim to make starts of video with good angel of scene and discard unwanted starting part of video and can further tap to stop first video and if need user can start 2^{nd} video after stop of first video and can further tap to trim starts of 2^{nd} video to remove unwanted starting part of video or further tap to stop 2^{nd} video or stop video by particular type of eye gaze or eye status and device orientation. So, user gets immediacy as well as multi-tasking functionalities during the recording of video i.e. record one or more video, capture one or more photos, share captured or recorded and saved visual media items to one or more contact(s), further record one or more video, capture one or more photos, and further share captured or recorded and saved visual media items to one or more same or different selected contact(s).

In another embodiment after selecting back camera mode via mode changing icon 5551 and after staring of back camera video user can tap on 5540 (icon or control or pre-defined or identified area on display 210 or camera display view screen) to ON or OFF and in the event of ON, start front camera selfie video 5540 via front camera to provide commentary or news on recording of back camera video 5553 via back camera. For example when user is recording fashion model video 5553 via back camera at particular fashion show, user can also enable to concurrently record front camera video 5540 to provide video comments or reviews or show or event or scene description or commentary or news or reactions or feedbacks on said currently recording of video 5553 via back camera related to current scene view by recorder. In an embodiment Front camera video (video images) is merged with back camera video recording, so after recording viewer of video can view both front camera video 5553 and back camera video 5540 together. In another embodiment front camera and back camera video is recorded separately, so user can view both video separately. In an another embodiment viewing user is enabled to view front camera video and back camera video together as well as separately based on selecting option. In an another embodiment both front and back camera video recording is happening together or concurrently or simultaneously, so in the event of trimming of back camera video front camera video is also trimmed. In an embodiment enable user to change position of front camera video on back camera video recording before starting or during and after recording of video. In another embodiment viewing user is enabled to change position, show or hide front camera video on back camera video while viewing of back camera video. In another embodiment invention can implement on back camera video (thumb size) on front camera video or front camera video (thumb size e.g. 5540) on back camera video (large size e.g. 5553). In an embodiment user can discard one or more videos during recording of video but take or save or share one or more photos or user can capture and remove or capture, preview & remove one or more photos but save and/or preview and/or share one or more videos. As discussed above user can take one or more back camera and in an embodiment simultaneously front camera video(s) and photo(s), can trimmed video(s) or remove video (s) or photo(s) during recording of parent video session (i.e. up-to stop by user by tapping on stop video icon or stop automatically in the event of eye tracking system loaded and identification of particular type of user's eye gaze 5520).

In another embodiment enabling user to pre-set default or mark all or one or more video(s) and photo(s) as ephemeral including set view time, life time and/or number of times of view within life time or make as non-ephemeral and/or make as real-time view including set accept-to-view time within which recipient have to tap on notification or indication to view, number of times reminder notification in the event of non-acceptance of invitation to view or send when recipient user is online or not busy or send as per recipient user's do not disturb settings and/or enabling user to start sharing session or invite one or more contacts and/or groups and one or more types of destination(s) and in the event of acceptance of sharing session or invitation, real-time send said captured front or back camera one or more photos and videos during said parent video recording session and in the event of ending of said parent video recording session end said started sharing session.

In another embodiment enabling to pre-set default or select one or more contacts and/or groups and/or one or more types of destination(s) 5565 during recording of parent video session, and in the event of selection of one or more contacts and/or groups and/or one or more types of destination(s) e.g. 5580, real-time or auto sent all or one or more captured or recorded or trimmed front or back camera phot(s) and/or video(s) e.g. 5553 to said selected one or more contacts and/or groups and/or one or more types of destination(s) e.g. 5580 up-to changing or updating of selection of one or more contacts and/or groups and/or one or more types of destination(s) 5565, in the event of update in selection of one or more contacts and/or groups and/or one or more types of destination(s) 5565, real-time or auto sent all or one or more captured or recorded or trimmed front or back camera phot(s) and/or video(s) after said updates to said updated selection specific one or more contacts and/or groups and/or one or more types of destination(s). In an another embodiment show/hide contact menu or contact(s) and/or group(s) and/or destination(s) list(s) 5565 based on user selection, hover on particular area on display screen, voice command, show after capture or stop of recording of child video for pre-set duration and then hide, stop of parent video, show for some time at the time of starting of parent video. In another embodiment close contact menu 5565 up-to manually open by user.

In another embodiment present thumbnail of captured photo(s) or recorded video(s) on top or right side (i.e. switch to contact(s) menu or list for enabling to select contact(s) for sharing or switch to captured visual media list for enabling to review, remove, edit or augment or apply one or more photo filters or augment and select for sending or sharing etc.) of display 210 or show/hide based on user tap on particular icon, for enabling user to view, select and send to one or more selected or pre-set contact(s) and/or group(s) and/or one or more types of destination(s).

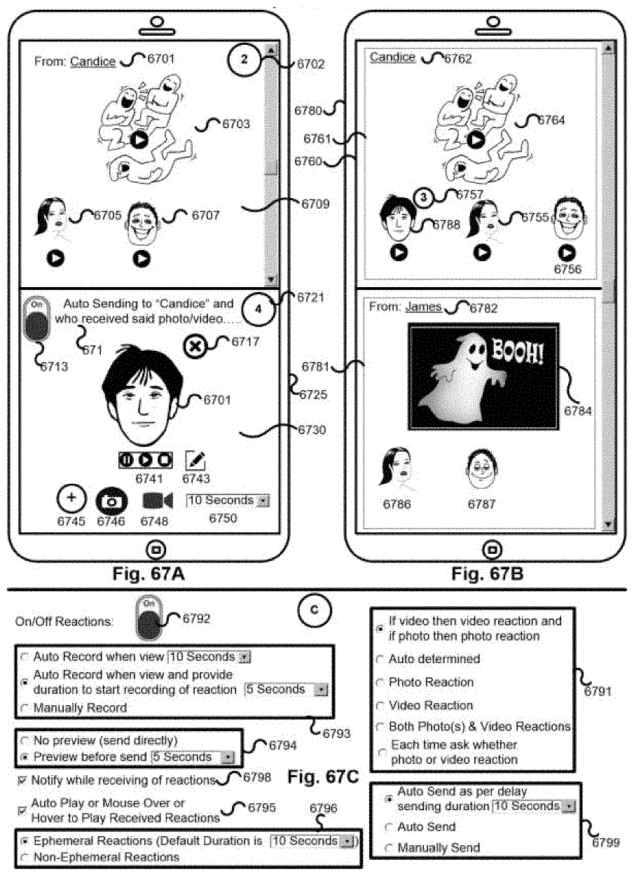

In another embodiment user can view real-time recipient user's or users' reactions (as discussed in detail in FIG. 67) during recording of parent video on prominent place of camera display screen.

In another embodiment user can view real-time recipient user's or users' reactions in the form of transparent and/or animated like or dislike icons or comment text during recording of parent video on camera display screen.

Auto ON camera display screen (as discussed in FIG. 3-5) and always on video recording and during parent video recording session taking, removing, previewing (preview photo or video for pre-set duration of time and preview in thumbnail mode), cancelling, capturing and trimming and/or merging and sharing of one or more front camera and/or back camera videos and/or photos during recording of video.

In another embodiment user can pause and re-start or resume & stop (to mark as end of child video) 5545 child video during recording of parent video session.

In another embodiment user is enabled to take multiple photos based on pre-set interval of time and number of takes in the event of tapping on photo icon 5558 or based on settings or tapping on particular control or icon (not shown in figure).

In another embodiment user can capture photo e.g. 5553 and can provide video (e.g. video comments) on it after capturing said photo via recording front or back camera video 5540 based on option selections, which is merged with said photo or in another embodiment user can remove or in another embodiment user can retake front or back camera video, so viewing user can view said video on/with said photo together or can view separately or can ON or OFF viewing of said video on photo.

In another embodiment after selecting back camera mode and after staring of back camera video user can swipe to 3^{rd} button or pre-defined area 4354 and can able to start capturing of one or more front camera selfie photo(s) 4349 via tapping at/on or swiping to particular pre-defined area of visual media capture controller label e.g. 4341 to provide user's expressions during recording of video 4340 via back camera. For example user is recording natural scenery video 4340 at particular tourist place and can also enable to concurrently capture one or more photo(s) via tapping on 4341 to provide user's face expressions on said currently recording of video via back camera related to current scene view by recorder.

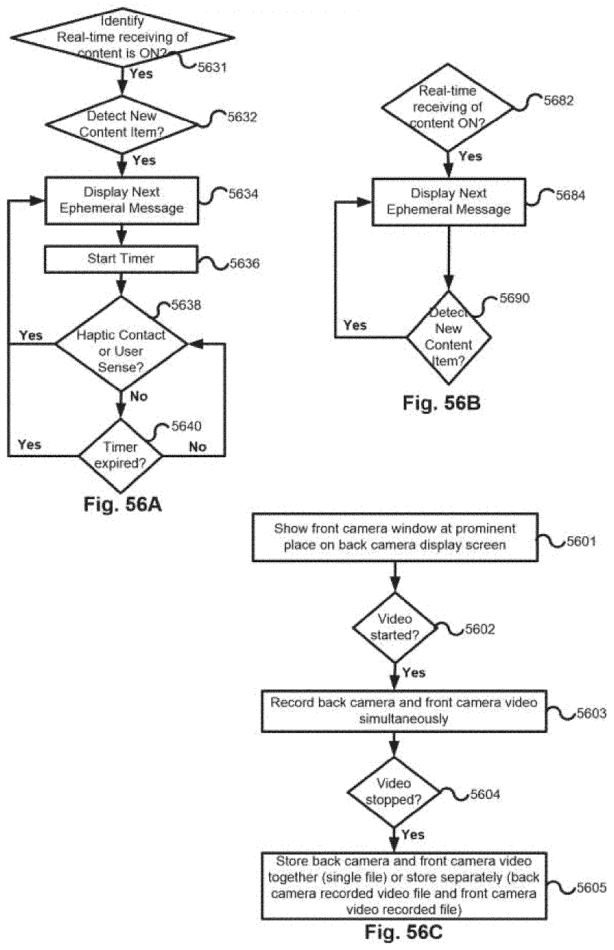

FIG. 56 illustrates real-time sending and viewing ephemeral message in accordance with the invention. FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores a real-time ephemeral message controller 276 to implement operations of the invention. The real-time ephemeral message controller 276 includes executable instructions to real-time display of ephemeral messages. An ephemeral message may be a text, an image, a video and the like. In an embodiment the display time for the ephemeral message is typically set by the message sender. However, the display time may be a default setting or a setting specified by the recipient. Regardless of the setting technique, in an embodiment the message is transitory.

The processor 236 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the real-time ephemeral message controller 276 monitors signals from the touch controller 215. If haptic contact is observed by the touch controller 215 during the display of an ephemeral message, then the display of the existing message is terminated and a subsequent ephemeral message, if any, is displayed. In one embodiment, two haptic signals may be monitored. A continuous haptic signal may be required to display a message, while an additional haptic signal may operate to terminate the display of the message. For example, the viewer might tap the screen with a finger while maintaining haptic contact with another finger. This causes the screen to display the next piece of media in the set. In one embodiment, the haptic contact to terminate a message is any gesture applied to any location on the display 210. In another embodiment, the haptic contact is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the real-time ephemeral message controller 276.

FIG. 56 (A) illustrates processing operations associated with the real-time ephemeral message controller 276. Initially, identify that real-time receiving of content setting is ON (5631—Yes); then detect or identify by server that particular recipient receives content item or visual media item from sender (5632—Yes); an ephemeral message is displayed 5634. A timer is then started 5636. The timer may be associated with the processor 235.

Haptic contact and/or one or more type of pre-defined user sense(e) via one or more types of user device(s) sensor(s) is/are then monitored 5638. If haptic contact and/or one or more type of pre-defined user sense via one or more types of user device(s) sensor(s) exists (5638—Yes), then the current message is deleted and the next message, if any, is displayed 5634. If haptic contact and/or one or more type of pre-defined user sense via one or more types of user device(s) sensor(s) does not exist (5638—No), then the timer is checked 5640. If the timer has expired (5640—Yes), then the current message is deleted and the next message, if any, is displayed 200. If the timer has not expired (5640—No), then another haptic contact and/or one or more type of pre-defined user sense(s) via one or more types of user device(s) sensor(s) check is made 5638. This sequence between blocks 5638 and 5640 is repeated until haptic contact and/or one or more type of pre-defined user sense(s) via one or more types of user device(s) sensor(s) is identified or the timer expires.

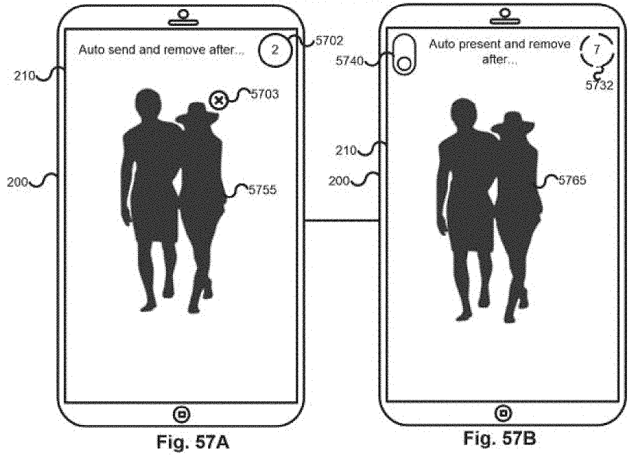

FIG. 57 (C) illustrates the exterior of electronic device 200 of sender device. In an embodiment after capturing one or more video and photos (as discussed in FIG. 55), sender user is presented with preview of said each visual media items for pre-set duration for enabling to review, remove and select or change default or pre-set destination(s) and/or contact(s) and edit or augment visual media item and in the event of expiry of said pre-set preview duration and non-action from viewing user's side then auto send said visual media item to default or pre-set one or more contact(s) and/or one or more types of destination(s) and present next (if any) visual media item for user preview for pre-set duration. In an another embodiment sender can capture photo via photo icon or record video via video icon or select one or more types of visual media from gallery and select one or more contact(s) and/or one or more types of destination(s) and send. In an another embodiment employ method discussed in FIG. 3 or FIG. 4 or FIG. 5 or FIG. 6-8 or FIG. 43 or FIG. 48 for taking and sending or sharing visual media item then sender user is presented with preview of said each visual media item for pre-set duration for enabling to review, remove and select or change default or pre-set destination(s) and/or contact(s) and edit or augment visual media item and in the event of expiry of said pre-set preview duration and non-action from viewing user's side then auto send said visual media item to default or pre-set one or more contact(s) and/or one or more types of destination(s). FIG. 57 (D) illustrates the exterior of electronic device 200 of recipient device. The figure also illustrates the display 210. The display 210 presents a one or more or set of ephemeral messages 5734 available for viewing. A first message 5755 from sender's device sent to recipient device (after identifying that recipient user provide setting to receive real-time content ON 5631 (5740—ON)) upon expiration of preview timer 5702 and present said message 5765 (5734) to recipient. Upon expiration of the timer 5732 (5740), a second message (if any) 5732 (5734) is displayed. Alternately, if haptic contact and/or one or more type of pre-defined user sense(e) via one or more types of user device(s) sensor(s) 5638 is received before the timer expires 5740 the second message (if any) 5734 is displayed.

In another embodiment FIG. 56 (B) illustrates processing operations associated with the real-time ephemeral message controller 276. Initially, identify that real-time receiving of content setting is ON (5682—Yes); then an ephemeral message is displayed 5684. In the event of detection or identification of receiving of new content item or visual media item by server from sender (5690—Yes) then the current message 5665 is deleted and the next message, if any, is displayed;

In another embodiment FIG. 57 (C) illustrates the exterior of electronic device 200 of sender device. In an embodiment after capturing one or more video and photos (as discussed in FIG. 55), sender user is presented with preview of said each visual media items for pre-set duration for enabling to review, remove and select or change default or pre-set destination(s) and/or contact(s) and edit or augment visual media item and in the event of expiry of said pre-set preview duration and non-action from viewing user's side then auto send said visual media item to default or pre-set one or more contact(s) and/or one or more types of destination(s) and present next (if any) visual media item for user preview for pre-set duration. In an another embodiment sender can capture photo via photo icon or record video via video icon or select one or more types of visual media from gallery and select one or more contact(s) and/or one or more types of destination(s) and send. In an another embodiment employ method discussed in FIG. 3 or FIG. 4 or FIG. 5 or FIG. 6-8 or FIG. 43 or FIG. 48 for taking and sending or sharing visual media item then sender user is presented with preview of said each visual media item for pre-set duration for enabling to review, remove and select or change default or pre-set destination(s) and/or contact(s) and edit or augment visual media item and in the event of expiry of said pre-set preview duration and non-action from viewing user's side then auto send said visual media item to default or pre-set one or more contact(s) and/or one or more types of destination(s). FIG. 57 (D) illustrates the exterior of electronic device 200 of recipient device. The figure also illustrates the display 210. The display 210 presents a one or more or set of ephemeral messages 5784 available for viewing. A first message 5755 from sender's device sent to recipient device (after identifying that recipient user provide setting to receive real-time content ON 5682 (5640—ON)) upon expiration of preview timer 5702 and present said message 5765 (5734) to recipient. In the event of detection or identification of receiving of new content item or visual media item by server from sender (5790—Yes) then the current message 5765 is deleted and the next message, if any, is displayed. For illustrating this embodiment omit and ignore FIG. 5732 from FIG. 57 (D).

In an embodiment FIG. 56 (C) illustrates describes process, initially at 5601 showing of front camera display screen on back camera display screen; in the event of starting of recording of bask camera video (5602—Yes), also starts recording of front camera video simultaneously 5603 and in the event of stopping of recording of video (5604—Yes), store back camera and front camera video together as a single media or file or store back camera recorded video file and front camera video recorded file separately 5605.

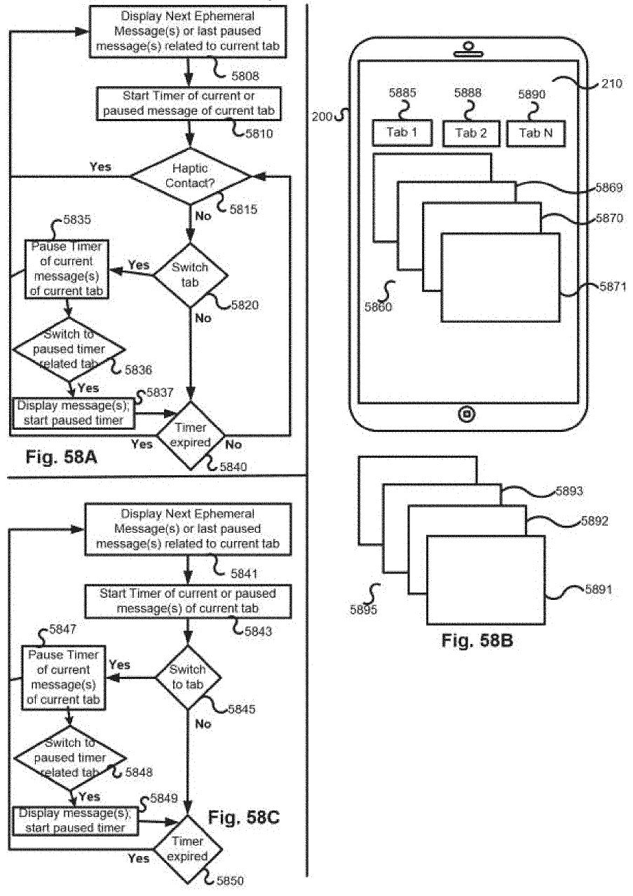

FIG. 58 illustrates processing operations associated with multi-tabs accelerated display of ephemeral messages in accordance with an embodiment of the invention and illustrates the exterior of an electronic device implementing multi-tabs accelerated display of ephemeral messages in accordance with the invention.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores a multi-tabs ephemeral message controller 274 to implement operations of the invention. The multi-tabs ephemeral message controller 274 includes executable instructions to accelerate display of ephemeral messages. An ephemeral message may be a text, an image, a video and the like. The display time for the ephemeral message is typically set by the message sender. However, the display time may be a default setting or a setting specified by the recipient. Regardless of the setting technique, the message is transitory.

The processor 230 is also coupled to image sensors 244. The image sensors 244 may be known digital image sensors, such as charge coupled devices. The image sensors capture visual media, which is presented on display 210.

In an embodiment a touch controller 215 is connected to the display 210 and the processor 230. The touch controller 215 is responsive to haptic signals applied to the display 210. In one embodiment, the multi-tabs ephemeral message controller 274 monitors signals from the touch controller 215. If haptic contact is observed by the touch controller 215 during the display of an ephemeral message, then the display of the existing message is terminated and a subsequent ephemeral message, if any, is displayed. In one embodiment, two haptic signals may be monitored. A continuous haptic signal may be required to display a message, while an additional haptic signal may operate to terminate the display of the message. For example, the viewer might tap the screen with a finger while maintaining haptic contact with another finger. This causes the screen to display the next piece of media in the set. In one embodiment, the haptic contact to terminate a message is any gesture applied to any location on the display 210. In another embodiment, the haptic contact is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the multi-tabs ephemeral message controller 274.

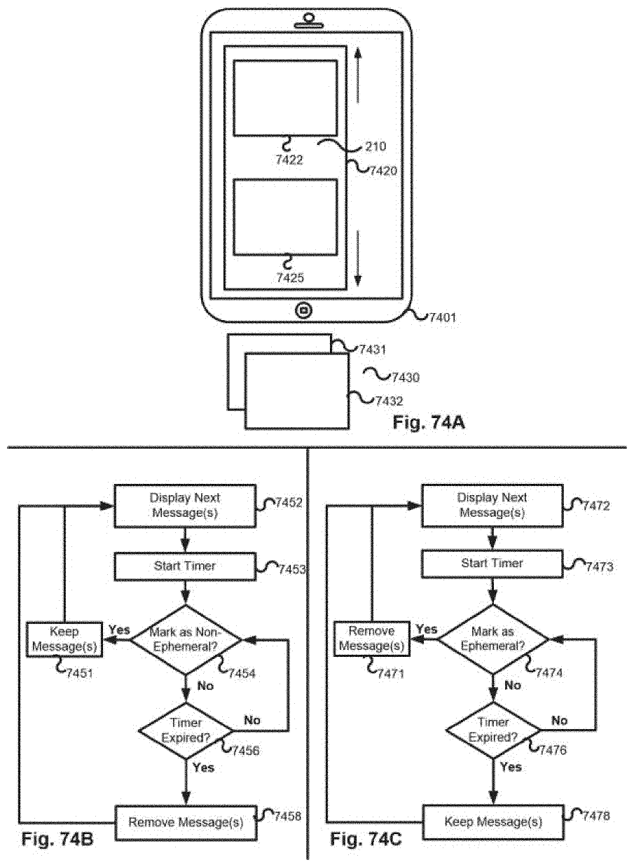

FIG. 58 (C) illustrates processing operations associated with the ephemeral message controller 277 and FIG. 58(B) illustrates the exterior of electronic device 200. In an embodiment, a multi-tabs ephemeral message controller 274 with instructions executed by a processor 230 to: present on a display 210 a one or more or set of ephemeral messages (e.g. 5871 or 3410 or 3530 or 3820 or 3971—depends upon type of feed or stories or presentation interface) related to first tab 5885 available for viewing on a first tab 5885 (5841); present on the display 210 a first set of ephemeral message (e.g. 3410 or 3530 or 3820 or 3971—depends upon type of feed or stories or presentation interface) or first ephemeral message e.g. 5871 (5841) of the collection of ephemeral messages related to a first tab 5885 on first tab 5885 related interface or feed for a first transitory period of time defined by a timer 5843 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof), wherein the first set of or first ephemeral message is deleted when the first transitory period of time expires 5850 and proceeds to present on the display a second ephemeral message 5870 or second set of ephemeral messages of the collection of ephemeral messages related to a first tab 5885 on first tab 5885 related interface or feed for a second transitory period of time defined by the timer, wherein the ephemeral message controller deletes the second ephemeral message 5870 or second set of ephemeral message upon the expiration of the second transitory period of time; wherein the ephemeral message controller initiates the timer upon the display of the first ephemeral message 5871 or first set of ephemeral message and the display of the second ephemeral message 5870 or second set of ephemeral message on first tab 5885; wherein in response to switching from first tab 5885 to second tab 5888 (5845) pause timer 5847 associated with one or more or set of messages or feeds or scrolled up message(s) including pause timer of current message(s) 5871 or 5870 of current tab 5847, pause started timer of auto refresh (FIGS. 34—3430), pause started timer of set of messages (FIGS. 35—3540 and 3558), pause started timer of each completely scrolled up message whose timer started (FIGS. 36—3660 and 3680), pause started timer associated with each presented message (FIGS. 37—3734 and 3746), pause started timer associated with each presented message on scrollable feed (FIGS. 38—3840, 3864 and 3853), pause started interval timer of currently presented message (FIGS. 39—3933), pause started timer associated with each presented message (FIGS. 74—7456 and 7476), pause started timer associated with message(s) related to one or more type of feeds or stories or events or galleries or presentation interface (discussed in specification) and prevent presenting of next (if any) e.g. 5869 or next set of message(s); in response to switching to particular tab or second tab 5888, present on a display 210 a one or more e.g. 5891 or set of ephemeral messages related to second tab 5888 available for viewing on a second tab 5888; present on the display 210 a first ephemeral message 5891 or first set of ephemeral message of the collection of ephemeral messages related to a second tab 5888 on second tab 5888 related interface or feed for a first transitory period of time defined by a timer, wherein the first ephemeral message 5891 or first set of ephemeral message is deleted when the first transitory period of time expires and proceeds to present on the display 210 a second ephemeral message 5892 or second set of ephemeral message of the collection of ephemeral messages related to a second tab 5888 on second tab 5888 related interface or feed for a second transitory period of time defined by the timer, wherein the ephemeral message controller deletes the second ephemeral message 5892 or second set of ephemeral message upon the expiration of the second transitory period of time; wherein the ephemeral message controller initiates the timer upon the display of the first ephemeral message 5891 or first set of ephemeral message and the display of the second ephemeral message 5892 or second set of ephemeral message on second tab 5888; and wherein the ephemeral message controller display messages and starts paused timer 5849 related to first tab 5885 in response to switching from second tab 5888 to first tab 5885 (5848—Yes).

FIG. 58 (A) illustrates processing operations associated with the multi-tabs ephemeral message controller 274 and FIG. 58(B) illustrates the exterior of electronic device 200. In an embodiment, a multi-tabs ephemeral message controller 274 with instructions executed by a processor 230 to: present on a display 210 a one or more or set of ephemeral messages (e.g. 5871 or 3410 or 3530 or 3820 or 3971—depends upon type of feed or stories or presentation interface) related to first tab 5885 available for viewing on a first tab 5885 (5808); present on the display 210 a first set of ephemeral message (e.g. 3410 or 3530 or 3820 or 3971—depends upon type of feed or stories or presentation interface) or first ephemeral message e.g. 5871 (5808) of the collection of ephemeral messages related to a first tab 5885 on first tab 5885 related interface or feed for a first transitory period of time defined by a timer 5810 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof), wherein the first set of or first ephemeral message is deleted when the first transitory period of time expires 5840; receive from a touch controller a haptic contact signal (5815—Yes) indicative of a gesture applied to the display during the first transitory period of time; wherein the ephemeral message controller deletes the first ephemeral message e.g. 5871 or first set of ephemeral message in response to the haptic contact signal (5815—Yes) and proceeds to present on the display a second ephemeral message 5870 or second set of ephemeral messages of the collection of ephemeral messages related to a first tab 5885 on first tab 5885 related interface or feed for a second transitory period of time defined by the timer, wherein the ephemeral message controller deletes the second ephemeral message 5870 or second set of ephemeral message upon the expiration of the second transitory period of time; wherein the second ephemeral message e.g. 5870 or second set of ephemeral message is deleted when the touch controller receives another haptic contact signal (5815—Yes) indicative of another gesture applied to the display during the second transitory period of time; wherein the ephemeral message controller initiates the timer upon the display of the first ephemeral message 5871 or first set of ephemeral message and the display of the second ephemeral message 5870 or second set of ephemeral message on first tab 5885; wherein in response to switching from first tab 5885 to second tab 5888 (5820) pause timer 5835 associated with one or more messages or feeds or scrolled up message(s) including pause timer of current message(s) 5871 or 5870 of current tab 5835, pause started timer of set of messages (FIGS. 35-3540 and 3558), pause started timer associated with each presented message (FIG. 37—3734 and 3746), pause started timer associated with each presented message on scrollable feed (FIG. 38—3840, 3864 and 3853), pause started interval timer of currently presented message (FIG. 39—3933), pause started timer associated with each presented message (FIG. 74—7456 and 7476), pause started timer associated with message(s) related to one or more type of feeds or stories or events or galleries or presentation interface (discussed in specification) and prevent presenting of next (if any) or next set of message(s); in response to switching to particular tab or second tab, present on a display 210 a one or more e.g. 5891 or set of ephemeral messages related to second tab 5888 available for viewing on a second tab 5888; present on the display 210 a first ephemeral message 5891 or first set of ephemeral message of the collection of ephemeral messages related to a second tab 5888 on second tab 5888 related interface or feed for a first transitory period of time defined by a timer, wherein the first ephemeral message 5891 or first set of ephemeral message is deleted when the first transitory period of time expires; receive from a touch controller a haptic contact signal (5815—Yes) indicative of a gesture applied to the display during the first transitory period of time; wherein the ephemeral message controller deletes the first ephemeral message e.g. 5891 or first set of ephemeral message in response to the haptic contact signal (5815—Yes) and proceeds to present on the display 210 a second ephemeral message 5892 or second set of ephemeral message of the collection of ephemeral messages related to a second tab 5888 on second tab 5888 related interface or feed for a second transitory period of time defined by the timer, wherein the ephemeral message controller deletes the second ephemeral message 5892 or second set of ephemeral message upon the expiration of the second transitory period of time; wherein the second ephemeral message e.g. 5892 or second set of ephemeral message is deleted when the touch controller receives another haptic contact signal (5815—Yes) indicative of another gesture applied to the display during the second transitory period of time; wherein the ephemeral message controller initiates the timer upon the display of the first ephemeral message 5891 or first set of ephemeral message and the display of the second ephemeral message 5892 or second set of ephemeral message on second tab 5888; and wherein the ephemeral message controller display messages and starts paused timer 5837 related to first tab 5885 in response to switching from second tab 5888 to first tab 5885 (5836—Yes).

In an embodiment different tabs have same type of presentation interface or feed or each tab have different types of presentation interface or feed (various types of feeds or presentation interface or stories discussed in detail in FIGS. 58, 11, 12, 13, 19, 28, 31 to 39, 43 (C), 48 (C), 73-75, and 81)

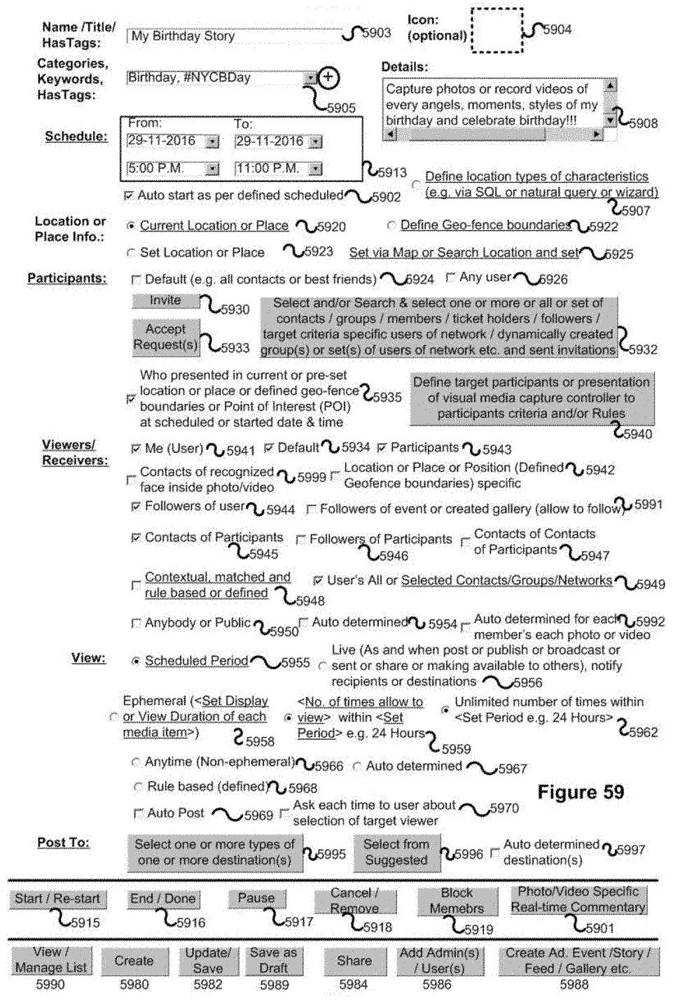

FIG. 59 illustrates user interface 279 to enabling user to provide name or title of event or gallery or album or story or feed or folder 5903, select or upload or search and select or drag and drop icon or image or photo or video or animation for event or gallery or album or story or feed or folder icon 5904, provide or add or update or search or select one or more categories, tags, taxonomy, keywords, key phrases and hashtags 5905, provide or update details or description related to event or gallery or album or story or feed or folder 5908. In another embodiment system dynamically present category or title or keywords or details or subject or story specific structured forms (not shown in Figure) for enabling user to provide structured details about event or gallery or album or story or feed or folder. User can provide schedule (date and time) 5913 of starting and/or ending of taking and adding & viewing of visual media items by enabling participant members to capture or record visual media items and/or enabling viewers to view said shared visual media items during said start and end scheduled period or during manually starting and ending of event or gallery or album or story or feed or folder. User can set as auto start of event or group sharing & viewing 5913 based on defined schedule 5902. User can set location of event as current location of user 5920 or select location or place from list 5923 or enable user to search and/or select location from map and set as location of event 5925 or define geo-fence boundaries of event 5922. In another embodiment user can define location types or location characteristics based on structured query language (SQL) or natural query or via wizard interface 5907 including step by step guidance to define location(s) or place(s) e.g. “Garden of Boston” or “Rivers” or “Temple of Kerala” or “Malls of London”, “5 star hotels of world”, so in the event of monitored current location of user device matched with said location type (e.g. if query is “Garden of Boston” then based on current location category is “Garden” then all users who are presented in or near to garden are alerted and presented with visual media capture controller and in the event of taking visual media auto send to said “Garden of Boston” gallery or folder or feed or category or visual story) then and based on other criteria user is notified or alerted (e.g. via push notification or message with notification tone or ringtone and/or vibration type(s)) or presented with said created event related visual media capture controller or icon and/or label so user can one tap capture or record front camera or back camera photo or video and send to said created event related gallery or storage medium or folder, so other authorized members or target viewers can view them. Based on said location of event and based on scheduled date & time of event or manually started date & time of event, system enables participant members or users presence at said location at said scheduled date & time or manually started date & time 5935 to capture, record, search & select, select, edit, update, share or store or send or post or add one or more types of one or more content items to said event related gallery or album or story or feed or folder or shared storage medium and based on access rights, privileges access and view content items posted by other participant members of said event or gallery or album or feed or story or folder.

User can set participant as default users or prospective sources 5924 including user's phone contacts and/or social network contacts and/or one or more groups & like. User can allow any member of network to become participants 5926. User can invite users via preparing lists for invitation based on adding to list by user names, adding to list from contacts, add nearby users, add via face recognition, add via QR code and add via codes or user can employee plurality of available techniques to invite and add users. User can select or search and select or match based on one or more criteria one or more types of users including contacts, clients or customers or guest or ticket holders list, similar interest or target criteria specific users 5932, wherein target criteria includes one or more keywords, Boolean operators and selection of fields and associated values matched with user profile and user data including current location or location boundaries, check in place, user status, user's one or more types of one or more activities, actions, events, transactions, interactions, senses, behavior, user profile including one or more fields and associated values and any combination thereof via providing structured query language (SQL) as target participant criteria structured including age, gender, qualifications, education, skills, related entities type and name including school, college, company, organization (e.g. present visual media capture controller to users who are at particular location or checked-in particular location or place or points of interest or spot or point at particular date & time and gender=female AND age range=18 to 25 years 5902 and invite 5930 one or more or all contacts, groups, networks, followers, dynamically created group(s) based on location or location of event and one or more rules and criteria, selected or target criteria specific matched users of network based on their privacy settings and preferences to participate or become member of/in event or gallery or album or story or feed or folder for collaborative sharing and viewing. In an embodiment user can provide one or more types of admin rights to one or more members and provide one or more or all types of access rights 987. User can accept one or more requests 5933 from other users of network to become member and/or admin of particular event or gallery or album e.g. event or gallery or album.

User create, configure, update & manage one or more events or galleries or albums or stories and in one embodiment making available for participant member or target participants based on pre-defined criteria & rules for enabling participant members to capture, record, add, modify, remove and store to said event or gallery or album or story visual media items based on rights & privileges provided by administrator(s) via selected or auto presented contextual visual media capture controller control(s), wherein auto present visual media capture controller control(s) based on memberships, rights and privileges, current location at particular date & time and target prospective participants criteria or auto determination based on current location or location boundaries, check in place, user status, user's one or more types of one or more activities, actions, events, transactions, interactions, senses, behavior, user profile including one or more fields and associated values and any combination thereof via providing structured query language (SQL) as target participant criteria structured including age, gender, qualifications, education, skills, related entities type and name including school, college, company, organization (e.g. present visual media capture controller to users who are at particular location or checked-in particular location or place or points of interest or spot or point at particular date & time and gender=female AND age range=18 to 25 years 5940 and enable user or participant to tap or haptic contact engagement on presented or selected visual media capture controller (discussed in detail in FIG. 43-52) to capture photo or record video or prepare one or more types of content items and auto post to said created event or gallery or album or feed or story or folder for making them available to pre-defined types of viewers based on access rights & privileges)

User can provide rights to receive, access and view event or gallery or album or story or feed or folder related content items to one or more types of viewers including user only or make it private 5941 so only event or gallery or album creator user only can access it 5941 and/or user can provide rights to receive and view event or gallery or album to all or selected one or more contacts, groups or networks 5949 and/or default or pre-set users 5934 and/or all or selected one or more followers of user 5944 and/or participants or members 5943 of event or gallery or album 5903 and/or contacts of participants or members 5945 of event or gallery or album 5903 and/or followers of participants 5946 and/or contacts of contacts of participants 5947 and/or contacts of recognized face inside photo/video 5999 and/or location or place or position (defined geo-fence boundaries) specific 5942 and/or followers of event or created gallery (allow to follow) 5991 and/or one or more target criteria specific target viewers, wherein target viewers criteria comprises age, age range, gender, location, place, education, skills, income range, interest, college, school, company, categories, keywords, and one or more named entities specific and/or provided, selected, applied, updated one or more rules specific users of networks or users of one or more 3^{rd} parties networks, domains, web sites, servers, applications via integrating or accessing Application Programming Interface (API) e.g. view by users situated or dwell only in particular location(s) or defined radius or defined geo-fence boundary specific users or view when system detects one or more types of pre-defined activities, actions, events, status, sense via one or more types of sensor and transaction or user who scan one or more QR codes or object or product or shop or one or more types of pre-define objects or items or entities via camera display screen 5948 and/or user's all or one or more selected contacts and/or networks and/or groups

5949 and/or allow to receive or view by anybody 5950 or allow system to auto determine or auto identify 5954 or auto determine for each posting user's each posted content item specific viewer(s) 5992 whom to send event or gallery or album associate media items.

User can provide presentation settings and duration or scheduled to view said event or gallery or album including enabling viewers to view during start and end of event or gallery or album period 5955, user can view anytime 5966, user can view based on one or more rules 5968 including particular one or more dates and associate time or ranges of date and time. User can select auto determined option 5967, so system can determine when to send or broadcast or present one or more content(s) or media item(s) related to event or gallery or album e.g. event or gallery or album 5903. In another embodiment enable user to set to notify target viewers or recipients 5956 as and when media item(s) related to event or gallery or album e.g. event or gallery or album 903 shared by user or participant one or more members of event or gallery or album. In an embodiment enable user to set view or display duration with event or gallery or album or one or more or each media item(s) related to event or gallery or album 5958, so recipients or viewers can view only said set period of duration only and in the event of expiration of said set period of time remove or hide from recipient(s) or viewer(s) device and/or server and/or user's device. Use can also enable to allow target viewer(s) to view set particular times only for/within set particular period of duration only 5959. Use can also enable to allow target viewer(s) to view unlimited times for/within set particular period of duration only 5962. User can also set to auto post each media item(s) to selected or set target viewers or auto determined target viewer(s) or recipient(s) or destination(s) 5969 or user can set to ask each time to user to post or send or share or broadcast or present to target recipient(s) or viewer(s) media item(s) 5970.

User is enabled to manage and view list of one or more events or galleries or albums or feeds or stories or folders 5990 including remove one or more selected events or galleries or albums or feeds or stories or folders and update particular selected story and associated configuration settings, privacy settings and preferences including add members, remove members, invite members, change target viewers or criteria of viewership and change view duration & presentation settings. User is enabled to add or create one or more events or galleries or albums or feeds or stories or folders 5980. User is enabled to save or update 5982 or save as draft 5989 one or more events or galleries or albums or feeds or stories or folders (in an embodiment processes and save at user device's 200 local storage medium and/or processes and save at server 110 via server module 179 or process and/or save or store at one or more 3^{rd} parties one or more servers, applications, storage mediums, databases & devices via one or more types of one or more web services, APIs, SDKs, communication interfaces & networks). User can share or publish created story to/with one or more participant members of event or gallery or album 5984 or auto share or publish in the event of creating event or gallery or album or story or feed or folder, so participant can become members of event or gallery or album and capture, record, select and add or post or share or send or store one or more media item(s) to said event or gallery or album, can remove membership from event or gallery or album, request to become admin of event or gallery or album.

In an another embodiment event or gallery or album creator user can allow one or more or all participants or one or more admin of event or gallery or album to pause the event or gallery or album e.g. event or gallery or album 5903 and/or stop the event or gallery or album 5903 and/or remove the event or gallery or album 5903 and/or invite or add members to event or gallery or album and/or change confirmation settings of event or gallery or album (not shown in FIG. 59).

In an another embodiment enabling to any participant members to pause or re-start event or gallery or album 5903 for stop to receiving notifications up-to re-start and adding or updating media item(s) to event or gallery or album.

In an embodiment auto pause event or gallery or album to receive notifications or indications based on pre-defined or determined events or triggers, for example when phone is busy in phone call or do not disturb apply by user and when user feel disturbed or obstructed.

After creation and configuration of event or gallery or album or story or feed or folder, user is enable to manually start 5915 event or gallery or album 5903 or auto start as per pre-set schedule 5902. User is enable to pause 5917 particular selected story e.g. event or gallery or album 5903, in the event of pausing of event or gallery or album e.g. event or gallery or album 5903, system stops user or admin user and participant members to capturing and posting one or more content items or visual media items to event or gallery or album e.g. event or gallery or album 5903. In the event of stop or done or end 5916 by user or authorized user, system stops capturing and adding or posting of further any media item(s) to/at event or gallery or album, change in event or gallery or album configuration including adding or removing members and like for creator user or admin user(s) or any participant members of event or gallery or album up-to event or gallery or album re-start 5915 by creator of event or gallery or album user or authorized user. In the event of removal 5918 of event or gallery or album by user or authorized user(s), based on settings, system removes event or gallery or album from server and/or creator user device and/or all participant members' device(s) and/or viewer device(s) of event or gallery or album e.g. event or gallery or album 5903.

In another embodiment user or authorized user or participant or posting users is are enabled to provide real-time commentary 5901 on user posted or posted by other members related visual media items or provide instruction where, when, how, why to capture and who capture what, at what time what is agenda or sub-events.

In another embodiment creator user or admin(s) user is/are enabled to block 5919 one or more participant members.

In another embodiment advertisers are enabled to create one or more events or galleries or stories or feeds or folders or stories related to brands, products, services and entities including companies for enabling target participant criteria specific users to post content items to said created one or more events or galleries or stories or feeds or folders or stories and enabling target viewers to view said posted content items related to one or more events or galleries or stories or feeds or folders or stories.

In another embodiment participant members can post to authorized one or more events or galleries or stories or feeds or folders or stories as well as one or more types of one or more destination(s) pre-set by creator or admin user(s) 5995 or selected one or more types of one or more destination(s) by creator or admin user(s) from suggested list 5996 or set as auto determined one or more types of one or more destination(s) by creator or admin user(s) 5997, wherein one or more types of one or more destination(s) comprises one or more web sites, applications, servers, storage mediums or databases, devices, networks and web services via one or more types of communication interfaces or application programming language (API).

In another embodiment server can create events or galleries or stories or feeds or folders or stories related to categories, hashtags, trends, keywords, events for enabling users or particular pre-defined types of users of network as per target participants criteria to search, match, select, select from directories, select from auto suggested or auto matched lists or auto presented contextual lists one or more events or galleries or stories or feeds or folders or stories or visual media capture controller controls or labels related to said events or galleries or stories or feeds or folders or stories for capturing photos, recording videos, preparing visual media and sharing or sending or adding or storing or saving or posting to said one or more events or galleries or stories or feeds or folders or stories.

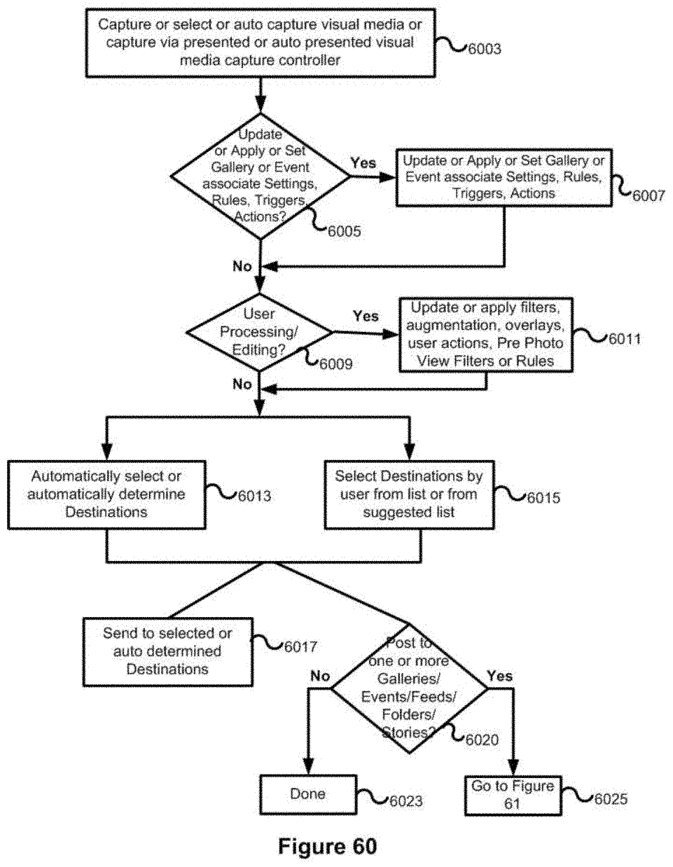

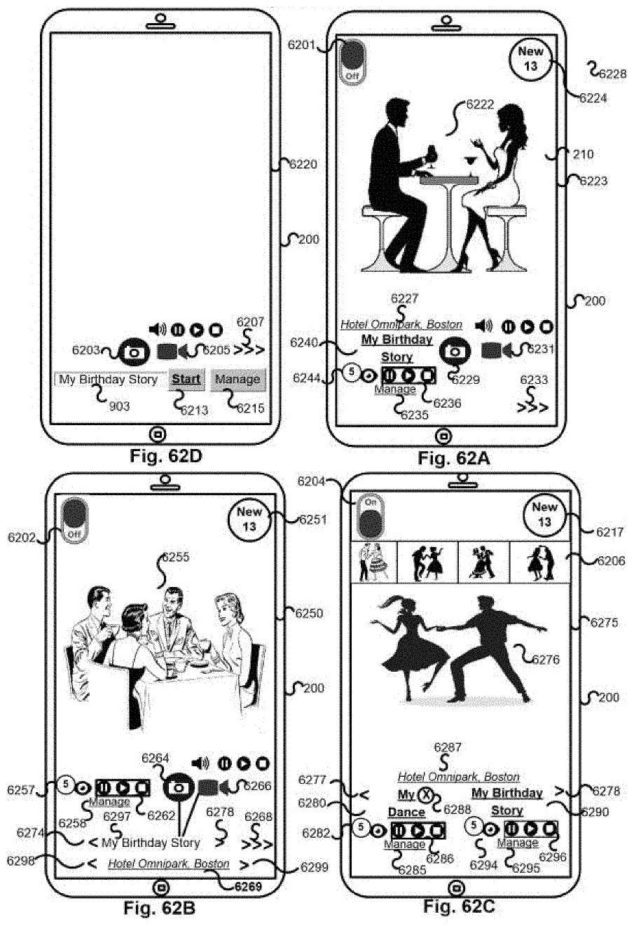

FIG. 60 illustrates processing operations associated with the intelligent message controller including real-time or non-real-time presenting of ephemeral or non-ephemeral 275. Initially, a message including ephemeral message or non-ephemeral message is captured 6003 via camera photo capture icon or video record icon or presented multi-tasking visual media capture controller control(s) or label(s) and/or icon(s) or image(s). E.g. FIG. 62 (A) illustrates electronic device 200 and touch display 210 with a photo 6222 operative as an ephemeral message or a non-ephemeral message based on settings.

The next processing operation of FIG. 60 is to determine whether to alter or set or apply or select one or more rules and settings for one or more destination(s) or recipient(s) or contact(s) (as discuss in FIG. 7) including a timer or a message duration parameter. E.g. FIG. 7 (748) illustrates an example of indicia 302 of a message duration parameter. In this example, the indicia indicate a default of 10 seconds as the message duration parameter. If the indicia is engaged (e.g., through haptic contact), then a prompt may be supplied for a new message duration parameter (e.g., 10 seconds). Such activity (6005—Yes) results in the acceptance of the new timer value 6007. If a new timer value is specified or no alteration of a timer (6005—No) control proceeds to block 6009. The user may be prompted to augment or edit or update the ephemeral message including apply one or more photo filters and edit tools, add text, add one or more types of one or more selected or selected from suggested overlays 6011.

The next operation of FIG. 602 is to accept destinations 6015 or auto select or auto determine or select pre-set default destination(s) 6013. As more fully described below, a destination may be used to identify intended recipients of a message or a location or “gallery” where one or more messages may be accessed. FIG. 62 (A) illustrates an icon 6233 to invoke a destination list. Haptic contact on the icon may result in a displaying a destination list. The destination list may include a destination of one or more contextual or auto presented or opted events, galleries, stories, albums, folders (as discussed in FIG. 59-64), where particular event or gallery e.g. 5903 is a reference to an ephemeral gallery of ephemeral messages and/or a non-ephemeral gallery of non-ephemeral messages based on sender's (as discussed in FIG. 7) or receiver's (as discussed in FIG. 8) settings. The destination list may also include a friends or contacts listing various friends that may be message including ephemeral message or non-ephemeral message recipients. Haptic contact with a box associated with a listed individual or events or galleries or feeds or stories places the corresponding individual or events or galleries or feeds or stories on a destination list.

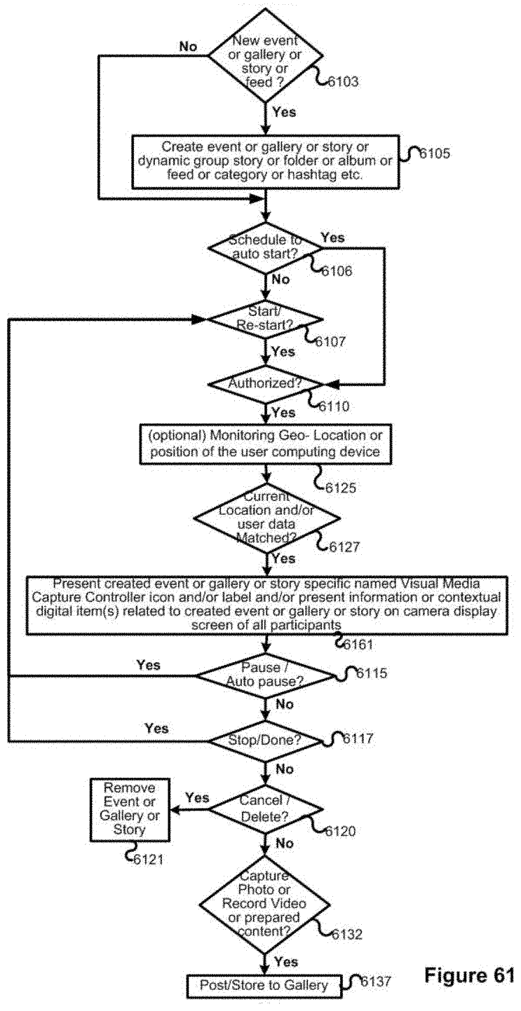

Returning to FIG. 60, after the destination list is specified, the ephemeral message or non-ephemeral message is sent to the specified destinations 6233 or visual media capture controller control e.g. 6229 or 6280 or 6290 associated contact(s) or destination(s) or pre-set default destination(s). For example, the ephemeral message is sent to one or more contacts selected from list of presented contacts, if any. A check is also made to determine whether the message should be posted to an ephemeral gallery and/or non-ephemeral gallery 6020. If not (6020—No), processing is completed. If so (6020—Yes), the processing of FIG. 61 is performed 6025. Thus, it is possible to send a message to one or more contacts and/or post to an ephemeral gallery and/or non-ephemeral gallery.

FIG. 61 illustrates a computer-implemented event or gallery or album method in accordance with the disclosed architecture. At 6103, if new event or gallery or album or gallery e.g. 5903 then at 6105 create event or gallery or album or gallery (in an embodiment processes and save at user device's 200 local storage medium and/or processes and save at server 110 via server module 179 or process and/or save or store at one or more 3^{rd} parties one or more servers, applications, storage mediums, databases & devices via one or more types of one or more web services, APIs, SDKs, communication interfaces & networks) and if not or already exists then based on setting 5902 auto start as per pre-defined scheduled 6106 by creator or admin(s) of event or gallery e.g. 5903 or enable event or gallery or album or gallery creator user or authorized user(s) to manually start or re-start 6107 event or gallery or album system for all participant members or start by member for his own purpose for said created event or gallery or album e.g. 5903 via e.g. clicking or tapping on “start” button 5915 or 6213 or 6236 or 6262 or 6286. At 6110 based on determination of authorized user or participant members based on defined participant or invitation accepted participant or target criteria specific participants (as discuss in FIG. 59), at 6125 optionally system monitors geo-location position of computing device of participant member and at 6127 based on pre-defined event's location, system matches event's location with nearest identified or monitored current location of user device of participant member and/or matches information about and settings of event e.g. 5903 (as describe in FIG. 59) with one or more types of user data including user profile (fields and associated values e.g. gender, age, education, skills, related entities etc.), logged activities, actions, events, transactions, checked-in places, status, senses, behavior & like and based on that present said created event or gallery or album specific named Visual Media Capture Controller control or icon and/or label or contextual one or more Visual Media Capture Controller controls or icons and/or labels 6161 (e.g. 6229 or 6264 or 6280 or 6290) on display e.g. e.g. 6223 or 6250 or 6275 at device(s) e.g. 200/140 of all participant members of event or gallery or album e.g. 5903 and/or present information or one or more contextual or associated digital items e.g. 6227 or 6269 or 6287 related to created gallery or story e.g. 5903 on camera display screen e.g. 6223 or 6250 or 6275 at user device 200/140. At 6115 check is made whether event or gallery or album or gallery creator user or authorized user(s) paused the event or gallery or album e.g. 5903 for all participant members or pause by member for his own purpose or system auto paused the event or gallery or album e.g. 5903, if pause or auto pause (6115=Yes) then start when event or gallery or album or gallery creator user or authorized user(s) starts 6107 event or gallery or album system for all participant members or start by member for his own purpose for said created event or gallery or album e.g. 5903 via e.g. clicking or tapping on “start” button 5915 or 6236 or 6262 or 6286. If not paused at (6115=No), then check is made that event or gallery or album or gallery creator user or authorized user stopped the event or gallery or album e.g. 5903 then if stop (6117=Yes) then hide the visual media capture controller from all participant members or if stop by member then hide the visual media capture controller from member device's display. If stop (6117=No) then at 6120 check is made whether event or gallery or album or gallery creator user or authorized user(s) removed the event or gallery or album e.g. 5903, if (6120=Yes) then remove the event or gallery or album e.g. 5903 from all participant members 6121 or if member remove (6120=Yes) the event or gallery or album or gallery e.g. 5903 then remove event or gallery or album e.g. 5903 from member's device. If at 1020 event or gallery or album e.g. 5903 not removed (6120=No) then at 6132 check is made whether user one tap or haptic contact engagement on visual media capture controller control or icon and/or label to take visual media including photo or video, preview for pre-set duration, then auto send or post and save 6137 at server 110 to said visual media capture controller control or label associated one or more destination(s) including said created event or gallery or story or feed or album or folder 5903 (6135) at server 110 or enable to prepare or edit one or more content item or augment visual media item(s) or one or more types of post and manually post or send to selected one or more destinations including contacts and/or groups and/or said created event or gallery or story or feed or album or folder 5903 (6137).

FIG. 62 illustrates exemplary graphical user interface(s) for providing or explaining event or gallery or album system. At 903 user can provide title or name of event or gallery or album e.g. “My Birthday Story” and tap or click on “Start” button or icon or link or accessible control 6213 to start preparing or adding event or gallery or album specific one or more types of one or more media item(s) including selected or captured photo(s), selected or recorded video(s) and user generated or provided content item(s). User can configure and manage created story via clicking or tapping on “Manage” icon or label or button or accessible control 6215 (as discuss in FIGS. 59 and 61). User can input title at 5903 and tap on “start” button 6213 to immediately start event or gallery or album which created, manage and viewed by user only and later user can configure story and invite one or more contacts or groups or followers or one or more types of users of networks and set or apply or update privacy settings for viewers, members and can provide or update presentation settings via clicking or tapping on “Manage” icon or label or button or accessible control 6215 (as discuss in FIGS. 59 and 61).

At 6201, user can ON or OFF system. In an embodiment in the event of creation of event or gallery or album e.g. 5903 user device 200 is auto presented with visual media capture controller label or icon 6240 based on matching event details, metadata, preferences, criteria and rules with user data and/or in the event of monitoring or tracking of user device's geo-location or position 235, system or server matches events locations with current or nearest location of user device and identifies matched event(s) and based on privacy settings and authorization or identification of membership of said matched event system auto presents visual media capture controller control(s) or label(s) and/or icon(s) 6240 or 6229 on each participant members of event, so participant member can tap on said created gallery or event or gallery or album e.g. 5903 specific presented visual media capture controller label or icon e.g. 6240 to take front camera or back camera photo or video, preview for pre-set duration and after expiry of said preview duration auto send said captured visual media to said visual media capture controller associated one or more destination(s) including event or gallery e.g. 5903.

In another embodiment user can access more than one visual media capture controller controls or labels and/or icons e.g. 6280 and 6290. In another embodiment user can remove or skip or ignore or hide or close said presented visual media capture controller controls or labels and/or icons by tapping on remove or skip or hide icon e.g. 6288 and instruct system to present next available visual media capture controller controls or labels and/or icons based on matching user data with events data and/or matching current or updated geo-location or position information of user device 200 with location information of events. In another embodiment system automatically remove or hide currently presented and present next or new or available or matched one or more visual media capture controller controls or labels and/or icons based on matching updated user data with updated events data and/or matching current or updated geo-location or position information of user device 200 with location information of events.

In an embodiment system enables user to show previous and next one or more visual media capture controller controls or labels and/or icons for view only and shows current one or more visual media capture controller controls or labels and/or icons for taking associate one or more types of one or more visual media item(s) and posting to associated event or gallery or story or feed or folder. In an embodiment user can tap on default camera photo capture icon e.g. 6229 or video record icon e.g. 6231 to capture photo and send to selected one or more contacts and/or one or more events or stories or galleries or one or more types of feeds via icon 6233 in normal ways. In another embodiment user is enable to pause or re-start or stop 6236 event or gallery or album e.g. 5903 and manage event or gallery or album 6235 (as discuss in FIGS. 59 and 61).

In another example when user checked-in place e.g. “Baristro” then system based on matching user data with advertisement details identifies one or more visual media capture controller controls or labels and/or icons related said brand or posted by advertiser(s) and presents to user contextual one or more visual media capture controller controls or labels and/or icons.

In another presentation user device is presented with started created event or gallery or album or gallery label or name or tile e.g. “My birthday Story” 6297 and associate information e.g. 6269 and enabling user to tap on camera photo capture icon 6264 or record video icon 6266 to capture photo or record video and post said captured photo or recorded video to created event or gallery or album or gallery e.g. 5903. In an another embodiment user is enable to switch to other event or gallery or album via previous event or gallery or album icon 6274 or next event or gallery or album icon 6278. In another embodiment user is enable to view number of views 6257 or 6244 or 6282 by viewers of shared media item(s) or content item(s) by user. In an another embodiment user can view, user or skip presented more than one nearest or next prospective or contextual or identified or presented visual media capture controller controls or labels and/or icons via tapping on previous icon 6298/6274 or next icon 6299/6278. Ina n another embodiment user can view newly received number of media item(s) 6251 shared by other participant members of event or gallery or album e.g. 5903. In an another embodiment when user pause via 6262 (pause icon) event or gallery or album e.g. 5903 then user is enable to take normal photo or video via camera icons 6264 or 6266 and send to selected contact(s) and/or group(s) and/or my story and/or our story via icon 6268.

In another example, In another embodiment use is presented with more than one visual media capture controller(s) or menu item(s) e.g. 6280 and 6290 related to more than one created events or galleries or albums or feeds or stories or folders and display information about current contextual identified event or story specific information e.g. 6287 and enable to capture photo or record video (one tap) or record video (hold on label to start and release label when finish video) and add to selected or clicked or tapped visual media capture controller label or icon e.g. 6280 or 6290 specific or related event or gallery or album. User is enable to pause, restart, and stop event or gallery or album or gallery 6280 via icon 6286 and manage via 6285 (as discuss in FIGS. 59 and 61) and view number of views on shared media item(s) indictor 6282 or pause, restart, and stop event or gallery or album or gallery 6290 via icon 6296 and manage via 6295 (as discuss in FIGS. 59 and 61) and view number of views on shared media item(s) indictor 6294. User is enabling to skip or hide or remove or instruct to present next nearest or next prospective events or stories via icon 6288.

In an embodiment user is enable to view statistics including view number of visual media item(s) or content item(s) created or shared or add to event or gallery or album by user and participant member(s) (if any), number of views and reactions on each or all visual media item(s) or content item(s) created or shared or ads to event or gallery or album by user and each participant member(s) (if any), number of total media item(s) in particular event or gallery or album or all events or galleries or albums or feeds or stories or folders and like.

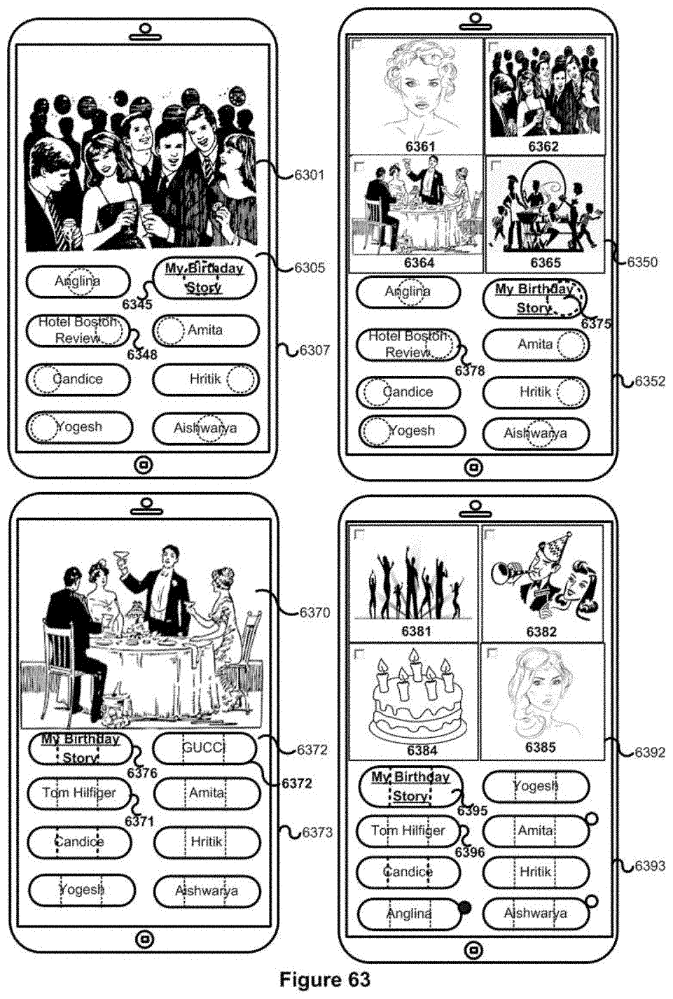

FIG. 63 illustrates multi-tasking visual media capture controller control(s) or label(s) and/or icon(s) 6305 (discussed in detail in FIGS. 43-52), In an embodiment system presents one or more multi-tasking visual media capture controller controls or labels and/or icons based on matching user data and/or connected users' data including user profile (fields and associated values), logged or stored or current user activities, actions, events, transactions, locations, checked-in places, status, reactions including comments, likes, dislikes, ratings etc., connections or nearest connections, communications, collaborations, interactions, posted or shared data, user senses via one or more sensors including voice sensors, image sensors, GPS sensors, touch controller or hove sensors & other types of sensors, behavior & participations with events data and selecting, applying & executing one or more rules or updated rules from rule base e.g. 6348 or 6371 (based on birthday party location or check-in by user or participant members) or 6372 (based on recognition of object (by employing object recognition technologies) or object text (by employing optical character recognition technologies) inside captured visual media items including photos or videos by user or participant members or connected users of user and identification of logo or brand name on user's or connected users or participant members' cloths or accessories) and/or matching current or updated geo-location or position information of user device 200 with location information of events e.g. 6345 or 6376. So user can take front camera or back camera photo or video e.g. 6301 or 6371 and auto send to said multi-tasking visual media capture controller control or label and/or icon associated event e.g. 5903 and/or contact(s) and/or group(s) and/or one or more feed(s) and/or one or more types of one or more destination(s) and can view received visual media items 6350 or 6392 via 6375 or 6395 from one or more senders or sources or participant members of event(s).

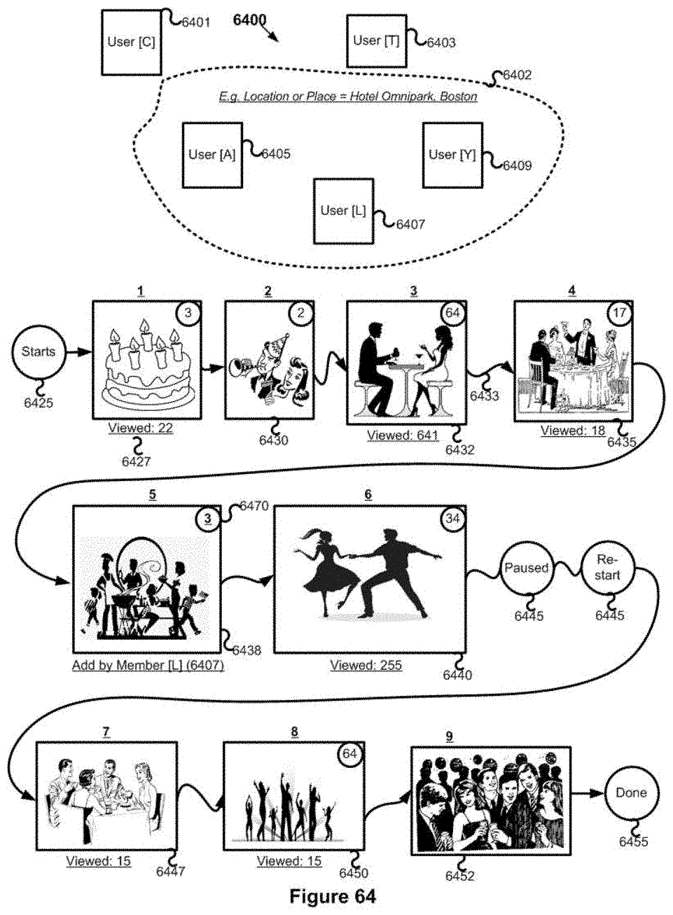

FIG. 64 illustrates logical flow and example of event or gallery or album e.g. event or gallery or album 5903. At 6425 when creator of rich tory or authorized user starts event or gallery or album e.g. 5903 via “Start” icon 6213 or 5915 or 6106 or 6107 then system presents visual media capture controller control or label and/or icon (e.g. named same as event or gallery or album title or customized or updated name provided by admin) e.g. “My Birthday Story” 6240. At 6427 when use device 200 of user [A] 6405 or user [L] 6407 or user [Y] 6409 arrives within or near to particular radius boundary or reach near to pre-defined geo-fence boundaries or system determine that user reach near to location of event (e.g. 6402—Hotel Omnipark, Boston) and/or scheduled date & time 5913 of event e.g. 5903 or manually start by creator or authorized user(s) date & time 5915 matched with user's arriving date & time, in the event of matching of location and event date & time then user is presented with said current event 5903 specific visual media capture controller control(s) or icon(s) and/or label(s) e.g. 6240 or 6229 or 6231 or 6264 or 6266 or 6280 or 6290 and information about said event 6227 or 6269 or 6287 including place name, location information, place details, event details, event organizer, event participant members, agenda, plans, speakers, food menu, programs etc. from information provided by event creators or admin(s) or participant members or one or more sources or curated information based on event location or event information 5903 and

For example when user [A] 6405 reaches at event 5903 location (e.g. “Hotel Omnipark, Boston”) then user is presented with 1201 and user [A] 6405 is presented with visual media capture controller control or label and/or icon or image 6240 or 6345 or 6375 or 6376 or 6395 and event name and details 6227 or 6269 or 6287 and when user tap or access as per (discussed in detail in FIGS. 43-52) on multi-tasking visual media capture controller control or label and/or icon or image to take visual media then pre-set duration of auto preview of visual media is presented to user and in the event of expiration of preview duration for enabling user to cancel or remove or save locally & stop posting or review or add or change destination(s), in the event of no user action, system auto sends said captured front or back camera photo or recorded front or back camera video to said visual media capture controller control or label and/or icon or image e.g. 6240 associated event or story or album or folder e.g. 5903 at server 110 where said shared or sent or posted visual media saved to event or gallery or album or folder e.g. 5903 at local storage of user device 200 and/or storage medium of server 110 or database 115 and/or 3^{rd} parties one or more web sites, web pages, feeds, stories, applications, interfaces, storage mediums, servers, devices, and database or cloud storage. In an embodiment user can view, search, browse, select, edit, update, augment, apply photo filters or lenses or overlays, provide details, remove, sort, filter, drag and drop, order, rank one or more media items of selected event or gallery or album e.g. 5903 gallery or album or folder. For example user can views captured photo 6427 at event 5903. In an embodiment user can also view other details related to said captured photo or media item including date & time, location, metadata, auto identified keywords based on auto recognized objects associated keywords, file type, size, resolution and like, view statistics including number of receivers, viewers or views, likes, comments, dislikes and ratings, event related information and based on recognized object(s) inside photo(s) or video(s) taken at event 5903 location, identify similar photos and videos, so user can compare and view and determine quality of his captured photo or video.

In an embodiment if event or gallery or album has more than one member i.e. other than creator of event or gallery or album user, then user or authorized participant or members can view photos or videos posted by participant members or related to event e.g. 5903. User can filter, search, match and select one or more events or galleries including filter one or more selected participant member(s) wise and/or filter one or more keyword(s) or tag(s) wise and/or filter as per date & time or ranges of date & time and/or view chronologically and/or view as per one or more object keywords, object model(s) or image sample(s) specific and/or one or more keywords, key phrases, Boolean operators and any combination thereof specific media items related to one or more selected galleries.

In an embodiment user can tap on photo 1240 to sequence wise view all shared media item(s) by all participant members of event 5903 as per set period of interval between presented media items. In the event of pause 6445 of event or gallery or album 9503 by user or authorized user(s) of user device 200, then system hide event specific visual media capture controller e.g. 6420 or 6345 or 6376 from devices or applications of all participant members of event or gallery or album 5309. If member of event or gallery or album 5903 pauses 1245 the event or gallery or album 903 then system hide event specific visual media capture controller e.g. 6420 or 6345 or 6376 from device of said member only. User can view various status of user and/or participant members at event or gallery or album e.g. 5903 interfaces e.g. 6400. User can restart 6445 paused 6445 event or gallery or album e.g. 5903 via e.g. tap on icon or button or accessible control 5915 or 6236 (play icon) or 6297 (play icon). After re-starts, system again show event specific visual media capture controller e.g. 6420 or 6345 or 6376 at devices or applications of all participant members of event or gallery or album 5309.

Event or gallery or album 5903 creator or authorized user (if any) can stop event or gallery or album 5903 via e.g. button 5916 or icon 6236 (stop icon) or 6262 (stop icon), in the event of stopping of event or gallery or album e.g. 5903, system hides or removes event or gallery or album e.g. 5903 related visual media capture controller control or label and/or icon e.g. 6240 or 6345 or 6376 and hide or removes any information about current event e.g. 6227 or 6269 from devices or interfaces or applications or displays of all participant members of event or gallery or album 5903 to prevent them to capture and post any visual media at event 5903. Event or gallery or album 5903 creator or authorized user (if any) can re-start event or gallery or album 5903 via e.g. button 5915 or 6236 (play icon) or 6262 (play icon), in the event of re-starting of event or gallery or album e.g. 5903, system presents event or gallery or album 5903 specific labeled visual media capture controller label or icon 6240 or 6345 or 6376 on display or applications or interfaces or devices of all participant members.

In another embodiment one or more types of presentation interface is used for viewers selections or preferences including present newly shared or updated received media item(s) related to one or more stories or sources in slide show format, visual format, ephemeral format, show on feeds or albums or gallery format or interface, sequence of media items with interval of display timer duration, show filtered media item(s) including filter story(ies) wise, user(s) or source(s) wise, date & time wise, date & time range(s) wise, location(s) or place(s) or position(s) or POI(s) specific and any combination thereof, show push notification associate media item(s) only.

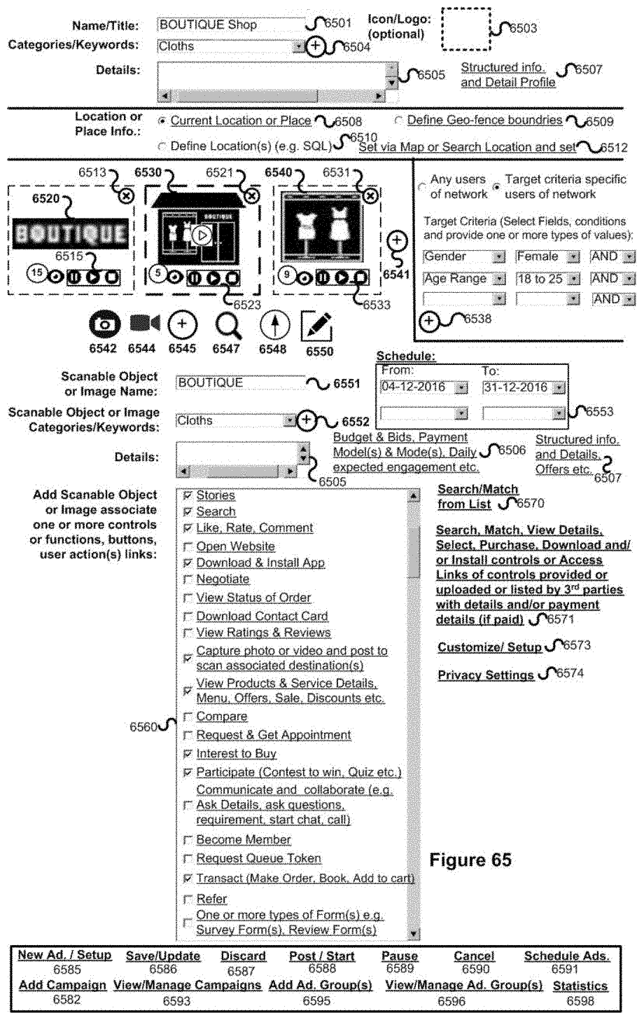

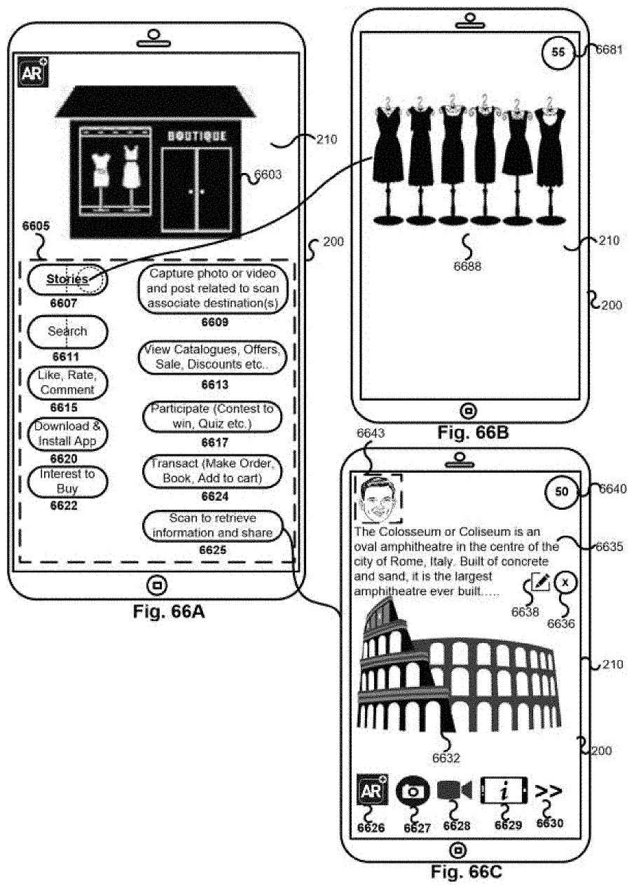

FIGS. 65-66 illustrates augmented reality platform, augmented reality applications, functions, controls, web services, objects, interfaces and app store, app search engine 180 and client application 280 for users of network, advertisers and developers wherein developers can create platform account, provide profile details, make verification or validation, create paid or free account, develop, configure, upload and list and provide or associate details & metadata including description, developer profile & details, version information, creation or upload or listing or updated date & time, listing video and images, product or company or developer's logo, required permissions, content rating, language(s), information about compatible devices, license agreement, support details, category an keywords or tags, price (free, paid, sponsored, advertised based, transaction based, subscription model & like), in-app products & associate details and prices or price models, access, integration, customization, configuration, setup documentation & help and upload file or package of augmented reality applications, functions, controls (e.g. button), web services, objects, interfaces and any combination thereof which developers wants to list or making them searchable and available for users of network and advertisers. Server 110 receives said uploaded files, details, metadata or package(s) of augmented reality applications, functions, controls (e.g. button), web services, objects, interfaces and any combination thereof from developers and if payment required then receive payment. After that server verifies said uploaded files, details, metadata or package(s) of augmented reality applications, functions, controls (e.g. button), web services, objects, interfaces and any combination thereof received from each developer. After verification server 110 lists said uploaded files, details, metadata or package(s) of augmented reality applications, functions, controls (e.g. button), web services, objects, interfaces and any combination thereof from developers and enable users or searching users or advertisers or viewers to search said augmented reality applications, functions, controls (e.g. button), web services, objects, interfaces and any combination thereof from plurality of developers. Searching user can search based on search query including keywords, Boolean operators, select advance search options including search developer name, company name & product name specific, device compatibility specific, category specific, price specific (free, paid, sponsored, advertised based & like) uploaded or listed date & time specific, rating specific, language(s) specific augmented reality applications, functions, controls (e.g. button), web services, objects, interfaces and any combination thereof. Based on search query, keywords, advance search option selections, and criteria, Boolean operators, conditions and rules, server 110 searches and matches augmented reality applications, functions, controls (e.g. button), web services, objects, interfaces and any combination thereof and presents search results to searching user or requestor or viewer. In another embodiment server 110 auto suggest, provide and auto present lists of or one or more augmented reality applications, functions, controls (e.g. button), web services, objects, interfaces and any combination thereof based on based on matching details of augmented reality applications, functions, controls (e.g. button), web services, objects, interfaces provided by developers or auto generated ant stored at server 110 (including ratings, reviews, number of likes, dislikes, added to wish lists, engagements or access for particular number of times or duration at one or more locations, amount of payments, number of downloads or installs, report as spam or inappropriate) with one or more types of user data and/or connected users data including user profile (fields & associated values including age, gender, qualification, skills, income range, interests, preferences, privacy settings, interacted entities and associated details including school, college, company, organization, home & work address), current location of user or user device(s), logged or stored current or past user's activities, actions, users senses, behavior, interactions, communications, collaborations, sharing, participations, connections or contacts, events, transactions, locations based on checked-in place, monitoring of user device locations based on GPS sensor of user device, one or more types of sensor(s) of user device(s), user status (online or offline) or manually status provided by user (e.g. “I am available” or “I am at class” or “I am watching movie” etc. indicating user's activities, actions, events, transactions), sharing of one or more types of contents, provided user reactions including ratings, comments or reviews or feedback, likes or dislikes, provide or fill-up one or more types of structured data including one or more types of or customized or contextual survey forms or profile forms or fields for fill-up associated values), installed or used or accessed augmented reality applications, functions, controls (e.g. button), web services, objects, interfaces and 3^{rd} parties provided details via application programming language (API) or web services or one or more communication interfaces and auto suggest or presents matched augmented reality applications, functions, controls (e.g. button), web services, objects, interfaces at user device or user interface.

System Architecture

FIG. 1 is a network diagram depicting a network system 100 having a client-server architecture configured for exchanging data over a network, according to one embodiment. For example, the network system 100 may be an augmented reality system where clients may communicate and exchange data within the network system 100. The data may pertain to various functions (e.g., sending and receiving scanned image or captured photo or recorded video visual media or one or more types of content items including text and photo communication, determining geolocation) and aspects (e.g., publication of augmented reality applications, functions, controls (e.g. button), web services, objects, interfaces and any combination, management of augmented reality applications, functions, controls (e.g. button), web services, objects, interfaces and any combination) associated with the network system 100 and its users. Although illustrated herein as client-server architecture, other embodiments may include other network architectures, such as peer-to-peer or distributed network environments.

A data exchange platform, in an example, includes an augmented reality application 110, and may provide server-side functionality via a network 125 (e.g., the Internet) to one or more clients (e.g. 200/130/135/140). Although described as residing on a server in some embodiments, in other embodiments some or all of the functions of augmented reality application 110 may be provided by a client device. The one or more clients may include users that use the network system 100 and, more specifically, the augmented reality application 110, to exchange data over the network 125. These operations may include transmitting, receiving (communicating), and processing data to, from, and regarding content and users of the network system 100. The data may include, but is not limited to, content and user data such as user profiles, logged activities, actions, events, transactions, behavior, senses, interactions, sharing, participations, auto or manually provided status, communications, collaborations, sharing, viewing, searching, sending or receiving of visual media or one or more types of contents including messaging content and associated metadata & system data, client device information, geolocation information, augmented reality applications, functions, controls (e.g. button), web services, objects, interfaces and configuration data, object recognition data, publication criteria including target criteria, target location criteria, schedules of presentation, associated data and object criteria for recognized objects in a scanned view or scanned object or scanned scene or photo or video, among others.

In various embodiments, the data exchanges within the network system 100 may be dependent upon user-selected functions available through one or more client or user interfaces (UIs). The UIs may be associated with a client machine, such as client devices 200, 130, 135, 140 using a programmatic client 280, such as a client application. The programmatic client 280 may be in communication with the augmented reality application 180 via an application server 199. The client devices 200, 130, 135, 140 include mobile devices with wireless communication components, and audio and optical components for scanning or capturing or recording various forms of visual media including scanned object or scanned image or scanned scene or photos and videos (e.g., photo application 263).

Turning specifically to the augmented reality application 180, an application program interface (API) server 197 is coupled to, and provides programmatic interface to one or more application server(s) 199. The application server 199 hosts the augmented reality application 180. The application server 199 is, in turn, shown to be coupled to one or more database servers 198 that facilitate access to one or more databases 115.

The API server 197 communicates and receives data pertaining to messages and augmented reality applications, functions, controls (e.g. button), web services, objects, interfaces, among other things, via various user input tools. For example, the API server 197 may send and receive data to and from an application (e.g., via the programmatic client 200) running on another client machine (e.g., client devices 130, 135, 140 or a third party server, web site, application, device, network, storage medium).

In one example embodiment, the augmented reality application 180 provides a system and a method for operating and publishing augmented reality applications, functions, controls (e.g. button), web services, objects, interfaces for distribution based on user scanned object or scanned view or captured photo or video (image(s) of video) matching with object criteria of advertisers or publishers and/or matching of current monitored location of user device matched with location criteria of advertisement provided by advertiser or publisher or user and/or matching user device date & time matched with publication schedules associated with advertiser or publication and/or matching of target criteria with user data including user profile (fields and associated values) via augmented reality application 180. The augmented reality application 180 supplies an augmented reality application, function, control (e.g. button), web service, object, interface to the client device e.g. 200 based on a recognized object in a scanned view or photo or video taken with the client device 200 (263) satisfying specified object criteria and/or matching of current monitored location of user device matched with location criteria of advertisement provided by advertiser or publisher or user and/or matching user device date & time matched with publication schedules associated with advertiser or publication and/or matching of target criteria with user data including user profile (fields and associated values). In another example, the augmented reality application 180 supplies an augmented reality application, function, control (e.g. button), web service, object, interface to the client device 200 based on the augmented reality application, function, control (e.g. button), web service, object, interface being associated with a maximum bid from an advertiser who created or configured or associated the augmented reality application, function, control (e.g. button), web service, object, interface with advertisement or publication. In other example embodiments, augmented reality applications, functions, controls (e.g. button), web services, objects, interfaces and any combination thereof from advertisers or publishers may be provided on one or more payment models and modes including pay per view, pay per presentation, pay per access or pay per one or more types of one or more access or activities or user actions or transactions, subscription or a fix fee or customized fees (e.g., an advertisers agrees to pay a fixed amount for the presentation of augmented reality applications, functions, controls (e.g. button), web services, objects, interfaces, or the like.

The augmented reality application, function, control (e.g. button), web service, object, interface may include video or audio and visual content and visual effects. Examples of audio and visual content include videos, presentation, pictures, texts, logos, animations, and sound effects. The audio and visual content or the visual effects can be shown on scanned object or inside camera view at the display 210 of client device 200. For example, the augmented reality application, function, control (e.g. button), web service, object, interface may include text that can be shown on dynamically tracked object(s) inside camera view or scanned view or scan scene or overlaid on top of a photo or video taken by the client device 200. In other examples, the augmented reality application, function, control (e.g. button), web service, object, interface may include visual media, presentation, information about particular advertised product(s) or physical establishment(s) e.g. shop, college, school, showroom, mall, garden, forest, museum, tourist place, club, restaurant, hotel, vehicle, road, station & like associated with a location, an advertiser, a seller, a brand, a person, etc. For example, in regard to an advertiser, the augmented reality application, function, control (e.g. button), web service, object, interface may include visual media or contents, like button, products catalogues or menu or list of provided services, review, information about offers & discounts, one or more participation and transaction applications to participate in contest, send photo to particular destination(s), buy or add to cart or order product(s), download application, subscribe service(s), survey form and like.

The augmented reality applications, functions, controls (e.g. button), web services, objects, interfaces may be stored in the database(s) or storage medium 115 and accessed through the database server 198 or stored in the or access through the one or more 3^{rd} parties or developers servers, storage mediums, cloud resources, devices, networks, applications via one or more web services and application programming language (APIs) and software development toolkit (SDKs).

The augmented reality application 180 includes a augmented reality application, function, control (e.g. button), web service, object, interface publication module that selects or enable to access or configure or generates or provide augmented reality applications, functions, controls (e.g. button), web services, objects, interfaces and any combination thereof based on request, identification of user device current location, date & time, user data & scanned object or scanned image or scanned view or scene or captured photo or recorded video (image(s) of video), selections, subscription, voice command, one or more types of user senses via user device sensors, match based on user preferences, search and configuration data associated with the satisfaction of specified object criteria by objects recognized in a photograph taken by the client device 110. An augmented reality application, function, control (e.g. button), web service, object, interface may be generated based on supplied configuration data that may include parameters, settings, preferences, data, wizard based setup related data, one or more types of contents & data that can be applied to generate customized augmented reality application, function, control (e.g. button), web service, object, interface. The augmented reality application, function, control (e.g. button), web service, object, interface publication module may itself include a user-based augmented reality application, function, control (e.g. button), web service, object, interface publication module and an advertiser-based augmented reality application, function, control (e.g. button), web service, object, interface publication module

In one example embodiment, the augmented reality application 180 includes a user-based publication module that enables users to upload configuration data for generating a augmented reality application, function, control (e.g. button), web service, object, interface or select one or more augmented reality application, function, control (e.g. button), web service, object, interface from list or search, match, select, purchase and associate one or more augmented reality applications, functions, controls (e.g. button), web services, objects, interfaces and object criteria for comparing against recognized objects in a scanned object or scanned view or scanned image or photo or video and/or location criteria matched with user device current location and/or target criteria match with user data and/or schedules of publication or presentation or availability match with user device current date & time. For example, the user may upload contacts and photos of contacts for the creation or customization, configuration and setup of an augment realty application and specify criteria that must be satisfied by a face recognized in the photo in order for the said augmented reality to be made available to a mobile device. Once the user submits the contacts, profile & photos of contacts and specifies the object criteria including face recognition of contacts, the augmented reality application, function, control (e.g. button), web service, object, interface publication module generates a augmented reality application or control (e.g. button) or interface which will available to or presents to contacts of user and in the event of scanning of face of contact, it will display information about user on user face inside profile photo based on recognizing or detection or matching of user's face inside said photo with scanned image.

In another example embodiment, the augmented reality application, function, control (e.g. button), web service, object, interface application 180 includes an advertiser-based publication module that enables advertiser to upload configuration data for generating a augmented reality application, function, control (e.g. button), web service, object, interface or select one or more augmented reality application, function, control (e.g. button), web service, object, interface from list or search, match, select, purchase and associate one or more augmented reality applications, functions, controls (e.g. button), web services, objects, interfaces and object criteria for comparing against recognized objects in a scanned object or scanned view or scanned image or photo or video and/or location criteria matched with user device current location and/or target criteria match with user data and/or schedules of publication or presentation or availability match with user device current date & time, and submit bids for the presentation of a augmented reality application, function, control (e.g. button), web service, object, interface based on the uploaded configuration data based on the satisfaction of the uploaded object criteria by an object recognized in a scanned object or scanned face or scanned view or a photo or a video (image(s) of video) and/or location criteria matched with user device current location and/or target criteria match with user data and/or schedules of publication or presentation or availability match with user device current date & time. A bidding process may be used to determine the advertiser with the highest bid. That advertiser can then exclude publication of augmented reality applications, functions, controls (e.g. button), web services, objects, interfaces from other advertisers (with lower bids) that might otherwise be published based on satisfaction of the uploaded object criteria and/or location criteria and/or target criteria and/or schedules of publication and/or one or more keywords, fields & associated values, taxonomy, ontology, categories, tags, hashtags & like.

FIG. 65 illustrates user interface for enabling user or advertiser to create new augmented reality advertisement 6585 or configure or setup augmented reality related functions, controls (e.g. button), web services, objects, interfaces 6585 including provide location details (input 6510, searched & select location(s) or place(s) from map 6512 or set or select location as current location of user device 6508, provide longitude & latitude information, pre-defined geo-fence boundaries 6509 etc.), provide one or more object criteria including object model(s) or sample image(s) or video(s) including add 6541 (capture photo 6542, record video and/or voice 6544, select photo or video and/or voice 6545, search photo, video, voice, image(s) or object model(s) 6547, edit or update or augment or apply one or more photo filter or overlays on one or more object models including photos, video and/or voice 6550 and add e.g. 6520, 6530 & 6540 or upload 6548) or update or remove 6513/6521/6531 and provide object keyword(s) 6552 and associated metadata 6551, details 6552, structured information (form(s) or fields and associated values) 6507 and other details including name/title 6501 and details of advertisers or products or services 6505, logo or icon 6503, structured information (form(s) or fields and associated values) 6507 and search, match & select from list one or more augmented reality applications, functions, controls (e.g. button), web services, objects, interfaces 6560 and/or search, match, view details, purchase, download or install or access link of one or more augmented reality applications, functions, controls (e.g. button), web services, objects, interfaces from server(s) provided or listed by one or more developers 6571, configure & customize 6573, apply privacy settings & access rights, privileges, polices, terms & conditions 6574, select and associate (6560/6571) one or more augmented reality applications, functions, controls (e.g. button), web services, objects, interfaces provided by 3^{rd} parties developers and/or 3^{rd} parties servers, web sites, storage mediums or cloud storage, networks, devices, applications and access via web services and/or application programming language (API) & software development toolkit (SDK) (6571/6560) and server 110 or created by advertiser or user of network and provide scheduled date & time 6553 and 6538 provide target criteria 1038 including target audience characteristics or types of users of network, including gender type, age range, location(s), place(s), educations, skills, interacted entities type & name including school name & location, college name, company name & location etc., interests, income ranges, structured query language (SQL) or natural query or specific users (e.g. “All users who enters in to all malls of New York”), who can search, select, access or auto presented with said augmented reality applications, functions, controls (e.g. button), web services, objects, interfaces via scanning said provided one or more object(s) or identifying similar type of object(s) matched with said provided object(s) based on object recognition, machine vision and optical character recognition (OCR) technologies or techniques or auto present or show or aloe to access of said advertised augmented reality related one or more contextual augmented reality related functions, controls (e.g. button), web services, objects, interfaces at users' devices based on user data including user profile, activities, actions, events, transactions, current or past locations or checked-in places, status, senses, behavior, communication, collaboration, sharing, reactions (likes, dislikes, comments, ratings etc.), advertisement(s) associated object criteria, schedule(s) and target criteria.

After providing information user or advertiser can save or update 6586 at server 110 via server module 180, save as draft, post or start or make available for server validation or verification and after validation and verification available for users of network 6588, scheduled to start or make available at scheduled date & time or date & time ranges 6591, pause 6589, remove 6587, cancel 6590 said augmented reality advertisement or configured augmented reality related functions, controls (e.g. button), web services, objects, interfaces. Advertiser or user is enabled to create one or more augmented reality advertisements or setups 6585, advertisements or setups groups 6595, add campaigns 6582, view & manage advertisements or setups groups 6596 including associated created one or more advertisements or setups, view & manage campaigns 6593 including associated created advertisements or setups and groups and view, access and analyze statistics and analytics for monitoring and tracking advertisements performance. In another embodiment advertisers can provide bids for auto presenting or showing or accessing of augmented reality related one or more contextual augmented reality related functions, controls (e.g. button), web services, objects, interfaces at users' devices based on user scan, user location, user data, advertisement object criteria, schedule and target criteria.

In one embodiment, in the event of starting of verified said created advertisement (FIG. 65), server 110 monitors and tracks location information of device(s) of user(s) of network (based on GPS sensor of user device) e.g. 200 and matches with said advertisement related location(s) or place(s) or geo-boundaries information (6508, 6510, 6509 & 6512), date & time of user device(s) matches with said advertisement related schedule(s) 6553 and when user of network scans or captures or record particular object e.g. 6603 via device camera or camera display screen of user device then server 110 identifies, matches, recognizes and detects said scanned object or object inside captured photo or video (inside series of images) e.g. 6603 with pre-stored object criteria including object models or sample image(s) or video(s) e.g. 6530 supplied by advertisers with advertisement(s) and matches user data of users whose current location matches with said advertisement related location(s) (6508, 6510, 6509 & 6512), wherein user data including user profile (structured fields and associate values including Demographic Information, Psychographic Information, Behavioral Information & Geographic Information like age, gender, language, marital status, interests, education, skills, height, weight, physical characteristics, work address & company name & location, school name & location, college name & location etc.), activities, actions, events, transactions, current or past locations or checked-in places, status, senses, behavior, communication, collaboration, sharing, reactions (likes, dislikes, comments, ratings etc.) with target criteria 6538 and/or advertiser profile 6506 and/or advertised product or service or place or brand or object or logo or entity (e.g. shop, company etc.) profile 6507 associate with said advertisement and identifies said advertisement related or associated one or more augmented reality applications, functions, controls (e.g. button), web services, objects, interfaces 6560 (selected or checked via check boxes) and present said matched or contextual one or more augmented reality applications, functions, controls (e.g. button), web services, objects, interfaces related to one or more advertisements e.g. 6605 (6607, 6609, 6611, 6613, 6615, 6617, 6620, 6622 & 6624) at user interface 6605 on user display 210 on user device 200 and enabling user to access said one or more presented contextual augmented reality applications, functions, controls (e.g. button), web services, objects, interfaces. For example when user tap on “Stories” button 6607 then system searches, matches, identifies said advertised shop or brand or product 6501 located at said location 6508 related visual media items or visual media items posted with or associated with said advertisement and presents said matched visual media items e.g. 6688 at use interface or display 210 or user device 200. In one embodiment system presents said visual media items e.g. 6688 in sequences one by one based on pre-set interval of time 6681 and advances or present next available (if any) visual media item in the event of expiration of said interval period 6681.

In one embodiment advertiser or user have to provide at least one object model or one location or place information and at least one augmented reality function, control (e.g. button), web service, object, interface & any combination thereof with each posted or verified or started advertisement for starting advertisement.

In one embodiment user is auto presented with camera display screen to scan object or capture photo or record video (as discussed in detail in FIG. 3) or view and access presented one or more augmented reality applications, functions, controls (e.g. button), web services, objects, interfaces.

In one embodiment, in the event of starting of verified said created advertisement (FIG. 65), server 110 monitors and tracks location information of device(s) of user(s) of network (based on GPS sensor of user device) e.g. 200 and matches with said advertisement related location(s) or place(s) or geo-boundaries information (6508, 6510, 6509 & 6512), date & time of user device(s) matches with said advertisement related schedule(s) 6553 and matches user data of users whose current location matches with said advertisement related location(s) (6508, 6510, 6509 & 6512), wherein user data including user profile (structured fields and associate values including Demographic Information, Psychographic Information, Behavioral Information & Geographic Information like age, gender, language, marital status, interests, education, skills, height, weight, physical characteristics, work address & company name & location, school name & location, college name & location etc.), activities, actions, events, transactions, current or past locations or checked-in places, status, senses, behavior, communication, collaboration, sharing, reactions (likes, dislikes, comments, ratings etc.) with target criteria 6538 and/or advertiser profile 6506 and/or advertised product or service or place or brand or object or logo or entity (e.g. shop, company etc.) profile 6507 associate with said advertisement and identifies said advertisement related or associated one or more augmented reality applications, functions, controls (e.g. button), web services, objects, interfaces 6560 (selected or checked via check boxes) and present said matched or contextual one or more augmented reality applications, functions, controls (e.g. button), web services, objects, interfaces related to one or more advertisements e.g. 6605 (6607, 6609, 6611, 6613, 6615, 6617, 6620, 6622 & 6624) at user interface 6605 on user display 210 on user device 200 and enabling user to access said one or more presented contextual augmented reality applications, functions, controls (e.g. button), web services, objects, interfaces. For example when user tap on “Stories” button 6607 then system searches, matches, identifies said advertised shop or brand or product 6501 located at said location 6508 related visual media items or visual media items posted with or associated with said advertisement and presents said matched visual media items e.g. 6688 at use interface or display 210 or user device 200. In one embodiment system presents said visual media items e.g. 6688 in sequences one by one based on pre-set interval of time 6681 and advances or present next available (if any) visual media item in the event of expiration of said interval period 6681.

In another embodiment in the event of change or update in monitored user device's current location, date & time, addition, deletion or updating of one or more types of user data (as discussed throughout the specification), update in posted or started advertisement associated object criteria including object model(s), updates in associated one or more augmented reality applications, functions, controls (e.g. button), web services, objects & interfaces, updates in target criteria & schedules and updates in other one or more types of associated details & metadata then auto add, update, remove, show, hide one or more contextual augmented reality applications, functions, controls (e.g. button), web services, objects, interfaces at user display 210 of user device 200.

In another embodiment enabling user to remove auto presented one or more augmented reality applications, functions, controls (e.g. button), web services, objects & interfaces from display 210 of user device 200. In another embodiment enabling user to manually search, match, select, arrange, drag and drop, bookmark, share, sort, filter, rank, rate, like or dislike, add and remove one or more contextual augmented reality applications, functions, controls (e.g. button), web services, objects & interfaces from user display 210 of user device 200.

In another embodiment advertiser can add more than one object criteria (e.g. 6520, 6530 & 6540) and each said object criteria have same or different target criteria and/or location and/or schedules to present and have same or different augmented reality digital items including applications, functions, controls (e.g. button), web services, objects & interfaces and any combination thereof.

In another embodiment advertiser or user can define target location(s) 6510 including define location(s) via select on map, select from list of locations, places or address or define location based on supplying or creating or defining structured query language (SQL) or natural query or keywords or key phrases, for example “All GUCCI shops of New York”, can be one of a class of locations (e.g., all restaurants, all shopping malls in a five mile radius, etc.) and the contextual one or more augmented reality applications, functions, controls (e.g. button), web services, objects & interfaces is/are presented when the target device meets the geo-location criteria for one location. In other words, a query provided to the system can be “all shopping malls”. Thus, when the target device (as carried by a user) enters any shopping mall, the auto presentation of the one or more contextual or matched augmented reality applications, functions, controls (e.g. button), web services, objects & interfaces are triggered to all matched or intended and approved or object criteria and/or target criteria specific devices.

FIG. 66 illustrates various examples, for example when user tap on button 6609 then it captures photo or records video and auto send to said advertised destination(s) including advertised product or service or place or brand or object or logo or entity (e.g. shop, company etc.) related feed, story, web page, profile, gallery, album, event or send to followers of said advertised product or service or place or brand or object or logo or entity (e.g. shop, company etc.). In another example user can scan object or product and search & view information about it 6611. In another example user can scan object or product and view catalogues, offers, sale, and discounts 6613. In another example user can scan advertised object and can download & install associated application 6620. In another example user can scan advertised object and can participate in contest 6617. In another example user can scan advertised object and can add to with lists 6622. In another example user can scan advertised object or product and can make order, make payment and buy and add to cart product 6624.

In an another embodiment by tapping on augmented sharing button (e.g. 6629 or 6625) to enabling user to capture visual media and/or retrieve and share captured, recorded, selected or camera display screen related viewed scene(s) and/or scanned object(s) and/or code(s) and/or provided voice related one or more types of recognized or identified contents or information from one or more sources based on object recognition technologies (which identifies object(s) related keywords via server module 180 and server module 180 searches, matches said identified keywords specific information from one or more sources including one or more web sites (search engines, social networks), applications, user accounts, user generated or provided contents, servers, databases, devices, networks, advertisers, 3^{rd} parties providers by/via server module 180 of server 110 by tapping on e.g. button 6625 or 6629 of MVMCC control or label and/or image (e.g. 4374). For example when user scans or views “Colosseum, Rome, Italy” via camera display screen or via one or more types of wearable device(s) e.g. eye glasses then, server module 180 recognizes said viewed or scanned or captured image(s) and/or photo(s) and/or video(s) and/or voice(s) and/or code including QRcode and identifies recognized, related, matched and contextual keyword(s) and searches and matches one or more types of contents including web links, blogs, articles, news, tweets, user posted contents like visual media and sends to one or more pre-set contacts and/or groups and/or destinations.

FIG. 66 (C) illustrates augmented reality information retrieving and sharing button 6629. Like photo icon 6627 for taking photo, video icon 6628 for recording video, now user is able to capture or scan view or scene or particular object and send said scanned, captured, selected, recorded image(s) to server module 180 of server 110 which recognizes said supplied image(s) e.g. viewed or scanned or provided image 6632 and identifies associated one or more keywords or tags and based on one or more types of user data and connected users of user and accompanied users' data (age, gender, place, provided activity type(s) or one or more types of status, asked and provided additional information) searches, retrieves and aggregates one or more types of contextual contents or information (web links, hashtags, keywords, categories, tags, text, blog, news, article, structured information (fields and associated one or more types of value(s) or data) one or more types of visual media including photo(s), video(s), voice, photo filter(s), emoticon(s), clipart, emoji, cartoon, avatar) from one or more sources including one or more web sites (search engines, social networks), applications, user accounts, user generated or provided or shared one or more types of contents or user data (user profile, shared visual media, user status, checked-in place or current location etc.), servers, databases, devices, networks, advertisers, 3^{rd} parties providers and based on settings auto sent said information to pre-set one or more contacts and/or groups and/or one or more types of one or more destinations or sent to selected one or more contacts and/or groups and/or one or more types of one or more destinations 6630. In an another embodiment user is enable to preview for pre-set duration 6640 to view, edit via tap on edit icon 6638 or edit via tap on content, remove via remove icon 6636 or swipe left content 6635 to remove or tap on content 6635 to edit or remove, change or update one or more types of destination(s) and in the event of expiration of said pre-set preview duration 6640 and non-receiving of any action of viewing user, auto send said retrieved and presented one or more types of content and information 6635 to pre-set one or more contacts and/or groups and/or one or more types of one or more destinations. In an another embodiment user is enabled to capture photo or record video and instruct via button 6629 server module 180 to send said captured phot or recorded video with recognized or associated one or more types of contents or information, recognized, identified, searched, matched, accumulated, retrieved, analyzed, generated and compiled by server module 180 based on user data and sent to said user selected or pre-set or auto determined one or more contacts and/or groups and/or one or more types of one or more destinations. In an another embodiment enabling user to select, capture, record and scan one or more person(s) or face(s) or human body(ies) via camera display screen 210 of user device 200 and sent to server module 180 of server 110 which recognizes said supplied human or human face(s) or body(ies) via face recognition technologies and identifies unique identity of said on or more person(s) and identifies associated on or more types of information, profile data or user data (age, gender, photo, video, current location or place, checked-in location or place, one or more types of status, language, interests, contact information, visiting card etc.) based on said person's privacy settings and preferences and present to said user for pre-set duration of preview for review, remove, edit, augment, change or update destination(s) and in the event of expiration of said preview duration or non-action on preview by viewing user, auto sent said captured photo or recorded video with said retrieved or edited information to selected or pre-set or auto determined one or more contacts and/or groups and/or one or more types of one or more destinations.

In an another embodiment in the event of haptic contact engagement of anywhere in display screen or on icon 6629, merge, overlays captured image 6632 with retrieved one or more types of said image associated information (as discussed above) and convert both as single image (i.e. captured image+Text overlays). In an embodiment server module 180 adjust image and text area and position automatically.

In an another embodiment in the event of haptic contact engagement of anywhere in display screen or on icon 6629, merge, overlays recorded video associated image 6632 with retrieved one or more types of said image associated information (as discussed above) and integrate contextual text with image of video (i.e. video related image+Text overlays). In an embodiment server module 180 adjust image and text area and position automatically. So recorded video shows said recorded video related image specific contextual or matched retrieved one or more types of information or digital contents and as per change in image presented content also changed as per current image. In an another embodiment in the event of user wants more information on photo or video then server module 180, adds additional image and like live photo (i.e. short video e.g. 2 or 5 second video) show sequences of images (e.g. first image is captured image and next pre-set duration or pre-set number of images contains one or more types of content or information about or contextually related to said captured image or based on retrieved information length divide said and convert said information into number of images). Viewing user is presented with said live photo (e.g. JPG file or .MOV file) or (new term or new type of media “Live iPhoto” or “ImageInfo photo” or “AR Photo” or “ARVideo” or “AR Media” or “ARVisual Media”, wherein “AR” means Augmented Reality) or short video in such a way that viewing user can view captured image first and then present next image (which contains one or more types of contextual information retrieved by server module 180) and pause for some pre-set duration to enable viewing user to read said captured image associated retrieved, integrated contextual one or more types of contents (based on presented content (e.g. number of characters) pause image for pre-set duration so viewing user can read said information or enable to tap to pause on image and further tap to view next image or double tap to make information OFF on image of further double tap to make information on image ON or show thumb image beneath or prominent place of image so user can jump on particular image inside said live photo or short duration of video). In an another embodiment enabling capturing user to provide preferences of showing of one or more types of retrieved content including historical information, ratings, reviews, likes, dislikes, experience, complaints, suggestions, news, blogs, articles, advertisements, offers, nearby palaces, related application(s) links, information, jokes, hashtags, keywords, weather, emoji, cartoons, avatars, emoticons, photos, videos, voice media, links, events, general information, health related information, map (show place point, route, estimated time to reach etc.), one or more types of statistics & analytics, attributes or features or characteristics related information, price or fees or payment information, location or place information, related or interacted or admin persons or people associate information or profile, user actions including one or more types of control(s) e.g. button(s), menu item(s), link(s), applications, interfaces, web site, web pages, link(s) of one or more types of media e.g. buy, like, dislike, rate, comment, refer, share, order, participate in deal, sell, book, become member, visit place, chat, message etc. for enabling sender and one or more viewing user to do one or more activities, actions, transactions, participations, communications, collaborations, sharing

In an another embodiment server module real-time search information based on view on camera display screen and show message on prominent place of camera display screen that information found and in the event of information not found then shows message or icon that information not found. In an another embodiment after capturing phot server module 180 takes time to retrieve and prepare contextual photo and augmented reality media file and present once generated.

In an another embodiment enabling capturing user to real-time providing of one or more types of pre-defined visual reactions, visual instruction, visual expressions, visually provide preferences & visual commands to provide one or more types of preferences or enabling to provide voice, commentary, news & description or commentary or reviews on captured visual media via front camera 6643 while capturing photo or recording video 6632 and in the event of receiving of said back camera and front photo(s) and/or video(s) server module 180, identifies said visual and/or voice preferences, instructions, commands, reactions, expressions, feelings, actions, status, activities, senses and commentary including types, categories, tags, hashtags and keywords associated with said visual and/or voice preferences, instructions, commands, reactions, expressions, feelings, actions, status, activities, senses and commentary like, want to buy, rating, comments, bought, ask to refer, based on provided voice identifies user's current one or more type(s) and/or name(s) of activities, actions, transactions, status and reactions.

In an another embodiment based on settings sender can capture or record front and back camera one or more phot(s) and/or video(s) simultaneously and one or more viewers or recipients can view said front and back camera one or more phot(s) and/or video(s) and/or retrieved one or more types of contents, overlays, & information together as single media or merged media or merged presentation with one or more options including swipe left on media to skip, tap on media to view next, double tap on media to pause and again double tap on media to start, swipe right to ON or OFF presentation of retrieved contextual contents or front camera photo(s) or video(s) presented with said captured photo(s) or recorded video(s).

In an another embodiment enabling capturing user to set limit of particular number of characters, words, lines, paragraphs for one or more and types of retrieved contents by server module 180.

In an embodiment show overlays and merge retrieved information on each identified object inside captured image or recorded video associate image.

Wherein captured image or live photo or recorded video associate recognized and identified one or more types of retrieved information by server module 180 comprises information about object (product, item), view, scene, place, point of interest, physical structure (shop, tourist place, monuments, museum, art, building etc.), food type (vegetable, bean, coffee, pizza etc.) associate information, health related information, user generated and shared contextual contents, product features, seller's profile, likes and dislikes, reviews, price, fees, upcoming or current events details, statistics information, place information, current related news, types of activities information, and attach one or more types of user actions (buy, like, refer etc.), links,

In an another embodiment enabling user to haptic contact engagement on particular part or object in view of camera display screen, in the event of recipient haptic contact engagement on particular part or object in view of camera display screen via touch controller 215, augment reality client application 280 sends said scene image with user's haptic contact engagement marked area to server module 180, which recognizes marked part related object(s) inside said received image and identifies said tapped or marked area related object related one or more types of content and information from one or more sources (For example camera view has coffee cup, coffee inside cup, table or furniture, light, coffee house objects inside scene user viewing via camera display screen and user tap or haptic contact engagement on coffee cup, then augment reality client application 280 sends said image with haptic contact engagement marked area to server module 180 which recognizes said coffee cup and identifies associated information and searches, matches and retrieves one or more types of contents and in an embodiment further filter said retrieved content based on one or more types of user data and prepares user specific contents and present to user for user review and sent to one or more connected users of user).

Although the present disclosure is described with reference to specific example embodiments, it will be evident that various modifications and changes may be made to these embodiments without departing from the broader spirit and scope of the disclosure. Accordingly, the specification and drawings are to be regarded in an illustrative rather than a restrictive sense.

The auto presented or searched or selected one or more augmented reality applications, functions, controls (e.g. button), web services, objects & interfaces provided by one or more developers and from one or more sources, makes the information about the surrounding real world of the user becomes interactive and digitally manipulable with the help of advanced AR technology (e.g. adding computer vision, object tracking and object recognition). An example technology provides users with a set of augmented reality applications, functions, controls (e.g. button), web services, objects & interfaces (e.g., enabling enhancements and augmentations) that can be invoked via scanning via camera display screen or a photo or a video taken by the user. The set of augmented reality applications, functions, controls (e.g. button), web services, objects & interfaces may be determined based on a recognition of an object in the scanned object or scene via camera display screen or take the photo or video (series of images) that satisfies specified object criteria and/or target criteria matched with user data including or user profile (fields and associated values), user activities, actions, events, truncations, senses, status and/or target location(s) information matched with user device monitored location and/or schedule(s) of presentation or publication matched with user device current date & time and/or one or more types of associated details & metadata associated with the augmented reality applications, functions, controls (e.g. button), web services, objects & interfaces. In this way, the augmented reality applications, functions, controls (e.g. button), web services, objects & interfaces are presented to a user for selection and use based on a recognized content of the scanned view or scanned object or photo or video or selection on map. For example, if the user scans via camera display screen or takes a photo and an object in the scanned view or photo or image(s) of video or selected object on map is recognized as the GUCCI shop, New York City (Manhattan, Trump Tower), augmented reality applications, functions, controls (e.g. button), web services, objects & interfaces associated with the GUCCI shop, New York City (Manhattan, Trump Tower) may be provided to the user for use while user device's current location is near to or surround or in GUCCI shop, New York City (Manhattan, Trump Tower) based on administrator or advertiser of said GUCCI shop, New York City (Manhattan, Trump Tower) provide location, object criteria and target criteria. In other embodiment GUCCI global or national brand advertiser can create advertisement including set target criteria or target audience or target viewer as female audience (i.e. Gender=Female) AND Age Range=between 18 to 25 and set location=“All Shops in Anywhere in the World” (i.e. location of each shop of GUCCI, identified based on map or provide by administrator or server or 3^{rd} parties) location sand adds or provides object criteria including object models or sample image of multiple “GUCCI” products associate each product specific selected one or more augmented reality applications, functions, controls (e.g. button), web services, objects & interfaces from list 6560 including for each product “visual story” application which enables users presence at or near to any shop of GUCCI and who are female and falls in 18 to 25 age range and who scans particular product at any GUCCI shop then based on scan or photo or video system identifies matched GUCCI product associated augmented reality application or control (e.g. button) which enable said user to view visual story related to said scanned GUCCI product.

In another example, “Super Mall” (London) administrator or advertiser, may create augmented reality advertisement and set location via define a geo-fence (e.g., geographic boundary) around the “Super Mall” area in London including all shops of super mall and select all visitors or user devices who will enters into “Super Mall” will auto present with one or more selected augmented reality applications, functions, controls (e.g. button), web services, objects & interfaces by advertiser including for example “Super Mall” video review. “Super Mall” (London) administrator or advertiser, may also add each shop inside “Super Mall” related exact location by employing e.g. iBecon or Wi-Fi or other accurate location information provider devices and services and select one or more augmented reality applications, functions, controls (e.g. button), web services, objects & interfaces for each shop including video review or visual media story (sequences of user generated and use posted visual media), so when user reach near to particular shop or enters into particular shop inside “Super Mall” then user is presented with said selected one or more augmented reality applications, functions, controls (e.g. button), web services, objects & interfaces and any combination thereof. In an embodiment the presentation of the augmented reality applications, functions, controls (e.g. button), web services, objects & interfaces to the user may be in response to the user performing a gesture (e.g. a swipe operation) on a screen of the mobile device. Furthermore, although some example embodiments describe the use of augmented reality applications, functions, controls (e.g. button), web services, objects & interfaces in conjunction with or based on scan of object via camera display screen or captured photos or recorded video, it should be noted that other example embodiments contemplate the use of augmented reality applications, functions, controls (e.g. button), web services, objects & interfaces with map.

Third party entities (e.g., advertisers, sellers, merchants, restaurants, companies, individual users, owner or administrator of tourist places, points of interests and one or more types of entities etc.) may, in one example embodiment, create augmented reality applications, functions, controls (e.g. button), web services, objects & interfaces for inclusion in the set presented for user selection based on recognition of an object satisfying criteria specified by the creator of the augmented reality applications, functions, controls (e.g. button), web services, objects & interfaces. For example, a scanned view or scanned object or scan via camera display screen particular scene or photo of image(s) of video including an object recognized as a restaurant may result in the user being presented with augmented reality applications, functions, controls (e.g. button), web services, objects & interfaces that present a menu of the restaurant on the user device interface. Or a photo or image (s) of video or scanned view including an object recognized as a food type may result in the user being presented with augmented reality applications, functions, controls (e.g. button), web services, objects & interfaces that let the user view information e.g., calories, fat content, cost or other information associated with the food type. Third party entities may also bid (or otherwise purchase opportunities) to have a augmented reality applications, functions, controls (e.g. button), web services, objects & interfaces included in a set presented to a user for augmentation of a particular scanned view or photo or video.

More specifically, various examples of an augmented reality applications, functions, controls (e.g. button), web services, objects & interfaces platform are described. The augmented reality applications, functions, controls (e.g. button), web services, objects & interfaces platform includes a augmented reality application, function, control (e.g. button), web service, object & interface publication module that operates at a server, in some embodiments, and generates augmented reality applications, functions, controls (e.g. button), web services, objects & interfaces based on customization & configuration data associated with the satisfaction of specified object criteria by objects recognized in a scanned view or a photo or a video. In other embodiments, some or all of the functionality provided by the augmented reality application, function, control (e.g. button), web service, object & interface publication module may be resident on client devices. An augmented reality application, function, control (e.g. button), web service, object & interface may be generated based on supplied configuration data and/or object criteria and/or target criteria and/or location(s) information and/or schedules of presentation and/or one or more types of associated data that may include audio and/or visual content or visual effects that can be applied to augment the scanned view at a mobile computing device. The augmented reality application, function, control (e.g. button), web service, object & interface publication module may itself include a user-based augmented reality application, function, control (e.g. button), web service, object & interface publication module and an advertiser-based augmented reality application, function, control (e.g. button), web service, object & interface publication module.

The augmented reality application, function, control (e.g. button), web service, object & interface platform also includes a augmented reality (application, function, control (e.g. button), web service, object & interface) engine that determines that a mobile device has scan particular object or scan view or scan scene or has taken a photo or a video or selects object from map and, based on the scanned object or photo or video including an object that satisfies the object criteria and/or target criteria and/or target location(s) and/or schedules of presentation, provides the augmented reality application, function, control (e.g. button), web service, object & interface to the client device. To this end, the augmented reality (application, function, control (e.g. button), web service, object & interface) engine includes an object recognition module configured to find and identify objects in the scanned object(s) or inside scanned view or scanned scene or a photo or a video (image(s) inside video); and compare each object against the object criteria. The object criteria may include associations between an object and a source of image data, for example exhibits in a museum, in which case the associated augmented reality application, function, control (e.g. button), web service, object & interface may include images including data associated with a specific exhibit in the museum.

Using the user-based augmented reality application, function, control (e.g. button), web service, object & interface publication module, the augmented reality application, function, control (e.g. button), web service, object & interface publication application provides a Graphical User Interface (GUI) (e.g. FIG. 65) for a user to configure, customize, setup one or more augmented reality applications, functions, controls (e.g. button), web services, objects & interfaces provided by one or more developers or created, uploaded, register by user or upload configuration data for generating a augmented reality application, function, control (e.g. button), web service, object & interface at server 110 and upload object criteria for comparing to recognized objects in a scanned image or scanned object or scanned view or scanned scene or a photo. For example, the user may upload an augmented reality application, function, control (e.g. button), web service, object & interface and specify criteria that must be satisfied by an object recognized in the scanned image or photo or image(s) of video in order for the one or more augmented reality applications, functions, controls (e.g. button), web services, objects & interfaces to be made available to a mobile device. Once the user submits the one or more augmented reality digital items or packages including applications, functions, controls (e.g. button), web services, objects & interfaces and any combination thereof and specifies the object criteria, the augmented reality application, function, control (e.g. button), web service, object & interface publication module generates based on supplied configuration data or supply a augmented reality application, function, control (e.g. button), web service, object & interface and is associated with satisfaction of the specified object criteria. As such, mobile devices that have scan an object or taken a photo or video 9 image(s) of video) including a recognized object that satisfies the specified object criteria may have access to the one or more augmented reality applications, functions, controls (e.g. button), web services, objects & interfaces.

In other examples, if a scanned object or scanned view via camera display screen or photo or image(s) of video or select on map includes more than a specified number of objects that satisfy specified object criteria and/or target audience criteria and/or schedules of presentation and/or target one or more types of one or more defined locations or places or geo-fence boundaries or queried locations (e.g. via SQL or natural query) and/or one or more associated data & metadata, the augmented reality (application, function, control (e.g. button), web service, object & interface) engine may use a augmented reality application, function, control (e.g. button), web service, object & interface priority module to generate a ranking of augmented reality applications, functions, controls (e.g. button), web services, objects & interfaces associated with object criteria satisfied by the objects in the scanned object or scanned view or photo or video and/or matching current monitored location of user device with the location specified with criteria of publication and/or schedules of publication matched date & time of user device and/or user data including user profile, logged user activities, actions, events, transactions, senses, behavior, status matched with data associated with said target criteria or publication criteria or advertisement associated data & metadata based on specified augmented reality application, function, control (e.g. button), web service, object & interface priority criteria. The augmented reality (application, function, control (e.g. button), web service, object & interface) engine may then provide the specified number of the augmented reality applications, functions, controls (e.g. button), web services, objects, interfaces and any combination thereof to the client device according to the ranking of the augmented reality applications, functions, controls (e.g. button), web services, objects, interfaces and any combination thereof, which may be based on any combination of a augmented reality applications, functions, controls (e.g. button), web services, objects, interfaces and any combination thereof creation date, a augmented reality applications, functions, controls (e.g. button), web services, objects, interfaces and any combination thereof type, a user ranking of the augmented reality applications, functions, controls (e.g. button), web services, objects, interfaces and any combination thereof, etc.

Using the advertiser-based augmented reality application, function, control (e.g. button), web service, object, interface and any combination thereof publication module, the augmented reality application, function, control (e.g. button), web service, object, interface and any combination thereof publication application provides a GUI (e.g. FIG. 65) for advertisers to configure, customize, setup one or more augmented reality applications, functions, controls (e.g. button), web services, objects & interfaces provided by one or more developers or created, uploaded, register by advertiser or upload configuration data for generating a augmented reality application, function, control (e.g. button), web service, object & interface at server 110 and upload object criteria for comparing to recognized objects in a scanned image or scanned object or scanned view or scanned scene or a photo and/or provide target criteria to match with user data and/or provide target location(s) to match with user device current or nearest location based on monitoring of user device via GPS sensor by server 110 and/or match schedules of presentation with date & time of user device monitored by server 110 and/or other data associated with augmented reality advertisement or publication criteria with data of user including profile, and submit bids for the presentation of a augmented reality application, function, control (e.g. button), web service, object, interface and any combination thereof based on the satisfaction of the uploaded object criteria by an object recognized in a scanned object or scanned view or a photo or a video (from series of image(s) of video). A bidding process may be used to determine the advertiser with the highest bid amount. That advertiser can then exclude publication of one or more augmented reality applications, functions, controls (e.g. button), web services, objects, interfaces and any combination thereof from other advertisers (with lower bids) that might otherwise be published based on satisfaction of the uploaded object criteria and/or target criteria and/or target location(s) and/or schedule(s) and/or other associated structured or non-structured data & metadata. Therefore, the augmented reality application, function, control (e.g. button), web service, object & interface of the highest bidding advertiser may be the only augmented reality application, function, control (e.g. button), web service, object & interface that can be accessed by mobile devices that have scan an object or scan particular view or scan scene or taken a photo or a video (video comprise series of image(s) of video) including a recognized object that satisfies the uploaded object criteria. In examples, the common object criteria include a type of object for which multiple advertisers sell branded products of the same type.

The augmented reality (application, function, control (e.g. button), web service, object & interface) engine includes a collection module to store previously provided augmented reality applications, functions, controls (e.g. button), web services, objects, interfaces and any combination thereof in an augmented reality application, function, control (e.g. button), web service, object & interface collection associated with a client device. The collection module may then instruct the an augmented reality application, function, control (e.g. button), web service, object & interface publication module to provide a new an augmented reality application, function, control (e.g. button), web service, object & interface to the client device in response to the an augmented reality application, function, control (e.g. button), web service, object & interface collection including a specified number of a type of an augmented reality application, function, control (e.g. button), web service, object & interface.

The augmented reality (application, function, control (e.g. button), web service, object & interface) engine includes a count module to generate a count of objects of a specified object type identified in scanned view or scanned object(s) or photos or videos (image(s) of video) taken by the client device. The count module may then instruct the an augmented reality application, function, control (e.g. button), web service, object & interface publication module to adjust a content of an augmented reality application, function, control (e.g. button), web service, object & interface associated with the specified object type in response to the count reaching a specified threshold value.

FIG. 67 illustrates exemplary interfaces 281 and examples, wherein while viewing of content item or visual media item or post received from one or more users or contacts or sources, then based on settings user's reactions while viewing is auto recorded and auto send or send after user's preview and permission to said sender user or contact or source and based on setting make said photo or video reaction as ephemeral or non-ephemeral.

In an embodiment FIG. 67 (C) shows various types of settings for recording, previewing, sending of user's photo or video reactions including make ON or OFF recording, previewing, sending of user's reactions related settings 6792 described in FIG. 67 (C), user can set as auto record user's photo or video reaction or manually record or auto record user's reaction and start auto recording after pre-set period of time (so user can properly reacted or be prepare for proper reaction) while viewing of one or more types of contents (shared, received, subscribed, communicated, presented, auto presented etc. from one or more senders or contacts or sources (servers e.g. server 110 via server module 181, web sites, web applications, devices, networks, databases or storage mediums and web services or APIs)) at one or more types of feeds, stories, albums, galleries, folders, posts, inbox or received contents, browsing of web sites or web pages, navigating map, viewing content or visual media in one or more features of one or more applications, interfaces, presentation interfaces and one or more types of digital content presentation interface. In another embodiment user can auto send or send after preview and manually send or send after pre-set duration of preview and in the event of expiration of said preview duration auto send said auto recorded or manually recorded phot or video reaction to viewed visual media item or content item or newsfeed item associate sender or source or contact 6794 and 6799. In another embodiment reaction sender user can make said photo or video reaction for receiver as ephemeral (after presenting of said reaction pre-set duration of time started and in the event of expiry of said pre-set duration of view or display timer, said reaction photo or video is removed from recipient's and/or sender's interface or device and/or from server's 110 database or storage medium 115 via server module 181) or non-ephemeral 6796. User can also set auto recording of reaction in particular visual media type including if viewing or viewed visual media item is video then reaction is auto recorded in video format or if photo then reaction is auto recorded in photo format or auto determine auto recorded user's reactions visual media type by system based on type of viewed content, sender or source type, duration of reaction, speed of viewing or duration to switching to next content item and determined user's busy status or set reaction type as photo reaction or video reaction or both photo and video reaction(s) or each time ask user to type of user reaction and number of times record photo or video reactions (default is one photo and/or video based on setting) 6791. In another embodiment user can provided settings related to receiving of photo or video or visual media reactions on user posted content items or news items or visual media items including notify user while receiving of one or more reactions from viewer or recipient users of sender user posted content 6798, if user tap on notification or while interface is open and user is viewing the content items or news items or news feed or visual media items then auto play or auto paly while hover or mouse over said received video or live photo or one or more types of visual media reactions from one or more users or recipients of sender user's post(s) 6795.

For example when user [Candice] 6762 device (FIG. 67 (B)) sends post or message or video 6764 to e.g. user [Yogesh] device (FIG. 67 (A)) at user interface 6709 e.g. post or message or video 6703 received from user [Candice] 6701 and presents said post 6703 for pre-set view or display duration of time 6702 based on ephemeral setting (pre-set view or display time for receipting) of sender user [Candice] and in the event of after presenting starting of pre-set timer 6702 and expiry of said pre-set timer 6702, remove said message or post or news item or video 6703 from user [Yogesh] device 6725 or interface 6709, then based on setting 6793 when user [Yogesh] is viewing said post or news item 6703 then device 200 or 6725 image sensor (in background or silent mode or in foreground mode or present camera display screen) 244 automatically captures or records user's natural reactions photo(s) or pre-set duration 6793 of video(s) e.g. 6701 while viewing of said post 6703 and based on preview setting 6794 viewing user [Yogesh] is presented with preview interface 6701 for previewing said captured photo or recorded video 6701 related to user's reaction for pre-set period of time 6721 and based on sending setting 6799 in the event of expiration of said pre-set duration of preview 6721, based on setting auto send or auto send after pre-set period of time for enabling user to view 6701 or play 6741, cancel 6717, update or edit or augment 6743 the reaction visual media 6701 or manually send ad presents said captured photo or recorded video related to user's reaction 6788 to said post or news item or message or video 6703 sender user e.g. [Candice] or source at sender user's device 6780 on user interface 6760 in news item 6761. In another embodiment reaction photo or video sender can set view timer 6750 with said auto or manually captured or recorded auto or manually sending video or photo and in the event of presenting of said reaction 6788 to post sender or other viewing users of said post and starting of timer 6757 and then expiry of said view timer 6757 then remove said ephemeral reaction video or photo 6788 from reaction viewer user device 6780 e.g. and/or sender's device e.g. 6725 and/or from server 110 database or storage medium 115 via server module 181. In another embodiment sender user e.g. [Candice] can view said posted content item 6764 related reaction visual media photos or videos from other recipient users or viewing users e.g. 6755 and 6756. In another embodiment user can manually capture (via camera display screen photo capture icon 6746) or select 6745 reaction photo or select 6745 or record reaction video (via camera display screen video capture icon 6748). In another embodiment e.g. user [Candice] receive and view posts from other users e.g. receive post or photo 6784 from user [James] 6782 and can receive and view reactions 6786 and 6787 from other viewing users of said post or video 6784.

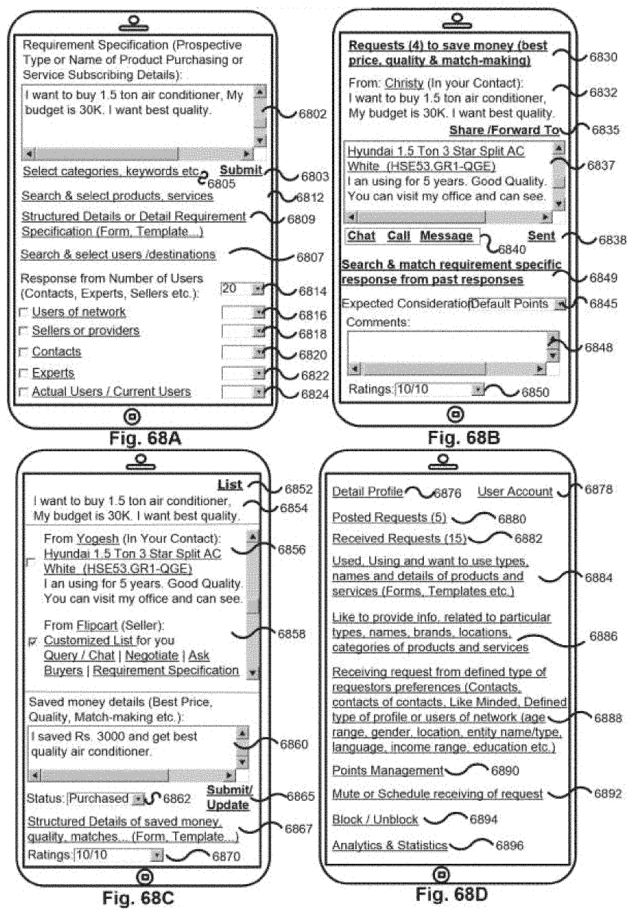

FIG. 68 illustrates user interface or application 284 for enabling user to prepare structured (one or more types of domain, category, brand, product or service type or name specific form(s)) 6809 and freeform 6802 requirement specification, associate one or more categories, keywords, tags, taxonomy and metadata 6805 and/or search and select one or more products and services 6812 and submit 6803 or select one or more contacts and/or groups and/or one or more types of one or more destinations and/or defined types of users of network (via SQL, natural query, wizard, advance search) 6807 or select required number of responders including user contacts, contacts of contacts, actual current or past users of requirement specification related products or services, experts, sellers, service providers, and users of network 6814 (server module 188 of server 110 auto matches and identifies said number of responders) and selected type and number of responders or sources of responses on said posted or submitted requirement specification including send said requirement specification to matched number of users of network 6816 (server module 188 of server 110 matches requirement specification with user data of users of network and send said requirement specification to matched users of network), send to said requirement specification related contextual sellers, retailers, distributers, wholesalers, service providers, re-sellers, franchise holders, shops, and manufacturers 6818, send to contacts of user 6820, send to experts 6822 (sponsored, paid and free domain or subject or category or product or service specific expert service provider (guide, consulting, provide answers of queries, provide experiment, support, training etc.) and actual current and/or past customers, users, clients, guests, users 6824 of said requirement specification related one or more products and services and then submit 6803.

In an embodiment server module 188 of server 110 identifies requirement specification related matched prospective responders based on matching requirement specification with users data of user's contacts including current or past using of said requirement specification related one or more products or services, identifies sellers based on matching requirement specification related one or more products or services with sellers' profile data including seller of said requirement specification related one or more products or services, identify experts based on matching requirement specification related one or more products or services with experts' profiles data including experts who provide one or more types of expert services related to said requirement specification related one or more products or services.

After submitting 6803 requirement specification 6802, server module 188 verifies, processes, spell checks, associate one or more metadata with received requirement specification and sent to requirement specification associated selected one or more contacts and destinations or sent to auto matched prospective responders e.g. 6830. Receivers can select and accept one or more requests on which receiver wants to provide response from list of received requests or requirement specifications 6830. Responder can select particular request to requirement specification 6832 from list of received requests or requirement specifications 6830 and prepare or draft or update response 6837 and sent 6838 to requestor said response 6856 at user interface via server module 188. In an embodiment responder can select one or more types of commination applications and can real-time chat, messaging and call with said requestor to ask more entails, provide answers etc. In an embodiment responder can share or forward to other connected users of user who can provide better answer 6835. In an embodiment responder can ask for one or more types and amount of considerations from requestor before response including payment models & modes (per response charges, per real-time chat session price, amount etc.), number of points (for per response, per real-time chat session, per answer for per query etc.), sponsored or free (no any consideration required) or default points pre-set by server module 188 of server 110. In an embodiment responder can provide comments 6848 and ratings 6850 on request or on requestor. In an embodiment responder can search, match and select past responses for providing response on particular selected request or requirement specification 6849.

After receiving responses on one or more requirement specifications from one or more responders requiting user can view lists of requirement specifications 6852, select particular requirement specification or request and can view or access associate responses e.g. 6856 and 6858 and can use, access, invoke, open and take one or more actions (e.g. chat, negotiate, ask buyers etc.) associate with response e.g. 6858. After viewing said response requestor or viewing user for example bought air conditioner from said response associated seller and can provides freeform details 6860 or structured details 6867 (about how said response helpful to said user or requestor or viewer or buyer) including saved amount of money, saving in total cost of ownership, saving per piece or total saving, monthly saving, level of match making with user's requirement specification, level of quality which buyer or user expected or got, associate experience, details about other benefits received including, provide comments, provide ratings 6870, provide status on said response e.g. “Purchased” 6862 (other status may include received, unread, read or viewed, not liked, liked, purchased, add to interest, pending) and can submit or update 6865. Server module 1888 monitors, tracks, save said details and present one or more types of statistics and details at each user interface related to received responses including list of submitted requirement specifications, each requirement specification related received responses, each responder related responses, each responders whose response(s) user selects and used for making product purchasing decision or purchased based on response, total money saved by each responder, one or more types of offers received, weight & rating of each responder based on level of match making provided, quick response, other one or more types of benefits received including quick delivery with no or less cost, return policy, escrow or insurance policy, redeemable points, vouchers, coupons, gifts, in-place presentation, cash back with purchase or subscribe based on response associate suggested products and service, quality of matched product and services provided in response, after purchase better experience, user reactions including comment, review, like, dislike after purchase or use.

Server module 1888 monitors, tracks, save said details and present one or more types of statistics and details at each user interface related to provided responses including each requirement specification related response and associated status including viewed, not viewed, rated, executed or used in making purchasing or subscribing decision or in purchase, liked or rated or disliked after making purchase and using product or service, provided comments, amount of saved money, one or more types of rating received on response which requestor used in making purchase of product or subscribing of service including quality rating, level of match making rating, quality or level of delivery service, return policy, insurance & escrow service, quality or level of after purchase support service, other one or more types of benefits received with purchase of said suggested product or subscribing of said suggested service and after purchase product or service using experience (e.g. food taste, food quality, room facilities quality, room service quality, design, length of life of product, new features, advancements etc.).

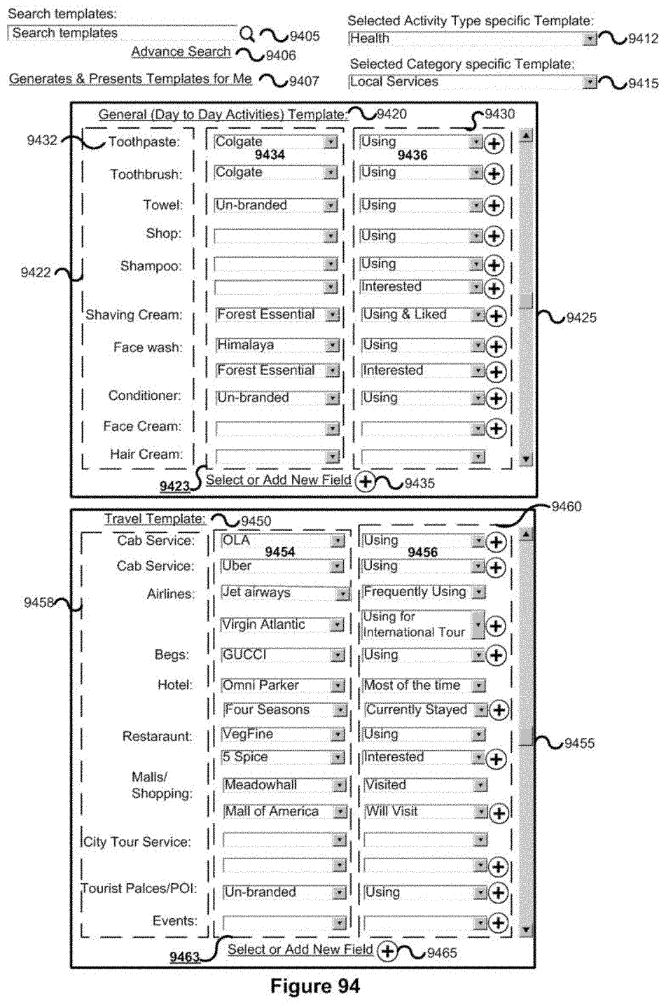

In an embodiment user can create accounts via server 110 and In an embodiment user can provide one or more types of user related details via one or more types of profiles, forms, templates and preferences 6876, 6884 (as discussed in details in FIGS. 94-99). In an embodiment user is enabled to view and access and manage sent or submitted requests 6880 or received requests 6882. In an embodiment user can provide preferences for receiving requests (in which user is expert, or using particular types, categories, brands, places and keywords specific products and services) including types, keywords, categories, places, locations, taxonomy 6886 and one or more selected contacts, contacts of contacts, followers, particle type of defined profile of requestors (e.g. particular age range, gender, education or qualification, type of interests & skills, related to particular type & named entities including school, college, class, club, place, brand, shop etc.) specific requests 6888. In an embodiment user is enabled to manage points including view total number of balance points, total points spend or earned on/within particular date & time or range(s) of date(s) and time(s), gift points, receive points from contacts, purchase points, sell points, redeem points in exchange of one or more types of considerations including cash, gift, voucher, coupon, product or service. In another embodiment user can mute receiving of requests 6892. In another embodiment user can schedule receiving of requests 6892. In another embodiment user can block responders for blocking receiving of requests from blocked responders 6894 or unblock blocked responders 6894. In another embodiment user can view, access, search, match & request various types of statistics and analytics 6896.

In an embodiment server logs user's submitted requirement specifications, associate responses, selected responses, executed responses (i.e. purchase product(s) or subscribe service(s) based on said one or more identified responses provided by identified responder(s)) and associate user provided details including saved money details (amount, total cost of ownership, monthly saving etc.), matchmaking level (exact, best, medium etc.) with requirement specification, quality of product or service, and other benefits gets including delivery details (e.g. time, fast etc.), associate additional benefits, offers, return policy, discounts, vouchers, redeemable points, coupons, cashback, gift based on receiving of particular response from responder.

In an embodiment server logs one or more types of details related to user's one or more activities, actions (view, share, like, dislike, rate, comment, refer, ask query, receive answer, negotiate, bid, compare etc.), events & status (sent or submit or post requirement specifications, sent said requirement specification to number of matched prospective responders, number of prospective responders accept said requirement specification, receive responses from said request accepted responders, response(s) viewed, response(s) selected or used for making purchasing of product decision or purchase product based on particular response or making subscribing of particular service decision or subscribing particular service based on particular response and provide notes or details on response regarding saved money details and other benefits details), transactions (e.g. bought, sell, order, subscribe, make payment based on one or more types of models & modes, add to cart etc.), behavior, interactions, communications (chat, messaging, questions, answers, presentation), sharing (exchange of one or more types of contents), collaboration (one or more similar requirement specifications providers and one or more said requirement specifications specific responders).

In an another embodiment requestor can define duration within which requestor wants response for making purchase decision including real-time or near real-time or within number of minutes, hours, days, and months etc.

In an another embodiment requestor can request nearby actual customer (for e.g. real-time helps in purchasing of particular types and brands of products e.g. cloths for marriage, jewelry, electronic products, booking caterers or marriage hall, wholesale purchase, visit or book flat or car or luxury goods or mass purchases etc.) based on user device's current location, (discuss in detail in user to user on demand services in FIGS. 71-72 (A) & (B)—instead on visual media taking providing and consuming service, it can also similarly used in providing user service via reaching at user or shop or reaching at user or shop at particular scheduled date & time and help in purchasing product and consuming service from nearest or arrived at particular scheduled date & time actual customer related to particular product or service). So actual customers or experts or experience purchaser can personally reach to user (real-time or at particular scheduled date & time at shop, office, manufacture place etc.) and helps user in guiding, consulting, querying, negotiating, comparing and purchasing of products or subscribing or consuming of services.

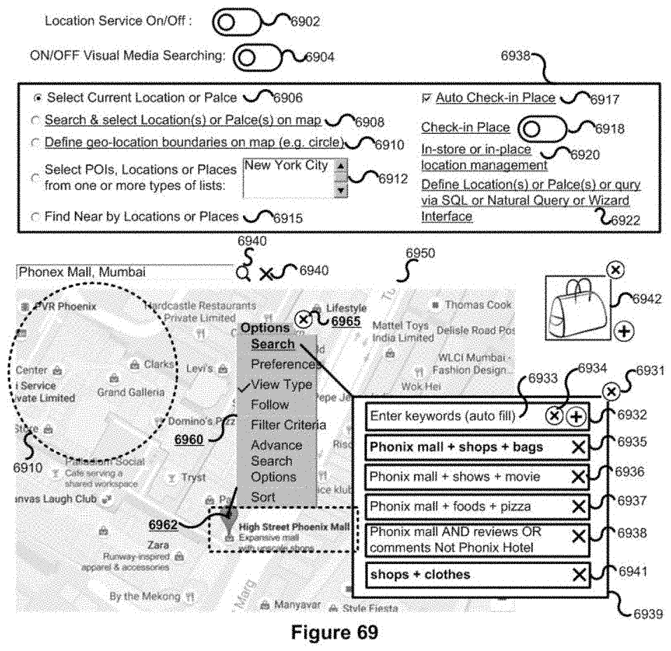

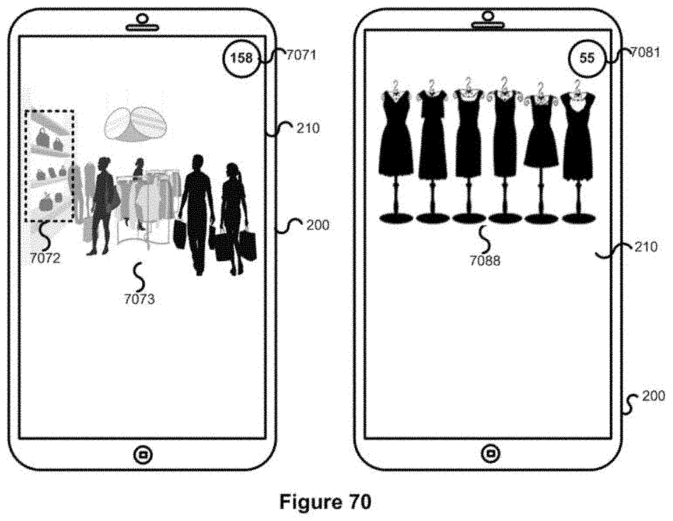

FIGS. 69-70 illustrates exemplary interface, wherein in one embodiment interface enabling user to ON or start location service if not enabled or OFF or disconnect location service 6902. In another embodiment user is enabled to ON/OFF visual media searching 6904. User is enabled to select current location of user device as location 6906, input location or place or point of interest or address or keywords (e.g. enter a city name, street address, intersection, or longitude and latitude—e.g. “Klamath Falls, Oregon”, “120 N Williams Ave, Klamath Falls”, OR “−121.623103, 41.953825”) 6940 or provide geocode 6940 or IP geolocation 6940 or select location or place or point of interest from suggested or bookmarked or saved or liked or visited or past checked-in locations or places or point of interest 6912 or auto-fill locations or places or point of interest 6940 or find nearby places and select from presented nearby places on map or list or search result 6915 or search & select particular point(s) inside establishment (e.g. particular shop inside mall, particular product showcase inside particular shop inside particular mall, particular product of particular product showcase or department inside particular shop inside particular mall based on e.g. very accurate location device or service e.g. iBeacon), select location or place via check-in place 6918 or auto checked-in place 6917 or search, match, navigate on map 6950 and select location or place or point of interest or spot or particular point on map 6950 and enabling user to input or edit or update or add 6932 or remove 6934 one or more keywords and/or Boolean operators and/or commands and/or and filter criteria & select advances search options via menu 6960 and any combination thereof 6933, select or auto-fill from suggested list 6933, wherein list may comprise place or location or point of interest specific suggested keywords 6933 or 693. Based on said identification of location or place or point of interest 6938 and then providing of one or more keywords 6939 (e.g. 6932 or 6935 or 6936 or 6937 or 6938) and/or Boolean operators 6939 (e.g. 6932 or 6935 or 6936 or 6937 or 6938) and/or filter criteria via menu 6960 (e.g. show recent or posted or created date & time range(s) specific visual media items, show most reacted e.g. most liked or most viewed visual media items, show visual media items captured, recorded or posted at said selected location or place or point of interest 6938, show visual media items captured, recorded, created or updated, selected & posted by connected users of user or location or place associate owner or advertiser or admin or brand verified user or source (via scanning QR code or object e.g. logo or name of brand etc.) or particular defined types of users of network including one or more filed and associated values including age range, skill type, education type, interest type, type of gender etc. specific and/or Boolean operators and any combination thereof etc.) and/or auto selecting and executing of one or more rules from rule base and/or any combination thereof, system or server 110 searches and matches said provided one or more keywords and/or Boolean operators and/or filter criteria and/or one or more types of user data (fields and associated values) with recognized object(s) inside visual media specific identified keywords and information and visual media associated one or more types of data and metadata including associated information or description and structured data (one or more fields associated values), keywords, tags, categories, comments, user reactions including users or viewers provided ratings, likes, dislikes, comments, emoticons and metadata including date & time of creation, date & time of posting, location where visual media takes or location where visual media posted, temperature, source, source profile and associated statistics including number of one or more types of reactions, views, and re-sharing and presents said search or matched or contextual visual media items e.g. 6973 (based on search query “Phonix mall+shops+bags” or 6988 (based on search query “Phonix mall+shops+clothes”) including presents said visual media items in sequences and auto present next (if any) visual media item based on pre-set duration of interval or haptic contact or tapping on visual media item, wherein user data comprises one or more types of detail user profiles including plurality types of fields and associated values like age, gender, interests, qualification, education, skills, home location, work location, interacted entities like school, college, company etc.), monitored or tracked or detected or recognized or sensed or logged or stored activities, actions, status, manual status provided or updated by user, locations or checked-in-places, events, transactions, re-sharing, bookmarks, wish lists, interests, recommendation or refer, privacy settings, preferences, reactions (liked or disliked or commented contents), sharing (one or more types of visual media or contents), viewing (one or more types of visual media or contents), reading, listing, communications, collaborations, interactions, following, participations, behavior and senses from one or more sources, domain or subject or activities specific contextual survey structured (fields and values) or un-structured forms, devices, sensors, accounts, profiles, domains, storage mediums or databases, web sites, applications, services or web services, networks, servers and user connections, contacts, groups, networks, relationships and followers.

For example when user enters query “Phonex Mall, Mumbai” to search location on map 6940, system shows or pinpoint said search query specific location or place or address on map 6962. In an embodiment user is presented with or user can select or open or invoke contextual menu from said searched or highlighted or pin pointed location or place or icon of said searched location or place 6962 (“High Street Phonix Mall”) and enabling user to select preferred menu item including search visual media items based on provided one or more queries, for example when user provides search query “Phonix mall+shops+bags” 6935. In another by default location or place is automatically added in search query, so when user provides “shops+bags” then system considered it as or prepare search query as “Phonix mall+shops+bags” 6935. After providing search query user can also provide one or more filter criteria and/or preferences and/or advance search options or selections (select one or more types of fields and provide associated one or more types of value(s) e.g. date & time range when visual media posted etc.).

FIG. 70 illustrates exemplary interface showing, For example “Phonix mall+shops+bags” 6935 specific visual media items at display 210 of user device 200 which also includes object criteria or object model 6942 specific matched visual media items 7073 which contains similar bag object 7072 inside visual media which is similar to said supplied object criteria or object model 6942.

FIG. 70 illustrates exemplary interface showing, For example “Phonix mall+shops+cloths” 6941 specific visual media items at display 210 of user device 200 which also includes object criteria or object model specific matched visual media items 7088 which contains similar cloth design or pattern or look inside visual media 7088 which is similar to said supplied object criteria or object model.

In another embodiment suggested keywords comprises keywords provided by said place associate one or more types of entities including advertiser, seller, user, owner, administrator, staff etc. For example mall administrator provide keywords including shop names and associate visual media related to each shop (e.g. shop outer or display photo or video, name & logo etc.), one or more shop owner or staff provided keywords including each product name or category and associate visual media, user can also provide keywords related to particular interested or purchased or liked or viewed products od particular shop(s), wherein said suggested keywords 6933 making available for searching users of network. In another embodiment search wizard interface provided to user for selecting step by step search query related keywords from suggested or listed or bookmarked or past used or saved or referred or used by connected user of user and/or Boolean operators with said one or more keyword(s), taxonomy, ontology, semantic syntax, categories, tags, hashtags, key phrases, alternative meaning or synonym of keyword and/or advance search options or selections of one or more types of one or more fields for providing one or more types of one or more values or ranges (input via text box or auto-fill control, select from radio buttons or check boxes, select from list or combo boxes and select from or access via or provide data or parameters via one or more types of controls etc.) and/or provide one or more preferences, presentation types & associate settings and privacy settings & safe search settings.

In another embodiment user can define location(s) or place(s) or query via structured query language (SQL) or natural query or wizard interface e.g. “All shops of mall” for searching and viewing visual media associate with said mall at selected place or location, “all customers” for searching and viewing visual media captured, recorded & posted by customers who visits said shop at said selected location or place on map.

In another embodiment visual media capturer or recorder user at particular place or location or point of interest is also presented with said suggested keywords for adding to or associate with said captured photo or recorded video or posting of said visual media with other auto associated details like user name, user device location or place name and information, metadata and system data including date & time of creation and posting at server 110.

In another embodiment based on update in monitored user device location or place, update in user status, checked-in place, adding or updating or logging of new activities, actions, events, transactions, reactions, interactions, communications, sharing and participations, system auto presents or updates list of suggested keywords.

In another embodiment enabling to creating, defining, configuring, collaborative updating (provided or updated by users of network) after verification and/or editing by editor or admin(s) or user admin(s), storing and updating domains, subjects, categories, keywords, entities, persons, products, services, places, point of interests, tourist places, shops, physical establishments including particular category or type or named or identified building(s), road(s), temple(s), mall(s), commercial center(s), manufacturing place(s) or one or more types of man-made or natural physical structure or things or establishments etc. specific pre-created or updated or updated by users of network ontology(ies), suggested keywords, structured data via domain or subject or entity specific forms (contextual one or more fields for enabling user to provide value(s) or details), tags, hashtags, keywords, semantic syntax, categories, types, taxonomy and based on user's current location or place or point of interest and associated information provided or access from one or more sources and/or one or more types of user data, system auto presents or suggest or enable to manually search, match & select contextual ontology(ies) and/or suggested keywords and/or taxonomy and/or categories or types and/or hashtags or tags to visual media capturer or recorder before or while or after capturing or recording or before, while or after posting for enabling to select and associate or updated one or more ontology(ies), suggested keywords, tags, hashtags, keywords, semantic syntax, categories, types, taxonomy and provided.

In another embodiment user can also provide object criteria or object model via select image, scan object or image, search & select image, capture photo or record video, drag and drop image, upload image e.g. 6942, and based on said provided object model or sample image, system recognizes said provided object inside visual media items based on object recognition and optical character recognition (OCR) technologies.

Following are some exemplary search queries:

(1) Show me all high fashion shops of New York City
(2) Show live customer engagements at particular type(s) of shops
(3) Show me latest cars in my area
(4) SQL Query=“select salable flats in Mumbai”
(5) Show particular location or place or map specific area
(6) I want to view latest books
(7) I want to view latest technology products
(8) I want to view latest recipe of <particular Food Item>
(9) I want to view latest demo or presentation of singer sewing machine
(10) I want to view latest gift products in Mumbai shops
(11) I want to live visit hair salon of Hong Kong
(12) I want view inside of “Coffee Day”, Comm Mall
(13) How they prepare Dosa at banana leaf, Vivana Mall, Thane
(14) I want to view all arts shops at Jaipur
(15) I want to view Dewali festivals at various places sp. Fireworks
(16) Show me sp. High price chocolates
(17) Show user review of particular product, show discounted products, show new products at particular place or shop etc.
(18) Show me: CD, music instrument, cloths, vehicles, jewelry, bike, ships, fruits, vegetables, department stores, particular types of items, particular color of purses at various places, flowers, how restaurant or hotels or hotel rooms looks inside at particular place(s).

FIG. 71 illustrates user to user providing and consuming on-demand services system, platform and exemplary embodiment and related exemplary user interface including user to user visual media taking or photographer services. FIG. 71 illustrates user to user providing and consuming on-demand services or user services based on points system, platform and exemplary embodiment and related exemplary user interface including user to user visual media taking or photographer services. According to some embodiments, system 100 can be implemented through software that operates on a portable computing device, such as a mobile computing device 110. System 100 can be configured to communicate with one or more network services, databases, objects that coordinate, orchestrate or otherwise provide user to user on-demand services. Additionally, the mobile computing device can integrate third-party services which enable further functionality through system 100.

As an alternative or addition, some or all of the components of system 100 can be implemented on one or more computing devices, such as on one or more servers or other mobile computing devices. System 100 can also be implemented through other computer systems in alternative architectures (e.g., peer-to-peer networks, etc.). Accordingly, system 100 can use data provided by an on-demand service searching & providing/consuming service system, data provided by other components of the mobile computing device, and information provided by a user in order to present user interface features and functionality for enabling the user to view, search, match, filter, identify or determine location and estimate time to arrive or reach, notify, book, transact and request an on-demand service. The user interface features can be specific to the location or area that the computing device is located in, so that area-specific information can be provided to the user. System 100 can also update the user interface features, including the content displayed as part of the user interface features, based on other user selections.

In some implementations, system 100 includes an on-demand service searching & providing/consuming service application 110, a map component 140, a map database 143, and location identification 145. The components of system 100 can combine to provide user interface features that are specific to user selections, user actions, activities, events, behavior, transactions & logs, user data, user location, user preferences & privacy settings to enable a user to view, access, search, match, select, notify, communicate, collaborate, negotiate, view or ask information, transact, & request on-demand services. The on-demand service application 110 can correspond to a program that is downloaded onto a smartphone, portable computer device (e.g., tablet or other location-aware device). In one implementation, a user can download and install the on-demand service application 110 on his or her computing device and register the computing device 110 with an on-demand service system.

The on-demand service searching & providing/consuming service application 110 can include an application manager 115, a user interface (UI) component 120, and a service interface 125. The service interface 125 can be used to handle communications exchanged between the on-demand service searching & providing/consuming service application 110 and the on-demand service searching & providing/consuming service system 170 (e.g., over a network). For example, the service interface 125 can use one or more network resources of the device 110 for exchanging communications over a wireless network. The network resources can include, for example, a cellular data/voice interface to enable the device to receive and send network communications over a cellular transport. As an alternative or variation, the network resources can include a wireless network interface for connecting to access points or for using other types of wireless mediums.

The application manager 115 can receive user input 111, location information 147, and other information (such as user information 151) to configure content that is to be provided by the UI component 120. For example, the UI component 120 can cause various user interface features 121 to be output to a display of the computing device 110. Some of the user interface features 121 can be area-specific (e.g., based on the current location of the computing device) to display information that is particular to the area. The user interface features 121 can also provide dynamically updated content based on user selections provided via the user input 111.

For example, the UI component 120 uses a UI framework that can be configured with various content, such as UI content 175 provided by the on-demand service searching & providing/consuming service system 170 and content as a result of user input 111. The UI component 120 can also configure the UI framework with location information 147 and map content 141. In this manner, a map of an area in which the user is currently located in can be displayed as part of a user interface feature 121. In some examples, the map component 140 can provide the map content 141 using map data stored in one or more map databases 143. Based on the locale of the user and the user selection(s) made for requesting an on-demand service, such as a type of visual media taker or type of food or a type of vehicle that the user would like to be transported in, the application manager 115 can cause area-specific and user-selection-specific UI content 175 to be presented with or as part of a user interface 121.

In some implementations, the user interfaces 121 can be configured by the application manager 115 to display information about on-demand services that are available for the user-specific area. On-demand services can include request visual media takers or general user as photographer service, order food & grocery delivery, request supply chain & logistics, home services, travel services, plumber, electrician, mechanic, maid, cleaner, order package delivery, local meals, request business services, health services, request availability of rooms, request freelancers, lawyers, tutor, doctors, support, courier, laundry, flower delivery, repair, car wash, ice creams, carpenter, tailor, deliver, hawkers services or other services that the user wants to search and can request via the on-demand service searching & providing/consuming service system. Based on the user's area, different services and service options can be available for the user.

For example, for an on-demand photographer, photographer may be available in one city, and unavailable in another. In various examples described, the user interfaces 121, which displays information about services available for a user, as well as features to enable the user to request services, can be configured with network user interface content (e.g., provided by the on-demand service system 170) to reflect the services available to the user based on the user's geographic area, type of services, and user profile. The user is enabled to interact with the different displayed user interface features 121, via the user input 111, to make selections and input preferences when requesting an on-demand service from the on-demand service searching & providing/consuming service system 170.

When the on-demand service application 110 is operated by the user, the various user interfaces 121 can be rendered to the user based on the user inputs 111 and/or information received from the on-demand service searching & providing/consuming service system 170. These user interfaces include, for example, a home page user interface (e.g., an initial page or launch page), a selection feature, a presentation user interface, contextual user actions menu or interface, a location suggestion user interface, a location search user interface, a confirmation user interface, or a combination of any of the features described. For example, the UI component 120 can cause a home page user interface 121 to be displayed that identifies the service(s) that the user can request using the on-demand service searching & providing/consuming service application 110. The home page user interface 121 can also provide only certain service selection options or types that are available in the user's area. In this manner, based on the current location of the computing device, the on-demand service searching & providing/consuming service application 110 can cause location-specific user interfaces 121 and content to be presented to the user.

In many instances, a geographic area that is specific to the user can be based on the user's current location (e.g., the current location of the computing device 110) or the user's requested service location (e.g., the photo taking location or point of interests where user stand to take visual media, the pickup location for a transport service, or a delivery location for a food service). For example, in some cases, the current location can be different from the requested service location, so that the user can manually select a particular pickup location or delivery location that is different from the current location of the computing device 110. The user's current location or service performance location can be determined by the location determination 145.

The location determination 145 can determine the location of the computing device in different ways. In one example, the location determination 145 can receive global positioning system (GPS) data 161 from location-based/location-aware resources 160 of the computing device 110. In addition, the location identification 145 can also receive GPS data 161 from other applications or programs that operate on the computing device 160. For example, system 100 can communicate with one or more other applications using one or more application program interfaces (APIs). The on-demand service searching & providing/consuming service application 110 can use the location information 147 to cause the UI component 120 to configure the UI framework based on the location information 147. In addition, the on-demand service searching & providing/consuming service application 110 can provide the user's location data 119 to the on-demand service searching & providing/consuming service system 170.

As an addition or alternative, the on-demand service searching & providing/consuming service application 110 can determine the user's current location or pint of interests location or pickup location (i) by using location data 177 provided by the on-demand service searching & providing/consuming service system 170, (ii) by using user location input provided by the user (via a user input 111), and/or (iii) by using user data 151 stored in one or more user databases 150.

For example, the on-demand service searching & providing/consuming service system 170 can cross-reference the location data 119 (received from the on-demand service searching & providing/consuming service application 110) with the other sources or databases (e.g., third party servers and systems) that maintain location information to obtain granular/specific data about the particular identified location. In some cases, by cross-referencing the data, the on-demand service searching & providing/consuming service system 170 can identify particular stores, restaurants, apartment complexes, venues, street addresses, etc., that are proximate to and/or located at the identified location, and provide this information as location data 177 to the on-demand service application 110. The application manager 115 can cause the UI component 120 to provide the specific location information as part of the user interface 121 so that the user can select a particular store or venue as the current location or the service performance location (e.g., a pick up location or delivery location).

The on-demand service searching & providing/consuming service application 110 can also receive user location input provided by the user to determine the current location or service location of the user. In one example, the on-demand service application 110 can cause the UI component 120 to present a location search user interface on the display. The user can input a search term to identify stores, restaurants, venues, addresses, etc., that the user wishes to request the on-demand service. The on-demand service searching & providing/consuming service application 110 can perform the search by querying one or more external sources to provide the search results to the user. In some variations, the user can manually provide user location input by entering an address (e.g., with a number, street, city, state) or by manipulating and moving a service location graphic/icon on a map that is displayed as part of a user interface 121. In response to the user selection, the on-demand service searching & providing/consuming service application 110 can provide the location data 119 to the on-demand service searching & providing/consuming service system 170.

The geolocation or position component or module 145 communicates with the GPS sensor to access an updated or a current geolocation of the mobile device. The geolocation information may include updated GPS coordinates of the mobile device. In one example, the geolocation or position component or module 160 periodically accesses the geolocation information every minute. In another example, the geolocation or position component or module 145 may dynamically access the geolocation information based on other usage (e.g., every time the mobile device is used by the user). In another embodiment geolocation or position component or module 145 may use various available technologies which determines and identifies accurate user or user device location or position including Accuware™ which provides up-to approx. 6-10 feet indoor or outdoor location accuracy of user device and can be integrated via Application Programming Interface (API). Various types of Beacons including iBeacons helps in identifying user's exact location or position. Many companies tap into Wi-Fi signals that are all around us—including when we are indoors.

The position module communicates with the position sensor to access direction information and position information of the mobile device. The direction information may include a direction in which the mobile device is currently pointed. The position information may identify an orientation in which the mobile device is currently kept.

In another variation, the on-demand service searching & providing/consuming service application 110 can retrieve and use user data 151 that are stored in a user database 150. The user database 150 can include records of the user's previous on-demand service requests or interests as well as user preferences. In some implementations, the user database 150 can be stored remotely at the on-demand service searching & providing/consuming service system 170 and user information can be retrieved from the on-demand service searching & providing/consuming service system 170. The on-demand service searching & providing/consuming service application 110 can use the data stored in the user database 150 to identify previous service locations for the user. Based, in part, on the current location of the computing device 110, the on-demand service searching & providing/consuming service application 110 can use the user data 151, such as the user's home address, the user's place of business, the user's preferences, etc., such as the frequency and recency of previous locations that the user requested services at, to provide recent and/or recommended points of interest to the user. When the user selects one of the entries of a recommended point of interest as a current location and/or pickup location, the on-demand service application 110 can provide the location data 119 to the on-demand service system 170.

Based on the user's current location or service location, the application manager 115 can cause area-specific user interface features 121 to be outputted by the UI component 120. An area that is specific to the user includes the current location (or service location) in which on-demand services can be provided to the user. The area can be a city or metropolitan area in which the computing device 110 is currently located in, can be an area having a predetermined distance radius from current location (e.g., six miles), or can be an area that is specifically partitioned from other areas. Based on the user's area, the application manager 115 can cause area-specific information about the on-demand service to be provided on one or more user interface features 121.

Area-specific information about the on-demand service can be provided, in part, by the on-demand service system 170. As discussed, the on-demand service application 110 can provide location information to the on-demand service system 170 so that the on-demand service system 170 can arrange for a service to be provided to a user (e.g., arrange a visual media taker user service or a photographer provider service). Based on the user-specified area, the on-demand service system 170 can provide information about available service providers (e.g., local photographers or visual media takers who resides at that area) that can perform the on-demand service in that area.

For example, for a visual media taker or photographer service, a visual media taker or photographer on-demand service searching & providing/consuming service system 170 can maintain information about the number of available photographers or users of network who are willing to provide photographer service or visual media taker services and requestors who want to consume said photographer or visual media capturing or recording or shooting service, the number of available photographers and requestor or prospective consumers of photo service or visual media taking service, which photographers or visual media taking service providers are currently performing a photography or visual media capturing or recording service, which requestors or prospective consumers of photographer service or visual media taking service currently looking for photographer service or visual media taking service, which photographer or visual media taking service provide(s) are ready to come at requestor's location and provide photographer service or visual media taking to users, which tourist or visual media shooting service consumer are ready to capture photo (s0 or video(s) travel or waiting for photographer or visual media taking service provider, the current location of the visual media taking service provider and service consumer, the direction and destination of the visual media taking service provider and/or service consumer in motion, etc., in order to properly facilitating the service between visual media taking service provider and service consumer including searching, matching, viewing, selecting, navigating, browsing, accessing, filtering, sorting, bookmarking, sending request or like or status (e.g. I want photographer etc.), requirement (e.g. type of service provider e.g. ratings, number of points, local photographer, expert photographer, guide, nearest available photographer, provider as well as consumer of service), negotiating (points), comparing, communicating (queries, chat, terms & conditions etc.), providing information (schedule, arriving time, time to reaching at point of interest, location of point of interest, plan to take visual media at one or more point of interests, requirement details etc.). Because services can vary between areas, such as cities, the application manager 115 can cause only information pertinent to the user's specific area to be provided as part of the user interface 121.

Using the information maintained about the services, the service providers and prospective or actual consumers, on-demand service searching & providing/consuming service system 170 can provide relevant information to the on-demand service searching & providing/consuming service application 110. Service information 171 can correspond to information about the particular on-demand service that can be arranged by the on-demand service searching & providing/consuming service system 170 (e.g., photographer service or visual media taking service, food services, delivery services, transport services services). Service information 171 can include information about costs for the service, available service options (e.g., types of photographer available (novice or general, experts, professional), types of food available, types of entertainment, delivery options), or other details (e.g., available times, specials, etc.). Provider information 173 can correspond to information about the available service providers themselves, such as profile information about the providers, the current location or movement of the photographer or visual media taking service provider, delivery vehicles, transport vehicles, food trucks, etc., or the types of vehicles.

Referring back to the example of an on-demand transport service, if the user become online and select one or more types of on-demand services e.g. photographer service or visual media taking service, transport or cab service, the on-demand services, service providers and consumers presenting, searching and facilitating in providing & consuming service system 170 would present nearest or area specific or preferences specific services, service providers. on-demand services, service providers and consumers presenting, searching and facilitating in providing & consuming service system 170 can transmit relevant service information 171 (e.g., number of points for the photographer service or visual media taking service (as per photo capturing or recording per video, duration of shooting, number of takes and retakes, guide service etc.), cost for the service, promotions in the area) and relevant provider information 173 (e.g., photographer or visual media taking service provide information, profile information) to the on-demand service application 110 so that the on-demand service application 110 can cause area-specific information to be presented to the user. For any type of on-demand service, the on-demand service system 170 can transmit service information 171 and/or service provider information 173 to the on-demand service application 110.

As an example, an area-specific user interface feature 121 can include a selection interface. The selection interface can include a selection feature that can be accessed by the user (e.g., by interacting with an input mechanism or a touch-sensitive display screen) in order to select one or more service options to search, match, view & request the on-demand service. Based on the user's determined area, type of services, preferences, option selections the selection interface can identify and display only type of service(s) specific service provider(s) to consumers and prospective consumers to service provider(s).

When the user interacts with the multistate selection feature, additional information corresponding to the selected service option can be provided in an area-specific user interface feature 121. In one implementation, the user interface feature 121 can correspond to a summary panel that displays area-specific information about the selected service option. For example, for an on-demand photographer service or visual media taking service, once a user makes a selection of a type of service (e.g., a type of or rating of photographer or visual media taking service provider (novice, free, sponsored, expert, professional, guide etc.), the summary panel can display information about the closest available photographer service or visual media taking service provider, the average point for consuming or providing photographer service or visual media taking service, service provider profile information, or other information that the user can quickly view to make an informed decision.

In another example, for an on-demand transport service, the summary panel can provide area-specific information, such as the estimated time of arrival for shooting location or point of interest location or pickup (based on the user's current location or pickup location and the current locations of the available photographer service or visual media taking service provider of the selected type), the average points required to consume service based on the area (e.g., the average estimated points can be area-specific because some areas can be more expensive than other areas or some of the tourist places related areas have more demand and supply, and the capacity of the photographer service or visual media taking service providers (how many photos or videos can photographer service or visual media taking service takes in a day or pick hours i.e. tourist or visitors date and/or timings). In one variation, the summary panel can be provided concurrently with the multistate selection panel so that when the user manipulates the multistate selection feature to select different service options, the content within the summary panel can be dynamically adjusted by the on-demand service application 110 to provide updated information corresponding to the selected option.

Once the user makes a selection by providing a user input 111, the application manager 115 can cause the UI component 120 to provide user interface features 121 that are based on the selected service option. The user or service providers can then view, search, match, sort, filter, communicate, compare, negotiate, book, request for the on-demand service based on the selection. In one example, when the user makes a request, a confirmation user interface feature 121 can be provided by the on-demand service application 110. From this user interface feature, the user can view the details of the request, such as what account or credit card to charge (and can edit or choose a different payment method e.g. point based service), provide specific requests to the photographer service or visual media taking service, enter a promotional code for a discount, select volunteer or free or sponsored service, calculate the price or number of points, cancel the request, or confirm the request. As an alternative, the request can be automatically confirmed without displaying a confirmation user interface feature 121.

After the user confirms the request for the on-demand service, the on-demand service application 110 can provide the service request 117 directly to the service provider via on-demand service system or server 170 via the service interface 125. In some examples, the service request 117 can include the service location specified by the user (e.g., the location where the user would like the service to be performed or provided), the user's account information, the selected service option, any specific notes or requests to the service provider, and/or other information provided by the user. Based on the received service request or indication to consume service 117, the on-demand service system 170 can send request or indication to consume service to selected (e.g. from map) or online or available & nearest or within particular distance or radius specific online or available service provider(s). The on-demand service system 170 can provide additional provider information 173 to the on-demand service application 110, such as the particular service provider who will be fulfilling the service, the service provider's ratings, etc., so that this information can be provided to the user on a user interface 121.

FIG. 72 (A) illustrates interface for visual media taking service consumer e.g. [Yogesh] 7212 i.e. who want photographer or nearest user of network who are ready to provide photo taking service to user for capturing photo of user or recording video of user or prospective consumer or requestor of service. Visual media taker service consumer or requestor user e.g. [Yogesh] 7212 can start location service on or off 7202. In another embodiment user is promoted with starting or activating location service if user device location service is off. Visual media taking service consumer user e.g. [Yogesh] can start requesting or consuming of service by activating service or ON the system 7204 or can deactivate or OFF the system 7204. User e.g. [Yogesh] 7212 can request or sending request for consuming visual media taking or photographer service 7204 with intention to capturing requesting user's e.g. [Yogesh] 7212 photo or recording of requesting user's e.g. [Yogesh] 7212 video by said request accepted visual media taking service provider or photographer. Then requesting user e.g. [Yogesh] 7212 can select requesting user's device's location as current location 7216 or search and select one or more locations or point of interests or places 7215 (e.g. search and select on map) where requesting user e.g. [Yogesh] 7212 wants to take visual media including capture photos or recording videos or shooting. In another embodiment requesting user e.g. [Yogesh] 7212 can also provide or selects types of visual media taking service providers including novice, paid, point based, type of mobile device or camera or accessories holder, free, sponsored, experts, professional, nearest, particular rating holders, particular language(s) known, local user, with guide service provider, requirement specifications (number of photos and/or videos at number and names of locations or places or points of interests or spots) etc. In the event of starting of location service 7202 and sending request 7204 and providing shooting location 7216 or 7215 and/or providing requirements specifications for types of service provider, system matches requesting user's e.g. [Yogesh] 7212 current location and/or types of service provider requirement specification with nearest locations of photographers or visual media taking service providers and/or profile & ratings of visual media taking service providers and presents on the map 7213 matched visual media taking service providers (e.g. 7217, 7208 and 7210) for requesting user's selection e.g. [Yogesh] 7212 of visual media taking service provider or system auto send request to nearest or requesting user's requirement specification specific matched visual media taking service providers. In the event of requesting user's e.g. [Yogesh] 7212 selection of visual media taking service provider e.g. user [Candice] 7217 from map 7213 or in the event of sending of requesting user's request to matched visual media taking service providers e.g. user [Candice] 7217 then e.g. matched user [Candice] 7217 receives notification or indication about said request and enabled to accept or reject or miss said request. In the event of accepting of request by visual media taking service providers e.g. user [Candice] 7217, requesting user e.g. [Yogesh] is notifies about accepting of request by visual media taking service providers e.g. user [Candice] 7217. Requesting user can view profile, manually send request to selected visual media taking service providers user(s) on map, view status of visual media taking service providers e.g. user [Candice] 7217 including request send, request received, request viewed, request accepted or canceled or missed, arriving or on route and arrived with route or estimated or updated time to arrival or arriving, view or provide ratings and reviews after consuming service, communicate via chat or call or one or more other communication applications via selected visual media taking service provider associated contextual menu 7206 on the map 7213. User can provide or select preferences of consuming of particular type(s) of visual media taking service provider(s) including novice, paid, point based, type of mobile device or camera or accessories holder, free, sponsored, experts, professional, nearest, particular rating holders, particular language(s) known, local user, with guide service provider visual media taking service providers 7218. User can provide or update user's profile information including optionally name, age, gender, photo, travel locations information or travel plan, interests, qualifications, home address and like 7219.

FIG. 72 (B) illustrates interface for Visual media taking service provider user e.g. [Candice]. Visual media taking service provider user e.g. [Candice] can start location service on or off 7222. In another embodiment user is promoted with starting or activating location service if user device location service is off. Visual media taking service provider user e.g. [Candice] can start providing of service 7224 by activating service or ON the system. Visual media taking service provider user e.g. [Candice] can deactivate or OFF the system the providing of visual media taking service 7224. In the event of starting of location service 7222 and starting of providing of visual media taking service 7224, in an embodiment system presents on the map requesting users or prospective service consumers (e.g. 7228 or 7230 or 7232) for enabling visual media taking service provider to select from map e.g. selection of user [Yogesh] 7232 or in another embodiment receives requests from nearest or matched prospective requestors or consumers of service 7223. For example user [Candice] 7217 receives notification or indication about said request from user [Yogesh] and enabled to accept or reject or miss said request. For example user [Candice] accepts said request of requesting user e.g. [Yogesh]. Visual media taking service provider user can view profile, manually send request to selected visual media taking service consumer user(s) on map, accept or reject or miss request of requestor, view status of visual media taking service consumer including request send, request received, request viewed, request accepted or canceled or missed, reaching at selected point of interest or place or on route and estimated or updated time to arrival or arriving at particle point of interest, view or provide ratings and reviews after providing service, communicate via chat or call or one or more other communication applications via selected visual media taking service consumer associated contextual menu 7226 on the map 7233. User can provide or select preferences of particular type(s) of visual media taking service consumer(s) including paid, number of points required for service, rating of service requestor or consumer, residence of particular country or location, particular language(s) known & like 7234. User can provide or update user's profile information including optionally name, age, gender, photo, interests, language, qualifications, home address and like 7235.

After accepting request (e.g. request of user [Yogesh] and arriving at requestor's location or requestor specified particular location of point of interest or place, visual media taking service providers e.g. user [Candice] can select or auto presented with visual media capture or record and preview interface with various options 7250. Visual media taking service providers e.g. user [Candice] can change front camera or back camera mode 7247 and can take photo via tapping or clicking on photo icon 7245 or can record video via tapping or clicking on video icon 7245 or using multi-tasking visual media capture controller control(s) or label(s) and/or icon(s) (as discussed in FIGS. 43-52) of requesting e.g. user [Yogesh] or his family or friends or accompanied one or more persons with preferred or suggested location(s) or point of interest(s) or place(s) or scene(s). After capturing photo or recording of video 7244, visual media taking service providers e.g. user [Candice] can preview said captured photo or recorded video for pre-set duration 7242 for enabling to remove 7245 or review and in the event of expiration of said pre-set duration 7242 of preview and non-removing of said captured or recorded or previewed visual media including photo or video, system auto send 7246 said captured or recorded or previewed visual media including photo or video 7244 from visual media taking service provider's device e.g. user [Candice]'s device 7201 to requesting user's device e.g. user [Yogesh]'s device 7299 and provide notification or indication 7266 of receiving of visual media and presents on display or user interface 7260 said received visual media e.g. 7246 for user preview for pre-set duration of time 7262 for enabling viewing or receiving user to remove 7265 or review or accept 7271 or reject 7265 said received visual media 7264 from visual media taking service providers e.g. user [Candice] and in the event of expiration of said pre-set duration 7262 of preview 7264 and non-removal of said received visual media 7264, auto accepts said received visual media 7264 and store said received visual media 7264 at local storage of user device 7299 and in the event of expiration of said pre-set duration 7262 of preview and removal 7265 of said received visual media 7264, then auto send notification about rejection of said visual media 7264 or auto send request to re-take visual media to visual media taking service providers e.g. user [Candice] device 7201 or user interface 7250 (e.g. all updated indications or notifications or status message(s) area 7246). In another embodiment requesting user e.g. user [Yogesh] can manually send request to re-take visual media 7273 to/at visual media taking service providers e.g. user [Candice]'s device 7201 or user interface 7250.

In another embodiment system saves or not save said captured or recorded or previewed visual media at visual media taking service provider's device's or local storage of device. In another embodiment requesting user after accepting of photo or video can also send request to take more photos or videos 7275 or can tap on “done” to finish shooting session or end capturing or recording of photos or videos 7277. In another embodiment visual media taking service provider can accept request to re-take or request to take more photos and/or videos and tap on “start” button 7252 or capture photo via photo icon 7245 or record video via video icon 7246 or reject request to re-take or request to take more photos and/or videos or tap or click “done” button 7251. In another embodiment after finishing of photo or video capture session by requestor or consumer of service or provider of service then presents rating and review interface to both service consumer 7278 and service provider 7253 user for enabling to rate each other or provide review for each other. In another embodiment visual media taking service providers e.g. user [Candice] can request 7254 visual media taking service consumer e.g. user [Yogesh] to provide visual media taking service to e.g. user [Candice]. In another embodiment in the event of acceptance of photo or video captured or recorded and send by visual media taking service providers e.g. user [Candice] by visual media taking service consumer e.g. user [Yogesh] then add particular pre-defined or customized numbers of points to visual media taking service providers e.g. user [Candice]'s account and deduct said number of points from visual media taking service consumer e.g. user [Yogesh]'s account.

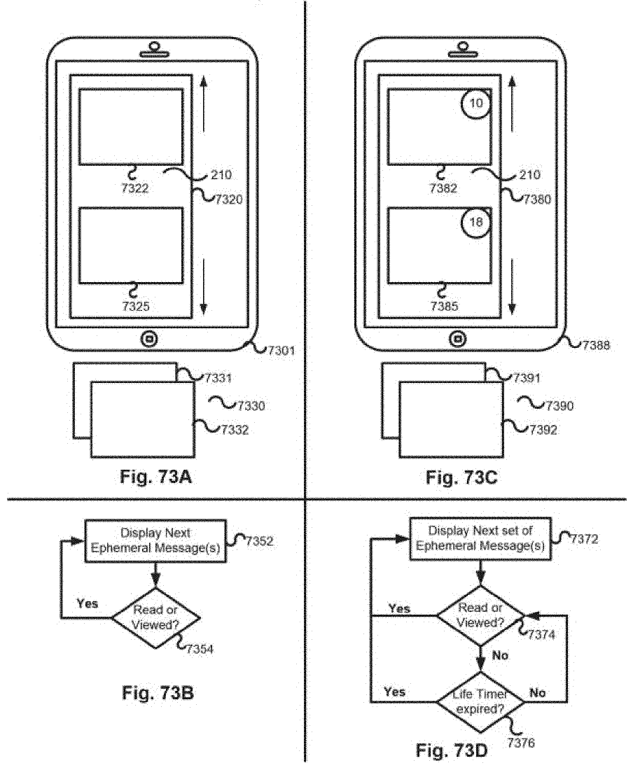

In an another embodiment FIGS. 73 (A) and 73 (B), an ephemeral message controller with instructions executed by a processor to: present on a display indicia of a set of ephemeral messages available for viewing; present on the display a first set of ephemeral message(s) 7352 (e.g. 7320-7322 and 7325) of the collection of ephemeral messages 7320 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof); identify one or more viewed or read and not-viewed or not-read or unread visual media items or news items or messages or one or more types of contents 7354 (e.g. 7320-7322 (status=viewed) and 7325 (status=not viewed); in the event of identification of read or viewed content items, remove said identified as read or viewed content items (e.g. 7322) and in the event of identification of not-read or not-viewed content items (e.g. 7325) keep as it and present on feed said identified as not-read or not-viewed content items (e.g. 7325) on the display 210 and present or append removed numbers of content items equivalent or pre-set number of or available to present content items or add or replace or show content item(s) in place of removed content item(s) (e.g. 7320-7331 and 7332) on the display 210.

In another embodiment enable user to mark one or more presented visual media items or content items as read or unread via haptic contact engagement or tap on one or more visual media items or content items or using of user action or button or control or read/unread switch or selection of preferred menu items including selection of read or unread menu item. In another embodiment system loads particular pre-set number of messages or visual media items or content items. In an another embodiment system auto determines read or unread status of one or more presented or provided visual media items or content items based on identification of user's tap on each indicia or list item or index of content item for opening of message or visual media item or content item, open application or feed interface for particular period of time, based on eye tracking system identification of user's view of message or visual media item or content item or based on eye tracking system identification of user's view of message or visual media item or content item for pre-set duration, scrolling of feed for pre-set period of time, one or more types of user actions on message or visual media item or content item, view and close or switch interface after pre-set period of time,

In an another embodiment FIGS. 73 (C) and 73 (D), an ephemeral message controller with instructions executed by a processor to: present on a display indicia of a set of ephemeral messages available for viewing; present on the display a first set of ephemeral message(s) 7372 (e.g. 7380-7382 and 7385) of the collection of ephemeral messages 7380 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof); identify one or more viewed or read and not-viewed or not-read or unread visual media items or news items or messages or one or more types of contents 7374 (e.g. 7380-7382 (status=viewed) and 7385 (status=not viewed); in the event of identification of read or viewed content items, remove said identified as read or viewed content items (e.g. 7382) and in the event of identification of not-read or not-viewed content items (e.g. 7385) keep as it and present on feed said identified as not-read or not-viewed content items (e.g. 7385) on the display 210 up-to expiration of life timer (7376—Yes) and in the event of expiration of life time (7376—Yes), remove said expired content item (e.g. 7385) and present or append removed numbers of content items equivalent or pre-set number of or available to present content items or add or replace or show content item(s) in place of removed content item(s) (e.g. 7320-7331 and 7332) on the display 210.

In an another embodiment FIGS. 74 (A) and 74 (B), an ephemeral message controller with instructions executed by a processor to: present on the display a first set of ephemeral message(s) 7452 (e.g. 7420-7422 and 7425) of the collection of ephemeral messages 7420 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof) for a first transitory period of time defined by a timer 7456, wherein the first set of ephemeral message(s) (e.g. 7422 and 7425) is/are deleted when the first transitory period of time expires 7456—Yes; enable user to mark one or more visual media item(s) or content item(s) or news items or messages or one or more types of contents as non-ephemeral 7454—Yes (e.g. 7420-7422 (mark as non-ephemeral) during the first transitory period of time 7456; in the event of mark as non-ephemeral 7454 to one or more messages or visual media items or content items (e.g. 7420-7422 (mark as non-ephemeral) during the first transitory period of time 7456, keep in feed or display 210 as it or save or save & hide or bookmark message(s) or visual media item(s) or content item(s) (e.g. 7422 (i.e. mark as non-ephemeral message) and proceeds to present on the display 210 or append to feed 7420 a second set of ephemeral message(s) (e.g. 7430-7431 and 7432) of the collection of ephemeral messages for a second transitory period of time defined by the timer 7456, wherein the ephemeral message controller 277 deletes the second set of ephemeral message(s) (e.g. 7430-7431 and 7432) upon the expiration of the second transitory period of time 7456—Yes; wherein the second set of ephemeral message(s) is/are deleted 7458 when the non-marking as non-ephemeral 7454—No during the second transitory period of time 7456; and wherein the ephemeral message controller 277 initiates the timer upon the display of the first set of ephemeral message and the display of the second set of ephemeral message. In another embodiment user can mark message or content item or visual media item (e.g. 7422) as non-ephemeral via tap on message area or use switchable button or control or menu item. In another embodiment user can mark all presented message or content item or visual media item (e.g. 7422) as non-ephemeral via tapping on non-message area on display 210. In another embodiment show mark as non-ephemeral status on each marked message at prominent place.

In an another embodiment FIGS. 74 (A) and 74 (C), an ephemeral message controller with instructions executed by a processor to: present on the display a first set of message(s) 7472 (e.g. 7420-7422 and 7425) of the collection of messages 7420, wherein the first set of message(s) (e.g. 7422 and 7425) is/are saved or bookmarked or saved & hide or keep as it on the display 210 when the first transitory period of time expires 7476—Yes; enable user to mark one or more visual media item(s) or content item(s) or news items or messages or one or more types of contents as ephemeral 7474—Yes (e.g. 7420-7422 (mark as ephemeral) during the first transitory period of time 7476; in the event of mark as ephemeral 7474—Yes to one or more messages or visual media items or content items (e.g. 7420-7422 (mark as ephemeral) during the first transitory period of time 7476, the ephemeral message controller 277 deletes the marked as ephemeral message (e.g. 7422) and proceeds to present on the display 210 or append to feed 7420 a second ephemeral message (e.g. 7431) of the set of ephemeral messages 7430, wherein in the event of non-mark as ephemeral, keep in feed or display 210 as it or save or save & hide or bookmark message(s) or visual media item(s) or content item(s) (e.g. 7425); and wherein the ephemeral message controller 277 initiates the timer upon the display of the first set of message and the display of the second set of message. In another embodiment user can mark message or content item or visual media item (e.g. 7422) as ephemeral via tap on message area or use switchable button or control or menu item. In another embodiment user can mark all presented message or content item or visual media item (e.g. 7422) as ephemeral via tapping on non-message area on display 210. In another embodiment show mark as ephemeral status on each marked message at prominent place.

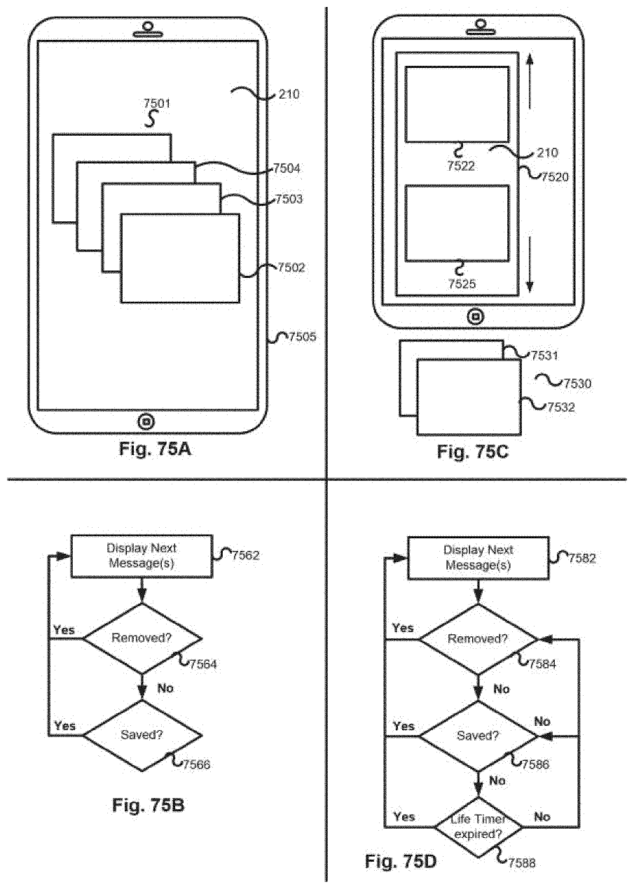

In an another embodiment in FIGS. 75 (A) and 75 (B) an ephemeral message controller 277 with instructions executed by a processor 230 to: present on a display indicia of a set of ephemeral messages available for viewing; present on the display a first ephemeral message (e.g. 7502) of the set of ephemeral messages (7501), wherein the first ephemeral message is deleted in the event or receiving remove instruction from user via tapping on remove button or particular type of pre-defined haptic contact engagement (e.g. one tap) or one or more types of pre-defined user sense from one or more types of one or more sensors from user device(s) and proceeds to present on the display 210 a second ephemeral message (7503) of the set of ephemeral messages (7501) OR the first ephemeral message is saved in the event or receiving save or bookmark or like instruction from user via tapping on save or bookmark or like button or particular type of pre-defined haptic contact engagement (e.g. two tap) or one or more types of pre-defined user sense from one or more types of one or more sensors from user device(s) and display of the existing message is hide or terminated and proceeds to present on the display 210 a second ephemeral message (7503) of the set of ephemeral messages (7501). So user must have to provide either remove or save instruction via one or more types of user command including tap on button or icon or image or control or particular type of haptic contact engagement of anywhere on the display (e.g. one tap or two tap or refit or left or up or down swipe) or one or more types of user senses via one or more types of user device(s)′ sensors to view next message (if any available). If not then user will not able to view next message.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the ephemeral message controller 277 monitors' pre-defined types of signals from the touch controller 215. If particular pre-defined type of haptic contact is observed by the touch controller 215 (e.g. tap on “remove” icon, one tap anywhere on display, swipe up etc.) during the display of an ephemeral message, then the existing message is removed and display of the existing message is terminated and a subsequent ephemeral message, if any, is displayed or if another type of pre-defined type of haptic contact (e.g. tap on “save” icon, two immediate tap or double tap anywhere on display, swipe down etc.) is observed by the touch controller 215 during the display of an ephemeral message, then the existing message is saved and the display of the existing message is terminated and a subsequent ephemeral message, if any, is displayed. In one embodiment, two haptic signals may be monitored. A continuous haptic signal may be required to display a message, while an additional haptic signal may operate to terminate the display of the message. For example, the viewer might tap the screen with a finger while maintaining haptic contact with another finger. This causes the screen to display the next piece of media in the set. In one embodiment, the haptic contact to terminate display of a message is any gesture applied to any location on the display 210. In another embodiment, the haptic contact is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The processor 230 is also coupled to image sensors 244. The image sensors 244 may be known digital image sensors, such as charge coupled devices. The image sensors capture visual media, which is presented on display 210. The processor 230 is also coupled to one or more sensors including Orientation Sensor 237, Position Sensor 242, GPS Sensor 238, Audio sensor 245, Proximity Sensor 246, Gyroscope 247, Accelerometer 248 and other one or more types of sensors 250 including hover sensor, eye tracking system via optical sensors 240 or image sensors 244. In one embodiment, the ephemeral message controller 275 monitors signals or senses or one or more types of pre-defined equivalents of generated or updated sensor data from the one or more sensors including voice command from audio sensor 245 or particular type of eye movement from eye tracking system based on image sensors 244 or optical sensors 240 or hover signal from e.g. specific type of proximity sensor 246. If one of the pre-defined types of said senses detected or is observed by the said one or more types of sensors during the display of an ephemeral message, then the currently presented message is removed and display of the existing message is terminated and a subsequent ephemeral message, if any, is displayed. If another pre-defined types of said senses detected or is observed by the said one or more types of sensors during the display of an ephemeral message, then the currently presented message is saved and display of the existing message is terminated and a subsequent ephemeral message, if any, is displayed. In one embodiment, two types of signals or senses from sensors may be monitored. A continuous signal or senses from one or more types of sensors may be required to display a message, while an additional sensor signal or sense may operate to terminate the display of the message. For example, the viewer might instruct via voice command or hover on display or done one or more types of pre-defined eye movement. This causes the screen to either remove or save currently presented message on the display and display the next piece of media in the set on the display. In one embodiment, the one or more types of pre-defined signal or senses provide by user and detected or sense by sensor to save or terminate a message while media viewer application or interface is open or while viewing of display 210. In another embodiment, the sensor signal or sense is any sense applied on the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

FIG. 75 (B) illustrates processing operations associated with the ephemeral message controller 277. Initially, an ephemeral message is displayed 7562 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof). Enabling user to provide either remove 7564 or save 7566 instruction via one or more types of haptic contact engagement or user senses or tap on button or icon or control. The ephemeral message controller 277, in the event of receiving remove instruction 7564, remove currently presented message 7502, terminate display of the currently presented message 7502 and present next message 7503, if any on the display 210. The ephemeral message controller 277, in the event of receiving save instruction 7566, save currently presented message 7502, terminate display of the currently presented message 7502 and present next message 7503, if any on the display 210. So user has to provide either remove instruction 7564 or save instruction 7566 to display next message 7562.

FIG. 75 (A) illustrates the exterior of electronic device 200. The Figure also illustrates the display 210. The display 210 presents a set of messages 7501 available for viewing. A first message 7502 may be displayed. Upon receiving of remove instruction 7564, remove presented message 7502 and a second message 7503 is displayed. Alternately, receiving of save instruction 7566, save presented message 7502, hide display of presented message 7502 and a second message 7503 is displayed.

In an another embodiment in FIGS. 75 (C) and 75 (D) an ephemeral message controller 277 with instructions executed by a processor 230 to: present on a display indicia of a set of ephemeral messages available for viewing; present on the display a first ephemeral message (e.g. 7502) of the set of ephemeral messages (7501), wherein the first ephemeral message is deleted after expiring of life timer 7588 and during the life timer 7588 receiving of remove instruction from user via tapping on remove button or particular type of pre-defined haptic contact engagement (e.g. one tap) or one or more types of pre-defined user sense from one or more types of one or more sensors from user device(s) and proceeds to present on the display 210 a second ephemeral message (7503) of the set of ephemeral messages (7501) after expiry of life timer 7588 OR the first ephemeral message is saved after expiring of life timer 7588 and during the life timer 7588 receiving save or bookmark or like instruction from user via tapping on save or bookmark or like button or particular type of pre-defined haptic contact engagement (e.g. two tap) or one or more types of pre-defined user sense from one or more types of one or more sensors from user device(s) and display of the existing message is hide or terminated and proceeds to present on the display 210 a second ephemeral message (7503) of the set of ephemeral messages (7501) after expiry of life timer 7588. In the event of not receiving of either remove instruction 7584 or save instruction 7586 and expiration of life timer 7588, based on pre-setting either remove or save currently presented message 7502 and show next message 7503 on the display 210. So user must have to provide or change or update either remove or save instruction before expiry of life timer 7588 via one or more types of user command including tap on button or icon or image or control or particular type of haptic contact engagement of anywhere on the display (e.g. one tap or two tap or refit or left or up or down swipe) or one or more types of user senses via one or more types of user device(s)′ sensors to view next message (if any available). If not then user will not able to view next message.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the ephemeral message controller 277 monitors' pre-defined types of signals from the touch controller 215. If particular pre-defined type of haptic contact is observed by the touch controller 215 (e.g. tap on “remove” icon, one tap anywhere on display, swipe up etc.) 7584 during the display of an ephemeral message the user instruction is saved, then the existing message is removed based on updated user instruction (7584 or 7586) after expiry of pre-define life timer 7588 and display of the existing message is terminated 7502 and a subsequent ephemeral message 7503, if any, is displayed or if another type of pre-defined type of haptic contact (e.g. tap on “save” icon, two immediate tap or double tap anywhere on display, swipe down etc.) 7586 is observed by the touch controller 215 during the display of an ephemeral message 7502, then the user instruction is saved and after expiration of pre-defined life timer 7588 based on updated user instruction ((7584 or 7586)) existing message 7502 is saved (7586—Yes) and the display of the existing message 7502 is terminated and a subsequent ephemeral message 7503, if any, is displayed 210. In one embodiment, two haptic signals may be monitored. In one embodiment, the haptic contact to terminate display of a message is any gesture applied to any location on the display 210. In another embodiment, the haptic contact is any gesture applied to the message itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The processor 230 is also coupled to image sensors 244. The image sensors 244 may be known digital image sensors, such as charge coupled devices. The image sensors capture visual media, which is presented on display 210. The processor 230 is also coupled to one or more sensors including Orientation Sensor 237, Position Sensor 242, GPS Sensor 238, Audio sensor 245, Proximity Sensor 246, Gyroscope 247, Accelerometer 248 and other one or more types of sensors 250 including hover sensor, eye tracking system via optical sensors 240 or image sensors 244. In one embodiment, the ephemeral message controller 275 monitors signals or senses or one or more types of pre-defined equivalents of generated or updated sensor data from the one or more sensors including voice command from audio sensor 245 or particular type of eye movement from eye tracking system based on image sensors 244 or optical sensors 240 or hover signal from e.g. specific type of proximity sensor 246. If one of the pre-defined types of said senses detected or is observed by the said one or more types of sensors e.g. 7584 during the display of an ephemeral message 7502 then said user instruction is saved, then the after expiration of pre-set life timer 7588 and based on updated user instruction (e.g. remove instruction 7584) currently presented message 7502 is removed and display of the existing message 7502 is terminated and a subsequent ephemeral message 7503, if any, is displayed. If another pre-defined types of said senses detected or is observed by the said one or more types of sensors during the display of an ephemeral message, then the user instruction is saved (e.g. save instruction 7586) and then after expiration of life timer 7588 and based on updated user instruction (e.g. save instruction 7586) the currently presented message 7502 is saved and display of the existing message 7502 is terminated and a subsequent ephemeral message 7503, if any, is displayed. In one embodiment, two types of signals or senses from sensors may be monitored. A continuous signal or senses from one or more types of sensors may be required to display a message, while an additional sensor signal or sense may operate to terminate the display of the message. For example, the viewer might instruct via voice command or hover on display or done one or more types of pre-defined eye movement. This causes the screen to either remove or save currently presented message on the display and display the next piece of media in the set on the display. In one embodiment, the one or more types of pre-defined signal or senses provide by user and detected or sense by sensor to save or terminate a message while media viewer application or interface is open or while viewing of display 210. In another embodiment, the sensor signal or sense is any sense applied on the message itself. In one embodiment, the gesture is un-prompted (i.e., there is no prompt such as “Delete” or “Saving” to solicit an action from the user). In another embodiment, the gesture may be prompted (e.g., by supplying a “Delete” or “Save” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

FIG. 75 (D) illustrates processing operations associated with the ephemeral message controller 277. Initially, an ephemeral message is displayed 7582 (In an embodiment message or notification can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof). Enabling user to provide either remove 7584 or save 7586 instruction via one or more types of haptic contact engagement or user senses or tap on button or icon or control. The ephemeral message controller 277, in the event of receiving remove instruction 7584, remove currently presented message 7502, terminate display of the currently presented message 7502 and present next message 7503, if any on the display 210. The ephemeral message controller 277, in the event of receiving save instruction 7566, save currently presented message 7502, terminate display of the currently presented message 7502 and present next message 7503, if any on the display 210. So user has to provide either remove instruction 7584 or save instruction 7586 to display next message 7582 during life timer 7588 and in the event of non-receiving of either remove 7584 or save 7586 instruction based on setting system either auto save 7586 or auto remove 7584 current message 7502 and present next message 7503 on the display 210.

FIG. 75 (C) illustrates the exterior of electronic device 200. The Figure also illustrates the display 210. The display 210 presents a set of messages 7501 available for viewing. A first message 7502 may be displayed. Upon receiving of remove instruction 7584, save said remove instruction and remove presented message 7502 after expiration of life timer 7588 and receiving of updated user instruction e.g. remove instruction 7584 and a second message 7503 is displayed. Alternately, receiving of save instruction 7566, save said save instruction 7586, save presented message 7502 and hide display of presented message 7502 and a second message 7503 is displayed after expiration of life timer 7588 and receiving of updated user instruction e.g. save instruction 7586.

In an embodiment various ephemeral message controller or feeds or interfaces or application or system or method can also provide intelligent ephemeral controller including enable viewer to mark presented visual media item(s) or content item(s) as non-ephemeral and in the event of mark as non-ephemeral, timer stops and other ephemeral settings removed including life duration, view duration and number of times view limitations and non-ephemeral associated settings applied including enable user to remove manually, hide from timeline or feed by sender and/or receiver and making them unviable for all or selected other users, set life duration and in the event of expiry prompt user and delete or auto delete. In another embodiment enable sender or source or creator or owner of visual media item(s) or content item(s) to allow one or more receivers or destinations or followers or contacts or groups viewers to mark as non-ephemeral all or particular posted visual media item(s) or content item(s). In another embodiment enable receiver or destination or viewer to select one or more sources or senders or contacts or groups or networks or following users and mark as non-ephemeral of received content items or visual media items received from that selected one or more sources or senders or contacts or groups or networks or following users. In an embodiment viewing user is presented with mark as non-ephemeral button or link or control or accessible image with all content items presented in feeds or stories or with content items received from particular source(s) or based on sender's or source's or creator's or owner's permission or based on viewer's or recipient's permission. In an embodiment instead of or alternative of touch controller 215 user can also use keyboard or mouse (not shown in FIG. 2 or anywhere in Figures) for personal desktop computer or one or more types of devices for accessing various types of ephemeral message controller 277 including user can scroll up by using keyboard or mouse (FIG. 31), user can click on load more 3211 (FIG. 32), user can push to refresh 3315 (FIG. 33), based on timer auto refresh also happens in personal desktop computer or one or more other types of devices (FIG. 34). In an embodiment in FIG. 31, in the event of complete scrolling up of each line of text or each paragraph of text remove complete scrolled-up each line of text or each paragraph of text or wait for pre-set period of time to remove complete scrolled-up each line of text or each paragraph of text, so within wait time user an further scrolled down to read or view again said scrolled-up line or paragraph. In another embodiment in the event of scrolled up and then within pre-set wait time or pre-set duration scrolled down of line of text or paragraph further start view timer or display timer associated with each piece of content item or visual media item (FIG. 36).

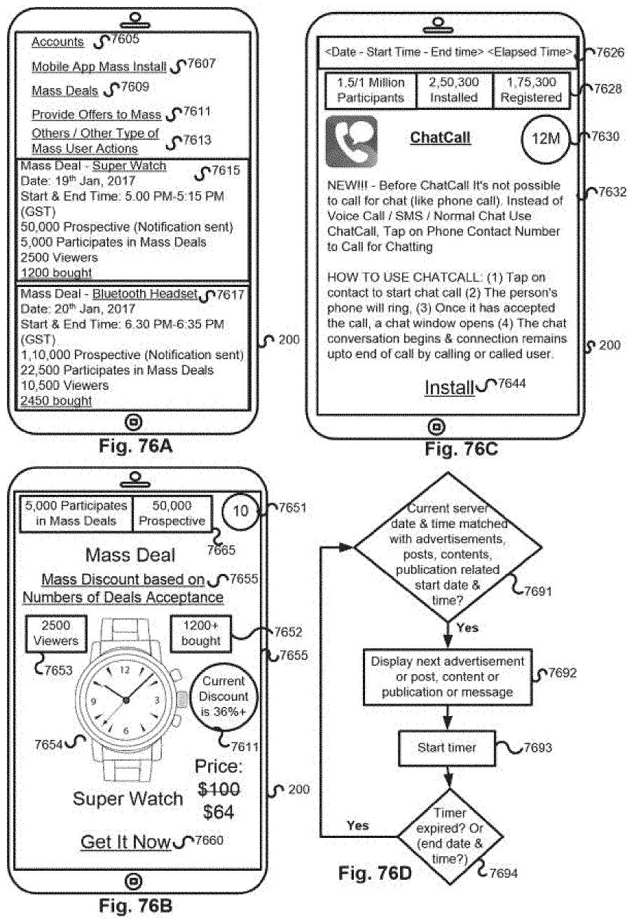

FIG. 76 illustrates user interface or application 286 of user device 200 enabling advertiser or publisher or user to create campaign or publication or define session and associated one or more types of one or more publications or advertisements or post(s) or listing(s) or contents and related metadata, rules, criteria comprises start and end date & time of session, publishing criteria including one or more locations or places or defined types of locations (via SQL, natural query, wizard interface, advance search, search query etc.), includes or excludes locations or types of locations, type of target user profile or user characteristics or user modeling or selected or provided field(s) and associate one or more types of value(s) (e.g. one age ranges (e.g. 18-25), gender (e.g. male and/or female), education types, skill types, interest or hobbies types, customers of particular categories or types, associated with or interacted with one or more types and/or name(s) or brand(s) of entities, one or more types of logged activities, actions, events, transactions, senses, behavior, status, locations, places, and connections, one or more types of physical characteristics (e.g. height etc.) or selected one or more users of network or selected or queried types of users of network, language, defined or filtered IP addresses inclusion or exclusion) or auto match by server or all, budget, type of models including pay per action, pay per transaction, pat percentage on total sale, pay per view, pay per presentation, pay per participations, and pay per push notification sent, type of target devices, one or more types of content item(s) (e.g. deals, structured details or data via one or more types of forms and templates, product or service details, visual media including video & photo or image, music or sound or voice, blog, link, test, article, advertisement, application description & download link, news, one or more types of one or more applications (e.g. chat), interfaces, web pages, and web site, selected one or more user actions including view, watch, listen, click, tap, fill form, shop or buy, add to cart, transact, advance booking or pre-order or advance buying, participate in deal, request for quote, download, install, advance order, invest, order, book, make payment, like, dislike, rate, provide comments, chat, communicate, collaborate, play games, add to wish list or bookmark, search or select & buy or add to cart, participate in auction, bid, request sample, ask queries, provide requirement specifications, post or share contents, capture or record photo and/or video and/or voice, register, subscribe, add money to wallet, connect, relate, map, make new connections, provide & consume user services, sell, verify, associate offers, discount rules, gifts, samples, vouchers, coupons, redeemable points, referrer rules (e.g. chain marketing etc.) and one or more types of benefits to viewer or particular type of action taker users.

After creating, defining and starting one or more types of one or more campaigns or advertisements or publications or posts, server module 187 of server 110 verifies, validates and approves or disapproves said created campaigns or advertisements or publications or posts.

After verification, validation and approving of said campaigns or advertisements or publications or posts by server module 187 of server 110, notifies said campaigns or advertisements or publications or posts creator or owner or advertiser or user or publisher about approving of said campaigns or advertisements or publications or posts and ready for presentation to target criteria specific and/or auto matched by server module 187 of server 110 specific viewers or users of network or all users of network who notifies via push notification or all users who opens application at the time of session.

Wherein auto matched by server module 187 of server 110 is based on matching advertisement or publication or one or more types of one or more content items and/or associated one or more types of user actions, applications, interfaces, web sites, web pages, data & any combination thereof presentation or listing or post details with one or more types of user data and/or user's connected users' data including user's mobile device location or place, user's one or more types of one or more activities, actions, events, transactions, status, senses, behavior, expressions, interacted entities, one or more fields and associated one or more types or data types specific value(s) related to one or more types or categories specific forms, profile types and templates specific (e.g. age, gender, incomer range, education types, skills types, interests or hobbies types, home and work and interacted entities addresses, past locations and checked-in places, past transactions & one or more types of user actions (e.g. viewed, referred, liked, disliked, reported, shared, bought, ordered, commented, booked, installed, participated, listened, read, used, consumed, subscribed, ate, drank etc.) on advertisements or posts or publications, interacted types, names & brands of entities, types and names or brands of products and services used, using and like to use, preferences or selections of user to receive one or more types or categories of or keywords related or receive from particular source(s) advertisements or contents or publications or posts.

In an embodiment after ready for user presentation server module 187 of server 110 based on user settings, privacy settings and preferences, sends push notifications or indications or alerts via one or more communication channels (e.g. send push notification or indication or alert via/at mobile devices(s) or PC(s) or tablet(s) or wearable device(s) via push notification service, SMS, email, message, call etc.) to all or advertisement or posts or publication associated target criteria specific or auto matched users of network who can further refer and share to other connected users of network based on permissions. In an embodiment enabling user to confirm & share (refer or invite to participate) or confirm or reject participation in viewing of particular or push notification related advertisement or publication or listing or post or one or more types of one or more content items presentation session (date & time selected or defined or provided by advertiser or publisher or user or posting user of said push notification related advertisement or publication or listing or post or one or more types of one or more content items presentation) or not respond or think later.

In an embodiment server module 187 of server 110 based on user setting can further notify about participated viewing of advertisement or publication or listing or post or one or more types of one or more content items presentation before pre-set duration or at the time of starting of session related to said participated particular advertisement or publication or listing or post or one or more types of one or more content items presentation, so user can tap on said notification and view session date & time related advertisement or publication or listing or post or one or more types of one or more content items presentation.

In an embodiment server module 187 of server 110 presents session date & time specific advertisement or publication or listing or post or presenting of one or more type of one or more content items e.g. 7632, 7655 and associated one or more types of one or more user actions e.g. 7644, 7660 at user interface on the date & time of session and user is enable to view, access, take presented or associated one or more actions. In an embodiment server module 187 of server 110 monitors, tracks, stores statistics, activities, actions, behavior of each viewer or user on each presented advertisement or published publication or listed item or posted item or presented of one or more type of one or more content items and associated one or more types of one or more user actions and analyze, calculates, processes, generates and provides one or more types of analytics to presented advertisement or published publication or listed item or posted item or presented of one or more type of one or more content items related user or advertiser or publisher, wherein monitored, tracked, stored one or more types of statistics, activities, actions, events, transactions, status, senses, behavior comprises number of push notification sent, number of participants, number of users presented with said advertisement or content, number of viewers, number of actual customers or users or paid users or purchasers or subscribers or registered users, number of users who took each associated type of user action (bought, transacted, participated, subscribed, ordered, viewed, shared, referred, liked, disliked, rated, commented, listened, add to interest list, app installed etc.), amount of total transaction, discount, commission, offers, cashbacks, redeemable points from one or more types or named location(s) or place(s), type of users (gender, age, age range, home or work location or place etc.).

In an embodiment server module 187 of server 110 presents number of participants (based on received confirmation from users via sent pre-session notifications) e.g. 7665/7628, real-time updates and presents updated details including number of viewers e.g. 7653, number of users purchased or bought, ordered e.g. 7652, installed e.g. 7628, updated discount rates or percentage of price 7611, number of users liked, number of users commented or rated, number of users listened, and number of users' one or more types of presented or updated one or more types of reactions, transactions, actions.

In an embodiment after expiration of pre-set duration of session or pre-set duration of presenting or presentation of said currently presented advertisement or content or post or publication or associate timer 7630 or 7651, hide or remove said presented current advertisement or content e.g. 7632, 7655 or display 210 from user device 200 and present (if any) next advertisement or content item or post or publication at user interface e.g. 7632, 7655 or display 210 of user device 200. For example user is presented with application installation advertisement 7632 so user can view details and user action 7644 so user can tap on install icon or label or control or button 7644 to download and install application and can register application. In the event of expiration of associated pre-set duration of timer (number of seconds or minutes or days etc.) 7630, server module 187 of server 110 removes or hides said presented advertisement or content item 7632 and presents next advertisement or content e.g. 7655 and again starts and presents associated pre-set timer 7651, so within start and end of pre-set duration of session user can view deals, view updated statistics 7653, 7652, 7611 related to currently presented deals 7655, refer deals to one or more contacts and can purchase or participate in currently presented deals 7655 and in the event of expiration of timer 7651, server module 187 of server 110 removes or hides said presented advertisement or content item 7655 and presents next advertisement or content (if any).

In an embodiment user is notified about contextual advertisements or posts or content items or listings or publications based on associate start date & time and in the event of tap or haptic contact engagement of said received notification, user is enabled to view said date & time associate advertisement or content up-to ending date & time associated with said advertisement or content. In an embodiment user can any time open application and can view current date & time associate advertisement or content or post or publication item.

In an embodiment server module 187 of server 100, presents current server date & time related advertisement(s) or content item(s) based on matching current server date & time with advertisements or publications or posts or listings associated pre-set starting date & time stored at sever database 115 of server 110 for presenting to users; and removes or hides said presented content item(s) based on said presented content item(s) associated ending date and time based on matching current server date & time with advertisements or publications or posts or listings associated ending date & time and present next (if any) current server date & time related advertisement or content item(s) based on matching current server date & time with advertisements or publications or posts or listings associated starting date & time for presenting to users.

In an embodiment server module 187 of server 100, presents current date & time associated content item(s) to targeted criteria specific users of network or auto matched users of network or present content item(s) to targeted criteria specific users of network or auto matched users of network based on content item(s) associated pre-set starting date and time; and remove or hide said presented content item(s) based on said presented content item(s) associated ending date and time.

For example advertises can create session and during session advertise one or more applications (enable viewers during session to view details, download, try, install, register, refer, purchase, purchase in app features or enhanced features), web sites (enable advertiser to building brand, sell or provide information about availability of curate or quality or new types of products and services to viewers during session, enable viewer during session to register or become paid member etc.), services (enable viewers during session to view details, offers, discounts, ask query, and subscribe service(s)), music album (enable viewers during session to listen first launch of music album or song of new movie, provide comments, ratings, like or dislike, purchase, subscribe source etc.) new movie (enable viewers during session to view trailer, view movie (based on payment or subscription, provide comments, ratings, like or dislike etc.), games (enable viewers during session to view details, view video or trailer of game, refer, share, download, install, subscribe, play, make members etc.), digital content (e.g. Book—enable viewers during session to read some parts of books, buy book etc.), enable viewers during session to book tickets of before release of new movie, drama, shows, events, sports, amusement parks (advance booking), hotel booking, food ordering (retailer or wholesaler or group purchasing), collective advance order of seasonal fruits & raw materials (e.g. order mango), order new mobile, PC, tablet, TV, watch, device & electronic items (even before manufacture or launch), advance orders of cloths based on design (e.g. Jinnam Dress—show design (Online/Offline (via booking of appointment)), tours & travels (packages, flights, cruises), internet services (Wi-Fi, Data services), TV cable services, seasonal products (e.g. umbrella etc.), brand building or marketing or promotion or awareness about new or coming products, services, movie, album, seasonal products, local deals (discounted products and services e.g. if a certain number of people signed up for the offer, then the deal became available to all), Local Shops.

In an embodiment advertiser can configure rules associate with advertisement including in the event of one or more types of levels of number of purchases then provide or increase pre-set discount and/or one or more types of benefits or offers.

In an embodiment dynamically extend or reduce session time based on user responses.

In an embodiment real-time surprise session (notify user about deal and in the event of acceptance, participate user in session and enable user to take one or more actions up-to end of session)

In an embodiment in the event of receiving of confirmation of particular no. of members participation for particular advertised session then only start session.

FIG. 76 (D) illustrates processing operations associated with the session based content (e.g. advertisement, one or more types of content or media or visual media including text, photo, video, web page, link, applications, user actions or call-to-actions or controls (e.g. button, menu item message etc.) controller 187. Initially, check is made 7691 by server module 187 whether current server date & time matched with advertisements, posts, contents, publication related start date & time or between or falls in start and end date & time stored at server database 115 of server 110; server module 187 continuously matching server date & time with advertisements, posts, contents, publication related start date & time and in the event of founding of matched advertisement, post, content, publication related start date & time (7691—Yes), then said matched advertisement, post, content, publication, message is displayed 7692. A timer is then started 7693. Then the timer is checked 7693 or end date & time associated with advertisement is checked 7693 or matched with server current date & time via server module 187. If the timer has expired or end date & time associated with advertisement is matched with server current date & time via server module 187 (7694—Yes), then the current presented advertisement or post or publication or one or more types of content item or message is deleted or hide and further check is made 7691 by server module 187 whether current server date & time matched with advertisements, posts, contents, publication related start date & time or between or falls in start and end date & time stored at server database 115 of server 110; server module 187 continuously matching server date & time with advertisements, posts, contents, publication related start date & time and in the event of founding of matched advertisement, post, content, publication related start date & time (7691—Yes), then said matched advertisement, post, content, publication, message is displayed 7692. A timer is then started 7693 or end date & time associated with advertisement is checked 7693 or matched with server current date & time via server module 187. Then the timer is checked 7693. If the timer has expired or end date & time associated with advertisement is matched with server current date & time via server module 187 (7694—Yes), then the current presented advertisement or post or publication or one or more types of content item or message is deleted or hide. If the timer has not expired (7693—No), then enabling user to view, access, take one or more types of one or more actions (e.g. buy, order, install, play, subscribe, provide one or more types of reactions including like, dislike, rate, comment) on currently presented advertisement or post or publication or one or more types of content item or message.

In an another embodiment FIG. 76 (D) illustrates processing operations associated with the session based content (e.g. advertisement, one or more types of content or media or visual media including text, photo, video, web page, link, applications, user actions or call-to-actions or controls (e.g. button, menu item message etc.) controller 187. Initially, check is made 7691 by server module 187 whether current server date & time matched with advertisements, posts, contents, publications, messages related start date & time or between or falls in start and end date & time stored at server database 115 of server 110 and match advertisements, posts, contents, publications, messages related target criteria and details with user data stored at server database 115 of sever 110 and in the event of founding of matched advertisement, post, content, publication (7691—Yes), then said matched advertisement, post, content, publication, message is displayed 7692. A timer is then started 7693. Then the timer is checked 7693 or end date & time associated with advertisement is checked 7693 or matched with server current date & time via server module 187. If the timer has expired or end date & time associated with advertisement is matched with server current date & time via server module 187 (7694—Yes), then the current presented advertisement or post or publication or one or more types of content item or message is deleted or hide and further check is made 7691 by server module 187 whether current server date & time matched with advertisements, posts, contents, publications, messages related start date & time or between or falls in start and end date & time stored at server database 115 of server 110 and match advertisements, posts, contents, publications, messages related target criteria and details with user data stored at server database 115 of sever 110 and in the event of founding of matched advertisement, post, content, publication (7691—Yes), then said matched advertisement, post, content, publication, message is displayed 7692. A timer is then started 7693. Then the timer is checked 7693 or end date & time associated with advertisement is checked 7693 or matched with server current date & time via server module 187. If the timer has expired or end date & time associated with advertisement is matched with server current date & time via server module 187 (7694—Yes), then the current presented advertisement or post or publication or one or more types of content item or message is deleted or hide. If the timer has not expired (7693—No), then enabling user to view, access, take one or more types of one or more actions (e.g. buy, order, install, play, subscribe, provide one or more types of reactions including like, dislike, rate, comment) on currently presented advertisement or post or publication or one or more types of content item or message.

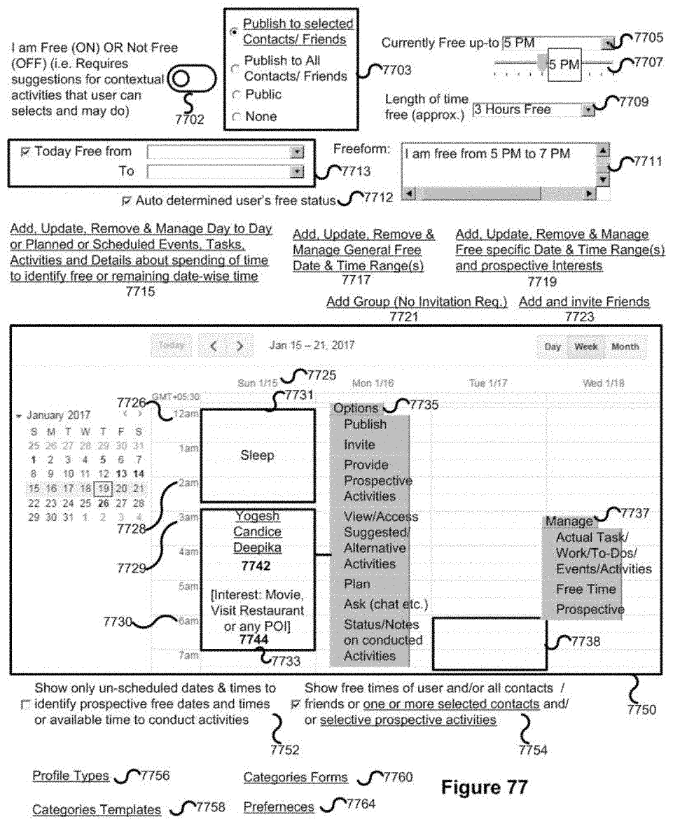

FIGS. 77-79 illustrates user interface or application 285 of user device 200 for enabling user to ON or OFF 7702 or 7805 or 7825 availability of user for presenting suggested contextual prospective activities and enabling to make said availability status, place and information including from particular date & time to particular date & time to all or one or more contacts, make it public or make it private i.e. for user only 7703. In an another embodiment user can provide currently or today available from now up-to provided or inputted or selected time 7705/7809/7829 or select time via easy slider interface 7707/7811/7831 or can provide approximate number of hours user is available 7709/7813/7833 or provide from date & time up-to date & time information 7713 or freeform or in text form provide (system identifies from text From-To date & time range(s)) 7711 for instructing or requesting server module 189 of server 110 to present contextual or matched prospective & suggested activities at user interface 7820 of user device 200.

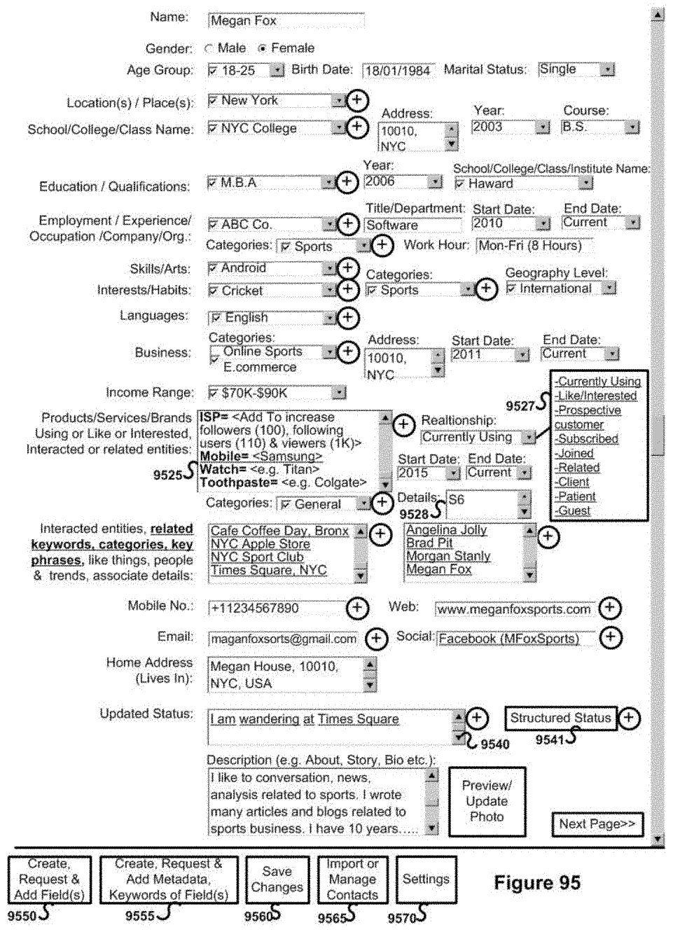

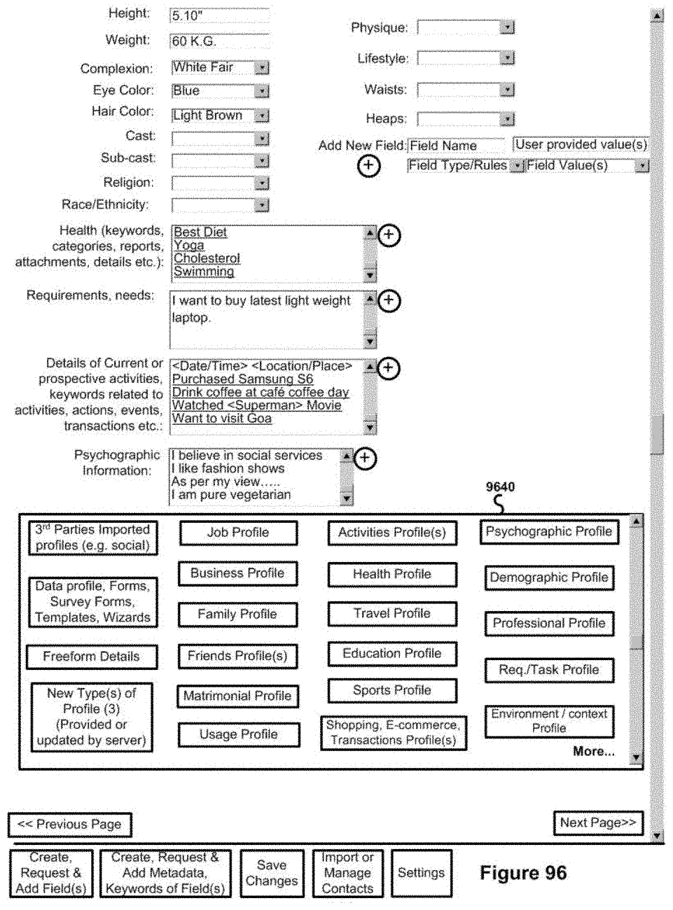

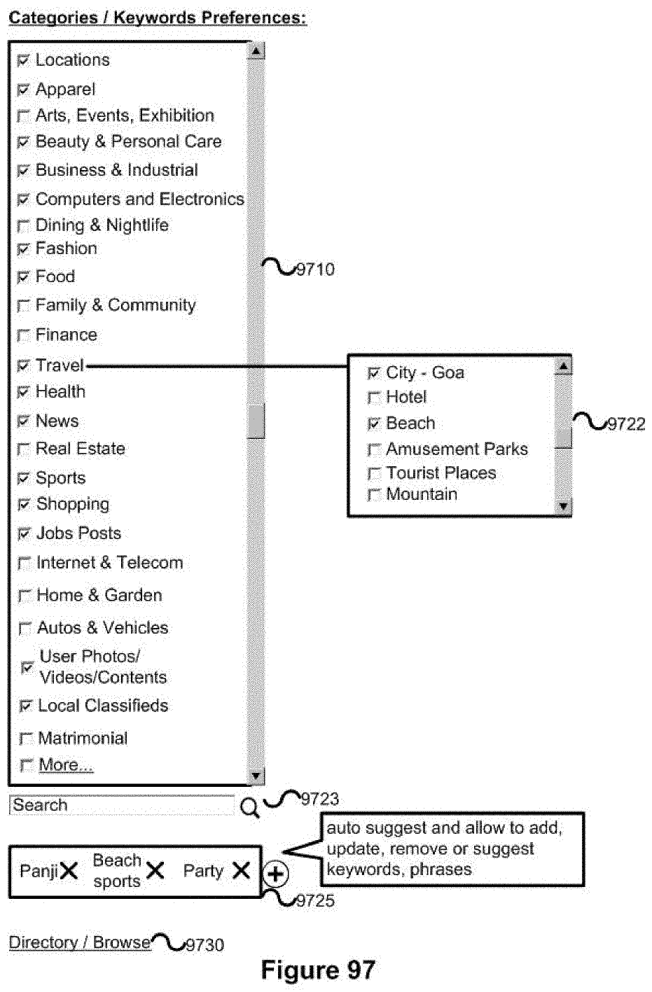

In an embodiment user can provide about user's scheduled 7715 or day to day 7717 general activities, events, to-dos, meetings, appointments, tasks and available date & time range(s) for conducting of other activities 7719 via using calendar interface 7750 and/or server module 189 auto identifies user's available date & time range(s) as per user setting 7712 based on provided data and user related data for conducting of other activities and provides each available date & time range(s) specific suggested list of contextual activities e.g. 7820/7845/7855/7890. For example user select current date 7725 and select up-to time or particular date 7725 or range(s) of date(s) and can select particular rang(s) of time 7726 & 7728 and can provide schedules details 7731 including information, place, participate contacts (via sending invitation(s) to one or more contacts or accept invitation(s) from one or more contacts). User can specify available date & time or date & time range(s) and can provide publication or sharing settings 7735 (as discussed in 7703) and can invite one or more selected friends or contacts 7723 and/or group(s) and/or close group(s) which no need to invited members of group 7721. Invitation accepted users shown to each member 7733 and members are enabled to provide, input or select or suggest one or more interests or prospective activities which user and members would like to do 7733. Server module 189 searches, matches, selects (or in an embodiment selects via server admin or editor or experts—human mediated) and presents one or more matched, contextual, prospective and suggested activities or information about activities 7820/7840/7855/7890 based on received said details about user's availability date & time or length of time or duration e.g. 7729-7730, monitored by server module 189 user device's 200 current location or place, invited and invitation accepted contacts or members 7742 and user or member(s) provided one or more prospective or suggested activities or interests or keywords 7744 and based on user's or each member user's data including user profile related age, gender, education, skills, interests, hobbies, income ranges, type of members or relationships (e.g. family members, best friends, wife, girlfriend, neighbor, classmate, associates, colleague, senior, club member etc.), prospective budget, calculated length of duration of activity, estimated total time to conduct one or more activities, types of visited or liked or bookmarked places, logged activities, actions, events, transactions, status, interacted entities, status, saved or logged past conducted and rated activities, home and work location(s) or place(s) of each member to find out based on time nearest location or place related activities, one or more types of domain or subject or interest or activities specific profiles 7756 or forms 7760 (as discussed in detail in FIG. 95-96) and/or templates 7758 (as discussed in detail in FIG. 94) and/or types of activities or interests or hobbies preferences 7764 (as discussed in detail in FIG. 97) and based on databases of information about current trend (new or popular movie, drama, book, show, actor, music album or song), one or more types of one or more shows, events, movies, associated user actions (e.g. book, trailer, direction, order, buy, negotiate, compare, ask, etc.). In an another embodiment user or member e.g. 7742 can selects and conduct one or more activities e.g. 7815 from suggested list of activities e.g. 7820 and can provide status, ratings, comments, notes on said selected and conducted one or more activities, user actions, events, transactions which server module 189 stores or logged for later use or for match making purpose. In an another embodiment user can view only un-scheduled dates & times to identify prospective free or availability dates and times or available time to conduct other activities 7752 on calendar 77650 or user can view on calendar 77650 free or available dates & times range(s) of user and/or all contacts/friends or one or more selected contacts and/or selective prospective activities 7754.

In another embodiment system auto identifies that user is now free or free for particular period or duration based on identifying type and name (based on various sensors identify that user is at e.g. airport, walking, in vehicle, not talking, not moving or conducting some entertainment activities like watching television), of user device's current location, based on user schedules and day-to-day general activities or routine time tables identifies remaining available times or rang(s) of time(s), user device is ON and user is not busy on phone call and after determining that user is free or available at particular time then system sends push notification or indication to confirm from user that user is free or available or not 7823. In the event of confirmation from user that at present user is free or available then auto ON icon 7825 or providing of free or available timings details and/or one or more types or names of interested activities via 7827 and/or 7829 and/or 7831 and/or 7833 then server module 189 based on said auto identified data, user provided data, real-time asking to user & provided data and stored one or more types of user data identifies, searches, matches and presents suggested activities e.g. 7840. So user can view, selects, use, access one or more presented activity items and associate one or more user actions, which server module 189 continuously monitors, tracks and stores or logs and updates at user data of server database 115 of sever 110.

In an another embodiment in the event of ON via icon 7825 and providing details of availability up-to time via 7829 or via slider interface 7831 or length of time in e.g. number of hours 7833. Based on said provided information and monitored user device's 200 current location or place by server module 189 and user data stored at database 115 of server 110, server module 189 for example identifies user location or place name or type as particular “airport” then based on said type or name of location server identifies rules from rule base stored at database 115 of server 110 and identifies nearest places and prepares, generates and presents one or more contextual or matched list of prospective or suggested activity items with details and one or more types of user actions (direction, menu, order, install, like etc.) e.g. 7840 (7835, 7836, 7837).

In another example based on length of duration i.e. instead of few hours (e.g. few days like in holidays, vacations, leave etc.) and based on type of user and based on type of activities e.g. alone, invited e.g. with family, with selected one or more friends, with group(s), with associates or colleagues and based on type of user device current place, server modules 189 identifies and presents few days related activities including tours & travels packages or based on user data and preferences identifies one or more types of classes or tutors or sports activities 7855.

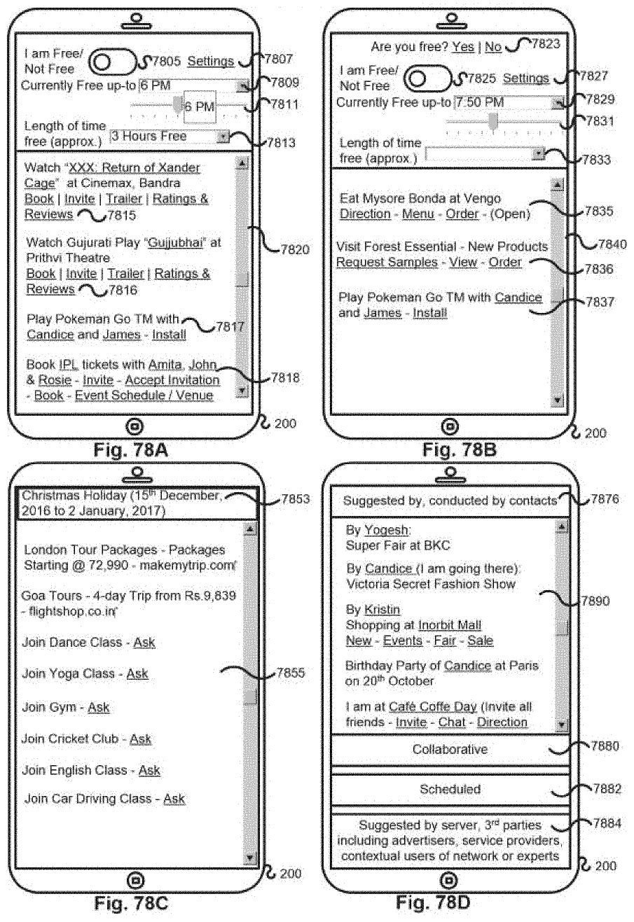

In an another embodiment FIG. 78 (D) illustrates user interface for enabling user to view, access, search (one or more keywords or search queries), filter (contact(s) wise, date & time wise, type of prospective activities wise, location or place of suggested activity wise), order one or more types of presented or suggested activities items provided or suggested by server module 189 of server 110 e.g. 7820, 7840 & 7855 and/or provided or selected or currently conducted by one or more contacts of user 7876 (e.g. 7890) and/or by one or more contacts of contacts of user and/or scheduled by user 7882 and/or collaborative 7880 and/or 3^{rd} parties service providers, sellers, advertisers, contextual or like-minded users of network and experts 7884. So user can adjust or update or change or plan or make choice or take decision or prepares time tables or calendar for current or scheduled or collaborative or prospective activities.

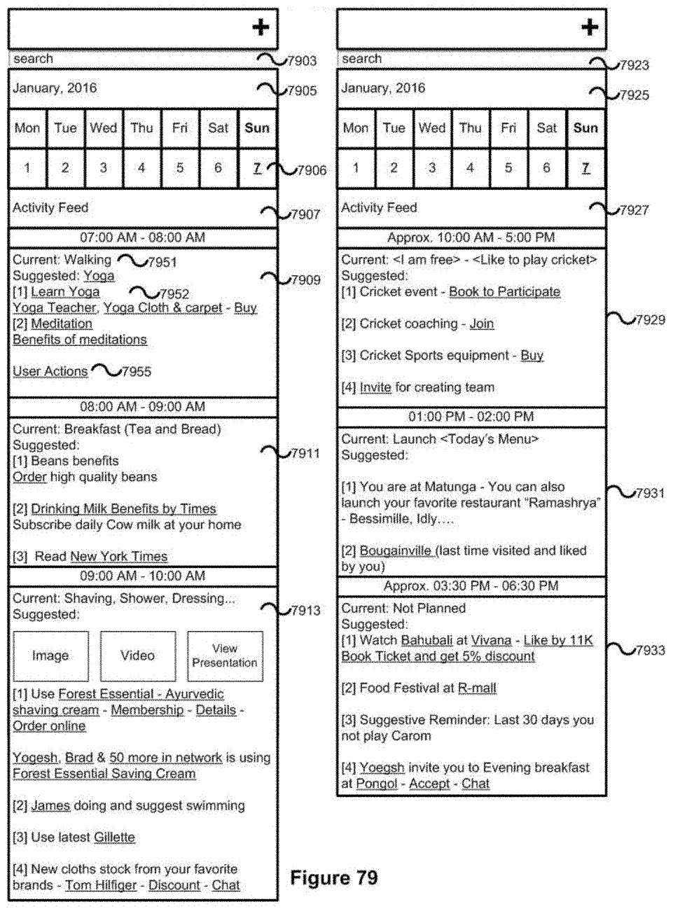

FIG. 79 illustrates various types of examples, user interface and various embodiments of suggesting prospective or alternative of current or scheduled or user provided activities, for example based on current or today's date 7906 client device's 200 application 285, presents to user time wise user scheduled activities or events or To-dos or Tasks or Appointments, day-to-day general activities and for reaming timings presents suggested contextual prospective activities (as discussed in FIGS. 77-78). For example user mentioned or provides that his day-to-day general activity is walking and timing is morning 7 AM to 8 AM. Based on current time, type of current activity (e.g. walking), user's one or more types of data including user profile (age, gender, preferences, past activities, interests, physical characteristics, user's home address, income range, etc.), server module 189 identifies alternative best matched suggested activities and presents said prospective activities to user at related activity item e.g. 7909. User can select, view, access, search, filter, remove or not like in future, like or add to interest list, rate, provide comment, bookmark, save, conduct, provide status, view similar activity having by contacts, make as collaborative, share (via user action contextual menu or activity item and/or user specific menu options 7955) one or more selected activity items from suggested list of activities 7952 alternative to user's current one or more activities 7951. In another example user's next activity is “Breakfast” 7911 and user is consuming “Tea and Bread”. Based on said current activity details and one or more types of user data (e.g. user's age, location, gender, income range, health profile including various types of health reports) server module 189 presents suggested alternatives activity items 7911 including order best quality beans, beans benefits related article links and milk related blog links from one or more sources. In another example in next user's activity e.g. “shaving, shower & dressing” 7913, based on said current activity details and one or more types of user data (e.g. user's current brand of shaving cream, shop, shampoo etc. via day-to-day activities templates (as discuss in FIG. 94) age, location, gender, income range, health profile including various types of health reports) server module 189 presents suggested alternatives activity items 7913 and also presents said suggested presented activity item doing by user's contacts

Activity item comprise details about one or more types of current, suggested (by server, 3^{rd} parties service providers, advertises, sellers, merchants, shops, manufactures, web sites, applications, servers, databases, web services, devices, networks and one or more types of entities), contacts of user, experts, users of network), alternative, currently doing by contacts one or more activities, actions, events, transactions, use, interactions, participations, requirements, interests, hobbies, tasks, To-dos, using of particular types of and/or name or branded products and services, reading, watching, listening, exercising, day to day activities, eating of particular types, names or brands of food at particular place or location, associated one or more types of content items visual media items including text, link, photo, video and one or more types of user actions including controls (button, link, list, contextual menu items or options etc.), links of applications, web sites, web pages, interfaces, media, web services, data, functions, objects and widgets.

The present invention relates generally to storing user data and connected users' data including user profile, user activities, actions, events, transactions, updates, status, logs, calendar entries (e.g. meetings, appointment, to-dos etc.), locations, check-in places, user preferences, privacy settings & user related one or more types of digital contents or resources and base on said user data identifying date-wise available user time or time ranges or time slots and associate various prospective activities other than user identified activities or calendar entries and presenting date & time or time range specific one or more prospective activities contents or feed or data from one or more sources including suggest by contacts or connected users of user, other users of networks, suggest by server, 3^{rd} parties partners, advertisers, sellers and service providers. So user can view said content and take one or more user actions on one or more presented activity item(s) including book ticket, book appointment, make order, buy product, view video, view map, ask query, update status of activity item including interested or like to do, cancelled, confirm to do, pending, collaborative, invite one or more contacts, waiting for suggestions of one or more friends or contacts to do or not do said suggested activity, doing, change, done, rated or not-rated status, refer or share to one or more contacts, like, dislike, rank, and rate it.

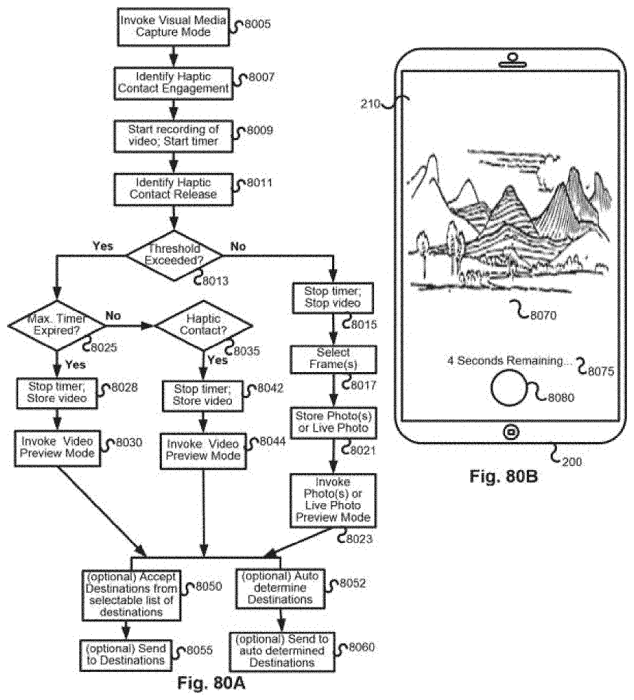

FIG. 80 illustrates in an embodiment the visual media capture controller 278 which enable user to single mode visual media capture that alternately produces photos and pre-set duration of video and in the event of haptic contact engagement enables user to stop said recording of video before expiration of pre-set duration of video limitation.

FIG. 80 explains, a computer-implemented method, comprising: receiving a haptic engagement signal 8005; starting a recording of video and starting a timer 8009 in response to receiving the haptic engagement signal 8007; receiving a haptic release signal 8011; in the event not exceeding of threshold (e.g. less than or equal to 2 or 3 seconds) (8013—No) stop timer and stop video 8015; select or extract frame(s) 8017; store photo 8021; in the event exceeding of threshold (e.g. greater than or equal to 2 or 3 seconds) (8013—Yes), check is made whether pre-set maximum duration of timer expired or pre-set maximum duration of video recorded (8025—Yes) (e.g. pre-set maximum of 10 seconds of video) stop timer and stop video; in the event of pre-set maximum duration of timer not expired or pre-set maximum duration of video not yet recorded (8025—No) (e.g. recording of less than pre-set maximum of 10 seconds of video) and receiving a haptic engagement signal 8035; stop timer, stop video and store video 8042.

In another embodiment invoke photo preview mode 8023; accept one or more destinations including accept from user one or more contacts or groups 8050 or auto determine destination(s) 8052 based on pre-set default destination(s) or auto selected destination(s); and enable user to send to 8055 or auto send 8060 said captured photo to said destination(s).

In another embodiment invoke video preview mode 8030 or 8044; accept one or more destinations including accept from user one or more contacts or groups 8050 or auto determine destination(s) 8052 based on pre-set default destination(s) or auto selected destination(s); and enable user to send to 8055 or auto send 8060 said recorded video to said destination(s).

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores a visual media capture controller 278 to implement operations of the invention. The visual media capture controller 278 includes executable instructions to alternately record a photo or a pre-set duration of recording of video or in the event of haptic contact engagement enables user to stop said recording of video before expiration of pre-set duration of video limitation based upon the processing of haptic signals, as discussed below.

The visual media controller 278 interacts with a photo library controller 294, which includes executable instructions to store, organize and present photos 291. The photo library controller may be a standard photo library controller known in the art. The visual media controller 278 also interacts with a video library controller 296, which includes executable instructions to store, organize and present videos 292. The video library controller may also be a standard video library controller known in the art.

The processor 230 is also coupled to image sensors 244. The image sensors 244 may be known digital image sensors, such as charge coupled devices. The image sensors capture visual media, which is presented on display 210. That is, in a visual media mode controlled by the visual media capture controller 278, the image sensors 244 capture visual media and present the visual media on the display 210 so that a user can observe the captured visual media.

A touch controller 215 is connected to the display 210 and the processor 230. The touch controller 215 is responsive to haptic signals applied to the display 210. In one embodiment, the visual media capture controller 278 presents a single mode input icon on the display 210. That is, the visual media capture controller 278 includes executable instructions executed by the processor to present a single mode input icon on the display 210.

The visual media capture controller 278 communicates with the processor 230 regarding haptic signals applied to the display 210, which are recorded by the touch controller 215. In one configuration, the visual media capture controller 278 processes haptic signals applied to the single mode input icon, as detailed in connection with the discussion of FIG. 80 (A), and determines whether to record a photo or auto stop and save pre-set duration of video or based on haptic contact engagement & release before expiration of timer stop recording of video, as discussed below.

The electronic device 100 may also include other components commonly associated with a smartphone, such as a wireless signal processor 220, a power control circuit 225 and a global positioning system processor 235. While many of components of FIG. 2 are known in the art, new functionality is achieved through the visual media capture controller 278.

FIG. 80 (A) illustrates processing operations associated with the visual media capture controller 278. Initially, a visual media capture mode is invoked 8005. For example, a user may access an application presented on display 210 to invoke a visual media capture mode. FIG. 80 (B) illustrates the exterior of electronic device 200. The Figure also illustrates the display 210. The electronic device 200 is in a visual media capture mode and presents visual media 8070. The display 210 also includes a single mode input icon 8080. In one embodiment, the amount of time that a user presses the single mode input icon 8080 determines whether a photo will be recorded or a pre-set duration of video and further haptic contact engagement & release enable user to stop recording of video before expiration of pre-set duration of time. For example, if a user initially intends to take a photo, then the icon 8080 is engaged with a haptic signal. If the user decides that the visual media should instead be a pre-set duration of video and in the expiry of pre-set duration timer auto stop video & auto save video, the user continues to engage the icon 8080 to start recording of video. If the engagement is persists for a specified period of time (e.g., 3 seconds), then the output of the visual media capture is determined to be video and starts recording of video. In the event of further haptic contact user can stop recording of video before pre-set duration of video. The video mode may be indicated on the display 210 with an icon. Thus, a single gesture allows the user to seamlessly transition from a photo mode to a video mode and therefore control the media output during the recording process. This is accomplished without entering one mode or another prior to the capture sequence.

Returning to FIG. 80(A), haptic contact engagement is identified 8007. For example, the haptic contact engagement may be at icon 8080 on display 210. The touch controller 215 generates haptic contact engagement signals for processing by the visual media capture controller 210 in conjunction with the processor 230. Alternately, the haptic contact may be at any location on the display 210.

Video is recorded and a timer is started 8009 in response to haptic contact engagement 8007. The video is recorded by the processor 230 operating in conjunction with the memory 236. Alternately, a still frame is taken from the video feed 8017 and is stored as a photo 8021 in response to haptic contact engagement and then video is recorded. The timer is executed by the processor 230 under the control of the visual media capture controller 278.

Video continues to record up-to pre-set duration of timer expired 8025. Haptic contact release is subsequently identified 8011. The elapsed time recorded by the timer is then evaluated by the visual media capture controller 278 against a specified threshold (e.g., 3 seconds). If the threshold is exceeded (8013—Yes) and pre-set duration of timer expired (8025—Yes) then timer is then stopped and video is stored 8028. If -set duration of timer not expired or not exceeded (8025—No) and identification of haptic contact engagement (8035—Yes) then stop timer and store video 8042. In particular, a video is sent to the video library controller 296 for handling. In one embodiment, the visual media capture controller 278 includes executable instructions to prompt the video library controller to enter a video preview mode 8030 or 8044. Consequently, a user can conveniently review a recently recorded video.

If the threshold is not exceeded (8013—No), a frame of video is selected 8017 and is stored as a photo 8021. As indicated above, an alternate approach is to capture a still frame from the camera video feed as a photo upon haptic engagement. Such a photo is then passed to the photo library controller 294 for storage 291. The visual media capture controller 278 may then invoke a photo preview mode 8023 to allow a user to easily view the new photo.

In an embodiment user is informed about remaining time of pre-set duration of video via text status or icon or visual presentation e.g. 8075.

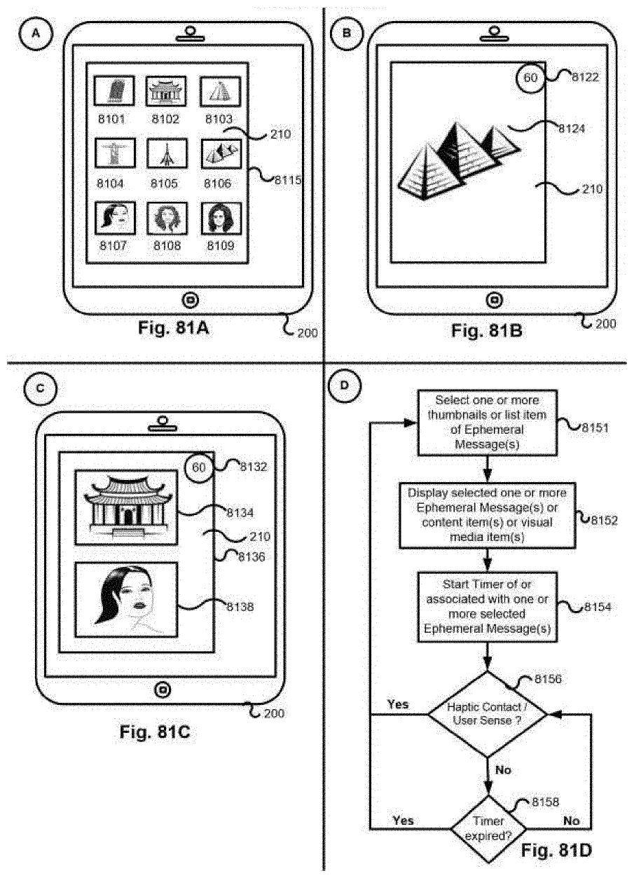

FIG. 81 illustrates processing operations associated with display of index or indicia or list item(s) or inbox list of items or search result item(s) or thumbnails of requested or searched or subscribed or auto presented or received digital item(s) or thumbnails or thumbshot or small representation of ephemeral message(s) or visual media item(s) including photo or video or content item(s) or post(s) or news item(s) or story item(s) 8115 for user selection 8151 based on type of feed (discussed throughout the specification), user is presented with said selection 8151 specific original version of ephemeral message(s) or content item(s) or visual media item(s) 8152 and starts timer associated with one or more or set of messages 8154 and in the event of expiry of timer e.g. 8122 or 8132 (8158) or receiving of haptic contact engagement 8156 or recognizing or detection of one or more types of pre-defined user sense 8156 on message e.g. 8124 or on feed or set of message(s) e.g. 8136, remove presented messages e.g. 8124 or e.g. 8136 on the display 210 and proceed to present index or list item(s) or thumbnails or thumbshot of ephemeral message(s) (if any) 8115 for further selection in accordance with an embodiment of the invention.

In an embodiment server 110 first displays indicia or index or thumbnails or thumbshot of one or more types of content item(s) or visual media item(s) 8115 and enable user to select one or more list item(s) or thumbnails or thumbshot of content item(s) or visual media item(s) 8115 (8151) and then based on selection 8151 server 110 serve, load, add to queue and present on user device 200 original version of one or more types of one or more content item(s) or visual media item(s) e.g. 8124 or 8136 on one or more types of ephemeral feeds 8152 including FIGS. 81 (B) & (C), FIG. 11 (A)—1107, FIG. 11 (B), FIG. 11 (C), FIG. 12 (A)—1223, FIG. 12 (B), FIG. 12 (C), FIG. 13 (A)—1323, FIG. 19 (C), FIG. 31 (B)—enable to select index items or thumbnails of original version of ephemeral message(s) or content item(s) then present selection specific original version of ephemeral message(s) or content item(s) e.g. 3108, FIG. 35 (A), FIG. 35 (C), FIG. 36 (C), FIG. 37 (A), FIG. 37 (C), FIG. 38 (A), FIG. 39 (C), FIG. 43 (C)—4315, FIG. 38 (B), FIG. 73 (A), FIG. 73 (C), FIG. 74 (A), FIG. 75 (A), FIG. 75 (C) and starts pre-set duration of timer associated with each ephemeral message or set of ephemeral message(s) or feed or story or presentation interface 8154 and in the event of expiry of timer e.g. 8122 or 8132 (8158) or receiving of haptic contact engagement 8156 or recognizing or detection of one or more types of pre-defined user sense 8156 on message e.g. 8124 or on feed or set of message(s) e.g. 8136, remove presented messages e.g. 8124 or e.g. 8136 on the display 210 and proceed to present index or list item(s) or thumbnails or thumbshot of ephemeral message(s) (if any) 8115 for further selection in accordance with an embodiment of the invention.

In an embodiment indicia or index or thumbnails or thumbshot of one or more types of content item(s) or visual media item(s) or message or ephemeral or notification or indication or original version of one or more types of one or more content item(s) or visual media item(s) can serve by server 110 via server module 178 or serve from client device 200 storage medium or serve from one or more sources including one or more contacts, connections, users, domains, servers, web sites, applications, user accounts, storage mediums, databases, networks, devices via one or more web services, application programming interface (API) or software development toolkit (SDK) or providing of authentication information or one or more types of communication interfaces and any combination thereof.

In an embodiment describe in FIG. 37, an ephemeral message controller 277 with instructions executed by a processor 230 to: present on the display 210 index or indicia or list item(s) or inbox list of items or search result item(s) or thumbnails of requested or searched or subscribed or auto presented or received digital item(s) or thumbnails or thumbshot or small representation of ephemeral message(s) or visual media item(s) including photo or video or content item(s) or post(s) or news item(s) or story item(s) 8115 of the collection of ephemeral content item(s) or messages(s) for enabling user to select one or more indicia or index item(s) or list item(s) or thumbnail(s) or thumbshot(s) 8151 e.g. 8106 which presented on FIG. 81 (B) type of presentation—8124 or e.g. 8102 and 8107 which presented on FIG. 81 (C) type of feed—8134 and 8138 (8152) for a corresponding associated transitory period of time defined by a timer e.g. timer 8122 associated with presented message 8142 and timer 8132 associated with presented messages 8134 and 8138 (8154), wherein the first ephemeral content item(s) or messages(s) e.g. 8124 or 8134 and 8138 is/are deleted when the corresponding associated transitory period of time expires 8158; receive from a touch controller a haptic contact signal 8156 indicative of a gesture applied to the display 210 during the first transitory period of time 8158; wherein the ephemeral message controller 277 deletes first one or more or set of presented ephemeral content item(s) or messages(s) (e.g. 8124 or e.g. 8134 and 8138) in response to the haptic contact signal (8156) or receive from a sensor(s) or sensor(s) controller a one or more types of pre-defined user sense signal 8156 indicative of a user sense applied to the display 210 during the first transitory period of time 8158; wherein the ephemeral message controller 277 deletes first one or more or set of presented ephemeral content item(s) or messages(s) (e.g. 8124 or e.g. 8134 and 8138) in response to the user sense(s) signal(s) (8156) and proceeds to present index item(s) or list item(s) or thumbnails or thumbshot of ephemeral message(s) (if any) 8115 for further selection and after selection of one or more index item(s) or list item(s) or thumbnails or thumbshot of ephemeral message(s) (if any) 8115 (8151), and proceeds to present on the display 210 a second one or more or set of ephemeral content item(s) or messages(s) e.g. 8101 on display 210 of FIG. 81(B) or e.g. 8102 and 8103 of FIG. 81 (C) (8152) of the collection of or identified or contextual ephemeral content item(s) or messages(s) for a corresponding associated transitory period of time defined by the timer for each presented ephemeral content item(s) or messages(s), wherein the ephemeral message controller 277 deletes the presented ephemeral content item(s) or messages(s) upon the expiration of the corresponding associated transitory period of time 8158 defined by a timer for each presented ephemeral content item(s) or messages(s); wherein the second set of ephemeral content item(s) or messages(s) is deleted when the touch controller receives another haptic contact signal 8156 indicative of another gesture applied to the display or receives from a sensor(s) or sensor(s) controller another one or more types of pre-defined user sense signal 8156 indicative of a user sense applied to the display 210 during the second transitory period of time 8158; and wherein the ephemeral content or message controller 277 initiates the timer upon the display of the first one or more or set of ephemeral content item(s) or messages(s) and the display of the second one or more or set of ephemeral content item(s) or messages(s).

In another embodiment the ephemeral message controller 277, in response to deletion of ephemeral message(s) e.g. 8124 from FIG. 81 (B) and 8134 and 8138 from FIG. 81 (C), also removes or hides related or corresponding or associated index item or list item or thumbnail or search result item or thumbshot item from presented list of index items or list items or thumbnails or search result items or thumbshot items 8115.

In another embodiment the ephemeral message controller 277, in response to deletion of ephemeral message(s) e.g. 8124 from FIG. 81 (B) and 8134 and 8138 from FIG. 81 (C), also removes or hides related or corresponding or associated index item or list item or thumbnail or search result item or thumbshot item from presented list of index items or list items or thumbnails or search result items or thumbshot items 8115 and load one or more or set of other (if any available) index items or list items or thumbnails or search result items or thumbshot items of original ephemeral message(s) or content item(s) or visual media item(s) 8115 from one or more sources including server 110.

FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like. The display time for the one or more or set of ephemeral message is/are typically set by the message sender. However, the display time may be a default setting or a setting specified by the recipient. Regardless of the setting technique, the message is transitory.

The processor 230 is also coupled to image sensors 244. The image sensors 244 may be known digital image sensors, such as charge coupled devices. The image sensors capture visual media, which is presented on display 210.

A touch controller 215 is connected to the display 210 and the processor 230. The touch controller 215 is responsive to haptic signals applied to the display 210. In one embodiment, the ephemeral message controller 277 monitors signals from the touch controller 215. If haptic contact is observed by the touch controller 215 during the display of set of ephemeral message(s), then the display of the existing message(s) is/are terminated and a subsequent set of ephemeral message(s), if any, is displayed. In one embodiment, two haptic signals may be monitored. A continuous haptic signal may be required to display a message(s), while an additional haptic signal may operate to terminate the display of the set of displayed message(s). For example, the viewer might tap the screen with a finger while maintaining haptic contact with another finger. This causes the screen to display the next set of media in the collection. In one embodiment, the haptic contact to terminate a set of message(s) is any gesture applied to any location on the display 210. In another embodiment, the haptic contact is any gesture applied to the message(s) itself. In one embodiment, the gesture is un-prompted (i.e., there is no prompt such as “Delete” to solicit an action from the user). In another embodiment, the gesture may be prompted (e.g., by supplying a “Delete” option on the display, which must be touched to effectuate deletion).

The electronic device 200 may also include other components commonly associated with a smartphone, such as a wireless signal processor 220, a power control circuit 225 and a global positioning system processor 235. While many of components of FIG. 2 are known in the art, new functionality is achieved through the ephemeral message controller 277.

In an embodiment FIG. 37 (D) illustrates processing operations associated with the ephemeral message controller 277. Initially, user is presented with one or more or set of index items or list items or thumbnails or search result items or thumbshot items 8115 then based on user selection of one or more index items or list items or thumbnails or search result items or thumbshot items 8115 (8151), one or more or set of said index items or list items or thumbnails or search result items or thumbshot items or reduced version of content item(s) 8115 associated original version of ephemeral message(s) is/are displayed 8152 (e.g. 8124 or 8134 and 8138). A timer associated with said each ephemeral message (e.g. timer 8122 for media item 8124 and timer 8132 for media item 8134 and 8138) is/are then started 8154. The timer may be associated with the processor 230.

Haptic contact is then monitored 8156. If haptic contact exists (8156—Yes), then the current one or more or set of message(s) (e.g. 8124 or 8134 and 8138) is/are deleted and user is further presented with one or more or set of index items or list items or thumbnails or search result items or thumbshot items 8115 then based on user selection of one or more index items or list items or thumbnails or search result items or thumbshot items 8115 (8151), one or more or set of said index items or list items or thumbnails or search result items or thumbshot items or reduced version of content item(s) 8115 associated original version of ephemeral message(s) is/are displayed 8152 (e.g. 8101 or 8103 and 8104 thumbnail(s) or list item(s) or index item(s) associated original or larger version of media item), if any, is displayed 8152. If haptic contact does not exist (8156—No), then the timer is checked 8158. If the timer has expired (8158—Yes), then the current one or more or set of message(s) (e.g. 8124 or 8134 and 8138) is/are deleted and user is further presented with one or more or set of index items or list items or thumbnails or search result items or thumbshot items 8115 then based on user selection of one or more index items or list items or thumbnails or search result items or thumbshot items 8115 (8151), one or more or set of said index items or list items or thumbnails or search result items or thumbshot items or reduced version of content item(s) 8115 associated original version of ephemeral message(s) (e.g. 8101 or 8103 and 8104), if any, is/are displayed 8152. If the timer has not expired (8158—No), then another haptic contact check is made 8156. This sequence between blocks 8156 and 8158 is repeated until haptic contact is identified or the timer expires.

FIG. 81 (A) illustrates user interface for presenting one or more or set of index items or list items or thumbnails or search result items or thumbshot items 8115 for user selection e.g. 8106. FIG. 81 (B) illustrates the exterior of electronic device 200. The Figure also illustrates the display 210. The display 210 presents a said selected one or more or set of index items or list items or thumbnails or search result items or thumbshot items 8115 associated original or larger version of ephemeral message(s) or content item(s) or visual media item(s) e.g. 8124 available for viewing. A first message 8124 corresponding to selected thumbnail 8106 (8152) may be displayed. Upon expiration of the timer 8158 (e.g. 8122) associate with each presented ephemeral message (e.g. 8124), a second message e.g. thumbnail 8101 associated original or larger version of content item (not shown in Figure) is displayed. Alternately, if haptic contact 8156 is received before the timer expires 8158 the second message based on user selection of thumbnail or list item is displayed.

In another embodiment FIG. 81 (D) illustrates processing operations associated with accelerated display of ephemeral messages in accordance with an embodiment of the invention and FIG. 37 (A-C) illustrates the exterior of an electronic device implementing accelerated display of ephemeral messages in accordance with the invention. FIG. 2 illustrates an electronic device 200 implementing operations of the invention. In one embodiment, the electronic device 200 is a smartphone with a processor 230 in communication with a memory 236. The processor 230 may be a central processing unit and/or a graphics processing unit. The memory 236 is a combination of flash memory and random access memory. The memory 236 stores an ephemeral message controller 277 to implement operations of the invention. The ephemeral message controller 277 includes executable instructions to accelerate display of ephemeral messages. An ephemeral message may be a text, an image, a video and the like. The display time for the ephemeral message is typically set by the message sender. However, the display time may be a default setting or a setting specified by the recipient. Regardless of the setting technique, the message is transitory.

The processor 230 is also coupled to image sensors 244. The image sensors 244 may be known digital image sensors, such as charge coupled devices. The image sensors capture visual media, which is presented on display 210. The processor 230 is also coupled to one or more sensors including Orientation Sensor 237, Position Sensor 242, GPS Sensor 238, Audio sensor 245, Proximity Sensor 246, Gyroscope 247, Accelerometer 248 and other one or more types of sensors 250 including hover sensor, eye tracking system via optical sensors 240 or image sensors 244. In one embodiment, the ephemeral message controller 277 monitors signals or senses or one or more types of pre-defined equivalents of generated or updated sensor data from the one or more sensors including voice command from audio sensor 245 or particular type of eye movement from eye tracking system based on image sensors 244 or optical sensors 240 or hover signal from e.g. specific type of proximity sensor 246. If one of the pre-defined types of said senses detected or is observed by the said one or more types of sensors during the display of a set of ephemeral message(s), then the display of the existing set of message(s) is/are terminated and a subsequent set of ephemeral message(s), if any, is displayed. In one embodiment, two types of signals or senses from sensors may be monitored. A continuous signal or senses from one or more types of sensors may be required to display a set of message(s), while an additional sensor signal or sense may operate to terminate the display of the set of message(s). For example, the viewer might instruct via voice command or hover on display or done one or more types of pre-defined eye movement. This causes the screen to display the next set of media in the collection. In one embodiment, the one or more types of pre-defined signal or senses provide by user and detected or sense by sensor to terminate a message while media viewer application or interface is open or while viewing of display 210. In another embodiment, the sensor signal or sense is any sense applied on the message area itself. In one embodiment, the gesture is un-prompted (i.e., there is no prompt such as “Delete” to solicit an action from the user). In another embodiment, the gesture may be prompted (e.g., by supplying a “Delete” option on the display, which must be sensed or touched to effectuate deletion).

The electronic device 200 may also include other components commonly associated with a smartphone, such as a wireless signal processor 220, a power control circuit 225 and a global positioning system processor 242. While many of components of FIG. 2 are known in the art, new functionality is achieved through the ephemeral message controller 277.

FIG. 81 (D) illustrates processing operations associated with the ephemeral message controller 277. Initially, user is presented with one or more or set of index items or list items or thumbnails or search result items or thumbshot items 8115 then based on user selection of one or more index items or list items or thumbnails or search result items or thumbshot items 8115 (8151), one or more or set of said index items or list items or thumbnails or search result items or thumbshot items or reduced version of content item(s) 8115 associated original version of ephemeral message(s) is/are displayed 8152 (e.g. 8124 or 8134 and 8138). A timer associated with said each ephemeral message (e.g. timer 8122 for media item 8124 and timer 8132 for media item 8134 and 8138) is/are then started 8154. The timer may be associated with the processor 230.

One or more types of user sense is/are then monitored, tracked, detected and identified 8156. If pre-defined user sense identified or detected or recognized or exists (8156—Yes), then the current set of message(s) (e.g. 8124 or 8134 and 8138) is/are deleted and user is further presented with one or more or set of index items or list items or thumbnails or search result items or thumbshot items 8115 then based on user selection of one or more index items or list items or thumbnails or search result items or thumbshot items 8115 (8151), one or more or set of said index items or list items or thumbnails or search result items or thumbshot items or reduced version of content item(s) 8115 associated original version of ephemeral message(s) is/are displayed 8152 (e.g. 8101 or 8103 and 8104 thumbnail(s) or list item(s) or index item(s) associated original or larger version of media item), if any, is displayed 8152. If user sense does not identified or detected or recognized or exist (8156—No), then the timer is checked 8158. If the timer has expired (8158—Yes), then the each expired timer associated message (e.g. 8124 or 8134 and 8138) is/are deleted and user is further presented with one or more or set of index items or list items or thumbnails or search result items or thumbshot items 8115 then based on user selection of one or more index items or list items or thumbnails or search result items or thumbshot items 8115 (8151), one or more or set of said index items or list items or thumbnails or search result items or thumbshot items or reduced version of content item(s) 8115 associated original version of ephemeral message(s) (e.g. 8101 or 8103 and 8104), if any, is/are displayed 8152. If the timer has not expired (8158—No), then another user sense identification or detection or recognition check is made 8156. This sequence between blocks 8156 and 8158 is repeated until one or more types of pre-defined user sense is identified or detected or recognized or the timer expires.

FIG. 81 (A) illustrates user interface for presenting one or more or set of index items or list items or thumbnails or search result items or thumbshot items 8115 for user selection e.g. 8106. FIG. 81 (B) illustrates the exterior of electronic device 200. The Figure also illustrates the display 210. The display 210 presents a said selected one or more or set of index items or list items or thumbnails or search result items or thumbshot items 8115 associated original or larger version of ephemeral message(s) or content item(s) or visual media item(s) e.g. 8124 available for viewing. A first message 8124 corresponding to selected thumbnail 8106 (8152) may be displayed. Upon expiration of the timer 8158 (e.g. 8122) associate with each presented ephemeral message (e.g. 8124), a second message e.g. thumbnail 8101 associated original or larger version of content item (not shown in Figure) is displayed. Alternately, if one or more types of pre-define user sense or user sense data or signal via one or more types of sensor is received (8156) before the timer expires 8158 the second set of message based on user selection of thumbnail(s) or list item(s) is/are displayed.

In another embodiment in the event of haptic contact engagement or tap and hold or haptic contact persist on list item or thumbnail e.g. 8106, display larger and original version e.g. 8124 related to said tapped and hold list item or thumbnail e.g. 8106 and starts timer and show up-to haptic contact persist or hold on display 210 and in the event of haptic contact release or disengagement on the message or in the event of expiration of said pre-set or pre-defined timer remove said displayed message and in another embodiment remove said associated index item or thumbnail 8106 from presented set of index items or list items or thumbnails 8115.

In another embodiment in the event of haptic contact engagement or tap and hold or haptic contact persist on list item or thumbnail e.g. 8106, display larger and original version e.g. 8124 related to said tapped and hold list item or thumbnail e.g. 8106 and starts timer and show up-to haptic contact persist or hold on display 210 and in the event of like by user do not remove it or in the event of not like by user or no user action (like or mark as save etc.) and in the event of haptic contact release or disengagement on the message and expiration of pre-set number of times of view or expiration of pre-set number of times of view within life duration or in the event of not like by user or no user action (like or mark as save etc.) and in the event of expiration of said pre-set or pre-defined timer and expiration of pre-set number of times of view or expiration of pre-set number of times of view within life duration remove said displayed message In another embodiment in the event or removal of said message also remove associated index item or thumbnail 8106 from presented set of index items or list items or thumbnails 8115.

In another embodiment enable user to mark as read or unread, like or dis-like, rate, mark as ephemeral or non-ephemeral, save or remove, hide or unhide, pre-set number of times of view or life duration or view time associated with each or one or more or set of selected message(s) and include or exclude before presenting to user on one or more types of feeds and presentation interface e.g. FIGS. 81 (B) and (C) (discussed throughout the specification) one or more selected index items or list items or thumbnails associated original or larger version of visual media items or content items

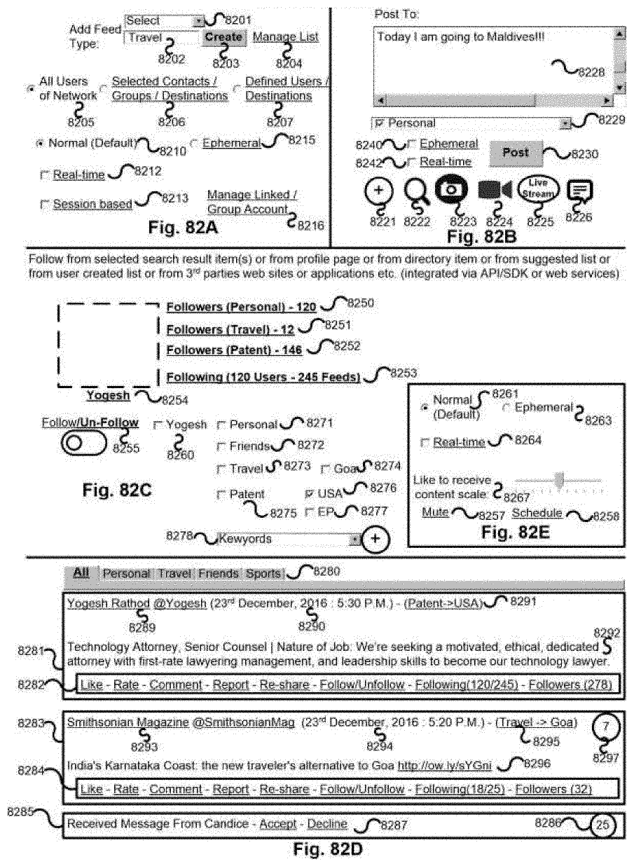

FIG. 82 illustrates user interface, wherein FIG. 82 (A) user interface enables user to manage including view list, remove, view statistics (8204) or select 8201, create or add 8203 or one or more type of feeds 8202 (which stores at server database 115 of server 110 via server module 183[A]) including e.g. personal, relatives specific, best friends specific, friends specific, interest specific, professional type specific, news specific 8202, and enable to provide configuration settings, privacy settings, presentation settings and preferences for one or more or each feeds 8202 including allow all users of network 8205, allow to selected or all contacts, groups, destinations 8206 to follow or subscribe said particular type of feed(s) e.g. 8202, allow predefine types of users of network and/or destinations based on structured query language (SQL), customized query, natural query, criteria specific (selected one or more fields and provided associated values and/or Boolean operators between selected fields & values (e.g. Age Range >=18-<=25 AND Gender=Male AND education=“M.B.A.” OR “D.B.A.” AND Location or Place=Mumbai AND College=“ABC college”) and wizard interface or allow invited or allow request accepted of requestors or allow to follow or subscribe one or more types of created feeds to pre-defined characteristics of followers only based on use data and user profile 8207. For example personal feeds type is allow following or subscribing only to user's contacts. For example for News type of feed, allowing following or subscribing to all users of network. For example for professional type of feed, allowing to subscribe or follow to connected users only or to pre-defined types of characteristics users of network only. In another embodiment make particular feed real-time 8212 only i.e. receiving user can accept or reject or miss 8287 push notification to view said message within pre-set duration 8286 else receiving or following user or follower is unable to view said message 8285. In another embodiment enable posting user to make posted content item as ephemeral 8215 and provide ephemeral settings including pre-set view or display duration, pre-set number of times of allow to view, pre-set number of times of allow to view within pre-set life duration and after presenting in the event of expiry of view timer e.g. 8297 or surpass number of times of views or expiry of life duration remove said message e.g. 8283 from recipient user's device. In another embodiment enable posting user to start broadcasting session 8213 and enable followers to view during that session content item or start real-time view content as and when contents are posted, in the event of first posted content item if follower not viewed said content item then in the event of posting of second content item follower can view only second posted & received content item and in the event of follower viewed said content item then in the event of posting of and receiving of second content item then system removes first content item from recipient device and present second posted content item.

In another embodiment FIG. 82 (C) illustrates user interface for enable searching user to provide search query and search users and related one or more types of feeds (via sending search request or following request for following to selected of one or more users and/or one or more type(s) of feed(s) of one or more user(s) at server 110 via server module 183(D)) and select from search result item(s) users e.g. 8254 and/or related one or more types of feeds (8271, 8272, 8273, 8274, 8275, 8276, 8277) and follow all or selected one or more types of feeds (8260) of one or more selected users (e.g. 8260) or provide search query to search posted contents or messages of users of network and select source(s) or user(s) or related one or more types of feeds associated with posted message or content items and follow source(s) or related one or more types of feeds or follow user's all or selected one or more types of feeds of user from search result item or from user's profile page or from categories directory item or from suggested list or from user created list or from 3rd parties' web sites or applications. In another embodiment following user can follow or unfollow 8255 user(s). In another embodiment following user can mute receiving of posted messages from particular user up-to un-mute. In another embodiment following user can schedule to receive posted messages from followed users or followed users' feeds 8258. In another embodiment following user can receive and view only real-time 8264 and in the event of not viewing in real-time discard said message or remind user for pre-set times within pre-set interval period of time and in the event of not viewing after said pre-set times of reminder then remove or discard said received message(s) from followed user(s). In another embodiment following user can provide scale 8267 to indicate how much content user likes to receive from all or particular followed user or particular feed of particular followed user(s) and/or also provide one or more keywords, categories, hashtags 8278 inside posted messages which user likes to receive said keywords, categories, hashtags specific messages from followed user(s).

In another embodiment FIG. 82 (B) illustrates user interface for enabling user to select one or more types of feeds 8229 (created via user interface discussed in FIG. 82 (A)) and post 8230 message 8228 (which processes and stores at server database 115 of server 110 via server module 183(D)) which will available to followers of posting user. User can post text message 8228, chat 8226, selected 8221 photo, captured photo 8223, selected 8221 video, recorded video 8224 and start live stream which can view real-time by followers.

In another embodiment FIG. 82 (D) illustrates user interface for enabling following user (e.g. user [Yogesh]) to view message posted by user 8281 and view posted messages e.g. 8283 or one or more types of one or more content items or visual media items from followed user(s)'s e.g. 8293 followed type(s) of feed(s) e.g. 8295 related posted messages 8283 at/under/within//in said categories or type of feed(s) 8280 presented messages (e.g. 8281, 8283, 8285), wherein messages serve by server 110 from server database 115 via server module 183(C). For example when user [Yogesh] followed user [Candice]'s “Sports” type feed then when user [Candice] post message under “Sports” type feed or first select “Sports” type feed and then tap on post to post said message at server 110 then server 110 presents said posted message related to “Sports” type feed of user [Yogesh] at following user [Candice]'s “Sports” category tab so receiving user can view all followed “Sports” type feed related messages from all followed users in said “Sports” category tab. Present invention also enables group of users via linked account 8216 (Send request to one or more users to add them in one or more types of created feeds and in the event of acceptance of request by invitee then add said user to linked account related to one or more types of feeds. User can remove one or more users from linked accounts.) to posts in one or more created and selected types of feeds for making them available for common followers of group.

FIG. 83 illustrates one of the exemplary user interface for enabling or facilitating user to input or edit or draft e.g. 8317, search & match 8304, select, select from suggested list (e.g. 8306, 8307, 8308), real-time send or present alerts or notifications or indications (e.g. via interface or via push notification and in the event of access of or tap on notification show interface or on device lock interface to present said contextual keywords) about contextual keywords based on user device monitored location(s), checked-in place, logged user status, activities, actions, events, transactions, communications, sharing and participations, select via auto-fill e.g. 8317, 8309 or 8305 and add, update, remove and provide user related keywords, key phrases, tags and hashtags (e.g. 8310, 8311, 8312), associate and provide one or more Boolean operators (AND/OR./NOT/+/−/Phrases) 8391, categories (e.g. 8301, 8302 & 8303), taxonomy (e.g. 8301, 8302 & 8303) and providing, associating, selecting 8330 editing or updating, removing and adding one or more types of one or more relationship 8352 and 8354 or ontology(ies) 8352 and 8354 including one or more types of or one or more types of one or more activities, actions, events, transactions, status, locations, interactions, associations, interrelationships, synonym or meaning, senses, expressions, behavior, reactions, communications, collaborations, sharing, participations and associate one or more information, structured information and metadata (e.g. 8330, 8332) via selecting from notification specific or associated or presented contextual keywords, selecting from categories suggested list (e.g. 8306, 8307, 8308), add via scanning object or entities including person, product, service, brand, shop name, item, thing, parts, accessory, movie, application, web site, link, place, physical establishment, etc. based on object recognition, face recognition and optical character recognition (OCR) technologies, add via find or suggest nearest objects or entities and select and add, add via scanning one or more types of QRcode or other types of code which infers or provides unique identities of related object or entity, select from categories, domains, subjects or fields and type of activities specific templates, domains, subjects or fields and type of activities specific structured forms including provided one or more fields specific one or more types of value(s), searching and selecting keywords and key phrases via search engine, preparing and generating via Structured Query Language (SQL), natural query, and wizard interface and providing to user intelligent interface to enabling user to associate, relate, map and provide one or more types of one or more relationship(s) and ontologies among or between one or more keywords, key phrases, types, categories, taxonomy, tags and hashtags including input, search, match, select, auto fill from suggested one or more types of activities, actions, events, transactions, status, locations, interactions, associations, interrelationships, senses, expressions, behavior, reactions, communications, collaborations, sharing, participations and provide categories, sub-categories, taxonomy between or among keywords, key phrases

Wherein searching, matching, notifying and presenting of one or more or categories suggested list(s) (e.g. 8306, 8307, 8308) of keywords, key phrases, tags, hashtags and associated contextual categories, taxonomy, metadata, relationships and ontology (ies) for user selection is/are based on one or more types of stored user data including user profile, activities, actions, events, transactions, status, locations, interactions, associations, interrelationships, senses, expressions, behavior, reactions, communications, collaborations, sharing, participations and any combination thereof.

Wherein template(s) 8376 comprise categories, domains, subjects or fields and type of activities specific set of keywords, key phrases, tags and hashtags, associate and provide one or more Boolean operators, categories, taxonomy and one or more types of one or more relationship or ontology(ies) including one or more types of or one or more types of one or more activities, actions, events, transactions, status, locations, interactions, associations, interrelationships, synonym or meaning, senses, expressions, behavior, reactions, communications, collaborations, sharing, participations and associate one or more information, structured information and metadata. In an embodiment presenting or suggesting templates bas on one or more types of stored user data including user profile, activities, actions, events, transactions, status, locations, interactions, associations, interrelationships, senses, expressions, behavior, reactions, communications, collaborations, sharing, participations and any combination thereof.

Wherein structured forms(s) 8374 comprise categories, domains, subjects or fields and type of activities specific user specific configured or customized structured forms(s) for enabling user to select filed(s) of form(s) to provide one or more types of value(s) including provided structured data (e.g. Filed is “Gender” and Value is “Female” or Filed is “Education” and Value is “M.B.A.” Filed is “Age Range” and Value is “18-25”), keywords, key phrases, tags and hashtags, associate and provide one or more Boolean operators, categories, taxonomy and one or more types of one or more relationship or ontology(ies) (e.g. Filed is “What are you eating <at checked-in place—restaurant name & type>” and Value is “Sandwich”) including one or more types of or one or more types of one or more activities, actions, events, transactions, status, locations, interactions, associations, interrelationships, synonym or meaning, senses, expressions, behavior, reactions, communications, collaborations, sharing, participations and associate one or more information, structured information and metadata. In an embodiment presenting or suggesting templates bas on one or more types of stored user data including user profile, activities, actions, events, transactions, status, locations, interactions, associations, interrelationships, senses, expressions, behavior, reactions, communications, collaborations, sharing, participations and any combination thereof.

There are plurality of various ways to adding user related keywords, key phrases and associate categories, relationships and other types of information including for example based on monitoring of user device location and user data e.g. when user enters in to particular geo-location or place boundary, system identifies and presents said place related keywords e.g. when user [Yogesh] enter into “Cafe Paris” then user [Yogesh] device's lock screen presents suggested keywords, which user yet not added, to user (e.g. “Cafe Paris”, List of menu items for user selection (which menu item user likes or frequently order)) for speed up adding of keywords and/or associating of relationships to user related collections of keywords or user is notifies about said suggested keywords and in the event of acceptance via notification associate button or icon or control or user action “Accept or Add” then adding of said suggested keywords to user related collection of keywords and associated relationships or in the event of “Reject” then cancel adding of said suggested keywords to user related collection of keywords and associated relationships. User can select and add said suggested keywords (“Food” and “Vegetarian AND Guajarati”) e.g. 8314 and 8320 related contextual relationship 8338 types 8354 or 8352 including activities types e.g. select 8330 or input e.g. (want to eat”) 8332 or update e.g. 8323 etc. In another example after purchasing of particular brand product user can speak brand name (e.g. “iPhone™”) and speak relationship e.g. “purchased” or “bought” then based on voice recognition system identifies and add said keywords to user related lists or collection of keywords and associated relationships. In another embodiment user is frequently presented with keyword(s) selection or input and associated relationship(s) input or selection interface based on one or more rules, updates in user data, user senses, preferences, privacy settings and settings including expiry of pre-set interval duration of reminder or when user switched ON device or when user online or when user not busy then present interface once or remind user to adding of keyword(s) and providing of associated relationships, when identification of contextual or preference based type(s) or category(ies) of place(s) or location(s) or point of interest(s) based on update or change in user's device monitored location, change in user's status, identification or recognition of keywords while user talking based on voice recognition technology and user data. In another embodiment user can capture photo or record video or scan or view via camera display screen of user device or via digital spectacles glass including and based on optical character recognition, system identifies keywords inside said capture photo or images of recorded video and add to user related collection of keywords and associated relationships. In another embodiment user can copy paste text and system identifies and add user related keywords or first presents to user for user selection and then add to and add to user related collection of keywords. In another embodiment connected users of user suggests one or more keywords to user and user can select and add to user related collection of keywords and associated relationships. In another embodiment 3^{rd} parties including advertiser, seller, place owner, service provider can present to user one or more suggested keywords (with or without one or more offers, gifts, prize, cash back, discount, coupons, redeemable points in exchange of adding of said keywords to user related collection of keywords and associated relationships or sharing of said one or more keywords to one or more connections or contacts of users) for enabling user to adding selected keywords from said presented list of suggested keywords to user related collection of keywords and associated relationships.

In another embodiment system can present to user for user selections or accumulate, auto add, remove & update lists or set or collections or categories of user related keywords, key phrases, categories, taxonomy, tags, hashtags and identify relationships among them based on user settings including auto add or auto present for user selection keywords, key phrases, categories, taxonomy, tags, hashtags and identified possible relationships among them based on user data and current or falls within particular period of duration related user data including user's one or more activities, actions, senses generated from one or more sensors of one or more user devices, behavior, events, transactions, status, locations, checked-in-place, communications, collaborations, participations & sharing 8460, enable system to extracting keywords and key phrases from one or more types of user data from one or more sources (via Application Programming Interface (API)) including user detail profile, provided domain specific filled-up survey forms, sent or shared and received or viewed information from one or more sources, identified objects inside shared and viewed photos and videos related keywords and associated metadata or data related keywords 8462, enabling system to monitoring of user status, manual status, logged or stored one or more types of locations & checked-in places, activities, actions, events, transactions, behavior, senses detected or recognized by one or more sensors 8464, enabling system to auto identify keywords and key phrases based on recording of video via digital spectacles camera and extracting keywords and key phrases based on identified or recognized objects inside image(s) or video i.e. from series of images 8466, enabling system to auto identifying keywords and key phrases based on monitoring and recording of voice and extracting of keywords & key phrases 8468, and enabling system to monitoring user locations, places, checked-in-places, Points of Interest (POIs) based on monitoring, tracking and storing geo-location information of user's smart device and accumulate associated searched or matched information from one or more sources 8470, domain or subject or field specific detail structured user profile(s) 8472 including job profile, physical characteristics profile, interest profile, travel profile, general detail profile etc., domain specific customized and contextual updated forms 8374 and domain specific customized and contextual updated templates 8476.

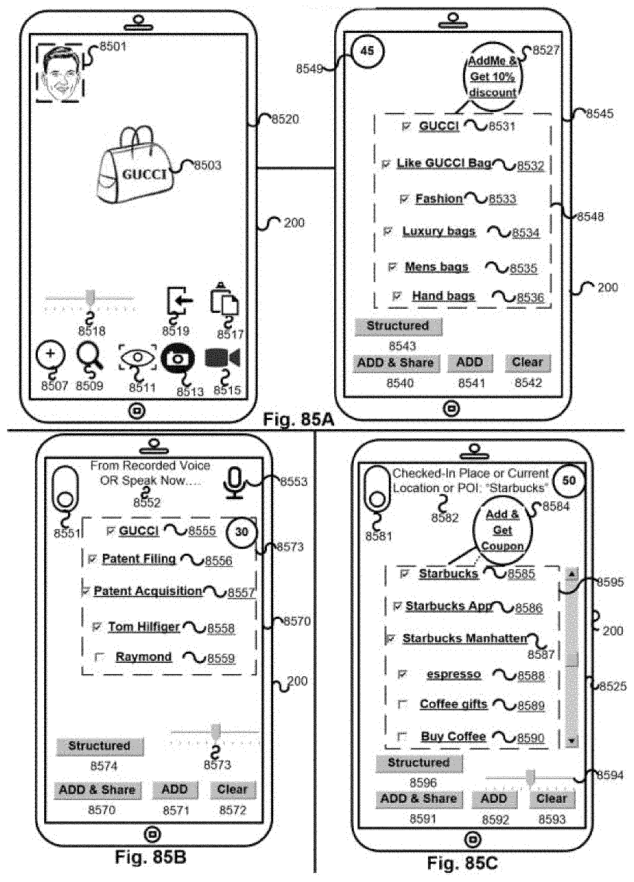

In an another embodiment FIG. 85 (A) illustrates user interface wherein user is enable to scan or view one or more scene or object or particular pre-defined object or area or spot or logo or QRcode 8503 via camera display screen 8520 of user device 200 i.e. camera view (without capturing photo or taking video or visual media) or select photo or video 8507 or search from one or more sources and select photo or video 8509 or capture photo 8513 or record video 8515 or import one or more photos, videos, one or more types of content items from one or more sources including user device galleries, folders, screenshots, shared and 3^{rd} parties websites or applications or copy or cut and paste visual media or text or one or more types of contents 8517 and based on user command or instruction to present contextual keywords, key phrases, categories & hashtags and/or associated contextual prospective type of relationships or ontology(ies) via button 8511, system auto recognizes and identifies object(s) or pre-defined object or area or spot or logo or text or particular object or pre-defined or pre-stored object or QRcode 8503 inside camera view for example when user is viewing particular bag 8503 from particular shop via camera view 8520 and after tap on button 8511, system identifies or auto recognizes object inside camera view 8503 and matches said identifies one or more objects 8503 and scanner user data with pre-stored objects, images, QR codes and/or associated one or more types of data including said pre-provided or pre-defined object(s) or object model(s) provider's profile, object model(s) associated details, preferences, target viewers' criteria including target viewer's pre-defined characteristics including gender, age, interest, education, qualification, skills, interacted or related entities and matches with viewing's user's data including user's current location or checked-in place or nearest location, user profile including age, gender, interest & like, user activities, actions, events, transactions, status, locations, behavior, senses, communications, sharing and identifies associate keywords, key phrases, categories & hashtags and associated relationships & ontology(ies) provided by advertisers or users or merchants or server 110 or 3^{rd} parties and presents list of keywords, key phrases, categories & hashtags and associated relationships & ontology(ies) e.g. 8548 at user interface 8545 on user device 200 for enabling user to select and add said one or more selected keywords via “Add” button 8541 or tap on preferred keyword area to select and add said keyword or tap on “+” icon associated with preferred keyword to select and add or access keyword associated contextual menu to select and add said keyword to user related collection of keywords at server database or storage medium 115 of server 110 via server module 184 (C). In another embodiment user can select one or more keywords from suggested or presented list of keywords and add to user related collection of keywords at server 110 and can also share with one or more or all connected users or contacts of user. In another embodiment user can manually clear remaining or presented list of keywords via tap on “Clear” button 8542 or user can swipe left or right to remove each keyword or tap on (−) icon associated with each keyword to remove. In another embodiment based on pre-set settings, user have to select one or more keywords within pre-set duration of time for adding to user related collections of keywords and in the event of expiration of aid pre-set duration timer auto remove or clear said currently suggested or presented list of keywords 8548 from user interface 8545 of user device 200. In another embodiment user can provided one or more types of pre-defined user senses for instruction to adding or removing one or more keywords including user can speak keyword and can add to user related collection of keywords or user can provided various voice commands including “clear” to clear said list 8548, “add all” to add all keywords 8548 to user related collection of keywords, “add and share+<name of keyword(s)” to user related collection of keywords and share, access, invoke, open, close associated one or more link(s) of web site(s) or web page(s), view contents etc. In another embodiment user can instruct system to present more or less number of suggested keywords 8518. In another embodiment system presents keywords based on rank of keyword, wherein rank of keyword based number of users added said keyword out of number of users who presented with said keyword, number of users access number of times said keyword related applications, objects, interfaces and contents, advertised keyword and associated bid, one or more types of user data. In an embodiment user is enabled to select, capture, record, scans object or code or logo e.g. 8503 and also enabled to provide one or more types of one or more expressions of user, pre-defined type(s) of one or more visual expressions, visual commands, visual keywords and visual instruction via front camera 8501 photo(s) and/or video(s) and sent to server module 184 (A) which recognizes object inside said provided image(s) 8503 and recognizes one or more types of one or more expressions of user, pre-defined type(s) of one or more visual expressions, visual commands and visual instruction inside said front camera one or more photo(s) or video(s) 8501 and identifies keywords (e.g. object name, brand, company, product name, tags and associated information from one or more sources) and identifies user's reactions, activity or action or transaction or status or requirement type(s) including like (via showing thumb), more like (via smiling face), dislike (via showing downward thumb), purchase, rate (via showing within 1 to 5 fingers (one hand) or 1-10 fingers (both hands) e.g. 4 finger to provide 4 stars to periocular scanned product or food item or logo or service provider person or face). Server module 184 (A) provides said identified data to server module 184 (B) which identifies and matches contextual suggested keywords and presents to user at user interface 8548 of user device 200 e.g. 8532 for enabling user to select from said presented one or more suggested keywords and adds 8541 to user related collection of keywords and/or adds and share with one or more contacts and/or users of network 8540.

In an embodiment server 110 receives scanned or supplied image e.g. 8593 and sent to object or face or text recognition or detection or identification server module 184 (A) which compares said supplied image with each pre-stored images or object models at server storage medium 115, and searches, matches, analyze, identifies and presents associated or suggested keywords from one or more sources including advertised object model associated keywords via server module 184 (B).

In an another embodiment FIG. 85 (B) illustrates user interface wherein based on voice recognition, system identifies or recognizes contextual keyword(s) 8573 while user is talking 8553, and present identified or recognized keywords 8553 at user interface 8570 on user device 200 for enabling user to select one or more keywords and add 8571 to user related collection of keywords or clear 8572 or add to user related collection of keywords and share with one or more contacts or destinations 8570. User is enabled to ON or OFF 8551 recording of user voice for recognizing keywords. In another embodiment user can instruct system to present more or less number of suggested keywords 8573 recognized or identifies during user's recording of voice or talks.

In an embodiment server 110 receives incremental or frequently voice recording file or stream of user 8593 and sent to voice recognition module 184 (E) which identifies keywords in user's voice file or stream and sent to server module 184 (B), which finds out important or user related or contextual or suggested keywords 8573 based on user data, and presents said identified or recognized contextual keywords 8553 at user interface 8570 on user device 200 for enabling user to select one or more keywords and add 8571 to user related collection of keywords at server database or storage medium 115 of server 110 via server module 184 (C).

In an another embodiment FIG. 85 (C) illustrates user interface wherein based on monitored user device's current location or checked-in place provided by user or auto checked-in place by server 110 via server module 184 (F) and/or one or more types of user data stored at server database 115 of server 110, system identifies, searches, matches and presents said monitored user device location or said checked-in place specific or nearest location specific or pre-set radius of location surround user's current location specific contextual keywords 8595 by server 110 via module 184(B) and enabling user to select one or more keywords from said list of keywords 8595 and add 8592 to user related collection of keywords at server database 115 of server 110 via server module 184 (C) or clear 8593 or add to user related collection of keywords and share with one or more contacts or destinations 8591. User is enabled to ON or OFF 8581 location service and presenting of user device's current location or checked-in place specific suggested keywords. In another embodiment user can instruct system to present more or less number of suggested keywords 8594 based on user device's current location or checked-in place.

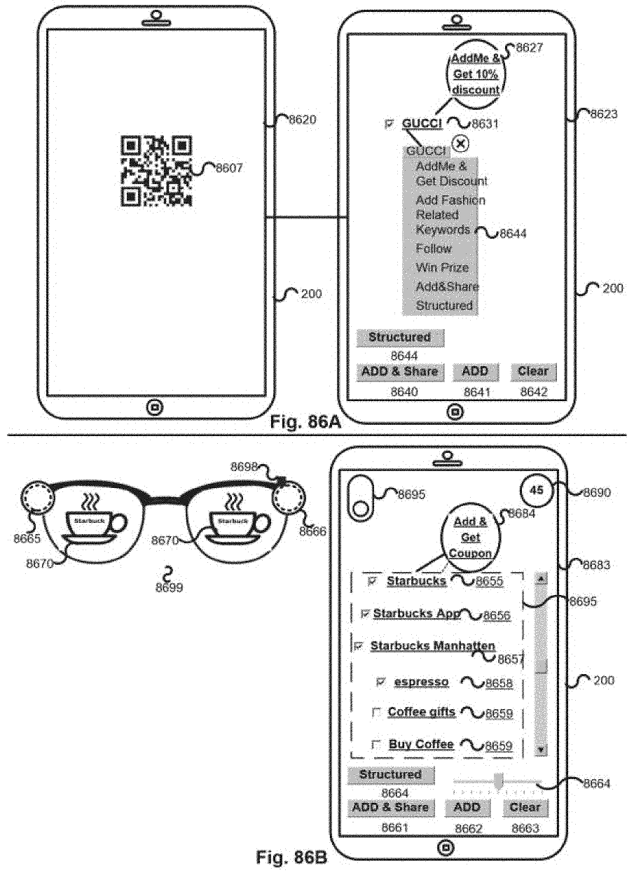

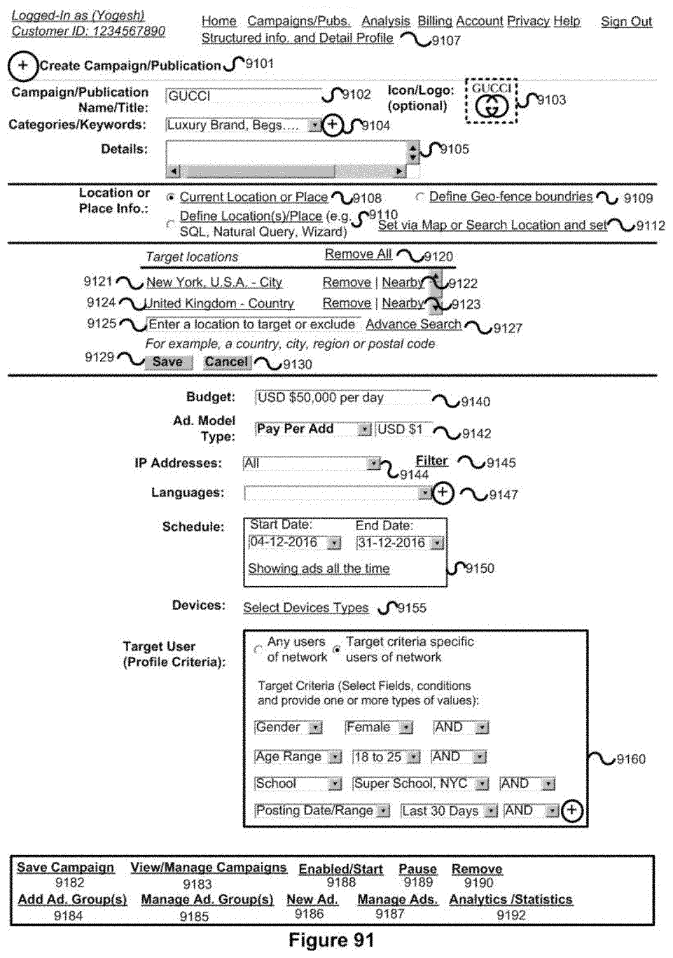

In an another embodiment FIG. 86 (A) illustrates user interface for enabling user to scan one or more types of codes, printed codes and barcodes including QRcode e.g. 8607 and based on scanned said e.g. QRcode e.g. 8607 and/or said e.g. QRcode e.g. 8607 associated criteria including locations, target criteria (discussed in detail in FIGS. 91 & 92), system identifies and presents said scanned e.g. QRcode e.g. 8607 associated keyword(s) e.g. “GUCCI™” 8631 and enabling user to select one or more keywords e.g. 8631 from said presented list of keywords and add 8641 to user related collection of keywords or clear 8642 or add to user related collection of keywords and share with one or more contacts or destinations 8640 and enabling user to access contextual menu 8644 associated with each presented or suggested keyword e.g. 8631. for example said contextual menu 8644 enables user to access said keyword e.g. 8631 related contextual or associated one or more options including add said keywords, add & share said keyword, add provided additional keywords, follow said keyword or keyword related hashtag, participate in said keyword related offers and conduct said keyword related one or more types of actions, activities, transactions, participations, communications, sharing, viewing via associated one or more types of one or more applications, interfaces, objects, one or more types of media or content items, web services and any combination thereof.

In an embodiment server 110 receives scanned barcode or code e.g. QRcode 8607 related details from user device 200 via QRcode interpreter module and matches said received QRcode related details e.g. unique identity with associated details stored at server database 110 of server 110, and searches, matches, analyze, identifies and presents associated or suggested keywords from one or more sources including advertised object model or QRcode associated keywords via server module 184 (B) of server 110.

In an another embodiment FIG. 86 (B) illustrates user interface wherein based on user view or viewing (e.g. 8670) via user's spectacles device 8699 associated video camera(s) (8665 & 8666), system identifies or recognizes captured or record photo or video associated object(s) and based on user setting (auto) or command or instruction to present contextual keywords, key phrases, categories & hashtags and/or associated contextual prospective type of relationships or ontology(ies) via auto setting or spectacles associate button 8698, system auto recognizes and identifies object(s) or pre-defined object or area or spot or logo or text or particular object or pre-defined or pre-stored object or QRcode 8503 inside camera view for example when user is viewing particular coffee cup 8570 from particular type of shop via camera view 8665 & 8666 and after tap on button 8698, system identifies or auto recognizes object inside camera view 8670 and matches said identifies one or more objects 8670 and viewer user data with pre-stored objects, images, QR codes and/or associated one or more types of data including said pre-provided or pre-defined object(s) or object model(s) provider's profile, object model(s) associated details, preferences, target viewers' criteria including target viewer's pre-defined characteristics including gender, age, interest, education, qualification, skills, interacted or related entities and matches with viewing's user's data including user's current location or checked-in place or nearest location, user profile including age, gender, interest & like, user activities, actions, events, transactions, status, locations, behavior, senses, communications, sharing and identifies associate keywords, key phrases, categories & hashtags and associated relationships & ontology(ies) provided by advertisers or users or merchants or server 110 or 3^{rd} parties and presents list of keywords, key phrases, categories & hashtags and associated relationships & ontology(ies) e.g. 8695 at user interface 8683 on user device 200 for enabling user to select and add said one or more selected keywords via “Add” button 8662 or tap on preferred keyword area to select and add said keyword or tap on “+” icon associated with preferred keyword to select and add or access keyword associated contextual menu to select and add said keyword to user related collection of keywords at server 110. In another embodiment user can select one or more keywords from suggested or presented list of keywords and add to user related collection of keywords at server 110 and can also share with one or more or all connected users or contacts of user. In another embodiment user can manually clear remaining or presented list of keywords via tap on “Clear” button 8663 or user can swipe left or right to remove each keyword or tap on (−) icon associated with each keyword to remove. In another embodiment based on pre-set settings, user have to select one or more keywords within pre-set duration of time 8690 for adding to user related collections of keywords and in the event of expiration of aid pre-set duration timer 8690 auto remove or clear said currently suggested or presented list of keywords 8695 from user interface 8683 of user device 200. In another embodiment user can provided one or more types of pre-defined user senses for instruction to adding or removing one or more keywords including user can speak keyword and can add to user related collection of keywords or user can provided various voice commands including “clear” to clear said list 8695, “add all” to add all keywords 8695 to user related collection of keywords, “add and share+<name of keyword(s)” to user related collection of keywords and share, access, invoke, open, close associated one or more link(s) of web site(s) or web page(s), view contents etc. In another embodiment user can instruct system to present more or less number of suggested keywords 8664. In another embodiment system presents keywords based on rank of keyword, wherein rank of keyword based number of users added said keyword out of number of users who presented with said keyword, number of users access number of times said keyword related applications, objects, interfaces and contents, advertised keyword and associated bid, one or more types of user data.

In an embodiment server 110 receives image viewed by user via user device (e.g. eyeglass or wearable device) e.g. 8670 and sent to object or face or text recognition or detection or identification server module 184 (A) which compares said supplied image with each pre-stored images or object models at server storage medium 115 of server 110, and searches, matches, analyze, identifies and presents associated or suggested keywords from one or more sources including advertised object model associated keywords via server module 184 (B).

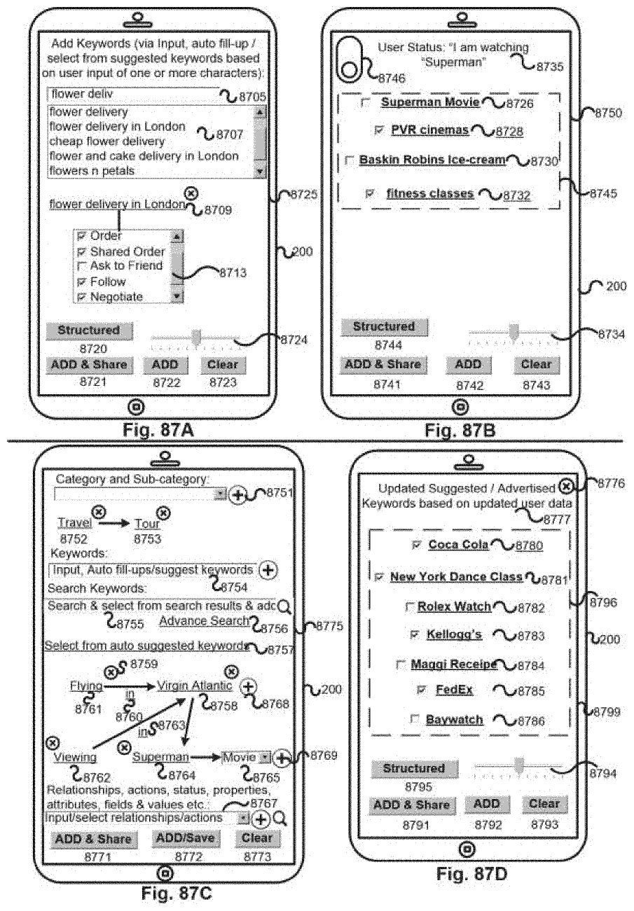

In an another embodiment FIG. 87 (A) illustrates user interface enabling user to simplest way to input or auto-fill 8705 or select from inputted characters specific auto suggested list of keywords 8707 and add keyword(s) e.g. 8709 and/or associated one or more related actions, reactions, relationships, interaction type, categories, and type(s) of activities, events, transactions, status, location or place to user related collections of keywords.

In an another embodiment based on user input of character or addition or updating in inputted characters 8705, server module 185 (B) of server 110, auto suggests said inputted one or more characters specific updated list of keywords 8707 and enables user to add selected keywords from suggested keywords 8707 and store to user related collection of keywords at server database 115 of server 110 via server module 184 (C).

In an another embodiment FIG. 87 (B) illustrates user interface wherein based on user's status provided or selected by user or auto identified by system 8735, which stores at server database 115 of server 115, and/or one or more types of user data stored at server database 115 of server 110, system or server module 184 (B) identifies, searches, matches and presents said provided or selected or identified user status e.g. 8735 specific contextual keywords 8745 and enabling user to select one or more keywords from said list of keywords 8745 and add 8742 to user related collection of keywords at server database 115 of server 110 via server module 184 (C) or clear 8743 or add to user related collection of keywords and share with one or more contacts or destinations 8741. User is enabled to ON or OFF 8746 making available status to other users or connected users and presenting of status specific suggested keywords. In another embodiment user can instruct system to present more or less number of suggested keywords 8734 based on user's status.

In an another embodiment FIG. 87 (C) illustrates user interface enabling user to select one or more categories 8751 (e.g. “Travel” category 8752 and “Tour” sub-category 8753), input or autofill or select from suggested list one or more keywords, key phrases & hashtags 8754 and/or search & select keywords from keywords search engine 8755 or use advance search option 8756 or select from auto suggested keywords 8757 from one or more sources or methods including e.g. via scan (FIGS. 85 (A) & 86 (A)), view object (FIG. 86(B)) voice (FIG. 85(B)) or categories keywords directory etc. (e.g. 8758 and 8764) and selecting, inputting, editing and associating one or more relationships to one or more keywords e.g. user adds action type keyword “Flying” 8761 via search, select or input action type keyword 8767 and tap on “+” to adds keyword “Virgin Atlantic” 8758 via 8754 or 8755 or 8757. System auto show arrow (→) to visually describe relationship user can change to (←) to describe relationship and select or input and add relationship keyword “in” 8760 via tap on arrow (→) and input or input 8767 or select from 8767. User can removes 8759, adds (“+” e.g. 8768 or 8769) and updates (tap on keyword) one or more keywords, relationships, action types, properties. User can further adds action type keyword “Viewing” 8762 via search, select or input 8767 and adds keyword “Superman” 8764 via 8754 or 8755 or 8756 or 8757 and adds associate types, attributes, properties, features, function e.g. “Movie” 8765 and add relationship between keywords “Viewing” 8762 and “virgin Atlantic” 8758. User can visually or via drag and drop add or updates one or more types of keywords or relationships draw or add relationships or action types of properties, remove one or more types of keywords or relationships. After preparing user related current travel ontology i.e. adding, updating & removing one or more categories, category associated one or more sub-categories and category related or associated one or more keywords, keyword associated one or more types of one or more relationships, activities, actions, events, transactions, status, interactions, entities, attributes, aspects, properties, features, characteristics, or parameters, features, functions, user can add or save said ontology to user's collection of user created ontologies at server database 115 of server 110 and/or share with one or more connected users or contacts or groups or destinations of users 8791 or clear or remove or discard said prepared ontology 8793 from user interface. Present invention enables user created and user related ontology in simplified manner. In another embodiment system enables user to selects or auto identifies type(s) of keyword(s) including one or more types of entity name e.g. brand, person, item, product, service, school, college, company, organization, department, shop, mall, physical establishment, activity type, action type, status type, transaction type, relationship type, place or location type, event type. In another embodiment user can define filed name, field data type and provide associate value(s).

In an another embodiment FIG. 87 (D) illustrates user interface, presenting identified and suggested user related contextual keywords, key phrases, hashtags and/or associated contextual categories, types, taxonomy, relationships, attributes 8796 including advertised keywords via server module 184 (B) based on matching keywords, key phrases, hashtags database(s) or tables in database(s) 115 of server 110 with one or more types of user data stored at server database 115 of server 110 including one or more types of detail user profiles, monitored or tracked or detected or recognized or sensed or logged or stored activities, actions, status, manual status provided or updated by user, locations or checked-in-places, events, transactions, reactions (liked or disliked or commented contents), sharing (one or more types of visual media or contents), viewing (one or more types of visual media or contents), reading, listing, communications, collaborations, interactions, following, participations, behavior and senses from one or more sources, domain or subject or activities specific contextual survey structured (fields and values) or un-structured forms, devices, sensors, accounts, profiles, domains, storage mediums or databases, web sites, applications, services or web services, networks, servers and user connections, contacts, groups, networks, relationships and followers. User is enabled to select one or more keywords from said list of keywords 8796 provided by server 110 via server module 184 (B) and add 8792 to user related collection of keywords at server database 115 or user related collection of keywords table(s) of server database 115 of server 110 or clear 8793 or 8776 or add to user related collection of keywords and share with one or more contacts or destinations 8791. In another embodiment user can instruct system to present more or less number of suggested keywords 8794 based on user's data.

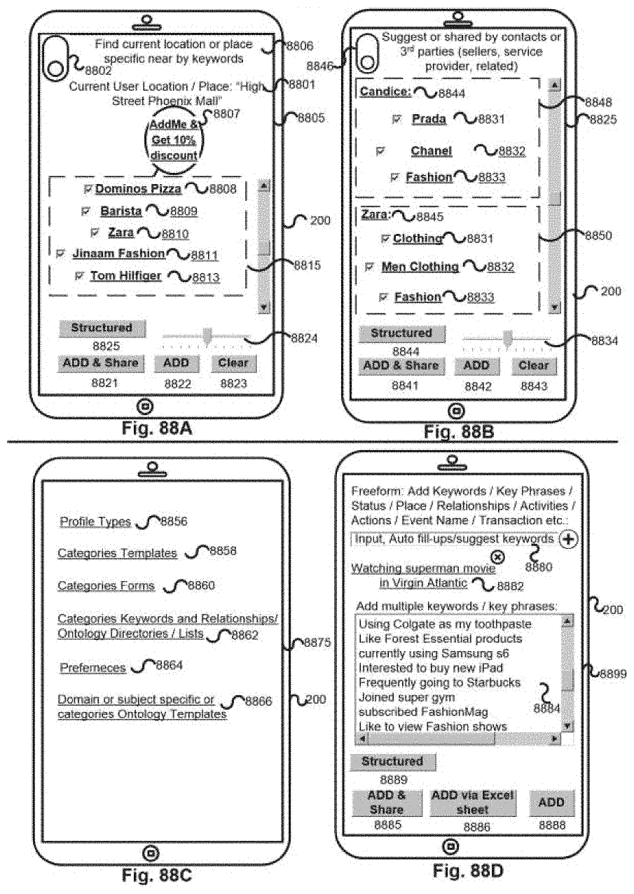

In an another embodiment FIG. 88 (A) illustrates user interface, enabling user to ON or OFF 8802 finding of user device's monitored current location or place e.g. 8801 nearby or surround locations or places by server module 184 (F) related keywords. System presents, based on monitored user device's current location by server module 184 (F) or checked-in place provided by user or auto checked-in place and/or one or more types of user data stored at server database 115 of server 110 and supplied to server module 184 (B) for searching and providing nearby locations or places specific suggested keywords, system identifies, searches, matches and presents said monitored user device location or said checked-in place specific nearest locations or places or locations or point of interests or places surround user device's current location specific or pre-set radius of location surround user's current location specific contextual keywords 881 via server module 184 (B) and enabling user to select one or more keywords from said list of keywords 8815 and add 8822 to user related collection of keywords at server database 115 of server 110 via server module 184 (C) or clear 8823 or add to user related collection of keywords and share with one or more contacts or destinations 8821. In another embodiment user can instruct system to present more or less number of suggested keywords 8824 based on user device's current location or checked-in place.

In an another embodiment FIG. 88 (B) illustrates user interface, enabling user to ON or OFF or select and apply one or more privacy settings and preferences 8846 receiving of suggested or shared keywords from user's one or more all selected contacts or group(s) or follower(s) or network(s) and/or one or more types of all or one or more source(s) including web sites, servers, applications, sellers whose customer is user, service providers whose client or guest or subscriber is user, user's checked-in place related owner or advertiser or administrator or staff or salesperson or keywords provider. For example user [Y] receives suggested or shared keywords 8748 from connected user or contact user [Candice] 8844 and receives suggested or shared keywords 8748 from seller or shop or showroom of [Zara] 8845 in which user is customer and enabling user to select one or more keywords from said list(s) of keywords 8848/8850 and add 8842 to user related collection of keywords or clear 8843 or add to user related collection of keywords and share with one or more contacts or destinations 8841. In another embodiment user can instruct system to present more or less number of suggested keywords 8834 from all or one or more selected contacts or sources.

In an another embodiment server receives suggested keywords from one or more contacts of user and/or from 3^{rd} parties domains and stored at user related prospective suggested keywords via server module 184 (B) and presents to user at user interface 8825 of user device 200 based on user device's current monitored location or place via server module 184 (F) user status, user's voice, user's viewed image and one or more types of user data and enables user to select one or more keywords from said presented suggested list of keywords and in the event of selecting and adding of said selected keywords via client device “add” button 8842, server 110 stores said selected keywords e.g. 8848 and 8850 to server database 115 via server module 184 (C).

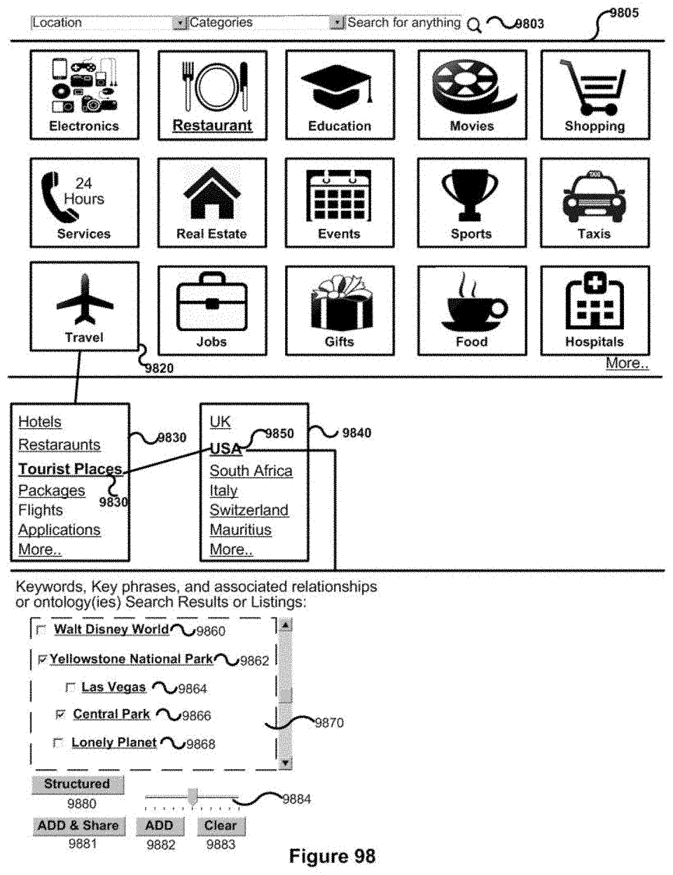

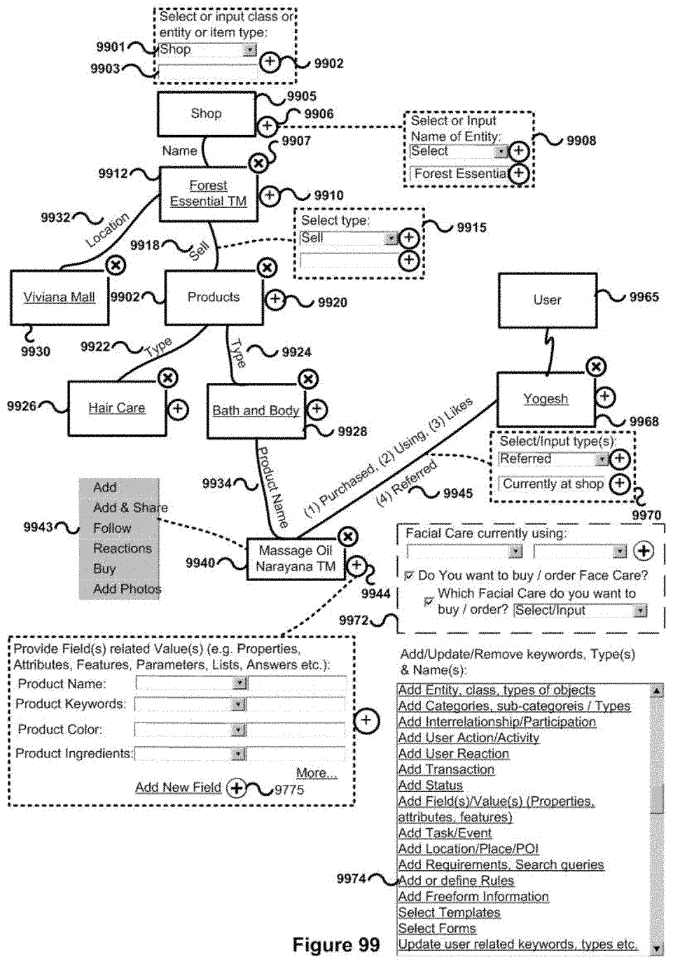

In an another embodiment FIG. 88 (C) illustrates user interface, enabling user to provide one or more types of user data including domains or subjects or categories or activities or requirement specific profiles 8856 and customized or configured forms, which is/are generated, configured, customized, and provided by server module 184 (C) of server 110 based on one or more types of user data (discuss in detail in FIGS. 95 & 96) to provide structured user data. In another embodiment enabling user to select domains or subjects or categories or activities or requirement specific templates, which is/are generated, configured, customized, and provided by server module 184 (C) of server 110 based on one or more types of user data, to select fields and input or select from contextual list of said selected field related one or more keywords, key phrases, hashtags and provide, input or select from contextual or prospective list or associate one or more relationships, categories, taxonomy, action or activity or transaction or status or location or place type, properties, attributes & particular type (discuss in detail in FIG. 94), which are stored at server database 115 of server 110 via server module 184 (C). In another embodiment enabling user to select one or more or set of keywords, key phrases, hashtags and select relationships or type(s) from associated contextual suggested list of relationships and type(s) from categories directory 8862, provided and customized by server 110 via server module 184 (B) and stored selected keywords at server database 115n of server 110 via server module 184 (C) (discuss in detail in FIG. 98). In another embodiment enabling user to select domain or subject or field or category or type specific ontology template, which is/are generated, configured, customized, and provided by server module 184 (C) of server 110 based on one or more types of user data and enable to configure and customize said selected ontology template related one or more individuals, classes, sub-classes, properties, sub-properties, properties, attributes, fields and associated values, relationships, features, parameters, and rules, which are stored at server database 115 of server 110 via server module 184 (C) 8866 (discuss in detail in FIG. 99).

In an another embodiment FIG. 88 (D) illustrates user interface, enabling user to provide, select from suggested list or auto-fill and add to list or manually input lists of user related keywords 8884 in freeform manner i.e. keywords or key phrases includes relationships, action, activity, event, transaction, status, category, type, properties, attributes, filed(s) and associated value(s), reaction, location, place, purpose, requirement and enabling user to add said list to collection of user related keywords, key phrases, hashtags and associated one or more type of or name of one or more relationships, actions, activities, events, transactions, status, categories, types, properties, attributes, filed(s) and associated value(s), reactions, locations, places, purposes, requirement specifications, which are stored at server database 115 of server 110 via server module 184 (C). In another embodiment user is enabled to share said list with one or more types of one or more contacts and/or destination(s) 8885. In another embodiment user is enabled to import list from excel sheet 8886.

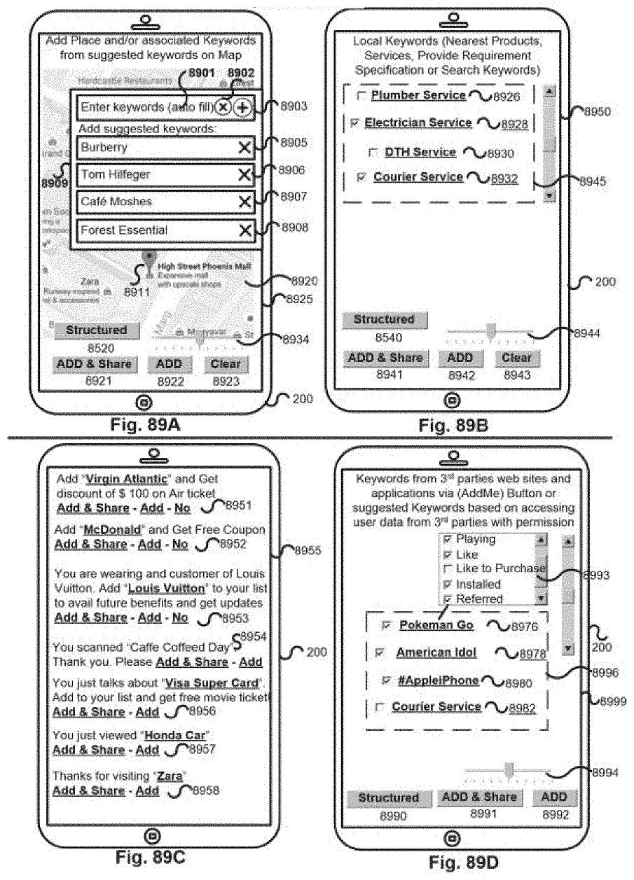

In an another embodiment FIG. 89 (A) illustrates user interface, enabling user to search or select from map 8920 particular location or place or auto select current user device's monitored location or place on map 8920 and can select from suggested contextual list of keywords via server module 184 (B) based on said location or place and/or user data and/or enable user to auto-fill and input 8901 one or more keywords 8909. User can add 8922 to user related collection of keywords which is/are stored at server database 115 of server 110 via server module 184 (C). User can add and share 8921 one or more selected keywords to one or more contacts and/or destinations. In another embodiment user can instruct system to present more or less number of suggested keywords 8734 based on user's selection of place or location or defined type(s) of place(s) or location(s) on map. When user adds selected one or more keywords from map then system also associates and stores related location or place and associated information with said selected and added keywords.

In an another embodiment FIG. 89 (B) illustrates user interface, based on user data and user's family related data stored at server database 115 of server 110 including user's home address, work address(es), interacted entities related addresses including school, college, class, and visited shops, markets, sports club, restaurants, point of interest, and shopping malls, system identifies local services, service providers, products, shops, and one or more types of relevant entities via server module 184 (B) and presents matched, associated, contextual, presented by said entities related keywords 8945 for user selection via server module 184 (B) and enabling user to add 8942 said selected keywords to user related collection of keywords at server database 115 of server 110 via server module 184 (C). In another embodiment user is enabled to add said selected keywords to user related collection of keywords at server 110 and also share said keywords to one or more selected contacts and/or destinations.

In an another embodiment FIG. 89 (C) illustrates user interface including received push notification(s) presentation interface or interface for receiving message(s) or indication(s) or alert(s) or call or notification(s) from push notification service module 184 (G) of server 110 regarding adding of particular keyword(s) provided by advertisers, 3^{rd} parties sellers, service providers, merchants and contacts of user and recognized, identified, inferred, sensed and detected based on user scanning or viewing of particular object(s), user's voice recording, user's current location or checked-in place(s), user's status, user's one or more types of recorded senses and behavior via user device(s) including smart phone, wearable device (wrist watch), eye glasses related one or more types of sensors, based on current user related keywords, near-by locations or places, user's or user's family home and work and interacted entities related addresses, one or more types of user data including domain or subject specific user profiles, user preferences, activities, actions, events, transactions, connections, participations, communications, sharing, relationships & interaction with entities.

In an another embodiment FIG. 89 (D) illustrates user interface on 3^{rd} parties web site or web page or application or interface which integrated “AddMe” or “Add” or “Add keywords” 8991 or “Add & Share” 8992 button or menu or one or more types of one or more control(s) or icon(s) or link(s) or interface(s) via application programming language and software development toolkit (SDK) and web services, for enabling users of network or logged-in user of network at said periocular web site or application or logged-in or access 3^{rd} parties integrated applications or features of web sites within present system via APIs, SDKs & web services to add 8992 at server database 115 of server 110 via server module 184 (C) and/or share with one or more contact(s) or connection(s) and/or connection(s) on 3^{rd} parties web sites or applications, one or more selected keywords, key phrases, hashtags from presented one or more keywords, key phrases, hashtags 8996 by server module 184 (B) and select or input or associate one or more categories, relationships, attributes, properties, filed(s) and associate value(s) from keyword related contextual list of prospective categories, relationships, attributes, properties, filed(s) and associate value(s) 8993 from 3^{rd} parties websites, applications and interfaces to user related collection of keywords at server database 115 of server 110 via server module 184 (C). In another embodiment user can instruct system to present more or less number of suggested keywords 8994 on/by 3^{rd} parties' web sites and applications.

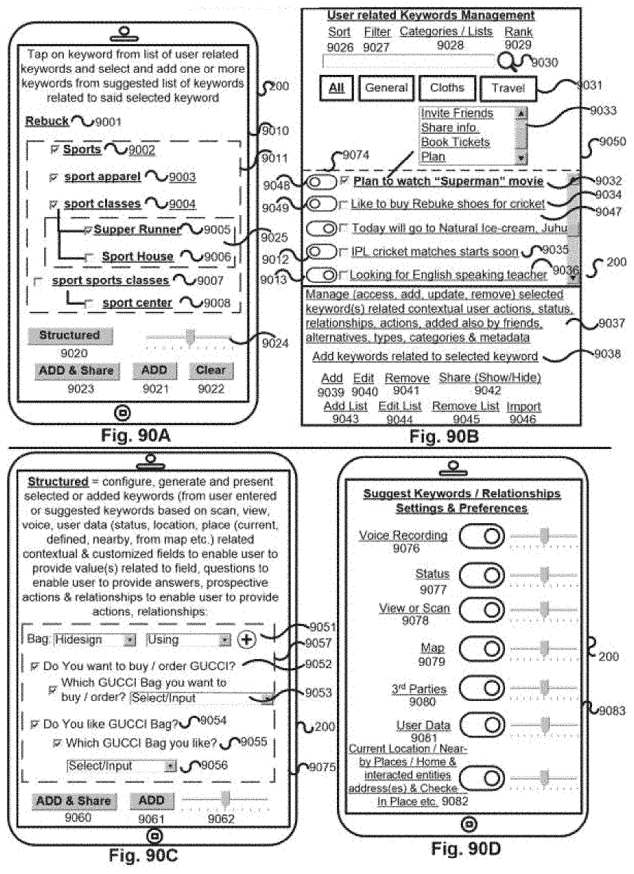

In an another embodiment FIG. 90 (A) illustrates user interface for enabling user to search, match, filter, rank, select from categories list or select keyword from list of user related keyword 9001 provided or presented by server module 183 (C) of server 110 for viewing said selected keyword 9001 related contextual keywords 9025 and select keywords (e.g. 9002, 9003, 9004) and select keyword(s) 9005 from suggested keywords 9025 related to selected keyword 9004, provided by server module 184 (B) and enabling user to add 9021 to user related collection of keywords at server database 115 of server 110 via server module 184 (C) or clear 9022 selections or presented list of keywords or add to user related collection of keywords and share with one or more contacts or destinations 9023. In another embodiment user can instruct system to present more or less number of suggested keywords 9024 based on user's selection of keyword for instructing to present said keyword(s) related contextual or suggested keywords.

In an another embodiment FIG. 90 (B) illustrates user interface for enabling user to access user related keywords provided or presented by server module 183 (C) of server 110 including view 9047, select, search (advance search keyword type, category, added date & time ranges, metadata) & match 9030, sort (alphanumeric ascending, descending order, order, date & time wise), filter (source(s) wise, particular one or more mutual contact(s) related, added date & time wise, rank wise, category, type, taxonomy wise, selected entity wise (e.g. brand, item, product name, service name, location or place name, local shop or service provider name, school, company, action type, status type etc.), user can view as per categories or lists of user related keywords 9028 or access via tabs 9031. User can provide rank 9029 to keyword(s) including assign rank (to identify most useful, recent) and can provide one or more types of one or more user created, updated or selected status and/or metadata 9037 to one or more user related & selected keywords e.g. 9032 including current, past, future (scheduled), pending, important, shared, mutual, transaction type (done, pending, prospective, collaborative, shared, ordered, bought, plan to book or buy, add to cart, interest to buy, add to wish list), doing, done, will do, planned, collaborative, connected, invitation send, invitation received, communication send, communication received, arrived, arriving, in-route, confirm, missed, reject, cancel, removed, new, no reply, read or viewed, not viewed or not read, sent, received, like, dis-like, referred, negotiating, enquiring, querying, question posted, answer received, sent requirement specification, one or more types of request (consulting, negotiation, comparison, alternative, lowest price, best quality, quotation etc.), searching matched or contextual service providers or sellers, conduct one or more types of user actions from contextually presented user actions 9033, added relationships, actions, activities, events, transactions, status, locations or places, categories, types, properties, attributes, filed(s) specific value(s), metadata & structured information 9037, added via source types (scan, voice, place etc.), visited, viewed presentation, attending or attended or will attend on date & time and place or venue, followed, gets discounts, participates, type of user expressions, watching, reading, listening, eating, testing, strolling, drinking, playing, looking for, celebrating, preparing. User can select keyword 9032 (e.g. Plan to watch “Superman” movie) and add or access associate contextual user actions selected by use and/or advertiser and/or server 110 and provided by server module 184 (H) of server 110 from one or more sources or developers or uploaded by user (e.g. menu items, buttons, links etc.) 9033 or 9037 (e.g. tap or click on “Invite Friends” to invite friend to show interest to view said movie together, tap or click on “Share Info.” To share link of trailers, videos, photos, reviews & ratings etc., tap or click on “Book Tickets” to book tickets or invite and confirm friends or contacts and then book ticket, tap or click on “Plan” to make plan with friends for watching movie and make trips and plan for lunch or dinner together etc. Based on keyword, system identifies user's current, past, present and future or scheduled one or more activities, actions, events, transactions, status, place, locations, purpose, requirement, intention, plan, task, need, query, problem, solution, prospective or actual customer for particular brand, product or service, interacted or related entities, behavior, expressions or moods, participations, user's one or more types of characteristics and enables or facilitates user, one or more connected users of user and related entities to conduct one or more activities, actions, events, transactions, participations, interactions, connections, sharing, communications, collaborations, plan, and tasks like presentations, make order, buy product, subscribe service, ask query, negotiate, book tickets, get discount or avails offers, view information, fill forms, show interest, make comments, provide one or more types of reactions including like, dislike, select emoticons & rate, search local and on-demand products & services. User can access and ad selected keyword related keywords (as discussed in detail in FIG. 90 (A)). User can manage user related keywords and/or keyword objects including add keywords and/or keyword objects 9039, edit keywords 9040, remove keywords 9041, add list 9043, edit list 9044, remove list 9045 and import and/or format keywords 9046 from one or more sources, applications, web services, user accounts, storage mediums, databases, servers, devices, and networks.

In another embodiment user is enabled to search, match, view listing details, make payment (if paid), download & install or use links to access link(s) associated one or more applications, functions, objects, interfaces and data or one or more type of contents or media items, updates, upgrades, select, configure, customize, apply presentation schema, attach, detach, select from keyword specific auto presented list of contextual and associate one or more selected user actions from list of provided user actions or user actions or controls accessible links (accessible features, functions, options, applications links or menu items or controls (e.g. buttons)) e.g. 9033 via server user actions app stores or search engine & module 184 (H).

In another embodiment user is enabled to share 9042 (show/hide) 9048 or publish or un-publish one or more selected keywords e.g. 9048 or 9049 or 9012 and associated or attached one or more contextual menu items or controls or links of one or more applications, interfaces, user actions or controls, features, options, call-to-actions, functions, objects & one or more types of one or more media items or content items or data, associated relationships, categories, types and metadata & system data 9033 to all or one or more selected or default or pre-set contacts and/or group(s) and/or one or more types of one or more destination(s) 9042, in the event of sharing or showing or make available of selected keyword(s) e.g. 9048 or 9049 or 9012 to one or more selected contacts and/or destinations, system real-time informs or notifies or alerts reminds or sends indications about sharing of that keywords and presents said keyword(s) to recipient user(s) at recipient user's device(s) (e.g. like showing of checked-in place or user status) and enable recipient user of said shared keyword(s) e.g. 9032 to access, view, select from one or more associated user actions e.g. 9033 to communicate, collaborate, exchange messages, share, participate with sender as well as all or one or more selected recipients or viewers of said keyword e.g. 9032 and conduct one or more planning, scheduling, activities, actions, events, transactions, tasks and participations (e.g. invite friends, share information, book ticket and make planning of event). In another example when user of user device 200, switched ON via icon 9049 to show or share or send or broadcast or advertise keyword “Like to buy Rebuke shoes for cricket” 9034 to user's connected users then said recipient users can provide comments, consulting, and suggest which shoes user can buy. In another example keyword 9036 has sharing icon “OFF” mode (default) 9013 to make it not publishable to others or not share with contacts but share with related entities e.g. in this context people who are English speaking teachers. In another example when user share keyword “IPL cricket matches starts soon” 9035 via keyword associated (publish (ON)/un-publish (OFF)) icon 9012 then system presents said shared or published keyword “IPL cricket matches starts soon” 9035 to connected users of user and enable them to exchange messages, make plan to view cricket match together and book tickets etc.

In another embodiment enabling to creating, updating, generating, removing, requesting, upgrading, listing, downloading, installing, accessing via link, sending, receiving, allowing user to adding, plugging or integrating with 3^{rd} parties websites & applications, customizing, configuring, monitoring, tracking, accessing associate analytics & statistics, presenting, and accessing keyword object(s) or instance of keyword object that related to user (i.e. customized or configured for each user or related to each user).

In another embodiment enabling to adding, attaching, selecting, updating, removing, configuring, customizing, set-up, allow to access properties, fields, data types, functions, classes, parameters (pass or provide associate values) based on one or more types of permissions, privacy settings, preferences & privacy policies, associating and presenting one or more contextual user actions or controls (e.g. menu item(s), button(s), link(s) etc.), keywords, categories, metadata, system data, filed(s) or structured form(s) or template(s) for enabling user to provide associate value(s), one or more types including one or more types of relationships, activities, actions, events, transactions, status, place or location, user sense, and behavior, one or more types of media or contents related to keyword or keyword related to user (i.e. customized or configured for each user or related to each user).

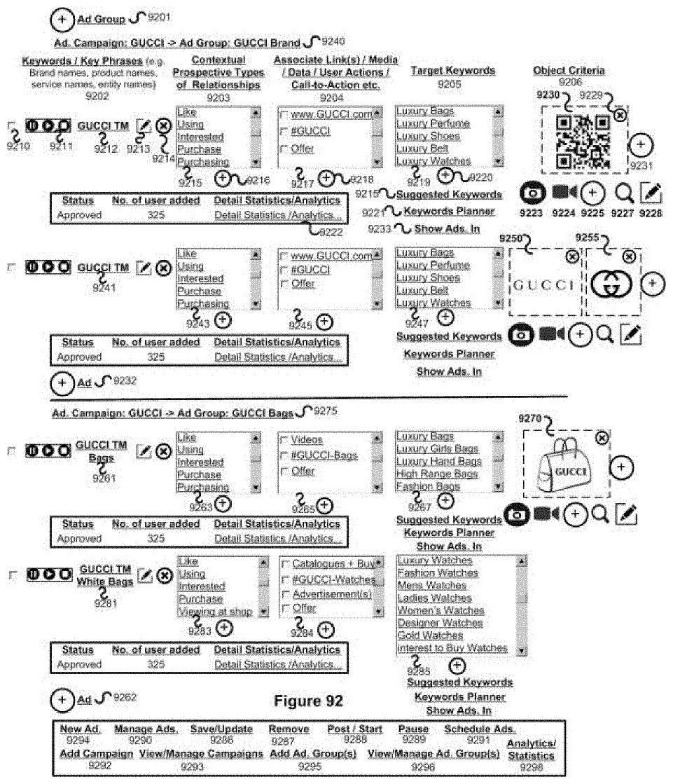

In another embodiment enabling authorized user to permit one or more types of access of keyword object based on one or more types and levels of authorization, privacy settings, system settings, privacy policies, rights & privileges. For example brand owner or administrator or authorized staff or user of network or publisher or enterprise user or advertiser or merchant e.g. “GUCCI™” can create, update, remove, publish (based on target criteria, location(s) or place(s), scheduling, object criteria etc.), manage & access “GUCCI” keyword object (discussed in detail in FIGS. 91-93) including searching, matching, viewing details, purchasing selected from listed to allow to access link(s) of, selecting, customizing, configuring, attaching, associating one or more user action(s) or control(s) (e.g. menu item(s), button(s), link(s)—for enabling users of network e.g. 8644 to e.g. add said keyword object or said object related keyword to user related object keywords and/or keywords, make order, buy or add to cart or add to wish list or interest list said keyword related or selected product(s), access related keywords, relationships, categories, types, metadata, fields to enabling user to provide values, action types, forms, templates, one or more types of one or more media items or content items, data & information, offers (provide offer to user in the event of adding of said keyword related to keyword object by user) and enabling to provide target criteria, target location, target audience criteria, object criteria, schedule to publishing for publishing, making available for users (via enabling user to scan object or sample image, identify in user's voice, suggested list based on one or more types of user data including user device location, checked-in place, status etc.) or advertise said keyword object or keyword (discussed in details in FIGS. 91, 92 & 93). Based on publisher's publication settings or target criteria, user is auto presented with said keyword object and/or keyword (for user selection to add or add & share) e.g. 8531, 8631, 8555 based on one or more types of user data or based on user scan, user view, user voice, user device current location or place, user status or user can search, match, select and add or add & share said keyword object and/or keyword to user related list or collection of keyword objects and/or keywords. User can access said keyword object or control (button, link & menu) or object link or application or interface and associated contextual user actions or one or more types of control(s) (e.g. via menu, button & link etc.), media items or data, forms, templates, related keywords, prospective list of actions, types, relationships, categories & metadata 8644.

In another example user of network publish user name keyword or profile object and making available for target criteria specific users of network (all, selected one or more contacts and/or destinations) and enable them to view, access permitted user data including user profile and associated user actions including e.g. call or messaging to/with user, send request for connection etc.

In an another embodiment FIG. 90 (C) illustrates user interface, wherein system presents user selected or added keyword(s) e.g. 8548 (all selected), from suggested keywords e.g. 8548 (as discussed in e.g. FIG. 85 (B)), specific contextual & customized one or more fields via server module 184 (B) of server 110 e.g. 9021 (e.g. via tap or click on “Structured” button 8543, 8574, 85 96, 8644, 8664, 8720, 8744, 8795, 8825, 8844, 8889, 8520, 8540, 8990, 9020) to enable user to provide one or more types of or data types specific value(s) 9021 related to field (e.g. “Bag”), presents question(s) 9052 or 9053 or 9054 or 9055 to enable user to provide answers e.g. via check to say “Yes” or un-check to say “No” or select from combo box 9053 or 9056 to provide answer, presents prospective actions & relationships to enable user to provide actions, relationships. In another embodiment user is enabled to add or save said filled form or provided field(s) specific value(s) 9061 to user related collection of keywords and associated filled structured information (e.g. 9051, 9052, 9053, 9054, 9055, 9056) or save at server database 115 of server 110 via server module 184 (C) and share said filled structured information (e.g. 9051, 9052, 9053, 9054, 9055, 9056) with one or more contacts or destinations 9060. In another embodiment user can instruct system to present more or less number of structured fields or customized contextual form(s) or template(s) or question(s) 9062 (e.g. 9051, 9052, 9053, 9054, 9055, and 9056).

In an another embodiment FIG. 90 (D) illustrates user interface enabling user to provide privacy settings and preferences, which stores at user device 200 and/or server database 115 of server 110, comprising enable or disable voice recording 9076, publishing of user status to connected or other users of network or providing or not providing suggested keywords based on said provided status 9077, enable or disable scan feature or providing or not providing suggested keywords based on user scan or user view via eyeglass 9048, enable or disable providing or not providing suggested keywords based on selection of particular location or place on map 9079, enable or disable providing or not providing suggested keywords based on user data 9081, enable or disable providing or not providing suggested keywords from/at/via/on one or more selected or logged-in 3^{rd} parties web site and applications related user data 9080, enable or disable providing or not providing suggested keywords based on current Location, near-by places, home & interacted entities address(es) & checked-in place etc. 9082. In another embodiment user can instruct system to present more or less number of suggested keywords based on recorded user voice 9076, user status (manual or auto or provided by user contacts or 3^{rd} parties one or more websites or applications or servers) 9077, when user scans objects or view objects or image(s) 9078, select location or place on map to provide or select keywords 9079, based on user data 9081, based on 3^{rd} parties including one or more web sites, applications, servers, storage mediums & devices related user data and at 3^{rd} parties one or more web sites and applications wherein present system integrated via one or more control(s) (e.g. “AddMe” button), application programming interface (API) and software development toolkit (SDK) and web services and one or more types of communication interface. In another embodiment sender or sharing user of keyword can apply one or more types of settings on one or more recipients as discuss in detail in FIG. 7. In another embodiment recipient user of keyword can apply one or more types of settings on one or more sender(s) of keyword(s) as discuss in detail in FIG. 8.

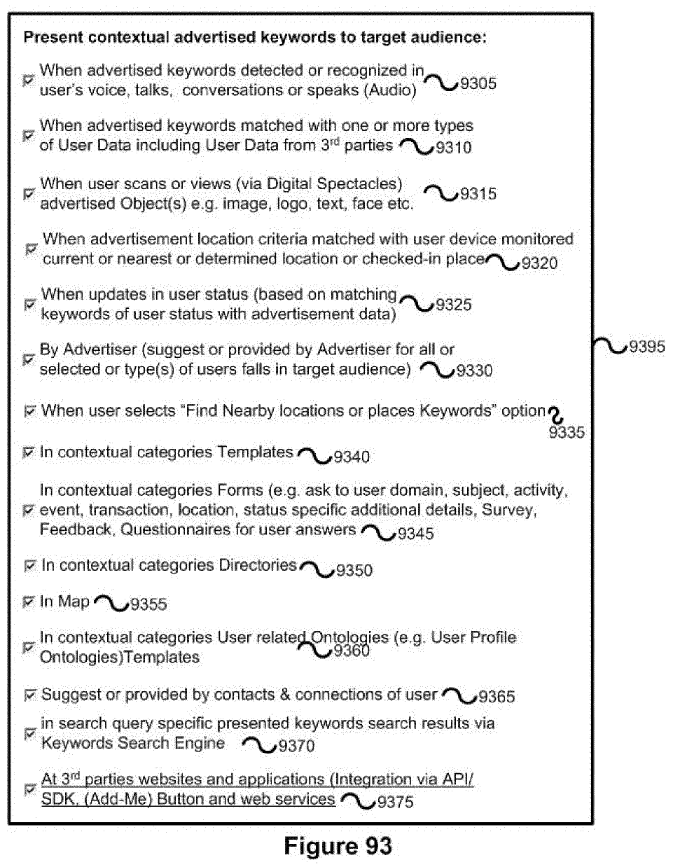

FIG. 91-93 illustrates user interface(s) for in an embodiment enabling advertiser or publisher user to create account including provide user and entity details 9107 (name, age, gender & other profile information, entity name & address, email, contact information), login information (e.g. user identity or email address, password) billing information & payment information (if paid) or free for general user, authorized publisher and server admin. In an embodiment after creating account, server or system verifies advertiser or publisher or user or account(s) and active user account to enable account holder to create and manage one or more advertisement campaigns, advertisement groups, advertisements and associate target criteria and other settings. In an embodiment enabling advertiser to create one or more advertisement campaigns 9101 or enabling user to create one or more publications 9101, campaign or publication comprises a set of advertisement groups (advertisements, keywords, and bids) that share a budget, advertisement model type, location targeting, type of user profile or defined characteristics of user targeting, schedules of targeting, languages targeting, device(s) type(s) targeting, campaign types (discussed in detail in FIG. 93) and other settings, campaign settings let advertiser control where and when their advertisements appear and how much they want to spend and campaigns are often used to organize categories of products or services that advertiser offer, Advertiser enable to provide campaign or publication name 9102, provide campaign or publication related categories and keywords 9104, provide icon or logo or image 9103, provide details 9105, set or define or provide locations to target advertisement or showing keyword(s) based on matching targeted advertisement related location(s) with current location of user device including select current location as target location 9108, select locations or places, provide address, provide geolocation information (e.g., coordinates including latitude, longitude, aptitude) or search or select location(s) or place(s) from/on map 9112 or select or define geo-fence boundaries 9109 or define types and characteristics of location or query specific locations or places based on structured query language (SQL), natural query and wizard interface, enable to enter (input, auto-fill up, suggested list) location to target or include or exclude location(s) 9125, for example user adds locations 9121 and 9124, remove all added 9120, remove selected or find nearby and add 9122 or 9123, user advance search to provide location criteria, conditions, rules, boundaries, query specific locations or places (For example SQL query: “Select Places where Place Type=‘GUCCI’” or Natural Query” “all GUCCI shops of world”). Advertiser can create separate advertisement campaigns to run advertisements in different locations or using different budgets. Advertiser can provide budget for particular duration including daily maximum spending budget of advertisement 9140, daily budget is the amount that advertiser set for each campaign to indicate how much, on average, advertiser's willing to spend per day, advertisement model including pay per add of keyword(s) by users of network 9142 or use cost-per-adding of keywords by user in user's collection of keywords (CPA) bidding, which means that advertiser pay only if someone adds advertised keyword(s). In general, the higher the advertiser's bid and the more relevant advertisements and keywords, the more likely advertiser's advertisement will show at a higher position in the suggested list of keywords. Advertiser can provides associated target criteria including add, include or exclude or filter 9145 IP addresses 9144, one or more languages 9147, schedule of showing of advertisement including start date, end date and showing advertisements all the time or particular time, time range at particular date or day 9150, select targeted device type(s) 9155 including mobile devices, personal computer, wearable device, tablets, android device and/or iOS devices etc., define target user's profile type or characteristics or modeling of target users including any users of network or target criteria specific users of network including one or more types of one or more profile fields including gender, age or age range, education, qualification, home or work locations, related entities including organization or school or college or company name(s) and Boolean operators and any combination thereof 9160. After creating and providing information and settings related to created campaign, user or publisher or advertiser can save campaign 9182 at server database 115 of server 100 via server module 184 (I) and/or local storage medium of user device 200, so user can access, update, start 9188, pause 9189, stop or remove 9190, view and manage 9183 one or more created campaigns and associate information and settings including one or more advertisement groups 9184 and 9185, and keywords advertisements 9186 and 9187 and can access started one or more campaigns, advertisement groups and advertisement associated or generated analytics and statistics 9192.

FIG. 92 illustrates user interface for enabling advertiser or publisher to create one or more advertisement groups 9240 and 9275 related to particular or selected campaign 9102. After creating and set-up of campaign 9102 (as discussed in FIG. 91), advertiser can create advertisement group e.g. 9240 via clicking or tapping on ad group button 9201. An ad group contains one or more ads 9212 and 9241 which target a shared or different set of keywords. Each of advertiser's or publisher's campaigns (discussed in FIG. 91) is made up of one or more ad groups 9240 and 9275. Advertiser can use ad groups to organize ads by a common theme and use different ad groups for different product or service types. For example, GUCCI™ creates campaign GUCCI™ (discussed in FIG. 91) and creates ad groups 9240 and 9275 including one for GUCCI™ brand and other for GUCCI™ bags. After creating ad group e.g. 9240 (“GUCCI™ Brand”), advertiser can creates advertisement(s) via create advertisement icon or link or control or button 9232 e.g. 9212. Ad group is where advertiser will add 9232, edit 9213, remove 9214 advertised keywords e.g. 9212 (“GUCCI™”), add, edit, remove 9216 one or more contextual prospective types of relationships, reactions, activities & actions 9215, add, edit, remove 9218 one or more call-to-actions or user actions links & controls, applications or links of applications, one or more types of media items or links of added one or more types of media items, one or more types of offer(s) including discount, redeemable points, coupons, cash backs, free gifts or samples or one or more types of benefits 9217 and add, edit, remove 9220 or choose keywords 9119 from suggested list of keywords 9215 or select via keywords planner 9221 (which helps to find out best relevant keywords which are found more in user data or user related collections of keywords) that can trigger those ads 9212 and/or 9241 when someone's (i.e. any users of network) user data (user's one or more types of profile or structured information (fields and provided associated values), logged or stored data related to user's activities, actions, events, transactions, senses, behavior, sharing, communications, collaborations, interactions, status, and current or past or checked-in locations or places) and user's collection of keywords 9047 including said advertisement related keyword contains said target keywords 9219, add 9231 (capture photo(s) 9223, record video(s) 9224, drag n drop image(s) or video(s) 9230 and select 9225 or search and select 9227 image(s) or video(s) (series of images), edit 9228, remove 9229 one or more object criteria including object model 9230 that can trigger those ads 9212 and/or 9241 when someone i.e. any users of network scans or view (via eye glass or spectacles equipped with video camera and connected with user device) similar to said supplied image 9250 (e.g. user [A] visits shop of Ney York City GUCCI shop 9121 and scans or view “GUCCI” logo 9255 or name 9250 or scans QRcode 9230 via user device camera or via eyeglass or digital spectacles which contains said object criteria (system matched and recognizes said scanned or viewed image with object criteria or object models associated with advertisements and identifies advertisements i.e. keywords presented to said scanner or viewer user). Every campaign needs at least 1 ad group, and every ad group needs at least 1 ad. In another embodiment advertiser can provide target keywords 9219 and select type of match (not shown in figure) including broad match, exact match, phrase match, or negative match, wherein broad match is the default match type and when advertiser use broad match, advertiser's ads automatically run on relevant variations of keywords 9219, even if these terms aren't in advertisement related target keyword lists 9219. In another embodiment advertiser can search, match, select, view details, purchase (if paid), customize, apply privacy settings & add one or more user actions or call-to-actions, controls, functions, objects, buttons, interfaces, links, contents, applications, web services and forms provided by one or more developers 9217.

In another embodiment after creating advertisement or publication campaign(s) 9102 (as discussed in FIG. 91), campaign associated advertisement group(s) 9240 and 9275 and advertisement group 9240 and 9275 related advertisement keyword(s) 9212, 9241, 9261, 9281, user or publisher or advertiser can anytime save campaign associated advertisement group(s) and associated keywords advertisement(s) at server database 115 of server 100 via server module 184 (I) and/or local storage medium of user device 200, so user can access, update, start 9288, pause 9289, stop or remove 9287, view and manage 9290 one or more created campaigns associated advertisement group(s) and associated keywords advertisement(s and associate information and settings including one or more advertisement groups 9240 and 9275, and keywords advertisements 9212, 9241, 9261, 9281 and can add new ads 9294, manage currently created ads 9290, add new ad group(s) 9295, mange ad group(S) 9296, add campaign(s) 9292, manage campaign(s) 9293 and can access started one or more campaigns, advertisement groups and advertisement associated or generated analytics and statistics 9299.

In another embodiment after creating advertisement or publication campaign(s) 9102 (as discussed in FIG. 91), campaign associated advertisement group(s) 9240 and 9275 and advertisement group 9240 and 9275 related advertisement keyword(s) 9212, 9241, 9261, 9281 with the intention that targeted contextual users of network show said advertised keywords in various types of suggested lists of keywords 8548, 8573, 8595, 8631, 8695, 8707, 8745, 8757, 8815, 8909, 8945, 8955, 8996, 9011, 9057 and add said advertised one or more keywords 9212, 9241, 9261, 9281 to user's list or collection of keywords 9074, advertiser starts 9188, pause 9189 & stop or remove 9190 one or more campaign (e.g. 9102), starts 9288, pause 9289 & stop or remove 9287 or scheduled to start 9291 advertisement group(s) (e.g. 9240 or 9275)) and starts, pause & remove 9211 advertisement(s) or advertisement of keyword(s) (e.g. 9212, 92419261, 9281). In another embodiment system or server 110, first verifies advertisement (keywords, logo, brand, product name, service name, description or details, and advertiser's identities etc.) and then allow or approved or make eligible to start said advertisements. In another embodiment advertiser can view, access, and manage each campaign, each ad group of each campaign and each keyword advertisement of each ad group of each campaign related status, statistics and analytics 9222.

FIG. 93 illustrates user interface for enabling advertisers to show ads 9212, 9241, 9261 and 9281 in selected various types of features or selected one or more types of presented suggested lists of keywords via click or tap on option 9233 for selecting various features or types of suggested lists of keywords, wherein said settings stored at server database 115 of server 110 via server module 184 (I) including present or show or display contextual ads or advertised keywords 9212, 9241, 9261 and 9281 to target criteria specific audience (as discussed in detail in FIGS. 91 and 92) when advertised keywords 9212, 9241, 9261 and 9281 detected or recognized in user's voice, talks, conversations or speaks (Audio) 9305 (discussed in detail in FIG. 85 (B)), when advertised keywords matched with one or more types of User Data including User Data from 3rd parties 9310 (discussed in detail in FIGS. 87 (D), 88 (B) & 89 (D)), when user scans or views (via Digital Spectacles) advertised Object(s) e.g. image, logo, text & face 9315 (discussed in detail in FIGS. 85 (A), 86 (A) & 86 (B)), when advertisement location criteria matched with user device monitored current or nearest or determined location or checked-in place 9320 (discussed in detail in FIG. 85 (C)), when updates in user status (based on matching keywords of user status with advertisement data) 9325 (discussed in detail in FIG. 87 (B)), by Advertiser (suggest or provided by Advertiser for all or selected or type(s) of users falls in target audience) 9330 (discussed in detail in FIG. 88 (B)), user selects “Find Nearby Keywords” option 9335 (discussed in detail in FIG. 88 (A)), in contextual categories templates 9340 (discussed in FIG. 94), in contextual categories forms 9345 (e.g. ask to user domain, subject, activity, event, transaction, location, status specific additional details, survey, feedback, questionnaires for user answers (discussed in FIGS. 95-96), in contextual categories directories (discussed in FIG. 98), in map 9355 (discussed in FIG. 89 (A)), in contextual categories User related Ontologies (e.g. User Profile Ontologies) templates 9360 (discussed in FIG. 99), suggest or provided by contacts & connections of user 9365 (discussed in FIG. 88 (B)), in searching user's search query specific keyword search results via Keywords Search Engine 9370 (e.g. 8705, 8755 & 8756), at 3rd parties or partners websites and applications which integrates presents system's one or more features e.g. (Keyword or Add-Me) Button via application programming interface (API), software development toolkit (SDK), and web services 9375 (discussed in FIG. 89 (D)).

FIG. 94 illustrates interface for enabling user to search & match 9405 & 9506, select (from categories list, directory, suggested list, book market lists, saved lists, used lists) 9412 and 9415 one or more templates or generates user specific contextual, configured, identified, recognized & customized one or more templates 9407 provided by server storage medium 115 of server 110 via server module 184 (B), wherein template e.g. 9420 comprise location or place specific, type of location or place specific, activity or action type specific, event specific, status type specific, keyword specific, requirement specific, general type, entity type and/or name specific (e.g. school, college, company, brand, product or service category or name specific related contextual set of fields or questions 9422 and each field associated prospective contextual or related keywords 9423, user actions or reactions, types (type of activity, actions, event, transaction, location or place, status, requirement, task, entity), categories, relationships 9430 for enabling user to input, select and provide one or more types (e.g. (data types—text, image, video, integer, date & time, ranges, Yes/No etc.) of one or more field(s) e.g. 9432 specific value(s) e.g. 9434 & 9436, selection(s) e.g. 9434 & 9436 or data. In an embodiment user is enabled to select or add one or more user provide or user suggested fields, each field associate data types and provides each field specific keyword(s), user actions, one or more types, categories and relationships. In another embodiment user can generates user specific contextual templates 9407 or in another embodiment system auto generates user specific contextual templates based on one or more types of user data, wherein template generated based on one or more types of user data including user profile (age, gender, interests, hobbies, qualifications, education, interacted or related one or more types of entities, skills, home & work or office or business address(es), marital status, age range, languages, income range, liked or purchased or provide list of used or like to use products and services), status, current or past or checked-in locations or places, logged or stored one or more types of activities, actions, events, transactions, senses, behavior, physical characteristics, demographic information, physiographic information, behavioral information, geographic information, user profile ontologies and one or more types of user profiles 9640 (or discussed in detail in FIGS. 95-96) and user related, associated data from one or more sources, websites, applications, services, servers, accounts, domains, storage mediums, databases, networks and devices access via application programming interface (APIs), software development toolkit (SDKs), web services and one or more types of communication interfaces with user permissions, privacy settings & login information. Templates facilitates user to easily remember and input, select and provide user related one or more types of domains, categories, entities, subjects, fields, activities, actions, status, locations, places, requirements specific keywords, associated user relationships, user actions, categories, and types. For example user selected or searched or select from categories or generates by user or auto generates by system and auto present to user day to day activities related template 9420 which enables user to easily remember type and name or brand name of products or services user is using or want to user or are interested e.g. toothpaste, toothbrush, towel, shop, shaving cream, face wash, shampoo, conditioner, hair oil, hair brush etc. in his/her day to day activities or type of day to day requirements e.g. food types, medicines, services, stationaries, travel service (cab, bus etc.), cable service, applications, web sites etc. or day to day user is interacted with one or more types of entities e.g. school, college, class, sports club, restaurant, company, office, person names etc. System or server 110 via server module 184 (B) contextually generates said day-to-day activity type of template i.e. template related fields and selections and lists of keywords (keyword related prospective or suggested contextual list e.g. brands name, products names, services names, entities names etc.), user actions, categories, types, and relationships based on plurality of user data as discuss above.

FIG. 95-96 is an illustrated of an example embodiment graphical user interface enabling user to provide plurality types of user data via presented forms, updated forms, user created or updated customized forms and fields, various types of user profile interfaces, templates, categories survey forms, application(s) provided by server storage medium 115 of server 110 via server module 184 (B), wherein user data comprise user profile or user details provided by user, connected or related users of user, 3rd parties web sites, applications, service providers, experts, servers, databases, devices & networks, identified by server 110 including user name, photo, video, voice, various addresses, contacts & social information, age, gender, marital status, interest, school, college, employer, company, skills, languages, education, qualifications, income range, habits, religion, height, weight, cast & like, user activities, actions, events, transactions, senses, interactions, behavior, interacted entities, locations, places, contacts or connections, presence information, updated free form status 9540, updated structured status 240, wherein enabling user to select or provide parts of structured status 9541, including select types of activities, purposes, status, actors, roles, actions, profile properties or fields and/or associate values, events & transactions, select location, place, nodes, product, service, items, grammar syntax, contact or connection or user name, rules, keywords, key phrases, objects, conditions, and one or more types of entities to form or create or draft structured status, key phrases, keywords, categories, preferences, shared contents, viewed contents, subscribed contents, filled domain or subject or requirement or activities specific forms, one or more types of lists including products and services using or like to use and privacy settings.

FIG. 95-96 is an illustrated of an example embodiment graphical user interface(s), wherein interface(s) e.g. 9640 comprise one or more forms, pages of forms, applications, web pages, web sites, customized forms or interface, editors, one or more types of controls or objects or functions including presented or contextual or dynamic or customized textbox, check boxes, radio buttons, combo boxes, auto fill, auto suggested lists, auto completion, auto identified and/or fill data, tabs, menus, list boxes, wizards, slider, tables, grids, toolbars & buttons, enabling user to provide various types of user details via selecting, inputting & editing one or more values for one or more fields or sub-fields or field or value of field associate type of metadata. User can provide details of one or more types of one or more interacted entities 9525, categories of entity, associate relationships 9527 and structured or unstructured details 9528, associate estimated number of contextual users who are prospective to become user followers, following users, viewers & connections. User can search or user is presented with various categories or types specific entities, products, services, items, objects, nodes, people, brands, company, school, college, activities, actions, events, & transactions, so user can select said one or more entity or item type and can provide one or more associate values.

In another embodiment user can add or create or update one or more fields and sub-fields 9550 including field name, field data type, constraints or rules & associate default values, one or more values of one or more fields 9555, metadata and request server to verify, validate, rank & add or store them for making them available for other users of network. So they can provide one or more fields specific user derails and values.

In another embodiment user is presented with server created or updated or user enabled to dynamically create or update customized one or more types of forms or interfaces or applications for providing various types of user related or provided details.

In another embodiment user is enabled to imports contacts from user's phone book(s), social contacts, email contacts and one or more types of contacts or connections from one or more sources, applications, services, web sites, devices, servers, databases & networks via one or more types of communication interfaces, web services and Application Programming Interface (API).

In another embodiment alerting or notifying or instructing user within interval or after particular period of time to provide one or more types of or field(s) specific details or one or more types of media items inkling text, link, photo, video, voice, files or attachments, location information via one or more types of interfaces, applications, web pages, forms, wizards, lists, templates and controls. In another embodiment making compulsory to provide or update one or more types of user data or provide or update one or more types of user data within particular period of time to accessing system.

In another embodiment user is enable to provide or set or apply one or more types of settings including opt-in for one or more types for notifications, provide payment details, update accounts including provide or verify mobile phone number, email address, apply security and change password, presentation settings, privacy settings, and preferences.

Based on said detail one or more types of user profile or customized user profile, in another embodiment advertisers or enterprise users is/are enabled including brands, products, service providers, sellers, manufacturers, companies, shops, people, colleges, organizations, companies and one or more types of entities to verify account, provide or update details and provide required one or more types of target audience, wherein target criteria comprise include or exclude one or more locations & places including countries, cities, towns, address, zip code, longitude & latitude, number of contextual users and/or actual customers and/or prospective customers and/or types of user actions, age ranges, interests, actual and/or prospective customers or clients or guests or buyers, subscribers, users, viewers or listeners or application users, gender, one or more named entities, networks, groups, languages, education, skills, income ranges, type of activities, actions, events, transactions & status, and one or more types of user data or user profile related fields and values.

In another embodiment enterprise users charge for per advertised keyword added by user and type of user actions including buy, appointment, order, group deal, fill form, register & download.

In an embodiment user can save or update 9560 said created or updated one or more types of one or more user profiles or forms at server database 115 of server 110 and/or user's client device(s) e.g. 200.

FIG. 97 is an illustrated of an exemplary graphical user interface enabling user to search 9723, match, browse 9730, select from suggested list(s) and select or provide preferences 9710 including one or more categories and sub-categories, taxonomy and ontology 9722, keywords, key phrases 9725 for enabling server system to identify contextual keywords related to user for presenting to user suggested lists of keywords and enabling user to select and add keywords from suggested list of keywords based on said user preferences. In an embodiment user can save or update said preferences at server database 115 of server 110 and/or user's client device(s) e.g. 200.

FIG. 98 is an illustrated of an exemplary graphical user interface enabling user to browse 9805, search 9803 and select category (e.g. 9820) and sub-category e.g. 9850, and select from said category (e.g. 9820) and sub-category e.g. 9850 specific keywords 9870 and add 9882 said selected keywords to user related collections of keywords at server database 115 of server 110 via server module 184 (C), add said selected keywords to user related collections of keywords and share with one or more contacts and/or destinations. Directory comprises type or categories specific user's activities (e.g. watching <named> movie, eating at <named restaurant>, join <named crick club>, like <named brand>, studying at <named school>, working at <named company>, and visited <named tourist place>, types of hobbies, types of interests, and other categories may include using or wants to use types and names of products or services, like to read <technology blogs or news or particular book>, categories of hashtags, types of foods, restaurant related liked and visited restaurants, menu item or food item, shops visited, news type, local service types, types of status, types of requirements, types of search keywords, types of following one or more types of contents, types & names or brands of clothes, shoes using, want to use, wants more details, follow and like.

FIG. 99 illustrates user interface for enabling user including user of network or one or more types of entities like enterprise users including merchant, seller, and advertisers to provide and update user related ontology(ies) and/or suggest user related ontology(ies) at server database 115 of server 110 via server module 184 (C). In another embodiment FIG. 99 illustrates user interface for enabling users of network to collaboratively suggest, add, remove and update user related ontology(ies) at server database 115 of server 110 via server module 184 (C) based on user levels, privacy settings & policies, rights & privileges. User can select 9901 or input 9903 and add 9902 entity type e.g. “Shop” 9901. After adding or selecting type of entity “Shop” 9905, user can select or input and add name of entity 9908 e.g. “Forest Essential™” 9912. User can add one or more entity names 9912 e.g. shops name via add icon 9906 beside type of entity 9905. After adding entity name 9912, user can add class, sub-class, categories, sub-categories e.g. “products” 9920 and add one or more products and services types and categories e.g. 9926 and 9928 and search, select, input, imports and adds product names e.g. 9940, and associate select and add one or more relationships 9915 (e.g. add relationship “sell” 9918 between nodes i.e. shop name 9912 and type “product” 9902) and can add product names 9926 and 9928 associate type(s) and name(s) of one or more relationships (e.g. “product name” 9934), activities, actions, events, transactions. locations, placers, status, reactions, tasks, attributes, properties, selected or added or suggested one or more fields specific one or more types or data type(s) specific value(s) 9974 e.g. price=$100, color=white etc. User can provide ontologies related to products selling by seller including products details, features, locations, selling, online selling, discounts, structured details or description. User can provide relationships with customers including prospective, current, frequent purchaser, good customer. After creating of said ontology by enterprise user “Forest Essential™”, other users of network including customers or prospective customers of “Forest Essential™” e.g. user [Yogesh] 9968 can select, input, suggest, search and add one or more types of relationships (“customer” or “using” 9945), participations, activities, actions, status, reactions (“Like”, “Referred” 9945), transactions (“Purchased” 9945), tasks, events, requirements 9974 with said entity “Forest Essential™” 9912. Based on provided relationships, connections, activities, reactions, status, transactions, tasks and participation details or ontology(ies), system dynamically present contextual fields 9972 (forms (survey form, requesting more detail form or profile form or feedback form or questionnaire form) or templates) for enabling user to provide one or more types of data or information or values related to selected field(s) from presented fields or questions or type of requesting details.

In an embodiment server administrator or editor(s) can create ontology(ies) on behalf of enterprise users. In an embodiment enterprise users are invited and facilitated to create and update said enterprise user related simplified ontology(ies). In an embodiment enterprise user is presented with their subject, concept, domain, field specific matched, generated, customized, configured and contextual templates of ontology(ies) which enables them to easily create, add, select, input, update domain specific ontology(ies) including modeling various concept related to domain of enterprise user comprises enabling to select individuals (i.e. instances are the basic, “ground level” components of an ontology. The individuals in an ontology may include concrete objects such as people, animals, tables, automobiles, molecules, and planets, as well as abstract individuals such as numbers and words), entities, classes, sets, collections, categories or types or taxonomy or kinds (e.g. preference type, interest type), concepts, types of objects, or kinds of things (i.e. concepts that are also called type, sort, category, and kind includes abstract groups, sets, or collections of objects e.g. people, vehicle, car, thing), sub-classes, sub-categories, types (a class is a subclass of collection or subtype. A partition is a set of related classes and associated rules that allow objects to be classified by the appropriate subclass. The rules correspond with the aspect values that distinguish the subclasses from the super classes. E.g. partition of the Car class into the classes 2-Wheel Drive Car and 4-Wheel Drive Car) or entities (e.g. Brand, product, service, school, college, class, shop, item, thing, company etc.), after creating or adding domain related contextual classes or entities or type of entity (e.g. “shop” or “manufacturer” or “distributor” or “seller” or “online seller” or “retailer”) and class name or entity name (e.g. “Forest Essential™” or “GUCCI™”) and their sub-classes (e.g. “products” or “type of cloths” or “collection of cloths” or “bags”) and sub-sub-classes (e.g. “Hair Care” and “Bath and Body”) and names or brands of products e.g. (Massage Oil Narayana™). After modeling, creating and adding domain or purpose or concept (purpose is to sell particular brand(s) products of shop) related classes, sub-classes, entity type and names, sub-categories etc., enterprise user can provide attributes i.e. aspects, properties, features, characteristics, or parameters that objects (and classes or sub-classes or entity type or entity name) can have e.g. shop have attributes or properties (“shop name”, “location” or “address”, product have attributes e.g. name, color, features, ingredients, price, discount etc.). Enterprise user can provide attributes via adding or selecting fields from contextually presented list of fields and can provide associate data type(s) specific one or more values or data or information or details. Objects in an ontology can be described by relating them to other things, typically aspects or parts. These related things are often called attributes, although they may be independent things. Each attribute can be a class or an individual. The kind of object and the kind of attribute determine the kind of relation between them. A relation between an object and an attribute express a fact that is specific to the object to which it is related. For example the Ford Explorer object has attributes such as: <has as name> Ford Explorer, <has by definition as part> door (with as minimum and maximum cardinality: 4), <has by definition as part one of> {4.0 L engine, 4.6 L engine}, <has by definition as part> 6-speed transmission. The value of an attribute can be a complex data type; in this example, the related engine can only be one of a list of subtypes of engines, not just a single thing. Enterprise user is enabled to add one or more relations (i.e. ways in which classes and individuals can be related to one another) comprises relation types for relations between classes, relation types for relations between individuals, relation types for relations between an individual and a class, relation types for relations between a single object and a collection and relation types for relations between collections. Relationships (also known as relations) between objects in ontology specify how objects are related to other objects. Typically a relation is of a particular type (or class) that specifies in what sense the object is related to the other object in the ontology. For example in the ontology that contains the concept Ford Explorer and the concept Ford Bronco might be related by a relation of type <is defined as a successor of>. The full expression of that fact then becomes: Ford Explorer is defined as a successor of: Ford Bronco. Relation types are sometimes domain-specific and are then used to store specific kinds of facts or to answer particular types of questions. For example in the domain of automobiles, we might need a made-in type relationship which tells us where each car is built. So the Ford Explorer is made-in Louisville. The ontology may also know that Louisville is-located-in Kentucky and Kentucky is-classified-as-a state and is-a-part-of the U.S. Software using this ontology could now answer a question like “which cars are made in the U.S.?”, enterprise user can also provide restrictions (i.e. formally stated descriptions of what must be true in order for some assertion to be accepted as input) and can provide, define rule base or rules (i.e. statements in the form of an if-then (antecedent-consequent) sentence that describe the logical inferences that can be drawn from an assertion in a particular form and can provide updates or events (i.e. the changing of attributes or relations). In another embodiment present invention provides simplified ontology(ies) for enabling general users to create and provided details related to domain specific ontology in simplified manner. In an embodiment user is provided with templates or forms or pre-defined fields (field name, filed data type (integer, text, range, flag, Boolean, image etc. and associate list(s) or pre-provided list item(s) and type of control (textbox, combo box, check box(es), radio button(s), list box, button(s), link(s) etc.) or user can add or selector input or suggest one or more types of and associate names of entities, categories, relationships, attributes, reactions, actions, activities, events, transactions, locations, places, reactions, status and requirements. System can analyze said simplified user related ontology based on keywords (identify entity type or name e.g. brand, product name etc.), categories, types (action, activity, status, relationships, and requirement), fields (associated at types) and field(s) associated values, user reactions (like, dislike, refer, rate etc.), user requirement (want to buy, looking for etc.), user relationship (customer, prospective customer etc.), user task (collaborative make decision to book movie ticket etc.) and based on analysis enable user to conduct one or more activities, transactions, and tasks or workflow and take one or more actions by providing one or more contextual user actions, applications, interfaces relate to keyword(s) or full or part of ontology(ies).

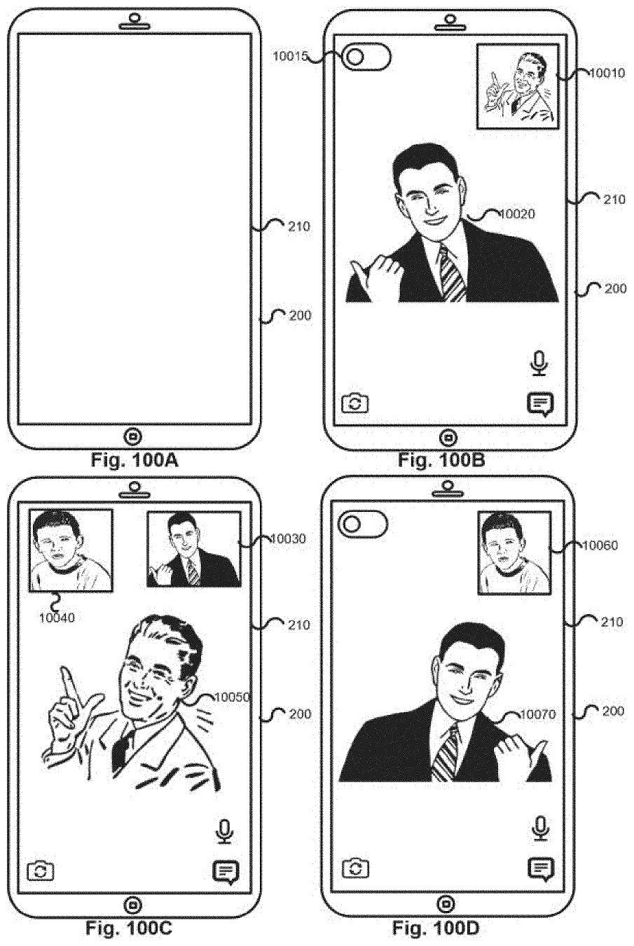

FIG. 100 illustrate user interface or application of natural talking 287, enabling user to when user device 200 is closed or screen is off 210 (FIG. 100 (A)) and in the event of providing voice command e.g. “yogeshone” by user then system or application 287 makes user device auto ON (FIG. 100 (B)) show front camera video interface, so user can starts video talking via camera display screen 210 (via image sensor 244 and audio sensor 245 of user device 200) and sent said voice command from application 287 of user device 200 to server module 190 which recognizes user's contact based on said received voice command and make auto ON said contact's device (if not ON) (FIG. 100 (C)) and show front camera video interface, so user can starts video talking via camera display screen 210 (via image sensor 244 and audio sensor 245 of user device 200) and enable both users 10020 and 10050 to start video talking or communication with each other (auto show front camera video interface of camera display).

In an embodiment user can issue voice command (e.g. “close natural talk”) to OFF or OFF via icon 10015 to stop current video communication or hide or close video interface and stop auto starting of video talk based on issuing of voice command or can issue voice command (e.g. “open natural talk”) to ON or ON via icon 10015 to start auto starting of video talk based on issuing of voice command.

In an embodiment in the event of non-receiving of user voice from any user 10020 and 10050 after pre-set duration server module 186 makes both user devices auto OFF and in an embodiment auto close or hide camera display screen.

In an embodiment in the event of issuing of one or more pre-defined voice command(s) (e.g. “byebye”, “done” etc.) from any user 10020 and 10050 then server module 186 makes both user devices auto OFF and in an embodiment auto close or hide camera display screen.

In an embodiment in the event of make away face from camera display screen by any user 10020 and 10050 then server module 186 makes both user devices auto OFF and in an embodiment auto close or hide camera display screen.

In an embodiment in the event of make face or particular type of face expression in front of camera display screen within pre-set duration by any user 10020 and 10050 based on face tracking system (runs in background and in spite of user device is OFF, image sensor tracks user face and detects particular type of face expression in background mode and sends to server module 186) then server module 186 makes both user devices auto ON and in an embodiment auto show or open camera display screen.

In an embodiment in the event providing voice command to starting video talk with particular contact, auto ON device, auto open front camera video interface and enable to start talking and store recording of video at relays server of server 110 if called user is not available or have slow internet connection at called user side or requiring of some time to connect with called user and in the event of availability of user or gaining of internet connection or connect with called user, present said stored or incrementally updated video. In an embodiment provide various types of status to caller and callee user(s) including initiating, connecting, connected, stored due to delayed, relayed, not available, disconnected, end, resume, slow internet connection, details about availability information or status provided or shared by callee (“I m in meeting”, “I m at gym”, “10 minutes” etc.).

In an embodiment in the event of voice command by caller to connect with particular contact, alerting or ringing one or more types of pre-set ringtone and/or one or more types of vibration at client device of callee and/or caller or no any ringtone and vibration, only auto ON device and open front camera video interface.

In an embodiment in the event of stating of first video session, show online status to other contacts or enable user to hide online status with other contacts. In an embodiment in the event of showing or sharing of online status with other contacts, enable them to start video talk with user.

In an embodiment enable multiple one to one video talking, one to many video talking and many to many video talking. In an embodiment user can provide voice command to connecting with second contact or other one or more contacts during first video talk communication session.

In an embodiment user can provide voice command to connecting with more than one users or group(s) or set(s) of users e.g. (voice command “best friend one” group to call pre-added set of members to said created group).

In an embodiment non-availability of user(s) whom user want to talk, one or more time reminding said users or sent video message or sent push notification to them.

In an embodiment in the event of slow internet connection or delay in connection then storing video at relay server of server 110 and in the event of establishing of connection or sufficient internet data connection present said stored video or present from relay server of server 110.

In an embodiment user can video talk with one or more users and contacts of user e.g. user 10030 can talk with user 10010 and 10060. User can scroll to select overlay video interface and tap on overlay video interface e.g. 10040 to enlarge video screen like e.g. 10050.

In an embodiment enabling user to apply “do not disturb policy” including make OFF or make ON and allow from all or selected one or more contacts, mute for scheduled period or allow during scheduled period, allow only when user is online, allow only when user is not busy based on auto determination, based on object rejection and/or user status allow only when user is not in particular state (e.g. taking shower, watching TV, eating food, not available or busy status etc.). In an embodiment user is enabled to block one or more users.

In an embodiment enabling user to switch from video talk to voice talk and voice talk to video talk. In an embodiment enabling user to exchange messages and capture, record and selects one or more photos and videos and share with each other.

It is contemplated for embodiments described herein to extend to individual elements and concepts described herein, independently of other concepts, ideas or system, as well as for embodiments to include combinations of elements recited anywhere in this application. Although embodiments are described in detail herein with reference to the accompanying drawings, it is to be understood that the invention is not limited to those precise embodiments. As such, many modifications and variations will be apparent to practitioners skilled in this art. Accordingly, it is intended that the scope of the invention be defined by the following claims and their equivalents. Furthermore, it is contemplated that a particular feature described either individually or as part of an embodiment can be combined with other individually described features, or parts of other embodiments, even if the other features and embodiments make no mentioned of the particular feature. Thus, the absence of describing combinations should not preclude the inventor from claiming rights to such combinations.

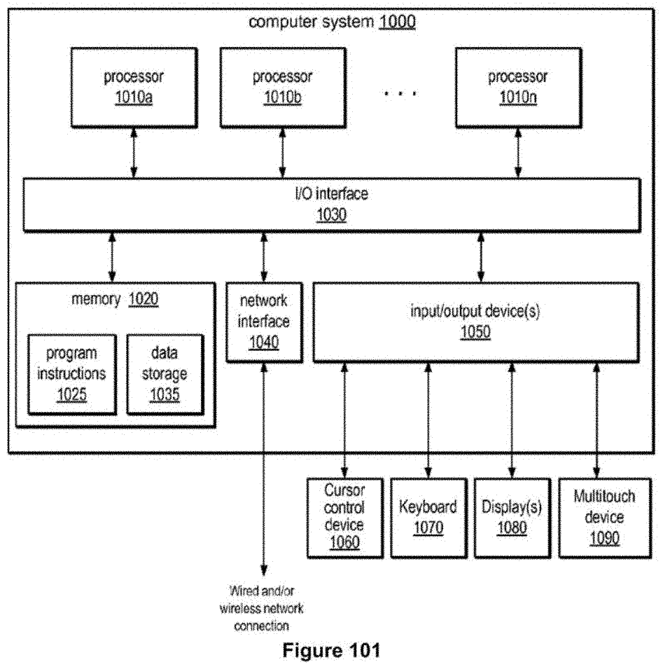

Various components of embodiments of methods as illustrated and described in the accompanying description may be executed on one or more computer systems, which may interact with various other devices. One such computer system is illustrated by FIG. 101. In different embodiments, computer system 1000 may be any of various types of devices, including, but not limited to, a personal computer system, desktop computer, laptop, notebook, or notebook computer, mainframe computer system, handheld computer, workstation, network computer, a camera, a set top box, a mobile device, a consumer device, video game console, handheld video game device, application server, storage device, a peripheral device such as a switch, modem, router, or in general any type of computing or electronic device.

In the illustrated embodiment, computer system 1000 includes one or more processors 1010 coupled to a system memory 1020 via an input/output (I/O) interface 1030. Computer system 1000 further includes a network interface 1040 coupled to I/O interface 1030, and one or more input/output devices 1050, such as cursor control device 1060, keyboard 1070, multitouch device 1090, and display(s) 1080. In some embodiments, it is contemplated that embodiments may be implemented using a single instance of computer system 1000, while in other embodiments multiple such systems, or multiple nodes making up computer system 1000, may be configured to host different portions or instances of embodiments. For example, in one embodiment some elements may be implemented via one or more nodes of computer system 1000 that are distinct from those nodes implementing other elements.

In various embodiments, computer system 1000 may be a uniprocessor system including one processor 1010, or a multiprocessor system including several processors 1010 (e.g., two, four, eight, or another suitable number). Processors 1010 may be any suitable processor capable of executing instructions. For example, in various embodiments, processors 1010 may be general-purpose or embedded processors implementing any of a variety of instruction set architectures (ISAs), such as the x86, PowerPC, SPARC, or MIPS ISAs, or any other suitable ISA. In multiprocessor systems, each of processors 1010 may commonly, but not necessarily, implement the same ISA.

In some embodiments, at least one processor 1010 may be a graphics processing unit. A graphics processing unit or GPU may be considered a dedicated graphics-rendering device for a personal computer, workstation, game console or other computing or electronic device. Modern GPUs may be very efficient at manipulating and displaying computer graphics, and their highly parallel structure may make them more effective than typical CPUs for a range of complex graphical algorithms. For example, a graphics processor may implement a number of graphics primitive operations in a way that makes executing them much faster than drawing directly to the screen with a host central processing unit (CPU). In various embodiments, the methods as illustrated and described in the accompanying description may be implemented by program instructions configured for execution on one of, or parallel execution on two or more of, such GPUs. The GPU(s) may implement one or more application programmer interfaces (APIs) that permit programmers to invoke the functionality of the GPU(s). Suitable GPUs may be commercially available from vendors such as NVIDIA Corporation, ATI Technologies, and others.

System memory 1020 may be configured to store program instructions and/or data accessible by processor 1010. In various embodiments, system memory 1020 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing desired functions, such as those for methods as illustrated and described in the accompanying description, are shown stored within system memory 1020 as program instructions 1025 and data storage 1035, respectively. In other embodiments, program instructions and/or data may be received, sent or stored upon different types of computer-accessible media or on similar media separate from system memory 1020 or computer system 1000. Generally speaking, a computer-accessible medium may include storage media or memory media such as magnetic or optical media, e.g., disk or CD/DVD-ROM coupled to computer system 1000 via I/O interface 1030. Program instructions and data stored via a computer-accessible medium may be transmitted by transmission media or signals such as electrical, electromagnetic, or digital signals, which may be conveyed via a communication medium such as a network and/or a wireless link, such as may be implemented via network interface 1040.

In one embodiment, I/O interface 1030 may be configured to coordinate I/O traffic between processor 1010, system memory 1020, and any peripheral devices in the device, including network interface 1040 or other peripheral interfaces, such as input/output devices 1050. In some embodiments, I/O interface 1030 may perform any necessary protocol, timing or other data transformations to convert data signals from one component (e.g., system memory 1020) into a format suitable for use by another component (e.g., processor 1010). In some embodiments, I/O interface 1030 may include support for devices attached through various types of peripheral buses, such as a variant of the Peripheral Component Interconnect (PCI) bus standard or the Universal Serial Bus (USB) standard, for example. In some embodiments, the function of I/O interface 1030 may be split into two or more separate components, such as a north bridge and a south bridge, for example. In addition, in some embodiments some or all of the functionality of I/O interface 1030, such as an interface to system memory 1020, may be incorporated directly into processor 1010.

Network interface 1040 may be configured to allow data to be exchanged between computer system 1000 and other devices attached to a network, such as other computer systems, or between nodes of computer system 1000. In various embodiments, network interface 1040 may support communication via wired and/or wireless general data networks, such as any suitable type of Ethernet network, for example; via telecommunications/telephony networks such as analog voice networks or digital fiber communications networks; via storage area networks such as Fiber Channel SANs, or via any other suitable type of network and/or protocol.

Input/output devices 1050 may, in some embodiments, include one or more display terminals, keyboards, keypads, touchpads, scanning devices, voice or optical recognition devices, or any other devices suitable for entering or retrieving data by one or more computer system 1000. Multiple input/output devices 1050 may be present in computer system 1000 or may be distributed on various nodes of computer system 1000. In some embodiments, similar input/output devices may be separate from computer system 1000 and may interact with one or more nodes of computer system 1000 through a wired and/or wireless connection, such as over network interface 1040.

As shown in FIG. 13, memory 1020 may include program instructions 1025, configured to implement embodiments of methods as illustrated and described in the accompanying description, and data storage 1035, comprising various data accessible by program instructions 1025. In one embodiment, program instruction 1025 may include software elements of methods as illustrated and described in the accompanying description. Data storage 1035 may include data that may be used in embodiments. In other embodiments, other or different software elements and/or data may be included.

Those skilled in the art will appreciate that computer system 1000 is merely illustrative and is not intended to limit the scope of methods as illustrated and described in the accompanying description. In particular, the computer system and devices may include any combination of hardware or software that can perform the indicated functions, including computers, network devices, internet appliances, PDAs, wireless phones, pagers, etc. Computer system 1000 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 1000 may be transmitted to computer system 1000 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the present invention may be practiced with other computer system configurations.

Various embodiments may further include receiving, sending or storing instructions and/or data implemented in accordance with the foregoing description upon a computer-accessible medium. Generally speaking, a computer-accessible medium may include storage media or memory media such as magnetic or optical media, e.g., disk or DVD/CD-ROM, volatile or non-volatile media such as RAM (e.g. SDRAM, DDR, RDRAM, SRAM, etc.), ROM, etc., as well as transmission media or signals such as electrical, electromagnetic, or digital signals, conveyed via a communication medium such as network and/or a wireless link.

The various methods as illustrated in the Figures and described herein represent examples of embodiments of methods. The methods may be implemented in software, hardware, or a combination thereof. The order of method may be changed, and various elements may be added, reordered, combined, omitted, modified, etc. Various modifications and changes may be made as would be obvious to a person skilled in the art having the benefit of this disclosure. It is intended that the invention embrace all such modifications and changes and, accordingly, the above description to be regarded in an illustrative rather than a restrictive sense.

In an embodiment a program is written as a series of human understandable computer instructions that can be read by a compiler and linker, and translated into machine code so that a computer can understand and run it. A program is a list of instructions written in a programming language that is used to control the behavior of a machine, often a computer (in this case it is known as a computer program). A programming language's surface form is known as its syntax. Most programming languages are purely textual; they use sequences of text including words, numbers, and punctuation, much like written natural languages. On the other hand, there are some programming languages which are more graphical in nature, using visual relationships between symbols to specify a program. In computer science, the syntax of a computer language is the set of rules that defines the combinations of symbols that are considered to be a correctly structured document or fragment in that language. This applies both to programming languages, where the document represents source code, and markup languages, where the document represents data. The syntax of a language defines its surface form. Text-based computer languages are based on sequences of characters, while visual programming languages are based on the spatial layout and connections between symbols (which may be textual or graphical or flowchart(s)). Documents that are syntactically invalid are said to have a syntax error. Syntax—the form—is contrasted with semantics—the meaning. In processing computer languages, semantic processing generally comes after syntactic processing, but in some cases semantic processing is necessary for complete syntactic analysis, and these are done together or concurrently. In a compiler, the syntactic analysis comprises the frontend, while semantic analysis comprises the backend (and middle end, if this phase is distinguished). There are millions of possible combinations, sequences, ordering, permutations & formations of inputs, interpretations, and outputs or outcomes of set of instructions of standardized or specialized or generalized or structured or functional or object oriented programming language(s).

The present invention has been described in particular detail with respect to a limited number of embodiments. Those of skill in the art will appreciate that the invention may additionally be practiced in other embodiments. First, the particular naming of the components, capitalization of terms, the attributes, data structures, or any other programming or structural aspect is not mandatory or significant, and the mechanisms that implement the invention or its features may have different names, formats, or protocols. Furthermore, the system may be implemented via a combination of hardware and software, as described, or entirely in hardware elements. Also, the particular division of functionality between the various system components described herein is merely exemplary, and not mandatory; functions performed by a single system component may instead be performed by multiple components, and functions performed by multiple components may instead performed by a single component. Additionally, although the foregoing embodiments have been described in the context of a social network website, it will apparent to one of ordinary skill in the art that the invention may be used with any social network service, even if it is not provided through a website. Any system that provides social networking functionality can be used in accordance with the present invention even if it relies, for example, on e-mail, instant messaging or any other form of peer-to-peer communications, or any other technique for communicating between users. Systems used to provide social networking functionality include a distributed computing system, client-side code modules or plug-ins, client-server architecture, a peer-to peer communication system or other systems. The invention is thus not limited to any particular type of communication system, network, protocol, format or application.

What is claimed is:

1. A computer-implemented method comprising:
a. displaying contextual keywords with corresponding associated or related or contextual one or more types of user actions, reactions, call-to-actions, relations, activities and interactions for user selection, wherein displaying contextual keywords based on monitored and tracked user device current location and place, check-in place and place associated activities and keywords, triggering of particular events and executing of associated rules, user preferences and privacy settings, requirement specifications, search queries, identified keywords from user status, search query specific keywords, shared by connected users, current trend, ranked keywords, user inputted keywords, identified keywords from recognized object or code based on scanned data received from user, identified keywords from received user voice data, participated or current place associated event related keywords, identified activities related or associated keywords, identified keywords based on interaction of user with one or more type of entities, identification of transaction and associated data and keywords and one or more types of data or digital content related to user and any combination thereof; and
b. in the event of selection of keywords store and associate keywords with unique identity of user and in the event of selection of keyword associated action, associate keywords with unique identity of user and store data related to selected type of user actions, reactions, call-to-actions, relations, activities and interactions.

2. The computer-implemented method of claim 1 wherein types of actions and call-to-actions controls comprises follow, connect, share contact information, purchase, book, order, chat, call, participate in deal, claim offer, redeem offer, get appointment, search, bookmark, install, share, refer, view one or more types of contents including videos, photos, blogs, posts, messages, news, location information, reviews, profile, products and services details, and map and direction.

3. The computer-implemented method of claim 1 wherein types of reactions and reactions controls comprises like, interest to buy, like if low price, dislike, comment, rate, plan to watch.

4. The computer-implemented method of claim 1 wherein types of relations comprises buyer, seller, viewer, guest, client, customer, prospective customer, subscriber, patient, student, friend, classmate, colleague, partner, associate, employee, employer, service provider, professional, owner.

5. The computer-implemented method of claim 1 wherein types of activities including viewing, viewed, playing, reading, read, purchased, eating, plan to visit, listening, joined, joining, like to join, studying, participating, travelling, talking, meeting, attending, visiting, talking, walking.

6. The computer-implemented method of claim 1 wherein enabling to search, match, filter, select, import, input, add, update, remove, categories, rank, order, bookmark, and share one or more keywords with one or more contacts.

7. The computer-implemented method of claim 1 wherein enabling to share one or more keywords with one or more contacts and enable collaboration, communication, workflow, sharing, transaction, and participation among users associated with shared or common keywords.

8. The computer-implemented method of claim 1 wherein user data comprises one or more types of detail user profiles including plurality types of fields and associated values like age, gender, interests, qualification, education, skills, home location, work location, interacted entities like school, college, company and like, monitored or tracked or detected or recognized or sensed or logged or stored activities, actions, status, manual status provided or updated by user, locations or checked-in-places, events, transactions, re-sharing, bookmarks, wish lists, interests, recommendation or refer, privacy settings, preferences, reactions including liked or disliked or commented contents, sharing of one or more types of visual media or contents, viewing of one or more types of visual media or contents, reading, listing, communications, collaborations, interactions, following, participations, behaviour and senses from one or more sources, domain or subject or activities specific contextual survey structured forms and fields and values or un-structured forms, user data of user connections, contacts, groups, networks, relationships and followers and access user data from one or more sources, domains, devices, sensors, accounts, profiles, storage mediums or databases, web sites, applications, services, networks, servers via web services, application programming languages (APIs).

9. The computer-implemented method of claim 1 wherein keyword(s) associated one or more types of data comprises one or more categories, type(s) and name(s) of entities, relationships, activities, actions, events, transactions, status, reactions, tasks, locations, places, senses, expressions, requirements or requirement specifications, search queries, structured data including one or more fields and provided one or more types of value(s) or data for providing properties, attributes, features, characteristics, functions, qualities and one or more types of details and one or more types of user actions.

10. The computer-implemented method of claim 1 wherein displaying keywords associated or related one or more types of contents including posts, photos, videos, blogs, news, messages, applications, graphical user interfaces (GUIs), features, web pages, websites, forms, objects, controls, call-to-actions, offers, advertisements, search results, products, services, people, user accounts.

11. A computer-implemented method comprising:
a. displaying contextual keywords with corresponding associated or related or contextual one or more types of user actions, reactions, call-to-actions, relations, activities and interactions for user selection, wherein displaying contextual keywords based on monitored and tracked user device current location and place, check-in place and place associated activities and keywords, triggering of particular events and executing of associated rules, user preferences and privacy settings, requirement specifications, search queries, identified keywords from user status, search query specific keywords, shared by connected users, current trend, ranked keywords, user inputted keywords, identified keywords from recognized object or code based on scanned data received from user, identified keywords from received user voice data, participated or current place associated event related keywords, identified activities related or associated keywords, identified keywords based on interaction of user with one or more type of entities, identification of transaction and associated data and keywords and one or more types of data or digital content related to user and any combination thereof; and
b. in the event of selection of keywords store and associate keywords with unique identity of user and in the event of selection of keyword associated action, associate keywords with unique identity of user and store data related to selected type of user actions, reactions, call-to-actions, relations, activities and interactions.

12. The computer-implemented system of claim 11 wherein types of actions and call-to-actions controls comprises follow, connect, share contact information, purchase, book, order, chat, call, participate in deal, claim offer, redeem offer, get appointment, search, bookmark, install, share, refer, view one or more types of contents including videos, photos, blogs, posts, messages, news, location information, reviews, profile, products and services details, and map and direction.

13. The computer-implemented system of claim 11 wherein types of reactions or reactions controls comprises like, interest to buy, like if low price, dislike, comment, rate, plan to watch.

14. The computer-implemented system of claim 11 wherein types of relations comprises buyer, seller, viewer, guest, client, customer, prospective customer, subscriber, patient, student, friend, classmate, colleague, partner, associate, employee, employer, service provider, professional, owner.

15. The computer-implemented system of claim 11 wherein types of activities including viewing, viewed, playing, reading, read, purchased, eating, plan to visit, listening, joined, joining, like to join, studying, participating, travelling, talking, meeting, attending, visiting, talking, walking.

16. The computer-implemented system of claim 11 wherein enable to search, match, filter, select, import, input, add, update, remove, categories, rank, order, bookmark, and share one or more keywords with one or more contacts.

17. The computer-implemented system of claim 11 wherein enable to share one or more keywords with one or more contacts and enable collaboration, communication, workflow, sharing, transaction, and participation among users associated with shared or common keywords.

18. The computer-implemented system of claim 11 wherein user data comprises one or more types of detail user profiles including plurality types of fields and associated values like age, gender, interests, qualification, education, skills, home location, work location, interacted entities like school, college, company and like, monitored or tracked or detected or recognized or sensed or logged or stored activities, actions, status, manual status provided or updated by user, locations or checked-in-places, events, transactions, re-sharing, bookmarks, wish lists, interests, recommendation or refer, privacy settings, preferences, reactions including liked or disliked or commented contents, sharing of one or more types of visual media or contents, viewing of one or more types of visual media or contents, reading, listing, communications, collaborations, interactions, following, participations, behaviour and senses from one or more sources, domain or subject or activities specific contextual survey structured forms and fields and values or un-structured forms, user data of user connections, contacts, groups, networks, relationships and followers and access user data from one or more sources, domains, devices, sensors, accounts, profiles, storage mediums or databases, web sites, applications, services, networks, servers via web services, application programming languages (APIs).

19. The computer-implemented system of claim 11 wherein keyword(s) associated one or more types of data comprises one or more categories, type(s) and name(s) of entities, relationships, activities, actions, events, transactions, status, reactions, tasks, locations, places, senses, expressions, requirements or requirement specifications, search queries, structured data including one or more fields and provided one or more types of value(s) or data for providing properties, attributes, features, characteristics, functions, qualities and one or more types of details and one or more types of user actions.

20. The computer-implemented system of claim 11 wherein display keywords associated or related one or more types of contents including posts, photos, videos, blogs, news, messages, applications, graphical user interfaces (GUIs), features, web pages, websites, forms, objects, controls, call-to-actions, offers, advertisements, search results, products, services, people, user accounts.
